(19) United States
(12) Patent Application Publication
(10) Pub. No.: US 2014/0011682 A1
(43) Pub. Date: Jan. 9, 2014

(54) USE OF OPEN-CHAIN CARBOXYLIC ACIDS, CARBONIC ESTERS, CARBOXAMIDES AND CARBONITRILES OF ARYL, HETEROARYL AND BENZYLSULFONAMIDE OR THE SALTS THEREOF FOR IMPROVING THE STRESS TOLERANCE IN PLANTS

(71) Applicants: Jens Frackenpohl, Frankfurt (DE); Lothar Willms, Hofheim (DE); Thomas Mueller, Frankfurt (DE); Stefan Lehr, Lyon (DE); Pascal Von Koskull-Doering, Leverkusen (DE); Ines Heinemann, Hofheim (DE); Christopher Hugh Rosinger, Hofheim (DE); Isolde Haeuser-Hahn, Leverkusen (DE); Martin Jeffrey Hills, Idstein (DE)

(72) Inventors: Jens Frackenpohl, Frankfurt (DE); Lothar Willms, Hofheim (DE); Thomas Mueller, Frankfurt (DE); Stefan Lehr, Lyon (DE); Pascal Von Koskull-Doering, Leverkusen (DE); Ines Heinemann, Hofheim (DE); Christopher Hugh Rosinger, Hofheim (DE); Isolde Haeuser-Hahn, Leverkusen (DE); Martin Jeffrey Hills, Idstein (DE)

(73) Assignee: BAYER INTELLECTUAL PROPERTY GMBH, Monheim (DE)

(21) Appl. No.: 13/977,330

(22) PCT Filed: Dec. 27, 2011
(86) PCT No.: PCT/EP2011/074073

§ 371 Date: Sep. 23, 2013

Related U.S. Application Data
(60) Provisional application No. 61/429,618, filed on Jan. 4, 2011.

(30) Foreign Application Priority Data
Dec. 30, 2010 (EP) 10197395.6

(51) Int. Cl. A01N 41/06; A01N 43/50

(52) U.S. Cl. CPC A01N 41/06; A01N 43/50
USPC 504/275; 560/12; 504/319; 548/340.1

(57) ABSTRACT

The invention relates to the use of open-chain aryl-, heteroaryl- and benzylsulfonamidocarboxylic acids, -carboxylic esters, -carboxamides and -carbonitriles or salts thereof of the formula (I)

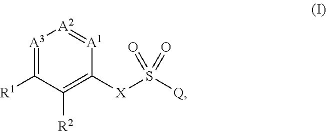

in which the respective substituents have the meanings given in the description, for increasing stress tolerance in plants with respect to abiotic stress, and also for increasing plant growth and/or for increasing plant yield.

The invention relates to the use of open-chain aryl-, heteroaryl- and benzylsulfonamidocarboxylic acids, -carboxylic esters, -carboxamides and -carbonitriles or salts thereof for increasing stress tolerance in plants with respect to abiotic stress, and also for increasing plant growth and/or for increasing plant yield.

It is known that certain arylsulfonamides, for example 2-cyanobenzenesulfonamides, have insecticidal properties (cf., for example, EP0033984 and WO2005035486, WO2006056433, WO2007060220). 2-Cyanobenzenesulfonamides with particular heterocyclic substituents are described in EP2065370. It is also known that particular substituted 2-cyanobenzenesulfonamides can be used as insecticides for soil and seed applications (cf. WO2006100271 and WO2006100288). The anthelmintic action of 3-cyanobenzenesulfonamides is described in US3821276.

The preparation of sulfamidoalkanecarboxylic acids and sulfamidoalkanecarbonitriles is described in DE847006. The use of selected arylsulfonamides having alkylcarboxyl substituents as growth regulators especially for limiting the longitudinal growth of rice and wheat plants with the aim of generating resistance against lodging is described in DE2544859, whereas the fungicidal action of certain N-cyanoalkylsulfonamides is described in EP176327. Furthermore, it is known that substituted N-sulfonylaminoacetonitriles can be used for controlling parasites in warm-blooded animals (cf. WO2004000798).

It is also known that substituted arylsulfonamides (cf., for example, WO2009105774, WO2006124875, WO96/36595) and substituted hetarylsulfonamides (cf. WO2009113600, WO2007122219) can be used as pharmaceutically active compounds. WO2003007931 likewise describes the pharmaceutical use of substituted naphthylsulfonamides, while Eur. J. Med. Chem. 2010, 45, 1760 describes naphthylsulfonyl-substituted glutaminamides and their antitumor action. Furthermore, it is known that pyrrolidinyl-substituted arylsulfonamides can be used as cathepsin C inhibitors in the treatment of respiratory disorders (WO2009026197) or as antiinfective agents in the treatment of hepatitis C (WO2007092588). The pharmaceutical use of N-arylsulfonyl derivatives of various other amino acids, for example as urokinase inhibitors (cf. WO200005214), as active compounds for the treatment of diabetes (cf. WO2003091211), as analgetics (cf. WO2008131947) and as γ-secretase modulators (cf. WO2010108067) has also been described.

It is known that plants can react with specific or unspecific defense mechanisms to natural stress conditions, for example cold, heat, drought stress (stress caused by drought and/or lack of water), injury, pathogenic attack (viruses, bacteria, fungi, insects) etc., but also to herbicides [Pflanzenbiochemie [Plant Biochemistry], pp. 393-462, Spektrum Akademischer Verlag, Heidelberg, Berlin, Oxford, Hans W. Heldt, 1996; Biochemistry and Molecular Biology of Plants, pp. 1102-1203, American Society of Plant Physiologists, Rockville, Md., eds. Buchanan, Gruissem, Jones, 2000].

In plants, numerous proteins involved in defense reactions to abiotic stress (e.g. cold, heat, drought, salinity, flooding), and the genes that code for them, are known. Some of these form part of signal transduction chains (for example transcription factors, kinases, phosphatases) or cause a physiological response of the plant cell (for example ion transport, deactivation of reactive oxygen species). The signaling chain genes of the abiotic stress reaction include transcription factors of the DREB and CBF classes (Jaglo-Ottosen et al., 1998, Science 280: 104-106). The reaction to salinity stress involves phosphatases of the ATPK and MP2C types. In addition, in the event of salinity stress, the biosynthesis of osmolytes such as proline or sucrose is often activated. This involves, for example, sucrose synthase and proline transporter (Hasegawa et al., 2000, Annu Rev Plant Physiol Plant Mol Biol 51: 463-499). The stress defense of the plants to cold and drought uses some of the same molecular mechanisms. There is a known accumulation of what are called late embryogenesis abundant proteins (LEA proteins), which include the dehydrins as an important class (Ingram and Bartels, 1996, Annu Rev Plant Physiol Plant Mol Biol 47: 277-403, Close, 1997, Physiol Plant 100: 291-296). These are chaperones which stabilize vesicles, proteins and membrane structures in stressed plants (Bray, 1993, Plant Physiol 103: 1035-1040). In addition, there is frequently induction of aldehyde dehydrogenases, which deactivate the reactive oxygen species (ROS) which form in the event of oxidative stress (Kirch et al., 2005, Plant Mol Biol 57: 315-332). Heat shock factors (HSF) and heat shock proteins (HSP) are activated in the event of heat stress and play a similar role here as chaperones to that of dehydrins in the event of cold and drought stress (Yu et al., 2005, Mol Cells 19: 328-333).

A number of signaling substances which are endogenous to plants and are involved in stress tolerance or pathogenic defense are already known. Examples include salicylic acid, benzoic acid, jasmonic acid or ethylene [Biochemistry and Molecular Biology of Plants, pp. 850-929, American Society of Plant Physiologists, Rockville, Md., eds. Buchanan, Gruissem, Jones, 2000]. Some of these substances or the stable synthetic derivatives and derived structures thereof are also effective on external application to plants or in seed dressing, and activate defense reactions which cause elevated stress tolerance or pathogen tolerance of the plant [Sembdner, and Parthier, 1993, Ann. Rev. Plant Physiol. Plant Mol. Biol. 44: 569-589).

It is additionally known that chemical substances can increase the tolerance of plants to abiotic stress. Such substances are applied by seed dressing, by leaf spraying or by soil treatment. For instance, an increase in the abiotic stress tolerance of crop plants by treatment with elicitors of systemic acquired resistance (SAR) or abscisic acid derivatives is described (Schading and Wei, WO200028055; Abrams and Gusta, US5201931; Abrams et al, WO97/23441, Churchill et al., 1998, Plant Growth Regul 25: 35-45). In addition, effects of growth regulators on the stress tolerance of crop plants have been described (Morrison and Andrews, 1992, J Plant Growth Regul 11: 113-117, RD-259027). In this context, it is likewise known that a growth-regulating naphthylsulfonamide (4-bromo-N-(pyridin-2-ylmethyl)naphthalene-1-sulfonamide) influences the germination of plant seeds in the same way as abscisic acid (Park et al. Science 2009, 324, 1068-1071). Furthermore, in biochemical receptor tests a naphthylsulfamidocarboxylic acid (N-[(4-bromo-1-naphthyl)sulfonyl]-5-methoxynorvaline) shows a mode of action comparable to 4-bromo-N-(pyridin-2-ylmethyl)naphthalene-1-sulfonamide (Melcher et al. Nature Structural & Molecular Biology 2010, 17, 1102-1108). It is also known that a further naphthylsulfonamide, N-(6-aminohexyl)-5-chloronaphthalene-1-sulfonamide, influences the calcium level in plants which have been exposed to cold shock (Cholewa et al. Can. J. Botany 1997, 75, 375-382).

Similar effects are also observed on application of fungicides, especially from the group of the strobilurins or of the succinate dehydrogenase inhibitors, and are frequently also accompanied by an increase in yield (Draber et al., DE3534948, Bartlett et al., 2002, Pest Manag Sci 60: 309). It is likewise known that the herbicide glyphosate in low dosage stimulates the growth of some plant species (Cedergreen, Env. Pollution 2008, 156, 1099).

In the event of osmotic stress, a protective effect has been observed as a result of application of osmolytes, for example glycine betaine or the biochemical precursors thereof, e.g. choline derivatives (Chen et al., 2000, Plant Cell Environ 23: 609-618, Bergmann et al., DE4103253). The effect of antioxidants, for example naphthols and xanthines, to increase abiotic stress tolerance in plants has also already been described (Bergmann et al., DD277832, Bergmann et al., DD277835). However, the molecular causes of the antistress action of these substances are substantially unknown.

It is additionally known that the tolerance of plants to abiotic stress can be increased by a modification of the activity of endogeneous poly-ADP-ribose polymerases (PARP) or poly-(ADP-ribose) glycohydrolases (PARG) (de Block et al., The Plant Journal, 2004, 41, 95; Levine et al., FEBS Lett. 1998, 440, 1; WO0004173; WO04090140).

It is thus known that plants possess several endogenous reaction mechanisms which can bring about effective defense against a wide variety of different harmful organisms and/or natural abiotic stress. Since the ecological and economic demands on modern crop treatment compositions are increasing constantly, for example with respect to toxicity, selectivity, application rate, formation of residues and favorable manufacture, there is a constant need to develop novel crop treatment compositions which have advantages over those known, at least in some areas.

Accordingly, it is an object of the present invention to provide further compounds which increase the tolerance to abiotic stress in plants, which enhance plant growth and/or contribute to an increase in plant yield. In this context, tolerance to abiotic stress is understood to mean, for example, tolerance to cold, heat, drought stress (stress caused by drought and/or lack of water), salts and flooding, but explicitly not the increased resistance to lodging of the plants or parts thereof, for example during or after heavy rain and thunderstorms.

Accordingly, the present invention provides the use of open-chain aryl-, heteroaryl- and benzylsulfonamidocarboxylic acids, -carboxylic esters, -carboxamides and -carbonitriles of the formula (I) or salts thereof

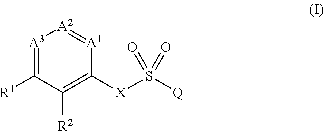

for increasing tolerance to abiotic stress in plants, where
Q is the moieties

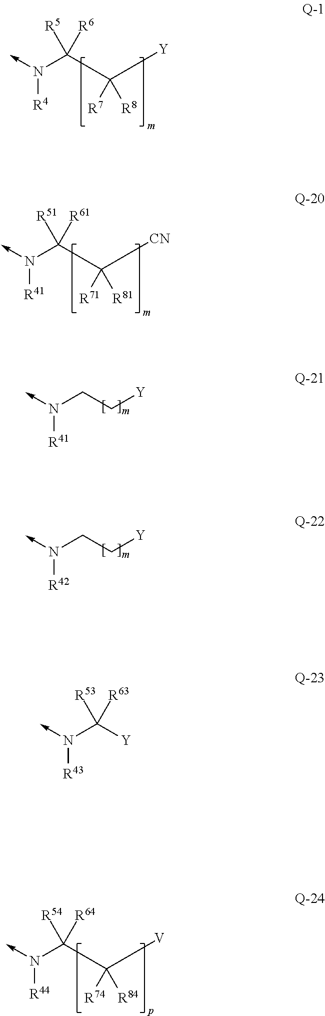

and where the radicals R⁴ to R⁸, and R⁴¹ to R⁸⁴ and also Y and m and p in each case have the meaning according to the definitions below and where the arrow is a bond to the sulfur atom of the SO₂ group;
A¹, A², A³ are the same or different and are each independently of one another N (nitrogen) or the C—W moiety, but there are never more than two adjacent nitrogen atoms, and where W in the C—W moiety in each case has the same or different meanings according to the definition below,
W is in each case hydrogen, nitro, amino, cyano, thiocyanato, isothiocyanato, halogen, (C₁-C₈)-alkyl, (C₃-C₈)-cycloalkyl, (C₂-C₈)-alkenyl, (C₂-C₈)-alkynyl, aryl, aryl-(C₁-C₈)-alkyl, aryl-(C₁-C₆)-alkoxy, heteroaryl, (C₁-C₆)-alkoxy-(C₁-C₈)-alkyl, (C₁-C₈)-haloalkyl, (C₃-C₈)-halocycloalkyl, (C₁-C₈)-alkoxy, (C₁-C₈)-haloalkoxy, aryloxy, heteroaryloxy, (C₃-C₈)-cycloalkyloxy, (C₃-C₈)-cycloalkyl-(C₁-C₈)-alkoxy, (C₁-C₈)-alkoxycarbonyl, (C₁-C₆)-alkoxycarbonyl-(C₁-C₆)-alkyl, hydroxycarbonyl, aminocarbonyl, (C₁-C₈)-alkylaminocarbonyl, (C₃-C₈)-cycloalkylaminocarbonyl, cyano-(C₁-C₈)-alkylaminocarbonyl, (C₂-C₈)-alkenylaminocarbonyl, (C₂-C₈)-alkynylaminocarbonyl, (C₁-C₈)-alkylamino, (C₁-C₈)-alkylthio, (C₁-C₈)-haloalkylthio, bis-(C₁-C₈)-alkylamino, (C₃-C₈)-cycloalkylamino, (C₁-C₈)-alkylcarbonylamino, (C₃-C₈)-cycloalkylcarbonylamino, formylamino, (C₁-C₈)-haloalkylcarbonylamino, (C₁-C₈)-alkoxycarbonylamino, (C₁-C₈)-alkylaminocarbonylamino, bis-[(C₁-C₈)-alkyl]-aminocarbonyl-amino, (C₁-C₈)-alkylsulfonylamino, (C₃-C₈)-cycloalkylsulfonylamino, arylsulfonylamino, hetarylsulfonylamino, sulfonyl-(C₁-C₈)-haloalkylamino, amino-(C₁-C₈)-alkylsulfonyl, amino-(C₁-C₈)-haloalkylsulfonyl, (C₁-C₈)-alkylsulfonyl, (C₃-C₈)-cycloalkylsulfonyl, arylsulfonyl, (C₁-C₈)-alkylsulfinyl, (C₃-C₈)-cycloalkylsulfinyl, arylsulfinyl, N,S-di-(C₁-C₈)-alkylsulfonimidoyl, S—(C₁-C₈)-alkylsulfonimidoyl, (C₁-C₈)-alkylsulfonylaminocarbonyl, (C₃-C₈)-cycloalkylsulfonylaminocarbonyl, (C₃-C₈)-cycloalkylaminosulfonyl, aryl-(C₁-C₈)-alkylcarbonylamino, (C₃-C₈)-cycloalkyl-(C₁-C₈)-alkylcarbonylamino, heteroarylcarbonylamino, (C₁-C₈)-alkoxy-(C₁-C₈)-alkylcarbonylamino, hydroxy-(C₁-C₈)-alkylcarbonylamino,
R¹ is H, nitro, amino, cyano, halogen, (C₁-C₈)-alkyl, (C₃-C₈)-cycloalkyl, (C₂-C₈)-alkenyl, (C₂-C₈)-alkynyl, aryl, aryl-(C₁-C₈)-alkyl, heteroaryl, (C₁-C₈)-alkoxy-(C₁-C₈)-alkyl, (C₁-C₈)-haloalkyl, (C₃-C₈)-halocycloalkyl, (C₁-C₈)-alkoxy, (C₁-C₈)-haloalkoxy, (C₁-C₈)-alkylthio, (C₁-C₈)-haloalkylthio, (C₁-C₈)-alkoxycarbonyl, hydroxycarbonyl, aminocarbonyl, (C₁-C₈)-alkylaminocarbonyl, (C₁-C₈)-alkylamino, bis-(C₁-C₈)-alkylamino, (C₃-C₈)-cycloalkylamino, (C₁-C₈)-alkylcarbonylamino, (C₃-C₈)-cycloalkylcarbonylamino, formylamino, (C₁-C₈)-haloalkylcarbonylamino, (C₁-C₈)-alkoxycarbonylamino, [(C₁-C₈)-alkyl-]aminocarbonyl-amino, sulfonylamino, (C₁-C₈)-alkylsulfonylamino, (C₁-C₈)-haloalkylsulfonylamino, (C₃-C₈)-cycloalkylsulfonylamino, amino-(C₁-C₈)-alkylsulfonyl, amino-(C₁-C₈)-haloalkylsulfonyl, (C₁-C₈)-alkylsulfonyl, (C₃-C₈)-cycloalkylsulfonyl, arylsulfonyl, (C₁-C₈)-alkylsulfinyl, (C₃-C₈)-cycloalkylsulfinyl, arylsulfinyl, N,S-di-(C₁-C₈)-alkylsulfonimidoyl, S—(C₁-C₈)-alkylsulfonimidoyl, (C₁-C₈)-alkylsulfonylaminocarbonyl, (C₃-C₈)-cycloalkylsulfonylaminocarbonyl, (C₃-C₈)-cycloalkylaminosulfonyl, amino-(C₁-C₈)-alkyl, amino-(C₂-C₈)-alkenyl, (C₂-C₈)-alkenylamino, (C₂-C₈)-alkenylimino,
R² is H, nitro, amino, cyano, halogen, (C₁-C₈)-alkyl, (C₃-C₈)-cycloalkyl, (C₂-C₈)-alkenyl, (C₂-C₈)-alkynyl, aryl, aryl-(C₁-C₈)-alkyl, heteroaryl, (C₁-C₈)-alkoxy-(C₁-C₈)-alkyl, (C₁-C₈)-haloalkyl, (C₃-C₈)-halocycloalkyl, (C₁-C₈)-alkoxy, (C₁-C₈)-haloalkoxy, (C₁-C₈)-alkylthio, (C₁-C₈)-haloalkylthio, (C₁-C₈)-alkoxycarbonyl, hydroxycarbonyl, aminocarbonyl, (C₁-C₈)-alkylaminocarbonyl, (C₁-C₈)-alkylamino, bis-(C₁-C₈)-alkylamino, (C₃-C₈)-cycloalkylamino, (C₁-C₈)-alkylcarbonylamino, (C₃-C₈)-cycloalkylcarbonylamino, formylamino, (C₁-C₈)-haloalkylcarbonylamino, (C₁-C₈)-alkoxycarbonylamino, [(C₁-C₈)-alkyl-]-aminocarbonyl-amino, sulfonylamino, (C₁-C₈)-alkylsulfonylamino, (C₁-C₈)-haloalkylsulfonylamino, (C₃-C₈)-cycloalkylsulfonylamino, amino-(C₁-C₈)-alkylsulfonyl, amino-(C₁-C₈)-haloalkylsulfonyl, (C₁-C₈)-alkylsulfonyl, (C₃-C₈)-cycloalkylsulfonyl, arylsulfonyl, (C₁-C₈)-alkylsulfinyl, (C₃-C₈)-cycloalkylsulfinyl, arylsulfinyl, N,S-di-(C₁-C₈)-alkylsulfonimidoyl, S—(C₁-C₈)-alkylsulfonimidoyl, (C₁-C₈)-alkylsulfonylaminocarbonyl, (C₃-C₈)-cycloalkylsulfonylaminocarbonyl, (C₃-C₈)-cycloalkylaminosulfonyl, amino-(C₁-C₈)-alkyl, amino-(C₂-C₈)-alkenyl, (C₂-C₈)-alkenylamino, (C₂-C₈)-alkenylimino,
R¹ and R² with the atoms to which they are attached form a fully saturated, partially saturated or fully unsaturated, 5- to 7-membered ring optionally interrupted by heteroatoms and optionally with further substitution by W, and where, in the case of compounds of the general formula (I), they must form a corresponding ring with the moieties Q-21 and Q-23.
R¹ and A³, if A³ is a C—W group, with the atoms to which they are attached form a fully saturated, partially saturated or fully unsaturated, 5- to 7-membered ring optionally interrupted by heteroatoms and optionally with further substitution,
X is a direct bond or is a (CHR³)ₙ moiety, and where R³ in the (CHR³)ₙ moiety in each case has the same or different meanings according to the definition below,
n is 0, 1,
R³ is H, (C₁-C₈)-alkyl, (C₂-C₈)-alkenyl-(C₁-C₈)-alkyl, (C₁-C₈)-haloalkyl, (C₃-C₈)-cycloalkyl, (C₃-C₈)-cycloalkyl-(C₁-C₈)-alkyl, aryl-(C₁-C₈)-alkyl, heteroaryl-(C₁-C₈)-alkyl, (C₁-C₈)-alkoxy-(C₁-C₈)-alkyl, (C₁-C₈)-haloalkoxy-(C₁-C₈)-alkyl, (C₁-C₈)-alkylthio-(C₁-C₈)-alkyl, (C₁-C₈)-haloalkylthio-(C₁-C₈)-alkyl,
R⁴ is H, (C₁-C₈)-alkyl, (C₂-C₈)-alkenyl-(C₁-C₈)-alkyl, (C₂-C₈)-alkynyl, (C₁-C₈)-alkylcarbonyl, (C₃-C₈)-cycloalkylcarbonyl, arylcarbonyl, heteroarylcarbonyl, (C₁-C₈)-alkoxycarbonyl, aryl-(C₁-C₈)-alkoxycarbonyl, (C₃-C₈)-cycloalkoxycarbonyl, (C₃-C₈)-cycloalkyl-(C₁-C₈)-alkoxycarbonyl, (C₁-C₈)-alkylsulfonyl, (C₃-C₈)-cycloalkylsulfonyl, arylsulfonyl, (C₁-C₈)-alkoxycarbonylcarbonyl, aryl-(C₁-C₈)-alkoxycarbonylcarbonyl, (C₁-C₈)-alkylaminothiocarbonyl, (C₁-C₈)-alkylaminocarbonyl, aryl-(C₁-C₈)-alkyl, heteroaryl-(C₁-C₈)-alkyl, cyano-(C₁-C₈)-alkyl, (C₁-C₈)-haloalkyl, (C₃-C₈)-cycloalkyl, (C₃-C₈)-cycloalkyl-(C₁-C₈)-alkyl, (C₁-C₈)-alkoxy-(C₁-C₈)-alkyl, (C₁-C₈)-haloalkoxy-(C₁-C₈)-alkyl, (C₂-C₈)-alkynyl-(C₁-C₈)-alkyl, (C₁-C₈)-alkoxycarbonyl-(C₁-C₈)-alkyl, aminocarbonyl-(C₁-C₈)-alkyl, (C₁-C₈)-alkylaminocarbonyl-(C₁-C₈)-alkyl, bis-(C₁-C₈)-alkylaminocarbonyl-(C₁-C₈)-alkyl,
R⁵ is halogen, (C₂-C₈)-alkyl, (C₁-C₈)-alkoxy, (C₁-C₈)-alkoxycarbonyloxy, (C₂-C₈)-alkenyl, (C₂-C₈)-haloalkenyl, (C₂-C₈)-alkenyl-(C₁-C₈)-alkyl, (C₂-C₈)-alkynyl, (C₂-C₈)-alkynyl-(C₁-C₈)-alkyl, aryl-(C₁-C₈)-alkyl, bisaryl-(C₁-C₈)-alkyl, aryl-(C₁-C₈)-alkoxyaryl-(C₁-C₈)-alkyl, aryloxyaryl-(C₁-C₈)-alkyl, (C₁-C₈)-alkoxyaryl-(C₁-C₈)-alkyl, heteroaryl-(C₁-C₈)-alkyl, heterocyclyl-(C₁-C₈)-alkyl, N—(C₁-C₈)-alkylheterocyclyl-(C₁-C₈)-alkyl, N—[(C₁-C₈)-alkoxycarbonyl]heterocyclyl-(C₁-C₈)-alkyl, N-(aryl-(C₁-C₈)-alkoxycarbonyl)heterocyclyl-(C₁-C₈)-alkyl, N-(arylcarbonyl)heterocyclyl-(C₁-C₈)-alkyl, N—[(C₁-C₈)-alkylcarbonyl]heterocyclyl-(C₁-C₈)-alkyl, N—[(C₃-C₈)-cycloalkylcarbonyl]heterocyclyl-(C₁-C₈)-alkyl, cyano-(C₁-C₈)-alkyl, (C₁-C₈)-haloalkyl, (C₃-C₈)-cycloalkyl, (C₃-C₈)-halocycloalkyl, (C₄-C₈)-cycloalkenyl, (C₃-C₈)-cycloalkyl-(C₁-C₈)-alkyl, (C₃-C₈)-cycloalkenyl-(C₁-C₈)-alkyl, hydroxy-(C₁-C₈)-alkyl, (C₁-C₈)-alkoxy-(C₁-C₈)-alkyl, (C₁-C₈)-haloalkoxy-(C₁-C₈)-alkyl, aryloxy-(C₁-C₈)-alkyl, aryl-(C₁-C₈)-alkoxy-(C₁-C₈)-alkyl, heteroaryl-(C₁-C₈)-alkoxy-(C₁-C₈)-alkyl, (C₃-C₈)-cycloalkoxy-(C₁-C₈)-alkyl, (C₃-C₈)-cycloalkyl-(C₁-C₈)-alkoxy-(C₁-C₈)-alkyl, (C₁-C₈)-alkylcarbonyloxy-(C₁-C₈)-alkyl, arylcarbonyloxy-(C₁-C₈)-alkyl, heteroarylcarbonyloxy-(C₁-C₈)-alkyl, —(C₃-C₈)-cycloalkylcarbonyloxy-(C₁-C₈)-alkyl, arylsulfonyloxy-(C₁-C₈)-alkyl, (C₁-C₈)-alkylsulfonyloxy-(C₁-C₈)-alkyl, hydrothio-(C₁-C₈)-alkyl, (C₁-C₈)-alkylthio-(C₁-C₈)-alkyl, (C₁-C₈)-haloalkylthio-(C₁-C₈)-alkyl, aryl-(C₁-C₈)-alkylthio-(C₁-C₈)-alkyl, —(C₃-C₈)-cycloalkylthio-(C₁-C₈)-alkyl, arylthio-(C₁-C₈)-alkyl, (C₁-C₈)-alkylsulfinyl-(C₁-C₈)-alkyl, (C₁-C₈)-alkylsulfonyl-(C₁-C₈)-alkyl, (C₁-C₈)-haloalkylsulfinyl-(C₁-C₈)-alkyl, (C₁-C₈)-haloalkylsulfonyl-(C₁-C₈)-alkyl, aryl-(C₁-C₈)-alkylsulfinyl-(C₁-C₈)-alkyl, aryl-(C₁-C₈)-alkylsulfonyl-(C₁-C₈)-alkyl, (C₃-C₈)-cycloalkylsulfinyl-(C₁-C₈)-alkyl, (C₃-C₈)-cycloalkylsulfonyl-(C₁-C₈)-alkyl, aryl, heteroaryl, heterocyclyl, N—[(C₁-C₈)-alkyl]heterocyclyl, N—[(C₁-C₈)-alkoxycarbonyl]heterocyclyl, N—[aryl-(C₁-C₈)-alkoxycarbonyl]heterocyclyl, N-(arylcarbonyl)heterocyclyl, N—[(C₁-C₈)-alkylcarbonyl]heterocyclyl, N—[(C₁-C₈)-cycloalkylcarbonyl]heterocyclyl, hydroxycarbonyl, (C₁-C₈)-alkoxycarbonyl, (C₃-C₈)-cycloalkoxycarbonyl, (C₃-C₈)-cycloalkyl-(C₁-C₈)-alkoxycarbonyl, aryl-(C₁-C₈)-alkoxycarbonyl, heteroaryl-(C₁-C₈)-alkoxycarbonyl, (C₁-C₈)-alkylaminocarbonyl, aminocarbonyl, bis-(C₁-C₈)-alkylaminocarbonyl, (C₃-C₈)-cycloalkylaminocarbonyl, aryl-(C₁-C₈)-alkylaminocarbonyl, heteroarylaminocarbonyl, cyano-(C₁-C₈)-alkylaminocarbonyl, (C₁-C₈)-haloalkylaminocarbonyl, (C₂-C₈)-alkynyl-(C₁-C₈)-alkylaminocarbonyl, hydroxycarbonyl-(C₁-C₈)-alkyl, (C₁-C₈)-alkoxycarbonyl-(C₁-C₈)-alkyl, (C₃-C₈)-cycloalkoxycarbonyl-(C₁-C₈)-alkyl, (C₃-C₈)-cycloalkyl-(C₁-C₈)-alkoxycarbonyl-(C₁-C₈)-alkyl, aryl-(C₁-C₈)-alkoxycarbonyl-(C₁-C₈)-alkyl, heteroaryl-(C₁-C₈)-alkoxycarbonyl-(C₁-C₈)-alkyl, (C₁-C₈)-alkylaminocarbonyl-(C₁-C₈)-alkyl, aminocarbonyl-(C₁-C₈)-alkyl, bis-(C₁-C₈)-alkylaminocarbonyl-(C₁-C₈)-alkyl, (C₃-C₈)-cycloalkylaminocarbonyl-(C₁-C₈)-alkyl, aryl-(C₁-C₈)-alkylaminocarbonyl-(C₁-C₈)-alkyl, heteroarylaminocarbonyl-(C₁-C₈)-alkyl cyano-(C₁-C₈)-alkylaminocarbonyl-(C₁-C₈)-alkyl, (C₁-C₈)-haloalkylaminocarbonyl-(C₁-C₈)-alkyl, (C₂-C₈)-alkynyl-(C₁-C₈)-alkylaminocarbonyl-(C₁-C₈)-alkyl, amino-(C₁-C₈)-alkyl, (C₁-C₈)-alkylamino-(C₁-C₈)-alkyl, (C₂-C₈)-alkenylamino-(C₁-C₈)-alkyl, arylamino-(C₁-C₈)-alkyl, bis-(C₁-C₈)-alkylamino-(C₁-C₈)-alkyl, bis-(C₃-C₈)-cycloalkylamino-(C₁-C₈)-alkyl, aryl-(C₁-C₈)-alkylamino-(C₁-C₈)-alkyl, tris-aryl-(C₁-C₈)-alkylamino-(C₁-C₈)-alkyl, (C₃-C₈)-cycloalkylamino-(C₁-C₈)-alkyl, (C₃-C₈)-cycloalkyl-(C₁-C₈)-alkylamino-(C₁-C₈)-alkyl, (C₁-C₈)-haloalkylamino-(C₁-C₈)-alkyl, (C₁-C₈)-alkylcarbonylamino-(C₁-C₈)-alkyl, (C₁-C₈)-cycloalkylcarbonylamino-(C₁-C₈)-alkyl, arylcarbonylamino-(C₁-C₈)-alkyl, heteroarylcarbonylamino-(C₁-C₈)-alkyl (C₁-C₈)-alkoxycarbonylamino-(C₁-C₈)-alkyl, (C₂-C₈)-alkenyloxycarbonylamino-(C₁-C₈)-alkyl, aryl-(C₁-C₈)-alkoxycarbonylamino-(C₁-C₈)-alkyl, aryl-(C₁-C₈)-alkoxycarbonyl[N—(C₁-C₈)-alkyl]amino-(C₁-C₈)-alkyl, heteroaryl-(C₁-C₈)-alkoxycarbonylamino-(C₁-C₈)-alkyl, (C₃-C₈)-cycloalkyl-(C₁-C₈)-alkoxycarbonylamino-(C₁-C₈)-alkyl, (C₃-C₈)-cycloalkoxycarbonylamino-(C₁-C₈)-alkyl, aminocarbonylamino-(C₁-C₈)-alkyl, arylsulfonylamino-(C₁-C₈)-alkyl, heteroarylsulfonylamino-(C₁-C₈)-alkyl, (C₁-C₈)-alkylsulfonylamino-(C₁-C₈)-alkyl, (C₃-C₈)-cycloalkylsulfonylamino-(C₁-C₈)-alkyl, aminoiminoamino-(C₁-C₈)-alkyl, arylsulfonylaminoiminoamino-(C₁-C₈)-alkyl, (C₁-C₈)-alkylaminoiminoamino-(C₁-C₈)-alkyl,
R⁷ is hydrogen, halogen, (C₁-C₈)-alkyl, (C₁-C₈)-alkoxy, (C₁-C₈)-alkoxycarbonyloxy, (C₂-C₈)-alkenyl, (C₂-C₈)-haloalkenyl, (C₂-C₈)-alkenyl-(C₁-C₈)-alkyl, (C₂-C₈)-alkynyl, (C₂-C₈)-alkynyl-(C₁-C₈)-alkyl, aryl-(C₁-C₈)-alkyl, bisaryl-(C₁-C₈)-alkyl, aryl-(C₁-C₈)-alkoxyaryl-(C₁-C₈)-alkyl, aryloxyaryl-(C₁-C₈)-alkyl, (C₁-C₈)-alkoxyaryl-(C₁-C₈)-alkyl, heteroaryl-(C₁-C₈)-alkyl, heterocyclyl-(C₁-C₈)-alkyl, N—(C₁-C₈)-alkyl heterocyclyl-(C₁-C₈)-alkyl, N—[(C₁-C₈)-alkoxycarbonyl]heterocyclyl-(C₁-C₈)-alkyl, N-(aryl-(C₁-C₈)-alkoxycarbonyl)heterocyclyl-(C₁-C₈)-alkyl, N-(arylcarbonyl)heterocyclyl-(C₁-C₈)-alkyl, N—[(C₁-C₈)-alkylcarbonyl]heterocyclyl-(C₁-C₈)-alkyl, N—[(C₃-C₈)-cycloalkylcarbonyl]heterocyclyl-(C₁-C₈)-alkyl, cyano-(C₁-C₈)-alkyl, (C₁-C₈)-haloalkyl, (C₃-C₈)-cycloalkyl, (C₃-C₈)-halocycloalkyl, (C₄-C₈)-cycloalkenyl, (C₃-C₈)-cycloalkyl-(C₁-C₈)-alkyl, (C₃-C₈)-cycloalkenyl-(C₁-C₈)-alkyl, hydroxy-(C₁-C₈)-alkyl, (C₁-C₈)-alkoxy-(C₁-C₈)-alkyl, (C₁-C₈)-haloalkoxy-(C₁-C₈)-alkyl, aryloxy-(C₁-C₈)-alkyl, aryl-(C₁-C₈)-alkoxy-(C₁-C₈)-alkyl, heteroaryl-(C₁-C₈)-alkoxy-(C₁-C₈)-alkyl, (C₃-C₈)-cycloalkoxy-(C₁-C₈)-alkyl, (C₃-C₈)-cycloalkyl-(Cᵣ C₈)-alkoxy-(C₁-C₈)-alkyl, (C₁-C₈)-alkylcarbonyloxy-(C₁-C₈)-alkyl, arylcarbonyloxy-(C₁-C₈)-alkyl, heteroarylcarbonyloxy-(C₁-C₈)-alkyl, —(C₃-C₈)-cycloalkylcarbonyloxy-(C₁-C₈)-alkyl, arylsulfonyloxy-(C₁-C₈)-alkyl, (C₁-C₈)-alkylsulfonyloxy-(C₁-C₈)-alkyl, hydrothio-(C₁-C₈)-alkyl, (C₁-C₈)-alkylthio-(C₁-C₈)-alkyl, (C₁-C₈)-haloalkylthio-(C₁-C₈)-alkyl, aryl-(C₁-C₈)-alkylthio-(C₁-C₈)-alkyl, —(C₃-C₈)-cycloalkylthio-(C₁-C₈)-alkyl, arylthio-(C₁-C₈)-alkyl, (C₁-C₈)-alkylsulfinyl-(C₁-C₈)-alkyl, (C₁-C₈)-alkylsulfonyl-(C₁-C₈)-alkyl, (C₁-C₈)-haloalkylsulfinyl-(C₁-C₈)-alkyl, (C₁-C₈)-haloalkylsulfonyl-(C₁-C₈)-alkyl, aryl-(C₁-C₈)-alkylsulfinyl-(C₁-C₈)-alkyl, aryl-(C₁-C₈)-alkylsulfonyl-(C₁-C₈)-alkyl, (C₃-C₈)-cycloalkylsulfinyl-(C₁-C₈)-alkyl, (C₃-C₈)-cycloalkylsulfonyl-(C₁-C₈)-alkyl, aryl, heteroaryl, heterocyclyl, N—[(C₁-C₈)-alkyl]heterocyclyl, N—[(C₁-C₈)-alkoxycarbonyl]heterocyclyl, N—[aryl-(C₁-C₈)-alkoxycarbonyl]heterocyclyl, N-(arylcarbonyl)heterocyclyl, N—[(C₁-C₈)-alkylcarbonyl]heterocyclyl, N—[(C₁-C₈)-cycloalkylcarbonyl]heterocyclyl, hydroxycarbonyl, (C₁-C₈)-alkoxycarbonyl, (C₃-C₈)-cycloalkoxycarbonyl, (C₃-C₈)-cycloalkyl-(C₁-C₈)-alkoxycarbonyl, aryl-(C₁-C₈)-alkoxycarbonyl, heteroaryl-(C₁-C₈)-alkoxycarbonyl, (C₁-C₈)-alkylaminocarbonyl, aminocarbonyl, bis-(C₁-C₈)-alkylaminocarbonyl, (C₃-C₈)-cycloalkylaminocarbonyl, aryl-(C₁-C₈)-alkylaminocarbonyl, heteroarylaminocarbonyl, cyano-(C₁-C₈)-alkylaminocarbonyl, (C₁-C₈)-haloalkylaminocarbonyl, (C₂-C₈)-alkynyl-(C₁-C₈)-alkylaminocarbonyl, hydroxycarbonyl-(C₁-C₈)-alkyl, (C₁-C₈)-alkoxycarbonyl-(C₁-C₈)-alkyl, (C₃-C₈)-cycloalkoxycarbonyl-(C₁-C₈)-alkyl, (C₃-C₈)-cycloalkyl-(C₁-C₈)-alkoxycarbonyl-(C₁-C₈)-alkyl, aryl-(C₁-C₈)-alkoxycarbonyl-(C₁-C₈)-alkyl, heteroaryl-(C₁-C₈)-alkoxycarbonyl-(C₁-C₈)-alkyl, (C₁-C₈)-alkylaminocarbonyl-(C₁-C₈)-alkyl, aminocarbonyl-(C₁-C₈)-alkyl, bis-(C₁-C₈)-alkylaminocarbonyl-(C₁-C₈)-alkyl, (C₃-C₈)-cycloalkylaminocarbonyl-(C₁-C₈)-alkyl, aryl-(C₁-C₈)-alkylaminocarbonyl-(C₁-C₈)-alkyl, heteroarylaminocarbonyl-(C₁-C₈)-alkyl, cyano-(C₁-C₈)-alkylaminocarbonyl-(C₁-C₈)-alkyl, (C₁-C₈)-haloalkylaminocarbonyl-(C₁-C₈)-alkyl, —(C₂-C₈)-alkynyl-(C₁-C₈)-alkylaminocarbonyl-(C₁-C₈)-alkyl, amino-(C₁-C₈)-alkyl, (C₁-C₈)-alkylamino-(C₁-C₈)-alkyl, (C₂-C₈)-alkenylamino-(C₁-C₈)-alkyl, arylamino-(C₁-C₈)-alkyl, bis-(C₁-C₈)-alkylamino-(C₁-C₈)-alkyl, bis-(C₃-C₈)-cycloalkylamino-(C₁-C₈)-alkyl, aryl-(C₁-C₈)-alkylamino-(C₁-C₈)-alkyl, tris-aryl-(C₁-C₈)-alkylamino-(C₁-C₈)-alkyl, (C₃-C₈)-cycloalkylamino-(C₁-C₈)-alkyl, (C₃-C₈)-cycloalkyl-(C₁-C₈)-alkylamino-(C₁-C₈)-alkyl, (C₁-C₈)-haloalkylamino-(C₁-C₈)-alkyl, (C₁-C₈)-alkylcarbonylamino-(C₁-C₈)-alkyl, (C₁-C₈)-cycloalkylcarbonylamino-(C₁-C₈)-alkyl, arylcarbonylamino-(C₁-C₈)-alkyl, heteroarylcarbonylamino-(C₁-C₈)-alkyl, (C₁-C₈)-alkoxycarbonylamino-(C₁-C₈)-alkyl, (C₂-C₈)-alkenyloxycarbonylamino-(C₁-C₈)-alkyl, aryl-(C₁-C₈)-alkoxycarbonylamino-(C₁-C₈)-alkyl, aryl-(C₁-C₈)-alkoxycarbonyl[N—(C₁-C₈)-alkyl]amino-(C₁-C₈)-alkyl, heteroaryl-(C₁-C₈)-alkoxycarbonylamino-(C₁-C₈)-alkyl, (C₃-C₈)-cycloalkyl-(C₁-C₈)-alkoxycarbonylamino-(C₁-C₈)-alkyl, (C₃-C₈)-cycloalkoxycarbonylamino-(C₁-C₈)-alkyl, aminocarbonylamino-(C₁-C₈)-alkyl, arylsulfonylamino-(C₁-C₈)-alkyl, heteroarylsulfonylamino-(C₁-C₈)-alkyl, (C₁-C₈)-alkylsulfonylamino-(C₁-C₈)-alkyl, (C₃-C₈)-cycloalkylsulfonylamino-(C₁-C₈)-alkyl, aminoiminoamino-(C₁-C₈)-alkyl, arylsulfonylaminoiminoamino-(C₁-C₈)-alkyl, (C₁-C₈)-alkylaminoiminoamino-(C₁-C₈)-alkyl,
R⁶ and R⁸ independently of one another are H, (C₁-C₈)-alkyl, (C₂-C₈)-alkenyl-(C₁-C₈)-alkyl, (C₂-C₈)-alkynyl-(C₁-C₈)-alkyl, aryl-(C₁-C₈)-alkyl, (C₃-C₈)-cycloalkyl, (C₃-C₈)-cycloalkyl-(C₁-C₈)-alkyl, heterocyclyl, heterocyclyl-(C₁-C₈)-alkyl, amino-(C₁-C₈)-alkyl, (C₁-C₈)-alkoxy-(C₁-C₈)-alkyl, (C₁-C₈)-alkylthio-(C₁-C₈)-alkyl, (C₁-C₈)-haloalkyl, (C₁-C₈)-alkylamino-(C₁-C₈)-alkyl, bis-(C₁-C₈)-alkylamino-(C₁-C₈)-alkyl, (C₁-C₈)-alkylcarbonylamino-(C₁-C₈)-alkyl, (C₃-C₈)-cycloalkylcarbonylamino-(C₁-C₈)-alkyl, arylcarbonylamino-(C₁-C₈)-alkyl, (C₁-C₈)-alkoxycarbonylamino-(C₁-C₈)-alkyl, aryl-(C₁-C₈)-alkoxycarbonylamino-(C₁-C₈)-alkyl, (C₃-C₈)-cycloalkyl-(C₁-C₈)-alkoxycarbonylamino-(C₁-C₈)-alkyl, aminocarbonylamino-(C₁-C₈)-alkyl, aminoiminoamino-(C₁-C₈)-alkyl, arylsulfonylaminoiminoamino-(C₁-C₈)-alkyl, (C₁-C₈)-alkylaminoiminoamino-(C₁-C₈)-alkyl,
R⁴¹ is H, (C₁-C₈)-alkyl, (C₂-C₈)-alkenyl-(C₁-C₈)-alkyl, (C₂-C₈)-alkynyl, (C₁-C₈)-alkylcarbonyl, (C₃-C₈)-cycloalkylcarbonyl, arylcarbonyl, heteroarylcarbonyl, (C₁-C₈)-alkoxycarbonyl, aryl-(C₁-C₈)-alkoxycarbonyl, (C₃-C₈)-cycloalkoxycarbonyl, (C₃-C₈)-cycloalkyl-(C₁-C₈)-alkoxycarbonyl, (C₁-C₈)-alkylsulfonyl, (C₃-C₈)-cycloalkylsulfonyl, arylsulfonyl, (C₁-C₈)-alkoxycarbonylcarbonyl, aryl-(C₁-C₈)-alkoxycarbonylcarbonyl, (C₁-C₈)-alkylaminothiocarbonyl, (C₁-C₈)-alkylaminocarbonyl, aryl-(C₁-C₈)-alkyl, heteroaryl-(C₁-C₈)-alkyl, cyano-(C₁-C₈)-alkyl, (C₁-C₈)-haloalkyl, (C₃-C₈)-cycloalkyl, (C₃-C₈)-cycloalkyl-(C₁-C₈)-alkyl, (C₁-C₈)-alkoxy-(C₁-C₈)-alkyl, (C₁-C₈)-haloalkoxy-(C₁-C₈)-alkyl, (C₂-C₈)-alkynyl-(C₁-C₈)-alkyl, (C₁-C₈)-alkoxycarbonyl-(C₁-C₈)-alkyl, aminocarbonyl-(C₁-C₈)-alkyl, (C₁-C₈)-alkylaminocarbonyl-(C₁-C₈)-alkyl, bis-(C₁-C₈)-alkylaminocarbonyl-(C₁-C₈)-alkyl,
   in the case of the grouping Q-21 is exclusively H or methyl,
R⁴² is (C₂-C₈)-alkyl, (C₂-C₈)-alkenyl-(C₁-C₈)-alkyl, (C₂-C₈)-alkynyl, (C₁-C₈)-alkylcarbonyl, (C₃-C₈)-cycloalkylcarbonyl, arylcarbonyl, heteroarylcarbonyl, (C₁-C₈)-alkoxycarbonyl, aryl-(C₁-C₈)-alkoxycarbonyl, (C₃-C₈)-cycloalkoxycarbonyl, (C₃-C₈)-cycloalkyl-(C₁-C₈)-alkoxycarbonyl, (C₁-C₈)-alkylsulfonyl, (C₃-C₈)-cycloalkylsulfonyl, arylsulfonyl, (C₁-C₈)-alkoxycarbonylcarbonyl, aryl-(C₁-C₈)-alkoxycarbonylcarbonyl, (C₁-C₈)-alkylaminothiocarbonyl, (C₁-C₈)-alkylaminocarbonyl, aryl-(C₁-C₈)-alkyl, heteroaryl-(C₁-C₈)-alkyl, cyano-(C₁-C₈)-alkyl, (C₁-C₈)-haloalkyl, (C₃-C₈)-cycloalkyl, (C₃-C₈)-cycloalkyl-(C₁-C₈)-alkyl, (C₁-C₈)-alkoxy-(C₁-C₈)-alkyl, (C₁-C₈)-haloalkoxy-(C₁-C₈)-alkyl, (C₂-C₈)-alkynyl-(C₁-C₈)-alkyl, (C₁-C₈)-alkoxycarbonyl-(C₁-C₈)-alkyl, aminocarbonyl-(C₁-C₈)-alkyl, (C₁-C₈)-alkylaminocarbonyl-(C₁-C₈)-alkyl, bis-(C₁-C₈)-alkylaminocarbonyl-(C₁-C₈)-alkyl,
R⁴³ is H or methyl,
R⁴⁴ is hydrogen, (C₁-C₈)-alkyl, (C₂-C₈)-alkenyl-(C₁-C₈)-alkyl, (C₂-C₈)-alkynyl, (C₁-C₈)-alkylcarbonyl, (C₃-C₈)-cycloalkylcarbonyl, arylcarbonyl, heteroarylcarbonyl, (C₁-C₈)-alkoxycarbonyl, aryl-(C₁-C₈)-alkoxycarbonyl, (C₃-C₈)-cycloalkoxycarbonyl, (C₃-C₈)-cycloalkyl-(C₁-C₈)-alkoxycarbonyl, (C₁-C₈)-alkylsulfonyl, (C₃-C₈)-cycloalkylsulfonyl, arylsulfonyl, (C₁-C₈)-alkoxycarbonylcarbonyl, aryl-(C₁-C₈)-alkoxycarbonylcarbonyl, (C₁-C₈)-alkylaminothiocarbonyl, (C₁-C₈)-alkylaminocarbonyl, aryl-(C₁-C₈)-alkyl, heteroaryl-(C₁-C₈)-alkyl, cyano-(C₁-C₈)-alkyl, (C₁-C₈)-haloalkyl, (C₃-C₈)-cycloalkyl, (C₃-C₈)-cycloalkyl-(C₁-C₈)-alkyl, (C₁-C₈)-alkoxy-(C₁-C₈)-alkyl, (C₁-C₈)-haloalkoxy-(C₁-C₈)-alkyl, (C₂-C₈)-alkynyl-(C₁-C₈)-alkyl, (C₁-C₈)-alkoxycarbonyl-(C₁-C₈)-alkyl, aminocarbonyl-(C₁-C₈)-alkyl, (C₁-C₈)-alkylaminocarbonyl-(C₁-C₈)-alkyl, bis-(C₁-C₈)-alkylaminocarbonyl-(C₁-C₈)-alkyl,
R⁵¹ and R⁷¹ independently of one another are hydrogen and methyl,
R⁵³ is methyl,
R⁶¹ and R⁸¹ independently of one another are hydrogen and methyl,
R⁶³ is H, methyl,
R⁵⁴, R⁶⁴, R⁷⁴, R⁸⁴ independently of one another are hydrogen, methyl, where at least one of the groups R⁵⁴, R⁶⁴, R⁷⁴, R⁸⁴ must be methyl,
V is hydroxycarbonyl, (C₁-C₈)-alkoxycarbonyl, (C₃-C₈)-cycloalkoxycarbonyl, (C₃-C₈)-cycloalkyl-(C₁-C₈)-alkoxycarbonyl, aryloxycarbonyl, aryl-(C₁-C₈)-alkoxycarbonyl, aminocarbonyl, (C₁-C₈)-alkylaminocarbonyl, bis-(C₁-C₈)-alkylaminocarbonyl, (C₁-C₈)-alkyl-[(C₁-C₈)-alkoxy]aminocarbonyl, (C₃-C₈)-cycloalkylaminocarbonyl, aryl-(C₁-C₈)-alkylaminocarbonyl, heteroaryl-(C₁-C₈)-alkylaminocarbonyl, cyano-(C₁-C₈)-alkylaminocarbonyl, (C₁-C₈)-haloalkylaminocarbonyl, (C₂-C₈)-alkynyl-(C₁-C₈)-alkylaminocarbonyl, (C₁-C₈)-alkoxycarbonyl-(C₁-C₈)-alkylaminocarbonyl, hydroxycarbonyl-(C₁-C₈)-alkylaminocarbonyl, aminocarbonyl-(C₁-C₈)-alkylaminocarbonyl, (C₁-C₈)-alkylaminocarbonyl-(C₁-C₈)-alkylaminocarbonyl, (C₃-C₈)-cycloalkylaminocarbonyl-(C₁-C₈)-alkylaminocarbonyl, (C₃-C₈)-cycloalkyl-(C₁-C₈)-alkylaminocarbonyl,
m is 0, 1, 2, 3, 4, 5,
p is 1, 2, 3, 4
Y is cyano, cyano-(C₁-C₈)-alkyl, hydroxy-(C₁-C₈)-alkyl, (C₁-C₈)-alkoxy-(C₁-C₈)-alkyl, hydroxycarbonyl, (C₁-C₈)-alkoxycarbonyl, (C₃-C₈)-cycloalkoxycarbonyl, (C₃-C₈)-cycloalkyl-(C₁-C₈)-alkoxycarbonyl, aryloxycarbonyl, aryl-(C₁-C₈)-alkoxycarbonyl, aminocarbonyl, (C₁-C₈)-alkylaminocarbonyl, bis-(C₁-C₈)-alkylaminocarbonyl, (C₁-C₈)-alkyl[(C₁-C₈)-alkoxy]aminocarbonyl, (C₃-C₈)-cycloalkylaminocarbonyl, aryl-(C₁-C₈)-alkylaminocarbonyl, heteroaryl-(C₁-C₈)-alkylaminocarbonyl, cyano-(C₁-C₈)-alkylaminocarbonyl, (C₁-C₈)-haloalkylaminocarbonyl, (C₂-C₈)-alkynyl-(C₁-C₈)-alkylaminocarbonyl, (C₁-C₈)-alkoxycarbonylaminocarbonyl, aryl-(C₁-C₈)-alkoxycarbonylaminocarbonyl, hydroxycarbonyl-(C₁-C₈)-alkyl, (C₁-C₈)-alkoxycarbonyl-(C₁-C₈)-alkyl, (C₃-C₈)-cycloalkoxycarbonyl-(C₁-C₈)-alkyl, (C₃-C₈)-cycloalkyl-(C₁-C₈)-alkoxycarbonyl-(C₁-C₈)-alkyl, (C₁-C₈)-alkylaminocarbonyl-(C₁-C₈)-alkyl, aminocarbonyl-(C₁-C₈)-alkyl, bis-(C₁-C₈)-alkylaminocarbonyl-(C₁-C₈)-alkyl, (C₃-C₈)-cycloalkylaminocarbonyl-(C₁-C₈)-alkyl, aryl-(C₁-C₈)-alkylaminocarbonyl-(C₁-C₈)-alkyl, heteroaryl-(C₁-C₈)-alkylaminocarbonyl-(C₁-C₈)-alkyl, cyano-(C₁-C₈)-alkylaminocarbonyl-(C₁-C₈)-alkyl, (C₁-C₈)-haloalkylaminocarbonyl-(C₁-C₈)-alkyl, (C₂-C₈)-alkynyl-(C₁-C₈)-alkylaminocarbonyl-(C₁-C₈)-alkyl, (C₃-C₈)-cycloalkyl-(C₁-C₈)-alkylaminocarbonyl-(C₁-C₈)-alkyl, (C₁-C₈)-alkoxycarbonylaminocarbonyl-(C₁-C₈)-alkyl, aryl-(C₁-C₈)-alkoxycarbonylaminocarbonyl-(C₁-C₈)-alkyl, (C₁-C₈)-alkoxycarbonyl-(C₁-C₈)-alkylaminocarbonyl, hydroxycarbonyl-(C₁-C₈)-alkylaminocarbonyl, aminocarbonyl-(C₁-C₈)-alkylaminocarbonyl, (C₁-C₈)-alkylaminocarbonyl-(C₁-C₈)-alkylaminocarbonyl, (C₃-C₈)-cycloalkylaminocarbonyl-(C₁-C₈)-alkylaminocarbonyl, (C₃-C₈)-cycloalkyl-(C₁-C₈)-alkylaminocarbonyl, (C₃-C₈)-cycloalkyl-(C₁-C₈)-alkylaminocarbonyl-(C₁-C₈)-alkyl, (C₂-C₈)-alkenyloxycarbonyl, (C₂-C₈)-alkenyloxycarbonyl-(C₁-C₈)-alkyl, (C₂-C₈)-alkenylaminocarbonyl, (C₂-C₈)-alkenyl-(C₁-C₈)-alkylaminocarbonyl, (C₂-C₈)-alkenylaminocarbonyl-(C₁-C₈)-alkyl, (C₂-C₈)-alkenyl-(C₁-C₈)-alkylaminocarbonyl-(C₁-C₈)-alkyl

The compounds of the formula (I) are capable of forming salts. Salt formation may take place by allowing a base to act on those compounds of the formula (I) carrying an acidic hydrogen atom, for example in the case that Y contains a COOH group. Suitable bases are, for example, organic amines, such as trialkylamines, morpholine, piperidine or pyridine, and also ammonium, alkali metal or alkaline earth metal hydroxides, carbonates and bicarbonates, in particular sodium hydroxide and potassium hydroxide, sodium carbonate and potassium carbonate and sodium bicarbonate and potassium bicarbonate. These salts are compounds in which the acidic hydrogen is replaced by an agriculturally suitable cation, for example metal salts, in particular alkali metal salts or alkaline earth metal salts, especially sodium salts or potassium salts, or else ammonium salts, salts with organic amines or quaternary ammonium salts, for example with cations of the formula [NRR′R″R′″]⁺ in which R to R′″ are in each case independently of one another organic radicals, in particular alkyl, aryl, aralkyl or alkylaryl. Also suitable are alkylsulfonium and alkylsulfoxonium salts, such as (C₁-C₄)-trialkylsulfonium and (C₁-C₄)-trialkylsulfoxonium salts.

The compounds of the formula (I) can form salts by addition of a suitable inorganic or organic acid, for example mineral acids, for example HCl, HBr, H₂SO₄, H₃PO₄ or HNO₃, or organic acids, for example carboxylic acids such as formic acid, acetic acid, propionic acid, oxalic acid, lactic acid or salicylic acid or sulfonic acids, for example p-toluenesulfonic acid, onto a basic group, for example amino, alkylamino, dialkylamino, piperidino, morpholino or pyridino. These salts then contain the conjugated base of the acid as anion.

Suitable substituents present in deprotonated form, such as, for example, sulfonic acids or carboxylic acids, may form inner salts with groups which for their part can be protonated, such as amino groups. The compounds of the formula (I) used in accordance with the invention and salts thereof are referred to hereinafter as “compounds of the formula (I)”.

Preference is given to the use according to the invention of compounds of the formula (I),

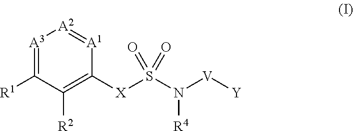

for increasing tolerance to abiotic stress in plants, where
Q is the moieties

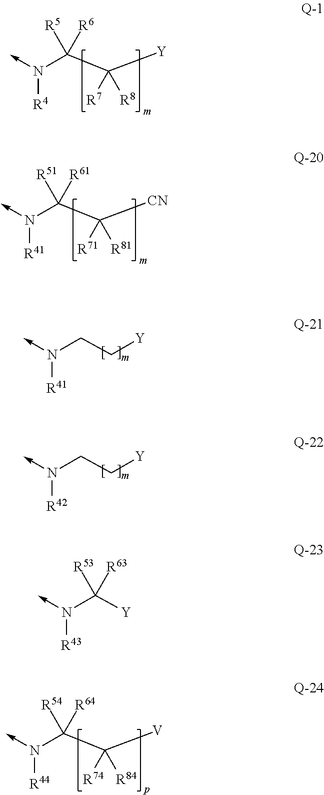

and where the radicals R⁴ to R⁸, and R⁴¹ to R⁸⁴ and also Y and m and p in each case have the meaning according to the definitions below and where the arrow is a bond to the sulfur atom of the SO₂ group;
A¹, A², A³ are the same or different and independently of one another are N (nitrogen) or the C—W moiety, but there are never more than two adjacent nitrogen atoms, and where W in the C—W moiety in each case has the same or different meanings according to the definition below,
W is in each case hydrogen, nitro, amino, cyano, thiocyanato, isothiocyanato, halogen, (C₁-C₆)-alkyl, (C₃-C₆)-cycloalkyl, (C₂-C₆)-alkenyl, (C₂-C₆)-alkynyl, aryl, aryl-(C₁-C₆)-alkyl, aryl-(C₁-C₆)-alkoxy, heteroaryl, (C₁-C₆)-alkoxy-(C₁-C₆)-alkyl, (C₁-C₆)-haloalkyl, (C₃-C₆)-halocycloalkyl, (C₁-C₆)-alkoxy, (C₁-C₆)-haloalkoxy, aryloxy, heteroaryloxy, (C₃-C₆)-cycloalkyloxy, (C₃-C₆)-cycloalkyl-(C₁-C₆)-alkoxy, (C₁-C₆)-alkoxycarbonyl, (C₁-C₆)-alkoxycarbonyl-(C₁-C₆)-alkyl, hydroxycarbonyl, aminocarbonyl, (C₁-C₆)-alkylaminocarbonyl, (C₃-C₆)-cycloalkylaminocarbonyl, cyano-(C₁-C₆)-alkylaminocarbonyl, (C₂-C₆)-alkenylaminocarbonyl, (C₂-C₆)-alkynylaminocarbonyl, (C₁-C₆)-alkylamino, (C₁-C₆)-alkylthio, (C₁-C₆)-haloalkylthio, bis-(C₁-C₆)-alkylamino, (C₃-C₆)-cycloalkylamino, (C₁-C₆)-alkylcarbonylamino, (C₃-C₆)-cycloalkylcarbonylamino, formylamino, (C₁-C₆)-haloalkylcarbonylamino, (C₁-C₆)-alkoxycarbonylamino, (C₁-C₆)-alkylaminocarbonylamino, bis-[(C₁-C₆)-alkyl]-aminocarbonyl-amino, (C₁-C₆)-alkylsulfonylamino, (C₃-C₆)-cycloalkylsulfonylamino, arylsulfonylamino, hetarylsulfonylamino, sulfonyl-(C₁-C₆)-haloalkylamino, amino-(C₁-C₆)-alkylsulfonyl, amino-(C₁-C₆)-haloalkylsulfonyl, (C₁-C₆)-alkylsulfonyl, (C₃-C₆)-cycloalkylsulfonyl, arylsulfonyl, (C₁-C₆)-alkylsulfinyl, (C₃-C₆)-cycloalkylsulfinyl, arylsulfinyl, N,S-di-(C₁-C₆)-alkylsulfonimidoyl, S—(C₁-C₆)-alkylsulfonimidoyl, (C₁-C₆)-alkylsulfonylaminocarbonyl, (C₃-C₆)-cycloalkylsulfonylaminocarbonyl, (C₃-C₆)-cycloalkylaminosulfonyl, aryl-(C₁-C₆)-alkylcarbonylamino, (C₃-C₆)-cycloalkyl-(C₁-C₆)-alkylcarbonylamino, heteroarylcarbonylamino, (C₁-C₆)-alkoxy-(C₁-C₆)-alkylcarbonylamino, hydroxy-(C₁-C₆)-alkylcarbonylamino,
R¹ is H, nitro, amino, cyano, halogen, (C₁-C₆)-alkyl, (C₃-C₆)-cycloalkyl, (C₂-C₆)-alkenyl, (C₂-C₆)-alkynyl, aryl, aryl-(C₁-C₆)-alkyl, heteroaryl, (C₁-C₆)-alkoxy-(C₁-C₆)-alkyl, (C₁-C₆)-haloalkyl, (C₃-C₆)-halocycloalkyl, (C₁-C₆)-alkoxy, (C₁-C₆)-haloalkoxy, (C₁-C₆)-alkylthio, (C₁-C₆)-haloalkylthio, (C₁-C₆)-alkoxycarbonyl, hydroxycarbonyl, aminocarbonyl, (C₁-C₆)-alkylaminocarbonyl, (C₁-C₆)-alkylamino, bis-(C₁-C₆)-alkylamino, (C₃-C₆)-cycloalkylamino, (C₁-C₆)-alkylcarbonylamino, (C₃-C₆)-cycloalkylcarbonylamino, formylamino, (C₁-C₆)-haloalkylcarbonylamino, (C₁-C₆)-alkoxycarbonylamino, [(C₁-C₆)-alkyl-]aminocarbonyl-amino, sulfonylamino, (C₁-C₆)-alkylsulfonylamino, (C₁-C₆)-haloalkylsulfonylamino, (C₃-C₆)-cycloalkylsulfonylamino, amino-(C₁-C₆)-alkylsulfonyl, amino-(C₁-C₆)-haloalkylsulfonyl, (C₁-C₆)-alkylsulfonyl, (C₃-C₆)-cycloalkylsulfonyl, arylsulfonyl, (C₁-C₆)-alkylsulfinyl, (C₃-C₆)-cycloalkylsulfinyl, arylsulfinyl, N,S-di-(C₁-C₆)-alkylsulfonimidoyl, S—(C₁-C₆)-alkylsulfonimidoyl, (C₁-C₆)-alkylsulfonylaminocarbonyl, (C₃-C₆)-cycloalkylsulfonylaminocarbonyl, (C₃-C₆)-cycloalkylaminosulfonyl, amino-(C₁-C₆)-alkyl, amino-(C₂-C₆)-alkenyl, (C₂-C₆)-alkenylamino, (C₂-C₆)-alkenylimino,
R² is H, nitro, amino, cyano, halogen, (C₁-C₆)-alkyl, (C₃-C₆)-cycloalkyl, (C₂-C₆)-alkenyl, (C₂-C₆)-alkynyl, aryl, aryl-(C₁-C₆)-alkyl, heteroaryl, (C₁-C₆)-alkoxy-(C₁-C₆)-alkyl, (C₁-C₆)-haloalkyl, (C₃-C₆)-halocycloalkyl, (C₁-C₆)-alkoxy, (C₁-C₆)-haloalkoxy, (C₁-C₆)-alkylthio, (C₁-C₆)-haloalkylthio, (C₁-C₆)-alkoxycarbonyl, hydroxycarbonyl, aminocarbonyl, (C₁-C₆)-alkylaminocarbonyl, (C₁-C₆)-alkylamino, bis-(C₁-C₆)-alkylamino, (C₃-C₆)-cycloalkylamino, (C₁-C₆)-alkylcarbonylamino, (C₃-C₆)-cycloalkylcarbonylamino, formylamino, (C₁-C₆)-haloalkylcarbonylamino, (C₁-C₆)-alkoxycarbonylamino, [(C₁-C₆)-alkyl-]-aminocarbonyl-amino, sulfonylamino, (C₁-C₆)-alkylsulfonylamino, (C₁-C₆)-haloalkylsulfonylamino, (C₃-C₆)-cycloalkylsulfonylamino, amino-(C₁-C₆)-alkylsulfonyl, amino-(C₁-C₆)-haloalkylsulfonyl, (C₁-C₆)-alkylsulfonyl, (C₃-C₆)-cycloalkylsulfonyl, arylsulfonyl, (C₁-C₆)-alkylsulfinyl, (C₃-C₆)-cycloalkylsulfinyl, arylsulfinyl, N,S-di-(C₁-C₆)-alkylsulfonimidoyl, S—(C₁-C₆)-alkylsulfonimidoyl, (C₁-C₆)-alkylsulfonylaminocarbonyl, (C₃-C₆)-cycloalkylsulfonylaminocarbonyl, (C₃-C₆)-cycloalkylaminosulfonyl, amino-(C₁-C₆)-alkyl, amino-(C₂-C₆)-alkenyl, (C₂-C₆)-alkenylamino, (C₂-C₆)-alkenylimino,
R¹ and R² with the atoms to which they are attached form a fully saturated, partially saturated or fully unsaturated, 5- to 7-membered ring optionally interrupted by heteroatoms and optionally with further substitution by W, and where, in the case of compounds of the general formula (I), they must form a corresponding ring with the moieties Q-21 and Q-23.
R¹ and A³, if A³ is a C—W group, with the atoms to which they are attached form a fully saturated, partially saturated or fully unsaturated, 5- to 7-membered ring optionally interrupted by heteroatoms and optionally with further substitution,
X is a direct bond or is a (CHR³)ₙ moiety, and where R³ in the (CHR³)ₙ moiety in each case has the same or different meanings according to the definition below,
n is 0, 1,
R³ is H, (C₁-C₆)-alkyl, (C₂-C₆)-alkenyl-(C₁-C₆)-alkyl, (C₁-C₆)-haloalkyl, (C₃-C₆)-cycloalkyl, (C₃-C₆)-cycloalkyl-(C₁-C₆)-alkyl, aryl-(C₁-C₆)-alkyl, heteroaryl-(C₁-C₆)-alkyl, (C₁-C₆)-alkoxy-(C₁-C₆)-alkyl, (C₁-C₆)-haloalkoxy-(C₁-C₆)-alkyl, (C₁-C₆)-alkylthio-(C₁-C₆)-alkyl, (C₁-C₆)-haloalkylthio-(C₁-C₆)-alkyl,
R⁴ is H, (C₁-C₆)-alkyl, (C₂-C₆)-alkenyl-(C₁-C₆)-alkyl, (C₂-C₆)-alkynyl, (C₁-C₆)-alkylcarbonyl, (C₃-C₆)-cycloalkylcarbonyl, arylcarbonyl, heteroarylcarbonyl, (C₁-C₆)-alkoxycarbonyl, aryl-(C₁-C₆)-alkoxycarbonyl, (C₃-C₆)-cycloalkoxycarbonyl, (C₃-C₆)-cycloalkyl-(C₁-C₆)-alkoxycarbonyl, (C₁-C₆)-alkylsulfonyl, (C₃-C₆)-cycloalkylsulfonyl, arylsulfonyl, (C₁-C₆)-alkoxycarbonylcarbonyl, aryl-(C₁-C₆)-alkoxycarbonylcarbonyl, (C₁-C₆)-alkylaminothiocarbonyl, (C₁-C₆)-alkylaminocarbonyl, aryl-(C₁-C₆)-alkyl, heteroaryl-(C₁-C₆)-alkyl, cyano-(C₁-C₆)-alkyl, (C₁-C₆)-haloalkyl, (C₃-C₆)-cycloalkyl, (C₃-C₆)-cycloalkyl-(C₁-C₆)-alkyl, (C₁-C₆)-alkoxy-(C₁-C₆)-alkyl, (C₁-C₆)-haloalkoxy-(C₁-C₆)-alkyl, (C₂-C₆)-alkynyl-(C₁-C₆)-alkyl, (C₁-C₆)-alkoxycarbonyl-(C₁-C₆)-alkyl, aminocarbonyl-(C₁-C₆)-alkyl, (C₁-C₆)-alkylaminocarbonyl-(C₁-C₆)-alkyl, bis-(C₁-C₆)-alkylaminocarbonyl-(C₁-C₆)-alkyl,
R⁵ is halogen, (C₂-C₆)-alkyl, (C₁-C₆)-alkoxy, (C₁-C₆)-alkoxycarbonyloxy, (C₂-C₆)-alkenyl, (C₂-C₆)-haloalkenyl, (C₂-C₆)-alkenyl-(C₁-C₆)-alkyl, (C₂-C₆)-alkynyl, (C₂-C₆)-alkynyl-(C₁-C₆)-alkyl, aryl-(C₁-C₆)-alkyl, bisaryl-(C₁-C₆)-alkyl, aryl-(C₁-C₆)-alkoxyaryl-(C₁-C₆)-alkyl, aryloxyaryl-(C₁-C₆)-alkyl, (C₁-C₆)-alkoxyaryl-(C₁-C₆)-alkyl, heteroaryl-(C₁-C₆)-alkyl, heterocyclyl-(C₁-C₆)-alkyl, N—(C₁-C₆)-alkylheterocyclyl-(C₁-C₆)-alkyl, N—[(C₁-C₆)-alkoxycarbonyl)heterocyclyl-(C₁-C₆)-alkyl, N-(aryl-(C₁-C₆)-alkoxycarbonyl)heterocyclyl-(C₁-C₆)-alkyl, N-(arylcarbonyl)heterocyclyl-(C₁-C₆)-alkyl, N—[(C₁-C₆)-alkylcarbonyl]heterocyclyl-(C₁-C₆)-alkyl, N—[(C₃-C₆)-cycloalkylcarbonyl]heterocyclyl-(C₁-C₆)-alkyl, cyano-(C₁-C₆)-alkyl, (C₁-C₆)-haloalkyl, (C₃-C₆)-cycloalkyl, (C₃-C₆)-halocycloalkyl, (C₄-C₆)-cycloalkenyl, (C₃-C₆)-cycloalkyl-(C₁-C₆)-alkyl, (C₃-C₆)-cycloalkenyl-(C₁-C₆)-alkyl, hydroxy-(C₁-C₆)-alkyl, (C₁-C₆)-alkoxy-(C₁-C₆)-alkyl, (C₁-C₆)-haloalkoxy-(C₁-C₆)-alkyl, aryloxy-(C₁-C₆)-alkyl, aryl-(C₁-C₆)-alkoxy-(C₁-C₆)-alkyl, heteroaryl-(C₁-C₆)-alkoxy-(C₁-C₆)-alkyl, (C₃-C₆)-cycloalkoxy-(C₁-C₆)-alkyl, (C₃-C₆)-cycloalkyl-(C₁-C₆)-alkoxy-(C₁-C₆)-alkyl, (C₁-C₆)-alkylcarbonyloxy-(C₁-C₆)-alkyl, arylcarbonyloxy-(C₁-C₆)-alkyl, heteroarylcarbonyloxy-(C₁-C₆)-alkyl, —(C₃-C₆)-cycloalkylcarbonyloxy-(C₁-C₆)-alkyl, arylsulfonyloxy-(C₁-C₆)-alkyl, (C₁-C₆)-alkylsulfonyloxy-(C₁-C₆)-alkyl, hydrothio-(C₁-C₆)-alkyl, (C₁-C₆)-alkylthio-(C₁-C₆)-alkyl, (C₁-C₆)-haloalkylthio-(C₁-C₆)-alkyl, aryl-(C₁-C₆)-alkylthio-(C₁-C₆)-alkyl, (C₃-C₆)-cycloalkylthio-(C₁-C₆)-alkyl, arylthio-(C₁-C₆)-alkyl, (C₁-C₆)-alkylsulfinyl-(C₁-C₆)-alkyl, (C₁-C₆)-alkylsulfonyl-(C₁-C₈)-alkyl, (C₁-C₆)-haloalkylsulfinyl-(C₁-C₆)-alkyl, (C₁-C₆)-haloalkylsulfonyl-(C₁-C₆)-alkyl, aryl-(C₁-C₆)-alkylsulfinyl-(C₁-C₆)-alkyl, aryl-(C₁-C₆)-alkylsulfonyl-(C₁-C₆)-alkyl, (C₃-C₆)-cycloalkylsulfinyl-(C₁-C₆)-alkyl, (C₃-C₆)-cycloalkylsulfonyl-(C₁-C₆)-alkyl, aryl, heteroaryl, heterocyclyl, N—[(C₁-C₆)-alkyl]heterocyclyl, N—[(C₁-C₆)-alkoxycarbonyl]heterocyclyl, N—[aryl-(C₁-C₆)-alkoxycarbonyl]heterocyclyl, N-(arylcarbonyl)heterocyclyl, N—[(C₁-C₆)-alkylcarbonyl]heterocyclyl, N—[(C₁-C₆)-cycloalkylcarbonyl]heterocyclyl, hydroxycarbonyl, (C₁-C₆)-alkoxycarbonyl, (C₃-C₆)-cycloalkoxycarbonyl, (C₃-C₆)-cycloalkyl-(C₁-C₆)-alkoxycarbonyl, aryl-(C₁-C₆)-alkoxycarbonyl, heteroaryl-(C₁-C₆)-alkoxycarbonyl, (C₁-C₆)-alkylaminocarbonyl, aminocarbonyl, bis-(C₁-C₆)-alkylaminocarbonyl, (C₃-C₆)-cycloalkylaminocarbonyl, aryl-(C₁-C₆)-alkylaminocarbonyl, heteroarylaminocarbonyl, cyano-(C₁-C₆)-alkylaminocarbonyl, (C₁-C₆)-haloalkylaminocarbonyl, (C₂-C₆)-alkynyl-(C₁-C₆)-alkylaminocarbonyl, hydroxycarbonyl-(C₁-C₆)-alkyl, (C₁-C₆)-alkoxycarbonyl-(C₁-C₆)-alkyl, (C₃-C₆)-cycloalkoxycarbonyl-(C₁-C₆)-alkyl, (C₃-C₆)-cycloalkyl-(C₁-C₆)-alkoxycarbonyl-(C₁-C₆)-alkyl, aryl-(C₁-C₆)-alkoxycarbonyl-(C₁-C₆)-alkyl, heteroaryl-(C₁-C₆)-alkoxycarbonyl-(C₁-C₆)-alkyl, (C₁-C₆)-alkylaminocarbonyl-(C₁-C₆)-alkyl, aminocarbonyl-(C₁-C₆)-alkyl, bis-(C₁-C₆)-alkylaminocarbonyl-(C₁-C₆)-alkyl, (C₃-C₆)-cycloalkylaminocarbonyl-(C₁-C₆)-alkyl, aryl-(C₁-C₆)-alkylaminocarbonyl-(C₁-C₆)-alkyl, heteroarylaminocarbonyl-(C₁-C₆)-alkyl, cyano-(C₁-C₆)-alkylaminocarbonyl-(C₁-C₆)-alkyl, (C₁-C₆)-haloalkylaminocarbonyl-(C₁-C₆)-alkyl, (C₂-C₈)-alkynyl-(C₁-C₈)-alkylaminocarbonyl-(C₁-C₈)-alkyl, amino-(C₁-C₆)-alkyl, (C₁-C₆)-alkylamino-(C₁-C₆)-alkyl, (C₂-C₆)-alkenylamino-(C₁-C₆)-alkyl, arylamino-(C₁-C₆)-alkyl, bis-(C₁-C₆)-alkylamino-(C₁-C₆)-alkyl, bis-(C₃-C₆)-cycloalkylamino-(C₁-C₆)-alkyl, aryl-(C₁-C₆)-alkylamino-(C₁-C₆)-alkyl, tris-aryl-(C₁-C₆)-alkylamino-(C₁-C₆)-alkyl, (C₃-C₆)-cycloalkylamino-(C₁-C₆)-alkyl, (C₃-C₆)-cycloalkyl-(C₁-C₆)-alkylamino-(C₁-C₆)-alkyl, (C₁-C₆)-haloalkylamino-(C₁-C₆)-alkyl, (C₁-C₆)-alkylcarbonylamino-(C₁-C₆)-alkyl, (C₁-C₆)-cycloalkylcarbonylamino-(C₁-C₆)-alkyl, arylcarbonylamino-(C₁-C₆)-alkyl, heteroarylcarbonylamino-(C₁-C₆)-alkyl, (C₁-C₆)-alkoxycarbonylamino-(C₁-C₆)-alkyl, (C₂-C₆)-alkenyloxycarbonylamino-(C₁-C₆)-alkyl, aryl-(C₁-C₆)-alkoxycarbonylamino-(C₁-C₆)-alkyl, aryl-(C₁-C₆)-alkoxycarbonyl[N—(C₁-C₆)-alkyl]amino-(C₁-C₆)-alkyl, heteroaryl-(C₁-C₆)-alkoxycarbonylamino-(C₁-C₆)-alkyl, (C₃-C₆)-cycloalkyl-(C₁-C₆)-alkoxycarbonylamino-(C₁-C₆)-alkyl, (C₃-C₆)-cycloalkoxycarbonylamino-(C₁-C₆)-alkyl, aminocarbonylamino-(C₁-C₆)-alkyl, arylsulfonylamino-(C₁-C₆)-alkyl, heteroarylsulfonylamino-(C₁-C₆)-alkyl, (C₁-C₆)-alkylsulfonylamino-(C₁-C₆)-alkyl, (C₃-C₆)-cycloalkylsulfonylamino-(C₁-C₆)-alkyl, aminoiminoamino-(C₁-C₆)-alkyl, arylsulfonylaminoiminoamino-(C₁-C₆)-alkyl, (C₁-C₆)-alkylaminoiminoamino-(C₁-C₆)-alkyl,
R⁷ is hydrogen, halogen, (C₁-C₆)-alkyl, (C₁-C₆)-alkoxy, (C₁-C₆)-alkoxycarbonyloxy, (C₂-C₆)-alkenyl, (C₂-C₆)-haloalkenyl, (C₂-C₆)-alkenyl-(C₁-C₆)-alkyl, (C₂-C₆)-alkynyl, (C₂-C₆)-alkynyl-(C₁-C₆)-alkyl, aryl-(C₁-C₆)-alkyl, bisaryl-(C₁-C₆)-alkyl, aryl-(C₁-C₆)-alkoxyaryl-(C₁-C₆)-alkyl, aryloxyaryl-(C₁-C₆)-alkyl, (C₁-C₆)-alkoxyaryl-(C₁-C₆)-alkyl, heteroaryl-(C₁-C₆)-alkyl, heterocyclyl-(C₁-C₆)-alkyl, N—(C₁-C₆)-alkyl heterocyclyl-(C₁-C₆)-alkyl, N—[(C₁-C₆)-alkoxycarbonyl]heterocyclyl-(C₁-C₆)-alkyl, N-(aryl-(C₁-C₆)-alkoxycarbonyl)heterocyclyl-(C₁-C₆)-alkyl, N-(arylcarbonyl)heterocyclyl-(C₁-C₆)-alkyl, N—[(C₁-C₆)-alkylcarbonyl]heterocyclyl-(C₁-C₆)-alkyl, N—[(C₃-C₆)—cycloalkylcarbonyl]heterocyclyl-(C₁-C₆)-alkyl, cyano-(C₁-C₆)-alkyl, (C₁-C₆)-haloalkyl, (C₃-C₆)-cycloalkyl, (C₃-C₆)-halocycloalkyl, (C₄-C₆)-cycloalkenyl, (C₃-C₆)-cycloalkyl-(C₁-C₆)-alkyl, (C₃-C₆)-cycloalkenyl-(C₁-C₆)-alkyl, hydroxy-(C₁-C₆)-alkyl, (C₁-C₆)-alkoxy-(C₁-C₆)-alkyl, (C₁-C₆)-haloalkoxy-(C₁-C₆)-alkyl, aryloxy-(C₁-C₆)-alkyl, aryl-(C₁-C₆)-alkoxy-(C₁-C₆)-alkyl, heteroaryl-(C₁-C₆)-alkoxy-(C₁-C₆)-alkyl, (C₃-C₆)-cycloalkoxy-(C₁-C₆)-alkyl, (C₃-C₆)-cycloalkyl-(C₁-C₆)-alkoxy-(C₁-C₆)-alkyl, (C₁-C₆)-alkylcarbonyloxy-(C₁-C₆)-alkyl, arylcarbonyloxy-(C₁-C₆)-alkyl, heteroarylcarbonyloxy-(C₁-C₆)-alkyl, (C₃-C₆)-cycloalkylcarbonyloxy-(C₁-C₈)-alkyl, arylsulfonyloxy-(C₁-C₆)-alkyl, (C₁-C₆)-alkylsulfonyloxy-(C₁-C₆)-alkyl, hydrothio-(C₁-C₆)-alkyl, (C₁-C₆)-alkylthiol-(C₁-C₆)-alkyl, (C₁-C₆)-haloalkylthio-(C₁-C₆)-alkyl, aryl-(C₁-C₆)-alkylthio-(C₁-C₆)-alkyl, (C₃-C₆)-cycloalkylthio-(C₁-C₆)-alkyl, arylthio-(C₁-C₆)-alkyl, (C₁-C₆)-alkylsulfinyl-(C₁-C₆)-alkyl, (C₁-C₆)-alkylsulfonyl-(C₁-C₆)-alkyl, (C₁-C₆)-haloalkylsulfinyl-(C₁-C₆)-alkyl, (C₁-C₆)-haloalkylsulfonyl-(C₁-C₆)-alkyl, aryl-(C₁-C₆)-alkylsulfinyl-(C₁-C₆)-alkyl, aryl-(C₁-C₆)-alkylsulfonyl-(C₁-C₆)-alkyl, (C₃-C₆)-cycloalkylsulfinyl-(C₁-C₆)-alkyl, (C₃-C₆)-cycloalkylsulfonyl-(C₁-C₆)-alkyl, aryl, heteroaryl, heterocyclyl, N—[(C₁-C₆)-alkyl]heterocyclyl, N—[(C₁-C₆)-alkoxycarbonyl]heterocyclyl, N—[aryl-(C₁-C₆)-alkoxycarbonyl]heterocyclyl, N-(arylcarbonyl)heterocyclyl, N—[(C₁-C₆)-alkylcarbonyl]heterocyclyl, N—[(C₁-C₆)-cycloalkylcarbonyl]heterocyclyl, hydroxycarbonyl, (C₁-C₆)-alkoxycarbonyl, (C₃-C₆)-cycloalkoxycarbonyl, (C₃-C₆)-cycloalkyl-(C₁-C₆)-alkoxycarbonyl, aryl-(C₁-C₆)-alkoxycarbonyl, heteroaryl-(C₁-C₆)-alkoxycarbonyl, (C₁-C₆)-alkylaminocarbonyl, aminocarbonyl, bis-(C₁-C₆)-alkylaminocarbonyl, (C₃-C₆)-cycloalkylaminocarbonyl, aryl-(C₁-C₆)-alkylaminocarbonyl, heteroarylaminocarbonyl, cyano-(C₁-C₆)-alkylaminocarbonyl, (C₁-C₆)-haloalkylaminocarbonyl, (C₂-C₆)-alkynyl-(C₁-C₆)-alkylaminocarbonyl, hydroxycarbonyl-(C₁-C₆)-alkyl, (C₁-C₆)-alkoxycarbonyl-(C₁-C₆)-alkyl, (C₃-C₆)-cycloalkoxycarbonyl-(C₁-C₆)-alkyl, (C₃-C₆)-cycloalkyl-(C₁-C₆)-alkoxycarbonyl-(C₁-C₆)-alkyl, aryl-(C₁-C₆)-alkoxycarbonyl-(C₁-C₆)-alkyl, heteroaryl-(C₁-C₆)-alkoxycarbonyl-(C₁-C₆)-alkyl, (C₁-C₆)-alkylaminocarbonyl-(C₁-C₆)-alkyl, aminocarbonyl-(C₁-C₆)-alkyl, bis-(C₁-C₆)-alkylaminocarbonyl-(C₁-C₆)-alkyl, (C₃-C₆)-cycloalkylaminocarbonyl-(C₁-C₆)-alkyl, aryl-(C₁-C₆)-alkylaminocarbonyl-(C₁-C₆)-alkyl, heteroarylaminocarbonyl-(C₁-C₆)-alkyl, cyano-(C₁-C₆)-alkylaminocarbonyl-(C₁-C₆)-alkyl, (C₁-C₆)-haloalkylaminocarbonyl-(C₁-C₆)-alkyl, —(C₂-C₆)-alkynyl-(C₁-C₆)-alkylaminocarbonyl-(C₁-C₆)-alkyl, amino-(C₁-C₆)-alkyl, (C₁-C₆)-alkylamino-(Cᵣ C₆)-alkyl, (C₂-C₆)-alkenylamino-(C₁-C₆)-alkyl, arylamino-(C₁-C₆)-alkyl, bis-(C₁-C₆)-alkylamino-(C₁-C₆)-alkyl, bis-(C₃-C₆)-cycloalkylamino-(C₁-C₆)-alkyl, aryl-(C₁-C₆)-alkylamino-(C₁-C₆)-alkyl, tris-aryl-(C₁-C₆)-alkylamino-(C₁-C₆)-alkyl, (C₃-C₆)-cycloalkylamino-(C₁-C₆)-alkyl, (C₃-C₆)-cycloalkyl-(C₁-C₆)-alkylamino-(C₁-C₆)-alkyl, (C₁-C₆)-haloalkylamino-(C₁-C₆)-alkyl, (C₁-C₆)-alkylcarbonylamino-(C₁-C₆)-alkyl, (C₁-C₆)-cycloalkylcarbonyl amino-(C₁-C₆)-alkyl , arylcarbonylamino-(C₁-C₆)-alkyl, heteroarylcarbonylamino-(C₁-C₆)-alkyl, (C₁-C₆)-alkoxycarbonylamino-(C₁-C₆)-alkyl, (C₂-C₆)-alkenyloxycarbonylamino-(C₁-C₆)-alkyl, aryl-(C₁-C₆)-alkoxycarbonylamino-(C₁-C₆)-alkyl, aryl-(C₁-C₆)-alkoxycarbonyl[N—(C₁-C₆)-alkyl]amino-(C₁-C₆)-alkyl, heteroaryl-(C₁-C₆)-alkoxycarbonylamino-(C₁-C₆)-alkyl, (C₃-C₆)-cycloalkyl-(C₁-C₆)-alkoxycarbonylamino-(C₁-C₆)-alkyl, (C₃-C₆)-cycloalkoxycarbonylamino-(C₁-C₆)-alkyl, aminocarbonylamino-(C₁-C₆)-alkyl, arylsulfonylamino-(C₁-C₆)-alkyl, heteroarylsulfonylamino-(C₁-C₆)-alkyl, (C₁-C₆)-alkylsulfonylamino-(C₁-C₆)-alkyl, (C₃-C₆)-cycloalkylsulfonylamino-(C₁-C₆)-alkyl, aminoiminoamino-(C₁-C₆)-alkyl, arylsulfonylaminoiminoamino-(C₁-C₆)-alkyl, (C₁-C₆)-alkylaminoiminoamino-(C₁-C₆)-alkyl,
R⁶ and R⁸ independently of one another are H, (C₁-C₆)-alkyl, (C₂-C₆)-alkenyl-(C₁-C₆)-alkyl, (C₂-C₆)-alkynyl-(C₁-C₆)-alkyl, aryl-(C₁-C₆)-alkyl, (C₃-C₆)-cycloalkyl, (C₃-C₆)-cycloalkyl-(C₁-C₆)-alkyl, heterocyclyl, heterocyclyl-(C₁-C₆)-alkyl, amino-(C₁-C₆)-alkyl, (C₁-C₆)-alkoxy-(C₁-C₆)-alkyl, (C₁-C₆)-alkylthio-(C₁-C₆)-alkyl, (C₁-C₆)-haloalkyl, (C₁-C₆)-alkylamino-(C₁-C₆)-alkyl, bis-(C₁-C₆)-alkylamino-(C₁-C₆)-alkyl, (C₁-C₆)-alkylcarbonylamino-(C₁-C₆)-alkyl, (C₃-C₆)-cycloalkylcarbonylamino-(C₁-C₆)-alkyl, arylcarbonylamino-(C₁-C₆)-alkyl, (C₁-C₆)-alkoxycarbonylamino-(C₁-C₆)-alkyl, aryl-(C₁-C₆)-alkoxycarbonylamino-(C₁-C₆)-alkyl, (C₃-C₆)-cycloalkyl-(C₁-C₆)-alkoxycarbonylamino-(C₁-C₆)-alkyl, aminocarbonylamino-(C₁-C₆)-alkyl, aminoiminoamino-(C₁-C₆)-alkyl, arylsulfonylaminoiminoamino-(C₁-C₆)-alkyl, (C₁-C₆)-alkylaminoiminoamino-(C₁-C₆)-alkyl,
R⁴¹ is H, (C₁-C₆)-alkyl, (C₂-C₆)-alkenyl-(C₁-C₆)-alkyl, (C₂-C₆)-alkynyl, (C₁-C₆)-alkylcarbonyl, (C₃-C₆)-cycloalkylcarbonyl, arylcarbonyl, heteroarylcarbonyl, (C₁-C₆)-alkoxycarbonyl, aryl-(C₁-C₆)-alkoxycarbonyl, (C₃-C₆)-cycloalkoxycarbonyl, (C₃-C₆)-cycloalkyl-(C₁-C₆)-alkoxycarbonyl, (C₁-C₆)-alkylsulfonyl, (C₃-C₆)-cycloalkylsulfonyl, arylsulfonyl, (C₁-C₆)-alkoxycarbonylcarbonyl, aryl-(C₁-C₆)-alkoxycarbonylcarbonyl, (C₁-C₆)-alkylaminothiocarbonyl, (C₁-C₆)-alkylaminocarbonyl, aryl-(C₁-C₆)-alkyl, heteroaryl-(C₁-C₆)-alkyl, cyano-(C₁-C₆)-alkyl, (C₁-C₆)-haloalkyl, (C₃-C₆)-cycloalkyl, (C₃-C₆)-cycloalkyl-(C₁-C₆)-alkyl, (C₁-C₆)-alkoxy-(C₁-C₆)-alkyl, (C₁-C₆)-haloalkoxy-(C₁-C₆)-alkyl, (C₂-C₆)-alkynyl-(C₁-C₆)-alkyl, (C₁-C₆)-alkoxycarbonyl-(C₁-C₆)-alkyl, aminocarbonyl-(C₁-C₆)-alkyl, (C₁-C₆)-alkylaminocarbonyl-(C₁-C₆)-alkyl, bis-(C₁-C₆)-alkylaminocarbonyl-(C₁-C₆)-alkyl,
   in the case of the grouping Q-21 is exclusively H or methyl,
R⁴² is (C₂-C₆)-alkyl, (C₂-C₆)-alkenyl-(C₁-C₆)-alkyl, (C₂-C₆)-alkynyl, (C₁-C₆)-alkylcarbonyl, (C₃-C₆)-cycloalkylcarbonyl, arylcarbonyl, heteroarylcarbonyl, (C₁-C₆)-alkoxycarbonyl, aryl-(C₁-C₆)-alkoxycarbonyl, (C₃-C₆)-cycloalkoxycarbonyl, (C₃-C₆)-cycloalkyl-(C₁-C₆)-alkoxycarbonyl, (C₁-C₆)-alkylsulfonyl, (C₃-C₆)-cycloalkylsulfonyl, arylsulfonyl, (C₁-C₆)-alkoxycarbonylcarbonyl, aryl-(C₁-C₆)-alkoxycarbonylcarbonyl, (C₁-C₆)-alkylaminothiocarbonyl, (C₁-C₆)-alkylaminocarbonyl, aryl-(C₁-C₆)-alkyl, heteroaryl-(C₁-C₆)-alkyl, cyano-(C₁-C₆)-alkyl, (C₁-C₆)-haloalkyl, (C₃-C₆)-cycloalkyl, (C₃-C₆)-cycloalkyl-(C₁-C₆)-alkyl, (C₁-C₆)-alkoxy-(C₁-C₆)-alkyl, (C₁-C₆)-haloalkoxy-(C₁-C₆)-alkyl, (C₂-C₆)-alkynyl-(C₁-C₆)-alkyl, (C₁-C₆)-alkoxycarbonyl-(C₁-C₆)-alkyl, aminocarbonyl-(C₁-C₆)-alkyl, (C₁-C₆)-alkylaminocarbonyl-(C₁-C₆)-alkyl, bis-(C₁-C₆)-alkylaminocarbonyl-(C₁-C₆)-alkyl,
R⁴³ is H or methyl,
R⁴⁴ is hydrogen, (C₁-C₆)-alkyl, (C₂-C₆)-alkenyl-(C₁-C₆)-alkyl, (C₂-C₆)-alkynyl, (C₁-C₆)-alkylcarbonyl, (C₃-C₆)-cycloalkylcarbonyl, arylcarbonyl, heteroarylcarbonyl, (C₁-C₆)-alkoxycarbonyl, aryl-(C₁-C₆)-alkoxycarbonyl, (C₃-C₆)-cycloalkoxycarbonyl, (C₃-C₆)-cycloalkyl-(C₁-C₆)-alkoxycarbonyl, (C₁-C₆)-alkylsulfonyl, (C₃-C₆)-cycloalkylsulfonyl, arylsulfonyl, (C₁-C₆)-alkoxycarbonylcarbonyl, aryl-(C₁-C₆)-alkoxycarbonylcarbonyl, (C₁-C₆)-alkylaminothiocarbonyl, (C₁-C₆)-alkylaminocarbonyl, aryl-(C₁-C₆)-alkyl, heteroaryl-(C₁-C₆)-alkyl, cyano-(C₁-C₆)-alkyl, (C₁-C₆)-haloalkyl, (C₃-C₆)-cycloalkyl, (C₃-C₆)-cycloalkyl-(C₁-C₆)-alkyl, (C₁-C₆)-alkoxy-(C₁-C₆)-alkyl, (C₁-C₆)-haloalkoxy-(C₁-C₆)-alkyl, (C₂-C₆)-alkynyl-(C₁-C₆)-alkyl, (C₁-C₆)-alkoxycarbonyl-(C₁-C₆)-alkyl, aminocarbonyl-(C₁-C₆)-alkyl, (C₁-C₆)-alkylaminocarbonyl-(C₁-C₆)-alkyl, bis-(C₁-C₆)-alkylaminocarbonyl-(C₁-C₆)-alkyl,
R⁵¹ and R⁷¹ independently of one another are hydrogen and methyl,
R⁵³ is methyl,
R⁶¹ and R⁸¹ independently of one another are hydrogen and methyl,
R⁶³ is H, methyl,
R⁵⁴, R⁶⁴, R⁷⁴, R⁸⁴ independently of one another are hydrogen, methyl, where at least one of the groups R⁵⁴, R⁶⁴, R⁷⁴, R⁸⁴ must be methyl,
V is hydroxycarbonyl, (C₁-C₆)-alkoxycarbonyl, (C₃-C₆)-cycloalkoxycarbonyl, (C₃-C₆)-cycloalkyl-(C₁-C₆)-alkoxycarbonyl, aryloxycarbonyl, Aryl-(C₁-C₆)-alkoxycarbonyl, aminocarbonyl, (C₁-C₆)-alkylaminocarbonyl, bis-(C₁-C₆)-alkylaminocarbonyl, (C₁-C₆)-alkyl-[(C₁-C₆)-alkoxy]aminocarbonyl, (C₃-C₆)-cycloalkylaminocarbonyl, aryl-(C₁-C₆)-alkylaminocarbonyl, heteroaryl-(C₁-C₆)-alkylaminocarbonyl, cyano-(C₁-C₆)-alkylaminocarbonyl, (C₁-C₆)-haloalkylaminocarbonyl, (C₂-C₆)-alkynyl-(C₁-C₆)-alkylaminocarbonyl, (C₁-C₆)-alkoxycarbonyl-(C₁-C₆)-alkylaminocarbonyl, hydroxycarbonyl-(C₁-C₆)-alkylaminocarbonyl, aminocarbonyl-(C₁-C₆)-alkylaminocarbonyl, (C₁-C₆)-alkylaminocarbonyl-(C₁-C₆)-alkylaminocarbonyl, (C₃-C₆)-cycloalkylaminocarbonyl-(C₁-C₆)-alkylaminocarbonyl, (C₃-C₆)-cycloalkyl-(C₁-C₆)-alkylaminocarbonyl,
m is 0, 1, 2, 3, 4, 5,
p is 1, 2, 3, 4,
Y is cyano, cyano-(C₁-C₆)-alkyl, hydroxy-(C₁-C₆)-alkyl, (C₁-C₆)-alkoxy-(C₁-C₆)-alkyl, hydroxycarbonyl, (C₁-C₆)-alkoxycarbonyl, (C₃-C₆)-cycloalkoxycarbonyl, (C₃-C₆)-cycloalkyl-(C₁-C₆)-alkoxycarbonyl, aryloxycarbonyl, aryl-(C₁-C₆)-alkoxycarbonyl, aminocarbonyl, (C₁-C₆)-alkylaminocarbonyl, bis-(C₁-C₆)-alkylaminocarbonyl, (C₁-C₆)-alkyl[(C₁-C₆)-alkoxy]aminocarbonyl, (C₃-C₆)-cycloalkylaminocarbonyl, aryl-(C₁-C₆)-alkylaminocarbonyl, heteroaryl-(C₁-C₆)-alkylaminocarbonyl, cyano-(C₁-C₆)-alkylaminocarbonyl, (C₁-C₆)-haloalkylaminocarbonyl, (C₂-C₆)-alkynyl-(C₁-C₆)-alkylaminocarbonyl, (C₁-C₆)-alkoxycarbonylaminocarbonyl, aryl-(C₁-C₆)-alkoxycarbonylaminocarbonyl, hydroxycarbonyl-(C₁-C₆)-alkyl, (C₁-C₆)-alkoxycarbonyl-(C₁-C₆)-alkyl, (C₃-C₆)-cycloalkoxycarbonyl-(C₁-C₆)-alkyl, (C₃-C₆)-cycloalkyl-(C₁-C₆)-alkoxycarbonyl-(C₁-C₆)-alkyl, (C₁-C₆)-alkylaminocarbonyl-(C₁-C₆)-alkyl, aminocarbonyl-(C₁-C₆)-alkyl, bis-(C₁-C₆)-alkylaminocarbonyl-(C₁-C₆)-alkyl, (C₃-C₆)-cycloalkylaminocarbonyl-(C₁-C₆)-alkyl, aryl-(C₁-C₆)-alkylaminocarbonyl-(C₁-C₆)-alkyl, heteroaryl-(C₁-C₆)-alkylaminocarbonyl-(C₁-C₆)-alkyl, cyano-(C₁-C₆)-alkylaminocarbonyl-(C₁-C₆)-alkyl, (C₁-C₆)-haloalkylaminocarbonyl-(C₁-C₆)-alkyl, (C₂-C₆)-alkynyl-(C₁-C₆)-alkylaminocarbonyl-(C₁-C₆)-alkyl, (C₃-C₆)-cycloalkyl-(C₁-C₆)-alkylaminocarbonyl-(C₁-C₆)-alkyl, (C₁-C₆)-alkoxycarbonylaminocarbonyl-(C₁-C₆)-alkyl, aryl-(C₁-C₆)-alkoxycarbonylaminocarbonyl-(C₁-C₆)-alkyl, (C₁-C₆)-alkoxycarbonyl-(C₁-C₆)-alkylaminocarbonyl, hydroxycarbonyl-(C₁-C₆)-alkylaminocarbonyl, aminocarbonyl-(C₁-C₆)-alkylaminocarbonyl, (C₁-C₆)-alkylaminocarbonyl-(C₁-C₆)-alkylaminocarbonyl, (C₃-C₆)-cycloalkylaminocarbonyl-(C₁-C₆)-alkylaminocarbonyl, (C₃-C₆)-cycloalkyl-(C₁-C₆)-alkylaminocarbonyl, (C₃-C₆)-cycloalkyl-(C₁-C₆)-alkylaminocarbonyl-(C₁-C₆)-alkyl, (C₂-C₆)-alkenyloxycarbonyl, (C₂-C₆)-alkenyloxycarbonyl-(C₁-C₆)-alkyl, (C₂-C₆)-alkenylaminocarbonyl, (C₂-C₆)-alkenyl-(C₁-C₆)-alkylaminocarbonyl, (C₂-C₆)-alkenylaminocarbonyl-(C₁-C₆)-alkyl, (C₂-C₆)-alkenyl-(C₁-C₆)-alkylaminocarbonyl-(C₁-C₆)-alkyl.

Particular preference is given to the use according to the invention of compounds of the formula (I) where

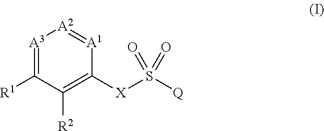

for increasing tolerance to abiotic stress in plants, where
Q is the moieties

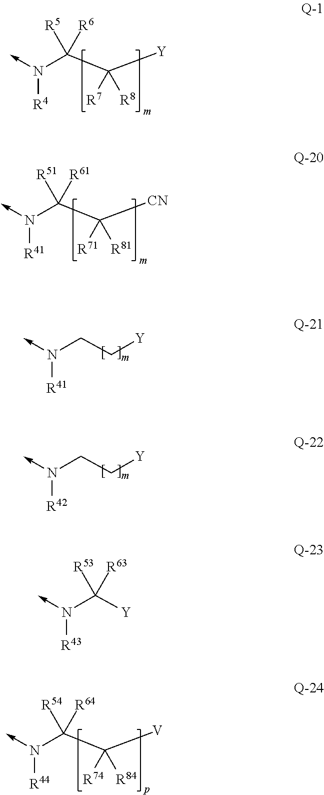

and where the radicals R⁴ to R⁸, and R⁴¹ to R⁸⁴ and also Y and m and p in each case have the meaning according to the definitions below and where the arrow is a bond to the sulfur atom of the SO₂ group;
A¹, A², A³ are the same or different and independently of one another are N (nitrogen) or the C—W moiety, but there are never more than two adjacent nitrogen atoms, and where W in the C—W moiety in each case has the same or different meanings according to the definition below,
W is in each case hydrogen, nitro, amino, cyano, thiocyanato, isothiocyanato, halogen, (C₁-C₄)-alkyl, (C₃-C₆)-cycloalkyl, (C₂-C₄)-alkenyl, (C₂-C₄)-alkynyl, aryl, aryl-(C₁-C₄)-alkyl, aryl-(C₁-C₄)-alkoxy, heteroaryl, (C₁-C₄)-alkoxy-(C₁-C₄)-alkyl, (C₁-C₄)-haloalkyl, (C₃-C₅)-halocycloalkyl, (C₁-C₄)-alkoxy, (C₁-C₄)-haloalkoxy, aryloxy, heteroaryloxy, (C₃-C₆)-cycloalkyloxy, (C₃-C₆)-cycloalkyl-(C₁-C₄)-alkoxy, (C₁-C₄)-alkoxycarbonyl, (C₁-C₄)-alkoxycarbonyl-(C₁-C₄)-alkyl, hydroxycarbonyl, aminocarbonyl, (C₁-C₄)-alkylaminocarbonyl, (C₃-C₆)-cycloalkylaminocarbonyl, cyano-(C₁-C₄)-alkylaminocarbonyl, (C₂-C₄)-alkenylaminocarbonyl, (C₂-C₄)-alkynylaminocarbonyl, (C₁-C₄)-alkylamino, (C₁-C₄)-alkylthio, (C₁-C₄)-haloalkylthio, bis-(C₁-C₄)-alkylamino, (C₃-C₆)-cycloalkylamino, (C₁-C₄)-alkylcarbonylamino, (C₃-C₆)-cycloalkylcarbonylamino, formylamino, (C₁-C₄)-haloalkylcarbonylamino, (C₁-C₄)-alkoxycarbonylamino, (C₁-C₄)-alkylaminocarbonylamino, bis-[(C₁-C₄)-alkyl]-aminocarbonyl-amino, (C₁-C₄)-alkylsulfonylamino, (C₃-C₆)-cycloalkylsulfonylamino, arylsulfonylamino, hetarylsulfonylamino, sulfonyl-(C₁-C₄)-haloalkylamino, amino-(C₁-C₄)-alkylsulfonyl, amino-(C₁-C₄)-haloalkylsulfonyl, (C₁-C₄)-alkylsulfonyl, (C₃-C₆)-cycloalkylsulfonyl, arylsulfonyl, (C₁-C₄)-alkylsulfinyl, (C₃-C₆)-cycloalkylsulfinyl, arylsulfinyl, N,S-di-(C₁-C₄)-alkylsulfonimidoyl, S—(C₁-C₄)-alkylsulfonimidoyl, (C₁-C₄)-alkylsulfonylaminocarbonyl, (C₃-C₆)-cycloalkylsulfonylaminocarbonyl, (C₃-C₆)-cycloalkylaminosulfonyl, aryl-(C₁-C₄)-alkylcarbonylamino, (C₃-C₆)-cycloalkyl-(C₁-C₄)-alkylcarbonylamino, heteroarylcarbonylamino, (C₁-C₄)-alkoxy-(C₁-C₄)-alkylcarbonylamino, hydroxy-(C₁-C₄)-alkylcarbonylamino,
R¹ is H, nitro, amino, cyano, halogen, (C₁-C₄)-alkyl, (C₃-C₆)-cycloalkyl, (C₂-C₄)-alkenyl, (C₂-C₄)-alkynyl, aryl, aryl-(C₁-C₄)-alkyl, heteroaryl, (C₁-C₄)-alkoxy-(C₁-C₄)-alkyl, (C₁-C₄)-haloalkyl, (C₃-C₆)-halocycloalkyl, (C₁-C₄)-alkoxy, (C₁-C₄)-haloalkoxy, (C₁-C₄)-alkylthio, (C₁-C₄)-haloalkylthio, (C₁-C₄)-alkoxycarbonyl, hydroxycarbonyl, aminocarbonyl, (C₁-C₄)-alkylaminocarbonyl, (C₁-C₄)-alkylamino, bis-(C₁-C₄)-alkylamino, (C₃-C₆)-cycloalkylamino, (C₁-C₄)-alkylcarbonylamino, (C₃-C₆)-cycloalkylcarbonylamino, formylamino, (C₁-C₄)-haloalkylcarbonylamino, (C₁-C₄)-alkoxycarbonylamino, [(C₁-C₄)-alkyl-]aminocarbonyl-amino, sulfonylamino, (C₁-C₄)-alkylsulfonylamino, (C₁-C₄)-haloalkylsulfonylamino, (C₃-C₆)-cycloalkylsulfonylamino, amino-(C₁-C₄)-alkylsulfonyl, amino-(C₁-C₄)-haloalkylsulfonyl, (C₁-C₄)-alkylsulfonyl, (C₃-C₆)-cycloalkylsulfonyl, arylsulfonyl, (C₁-C₄)-alkylsulfinyl, (C₃-C₆)-cycloalkylsulfinyl, arylsulfinyl, N,S-di-(C₁-C₄)-alkylsulfonimidoyl, S—(C₁-C₄)-alkylsulfonimidoyl, (C₁-C₄)-alkylsulfonylaminocarbonyl, (C₃-C₆)-cycloalkylsulfonylaminocarbonyl, (C₃-C₆)-cycloalkylaminosulfonyl, amino-(C₁-C₄)-alkyl, amino-(C₂-C₄)-alkenyl, (C₂-C₄)-alkenylamino, (C₂-C₄)-alkenylimino,
R² is H, nitro, amino, cyano, halogen, (C₁-C₄)-alkyl, (C₃-C₆)-cycloalkyl, (C₂-C₄)-alkenyl, (C₂-C₄)-alkynyl, aryl, aryl-(C₁-C₄)-alkyl, heteroaryl, (C₁-C₄)-alkoxy-(C₁-C₄)-alkyl, (C₁-C₄)-haloalkyl, (C₃-C₆)-halocycloalkyl, (C₁-C₄)-alkoxy, (C₁-C₄)-haloalkoxy, (C₁-C₄)-alkylthio, (C₁-C₄)-haloalkylthio, (C₁-C₄)-alkoxycarbonyl, hydroxycarbonyl, aminocarbonyl, (C₁-C₄)-alkylaminocarbonyl, (C₁-C₄)-alkylamino, bis-(C₁-C₄)-alkylamino, (C₃-C₆)-cycloalkylamino, (C₁-C₄)-alkylcarbonylamino, (C₃-C₆)-cycloalkylcarbonylamino, formylamino, (C₁-C₄)-haloalkylcarbonylamino, (C₁-C₄)-alkoxycarbonylamino, [(C₁-C₄)-alkyl-]-aminocarbonyl-amino, sulfonylamino, (C₁-C₄)-alkylsulfonylamino, (C₁-C₄)-haloalkylsulfonylamino, (C₃-C₆)-cycloalkylsulfonylamino, amino-(C₁-C₄)-alkylsulfonyl, amino-(C₁-C₄)-haloalkylsulfonyl, (C₁-C₄)-alkylsulfonyl, (C₃-C₆)-cycloalkylsulfonyl, arylsulfonyl, (C₁-C₄)-alkylsulfinyl, (C₃-C₆)-cycloalkylsulfinyl, arylsulfinyl, N,S-di-(C₁-C₄)-alkylsulfonimidoyl, S—(C₁-C₄)-alkylsulfonimidoyl, (C₁-C₄)-alkylsulfonylaminocarbonyl, (C₃-C₆)-cycloalkylsulfonylaminocarbonyl, (C₃-C₆)-cycloalkylaminosulfonyl, amino-(C₁-C₄)-alkyl, amino-(C₂-C₄)-alkenyl, (C₂-C₄)-alkenylamino, (C₂-C₄)-alkenylimino,
R¹ and R² with the atoms to which they are attached form a fully saturated, partially saturated or fully unsaturated, 5- to 7-membered ring optionally interrupted by heteroatoms and optionally with further substitution by W, and where, in the case of compounds of the general formula (I), they must form a corresponding ring with the moieties Q-21 and Q-23.
R¹ and A³, if A³ is a C—W group, with the atoms to which they are attached form a fully saturated, partially saturated or fully unsaturated, 5- to 7-membered ring optionally interrupted by heteroatoms and optionally with further substitution,
X is a direct bond or is a (CHR³)ₙ moiety, and where R³ in the (CHR³)ₙ moiety in each case has the same or different meanings according to the definition below,
n is 0, 1,
R³ is H, (C₁-C₄)-alkyl, (C₂-C₄)-alkenyl-(C₁-C₄)-alkyl, (C₁-C₄)-haloalkyl, (C₃-C₆)-cycloalkyl, (C₃-C₆)-cycloalkyl-(C₁-C₄)-alkyl, aryl-(C₁-C₄)-alkyl, heteroaryl-(C₁-C₄)-alkyl, (C₁-C₄)-alkoxy-(C₁-C₄)-alkyl, (C₁-C₄)-haloalkoxy-(C₁-C₄)-alkyl, (C₁-C₄)-alkylthio-(C₁-C₄)-alkyl, (C₁-C₄)-haloalkylthio-(C₁-C₄)-alkyl,
R⁴ is H, (C₁-C₄)-alkyl, (C₂-C₄)-alkenyl-(C₁-C₄)-alkyl, (C₂-C₄)-alkynyl, (C₁-C₄)-alkylcarbonyl, (C₃-C₆)-cycloalkylcarbonyl, arylcarbonyl, heteroarylcarbonyl, (C₁-C₄)-alkoxycarbonyl, aryl-(C₁-C₄)-alkoxycarbonyl, (C₃-C₆)-cycloalkoxycarbonyl, (C₃-C₆)-cycloalkyl-(C₁-C₄)-alkoxycarbonyl, (C₁-C₄)-alkylsulfonyl, (C₃-C₆)-cycloalkylsulfonyl, arylsulfonyl, (C₁-C₄)-alkoxycarbonylcarbonyl, aryl-(C₁-C₄)-alkoxycarbonylcarbonyl, (C₁-C₄)-alkylaminothiocarbonyl, (C₁-C₄)-alkylaminocarbonyl, aryl-(C₁-C₄)-alkyl, heteroaryl-(C₁-C₄)-alkyl, cyano-(C₁-C₄)-alkyl, (C₁-C₄)-haloalkyl, (C₃-C₆)-cycloalkyl, (C₃-C₆)-cycloalkyl-(C₁-C₄)-alkyl, (C₁-C₄)-alkoxy-(C₁-C₄)-alkyl, (C₁-C₄)-haloalkoxy-(C₁-C₄)-alkyl, (C₂-C₄)-alkynyl-(C₁-C₄)-alkyl, (C₁-C₄)-alkoxycarbonyl-(C₁-C₄)-alkyl, aminocarbonyl-(C₁-C₄)-alkyl, (C₁-C₄)-alkylaminocarbonyl-(C₁-C₄)-alkyl, bis-(C₁-C₄)-alkylaminocarbonyl-(C₁-C₄)-alkyl,
R⁵ is halogen, (C₂-C₄)-alkyl, (C₁-C₄)-alkoxy, (C₁-C₄)-alkoxycarbonyloxy, (C₂-C₄)-alkenyl, (C₂-C₄)-haloalkenyl, (C₂-C₄)-alkenyl-(C₁-C₄)-alkyl, (C₂-C₄)-alkynyl, (C₂-C₄)-alkynyl-(C₁-C₄)-alkyl, aryl-(C₁-C₄)-alkyl, bisaryl-(C₁-C₄)-alkyl, aryl-(C₁-C₄)-alkoxyaryl-(C₁-C₄)-alkyl, aryloxyaryl-(C₁-C₄)-alkyl, (C₁-C₄)-alkoxyaryl-(C₁-C₄)-alkyl, heteroaryl-(C₁-C₄)-alkyl, heterocyclyl-(C₁-C₄)-alkyl, N—(C₁-C₄)-alkylheterocyclyl-(C₁-C₄)-alkyl, N—[(C₁-C₄)-alkoxycarbonyl]heterocyclyl-(C₁-C₄)-alkyl, N-(aryl-(C₁-C₄)-alkoxycarbonyl)heterocyclyl-(C₁-C₄)-alkyl, N-(arylcarbonyl)heterocyclyl-(C₁-C₄)-alkyl, N—[(C₁-C₄)-alkylcarbonyl]heterocyclyl-(C₁-C₄)-alkyl, N—[(C₃-C₆)-cycloalkylcarbonyl]heterocyclyl-(C₁-C₄)-alkyl, cyano-(C₁-C₄)-alkyl, (C₁-C₄)-haloalkyl, (C₃-C₆)-cycloalkyl, (C₃-C₆)-halocycloalkyl, (C₄-C₆)-cycloalkenyl, (C₃-C₆)-cycloalkyl-(C₁-C₄)-alkyl, (C₃-C₆)-cycloalkenyl-(C₁-C₄)-alkyl, hydroxy-(C₁-C₄)-alkyl, (C₁-C₄)-alkoxy-(C₁-C₄)-alkyl, (C₁-C₄)-haloalkoxy-(C₁-C₄)-alkyl, aryloxy-(C₁-C₄)-alkyl, aryl-(C₁-C₄)-alkoxy-(C₁-C₄)-alkyl, heteroaryl-(C₁-C₄)-alkoxy-(C₁-C₄)-alkyl, (C₃-C₆)-cycloalkoxy-(C₁-C₄)-alkyl, (C₃-C₆)-cycloalkyl-(C₁-C₄)-alkoxy-(C₁-C₄)-alkyl, (C₁-C₄)-alkylcarbonyloxy-(C₁-C₄)-alkyl, arylcarbonyloxy-(C₁-C₄)-alkyl, heteroarylcarbonyloxy-(C₁-C₄)-alkyl, (C₃-C₆)-cycloalkylcarbonyloxy-(C₁-C₄)-alkyl, arylsulfonyloxy-(C₁-C₄)-alkyl, (C₁-C₄)-alkylsulfonyloxy-(C₁-C₄)-alkyl, hydrothio-(C₁-C₄)-alkyl, (C₁-C₄)-alkylthio-(C₁-C₄)-alkyl, (C₁-C₄)-haloalkylthio-(C₁-C₄)-alkyl, aryl-(C₁-C₄)-alkylthio-(C₁-C₄)-alkyl, (C₃-C₆)-cycloalkylthio-(C₁-C₄)-alkyl, arylthio-(C₁-C₄)-alkyl, (C₁-C₄)-alkylsulfinyl-(C₁-C₄)-alkyl, (C₁-C₄)-alkylsulfonyl-(C₁-C₄)-alkyl, (C₁-C₄)-haloalkylsulfinyl-(C₁-C₄)-alkyl, (C₁-C₄)-haloalkylsulfonyl-(C₁-C₄)-alkyl, aryl-(C₁-C₄)-alkylsulfinyl-(C₁-C₄)-alkyl, aryl-(C₁-C₄)-alkylsulfonyl-(C₁-C₄)-alkyl, (C₃-C₆)-cycloalkylsulfinyl-(C₁-C₄)-alkyl, (C₃-C₆)-cycloalkylsulfonyl-(C₁-C₄)-alkyl, aryl, heteroaryl, heterocyclyl, N—[(C₁-C₄)-alkyl]heterocyclyl, N—[(C₁-C₄)-alkoxycarbonyl]heterocyclyl, N—[aryl-(C₁-C₄)-alkoxycarbonyl]heterocyclyl, N-(arylcarbonyl)heterocyclyl, N—[(C₁-C₄)-alkylcarbonyl]heterocyclyl, N—[(C₁-C₄)-cycloalkylcarbonyl]heterocyclyl, hydroxycarbonyl, (C₁-C₄)-alkoxycarbonyl, (C₃-C₆)-cycloalkoxycarbonyl, (C₃-C₆)-cycloalkyl-(C₁-C₄)-alkoxycarbonyl, aryl-(C₁-C₄)-alkoxycarbonyl, heteroaryl-(C₁-C₄)-alkoxycarbonyl, (C₁-C₄)-alkylaminocarbonyl, aminocarbonyl, bis-(C₁-C₄)-alkylaminocarbonyl, (C₃-C₆)-cycloalkylaminocarbonyl, aryl-(C₁-C₄)-alkylaminocarbonyl, heteroarylaminocarbonyl, cyano-(C₁-C₄)-alkylaminocarbonyl, (C₁-C₄)-haloalkylaminocarbonyl, (C₂-C₄)-alkynyl-(C₁-C₄)-alkylaminocarbonyl, hydroxycarbonyl-(C₁-C₄)-alkyl, (C₁-C₄)-alkoxycarbonyl-(C₁-C₄)-alkyl, (C₃-C₆)-cycloalkoxycarbonyl-(C₁-C₄)-alkyl, (C₃-C₆)-cycloalkyl-(C₁-C₄)-alkoxycarbonyl-(C₁-C₄)-alkyl, aryl-(C₁-C₄)-alkoxycarbonyl-(C₁-C₄)-alkyl, heteroaryl-(C₁-C₄)-alkoxycarbonyl-(C₁-C₄)-alkyl, (C₁-C₄)-alkylaminocarbonyl-(C₁-C₄)-alkyl, aminocarbonyl-(C₁-C₄)-alkyl, bis-(C₁-C₄)-alkylaminocarbonyl-(C₁-C₄)-alkyl, (C₃-C₆)-cycloalkylaminocarbonyl-(C₁-C₄)-alkyl, aryl-(C₁-C₄)-alkylaminocarbonyl-(C₁-C₄)-alkyl, heteroarylaminocarbonyl-(C₁-C₄)-alkyl, cyano-(C₁-C₄)-alkylaminocarbonyl-(C₁-C₄)-alkyl, (C₁-C₄)-haloalkylaminocarbonyl-(C₁-C₄)-alkyl, (C₂-C₄)-alkynyl-(C₁-C₄)-alkylaminocarbonyl-(C₁-C₄)-alkyl, amino-(C₁-C₄)-alkyl, (C₁-C₄)-alkylamino-(C₁-C₄)-alkyl, (C₂-C₄)-alkenylamino-(C₁-C₄)-alkyl, arylamino-(C₁-C₄)-alkyl, bis-(C₁-C₄)-alkylamino-(C₁-C₄)-alkyl, bis-(C₃-C₆)-cycloalkylamino-(C₁-C₄)-alkyl, aryl-(C₁-C₄)-alkylamino-(C₁-C₄)-alkyl, tris-aryl-(C₁-C₄)-alkylamino-(C₁-C₄)-alkyl, (C₃-C₆)-cycloalkylamino-(C₁-C₄)-alkyl, (C₃-C₆)-cycloalkyl-(C₁-C₄)-alkylamino-(C₁-C₄)-alkyl, (C₁-C₄)-haloalkylamino-(C₁-C₄)-alkyl, (C₁-C₄)-alkylcarbonylamino-(C₁-C₄)-alkyl, (C₁-C₄)-cycloalkylcarbonylamino-(C₁-C₄)-alkyl, arylcarbonylamino-(C₁-C₄)-alkyl, heteroarylcarbonylamino-(C₁-C₄)-alkyl, (C₁-C₄)-alkoxycarbonylamino-(C₁-C₄)-alkyl, (C₂-C₄)-alkenyloxycarbonylamino-(C₁-C₄)-alkyl, aryl-(C₁-C₄)-alkoxycarbonylamino-(C₁-C₄)-alkyl, aryl-(C₁-C₄)-alkoxycarbonyl[N—(C₁-C₄)-alkyl]amino-(C₁-C₄)-alkyl, heteroaryl-(C₁-C₄)-alkoxycarbonylamino-(C₁-C₄)-alkyl, (C₃-C₆)-cycloalkyl-(C₁-C₄)-alkoxycarbonylamino-(C₁-C₄)-alkyl, (C₃-C₆)-cycloalkoxycarbonylamino-(C₁-C₄)-alkyl, aminocarbonylamino-(C₁-C₄)-alkyl, arylsulfonylamino-(C₁-C₄)-alkyl, heteroarylsulfonylamino-(C₁-C₄)-alkyl, (C₁-C₄)-alkylsulfonylamino-(C₁-C₄)-alkyl, (C₃-C₆)-cycloalkylsulfonylamino-(C₁-C₄)-alkyl, aminoiminoamino-(C₁-C₄)-alkyl, arylsulfonylaminoiminoamino-(C₁-C₄)-alkyl, (C₁-C₄)-alkylaminoiminoamino-(C₁-C₄)-alkyl,
R⁷ is hydrogen, halogen, (C₁-C₄)-alkyl, (C₁-C₄)-alkoxy, (C₁-C₄)-alkoxycarbonyloxy, (C₂-C₄)-alkenyl, (C₂-C₄)-haloalkenyl, (C₂-C₄)-alkenyl-(C₁-C₄)-alkyl, (C₂-C₄)-alkynyl, (C₂-C₄)-alkynyl-(C₁-C₄)-alkyl, aryl-(C₁-C₄)-alkyl, bisaryl-(C₁-C₄)-alkyl, aryl-(C₁-C₄)-alkoxyaryl-(C₁-C₄)-alkyl, aryloxyaryl-(C₁-C₄)-alkyl, (C₁-C₄)-alkoxyaryl-(C₁-C₄)-alkyl, heteroaryl-(C₁-C₄)-alkyl, heterocyclyl-(C₁-C₄)-alkyl, N—(C₁-C₄)-alkyl heterocyclyl-(C₁-C₄)-alkyl, N—[(C₁-C₄)-alkoxycarbonyl]heterocyclyl-(C₁-C₄)-alkyl, N-(aryl-(C₁-C₄)-alkoxycarbonyl)heterocyclyl-(C₁-C₄)-alkyl, N-(arylcarbonyl)heterocyclyl-(C₁-C₄)-alkyl, N—[(C₁-C₄)-alkylcarbonyl]heterocyclyl-(C₁-C₄)-alkyl, N—[(C₃-C₆)-cycloalkylcarbonyl]heterocyclyl-(C₁-C₄)-alkyl, cyano-(C₁-C₄)-alkyl, (C₁-C₄)-haloalkyl, (C₃-C₆)-cycloalkyl, (C₃-C₆)-halocycloalkyl, (C₄-C₆)-cycloalkenyl, (C₃-C₆)-cycloalkyl-(C₁-C₄)-alkyl, (C₃-C₆)-cycloalkenyl-(C₁-C₄)-alkyl, hydroxy-(C₁-C₄)-alkyl, (C₁-C₄)-alkoxy-(C₁-C₄)-alkyl, (C₁-C₄)-haloalkoxy-(C₁-C₄)-alkyl, aryloxy-(C₁-C₄)-alkyl, aryl-(C₁-C₄)-alkoxy-(C₁-C₄)-alkyl, heteroaryl-(C₁-C₄)-alkoxy-(C₁-C₄)-alkyl, (C₃-C₆)-cycloalkoxy-(C₁-C₄)-alkyl, (C₃-C₆)-cycloalkyl-(C₁-C₄)-alkoxy-(C₁-C₄)-alkyl, (C₁-C₄)-alkylcarbonyloxy-(C₁-C₄)-alkyl, arylcarbonyloxy-(C₁-C₄)-alkyl, heteroarylcarbonyloxy-(C₁-C₄)-alkyl, (C₃-C₆)-cycloalkylcarbonyloxy-(C₁-C₄)-alkyl, arylsulfonyloxy-(C₁-C₄)-alkyl, (C₁-C₄)-alkylsulfonyloxy-(C₁-C₄)-alkyl, hydrothio-(C₁-C₄)-alkyl, (C₁-C₄)-alkylthio-(C₁-C₄)-alkyl, (C₁-C₄)-haloalkylthio-(C₁-C₄)-alkyl, aryl-(C₁-C₄)-alkylthio-(C₁-C₄)-alkyl, (C₃-C₆)-cycloalkylthio-(C₁-C₄)-alkyl, arylthio-(C₁-C₄)-alkyl, (C₁-C₄)-alkylsulfinyl-(C₁-C₄)-alkyl, (C₁-C₄)-alkylsulfonyl-(C₁-C₄)-alkyl, (C₁-C₄)-haloalkylsulfinyl-(C₁-C₄)-alkyl, (C₁-C₄)-haloalkylsulfonyl-(C₁-C₄)-alkyl, aryl-(C₁-C₄)-alkylsulfinyl-(C₁-C₄)-alkyl, aryl-(C₁-C₄)-alkylsulfonyl-(C₁-C₄)-alkyl, (C₃-C₆)-cycloalkylsulfinyl-(C₁-C₄)-alkyl, (C₃-C₆)-cycloalkylsulfonyl-(C₁-C₄)-alkyl, aryl, heteroaryl, heterocyclyl, N—[(C₁-C₄)-alkyl]heterocyclyl, N—[(C₁-C₄)-alkoxycarbonyl]heterocyclyl, N—[aryl-(C₁-C₄)-alkoxycarbonyl]heterocyclyl, N-(arylcarbonyl)heterocyclyl, N—[(C₁-C₄)-alkylcarbonyl]heterocyclyl, N—[(C₁-C₄)—cycloalkylcarbonyl]heterocyclyl, hydroxycarbonyl, (C₁-C₄)-alkoxycarbonyl, (C₃-C₆)-cycloalkoxycarbonyl, (C₃-C₆)-cycloalkyl-(C₁-C₄)-alkoxycarbonyl, aryl-(C₁-C₄)-alkoxycarbonyl, heteroaryl-(C₁-C₄)-alkoxycarbonyl, (C₁-C₄)-alkylaminocarbonyl, aminocarbonyl, bis-(C₁-C₄)-alkylaminocarbonyl, (C₃-C₆)-cycloalkylaminocarbonyl, aryl-(C₁-C₄)-alkylaminocarbonyl, heteroarylaminocarbonyl, cyano-(C₁-C₄)-alkylaminocarbonyl, (C₁-C₄)-haloalkylaminocarbonyl, (C₂-C₄)-alkynyl-(C₁-C₄)-alkylaminocarbonyl, hydroxycarbonyl-(C₁-C₄)-alkyl, (C₁-C₄)-alkoxycarbonyl-(C₁-C₄)-alkyl, (C₃-C₆)-cycloalkoxycarbonyl-(C₁-C₄)-alkyl, (C₃-C₆)-cycloalkyl-(C₁-C₄)-alkoxycarbonyl-(C₁-C₄)-alkyl, aryl-(C₁-C₄)-alkoxycarbonyl-(C₁-C₄)-alkyl, heteroaryl-(C₁-C₄)-alkoxycarbonyl-(C₁-C₄)-alkyl, (C₁-C₄)-alkylaminocarbonyl-(C₁-C₄)-alkyl, aminocarbonyl-(C₁-C₄)-alkyl, bis-(C₁-C₄)-alkylaminocarbonyl-(C₁-C₄)-alkyl, (C₃-C₆)-cycloalkylaminocarbonyl-(C₁-C₄)-alkyl, aryl-(C₁-C₄)-alkylaminocarbonyl-(C₁-C₄)-alkyl, heteroarylaminocarbonyl-(C₁-C₄)-alkyl, cyano-(C₁-C₄)-alkylaminocarbonyl-(C₁-C₄)-alkyl, (C₁-C₄)-haloalkylaminocarbonyl-(C₁-C₄)-alkyl, (C₂-C₄)-alkynyl-(C₁-C₄)-alkylaminocarbonyl-(C₁-C₄)-alkyl, amino-(C₁-C₄)-alkyl, (C₁-C₄)-alkylamino-(C₁-C₄)-alkyl, (C₂-C₄)-alkenylamino-(C₁-C₄)-alkyl, arylamino-(C₁-C₄)-alkyl, bis-(C₁-C₄)-alkylamino-(C₁-C₄)-alkyl, bis-(C₃-C₆)-cycloalkylamino-(C₁-C₄)-alkyl, aryl-(C₁-C₄)-alkylamino-(C₁-C₄)-alkyl, tris-aryl-(C₁-C₄)-alkylamino-(C₁-C₄)-alkyl, (C₃-C₆)-cycloalkylamino-(C₁-C₄)-alkyl, (C₃-C₆)-cycloalkyl-(C₁-C₄)-alkylamino-(C₁-C₄)-alkyl, (C₁-C₄)-haloalkylamino-(C₁-C₄)-alkyl, (C₁-C₄)-alkylcarbonylamino-(C₁-C₄)-alkyl, (C₁-C₄)-cycloalkylcarbonylamino-(C₁-C₄)-alkyl, arylcarbonylamino-(C₁-C₄)-alkyl, heteroarylcarbonylamino-(C₁-C₄)-alkyl, (C₁-C₄)-alkoxycarbonylamino-(C₁-C₄)-alkyl, (C₂-C₄)-alkenyloxycarbonylamino-(C₁-C₄)-alkyl, aryl-(C₁-C₄)-alkoxycarbonylamino-(C₁-C₄)-alkyl, aryl-(C₁-C₄)-alkoxycarbonyl[N—(C₁-C₄)-alkyl]amino-(C₁-C₄)-alkyl, heteroaryl-(C₁-C₄)-alkoxycarbonylamino-(C₁-C₄)-alkyl, (C₃-C₆)-cycloalkyl-(C₁-C₄)-alkoxycarbonylamino-(C₁-C₄)-alkyl, (C₃-C₆)-cycloalkoxycarbonylamino-(C₁-C₄)-alkyl, aminocarbonylamino-(C₁-C₄)-alkyl, arylsulfonylamino-(C₁-C₄)-alkyl, heteroarylsulfonylamino-(C₁-C₄)-alkyl, (C₁-C₄)-alkylsulfonylamino-(C₁-C₄)-alkyl, (C₃-C₆)-cycloalkylsulfonylamino-(C₁-C₄)-alkyl, aminoiminoamino-(C₁-C₄)-alkyl, arylsulfonylaminoiminoamino-(C₁-C₄)-alkyl, (C₁-C₄)-alkylaminoiminoamino-(C₁-C₄)-alkyl,
R⁶ and R⁸ independently of one another are H, (C₁-C₄)-alkyl, (C₂-C₄)-alkenyl-(C₁-C₄)-alkyl, (C₂-C₄)-alkynyl-(C₁-C₄)-alkyl, aryl-(C₁-C₄)-alkyl, (C₃-C₆)-cycloalkyl, (C₃-C₆)-cycloalkyl-(C₁-C₄)-alkyl, heterocyclyl, heterocyclyl-(C₁-C₄)-alkyl, amino-(C₁-C₄)-alkyl, (C₁-C₄)-alkoxy-(C₁-C₄)-alkyl, (C₁-C₄)-alkylthio-(C₁-C₄)-alkyl, (C₁-C₄)-haloalkyl, (C₁-C₄)-alkylamino-(C₁-C₄)-alkyl, bis-(C₁-C₄)-alkylamino-(C₁-C₄)-alkyl, (C₁-C₄)-alkylcarbonylamino-(C₁-C₄)-alkyl, (C₃-C₆)-cycloalkylcarbonylamino-(C₁-C₄)-alkyl, arylcarbonylamino-(C₁-C₄)-alkyl, (C₁-C₄)-alkoxycarbonylamino-(C₁-C₆)-alkyl, aryl-(C₁-C₄)-alkoxycarbonylamino-(C₁-C₄)-alkyl, (C₃-C₆)-cycloalkyl-(C₁-C₄)-alkoxycarbonylamino-(C₁-C₄)-alkyl, aminocarbonylamino-(C₁-C₄)-alkyl, aminoiminoamino-(C₁-C₄)-alkyl, arylsulfonylaminoiminoamino-(C₁-C₄)-alkyl, (C₁-C₄)-alkylaminoiminoamino-(C₁-C₄)-alkyl,
R⁴¹ is H, (C₁-C₄)-alkyl, (C₂-C₄)-alkenyl-(C₁-C₄)-alkyl, (C₂-C₄)-alkynyl, (C₁-C₄)-alkylcarbonyl, (C₃-C₆)-cycloalkylcarbonyl, arylcarbonyl, heteroarylcarbonyl, (C₁-C₄)-alkoxycarbonyl, aryl-(C₁-C₄)-alkoxycarbonyl, (C₃-C₆)-cycloalkoxycarbonyl, (C₃-C₆)-cycloalkyl-(C₁-C₄)-alkoxycarbonyl, (C₁-C₄)-alkylsulfonyl, (C₃-C₆)-cycloalkylsulfonyl, arylsulfonyl, (C₁-C₄)-alkoxycarbonylcarbonyl, aryl-(C₁-C₄)-alkoxycarbonylcarbonyl, (C₁-C₄)-alkylaminothiocarbonyl, (C₁-C₄)-alkylaminocarbonyl, aryl-(C₁-C₄)-alkyl, heteroaryl-(C₁-C₄)-alkyl, cyano-(C₁-C₄)-alkyl, (C₁-C₄)-haloalkyl, (C₃-C₆)-cycloalkyl, (C₃-C₆)-cycloalkyl-(C₁-C₄)-alkyl, (C₁-C₄)-alkoxy-(C₁-C₄)-alkyl, (C₁-C₄)-haloalkoxy-(C₁-C₄)-alkyl, (C₂-C₄)-alkynyl-(C₁-C₄)-alkyl, (C₁-C₄)-alkoxycarbonyl-(C₁-C₄)-alkyl, aminocarbonyl-(C₁-C₄)-alkyl, (C₁-C₄)-alkylaminocarbonyl-(C₁-C₄)-alkyl, bis-(C₁-C₄)-alkylaminocarbonyl-(C₁-C₄)-alkyl,
   in the case of the grouping Q-21 is exclusively H or methyl,
R⁴² is (C₂-C₄)-alkyl, (C₂-C₄)-alkenyl-(C₁-C₄)-alkyl, (C₂-C₄)-alkynyl, (C₁-C₄)-alkylcarbonyl, (C₃-C₆)-cycloalkylcarbonyl, arylcarbonyl, heteroarylcarbonyl, (C₁-C₄)-alkoxycarbonyl, aryl-(C₁-C₄)-alkoxycarbonyl, (C₃-C₆)-cycloalkoxycarbonyl, (C₃-C₆)-cycloalkyl-(C₁-C₄)-alkoxycarbonyl, (C₁-C₄)-alkylsulfonyl, (C₃-C₆)-cycloalkylsulfonyl, arylsulfonyl, (C₁-C₄)-alkoxycarbonylcarbonyl, aryl-(C₁-C₄)-alkoxycarbonylcarbonyl, (C₁-C₄)-alkylaminothiocarbonyl, (C₁-C₄)-alkylaminocarbonyl, aryl-(C₁-C₄)-alkyl, heteroaryl-(C₁-C₄)-alkyl, cyano-(C₁-C₄)-alkyl, (C₁-C₄)-haloalkyl, (C₃-C₆)-cycloalkyl, (C₃-C₆)-cycloalkyl-(C₁-C₄)-alkyl, (C₁-C₄)-alkoxy-(C₁-C₄)-alkyl, (C₁-C₄)-haloalkoxy-(C₁-C₄)-alkyl, (C₂-C₄)-alkynyl-(C₁-C₄)-alkyl, (C₁-C₄)-alkoxycarbonyl-(C₁-C₄)-alkyl, aminocarbonyl-(C₁-C₄)-alkyl, (C₁-C₄)-alkylaminocarbonyl-(C₁-C₄)-alkyl, bis-(C₁-C₄)-alkylaminocarbonyl-(C₁-C₄)-alkyl,
R⁴³ is H or methyl,
R⁴⁴ is hydrogen, (C₁-C₄)-alkyl, (C₂-C₄)-alkenyl-(C₁-C₄)-alkyl, (C₂-C₄)-alkynyl, (C₁-C₄)-alkylcarbonyl, (C₃-C₆)-cycloalkylcarbonyl, arylcarbonyl, heteroarylcarbonyl, (C₁-C₄)-alkoxycarbonyl, aryl-(C₁-C₄)-alkoxycarbonyl, (C₃-C₆)-cycloalkoxycarbonyl, (C₃-C₆)-cycloalkyl-(C₁-C₄)-alkoxycarbonyl, (C₁-C₄)-alkylsulfonyl, (C₃-C₆)-cycloalkylsulfonyl, arylsulfonyl, (C₁-C₄)-alkoxycarbonylcarbonyl, aryl-(C₁-C₄)-alkoxycarbonylcarbonyl, (C₁-C₄)-alkylaminothiocarbonyl, (C₁-C₄)-alkylaminocarbonyl, aryl-(C₁-C₄)-alkyl, heteroaryl-(C₁-C₄)-alkyl, cyano-(C₁-C₄)-alkyl, (C₁-C₄)-haloalkyl, (C₃-C₆)-cycloalkyl, (C₃-C₆)-cycloalkyl-(C₁-C₄)-alkyl, (C₁-C₄)-alkoxy-(C₁-C₄)-alkyl, (C₁-C₄)-haloalkoxy-(C₁-C₄)-alkyl, (C₂-C₄)-alkynyl-(C₁-C₄)-alkyl, (C₁-C₄)-alkoxycarbonyl-(C₁-C₄)-alkyl, aminocarbonyl-(C₁-C₄)-alkyl, (C₁-C₄)-alkylaminocarbonyl-(C₁-C₄)-alkyl, bis-(C₁-C₄)-alkylaminocarbonyl-(C₁-C₄)-alkyl,
R⁵¹ and R⁷¹ independently of one another are hydrogen and methyl,
R⁵³ is methyl,
R⁶¹ and R⁸¹ independently of one another are hydrogen and methyl,
R⁶³ is H, methyl,
R⁵⁴, R⁶⁴, R⁷⁴, R⁸⁴ independently of one another are hydrogen, methyl, where at least one of the groups R⁵⁴, R⁶⁴, R⁷⁴, R⁸⁴ must be methyl,
V is hydroxycarbonyl, (C₁-C₄)-alkoxycarbonyl, (C₃-C₆)-cycloalkoxycarbonyl, (C₃-C₆)-cycloalkyl-(C₁-C₄)-alkoxycarbonyl, aryloxycarbonyl, aryl-(C₁-C₄)-alkoxycarbonyl, aminocarbonyl, (C₁-C₄)-alkylaminocarbonyl, bis-(C₁-C₄)-alkylaminocarbonyl, (C₁-C₄)-alkyl-[(C₁-C₄)-alkoxy]aminocarbonyl, (C₃-C₆)-cycloalkylaminocarbonyl, aryl-(C₁-C₄)-alkylaminocarbonyl, heteroaryl-(C₁-C₄)-alkylaminocarbonyl, cyano-(C₁-C₄)-alkylaminocarbonyl, (C₁-C₄)-haloalkylaminocarbonyl, (C₂-C₄)-alkynyl-(C₁-C₄)-alkylaminocarbonyl, (C₁-C₄)-alkoxycarbonyl-(C₁-C₄)-alkylaminocarbonyl, hydroxycarbonyl-(C₁-C₄)-alkylaminocarbonyl, aminocarbonyl-(C₁-C₄)-alkylaminocarbonyl, (C₁-C₄)-alkylaminocarbonyl-(C₁-C₄)-alkylaminocarbonyl, (C₃-C₆)-cycloalkylaminocarbonyl-(C₁-C₄)-alkylaminocarbonyl, (C₃-C₆)-cycloalkyl-(C₁-C₄)-alkylaminocarbonyl,
m is 0, 1, 2, 3, 4, 5,
p is 1, 2, 3, 4,
Y is cyano, cyano-(C₁-C₄)-alkyl, hydroxy-(C₁-C₄)-alkyl, (C₁-C₄)-alkoxy-(C₁-C₄)-alkyl, hydroxycarbonyl, (C₁-C₄)-alkoxycarbonyl, (C₃-C₆)-cycloalkoxycarbonyl, (C₃-C₆)-cycloalkyl-(C₁-C₄)-alkoxycarbonyl, aryloxycarbonyl, aryl-(C₁-C₄)-alkoxycarbonyl, aminocarbonyl, (C₁-C₄)-alkylaminocarbonyl, bis-(C₁-C₄)-alkylaminocarbonyl, (C₁-C₄)-alkyl[(C₁-C₄)-alkoxy]aminocarbonyl, (C₃-C₆)-cycloalkylaminocarbonyl, aryl-(C₁-C₄)-alkylaminocarbonyl, heteroaryl-(C₁-C₄)-alkylaminocarbonyl, cyano-(C₁-C₄)-alkylaminocarbonyl, (C₁-C₄)-haloalkylaminocarbonyl, (C₂-C₄)-alkynyl-(C₁-C₄)-alkylaminocarbonyl, (C₁-C₄)-alkoxycarbonylaminocarbonyl, aryl-(C₁-C₄)-alkoxycarbonylaminocarbonyl, hydroxycarbonyl-(C₁-C₄)-alkyl, (C₁-C₄)-alkoxycarbonyl-(C₁-C₄)-alkyl, (C₃-C₆)-cycloalkoxycarbonyl-(C₁-C₄)-alkyl, (C₃-C₆)-cycloalkyl-(C₁-C₄)-alkoxycarbonyl-(C₁-C₄)-alkyl, (C₁-C₄)-alkylaminocarbonyl-(C₁-C₄)-alkyl, aminocarbonyl-(C₁-C₄)-alkyl, bis-(C₁-C₄)-alkylaminocarbonyl-(C₁-C₄)-alkyl, (C₃-C₆)-cycloalkylaminocarbonyl-(C₁-C₄)-alkyl, aryl-(C₁-C₄)-alkylaminocarbonyl-(C₁-C₄)-alkyl, heteroaryl-(C₁-C₄)-alkylaminocarbonyl-(C₁-C₄)-alkyl, cyano-(C₁-C₄)-alkylaminocarbonyl-(C₁-C₄)-alkyl, (C₁-C₄)-haloalkylaminocarbonyl-(C₁-C₄)-alkyl, (C₂-C₄)-alkynyl-(C₁-C₄)-alkylaminocarbonyl-(C₁-C₄)-alkyl, (C₃-C₆)-cycloalkyl-(C₁-C₄)-alkylaminocarbonyl-(C₁-C₄)-alkyl, (C₁-C₄)-alkoxycarbonylaminocarbonyl-(C₁-C₄)-alkyl, aryl-(C₁-C₄)-alkoxycarbonylaminocarbonyl-(C₁-C₄)-alkyl, (C₁-C₄)-alkoxycarbonyl-(C₁-C₄)-alkylaminocarbonyl, hydroxycarbonyl-(C₁-C₄)-alkylaminocarbonyl, aminocarbonyl-(C₁-C₄)-alkylaminocarbonyl, (C₁-C₄)-alkylaminocarbonyl-(C₁-C₄)-alkylaminocarbonyl, (C₃-C₆)-cycloalkylaminocarbonyl-(C₁-C₄)-alkylaminocarbonyl, (C₃-C₆)-cycloalkyl-(C₁-C₄)-alkylaminocarbonyl, (C₃-C₆)-cycloalkyl-(C₁-C₄)-alkylaminocarbonyl-(C₁-C₄)-alkyl, (C₂-C₄)-alkenyloxycarbonyl, (C₂-C₄)-alkenyloxycarbonyl-(C₁-C₄)-alkyl, (C₂-C₄)-alkenylaminocarbonyl, (C₂-C₄)-alkenyl-(C₁-C₄)-alkylaminocarbonyl, (C₂-C₄)-alkenylaminocarbonyl-(C₁-C₄)-alkyl, (C₂-C₄)-alkenyl-(C₁-C₄)-alkylaminocarbonyl-(C₁-C₄)-alkyl.
   and Q is furthermore one of the Q-1.1 to Q-24.15 moieties specifically listed in the table below

| | |
|---|---|
| 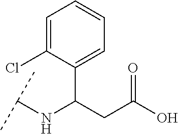 | Q-1.1 |
| 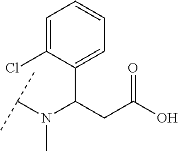 | Q-1.2 |
| 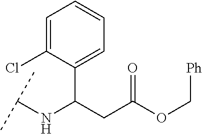 | Q-1.3 |
| 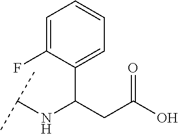 | Q-1.4 |
| 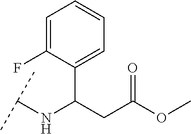 | Q-1.5 |
| 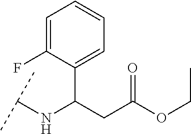 | Q-1.6 |
| 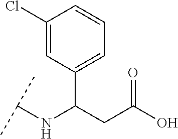 | Q-1.7 |
| 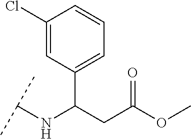 | Q-1.8 |
| 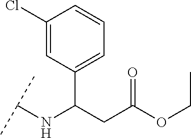 | Q-1.9 |
| 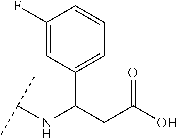 | Q-1.10 |
| 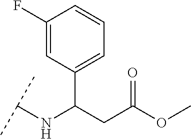 | Q-1.11 |
| 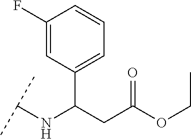 | Q-1.12 |
| 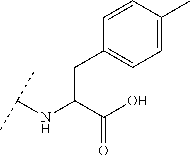 | Q-1.13 |
| 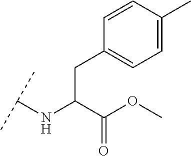 | Q-1.14 |
| 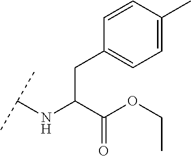 | Q-1.15 |
| 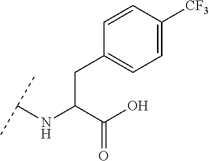 | Q-1.16 |
| 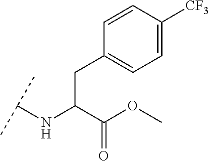 | Q-1.17 |
| 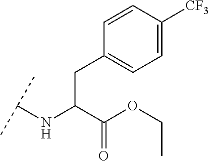 | Q-1.18 |
| 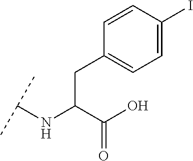 | Q-1.19 |
| 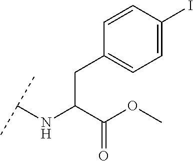 | Q-1.20 |
| 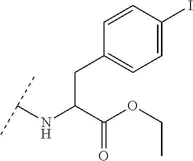 | Q-1.21 |
| 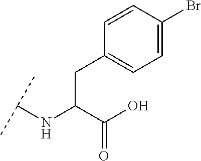 | Q-1.22 |
| 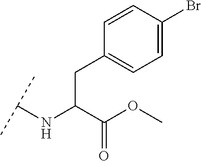 | Q-1.23 |
| 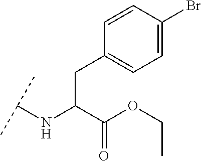 | Q-1.24 |
| 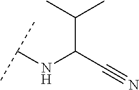 | Q-1.25 |
| 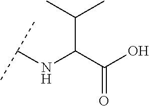 | Q-1.26 |
| 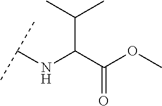 | Q-1.27 |
| 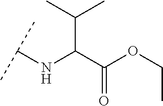 | Q-1.28 |
| 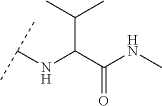 | Q-1.29 |
| 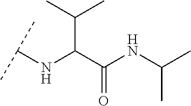 | Q-1.30 |
| 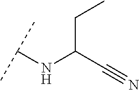 | Q-1.31 |
| 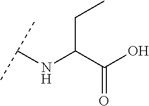 | Q-1.32 |
| 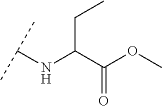 | Q-1.33 |
| 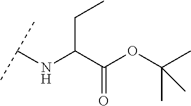 | Q-1.34 |
| 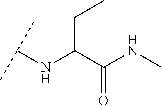 | Q-1.35 |
| 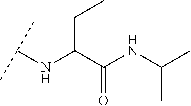 | Q-1.36 |
| 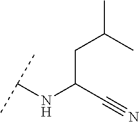 | Q-1.37 |
| 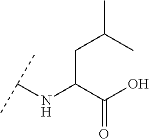 | Q-1.38 |
| 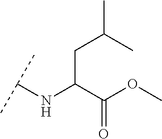 | Q-1.39 |
| 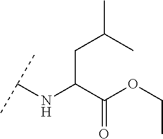 | Q-1.40 |
| 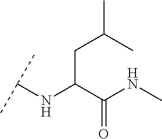 | Q-1.41 |
| 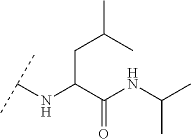 | Q-1.42 |
| 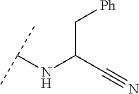 | Q-1.43 |
| 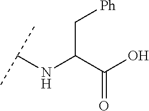 | Q-1.44 |
| 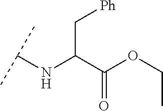 | Q-1.45 |
| 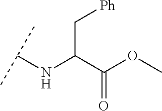 | Q-1.46 |
| 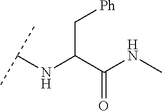 | Q-1.47 |
| 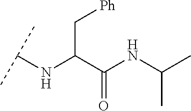 | Q-1.48 |
| 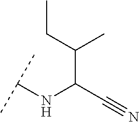 | Q-1.49 |
| 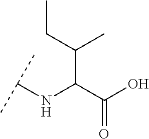 | Q-1.50 |
| 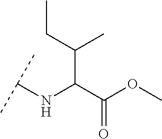 | Q-1.51 |
| 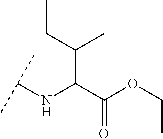 | Q-1.52 |
| 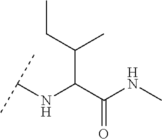 | Q-1.53 |
| 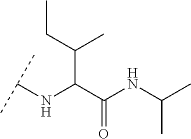 | Q-1.54 |
| 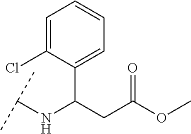 | Q-1.55 |
| 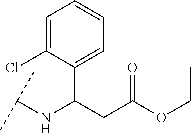 | Q-1.56 |
| 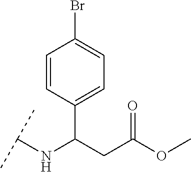 | Q-1.57 |
| 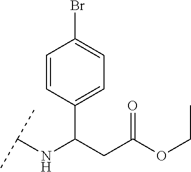 | Q-1.58 |
| 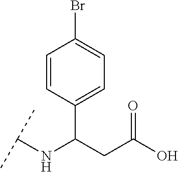 | Q-1.59 |
| 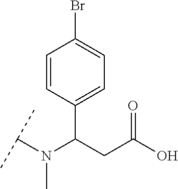 | Q-1.60 |
| 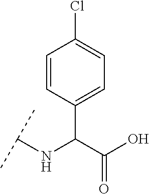 | Q-1.61 |
| 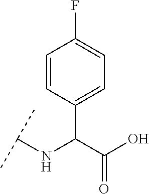 | Q-1.62 |
| 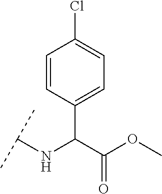 | Q-1.63 |
| 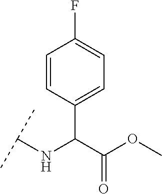 | Q-1.64 |
| 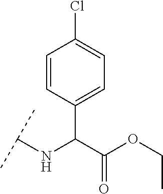 | Q-1.65 |
| 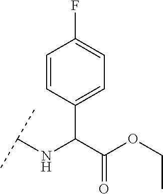 | Q-1.66 |
| 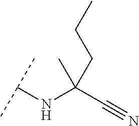 | Q-1.67 |
| 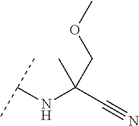 | Q-1.68 |
| 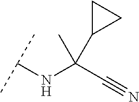 | Q-1.69 |
| 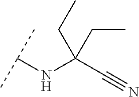 | Q-1.70 |
| 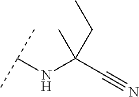 | Q-1.71 |
| 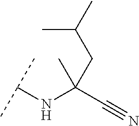 | Q-1.72 |
| 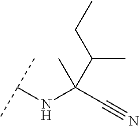 | Q-1.73 |
| 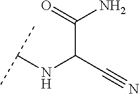 | Q-1.74 |
| 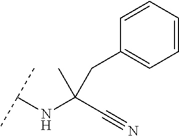 | Q-1.75 |
| 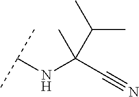 | Q-1.76 |
| 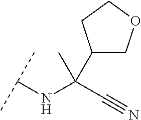 | Q-1.77 |
| 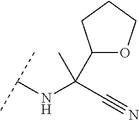 | Q-1.78 |
| 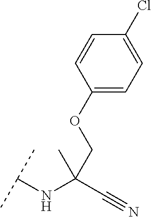 | Q-1.79 |
| 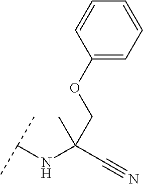 | Q-1.80 |
| 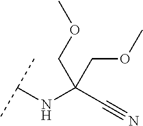 | Q-1.81 |
| 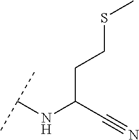 | Q-1.82 |
| 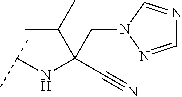 | Q-1.83 |
| 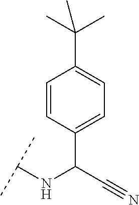 | Q-1.84 |
| 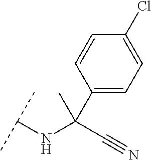 | Q-1.85 |
| 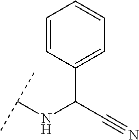 | Q-1.86 |
| 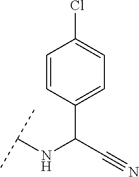 | Q-1.87 |
| 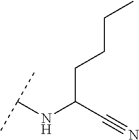 | Q-1.88 |
| 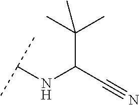 | Q-1.89 |
| 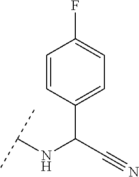 | Q-1.90 |
| 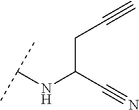 | Q-1.91 |
| 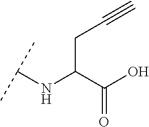 | Q-1.92 |
| 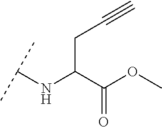 | Q-1.93 |
| 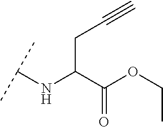 | Q-1.94 |
| 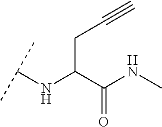 | Q-1.95 |
| 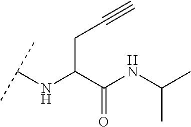 | Q-1.96 |
| 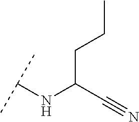 | Q-1.97 |
| 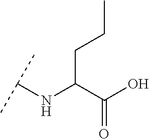 | Q-1.98 |
| 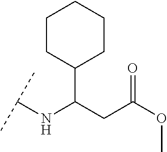 | Q-1.99 |
| 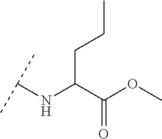 | Q-1.100 |
| 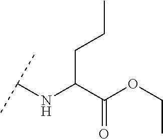 | Q-1.101 |
| 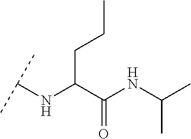 | Q-1.102 |
| 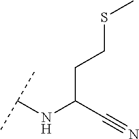 | Q-1.103 |
| 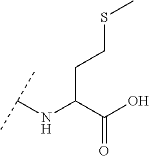 | Q-1.104 |
| 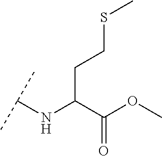 | Q-1.105 |
| 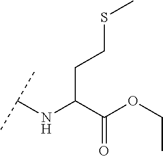 | Q-1.106 |
| 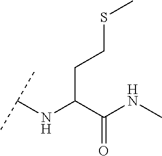 | Q-1.107 |
| 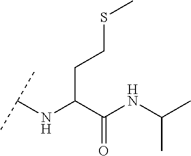 | Q-1.108 |
| 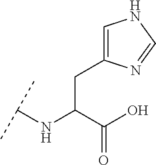 | Q-1.109 |
| 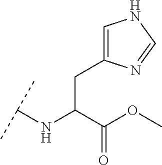 | Q-1.110 |
| 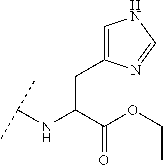 | Q-1.111 |
| 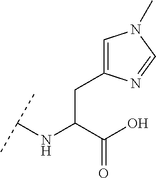 | Q-1.112 |
| 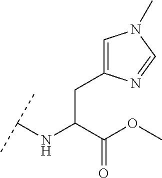 | Q-1.113 |
| 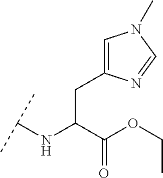 | Q-1.114 |
| 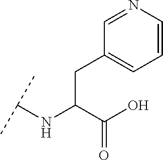 | Q-1.115 |
| 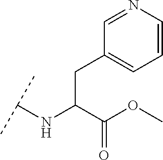 | Q-1.116 |
| 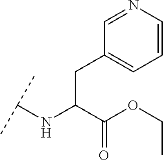 | Q-1.117 |
| 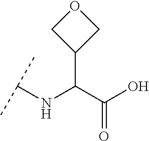 | Q-1.118 |
| 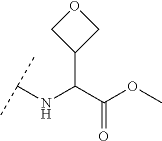 | Q-1.119 |
| 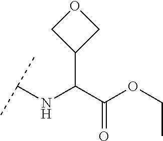 | Q-1.120 |
| 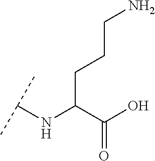 | Q-1.121 |
| 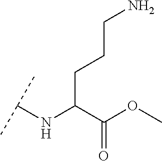 | Q-1.122 |
| 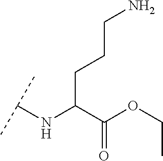 | Q-1.123 |
| 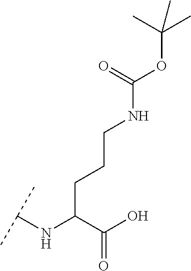 | Q-1.124 |
| 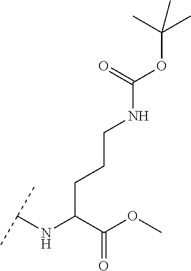 | Q-1.125 |
| 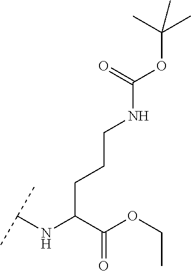 | Q-1.126 |
| 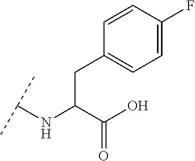 | Q-1.127 |
| 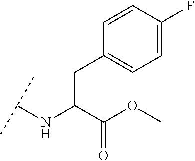 | Q-1.128 |
| 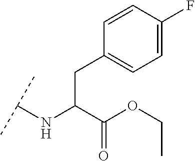 | Q-1.129 |
| 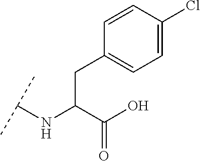 | Q-1.130 |
| 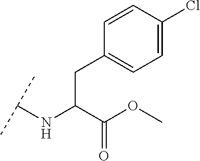 | Q-1.131 |
| 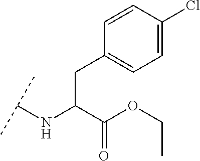 | Q-1.132 |
| 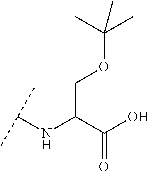 | Q-1.133 |
| 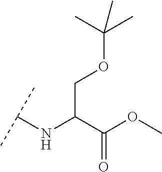 | Q-1.134 |
| 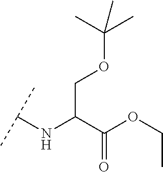 | Q-1.135 |
| 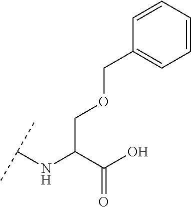 | Q-1.136 |
| 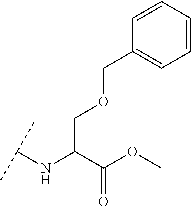 | Q-1.137 |
| 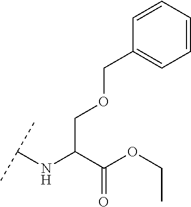 | Q-1.138 |
| 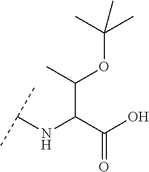 | Q-1.139 |
| 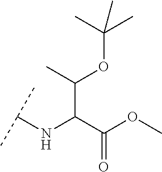 | Q-1.140 |
| 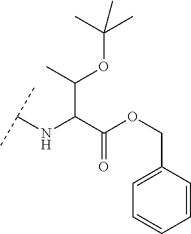 | Q-1.141 |
| 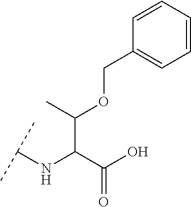 | Q-1.142 |
| 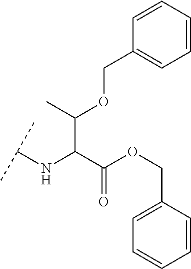 | Q-1.143 |
| 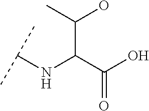 | Q-1.144 |
| 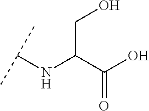 | Q-1.145 |
| 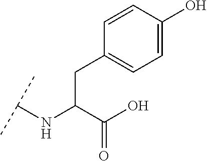 | Q-1.146 |
| 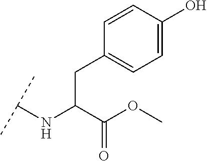 | Q-1.147 |
| 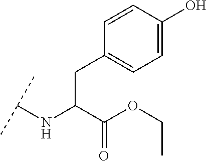 | Q-1.148 |
| 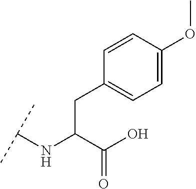 | Q-1.149 |
| 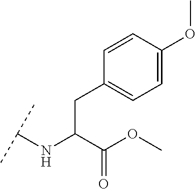 | Q-1.150 |
| 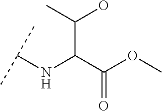 | Q-1.151 |
| 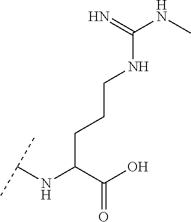 | Q-1.152 |
| 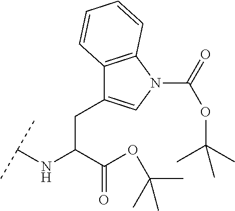 | Q-1.153 |
| 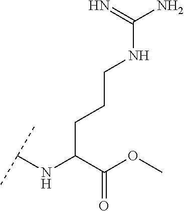 | Q-1.154 |
| 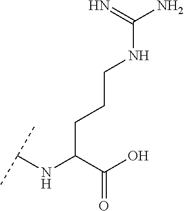 | Q-1.155 |
| 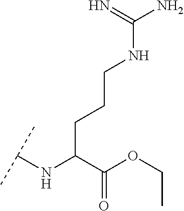 | Q-1.156 |
| 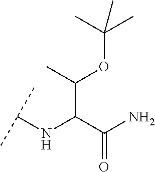 | Q-1.157 |
| 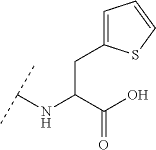 | Q-1.158 |
| 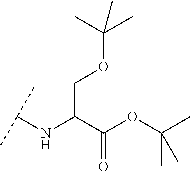 | Q-1.159 |
| 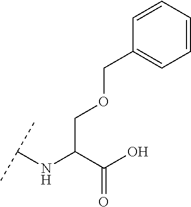 | Q-1.160 |
| 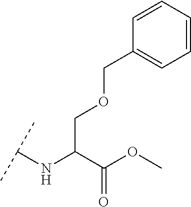 | Q-1.161 |
| 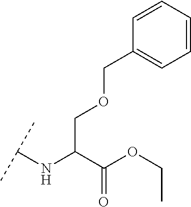 | Q-1.162 |
| 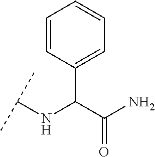 | Q-1.163 |
| 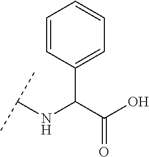 | Q-1.164 |
| 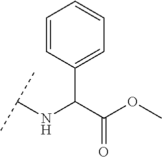 | Q-1.165 |
| 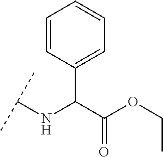 | Q-1.166 |
| 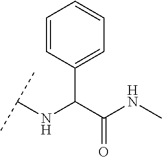 | Q-1.167 |
| 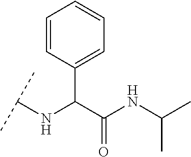 | Q-1.168 |
| 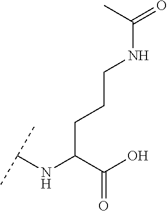 | Q-1.169 |
| 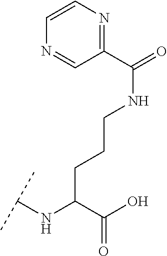 | Q-1.170 |
| 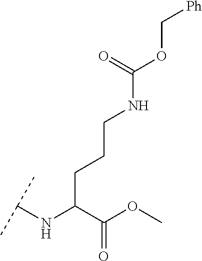 | Q-1.171 |
| 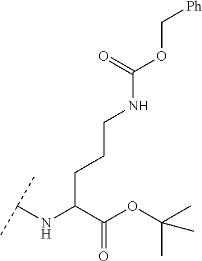 | Q-1.172 |
| 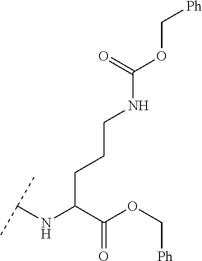 | Q-1.173 |
| 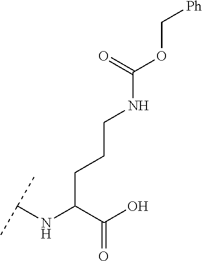 | Q-1.174 |
| 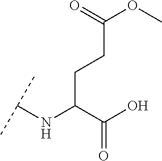 | Q-1.175 |
| 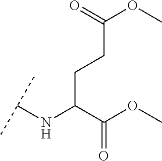 | Q-1.176 |
| 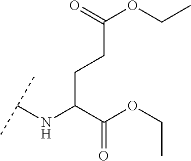 | Q-1.177 |
| 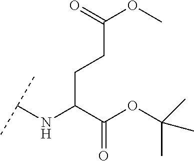 | Q-1.178 |
| 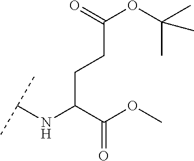 | Q-1.179 |
| 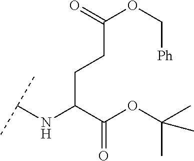 | Q-1.180 |
| 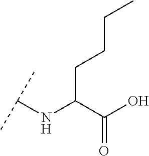 | Q-1.181 |
| 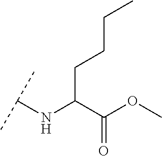 | Q-1.182 |
| 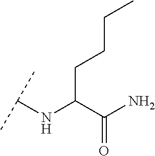 | Q-1.183 |
| 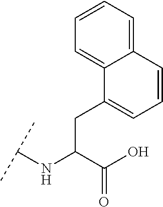 | Q-1.184 |
| 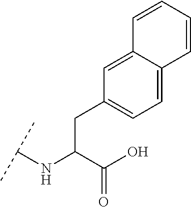 | Q-1.185 |
| 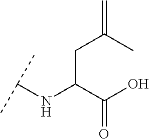 | Q-1.186 |
| 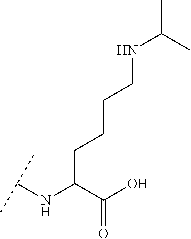 | Q-1.187 |
| 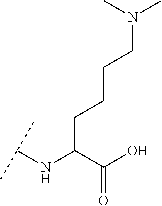 | Q-1.188 |
| 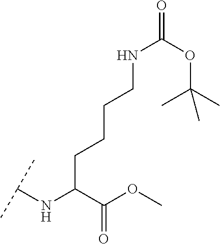 | Q-1.189 |
| 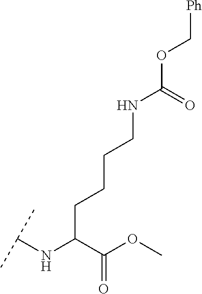 | Q-1.190 |
| 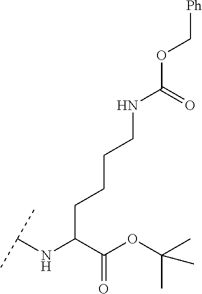 | Q-1.191 |
| 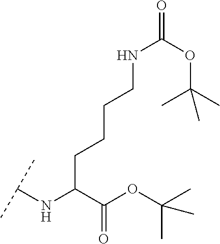 | Q-1.192 |
| 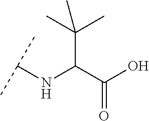 | Q-1.193 |
| 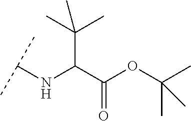 | Q-1.194 |
| 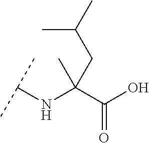 | Q-1.195 |
| 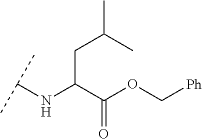 | Q-1.196 |
| 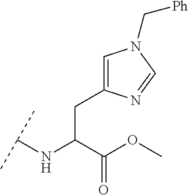 | Q-1.197 |
| 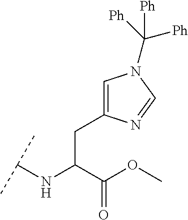 | Q-1.198 |
| 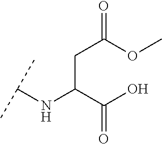 | Q-1.199 |
| 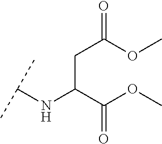 | Q-1.200 |
| 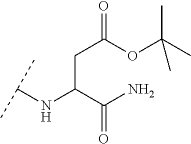 | Q-1.201 |
| 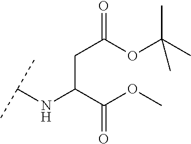 | Q-1.202 |
| 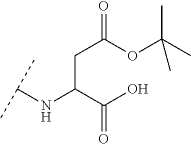 | Q-1.203 |
| 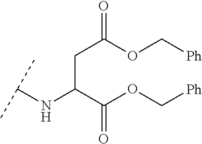 | Q-1.204 |
| 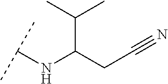 | Q-1.205 |
| 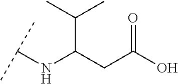 | Q-1.206 |
| 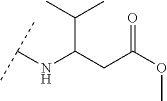 | Q-1.207 |
| 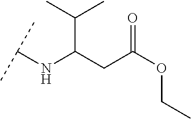 | Q-1.208 |
| 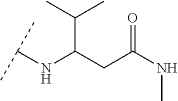 | Q-1.209 |
| 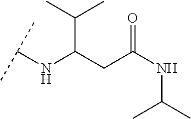 | Q-1.210 |
| 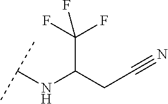 | Q-1.211 |
| 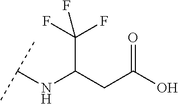 | Q-1.212 |
| 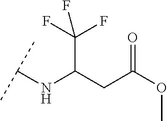 | Q-1.213 |
| 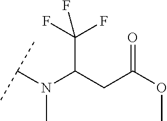 | Q-1.214 |
| 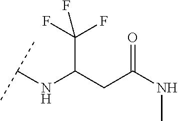 | Q-1.215 |
| 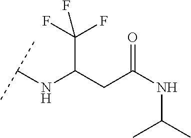 | Q-1.216 |
| 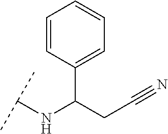 | Q-1.217 |
| 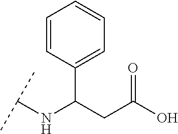 | Q-1.218 |
| 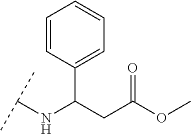 | Q-1.219 |
| 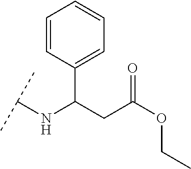 | Q-1.220 |
| 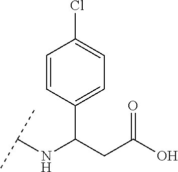 | Q-1.221 |
| 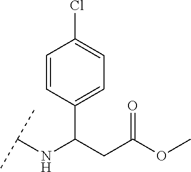 | Q-1.222 |
| 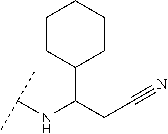 | Q-1.223 |
| 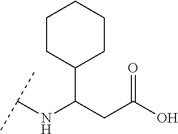 | Q-1.224 |
| 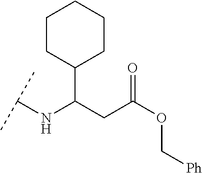 | Q-1.225 |
| 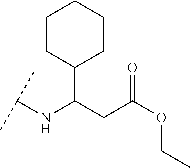 | Q-1.226 |
| 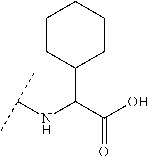 | Q-1.227 |
| 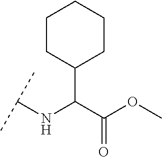 | Q-1.228 |
| 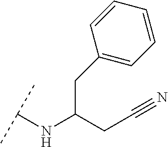 | Q-1.229 |
| 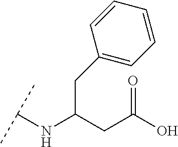 | Q-1.230 |
| 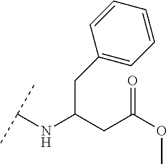 | Q-1.231 |
| 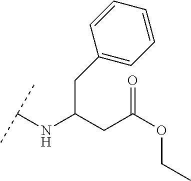 | Q-1.232 |
| 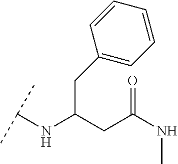 | Q-1.233 |
| 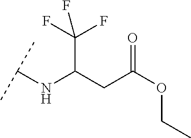 | Q-1.234 |
| 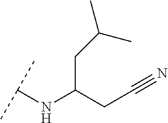 | Q-1.235 |
| 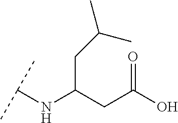 | Q-1.236 |
| 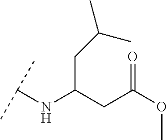 | Q-1.237 |
| 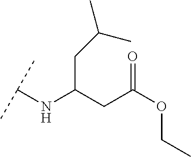 | Q-1.238 |
| 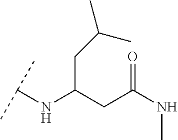 | Q-1.239 |
| 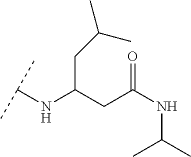 | Q-1.240 |
| 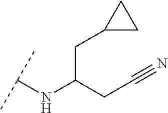 | Q-1.241 |
| 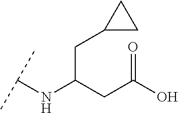 | Q-1.242 |
| 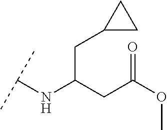 | Q-1.243 |
| 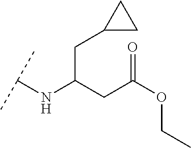 | Q-1.244 |
| 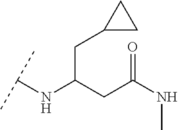 | Q-1.245 |
| 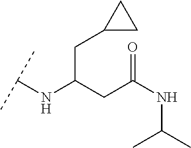 | Q-1.246 |
| 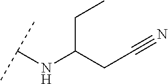 | Q-1.247 |
| 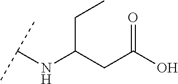 | Q-1.248 |
| 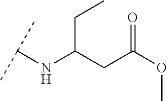 | Q-1.249 |
| 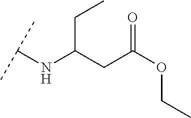 | Q-1.250 |
| 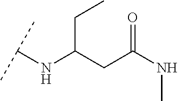 | Q-1.251 |
| 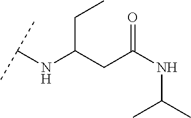 | Q-1.252 |
| 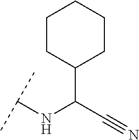 | Q-1.253 |
| 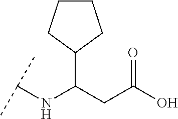 | Q-1.254 |
| 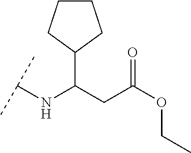 | Q-1.255 |
| 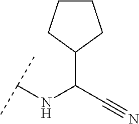 | Q-1.256 |
| 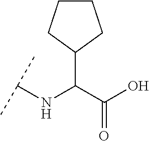 | Q-1.257 |
| 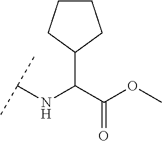 | Q-1.258 |
| 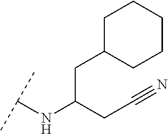 | Q-1.259 |
| 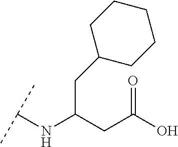 | Q-1.260 |
| 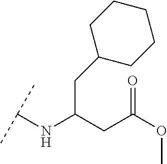 | Q-1.261 |
| 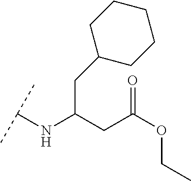 | Q-1.262 |
| 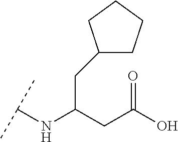 | Q-1.263 |
| 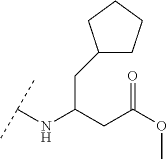 | Q-1.264 |
| 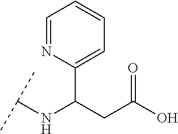 | Q-1.265 |
| 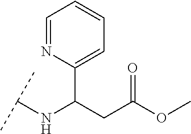 | Q-1.266 |
| 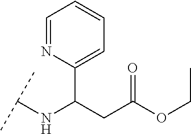 | Q-1.267 |
| 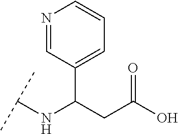 | Q-1.268 |
| 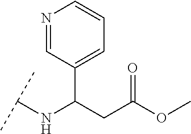 | Q-1.269 |
| 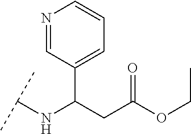 | Q-1.270 |
| 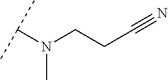 | Q-20.7 |
| 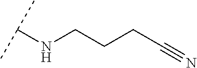 | Q-20.8 |
| 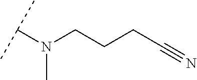 | Q-20.9 |
| 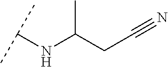 | Q-20.10 |
| 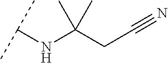 | Q-20.11 |
| 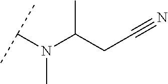 | Q-20.12 |
| 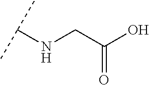 | Q-21.1 |
| 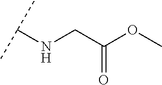 | Q-21.2 |
| 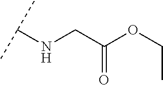 | Q-21.3 |
| 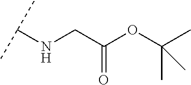 | Q-21.4 |
| 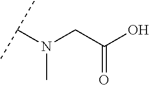 | Q-21.5 |
| 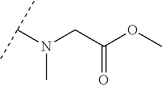 | Q-21.6 |
| 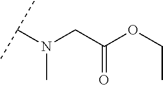 | Q-21.7 |
| 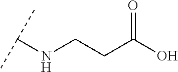 | Q-21.8 |
| 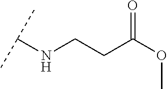 | Q-21.9 |
| 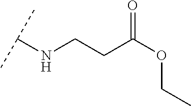 | Q-21.10 |
| 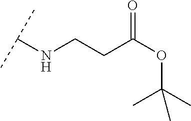 | Q-21.11 |
| 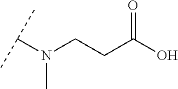 | Q-21.12 |
| 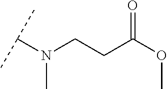 | Q-21.13 |
| 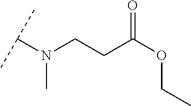 | Q-21.14 |
| 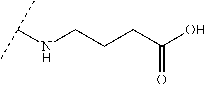 | Q-21.15 |
| 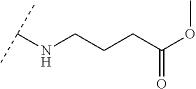 | Q-21.16 |
| 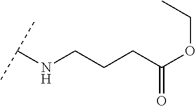 | Q-21.17 |
| 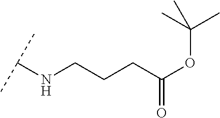 | Q-21.18 |
| 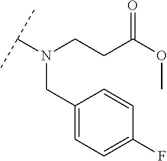 | Q-22.1 |
| 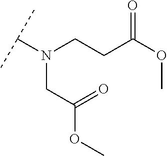 | Q-22.2 |
| 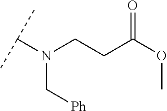 | Q-22.3 |
| 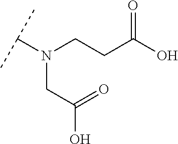 | Q-22.4 |
| 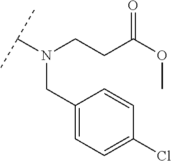 | Q-22.5 |
| 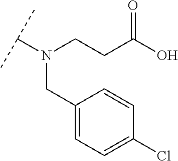 | Q-22.6 |
| 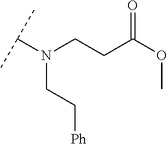 | Q-22.7 |
| 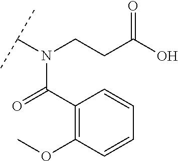 | Q-22.8 |
| 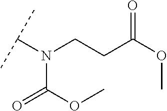 | Q-22.9 |
| 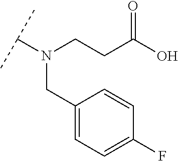 | Q-22.10 |
| 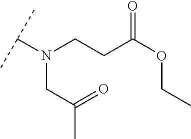 | Q-22.11 |
| 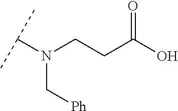 | Q-22.12 |
| 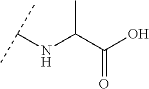 | Q-23.1 |
| 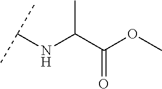 | Q-23.2 |
| 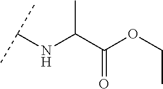 | Q-23.3 |
| 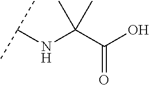 | Q-23.4 |
| 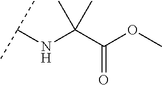 | Q-23.5 |
| 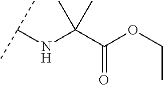 | Q-23.6 |
| 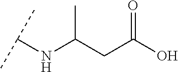 | Q-24.1 |
| 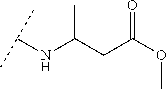 | Q-24.2 |
| 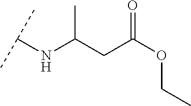 | Q-24.3 |
| 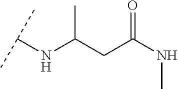 | Q-24.4 |
| 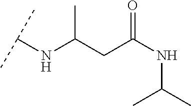 | Q-24.5 |
| 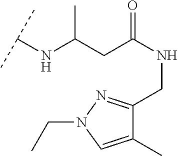 | Q-24.6 |
| 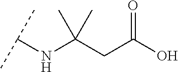 | Q-24.7 |
| 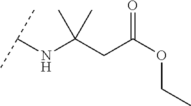 | Q-24.8 |
| 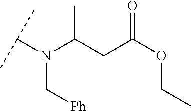 | Q-24.9 |
| 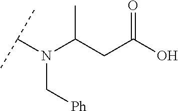 | Q-24.10 |
| 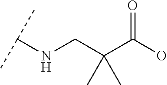 | Q-24.11 |
| 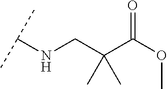 | Q-24.12 |
| 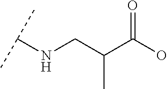 | Q-24.13 |
| 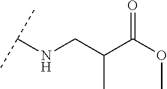 | Q-24.14 |
| 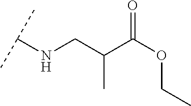 | Q-24.15 |

Very particular preference is given to the use according to the invention of compounds of the general formula (I) where

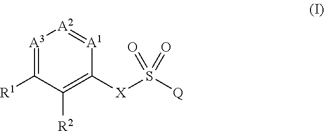

for increasing tolerance to abiotic stress in plants, where
Q is the moieties

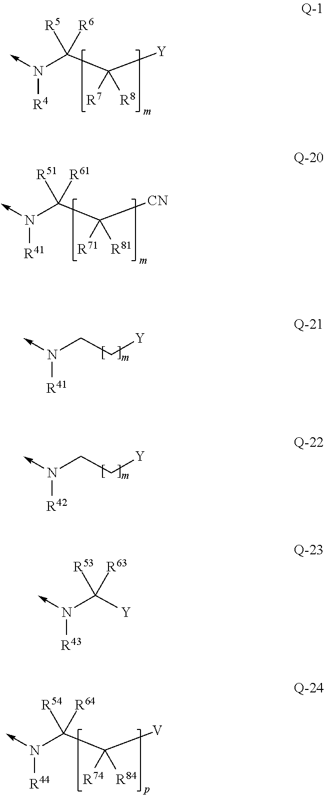

and where the radicals R⁴ to R⁸, and R⁴¹ to R⁸⁴ and also Y, V, m and p in each case have the meaning according to the definitions below and where the arrow is a bond to the sulfur atom of the SO₂ group;
A¹, A², A³ are identical or different and independently of one another are N (nitrogen) or the C—W moiety, but where there are never more than two adjacent nitrogen atoms, and where W in the C—W moiety in each case has the same or different meanings according to the definition below,
W is in each case hydrogen, nitro, amino, cyano, fluorine, chlorine, bromine, iodine, (C₁-C₄)-alkyl, (C₂-C₄)-alkenyl, aryl, aryl-(C₁-C₄)-alkyl, aryl-(C₁-C₄)-alkoxy, heteroaryl, (C₁-C₄)-alkoxy-(C₁-C₄)-alkyl, (C₁-C₄)-haloalkyl, (C₁-C₄)-alkoxy, (C₁-C₄)-haloalkoxy, aryloxy, (C₃-C₆)-cycloalkyloxy, (C₃-C₆)-cycloalkyl-(C₁-C₄)-alkoxy, (C₁-C₄)-alkoxycarbonyl, hydroxycarbonyl, aminocarbonyl, (C₁-C₄)-alkylaminocarbonyl, (C₃-C₆)-cycloalkylaminocarbonyl, cyano-(C₁-C₄)-alkylaminocarbonyl, (C₁-C₄)-alkylamino, (C₁-C₄)-alkylthio, (C₁-C₄)-haloalkylthio, bis-(C₁-C₄)-alkylamino, (C₃-C₆)-cycloalkylamino, (C₁-C₄)-alkylcarbonylamino, (C₃-C₆)-cycloalkylcarbonylamino, (C₁-C₄)-haloalkylcarbonylamino, (C₁-C₄)-alkoxycarbonylamino, (C₁-C₄)-alkylaminocarbonylamino, bis-[(C₁-C₄)-alkyl]-aminocarbonyl-amino, aryl-(C₁-C₄)-alkylcarbonylamino, (C₃-C₆)-cycloalkyl-(C₁-C₄)-alkylcarbonylamino, heteroarylcarbonylamino, (C₁-C₄)-alkoxy-(C₁-C₄)-alkylcarbonylamino, hydroxy-(C₁-C₄)-alkylcarbonylamino, (C₁-C₄)-alkoxycarbonyl-(C₁-C₄)-alkyl,
R¹ is H, nitro, amino, cyano, fluorine, chlorine, bromine, iodine, (C₁-C₄)-alkyl, (C₂-C₄)-alkenyl, aryl, aryl-(C₁-C₄)-alkyl, heteroaryl, (C₁-C₄)-alkoxy-(C₁-C₄)-alkyl, (C₁-C₄)-haloalkyl, (C₁-C₄)-alkoxy, (C₁-C₄)-haloalkoxy, (C₁-C₄)-alkylthio, (C₁-C₄)-haloalkylthio, (C₁-C₄)-alkoxycarbonyl, hydroxycarbonyl, aminocarbonyl, (C₁-C₄)-alkylaminocarbonyl, (C₁-C₄)-alkylamino, bis-(C₁-C₄)-alkylamino, (C₃-C₆)-cycloalkylamino, (C₁-C₄)-alkylcarbonylamino, (C₃-C₆)-cycloalkylcarbonylamino, (C₁-C₄)-haloalkylcarbonylamino, (C₁-C₄)-alkoxycarbonylamino, [(C₁-C₄)-alkyl]-aminocarbonyl-amino, amino-(C₁-C₄)-alkyl, amino-(C₂-C₄)-alkenyl, (C₂-C₄)-alkenylamino, (C₂-C₄)-alkenylimino,
R² is H, nitro, amino, cyano, fluorine, chlorine, bromine, iodine, (C₁-C₄)-alkyl, (C₂-C₄)-alkenyl, aryl, aryl-(C₁-C₄)-alkyl, heteroaryl, (C₁-C₄)-alkoxy-(C₁-C₄)-alkyl, (C₁-C₄)-haloalkyl, (C₁-C₄)-alkoxy, (C₁-C₄)-haloalkoxy, (C₁-C₄)-alkylthio, (C₁-C₄)-haloalkylthio, (C₁-C₄)-alkoxycarbonyl, hydroxycarbonyl, aminocarbonyl, (C₁-C₄)-alkylaminocarbonyl, (C₁-C₄)-alkylamino, bis-(C₁-C₄)-alkylamino, (C₃-C₆)-cycloalkylamino, (C₁-C₄)-alkylcarbonylamino, (C₃-C₆)-cycloalkylcarbonylamino, (C₁-C₄)-haloalkylcarbonylamino, (C₁-C₄)-alkoxycarbonylamino, [(C₁-C₄)-alkyl]-aminocarbonyl-amino, amino-(C₁-C₄)-alkyl, amino-(C₂-C₄)-alkenyl, (C₂-C₄)-alkenylamino, (C₂-C₄)-alkenylimino,
R¹ and R² with the atoms to which they are attached form a fully saturated, partially saturated or fully unsaturated, 5- to 7-membered ring optionally interrupted by heteroatoms and optionally with further substitution by W, and where, in the case of compounds of the general formula (I), they must form a corresponding ring with the moieties Q-21 and Q-23,
R¹ and A³, if A³ is a C—W group, with the atoms to which they are attached form a fully saturated, partially saturated or fully unsaturated, 5- to 7-membered ring optionally interrupted by heteroatoms and optionally with further substitution,
X is a direct bond or is a (CHR³)ₙ moiety, and where R³ in the (CHR³)ₙ moiety in each case has the same or different meanings according to the definition below,
n is 0, 1,
R³ is H, (C₁-C₄)-alkyl, (C₁-C₄)-haloalkyl, (C₃-C₆)-cycloalkyl, aryl-(C₁-C₄)-alkyl, (C₁-C₄)-alkoxy-(C₁-C₄)-alkyl,
R⁴ is H, (C₁-C₄)-alkyl, (C₂-C₄)-alkenyl-(C₁-C₄)-alkyl, (C₂-C₄)-alkynyl, (C₁-C₄)-alkylcarbonyl, (C₃-C₆)-cycloalkylcarbonyl, arylcarbonyl, heteroarylcarbonyl, (C₁-C₄)-alkoxycarbonyl, aryl-(C₁-C₄)-alkoxycarbonyl, (C₁-C₄)-alkylaminocarbonyl, aryl-(C₁-C₄)-alkyl, heteroaryl-(C₁-C₄)-alkyl, cyano-(C₁-C₄)-alkyl, (C₁-C₄)-haloalkyl, (C₃-C₆)-cycloalkyl, (C₁-C₄)-alkoxy-(C₁-C₄)-alkyl, (C₁-C₄)-haloalkoxy-(C₁-C₄)-alkyl, (C₂-C₄)-alkynyl-(C₁-C₄)-alkyl, (C₁-C₄)-alkoxycarbonyl-(C₁-C₄)-alkyl,
R⁵ is fluorine, (C₂-C₄)-alkyl, (C₁-C₄)-alkoxy, (C₁-C₄)-alkoxycarbonyloxy, (C₂-C₄)-alkenyl, (C₂-C₄)-haloalkenyl, (C₂-C₄)-alkenyl-(C₁-C₄)-alkyl, (C₂-C₄)-alkynyl, (C₂-C₄)-alkynyl-(C₁-C₄)-alkyl, aryl-(C₁-C₄)-alkyl, bisaryl-(C₁-C₄)-alkyl, aryl-(C₁-C₄)-alkoxyaryl-(C₁-C₄)-alkyl, aryloxyaryl-(C₁-C₄)-alkyl, (C₁-C₄)-alkoxyaryl-(C₁-C₄)-alkyl, heteroaryl-(C₁-C₄)-alkyl, heterocyclyl-(C₁-C₄)-alkyl, N—(C₁-C₄)-alkylheterocyclyl-(C₁-C₄)-alkyl, N—[(C₁-C₄)-alkoxycarbonyl]heterocyclyl-(C₁-C₄)-alkyl, N-(aryl-(C₁-C₄)-alkoxycarbonyl)heterocyclyl-(C₁-C₄)-alkyl, N-(arylcarbonyl)heterocyclyl-(C₁-C₄)-alkyl, N—[(C₁-C₄)-alkylcarbonyl]heterocyclyl-(C₁-C₄)-alkyl, N—[(C₃-C₆)-cycloalkylcarbonyl]heterocyclyl-(C₁-C₄)-alkyl, cyano-(C₁-C₄)-alkyl, (C₁-C₄)-haloalkyl, (C₃-C₆)-cycloalkyl, (C₃-C₆)-halocycloalkyl, (C₄-C₆)-cycloalkenyl, (C₃-C₆)-cycloalkyl-(C₁-C₄)-alkyl, (C₃-C₆)-cycloalkenyl-(C₁-C₄)-alkyl, hydroxy-(C₁-C₄)-alkyl, (C₁-C₄)-alkoxy-(C₁-C₄)-alkyl, (C₁-C₄)-haloalkoxy-(C₁-C₄)-alkyl, aryloxy-(C₁-C₄)-alkyl, aryl-(C₁-C₄)-alkoxy-(C₁-C₄)-alkyl, heteroaryl-(C₁-C₄)-alkoxy-(C₁-C₄)-alkyl, (C₃-C₆)-cycloalkoxy-(C₁-C₄)-alkyl, (C₃-C₆)-cycloalkyl-(C₁-C₄)-alkoxy-(C₁-C₄)-alkyl, (C₁-C₄)-alkylcarbonyloxy-(C₁-C₄)-alkyl, arylcarbonyloxy-(C₁-C₄)-alkyl, heteroarylcarbonyloxy-(C₁-C₄)-alkyl, (C₃-C₆)-cycloalkylcarbonyloxy-(C₁-C₄)-alkyl, arylsulfonyloxy-(C₁-C₄)-alkyl, (C₁-C₄)-alkylsulfonyloxy-(C₁-C₄)-alkyl, hydrothio-(C₁-C₄)-alkyl, (C₁-C₄)-alkylthio-(C₁-C₄)-alkyl, (C₁-C₄)-haloalkylthio-(C₁-C₄)-alkyl, aryl-(C₁-C₄)-alkylthio-(C₁-C₄)-alkyl, (C₃-C₆)-cycloalkylthio-(C₁-C₄)-alkyl, arylthio-(C₁-C₄)-alkyl, (C₁-C₄)-alkylsulfinyl-(C₁-C₄)-alkyl, (C₁-C₄)-alkylsulfonyl-(C₁-C₄)-alkyl, (C₁-C₄)-haloalkylsulfinyl-(C₁-C₄)-alkyl, (C₁-C₄)-haloalkylsulfonyl-(C₁-C₄)-alkyl, aryl-(C₁-C₄)-alkylsulfinyl-(C₁-C₄)-alkyl, aryl-(C₁-C₄)-alkylsulfonyl-(C₁-C₄)-alkyl, (C₃-C₆)-cycloalkylsulfinyl-(C₁-C₄)-alkyl, (C₃-C₆)-cycloalkylsulfonyl-(C₁-C₄)-alkyl, aryl, heteroaryl, heterocyclyl, N—[(C₁-C₄)-alkyl]heterocyclyl, N—[(C₁-C₄)-alkoxycarbonyl]heterocyclyl, N—[aryl-(C₁-C₄)-alkoxycarbonyl]heterocyclyl, N-(arylcarbonyl)heterocyclyl, N—[(C₁-C₄)-alkylcarbonyl]heterocyclyl, N—[(C₁-C₄)-cycloalkylcarbonyl]heterocyclyl, hydroxycarbonyl, (C₁-C₄)-alkoxycarbonyl, (C₃-C₆)-cycloalkoxycarbonyl, (C₃-C₆)-cycloalkyl-(C₁-C₄)-alkoxycarbonyl, aryl-(C₁-C₄)-alkoxycarbonyl, heteroaryl-(C₁-C₄)-alkoxycarbonyl, (C₁-C₄)-alkylaminocarbonyl, aminocarbonyl, bis-(C₁-C₄)-alkylaminocarbonyl, (C₃-C₆)-cycloalkylaminocarbonyl, aryl-(C₁-C₄)-alkylaminocarbonyl, heteroarylaminocarbonyl, cyano-(C₁-C₄)-alkylaminocarbonyl, (C₁-C₄)-haloalkylaminocarbonyl, (C₂-C₄)-alkynyl-(C₁-C₄)-alkylaminocarbonyl, hydroxycarbonyl-(C₁-C₄)-alkyl, (C₁-C₄)-alkoxycarbonyl-(C₁-C₄)-alkyl, (C₃-C₆)-cycloalkoxycarbonyl-(C₁-C₄)-alkyl, (C₃-C₆)-cycloalkyl-(C₁-C₄)-alkoxycarbonyl-(C₁-C₄)-alkyl, aryl-(C₁-C₄)-alkoxycarbonyl-(C₁-C₄)-alkyl, heteroaryl-(C₁-C₄)-alkoxycarbonyl-(C₁-C₄)-alkyl, (C₁-C₄)-alkylaminocarbonyl-(C₁-C₄)-alkyl, aminocarbonyl-(C₁-C₄)-alkyl, bis-(C₁-C₄)-alkylaminocarbonyl-(C₁-C₄)-alkyl, (C₃-C₆)-cycloalkylaminocarbonyl-(C₁-C₄)-alkyl, aryl-(C₁-C₄)-alkylaminocarbonyl-(C₁-C₄)-alkyl, heteroarylaminocarbonyl-(C₁-C₄)-alkyl, cyano-(C₁-C₄)-alkylaminocarbonyl-(C₁-C₄)-alkyl, (C₁-C₄)-haloalkylaminocarbonyl-(C₁-C₄)-alkyl, (C₂-C₄)-alkynyl-(C₁-C₄)-alkylaminocarbonyl-(C₁-C₄)-alkyl, amino-(C₁-C₄)-alkyl, (C₁-C₄)-alkylamino-(C₁-C₄)-alkyl, (C₂-C₄)-alkenylamino-(C₁-C₄)-alkyl, arylamino-(C₁-C₄)-alkyl, bis-(C₁-C₄)-alkylamino-(C₁-C₄)-alkyl, bis-(C₃-C₆)-cycloalkylamino-(C₁-C₄)-alkyl, aryl-(C₁-C₄)-alkylamino-(C₁-C₄)-alkyl, tris-aryl-(C₁-C₄)-alkylamino-(C₁-C₄)-alkyl, (C₃-C₆)-cycloalkylamino-(C₁-C₄)-alkyl, (C₃-C₆)-cycloalkyl-(C₁-C₄)-alkylamino-(C₁-C₄)-alkyl, (C₁-C₄)-haloalkylamino-(C₁-C₄)-alkyl, (C₁-C₄)-alkylcarbonylamino-(C₁-C₄)-alkyl, (C₁-C₄)-cycloalkylcarbonylamino-(C₁-C₄)-alkyl, arylcarbonylamino-(C₁-C₄)-alkyl, heteroarylcarbonylamino-(C₁-C₄)-alkyl, (C₁-C₄)-alkoxycarbonylamino-(C₁-C₄)-alkyl, (C₂-C₄)-alkenyloxycarbonylamino-(C₁-C₄)-alkyl, aryl-(C₁-C₄)-alkoxycarbonylamino-(C₁-C₄)-alkyl, aryl-(C₁-C₄)-alkoxycarbonyl[N—(C₁-C₄)-alkyl]amino-(C₁-C₄)-alkyl, heteroaryl-(C₁-C₄)-alkoxycarbonylamino-(C₁-C₄)-alkyl, (C₃-C₆)-cycloalkyl-(C₁-C₄)-alkoxycarbonylamino-(C₁-C₄)-alkyl, (C₃-C₆)-cycloalkoxycarbonylamino-(C₁-C₄)-alkyl, aminocarbonylamino-(C₁-C₄)-alkyl, arylsulfonylamino-(C₁-C₄)-alkyl, heteroarylsulfonylamino-(C₁-C₄)-alkyl, (C₁-C₄)-alkylsulfonylamino-(C₁-C₄)-alkyl, (C₃-C₆)-cycloalkylsulfonylamino-(C₁-C₄)-alkyl, aminoiminoamino-(C₁-C₄)-alkyl, arylsulfonylaminoiminoamino-(C₁-C₄)-alkyl, (C₁-C₄)-alkylaminoiminoamino-(C₁-C₄)-alkyl,
R⁷ is hydrogen, halogen, (C₁-C₄)-alkyl, (C₁-C₄)-alkoxy, (C₁-C₄)-alkoxycarbonyloxy, (C₂-C₄)-alkenyl, (C₂-C₄)-haloalkenyl, (C₂-C₄)-alkenyl-(C₁-C₄)-alkyl, (C₂-C₄)-alkynyl, (C₂-C₄)-alkynyl-(C₁-C₄)-alkyl, aryl-(C₁-C₄)-alkyl, bisaryl-(C₁-C₄)-alkyl, aryl-(C₁-C₄)-alkoxyaryl-(C₁-C₄)-alkyl, aryloxyaryl-(C₁-C₄)-alkyl, (C₁-C₄)-alkoxyaryl-(C₁-C₄)-alkyl, heteroaryl-(C₁-C₄)-alkyl, heterocyclyl-(C₁-C₄)-alkyl, N—(C₁-C₄)-alkyl heterocyclyl-(C₁-C₄)-alkyl, N—[(C₁-C₄)-alkoxycarbonyl]heterocyclyl-(C₁-C₄)-alkyl, N-(aryl-(C₁-C₄)-alkoxycarbonyl)heterocyclyl-(C₁-C₄)-alkyl, N-(arylcarbonyl)heterocyclyl-(C₁-C₄)-alkyl, N—[(C₁-C₄)-alkylcarbonyl]heterocyclyl-(C₁-C₄)-alkyl, N—[(C₃-C₆)-cycloalkylcarbonyl]heterocyclyl-(C₁-C₄)-alkyl, cyano-(C₁-C₄)-alkyl, (C₁-C₄)-haloalkyl, (C₃-C₆)-cycloalkyl, (C₃-C₆)-halocycloalkyl, (C₄-C₆)-cycloalkenyl, (C₃-C₆)-cycloalkyl-(C₁-C₄)-alkyl, (C₃-C₆)-cycloalkenyl-(C₁-C₄)-alkyl, hydroxy-(C₁-C₄)-alkyl, (C₁-C₄)-alkoxy-(C₁-C₄)-alkyl, (C₁-C₄)-haloalkoxy-(C₁-C₄)-alkyl, aryloxy-(C₁-C₄)-alkyl, aryl-(C₁-C₄)-alkoxy-(C₁-C₄)-alkyl, heteroaryl-(C₁-C₄)-alkoxy-(C₁-C₄)-alkyl, (C₃-C₆)-cycloalkoxy-(C₁-C₄)-alkyl, (C₃-C₆)-cycloalkyl-(C₁-C₄)-alkoxy-(C₁-C₄)-alkyl, (C₁-C₄)-alkylcarbonyloxy-(C₁-C₄)-alkyl, arylcarbonyloxy-(C₁-C₄)-alkyl, heteroarylcarbonyloxy-(C₁-C₄)-alkyl, (C₃-C₆)-cycloalkylcarbonyloxy-(C₁-C₄)-alkyl, arylsulfonyloxy-(C₁-C₄)-alkyl, (C₁-C₄)-alkylsulfonyloxy-(C₁-C₄)-alkyl, hydrothio-(C₁-C₄)-alkyl, (C₁-C₄)-alkylthio-(C₁-C₄)-alkyl, (C₁-C₄)-haloalkylthio-(C₁-C₄)-alkyl, aryl-(C₁-C₄)-alkylthio-(C₁-C₄)-alkyl, (C₃-C₆)-cycloalkylthio-(C₁-C₄)-alkyl, arylthio-(C₁-C₄)-alkyl, (C₁-C₄)-alkylsulfinyl-(C₁-C₄)-alkyl, (C₁-C₄)-alkylsulfonyl-(C₁-C₄)-alkyl, (C₁-C₄)-haloalkylsulfinyl-(C₁-C₄)-alkyl, (C₁-C₄)-haloalkylsulfonyl-(C₁-C₄)-alkyl, aryl-(C₁-C₄)-alkylsulfinyl-(C₁-C₄)-alkyl, aryl-(C₁-C₄)-alkylsulfonyl-(C₁-C₄)-alkyl, (C₃-C₆)-cycloalkylsulfinyl-(C₁-C₄)-alkyl, (C₃-C₆)-cycloalkylsulfonyl-(C₁-C₄)-alkyl, aryl, heteroaryl, heterocyclyl, N—[(C₁-C₄)-alkyl]heterocyclyl, N—[(C₁-C₄)-alkoxycarbonyl]heterocyclyl, N—[aryl-(C₁-C₄)-alkoxycarbonyl]heterocyclyl, N-(arylcarbonyl)heterocyclyl, N—[(C₁-C₄)-alkylcarbonyl]heterocyclyl, N—[(C₁-C₄)-cycloalkylcarbonyl]heterocyclyl, hydroxycarbonyl, (C₁-C₄)-alkoxycarbonyl, (C₃-C₆)-cycloalkoxycarbonyl, (C₃-C₆)-cycloalkyl-(C₁-C₄)-alkoxycarbonyl, aryl-(C₁-C₄)-alkoxycarbonyl, heteroaryl-(C₁-C₄)-alkoxycarbonyl, (C₁-C₄)-alkylaminocarbonyl, aminocarbonyl, bis-(C₁-C₄)-alkylaminocarbonyl, (C₃-C₆)-cycloalkylaminocarbonyl, aryl-(C₁-C₄)-alkylaminocarbonyl, heteroarylaminocarbonyl, cyano-(C₁-C₄)-alkylaminocarbonyl, (C₁-C₄)-haloalkylaminocarbonyl, (C₂-C₄)-alkynyl-(C₁-C₄)-alkylaminocarbonyl, hydroxycarbonyl-(C₁-C₄)-alkyl, (C₁-C₄)-alkoxycarbonyl-(C₁-C₄)-alkyl, (C₃-C₆)-cycloalkoxycarbonyl-(C₁-C₄)-alkyl, (C₃-C₆)-cycloalkyl-(C₁-C₄)-alkoxycarbonyl-(C₁-C₄)-alkyl, aryl-(C₁-C₄)-alkoxycarbonyl-(C₁-C₄)-alkyl, heteroaryl-(C₁-C₄)-alkoxycarbonyl-(C₁-C₄)-alkyl, (C₁-C₄)-alkylaminocarbonyl-(C₁-C₄)-alkyl, aminocarbonyl-(C₁-C₄)-alkyl, bis-(C₁-C₄)-alkylaminocarbonyl-(C₁-C₄)-alkyl, (C₃-C₆)-cycloalkylaminocarbonyl-(C₁-C₄)-alkyl, aryl-(C₁-C₄)-alkylaminocarbonyl-(C₁-C₄)-alkyl, heteroarylaminocarbonyl-(C₁-C₄)-alkyl, cyano-(C₁-C₄)-alkylaminocarbonyl-(C₁-C₄)-alkyl, (C₁-C₄)-haloalkylaminocarbonyl-(C₁-C₄)-alkyl, (C₂-C₄)-alkynyl-(C₁-C₄)-alkylaminocarbonyl-(C₁-C₄)-alkyl, amino-(C₁-C₄)-alkyl, (C₁-C₄)-alkylamino-(C₁-C₄)-alkyl, (C₂-C₄)-alkenylamino-(C₁-C₄)-alkyl, arylamino-(C₁-C₄)-alkyl, bis-(C₁-C₄)-alkylamino-(C₁-C₄)-alkyl, bis-(C₃-C₆)-cycloalkylamino-(C₁-C₄)-alkyl, aryl-(C₁-C₄)-alkylamino-(C₁-C₄)-alkyl, tris-aryl-(C₁-C₄)-alkylamino-(C₁-C₄)-alkyl, (C₃-C₆)-cycloalkylamino-(C₁-C₄)-alkyl, (C₃-C₆)-cycloalkyl-(C₁-C₄)-alkylamino-(C₁-C₄)-alkyl, (C₁-C₄)-haloalkylamino-(C₁-C₄)-alkyl, (C₁-C₄)-alkylcarbonylamino-(C₁-C₄)-alkyl, (C₁-C₄)-cycloalkylcarbonylamino-(C₁-C₄)-alkyl, arylcarbonylamino-(C₁-C₄)-alkyl, heteroarylcarbonylamino-(C₁-C₄)-alkyl, (C₁-C₄)-alkoxycarbonylamino-(C₁-C₄)-alkyl, (C₂-C₄)-alkenyloxycarbonylamino-(C₁-C₄)-alkyl, aryl-(C₁-C₄)-alkoxycarbonylamino-(C₁-C₄)-alkyl, aryl-(C₁-C₄)-alkoxycarbonyl[N—(C₁-C₄)-alkyl]amino-(C₁-C₄)-alkyl, heteroaryl-(C₁-C₄)-alkoxycarbonylamino-(C₁-C₄)-alkyl, (C₃-C₆)-cycloalkyl-(C₁-C₄)-alkoxycarbonylamino-(C₁-C₄)-alkyl, (C₃-C₆)-cycloalkoxycarbonylamino-(C₁-C₄)-alkyl, aminocarbonylamino-(C₁-C₄)-alkyl, arylsulfonylamino-(C₁-C₄)-alkyl, heteroarylsulfonylamino-(C₁-C₄)-alkyl, (C₁-C₄)-alkylsulfonylamino-(C₁-C₄)-alkyl, (C₃-C₆)-cycloalkylsulfonylamino-(C₁-C₄)-alkyl, aminoiminoamino-(C₁-C₄)-alkyl, arylsulfonylaminoiminoamino-(C₁-C₄)-alkyl, (C₁-C₄)-alkylaminoiminoamino-(C₁-C₄)-alkyl,
R⁶ and R⁸ independently of one another are H, (C₁-C₄)-alkyl, (C₂-C₄)-alkenyl-(C₁-C₄)-alkyl, aryl-(C₁-C₄)-alkyl, (C₃-C₆)-cycloalkyl, heterocyclyl, heterocyclyl-(C₁-C₄)-alkyl, (C₁-C₄)-alkoxy-(C₁-C₄)-alkyl, (C₁-C₄)-alkylthio-(C₁-C₄)-alkyl, (C₁-C₄)-haloalkyl,
R⁴¹ is H or methyl,
R⁴² is (C₂-C₄)-alkyl, (C₂-C₄)-alkenyl-(C₁-C₄)-alkyl, (C₁-C₄)-alkylcarbonyl, arylcarbonyl, heteroarylcarbonyl, (C₁-C₄)-alkoxycarbonyl, aryl-(C₁-C₄)-alkoxycarbonyl, (C₁-C₄)-alkylaminocarbonyl, aryl-(C₁-C₄)-alkyl, heteroaryl-(C₁-C₄)-alkyl, cyano-(C₁-C₄)-alkyl, (C₁-C₄)-haloalkyl, (C₃-C₆)-cycloalkyl, (C₁-C₄)-alkoxy-(C₁-C₄)-alkyl, (C₁-C₄)-haloalkoxy-(C₁-C₄)-alkyl, (C₁-C₄)-alkoxycarbonyl-(C₁-C₄)-alkyl , hydroxycarbonyl-(C₁-C₄)-alkyl, (C₁-C₄)-alkylaminocarbonyl-(C₁-C₄)-alkyl , (C₁-C₄)-alkylcarbonyl-(C₁-C₄)-alkyl,
R⁴³ is H or methyl,
R⁴⁴ is hydrogen, (C₁-C₄)-alkyl, aryl-(C₁-C₄)-alkyl,
R⁵¹ and R⁷¹ independently of one another are hydrogen and methyl,
R⁵³ is methyl,
R⁶¹ and R⁸¹ independently of one another are hydrogen and methyl,
R⁶³ is H, methyl,
R⁵⁴, R⁶⁴, R⁷⁴, R⁸⁴ independently of one another are hydrogen, methyl, where at least one of the groups R⁵⁴, R⁶⁴, R⁷⁴, R⁸⁴ must be methyl,
V is hydroxycarbonyl, (C₁-C₄)-alkoxycarbonyl, aryl-(C₁-C₄)-alkoxycarbonyl, aminocarbonyl, (C₁-C₄)-alkylaminocarbonyl, bis-(C₁-C₄)-alkylaminocarbonyl, (C₃-C₆)-cycloalkylaminocarbonyl, aryl-(C₁-C₄)-alkylaminocarbonyl, heteroaryl-(C₁-C₄)-alkylaminocarbonyl, cyano-(C₁-C₄)-alkylaminocarbonyl,
m is 0, 1, 2, 3, 4,
p is 1, 2, 3,
Y is cyano, hydroxycarbonyl, (C₁-C₄)-alkoxycarbonyl, (C₃-C₆)-cycloalkyl-(C₁-C₄)-alkoxycarbonyl, aryl-(C₁-C₄)-alkoxycarbonyl, aminocarbonyl, (C₁-C₄)-alkylaminocarbonyl, bis-(C₁-C₄)-alkylaminocarbonyl, (C₃-C₆)-cycloalkylaminocarbonyl, aryl-(C₁-C₄)-alkylaminocarbonyl, heteroaryl-(C₁-C₄)-alkylaminocarbonyl, cyano-(C₁-C₄)-alkylaminocarbonyl, (C₂-C₄)-alkynyl-(C₁-C₄)-alkylaminocarbonyl, (C₁-C₄)-alkoxycarbonylaminocarbonyl, aryl-(C₁-C₄)-alkoxycarbonylaminocarbonyl, hydroxycarbonyl-(C₁-C₄)-alkyl, (C₁-C₄)-alkoxycarbonyl-(C₁-C₄)-alkyl, (C₁-C₄)-alkylaminocarbonyl-(C₁-C₄)-alkyl, aminocarbonyl-(C₁-C₄)-alkyl, bis-(C₁-C₄)-alkylaminocarbonyl-(C₁-C₄)-alkyl, (C₃-C₆)-cycloalkylaminocarbonyl-(C₁-C₄)-alkyl, aryl-(C₁-C₄)-alkylaminocarbonyl-(C₁-C₄)-alkyl, heteroaryl-(C₁-C₄)-alkylaminocarbonyl-(C₁-C₄)-alkyl, cyano-(C₁-C₄)-alkylaminocarbonyl-(C₁-C₄)-alkyl, (C₂-C₄)-alkenyloxycarbonyl, (C₂-C₄)-alkenyloxycarbonyl-(C₁-C₄)-alkyl, (C₂-C₄)-alkenylaminocarbonyl, (C₂-C₄)-alkenyl-(C₁-C₄)-alkylaminocarbonyl, (C₂-C₄)-alkenylaminocarbonyl-(C₁-C₄)-alkyl, (C₂-C₄)-alkenyl-(C₁-C₄)-alkylaminocarbonyl-(C₁-C₄)-alkyl.
   and Q is furthermore one of the Q-1.1 to Q-24.15 moieties specifically listed in the table above.

With regard to the compounds used according to the invention, the terms used above and below are defined. These are familiar to the person skilled in the art and have in particular the meanings defined hereinafter:

According to the invention, “arylsulfonyl” represents optionally substituted phenylsulfonyl or optionally substituted polycyclic arylsulfonyl, here especially optionally substituted naphthylsulfonyl, for example substituted by fluorine, chlorine, bromine, iodine, cyano, nitro, alkyl, haloalkyl, haloalkoxy, amino, alkylamino, alkylcarbonylamino, dialkylamino or alkoxy groups.

According to the invention, “cycloalkylsulfonyl”—alone or as a constituent of a chemical group—represents optionally substituted cycloalkylsulfonyl, preferably having 3 to 6 carbon atoms, for example cyclopropylsulfonyl, cyclobutylsulfonyl, cyclopentylsulfonyl or cyclohexylsulfonyl.

According to the invention, “alkylsulfonyl”—alone or as a constituent of a chemical group—represents straight-chain or branched alkylsulfonyl, preferably having 1 to 8 or having 1 to 6 carbon atoms, for example methylsulfonyl, ethylsulfonyl, n-propylsulfonyl, isopropylsulfonyl, n-butylsulfonyl, isobutylsulfonyl, sec-butylsulfonyl and tert-butylsulfonyl.

According to the invention, “heteroarylsulfonyl” represents optionally substituted pyridylsulfonyl, pyrimidinylsulfonyl, pyrazinylsulfonyl or optionally substituted polycyclic heteroarylsulfonyl, here in particular optionally substituted quinolinylsulfonyl, for example substituted by fluorine, chlorine, bromine, iodine, cyano, nitro, alkyl, haloalkyl, haloalkoxy, amino, alkylamino, alkylcarbonylamino, dialkylamino or alkoxy groups.

According to the invention, “alkylthio”—alone or as a constituent of a chemical group—represents straight-chain or branched S-alkyl, preferably having 1 to 8 or having 1 to 6 carbon atoms, for example methylthio, ethylthio, n-propylthio, isopropylthio, n-butylthio, isobutylthio, sec-butylthio and tert-butylthio. Alkenylthio is an alkenyl radical bonded via a sulfur atom, alkynylthio is an alkynyl radical bonded via a sulfur atom, cycloalkylthio is a cycloalkyl radical bonded via a sulfur atom, and cycloalkenylthio is a cycloalkenyl radical bonded via a sulfur atom.

“Alkoxy” is an alkyl radical bonded via an oxygen atom, alkenyloxy is an alkenyl radical bonded via an oxygen atom, alkynyloxy is an alkynyl radical bonded via an oxygen atom, cycloalkyloxy is a cycloalkyl radical bonded via an oxygen atom, and cycloalkenyloxy is a cycloalkenyl radical bonded via an oxygen atom.

The term “aryl” is an optionally substituted mono-, bi- or polycyclic aromatic system having preferably 6 to 14, especially 6 to 10, ring carbon atoms, for example phenyl, naphthyl, anthryl, phenanthrenyl and the like, preferably phenyl.

The term “optionally substituted aryl” also includes polycyclic systems, such as tetrahydronaphthyl, indenyl, indanyl, fluorenyl, biphenylyl, where the bonding site is on the aromatic system. In systematic terms, “aryl” is generally also encompassed by the term “optionally substituted phenyl”.

A heterocyclic radical (heterocyclyl) contains at least one heterocyclic ring (=carbocyclic ring in which at least one carbon atom has been replaced by a heteroatom, preferably by a heteroatom from the group of N, O, S, P) which is saturated, unsaturated, partly saturated or heteroaromatic and may be unsubstituted or substituted, where the bonding site is localized on a ring atom. If the heterocyclyl radical or the heterocyclic ring is optionally substituted, it can be fused to other carbocyclic or heterocyclic rings. In the case of optionally substituted heterocyclyl, polycyclic systems are also included, for example 8-azabicyclo[3.2.1]octanyl, 8-azabicyclo[2.2.2]octanyl or 1-azabicyclo[2.2.1]heptyl. In the case of optionally substituted heterocyclyl, spirocyclic systems are also included, such as, for example, 1-oxa-5-aza-spiro[2.3]hexyl. Unless defined differently, the heterocyclic ring contains preferably 3 to 9 ring atoms and especially 3 to 6 ring atoms, and one or more, preferably 1 to 4 and especially 1, 2 or 3 heteroatoms in the heterocyclic ring, preferably from the group of N, O and S, although no two oxygen atoms should be directly adjacent, for example, with one heteroatom from the group of N, O and S, 1- or 2- or 3-pyrrolidinyl, 3,4-dihydro-2H-pyrrol-2- or 3-yl, 2,3-dihydro-1H-pyrrol-1- or 2- or 3- or 4- or 5-yl; 2,5-dihydro-1H-pyrrol-1- or 2- or 3-yl, 1- or 2- or 3- or 4-piperidinyl; 2,3,4,5-tetrahydropyridin-2- or 3- or 4- or 5-yl or 6-yl; 1,2,3,6-tetrahydropyridin-1- or 2- or 3- or 4- or 5- or 6-yl; 1,2,3,4-tetrahydropyridin-1- or 2- or 3- or 4- or 5- or 6-yl; 1,4-dihydropyridin-1- or 2- or 3- or 4-yl; 2,3-dihydropyridin-2- or 3- or 4- or 5- or 6-yl; 2,5-dihydropyridin-2- or 3- or 4- or 5- or 6-yl, 1- or 2- or 3- or 4-azepanyl; 2,3,4,5-tetrahydro-1H-azepin-1- or 2- or 3- or 4- or 5- or 6- or 7-yl; 2,3,4,7-tetrahydro-1H-azepin-1- or 2- or 3- or 4- or 5- or 6- or 7-yl; 2,3,6,7-tetrahydro-1H-azepin-1- or 2- or 3- or 4-yl; 3,4,5,6-tetrahydro-2H-azepin-2- or 3- or 4- or 5- or 6- or 7-yl; 4,5-dihydro-1H-azepin-1- or 2- or 3- or 4-yl; 2,5-dihydro-1H-azepin-1- or -2- or 3- or 4- or 5- or 6- or 7-yl; 2,7-dihydro-1H-azepin-1- or -2- or 3- or 4-yl; 2,3-dihydro-1H-azepin-1- or -2- or 3- or 4- or 5- or 6- or 7-yl; 3,4-dihydro-2H-azepin-2- or 3- or 4- or 5- or 6- or 7-yl; 3,6-dihydro-2H-azepin-2- or 3- or 4- or 5- or 6- or 7-yl; 5,6-dihydro-2H-azepin-2- or 3- or 4- or 5- or 6- or 7-yl; 4,5-dihydro-3H-azepin-2- or 3- or 4- or 5- or 6- or 7-yl; 1H-azepin-1- or -2- or 3- or 4- or 5- or 6- or 7-yl; 2H-azepin-2- or 3- or 4- or 5- or 6- or 7-yl; 3H-azepin-2- or 3- or 4- or 5- or 6- or 7-yl; 4H-azepin-2- or 3- or 4- or 5- or 6- or 7-yl, 2- or 3-oxolanyl (=2- or 3-tetrahydrofuranyl); 2,3-dihydrofuran-2- or 3- or 4- or 5-yl; 2,5-dihydrofuran-2- or 3-yl, 2- or 3- or 4-oxanyl (=2- or 3- or 4-tetrahydropyranyl); 3,4-dihydro-2H-pyran-2- or 3- or 4- or 5- or 6-yl; 3,6-dihydro-2H-pyran-2- or 3- or 4- or 5- or 6-yl; 2H-pyran-2- or 3- or 4- or 5- or 6-yl; 4H-pyran-2- or 3- or 4-yl, 2- or 3- or 4-oxepanyl; 2,3,4,5-tetrahydrooxepin-2- or 3- or 4- or 5- or 6- or 7-yl; 2,3,4,7-tetrahydrooxepin-2- or 3- or 4- or 5- or 6- or 7-yl; 2,3,6,7-tetrahydrooxepin-2- or 3- or 4-yl; 2,3-dihydrooxepin-2- or 3- or 4- or 5- or 6- or 7-yl; 4,5-dihydrooxepin-2- or 3- or 4-yl; 2,5-dihydrooxepin-2- or 3- or 4- or 5- or 6- or 7-yl; oxepin-2- or 3- or 4- or 5- or 6- or 7-yl; 2- or 3-tetrahydrothiophenyl; 2,3-dihydrothiophen-2- or 3- or 4- or 5-yl; 2,5-dihydrothiophen-2- or 3-yl; tetrahydro-2H-thiopyran-2- or 3- or 4-yl; 3,4-dihydro-2H-thiopyran-2- or 3- or 4- or 5- or 6-yl; 3,6-dihydro-2H-thiopyran-2- or 3- or 4- or 5- or 6-yl; 2H-thiopyran-2- or 3- or 4- or 5- or 6-yl; 4H-thiopyran-2- or 3- or 4-yl. Preferred 3-membered and 4-membered heterocyclic rings are, for example, 1- or 2-aziridinyl, oxiranyl, thiiranyl, 1- or 2- or 3-azetidinyl, 2- or 3-oxetanyl, 2- or 3-thietanyl, 1,3-dioxetan-2-yl. Further examples of “heterocyclyl” are a partly or fully hydrogenated heterocyclic radical having two heteroatoms from the group of N, O and S, for example 1- or 2- or 3- or 4-pyrazolidinyl; 4,5-dihydro-3H-pyrazol-3- or 4- or 5-yl; 4,5-dihydro-1H-pyrazol-1- or 3- or 4- or 5-yl; 2,3-dihydro-1H-pyrazol-1- or 2- or 3- or 4- or 5-yl; 1- or 2- or 3- or 4-imidazolidinyl; 2,3-dihydro-1H-imidazol-1- or 2- or 3- or 4-yl; 2,5-dihydro-1H-imidazol-1- or 2- or 4- or 5-yl; 4,5-dihydro-1H-imidazol-1- or 2- or 4- or 5-yl; hexahydropyridazin-1- or 2- or 3- or 4-yl; 1,2,3,4-tetrahydropyridazin-1- or 2- or 3- or 4- or 5- or 6-yl; 1,2,3,6-tetrahydropyridazin-1- or 2- or 3- or 4- or 5- or 6-yl; 1,4,5,6-tetrahydropyridazin-1- or 3- or 4- or 5- or 6-yl; 3,4,5,6-tetrahydropyridazin-3- or 4- or 5-yl; 4,5-dihydropyridazin-3- or 4-yl; 3,4-dihydropyridazin-3- or 4- or 5- or 6-yl; 3,6-dihydropyridazin-3- or 4-yl; 1,6-dihydropyridazin-1- or 3- or 4- or 5- or 6-yl; hexahydropyrimidin-1- or 2- or 3- or 4-yl; 1,4,5,6-tetrahydropyrimidin-1- or 2- or 4- or 5- or 6-yl; 1,2,5,6-tetrahydropyrimidin-1- or 2- or 4- or 5- or 6-yl; 1,2,3,4-tetrahydropyrimidin-1- or 2- or 3- or 4- or 5- or 6-yl; 1,6-dihydropyrimidin-1- or 2- or 4- or 5- or 6-yl; 1,2-dihydropyrimidin-1- or 2- or 4- or 5- or 6-yl; 2,5-dihydropyrimidin-2- or 4- or 5-yl; 4,5-dihydropyrimidin-4- or 5- or 6-yl; 1,4-dihydropyrimidin-1- or 2- or 4- or 5- or 6-yl; 1- or 2- or 3-piperazinyl; 1,2,3,6-tetrahydropyrazin-1- or 2- or 3- or 5- or 6-yl; 1,2,3,4-tetrahydropyrazin-1- or 2- or 3- or 4- or 5- or 6-yl; 1,2-dihydropyrazin-1- or 2- or 3- or 5- or 6-yl; 1,4-dihydropyrazin-1- or 2- or 3-yl; 2,3-dihydropyrazin-2- or 3- or 5- or 6-yl; 2,5-dihydropyrazin-2- or 3-yl; 1,3-dioxolan-2- or 4- or 5-yl; 1,3-dioxol-2- or 4-yl; 1,3-dioxan-2- or 4- or 5-yl; 4H-1,3-dioxin-2- or 4- or 5- or 6-yl; 1,4-dioxan-2- or 3- or 5- or 6-yl; 2,3-dihydro-1,4-dioxin-2- or 3- or 5- or 6-yl; 1,4-dioxin-2- or 3-yl; 1,2-dithiolan-3- or 4-yl; 3H-1,2-dithiol-3- or 4- or 5-yl; 1,3-dithiolan-2- or 4-yl; 1,3-dithiol-2- or 4-yl; 1,2-dithian-3- or 4-yl; 3,4-dihydro-1,2-dithiin-3- or 4- or 5- or 6-yl; 3,6-dihydro-1,2-dithiin-3- or 4-yl; 1,2-dithiin-3- or 4-yl; 1,3-dithian-2- or 4- or 5-yl; 4H-1,3-dithiin-2- or 4- or 5- or 6-yl; isoxazolidin-2- or 3- or 4- or 5-yl; 2,3-dihydroisoxazol-2- or 3- or 4- or 5-yl; 2,5-dihydroisoxazol-2- or 3- or 4- or 5-yl; 4,5-dihydroisoxazol-3- or 4- or 5-yl; 1,3-oxazolidin-2- or 3- or 4- or 5-yl; 2,3-dihydro-1,3-oxazol-2- or 3- or 4- or 5-yl; 2,5-dihydro-1,3-oxazol-2- or 4- or 5-yl; 4,5-dihydro-1,3-oxazol-2- or 4- or 5-yl; 1,2-oxazinan-2- or 3- or 4- or 5- or 6-yl; 3,4-dihydro-2H-1,2-oxazin-2- or 3- or 4- or 5- or 6-yl; 3,6-dihydro-2H-1,2-oxazin-2- or 3- or 4- or 5- or 6-yl; 5,6-dihydro-2H-1,2-oxazin-2- or 3- or 4- or 5- or 6-yl; 5,6-dihydro-4H-1,2-oxazin-3- or 4- or 5- or 6-yl; 2H-1,2-oxazin-2- or 3- or 4- or 5- or 6-yl; 6H-1,2-oxazin-3- or 4- or 5- or 6-yl; 4H-1,2-oxazin-3- or 4- or 5- or 6-yl; 1,3-oxazinan-2- or 3- or 4- or 5- or 6-yl; 3,4-dihydro-2H-1,3-oxazin-2- or 3- or 4- or 5- or 6-yl; 3,6-dihydro-2H-1,3-oxazin-2- or 3- or 4- or 5- or 6-yl; 5,6-dihydro-2H-1,3-oxazin-2- or 4- or 5- or 6-yl; 5,6-dihydro-4H-1,3-oxazin-2- or 4- or 5- or 6-yl; 2H-1,3-oxazin-2- or 4- or 5- or 6-yl; 6H-1,3-oxazin-2- or 4- or 5- or 6-yl; 4H-1,3-oxazin-2- or 4- or 5- or 6-yl; morpholin-2- or 3- or 4-yl; 3,4-dihydro-2H-1,4-oxazin-2- or 3- or 4- or 5- or 6-yl; 3,6-dihydro-2H-1,4-oxazin-2- or 3- or 5- or 6-yl; 2H-1,4-oxazin-2- or 3- or 5- or 6-yl; 4H-1,4-oxazin-2- or 3-yl; 1,2-oxazepan-2- or 3- or 4- or 5- or 6- or 7-yl; 2,3,4,5-tetrahydro-1,2-oxazepin-2- or 3- or 4- or 5- or 6- or 7-yl; 2,3,4,7-tetrahydro-1,2-oxazepin-2- or 3- or 4- or 5- or 6- or 7-yl; 2,3,6,7-tetrahydro-1,2-oxazepin-2- or 3- or 4- or 5- or 6- or 7-yl; 2,5,6,7-tetrahydro-1,2-oxazepin-2- or 3- or 4- or 5- or 6- or 7-yl; 4,5,6,7-tetrahydro-1,2-oxazepin-3- or 4- or 5- or 6- or 7-yl; 2,3-dihydro-1,2-oxazepin-2- or 3- or 4- or 5- or 6- or 7-yl; 2,5-dihydro-1,2-oxazepin-2- or 3- or 4- or 5- or 6- or 7-yl; 2,7-dihydro-1,2-oxazepin-2- or 3- or 4- or 5- or 6- or 7-yl; 4,5-dihydro-1,2-oxazepin-3- or 4- or 5- or 6- or 7-yl; 4,7-dihydro-1,2-oxazepin-3- or 4- or 5- or 6- or 7-yl; 6,7-dihydro-1,2-oxazepin-3- or 4- or 5- or 6- or 7-yl; 1,2-oxazepin-3- or 4- or 5- or 6- or 7-yl; 1,3-oxazepan-2- or 3- or 4- or 5- or 6- or 7-yl; 2,3,4,5-tetrahydro-1,3-oxazepin-2- or 3- or 4- or 5- or 6- or 7-yl; 2,3,4,7-tetrahydro-1,3-oxazepin-2- or 3- or 4- or 5- or 6- or 7-yl; 2,3,6,7-tetrahydro-1,3-oxazepin-2- or 3- or 4- or 5- or 6- or 7-yl; 2,5,6,7-tetrahydro-1,3-oxazepin-2- or 4- or 5- or 6- or 7-yl; 4,5,6,7-tetrahydro-1,3-oxazepin-2- or 4- or 5- or 6- or 7-yl; 2,3-dihydro-1,3-oxazepin-2- or 3- or 4- or 5- or 6- or 7-yl; 2,5-dihydro-1,3-oxazepin-2- or 4- or 5- or 6- or 7-yl; 2,7-dihydro-1,3-oxazepin-2- or 4- or 5- or 6- or 7-yl; 4,5-dihydro-1,3-oxazepin-2- or 4- or 5- or 6- or 7-yl; 4,7-dihydro-1,3-oxazepin-2- or 4- or 5- or 6- or 7-yl; 6,7-dihydro-1,3-oxazepin-2- or 4- or 5- or 6- or 7-yl; 1,3-oxazepin-2- or 4- or 5- or 6- or 7-yl; 1,4-oxazepan-2- or 3- or 5- or 6- or 7-yl; 2,3,4,5-tetrahydro-1,4-oxazepin-2- or 3- or 4- or 5- or 6- or 7-yl; 2,3,4,7-tetrahydro-1,4-oxazepin-2- or 3- or 4- or 5- or 6- or 7-yl; 2,3,6,7-tetrahydro-1,4-oxazepin-2- or 3- or 5- or 6- or 7-yl; 2,5,6,7-tetrahydro-1,4-oxazepin-2- or 3- or 5- or 6- or 7-yl; 4,5,6,7-tetrahydro-1,4-oxazepin-2- or 3- or 4- or 5- or 6- or 7-yl; 2,3-dihydro-1,4-oxazepin-2- or 3- or 5- or 6- or 7-yl; 2,5-dihydro-1,4-oxazepin-2- or 3- or 5- or 6- or 7-yl; 2,7-dihydro-1,4-oxazepin-2- or 3- or 5- or 6- or 7-yl; 4,5-dihydro-1,4-oxazepin-2- or 3- or 4- or 5- or 6- or 7-yl; 4,7-dihydro-1,4-oxazepin-2- or 3- or 4- or 5- or 6- or 7-yl; 6,7-dihydro-1,4-oxazepin-2- or 3- or 5- or 6- or 7-yl; 1,4-oxazepin-2- or 3- or 5- or 6- or 7-yl; isothiazolidin-2- or 3- or 4- or 5-yl; 2,3-dihydroisothiazol-2- or 3- or 4- or 5-yl; 2,5-dihydroisothiazol-2- or 3- or 4- or 5-yl; 4,5-dihydroisothiazol-3- or 4- or 5-yl; 1,3-thiazolidin-2- or 3- or 4- or 5-yl; 2,3-dihydro-1,3-thiazol-2- or 3- or 4- or 5-yl; 2,5-dihydro-1,3-thiazol-2- or 4- or 5-yl; 4,5-dihydro-1,3-thiazol-2- or 4- or 5-yl; 1,3-thiazinan-2- or 3- or 4- or 5- or 6-yl; 3,4-dihydro-2H-1,3-thiazin-2- or 3- or 4- or 5- or 6-yl; 3,6-dihydro-2H-1,3-thiazin-2- or 3- or 4- or 5- or 6-yl; 5,6-dihydro-2H-1,3-thiazin-2- or 4- or 5- or 6-yl; 5,6-dihydro-4H-1,3-thiazin-2- or 4- or 5- or 6-yl; 2H-1,3-thiazin-2- or 4- or 5- or 6-yl; 6H-1,3-thiazin-2- or 4- or 5- or 6-yl; 4H-1,3-thiazin-2- or 4- or 5- or 6-yl. Further examples of “heterocyclyl” are a partly or fully hydrogenated heterocyclic radical having 3 heteroatoms from the group of N, O and S, for example 1,4,2-dioxazolidin-2- or 3- or 5-yl; 1,4,2-dioxazol-3- or 5-yl; 1,4,2-dioxazinan-2- or -3- or 5- or 6-yl; 5,6-dihydro-1,4,2-dioxazin-3- or 5- or 6-yl; 1,4,2-dioxazin-3- or 5- or 6-yl; 1,4,2-dioxazepan-2- or 3- or 5- or 6- or 7-yl; 6,7-dihydro-5H-1,4,2-dioxazepin-3- or 5- or 6- or 7-yl; 2,3-dihydro-7H-1,4,2-dioxazepin-2- or 3- or 5- or 6- or 7-yl; 2,3-dihydro-5H-1,4,2-dioxazepin-2- or 3- or 5- or 6- or 7-yl; 5H-1,4,2-dioxazepin-3- or 5- or 6- or 7-yl; 7H-1,4,2-dioxazepin-3- or 5- or 6- or 7-yl.

When a base structure is substituted “by one or more radicals” from a list of radicals (=group) or a generically defined group of radicals, this in each case includes simultaneous substitution by a plurality of identical and/or structurally different radicals.

In the case of a partly or fully saturated nitrogen heterocycle, this may be joined to the rest of the molecule either via carbon or via the nitrogen.

Suitable substituents for a substituted heterocyclic radical are the substituents specified later on below, and additionally also oxo and thioxo. In this case, the oxo group as substituent at a ring carbon atom, for example, is a carbonyl group in the heterocyclic ring. As a result, lactones and lactams are preferably also included. The oxo group may also be present at the hetero ring atoms which can occur in various oxidation states, for example at N and S, in which case they form, for example, the divalent groups N(O), S(O) (also abbreviated as SO) and S(O)₂ (also abbreviated as SO2) in the heterocyclic ring. In the case of N(O)— and S(O)— groups, in each case both enantiomers are included.

According to the invention, the expression “heteroaryl” represents heteroaromatic compounds, i.e. fully unsaturated aromatic heterocyclic compounds, preferably 5- to 7-membered rings having 1 to 4, preferably 1 or 2, identical or different heteroatoms, preferably O, S or N. Inventive heteroaryls are, for example, 1H-pyrrol-1-yl; 1H-pyrrol-2-yl; 1H-pyrrol-3-yl; furan-2-yl; furan-3-yl; thien-2-yl; thien-3-yl, 1H-imidazol-1-yl; 1H-imidazol-2-yl; 1H-imidazol-4-yl; 1H-imidazol-5-yl; 1H-pyrazol-1-yl; 1H-pyrazol-3-yl; 1H-pyrazol-4-yl; 1H-pyrazol-5-yl, 1H-1,2,3-triazol-1-yl, 1H-1,2,3-triazol-4-yl, 1H-1,2,3-triazol-5-yl, 2H-1,2,3-triazol-2-yl, 2H-1,2,3-triazol-4-yl, 1H-1,2,4-triazol-1-yl, 1H-1,2,4-triazol-3-yl, 4H-1,2,4-triazol-4-yl, 1,2,4-oxadiazol-3-yl, 1,2,4-oxadiazol-5-yl, 1,3,4-oxadiazol-2-yl, 1,2,3-oxadiazol-4-yl, 1,2,3-oxadiazol-5-yl, 1,2,5-oxadiazol-3-yl, azepinyl, pyridin-2-yl, pyridin-3-yl, pyridin-4-yl, pyrazin-2-yl, pyrazin-3-yl, pyrimidin-2-yl, pyrimidin-4-yl, pyrimidin-5-yl, pyridazin-3-yl, pyridazin-4-yl, 1,3,5-triazin-2-yl, 1,2,4-triazin-3-yl, 1,2,4-triazin-5-yl, 1,2,4-triazin-6-yl, 1,2,3-triazin-4-yl, 1,2,3-triazin-5-yl, 1,2,4-, 1,3,2-, 1,3,6- and 1,2,6-oxazinyl, isoxazol-3-yl, isoxazol-4-yl, isoxazol-5-yl, 1,3-oxazol-2-yl, 1,3-oxazol-4-yl, 1,3-oxazol-5-yl, isothiazol-3-yl, isothiazol-4-yl, isothiazol-5-yl, 1,3-thiazol-2-yl, 1,3-thiazol-4-yl, 1,3-thiazol-5-yl, oxepinyl, thiepinyl, 1,2,4-triazolonyl and 1,2,4-diazepinyl, 2H-1,2,3,4-tetrazol-5-yl, 1H-1,2,3,4-tetrazol-5-yl, 1,2,3,4-oxatriazol-5-yl, 1,2,3,4-thiatriazol-5-yl, 1,2,3,5-oxatriazol-4-yl, 1,2,3,5-thiatriazol-4-yl. The inventive heteroaryl groups may also be substituted by one or more identical or different radicals. When two adjacent carbon atoms are part of a further aromatic ring, the systems are fused heteroaromatic systems, such as benzofused or polyannulated heteroaromatics. Preferred examples are quinolines (e.g. quinolin-2-yl, quinolin-3-yl, quinolin-4-yl, quinolin-5-yl, quinolin-6-yl, quinolin-7-yl, quinolin-8-yl); isoquinolines (e.g. isoquinolin-1-yl, isoquinolin-3-yl, isoquinolin-4-yl, isoquinolin-5-yl, isoquinolin-6-yl, isoquinolin-7-yl, isoquinolin-8-yl); quinoxaline; quinazoline; cinnoline; 1,5-naphthyridine; 1,6-naphthyridine; 1,7-naphthyridine; 1,8-naphthyridine; 2,6-naphthyridine; 2,7-naphthyridine; phthalazine; pyridopyrazines; pyridopyrimidines; pyridopyridazines; pteridines; pyrimidopyrimidines. Examples of heteroaryl are also 5- or 6-membered benzofused rings from the group of 1H-indol-1-yl, 1H-indol-2-yl, 1H-indol-3-yl, 1H-indol-4-yl, 1H-indol-5-yl, 1H-indol-6-yl, 1H-indol-7-yl, 1-benzofuran-2-yl, 1-benzofuran-3-yl, 1-benzofuran-4-yl, 1-benzofuran-5-yl, 1-benzofuran-6-yl, 1-benzofuran-7-yl, 1-benzothiophen-2-yl, 1-benzothiophen-3-yl, 1-benzothiophen-4-yl, 1-benzothiophen-5-yl, 1-benzothiophen-6-yl, 1-benzothiophen-7-yl, 1H-indazol-1-yl, 1H-indazol-3-yl, 1H-indazol-4-yl, 1H-indazol-5-yl, 1H-indazol-6-yl, 1H-indazol-7-yl, 2H-indazol-2-yl, 2H-indazol-3-yl, 2H-indazol-4-yl, 2H-indazol-5-yl, 2H-indazol-6-yl, 2H-indazol-7-yl, 2H-isoindol-2-yl, 2H-isoindol-1-yl, 2H-isoindol-3-yl, 2H-isoindol-4-yl, 2H-isoindol-5-yl, 2H-isoindol-6-yl; 2H-isoindol-7-yl, 1H-benzimidazol-1-yl, 1H-benzimidazol-2-yl, 1H-benzimidazol-4-yl, 1H-benzimidazol-5-yl, 1H-benzimidazol-6-yl, 1H-benzimidazol-7-yl, 1,3-benzoxazol-2-yl, 1,3-benzoxazol-4-yl, 1,3-benzoxazol-5-yl, 1,3-benzoxazol-6-yl, 1,3-benzoxazol-7-yl, 1,3-benzothiazol-2-yl, 1,3-benzothiazol-4-yl, 1,3-benzothiazol-5-yl, 1,3-benzothiazol-6-yl, 1,3-benzothiazol-7-yl, 1,2-benzisoxazol-3-yl, 1,2-benzisoxazol-4-yl, 1,2-benzisoxazol-5-yl, 1,2-benzisoxazol-6-yl, 1,2-benzisoxazol-7-yl, 1,2-benzisothiazol-3-yl, 1,2-benzisothiazol-4-yl, 1,2-benzisothiazol-5-yl, 1,2-benzisothiazol-6-yl, 1,2-benzisothiazol-7-yl.

The term “halogen” means, for example, fluorine, chlorine, bromine or iodine. When the term is used for a radical, “halogen” means, for example, a fluorine, chlorine, bromine or iodine atom.

According to the invention, “alkyl” means a straight-chain or branched open-chain, saturated hydrocarbon radical which is optionally mono- or polysubstituted. Preferred substituents are halogen atoms, alkoxy, haloalkoxy, cyano, alkylthio, haloalkylthio, amino or nitro groups, particular preference being given to methoxy, methyl, fluoroalkyl, cyano, nitro, fluorine, chlorine, bromine or iodine.

“Haloalkyl”, “-alkenyl” and “-alkynyl” mean alkyl, alkenyl and alkynyl, respectively, partially or fully substituted by identical or different halogen atoms, for example monohaloalkyl such as, for example, CH₂CH₂Cl, CH₂CH₂Br, CHClCH₃, CH₂Cl, CH₂F; perhaloalkyl such as, for example, CCl₃, CClF₂, CFCl₂, CF₂CClF₂, CF₂CClFCF₃; polyhaloalkyl such as, for example, CH₂CHFCl, CF₂CClFH, CF₂CBrFH, CH₂CF₃; here, the term perhaloalkyl also includes the term perfluoroalkyl.

Haloalkoxy is, for example, OCF₃, OCHF₂, OCH₂F, OCF₂CF₃, OCH₂CF₃ and OCH₂CH₂Cl; this applies correspondingly to haloalkenyl and other halogen-substituted radicals.

The expression “(C₁-C₄)-alkyl” mentioned here by way of example is a brief notation for straight-chain or branched alkyl having one to 4 carbon atoms according to the range stated for carbon atoms, i.e. comprises the methyl, ethyl, 1-propyl, 2-propyl, 1-butyl, 2-butyl, 2-methylpropyl or tert-butyl radicals. General alkyl radicals with a larger specified range of carbon atoms, e.g. “(C₁-C₆)-alkyl”, correspondingly also encompass straight-chain or branched alkyl radicals with a greater number of carbon atoms, i.e. according to the example also the alkyl radicals having 5 and 6 carbon atoms.

Unless stated specifically, preference is given to the lower carbon skeletons, for example having from 1 to 6 carbon atoms, or having from 2 to 6 carbon atoms in the case of unsaturated groups, in the case of the hydrocarbon radicals such as alkyl, alkenyl and alkynyl radicals, including in combined radicals. Alkyl radicals, including in composite radicals such as alkoxy, haloalkyl, etc., are, for example, methyl, ethyl, n-propyl or i-propyl, n-, i- or t- or 2-butyl, pentyls, hexyls such as n-hexyl, i-hexyl and 1,3-dimethylbutyl, heptyls such as n-heptyl, 1-methylhexyl and 1,4-dimethylpentyl; alkenyl and alkynyl radicals are defined as the possible unsaturated radicals corresponding to the alkyl radicals, where at least one double bond or triple bond is present. Preference is given to radicals having one double bond or triple bond.

The term “alkenyl” also includes in particular straight-chain or branched open-chain hydrocarbon radicals having more than one double bond, such as 1,3-butadienyl and 1,4-pentadienyl, but also allenyl or cumulenyl radicals having one or more cumulated double bonds, for example allenyl (1,2-propadienyl), 1,2-butadienyl and 1,2,3-pentatrienyl. Alkenyl is, for example, vinyl which may optionally be substituted by further alkyl radicals, for example prop-1-en-1-yl, but-1-en-1-yl, allyl, 1-methylprop-2-en-1-yl, 2-methylprop-2-en-1-yl, but-2-en-1-yl, 1-methylbut-3-en-1-yl and 1-methylbut-2-en-1-yl, 2-methylprop-1-en-1-yl, 1-methylprop-1-en-1-yl, 1-methylprop-2-en-1-yl, 2-methylprop-2-en-1-yl, but-2-en-1-yl, but-3-en-1-yl, 1-methylbut-3-en-1-yl or 1-methylbut-2-en-1-yl, pentenyl, 2-methylpentenyl or hexenyl.

The term “alkynyl” in particular also includes straight-chain or branched open-chain hydrocarbon radicals having more than one triple bond, or else having one or more triple bonds and one or more double bonds, for example 1,3-butatrienyl or 3-penten-1-yn-1-yl. (C₂-C₆)-Alkynyl is, for example, ethynyl, propargyl, 1-methylprop-2-yn-1-yl, 2-butynyl, 2-pentynyl or 2-hexynyl, preferably propargyl, but-2-yn-1-yl, but-3-yn-1-yl or 1-methylbut-3-yn-1-yl.

The term “cycloalkyl” means a carbocyclic saturated ring system having preferably 3-8 ring carbon atoms, for example cyclopropyl, cyclobutyl, cyclopentyl or cyclohexyl.

In the case of optionally substituted cycloalkyl, cyclic systems with substituents are included, also including substituents with a double bond on the cycloalkyl radical, for example an alkylidene group such as methylidene. In the case of optionally substituted cycloalkyl, polycyclic aliphatic systems are also included, for example bicyclo[1.1.0]butan-1-yl, bicyclo[1.1.0]butan-2-yl, bicyclo[2.1.0]pentan-1-yl, bicyclo[2.1.0]pentan-2-yl, bicyclo[2.1.0]pentan-5-yl, bicyclo[2.2.1]hept-2-yl (norbornyl), bicyclo[2.2.2]octan-2-yl, adamantan-1-yl and adamantan-2-yl. The expression “(C₃-C₇)-cycloalkyl” means a brief notation for cycloalkyl having three to 7 carbon atoms corresponding to the range specified for carbon atoms.

In the case of substituted cycloalkyl, spirocyclic aliphatic systems are also included, for example spiro[2.2]pent-1-yl, spiro[2.3]hex-1-yl, spiro[2.3]hex-4-yl, 3-spiro[2.3]hex-5-yl.

“Cycloalkenyl” means a carbocyclic, nonaromatic, partly unsaturated ring system having preferably 4-8 carbon atoms, e.g. 1-cyclobutenyl, 2-cyclobutenyl, 1-cyclopentenyl, 2-cyclopentenyl, 3-cyclopentenyl, or 1-cyclohexenyl, 2-cyclohexenyl, 3-cyclohexenyl, 1,3-cyclohexadienyl or 1,4-cyclohexadienyl, also including substituents with a double bond on the cycloalkenyl radical, for example an alkylidene group such as methylidene. In the case of optionally substituted cycloalkenyl, the elucidations for substituted cycloalkyl apply correspondingly.

The term “alkylidene”, for example also in the form (C₁-C₁₀)-alkylidene, means the radical of a straight-chain or branched open-chain hydrocarbon radical attached via a double bond. Suitable binding sites for alkylidene are, naturally, only those positions at the skeleton where two hydrogen atoms can be replaced by the double bond; radicals are, for example, ═CH₂, ═CH—CH₃, ═C(CH₃)—CH₃, ═C(CH₃)—C₂H₅ and ═C(C₂H₅)—C₂H₅. Cycloalkylidene means a carbocyclic radical attached via a double bond.

Depending on the nature and the attachment of the substituents, the compounds of the formula (I) may be present as stereoisomers. The formula (I) embraces all possible stereoisomers defined by their specific spatial form, such as enantiomers, diastereomers, Z and E isomers. If, for example, one or more alkenyl groups are present, there may be diastereomers (Z and E isomers). If, for example, one or more asymmetric carbon atoms are present, there may be enantiomers and diastereomers. Stereoisomers can be obtained from the mixtures obtained in the preparation by customary separation methods. The chromatographic separation can be effected either on the analytical scale to find the enantiomeric excess or the diastereomeric excess, or on the preparative scale to prepare test specimens for biological testing. It is also possible to prepare stereoisomers selectively by using stereoselective reactions employing optically active starting materials and/or auxiliaries. The invention thus also relates to all stereoisomers which are embraced by the formula (I) but are not shown in their specific stereomeric form, and to mixtures thereof.

Synthesis of open-chain aryl-, heteroaryl- and benzylsulfonamides having a substituted alkyl side chain and of analogs thereof.

The open-chain aryl-, heteroaryl- and benzylsulfonamides of the formula (I) according to the invention, optionally with further substitution, can be prepared by known processes (cf. Eur J. Med. Chem. 2010, 45, 1760; Comb. Chem. & High Throughput Scr. 2009, 12, 275; Bioorg. Med. Chem. 2007, 15, 7553; EP2065370). The synthesis routes used and examined proceed from commercially available or easily preparable amino acid derivatives, aminoalkylnitrile intermediates and the corresponding sulfonyl chlorides.

Aryl- and heteroarylsulfonyl chloride intermediates can be prepared, for example, by direct chlorosulfonation of the corresponding substituted aromatics and heteroaromatics (cf. Eur J. Med. Chem. 2010, 45, 1760) or by diazotization of an amino-substituted aromatic or heteroaromatic and subsequent chlorosulfonation (cf. WO2005035486). Coupling of the corresponding substituted sulfonyl chloride intermediates with the appropriate amino acid and aminoalkylnitrile derivatives with the aid of a suitable base (for example triethylamine or sodium hydroxide) in a suitable solvent (for example tetrahydrofuran or dichloromethane) affords the aryl-, heteroaryl- and benzylsulfonamides according to the invention, optionally with further substitution (for example sub-class I(a) in scheme 1).

Substituted N-sulfonylaminoalkylnitriles I(b) as sub-class of the aryl-, heteroaryl- and benzylsulfonamides of the formula (I) according to the invention can also be prepared via a Strecker reaction of substituted N-sulfonylaldimines with a suitable trialkylsilyl cyanide in a suitable polar-aprotic solvent (for example dichloromethane, acetonitrile, propionitrile) using elemental iodine (cf. Synthesis 2009, 3467) or using a suitable lanthanium binaphthylsulfonate complex (cf. Org. Lett. 2009, 11, 2321; here, the abbreviation BINSA means 1,1′-binaphthyl-2,2′-disulfonic acid). A further synthetic access to substituted N-sulfonylaminoalkylnitriles I(b) is offered by the conversion of the corresponding substituted N-sulfonylamino acid derivatives I(a) with the aid of thionyl chloride and then an aqueous ammonia solution into the substituted N-sulfonylamino acid amides I(c) according to the invention and their further reaction with thionyl chloride under reflux conditions (cf. Compt. Rend. Ch. 2009, 12, 1066). Thus, synthesis routes described in the literature were employed, and some were optimized (scheme 1).

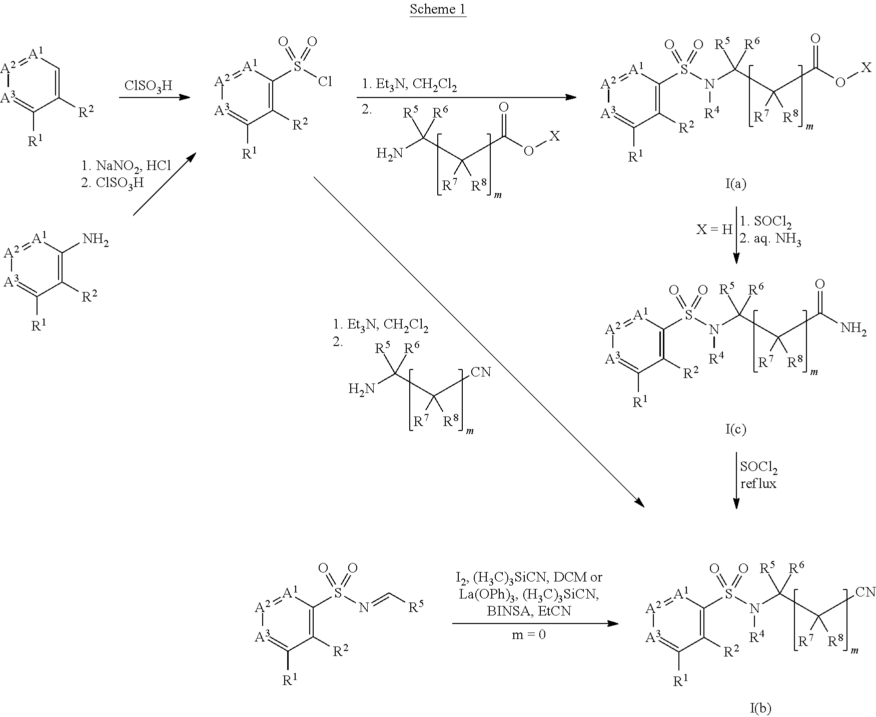

Selected detailed synthesis examples for the compounds of the formula I according to the invention are given below. The substance numbers mentioned correspond to the numbers listed in tables 1 to 100. The ¹H NMR, ¹³C NMR and ¹⁹F NMR spectroscopy data which are reported for the chemical examples described in the paragraphs which follow (400 MHz for ¹H NMR and 150 MHz for ¹³C NMR and 375 MHz for ¹⁹F NMR, solvent: CDCl₃, CD₃OD or d₆-DMSO, internal standard: tetramethylsilane δ=0.00 ppm), were obtained on a Bruker instrument, and the signals listed have the meanings given below: br=broad; s=singlet, d=doublet, t=triplet, dd=doublet of doublets, ddd=doublet of a doublet of doublets, m=multiplet, q=quartet, quint=quintet, sext=sextet, sept=septet, t=triplet, dq=doublet of quartets, dt=doublet of triplets.

### EXAMPLE NO. I.1-29

### Methyl 3-{[(4-bromophenyl)sulfonyl]amino}-4-methylpentanoate

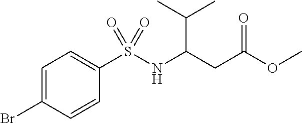 [SMILES: COC(=O)CC(NS(=O)(=O)c1ccc(Br)cc1)C(C)C]

4-Bromobenzenesulfonyl chloride (150 mg, 0.59 mmol) was dissolved in tetrahydrofuran (3 ml) and triethylamine (0.10 ml, 0.70 mmol) under argon. After 10 min of stirring at room temperature, the reaction solution was cooled to 0° C., and 3-amino-4-methyl pentanoate was added as hydrochloride salt (128 mg, 0.70 mmol). The resulting reaction mixture was stirred at room temperature for 6 h, then dichloromethane, water and sat. sodium bicarbonate solution were added, and the aqueous phases were subsequently extracted repeatedly with dichloromethane. The combined organic phases were dried over magnesium sulfate, filtered and concentrated under reduced pressure. By column chromatography purification of the crude product (ethyl acetate/heptane gradient), methyl 3-{[(4-bromophenyl)sulfonyl]amino}-4-methylpentanoate (141 mg, 66% of theory) was obtained as a colorless solid. ¹H NMR (400 MHz, d₆-DMSO δ, ppm) 7.80 (br. d, 1H, NH), 7.78 (d, 2H), 7.67 (d, 2H), 3.41 (m, 1H), 3.39 (s, 3H), 2.39 (dd, 1H), 2.16 (dd, 1H), 1.66 (m, 1H), 0.74 (d, 6H).

### EXAMPLE NO. I.37-106

### Methyl N-[(4-methoxyphenyl)sulfonyl]histidinate

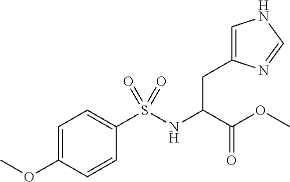

Under argon, 4-methoxybenzenesulfonyl chloride (100 mg, 0.48 mmol) was dissolved in tetrahydrofuran (5 ml) and triethylamine (0.09 ml, 0.63 mmol). After 10 min of stirring at room temperature, the reaction solution was cooled to 0° C., and histidine methyl ester (82 mg, 0.48 mmol) was added. The resulting reaction mixture was stirred at room temperature for another 6 h, dichloromethane, water and sat. sodium bicarbonate solution were added and the aqueous phases were then extracted repeatedly with dichloromethane. The combined organic phases were dried over magnesium sulfate, filtered and concentrated under reduced pressure. Purification of the crude product by column chromatography (ethyl acetate/heptane gradient) gave methyl N-[(4-methoxyphenyl)sulfonyl]histidinate (114 mg, 34% of theory) as a colorless solid. ¹H-NMR (400 MHz, d₆-DMSO δ, ppm) 9.21 (br. s, 1H, NH), 8.80 (s, 1H), 8.36 (br. d, 1H, NH), 7.58 (d, 2H), 7.29 (s, 1H), 7.06 (d, 2H), 4.12 (m, 1H), 3.84 (s, 3H), 3.75 (s, 3H), 3.02 (dd, 1H), 2.86 (dd, 1H).

In analogy to the preparation examples detailed above, and taking account of the general information regarding the preparation of compounds of the formula (I), the following compounds were obtained with the base structures I.1-I.112 specifically listed in the table below:

| | |
|---|---|
| 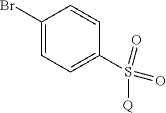 | I.1 |
| 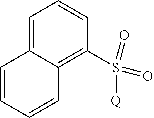 | I.2 |
| 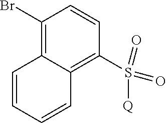 | I.3 |
| 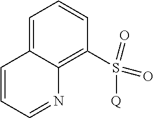 | I.4 |
| 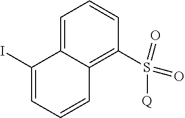 | I.5 |
| 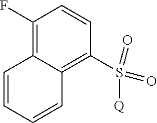 | I.6 |
| 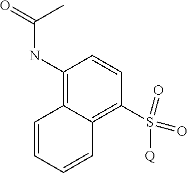 | I.7 |
| 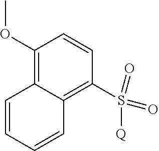 | I.8 |
| 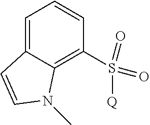 | I.9 |
| 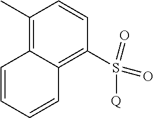 | I.10 |
| 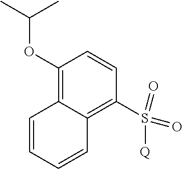 | I.11 |
| 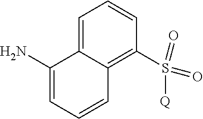 | I.12 |
| 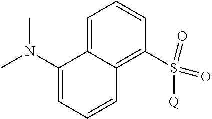 | I.13 |
| 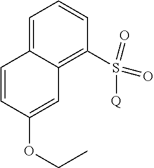 | I.14 |
| 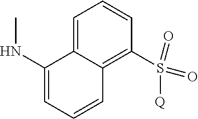 | I.15 |
| 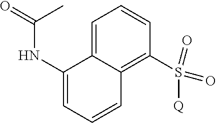 | I.16 |
| 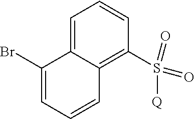 | I.17 |
| 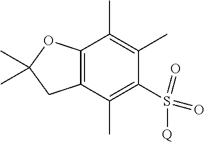 | I.18 |
| 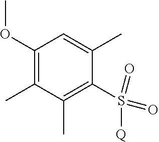 | I.19 |
| 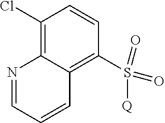 | I.20 |
| 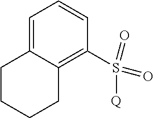 | I.21 |
| 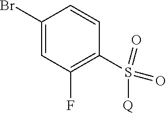 | I.22 |
| 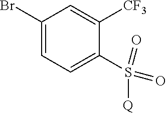 | I.23 |
| 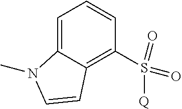 | I.24 |
| 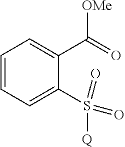 | I.25 |
| 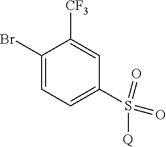 | I.26 |
| 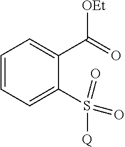 | I.27 |
| 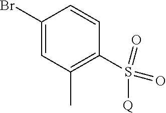 | I.28 |
| 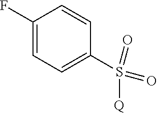 | I.29 |
| 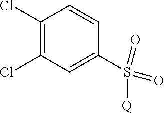 | I.30 |
| 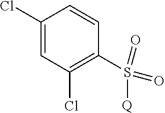 | I.31 |
| 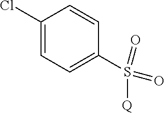 | I.32 |
| 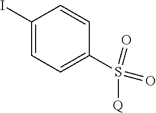 | I.33 |
| 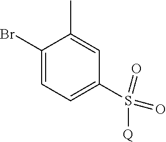 | I.34 |
| 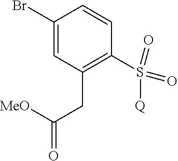 | I.35 |
| 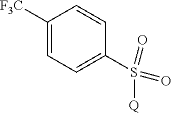 | I.36 |
| 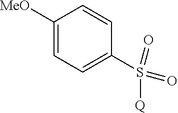 | I.37 |
| 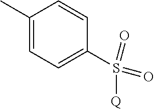 | I.38 |
| 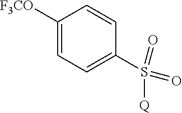 | I.39 |
| 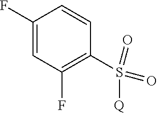 | I.40 |
| 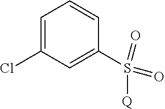 | I.41 |
| 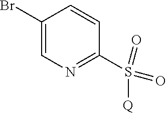 | I.42 |
| 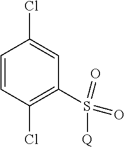 | I.43 |
| 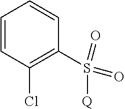 | I.44 |
| 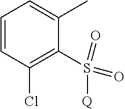 | I.45 |
| 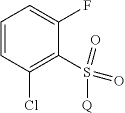 | I.46 |
| 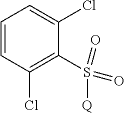 | I.47 |
| 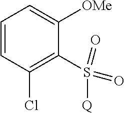 | I.48 |
| 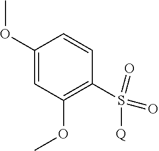 | I.49 |
| 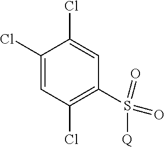 | I.50 |
| 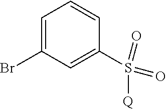 | I.51 |
| 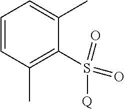 | I.52 |
| 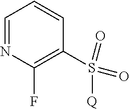 | I.53 |
| 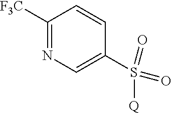 | I.54 |
| 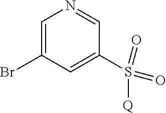 | I.55 |
| 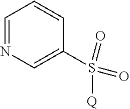 | I.56 |
| 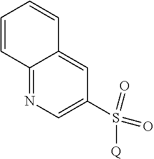 | I.57 |
| 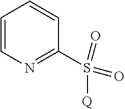 | I.58 |
| 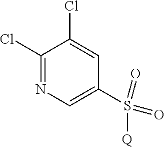 | I.59 |
| 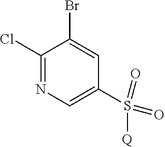 | I.60 |
| 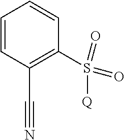 | I.61 |
| 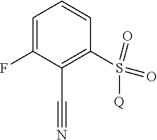 | I.62 |
| 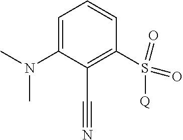 | I.63 |
| 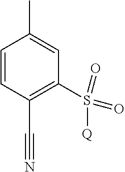 | I.64 |
| 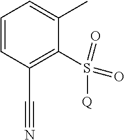 | I.65 |
| 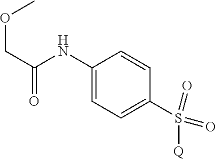 | I.66 |
| 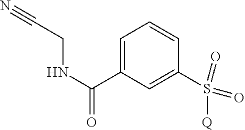 | I.67 |
| 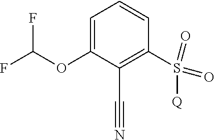 | I.68 |
| 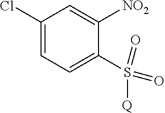 | I.69 |
| 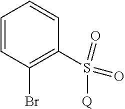 | I.70 |
| 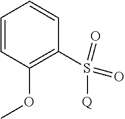 | I.71 |
| 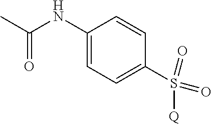 | I.72 |
| 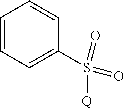 | I.73 |
| 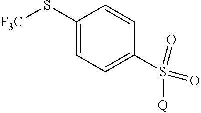 | I.74 |
| 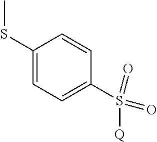 | I.75 |
| 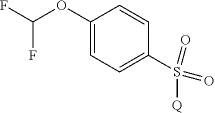 | I.76 |
| 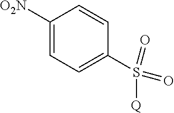 | I.77 |
| 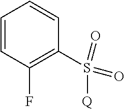 | I.78 |
| 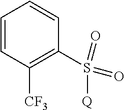 | I.79 |
| 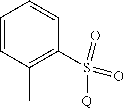 | I.80 |
| 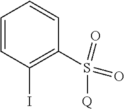 | I.81 |
| 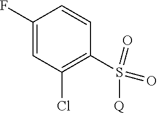 | I.82 |
| 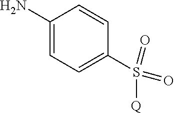 | I.83 |
| 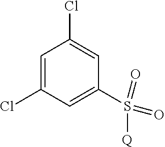 | I.84 |
| 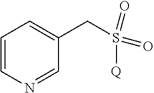 | I.85 |
| 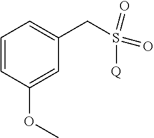 | I.86 |
| 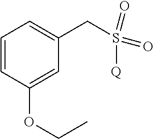 | I.87 |
| 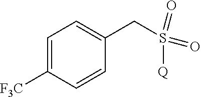 | I.88 |
| 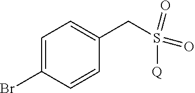 | I.89 |
| 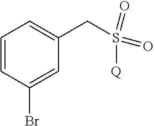 | I.90 |
| 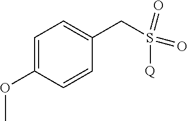 | I.91 |
| 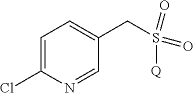 | I.92 |
| 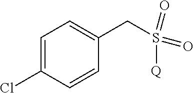 | I.93 |
| 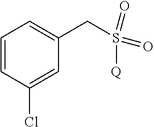 | I.94 |
| 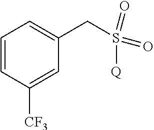 | I.95 |
| 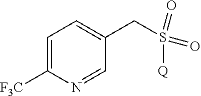 | I.96 |
| 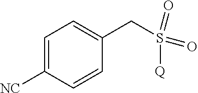 | I.97 |
| 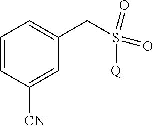 | I.98 |
| 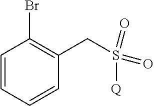 | I.99 |
| 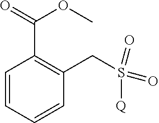 | I.100 |
| 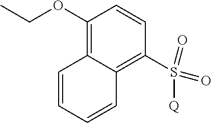 | I.101 |
| 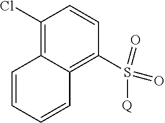 | I.102 |
| 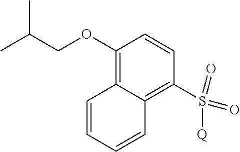 | I.103 |
| 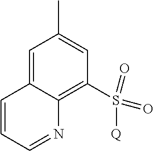 | I.104 |
| 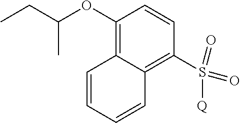 | I.105 |
| 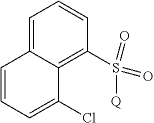 | I.106 |
| 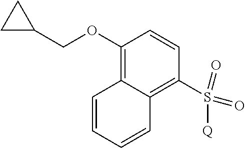 | I.107 |
| 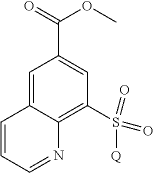 | I.108 |
| 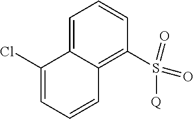 | I.109 |
| 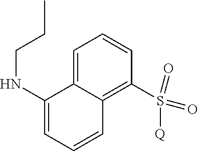 | I.110 |
| 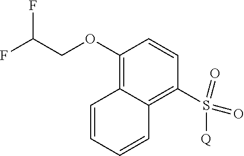 | I.111 |
| 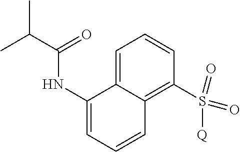 | I.112 |

TABLE 1
with basic structure I. 1 and the Q radicals listed:

| | I. | I. | I. | I. | I. | I. | I. | I. | I. | I. | I. | I. | I. | I. | I. | I. | I. | I. |
|---|---|---|---|---|---|---|---|---|---|---|---|---|---|---|---|---|---|---|
| No. | 1-1 | 1-2 | 1-3 | 1-4 | 1-5 | 1-9 | 1-11 | 1-12 | 1-13 | 1-14 | 1-21 | 1-23 | 1-24 | 1-26 | 1-28 | 1-29 | 1-33 | 1-34 |
| Q | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 |
| | I. | I. | I. | I. | I. | I. | I. | I. | I. | I. | I. | I. | I. | I. | I. | I. | I. | I. |
| No. | 1-35 | 1-36 | 1-37 | 1-38 | 1-39 | 1-40 | 1-41 | 1-42 | 1-43 | 1-44 | 1-45 | 1-46 | 1-47 | 1-48 | 1-49 | 1-50 | 1-51 | 1-54 |
| Q | Q- | Q- | Q- | Q- | Q- | Q- | Q- | Q- | Q- | Q- | Q- | Q- | Q- | Q- | Q- | Q- | Q- | Q- |
| | 1.57 | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 |
| | I. | I. | I. | I. | I. | I. | I. | I. | I. | I. | I. | I. | I. | I. | I. | I. | I. | I. |
| No. | 1-55 | 1-57 | 1-58 | 1-60 | 1-61 | 1-62 | 1-63 | 1-70 | 1-71 | 1-72 | 1-73 | 1-74 | 1-75 | 1-76 | 1-77 | 1-78 | 1-79 | 1-80 |
| Q | Q- | Q- | Q- | Q- | Q- | Q- | Q- | Q- | Q- | Q- | Q- | Q- | Q- | Q- | Q- | Q- | Q- | Q- |
| | 1.222 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |
| | | | | | I. | I. | I. | I. | I. | I. | I. | I. | I. | I. | I. | I. | I. | I. |
| | | | | No. | 1-82 | 1-83 | 1-84 | 1-86 | 1-90 | 1-91 | 1-92 | 1-93 | 1-95 | 1-103 | 1-105 | 1-106 | 1-107 | 1-108 |
| | | | | Q | Q- | Q- | Q- | Q- | Q- | Q- | Q- | Q- | Q- | Q- | Q- | Q- | Q- | Q- |
| | | | | | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 2
with basic structure I. 2 and the Q radicals listed:

| | I. | I. | I. | I. | I. | I. | I. | I. | I. | I. | I. | I. | I. | I. | I. | I. | I. | I. |
|---|---|---|---|---|---|---|---|---|---|---|---|---|---|---|---|---|---|---|
| No. | 2-1 | 2-2 | 2-3 | 2-4 | 2-5 | 2-9 | 2-11 | 2-12 | 2-13 | 2-14 | 2-21 | 2-23 | 2-24 | 2-26 | 2-28 | 2-29 | 2-33 | 2-34 |
| Q | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 21.8 | 21.10 |
| | I. | I. | I. | I. | I. | I. | I. | I. | I. | I. | I. | I. | I. | I. | I. | I. | I. | I. |
| No. | 2-35 | 2-36 | 2-37 | 2-38 | 2-39 | 2-40 | 2-41 | 2-42 | 2-43 | 2-44 | 2-45 | 2-46 | 2-47 | 2-48 | 2-49 | 2-50 | 2-51 | 2-54 |
| Q | Q- | Q- | Q- | Q- | Q- | Q- | Q- | Q- | Q- | Q- | Q- | Q- | Q- | Q- | Q- | Q- | Q- | Q- |
| | 21.9 | 24.9 | 24.8 | 24.11 | 24.7 | 24.10 | 24.3 | 24.1 | 21.12 | 22.1 | 22.2 | 22.3 | 22.4 | 22.7 | 22.8 | 22.9 | 22.10 | 22.11 |
| | I. | I. | I. | I. | I. | I. | I. | I. | I. | I. | I. | I. | I. | I. | I. | I. | I. | I. |
| | 2-55 | 2-57 | 2-58 | 2-60 | 2-61 | 2-62 | 2-63 | 2-70 | 2-71 | 2-72 | 2-73 | 2-74 | 2-75 | 2-76 | 2-77 | 2-78 | 2-79 | 2-80 |
| No. | Q- | Q- | Q- | Q- | Q- | Q- | Q- | Q- | Q- | Q- | Q- | Q- | Q- | Q- | Q- | Q- | Q- | Q- |
| Q | 1.222 | 24.5 | 24.6 | 1.220 | 1.231 | 1.238 | 1.200 | 21.18 | 21.2 | 23.5 | 1.100 | 1.113 | 1.27 | 23.2 | 1.39 | 1.120 | 1.106 | 1.45 |
| | | | I. | I. | I. | I. | I. | I. | I. | I. | I. | I. | I. | I. | I. | I. | I. | I. |
| | | No. | 2-82 | 2-83 | 2-84 | 2-86 | 2-90 | 2-91 | 2-92 | 2-93 | 2-95 | 2-103 | 2-105 | 2-106 | 2-107 | 2-108 | 2-109 | 2-110 |
| | | Q | Q- | Q- | Q- | Q- | Q- | Q- | Q- | Q- | Q- | Q- | Q- | Q- | Q- | Q- | Q- | Q- |
| | | | 1.116 | 1.99 | 1.125 | 1.93 | 1.128 | 1.134 | 1.143 | 1.190 | 1.176 | 1.234 | 1.155 | 1.110 | 1.154 | 1.266 | 1.56 | 1.57 |

TABLE 3
with basic structure I. 3 and the Q radicals listed:

| | I. | I. | I. | I. | I. | I. | I. | I. | I. | I. | I. | I. | I. | I. | I. | I. | I. | I. |
|---|---|---|---|---|---|---|---|---|---|---|---|---|---|---|---|---|---|---|
| No. | 3-1 | 3-2 | 3-3 | 3-4 | 3-5 | 3-9 | 3-11 | 3-12 | 3-13 | 3-14 | 3-21 | 3-23 | 3-24 | 3-26 | 3-28 | 3-29 | 3-33 | 3-34 |
| Q | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 21.8 | 21.10 |
| | I. | I. | I. | I. | I. | I. | I. | I. | I. | I. | I. | I. | I. | I. | I. | I. | I. | I. |
| No. | 3-35 | 3-36 | 3-37 | 3-38 | 3-39 | 3-40 | 3-41 | 3-42 | 3-43 | 3-44 | 3-45 | 3-46 | 3-47 | 3-48 | 3-49 | 3-50 | 3-51 | 3-54 |
| Q | Q- | Q- | Q- | Q- | Q- | Q- | Q- | Q- | Q- | Q- | Q- | Q- | Q- | Q- | Q- | Q- | Q- | Q- |
| | 21.9 | 24.9 | 24.8 | 24.11 | 24.7 | 24.10 | 24.3 | 24.1 | 21.12 | 22.1 | 22.2 | 22.3 | 22.4 | 22.7 | 22.8 | 22.9 | 22.10 | 22.11 |
| | I. | I. | I. | I. | I. | I. | I. | I. | I. | I. | I. | I. | I. | I. | I. | I. | I. | I. |
| No. | 3-55 | 3-57 | 3-58 | 3-60 | 3-61 | 3-62 | 3-63 | 3-70 | 3-71 | 3-72 | 3-73 | 3-74 | 3-75 | 3-76 | 3-77 | 3-78 | 3-79 | 3-80 |
| Q | Q- | Q- | Q- | Q- | Q- | Q- | Q- | Q- | Q- | Q- | Q- | Q- | Q- | Q- | Q- | Q- | Q- | Q- |
| | 1.222 | 24.5 | 24.6 | 1.220 | 1.231 | 1.238 | 1.200 | 21.18 | 21.2 | 23.5 | 1.100 | 1.113 | 1.27 | 23.2 | 1.39 | 1.120 | 1.106 | 1.45 |
| | | | I. | I. | I. | I. | I. | I. | I. | I. | I. | I. | I. | I. | I. | I. | I. | I. |
| | | No. | 3-82 | 3-83 | 3-84 | 3-86 | 3-90 | 3-91 | 3-92 | 3-93 | 3-95 | 3-103 | 3-105 | 3-106 | 3-107 | 3-108 | 3-109 | 3-110 |
| | | Q | Q- | Q- | Q- | Q- | Q- | Q- | Q- | Q- | Q- | Q- | Q- | Q- | Q- | Q- | Q- | Q- |
| | | | 1.116 | 1.99 | 1.125 | 1.93 | 1.128 | 1.134 | 1.143 | 1.190 | 1.176 | 1.234 | 1.155 | 1.110 | 1.154 | 1.266 | 1.56 | 1.57 |

TABLE 4
with basic structure I. 4 and the Q radicals listed:

| | I. | I. | I. | I. | I. | I. | I. | I. | I. | I. | I. | I. | I. | I. | I. | I. | I. | I. |
|---|---|---|---|---|---|---|---|---|---|---|---|---|---|---|---|---|---|---|
| No. | 4-1 | 4-2 | 4-3 | 4-4 | 4-5 | 4-9 | 4-11 | 4-12 | 4-13 | 4-14 | 4-21 | 4-23 | 4-24 | 4-26 | 4-28 | 4-29 | 4-33 | 4-34 |
| Q | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 21.8 | 21.10 |
| | I. | I. | I. | I. | I. | I. | I. | I. | I. | I. | I. | I. | I. | I. | I. | I. | I. | I. |
| No. | 4-35 | 4-36 | 4-37 | 4-38 | 4-39 | 4-40 | 4-41 | 4-42 | 4-43 | 4-44 | 4-45 | 4-46 | 4-47 | 4-48 | 4-49 | 4-50 | 4-51 | 4-54 |
| Q | Q- | Q- | Q- | Q- | Q- | Q- | Q- | Q- | Q- | Q- | Q- | Q- | Q- | Q- | Q- | Q- | Q- | Q- |
| | 21.9 | 24.9 | 24.8 | 24.11 | 24.7 | 24.10 | 24.3 | 24.1 | 21.12 | 22.1 | 22.2 | 22.3 | 22.4 | 22.7 | 22.8 | 22.9 | 22.10 | 22.11 |
| | I. | I. | I. | I. | I. | I. | I. | I. | I. | I. | I. | I. | I. | I. | I. | I. | I. | I. |
| No. | 4-55 | 4-57 | 4-58 | 4-60 | 4-61 | 4-62 | 4-63 | 4-70 | 4-71 | 4-72 | 4-73 | 4-74 | 4-75 | 4-76 | 4-77 | 4-78 | 4-79 | 4-80 |
| Q | Q- | Q- | Q- | Q- | Q- | Q- | Q- | Q- | Q- | Q- | Q- | Q- | Q- | Q- | Q- | Q- | Q- | Q- |
| | 1.222 | 24.5 | 24.6 | 1.220 | 1.231 | 1.238 | 1.200 | 21.18 | 21.2 | 23.5 | 1.100 | 1.113 | 1.27 | 23.2 | 1.39 | 1.120 | 1.106 | 1.45 |
| | | | I. | I. | I. | I. | I. | I. | I. | I. | I. | I. | I. | I. | I. | I. | I. | I. |
| | | No. | 4-82 | 4-83 | 4-84 | 4-86 | 4-90 | 4-91 | 4-92 | 4-93 | 4-95 | 4-103 | 4-105 | 4-106 | 4-107 | 4-108 | 4-109 | 4-110 |
| | | Q | Q- | Q- | Q- | Q- | Q- | Q- | Q- | Q- | Q- | Q- | Q- | Q- | Q- | Q- | Q- | Q- |
| | | | 1.116 | 1.99 | 1.125 | 1.93 | 1.128 | 1.134 | 1.143 | 1.190 | 1.176 | 1.234 | 1.155 | 1.110 | 1.154 | 1.266 | 1.56 | 1.57 |

TABLE 5
with basic structure I. 5 and the Q radicals listed:

| | I. | I. | I. | I. | I. | I. | I. | I. | I. | I. | I. | I. | I. | I. | I. | I. | I. | I. |
|---|---|---|---|---|---|---|---|---|---|---|---|---|---|---|---|---|---|---|
| No. | 5-1 | 5-2 | 5-3 | 5-4 | 5-5 | 5-9 | 5-11 | 5-12 | 5-13 | 5-14 | 5-21 | 5-23 | 5-24 | 5-26 | 5-28 | 5-29 | 5-33 | 5-34 |
| Q | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 21.8 | 21.10 |
| | I. | I. | I. | I. | I. | I. | I. | I. | I. | I. | I. | I. | I. | I. | I. | I. | I. | I. |
| No. | 5-35 | 5-36 | 5-37 | 5-38 | 5-39 | 5-40 | 5-41 | 5-42 | 5-43 | 5-44 | 5-45 | 5-46 | 5-47 | 5-48 | 5-49 | 5-50 | 5-51 | 5-54 |
| Q | Q- | Q- | Q- | Q- | Q- | Q- | Q- | Q- | Q- | Q- | Q- | Q- | Q- | Q- | Q- | Q- | Q- | Q- |
| | 21.9 | 24.9 | 24.8 | 24.11 | 24.7 | 24.10 | 24.3 | 24.1 | 21.12 | 22.1 | 22.2 | 22.3 | 22.4 | 22.7 | 22.8 | 22.9 | 22.10 | 22.11 |
| | I. | I. | I. | I. | I. | I. | I. | I. | I. | I. | I. | I. | I. | I. | I. | I. | I. | I. |
| No. | 5-55 | 5-57 | 5-58 | 5-60 | 5-61 | 5-62 | 5-63 | 5-70 | 5-71 | 5-72 | 5-73 | 5-74 | 5-75 | 5-76 | 5-77 | 5-78 | 5-79 | 5-80 |
| Q | Q- | Q- | Q- | Q- | Q- | Q- | Q- | Q- | Q- | Q- | Q- | Q- | Q- | Q- | Q- | Q- | Q- | Q- |
| | 1.222 | 24.5 | 24.6 | 1.220 | 1.231 | 1.238 | 1.200 | 21.18 | 21.2 | 23.5 | 1.100 | 1.113 | 1.27 | 23.2 | 1.39 | 1.120 | 1.106 | 1.45 |
| | | | I. | I. | I. | I. | I. | I. | I. | I. | I. | I. | I. | I. | I. | I. | I. | I. |
| | | No. | 5-82 | 5-83 | 5-84 | 5-86 | 5-90 | 5-91 | 5-92 | 5-93 | 5-95 | 5-103 | 5-105 | 5-106 | 5-107 | 5-108 | 5-109 | 5-110 |
| | | Q | Q- | Q- | Q- | Q- | Q- | Q- | Q- | Q- | Q- | Q- | Q- | Q- | Q- | Q- | Q- | Q- |
| | | | 1.116 | 1.99 | 1.125 | 1.93 | 1.128 | 1.134 | 1.143 | 1.190 | 1.176 | 1.234 | 1.155 | 1.110 | 1.154 | 1.266 | 1.56 | 1.57 |

TABLE 6
with basic structure I. 6 and the Q radicals listed:

| | I. | I. | I. | I. | I. | I. | I. | I. | I. | I. | I. | I. | I. | I. | I. | I. | I. | I. |
|---|---|---|---|---|---|---|---|---|---|---|---|---|---|---|---|---|---|---|
| No. | 6-1 | 6-2 | 6-3 | 6-4 | 6-5 | 6-9 | 6-11 | 6-12 | 6-13 | 6-14 | 6-21 | 6-23 | 6-24 | 6-26 | 6-28 | 6-29 | 6-33 | 6-34 |
| Q | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 21.8 | 21.10 |
| | I. | I. | I. | I. | I. | I. | I. | I. | I. | I. | I. | I. | I. | I. | I. | I. | I. | I. |
| No. | 6-35 | 6-36 | 6-37 | 6-38 | 6-39 | 6-40 | 6-41 | 6-42 | 6-43 | 6-44 | 6-45 | 6-46 | 6-47 | 6-48 | 6-49 | 6-50 | 6-51 | 6-54 |
| Q | Q- | Q- | Q- | Q- | Q- | Q- | Q- | Q- | Q- | Q- | Q- | Q- | Q- | Q- | Q- | Q- | Q- | Q- |
| | 21.9 | 24.9 | 24.8 | 24.11 | 24.7 | 24.10 | 24.3 | 24.1 | 21.12 | 22.1 | 22.2 | 22.3 | 22.4 | 22.7 | 22.8 | 22.9 | 22.10 | 22.11 |
| | I. | I. | I. | I. | I. | I. | I. | I. | I. | I. | I. | I. | I. | I. | I. | I. | I. | I. |
| No. | 6-55 | 6-57 | 6-58 | 6-60 | 6-61 | 6-62 | 6-63 | 6-70 | 6-71 | 6-72 | 6-73 | 6-74 | 6-75 | 6-76 | 6-77 | 6-78 | 6-79 | 6-80 |
| Q | Q- | Q- | Q- | Q- | Q- | Q- | Q- | Q- | Q- | Q- | Q- | Q- | Q- | Q- | Q- | Q- | Q- | Q- |
| | 1.222 | 24.5 | 24.6 | 1.220 | 1.231 | 1.238 | 1.200 | 21.18 | 21.2 | 23.5 | 1.100 | 1.113 | 1.27 | 23.2 | 1.39 | 1.120 | 1.106 | 1.45 |
| | | | I. | I. | I. | I. | I. | I. | I. | I. | I. | I. | I. | I. | I. | I. | I. | I. |
| | | No. | 6-82 | 6-83 | 6-84 | 6-86 | 6-90 | 6-91 | 6-92 | 6-93 | 6-95 | 6-103 | 6-105 | 6-106 | 6-107 | 6-108 | 6-109 | 6-110 |
| | | Q | Q- | Q- | Q- | Q- | Q- | Q- | Q- | Q- | Q- | Q- | Q- | Q- | Q- | Q- | Q- | Q- |
| | | | 1.116 | 1.99 | 1.125 | 1.93 | 1.128 | 1.134 | 1.143 | 1.190 | 1.176 | 1.234 | 1.155 | 1.110 | 1.154 | 1.266 | 1.56 | 1.57 |

TABLE 7
with basic structure I. 7 and the Q radicals listed:

| | I. | I. | I. | I. | I. | I. | I. | I. | I. | I. | I. | I. | I. | I. | I. | I. | I. | I. |
|---|---|---|---|---|---|---|---|---|---|---|---|---|---|---|---|---|---|---|
| No. | 7-1 | 7-2 | 7-3 | 7-4 | 7-5 | 7-9 | 7-11 | 7-12 | 7-13 | 7-14 | 7-21 | 7-23 | 7-24 | 7-26 | 7-28 | 7-29 | 7-33 | 7-34 |
| Q | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 21.8 | 21.10 |
| | I. | I. | I. | I. | I. | I. | I. | I. | I. | I. | I. | I. | I. | I. | I. | I. | I. | I. |
| No. | 7-35 | 7-36 | 7-37 | 7-38 | 7-39 | 7-40 | 7-41 | 7-42 | 7-43 | 7-44 | 7-45 | 7-46 | 7-47 | 7-48 | 7-49 | 7-50 | 7-51 | 7-54 |
| Q | Q- | Q- | Q- | Q- | Q- | Q- | Q- | Q- | Q- | Q- | Q- | Q- | Q- | Q- | Q- | Q- | Q- | Q- |
| | 21.9 | 24.9 | 24.8 | 24.11 | 24.7 | 24.10 | 24.3 | 24.1 | 21.12 | 22.1 | 22.2 | 22.3 | 22.4 | 22.7 | 22.8 | 22.9 | 22.10 | 22.11 |
| | I. | I. | I. | I. | I. | I. | I. | I. | I. | I. | I. | I. | I. | I. | I. | I. | I. | I. |
| No. | 7-55 | 7-57 | 7-58 | 7-60 | 7-61 | 7-62 | 7-63 | 7-70 | 7-71 | 7-72 | 7-73 | 7-74 | 7-75 | 7-76 | 7-77 | 7-78 | 7-79 | 7-80 |
| Q | Q- | Q- | Q- | Q- | Q- | Q- | Q- | Q- | Q- | Q- | Q- | Q- | Q- | Q- | Q- | Q- | Q- | Q- |
| | 1.222 | 24.5 | 24.6 | 1.220 | 1.231 | 1.238 | 1.200 | 21.18 | 21.2 | 23.5 | 1.100 | 1.113 | 1.27 | 23.2 | 1.39 | 1.120 | 1.106 | 1.45 |
| | | | I. | I. | I. | I. | I. | I. | I. | I. | I. | I. | I. | I. | I. | I. | I. | I. |
| | | No. | 7-82 | 7-83 | 7-84 | 7-86 | 7-90 | 7-91 | 7-92 | 7-93 | 7-95 | 7-103 | 7-105 | 7-106 | 7-107 | 7-108 | 7-109 | 7-110 |
| | | Q | Q- | Q- | Q- | Q- | Q- | Q- | Q- | Q- | Q- | Q- | Q- | Q- | Q- | Q- | Q- | Q- |
| | | | 1.116 | 1.99 | 1.125 | 1.93 | 1.128 | 1.134 | 1.143 | 1.190 | 1.176 | 1.234 | 1.155 | 1.110 | 1.154 | 1.266 | 1.56 | 1.57 |

TABLE 8
with basic structure I.8 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 8-1 | 8-2 | 8-3 | 8-4 | 8-5 | 8-9 | 8-11 | 8-12 | 8-13 | 8-14 | 8-21 | 8-23 | 8-24 | 8-26 | 8-28 | 8-29 | 8-33 | 8-34 | 8-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 21.8 | 21.10 | 21.9 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 8-36 | 8-37 | 8-38 | 8-39 | 8-40 | 8-41 | 8-42 | 8-43 | 8-44 | 8-45 | 8-46 | 8-47 | 8-48 | 8-49 | 8-50 | 8-51 | 8-54 | 8-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 21.12 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 8-57 | 8-58 | 8-60 | 8-61 | 8-62 | 8-63 | 8-70 | 8-71 | 8-72 | 8-73 | 8-74 | 8-75 | 8-76 | 8-77 | 8-78 | 8-79 | 8-80 | 8-82 |
| Q | Q- | Q- | Q- | Q- | Q- | Q- | Q- | Q- | Q- | Q- | Q- | Q- | Q- | Q- | Q- | Q- | Q- | Q- |
| | 24.5 | 24.6 | 1.220 | 1.231 | 1.238 | 1.200 | 21.18 | 21.2 | 23.5 | 1.100 | 1.113 | 1.27 | 23.2 | 1.39 | 1.120 | 1.106 | 1.45 | 1.116 |

| | No. | | | | | | | | | | | | | | |
|---|---|---|---|---|---|---|---|---|---|---|---|---|---|---|---|
| | I. | I. | I. | I. | I. | I. | I. | I. | I. | I. | I. | I. | I. | I. | I. |
| | 8-83 | 8-84 | 8-86 | 8-90 | 8-91 | 8-92 | 8-93 | 8-95 | 8-103 | 8-105 | 8-106 | 8-107 | 8-108 | 8-109 | 8-110 |
| Q | Q- | Q- | Q- | Q- | Q- | Q- | Q- | Q- | Q- | Q- | Q- | Q- | Q- | Q- | Q- |
| | 1.99 | 1.125 | 1.93 | 1.128 | 1.134 | 1.143 | 1.190 | 1.176 | 1.234 | 1.155 | 1.110 | 1.154 | 1.266 | 1.56 | 1.57 |

TABLE 9
with basic structure I.9 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 9-1 | 9-2 | 9-3 | 9-4 | 9-5 | 9-9 | 9-11 | 9-12 | 9-13 | 9-14 | 9-21 | 9-23 | 9-24 | 9-26 | 9-28 | 9-29 | 9-33 | 9-34 | 9-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 21.8 | 21.10 | 21.9 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 9-36 | 9-37 | 9-38 | 9-39 | 9-40 | 9-41 | 9-42 | 9-43 | 9-44 | 9-45 | 9-46 | 9-47 | 9-48 | 9-49 | 9-50 | 9-51 | 9-54 | 9-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 21.12 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 9-57 | 9-58 | 9-60 | 9-61 | 9-62 | 9-63 | 9-70 | 9-71 | 9-72 | 9-73 | 9-74 | 9-75 | 9-76 | 9-77 | 9-78 | 9-79 | 9-80 | 9-82 |
| Q | Q- | Q- | Q- | Q- | Q- | Q- | Q- | Q- | Q- | Q- | Q- | Q- | Q- | Q- | Q- | Q- | Q- | Q- |
| | 24.5 | 24.6 | 1.220 | 1.231 | 1.238 | 1.200 | 21.18 | 21.2 | 23.5 | 1.100 | 1.113 | 1.27 | 23.2 | 1.39 | 1.120 | 1.106 | 1.45 | 1.116 |

| | No. | | | | | | | | | | | | | | |
|---|---|---|---|---|---|---|---|---|---|---|---|---|---|---|---|
| | I. | I. | I. | I. | I. | I. | I. | I. | I. | I. | I. | I. | I. | I. | I. |
| | 9-83 | 9-84 | 9-86 | 9-90 | 9-91 | 9-92 | 9-93 | 9-95 | 9-103 | 9-105 | 9-106 | 9-107 | 9-108 | 9-109 | 9-110 |
| Q | Q- | Q- | Q- | Q- | Q- | Q- | Q- | Q- | Q- | Q- | Q- | Q- | Q- | Q- | Q- |
| | 1.99 | 1.125 | 1.93 | 1.128 | 1.134 | 1.143 | 1.190 | 1.176 | 1.234 | 1.155 | 1.110 | 1.154 | 1.266 | 1.56 | 1.57 |

TABLE 10
with basic structure I.10 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 10-1 | 10-2 | 10-3 | 10-4 | 10-5 | 10-9 | 10-11 | 10-12 | 10-13 | 10-14 | 10-21 | 10-23 | 10-24 | 10-26 | 10-28 | 10-29 | 10-33 | 10-34 | 10-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 21.8 | 21.10 | 21.9 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 10-36 | 10-37 | 10-38 | 10-39 | 10-40 | 10-41 | 10-42 | 10-43 | 10-44 | 10-45 | 10-46 | 10-47 | 10-48 | 10-49 | 10-50 | 10-51 | 10-54 | 10-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 21.12 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 10-57 | 10-58 | 10-60 | 10-61 | 10-62 | 10-63 | 10-70 | 10-71 | 10-72 | 10-73 | 10-74 | 10-75 | 10-76 | 10-77 | 10-78 | 10-79 | 10-80 | 10-82 |
| Q | Q- | Q- | Q- | Q- | Q- | Q- | Q- | Q- | Q- | Q- | Q- | Q- | Q- | Q- | Q- | Q- | Q- | Q- |
| | 24.5 | 24.6 | 1.220 | 1.231 | 1.238 | 1.200 | 21.18 | 21.2 | 23.5 | 1.100 | 1.113 | 1.27 | 23.2 | 1.39 | 1.120 | 1.106 | 1.45 | 1.116 |

| | No. | | | | | | | | | | | | | | |
|---|---|---|---|---|---|---|---|---|---|---|---|---|---|---|---|
| | I. | I. | I. | I. | I. | I. | I. | I. | I. | I. | I. | I. | I. | I. | I. |
| | 10-83 | 10-84 | 10-86 | 10-90 | 10-91 | 10-92 | 10-93 | 10-95 | 10-103 | 10-105 | 10-106 | 10-107 | 10-108 | 10-109 | 10-110 |
| Q | Q- | Q- | Q- | Q- | Q- | Q- | Q- | Q- | Q- | Q- | Q- | Q- | Q- | Q- | Q- |
| | 1.99 | 1.125 | 1.93 | 1.128 | 1.134 | 1.143 | 1.190 | 1.176 | 1.234 | 1.155 | 1.110 | 1.154 | 1.266 | 1.56 | 1.57 |

TABLE 11
with basic structure I.11 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 11-1 | 11-2 | 11-3 | 11-4 | 11-5 | 11-9 | 11-11 | 11-12 | 11-13 | 11-14 | 11-21 | 11-23 | 11-24 | 11-26 | 11-28 | 11-29 | 11-33 | 11-34 | 11-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 21.8 | 21.10 | 21.9 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 11-36 | 11-37 | 11-38 | 11-39 | 11-40 | 11-41 | 11-42 | 11-43 | 11-44 | 11-45 | 11-46 | 11-47 | 11-48 | 11-49 | 11-50 | 11-51 | 11-54 | 11-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 21.12 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 11-57 | 11-58 | 11-60 | 11-61 | 11-62 | 11-63 | 11-70 | 11-71 | 11-72 | 11-73 | 11-74 | 11-75 | 11-76 | 11-77 | 11-78 | 11-79 | 11-80 | 11-82 |
| Q | Q- | Q- | Q- | Q- | Q- | Q- | Q- | Q- | Q- | Q- | Q- | Q- | Q- | Q- | Q- | Q- | Q- | Q- |
| | 24.5 | 24.6 | 1.220 | 1.231 | 1.238 | 1.200 | 21.18 | 21.2 | 23.5 | 1.100 | 1.113 | 1.27 | 23.2 | 1.39 | 1.120 | 1.106 | 1.45 | 1.116 |

| | No. | | | | | | | | | | | | | | |
|---|---|---|---|---|---|---|---|---|---|---|---|---|---|---|---|
| | I. | I. | I. | I. | I. | I. | I. | I. | I. | I. | I. | I. | I. | I. | I. |
| | 11-83 | 11-84 | 11-86 | 11-90 | 11-91 | 11-92 | 11-93 | 11-95 | 11-103 | 11-105 | 11-106 | 11-107 | 11-108 | 11-109 | 11-110 |
| Q | Q- | Q- | Q- | Q- | Q- | Q- | Q- | Q- | Q- | Q- | Q- | Q- | Q- | Q- | Q- |
| | 1.99 | 1.125 | 1.93 | 1.128 | 1.134 | 1.143 | 1.190 | 1.176 | 1.234 | 1.155 | 1.110 | 1.154 | 1.266 | 1.56 | 1.57 |

TABLE 12
with basic structure I.12 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 12-1 | 12-2 | 12-3 | 12-4 | 12-5 | 12-9 | 12-11 | 12-12 | 12-13 | 12-14 | 12-21 | 12-23 | 12-24 | 12-26 | 12-28 | 12-29 | 12-33 | 12-34 | 12-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 21.8 | 21.10 | 21.9 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 12-36 | 12-37 | 12-38 | 12-39 | 12-40 | 12-41 | 12-42 | 12-43 | 12-44 | 12-45 | 12-46 | 12-47 | 12-48 | 12-49 | 12-50 | 12-51 | 12-54 | 12-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 21.12 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 12-57 | 12-58 | 12-60 | 12-61 | 12-62 | 12-63 | 12-70 | 12-71 | 12-72 | 12-73 | 12-74 | 12-75 | 12-76 | 12-77 | 12-78 | 12-79 | 12-80 | 12-82 |
| Q | Q- | Q- | Q- | Q- | Q- | Q- | Q- | Q- | Q- | Q- | Q- | Q- | Q- | Q- | Q- | Q- | Q- | Q- |
| | 24.5 | 24.6 | 1.220 | 1.231 | 1.238 | 1.200 | 21.18 | 21.2 | 23.5 | 1.100 | 1.113 | 1.27 | 23.2 | 1.39 | 1.120 | 1.106 | 1.45 | 1.116 |

| | No. | | | | | | | | | | | | | | |
|---|---|---|---|---|---|---|---|---|---|---|---|---|---|---|---|
| | I. | I. | I. | I. | I. | I. | I. | I. | I. | I. | I. | I. | I. | I. | I. |
| | 12-83 | 12-84 | 12-86 | 12-90 | 12-91 | 12-92 | 12-93 | 12-95 | 12-103 | 12-105 | 12-106 | 12-107 | 12-108 | 12-109 | 12-110 |
| Q | Q- | Q- | Q- | Q- | Q- | Q- | Q- | Q- | Q- | Q- | Q- | Q- | Q- | Q- | Q- |
| | 1.99 | 1.125 | 1.93 | 1.128 | 1.134 | 1.143 | 1.190 | 1.176 | 1.234 | 1.155 | 1.110 | 1.154 | 1.266 | 1.56 | 1.57 |

TABLE 13
with basic structure I.13 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 13-1 | 13-2 | 13-3 | 13-4 | 13-5 | 13-9 | 13-11 | 13-12 | 13-13 | 13-14 | 13-21 | 13-23 | 13-24 | 13-26 | 13-28 | 13-29 | 13-33 | 13-34 | 13-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 21.8 | 21.10 | 21.9 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 13-36 | 13-37 | 13-38 | 13-39 | 13-40 | 13-41 | 13-42 | 13-43 | 13-44 | 13-45 | 13-46 | 13-47 | 13-48 | 13-49 | 13-50 | 13-51 | 13-54 | 13-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 21.12 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 13-57 | 13-58 | 13-60 | 13-61 | 13-62 | 13-63 | 13-70 | 13-71 | 13-72 | 13-73 | 13-74 | 13-75 | 13-76 | 13-77 | 13-78 | 13-79 | 13-80 | 13-82 |
| Q | Q- | Q- | Q- | Q- | Q- | Q- | Q- | Q- | Q- | Q- | Q- | Q- | Q- | Q- | Q- | Q- | Q- | Q- |
| | 24.5 | 24.6 | 1.220 | 1.231 | 1.238 | 1.200 | 21.18 | 21.2 | 23.5 | 1.100 | 1.113 | 1.27 | 23.2 | 1.39 | 1.120 | 1.106 | 1.45 | 1.116 |

| | No. | | | | | | | | | | | | | | |
|---|---|---|---|---|---|---|---|---|---|---|---|---|---|---|---|
| | I. | I. | I. | I. | I. | I. | I. | I. | I. | I. | I. | I. | I. | I. | I. |
| | 13-83 | 13-84 | 13-86 | 13-90 | 13-91 | 13-92 | 13-93 | 13-95 | 13-103 | 13-105 | 13-106 | 13-107 | 13-108 | 13-109 | 13-110 |
| Q | Q- | Q- | Q- | Q- | Q- | Q- | Q- | Q- | Q- | Q- | Q- | Q- | Q- | Q- | Q- |
| | 1.99 | 1.125 | 1.93 | 1.128 | 1.134 | 1.143 | 1.190 | 1.176 | 1.234 | 1.155 | 1.110 | 1.154 | 1.266 | 1.56 | 1.57 |

TABLE 14
with basic structure I.14 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 14-1 | 14-2 | 14-3 | 14-4 | 14-5 | 14-9 | 14-11 | 14-12 | 14-13 | 14-14 | 14-21 | 14-23 | 14-24 | 14-26 | 14-28 | 14-29 | 14-33 | 14-34 | 14-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 21.8 | 21.10 | 21.9 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 14-36 | 14-37 | 14-38 | 14-39 | 14-40 | 14-41 | 14-42 | 14-43 | 14-44 | 14-45 | 14-46 | 14-47 | 14-48 | 14-49 | 14-50 | 14-51 | 14-54 | 14-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 21.12 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 14-57 | 14-58 | 14-60 | 14-61 | 14-62 | 14-63 | 14-70 | 14-71 | 14-72 | 14-73 | 14-74 | 14-75 | 14-76 | 14-77 | 14-78 | 14-79 | 14-80 | 14-82 |
| Q | Q- | Q- | Q- | Q- | Q- | Q- | Q- | Q- | Q- | Q- | Q- | Q- | Q- | Q- | Q- | Q- | Q- | Q- |
| | 24.5 | 24.6 | 1.220 | 1.231 | 1.238 | 1.200 | 21.18 | 21.2 | 23.5 | 1.100 | 1.113 | 1.27 | 23.2 | 1.39 | 1.120 | 1.106 | 1.45 | 1.116 |

| | No. | | | | | | | | | | | | | | |
|---|---|---|---|---|---|---|---|---|---|---|---|---|---|---|---|
| | I. | I. | I. | I. | I. | I. | I. | I. | I. | I. | I. | I. | I. | I. | I. |
| | 14-83 | 14-84 | 14-86 | 14-90 | 14-91 | 14-92 | 14-93 | 14-95 | 14-103 | 14-105 | 14-106 | 14-107 | 14-108 | 14-109 | 14-110 |
| Q | Q- | Q- | Q- | Q- | Q- | Q- | Q- | Q- | Q- | Q- | Q- | Q- | Q- | Q- | Q- |
| | 1.99 | 1.125 | 1.93 | 1.128 | 1.134 | 1.143 | 1.190 | 1.176 | 1.234 | 1.155 | 1.110 | 1.154 | 1.266 | 1.56 | 1.57 |

TABLE 15
with basic structure I.15 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 15-1 | 15-2 | 15-3 | 15-4 | 15-5 | 15-9 | 15-11 | 15-12 | 15-13 | 15-14 | 15-21 | 15-23 | 15-24 | 15-26 | 15-28 | 15-29 | 15-33 | 15-34 | 15-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 21.8 | 21.10 | 21.9 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 15-36 | 15-37 | 15-38 | 15-39 | 15-40 | 15-41 | 15-42 | 15-43 | 15-44 | 15-45 | 15-46 | 15-47 | 15-48 | 15-49 | 15-50 | 15-51 | 15-54 | 15-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 21.12 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 15-57 | 15-58 | 15-60 | 15-61 | 15-62 | 15-63 | 15-70 | 15-71 | 15-72 | 15-73 | 15-74 | 15-75 | 15-76 | 15-77 | 15-78 | 15-79 | 15-80 | 15-82 |
| Q | Q- | Q- | Q- | Q- | Q- | Q- | Q- | Q- | Q- | Q- | Q- | Q- | Q- | Q- | Q- | Q- | Q- | Q- |
| | 24.5 | 24.6 | 1.220 | 1.231 | 1.238 | 1.200 | 21.18 | 21.2 | 23.5 | 1.100 | 1.113 | 1.27 | 23.2 | 1.39 | 1.120 | 1.106 | 1.45 | 1.116 |

| | No. | | | | | | | | | | | | | | |
|---|---|---|---|---|---|---|---|---|---|---|---|---|---|---|---|
| | I. | I. | I. | I. | I. | I. | I. | I. | I. | I. | I. | I. | I. | I. | I. |
| | 15-83 | 15-84 | 15-86 | 15-90 | 15-91 | 15-92 | 15-93 | 15-95 | 15-103 | 15-105 | 15-106 | 15-107 | 15-108 | 15-109 | 15-110 |
| Q | Q- | Q- | Q- | Q- | Q- | Q- | Q- | Q- | Q- | Q- | Q- | Q- | Q- | Q- | Q- |
| | 1.99 | 1.125 | 1.93 | 1.128 | 1.134 | 1.143 | 1.190 | 1.176 | 1.234 | 1.155 | 1.110 | 1.154 | 1.266 | 1.56 | 1.57 |

TABLE 16
with basic structure I.16 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 16-1 | 16-2 | 16-3 | 16-4 | 16-5 | 16-9 | 16-11 | 16-12 | 16-13 | 16-14 | 16-21 | 16-23 | 16-24 | 16-26 | 16-28 | 16-29 | 16-33 | 16-34 | 16-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 21.8 | 21.10 | 21.9 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 16-36 | 16-37 | 16-38 | 16-39 | 16-40 | 16-41 | 16-42 | 16-43 | 16-44 | 16-45 | 16-46 | 16-47 | 16-48 | 16-49 | 16-50 | 16-51 | 16-54 | 16-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 21.12 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 16-57 | 16-58 | 16-60 | 16-61 | 16-62 | 16-63 | 16-70 | 16-71 | 16-72 | 16-73 | 16-74 | 16-75 | 16-76 | 16-77 | 16-78 | 16-79 | 16-80 | 16-82 |
| Q | Q- | Q- | Q- | Q- | Q- | Q- | Q- | Q- | Q- | Q- | Q- | Q- | Q- | Q- | Q- | Q- | Q- | Q- |
| | 24.5 | 24.6 | 1.220 | 1.231 | 1.238 | 1.200 | 21.18 | 21.2 | 23.5 | 1.100 | 1.113 | 1.27 | 23.2 | 1.39 | 1.120 | 1.106 | 1.45 | 1.116 |

| | No. | | | | | | | | | | | | | | |
|---|---|---|---|---|---|---|---|---|---|---|---|---|---|---|---|
| | I. | I. | I. | I. | I. | I. | I. | I. | I. | I. | I. | I. | I. | I. | I. |
| | 16-83 | 16-84 | 16-86 | 16-90 | 16-91 | 16-92 | 16-93 | 16-95 | 16-103 | 16-105 | 16-106 | 16-107 | 16-108 | 16-109 | 16-110 |
| Q | Q- | Q- | Q- | Q- | Q- | Q- | Q- | Q- | Q- | Q- | Q- | Q- | Q- | Q- | Q- |
| | 1.99 | 1.125 | 1.93 | 1.128 | 1.134 | 1.143 | 1.190 | 1.176 | 1.234 | 1.155 | 1.110 | 1.154 | 1.266 | 1.56 | 1.57 |

TABLE 17
with basic structure I.17 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 17-1 | 17-2 | 17-3 | 17-4 | 17-5 | 17-9 | 17-11 | 17-12 | 17-13 | 17-14 | 17-21 | 17-23 | 17-24 | 17-26 | 17-28 | 17-29 | 17-33 | 17-34 | 17-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 21.8 | 21.10 | 21.9 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 17-36 | 17-37 | 17-38 | 17-39 | 17-40 | 17-41 | 17-42 | 17-43 | 17-44 | 17-45 | 17-46 | 17-47 | 17-48 | 17-49 | 17-50 | 17-51 | 17-54 | 17-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 21.12 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 17-57 | 17-58 | 17-60 | 17-61 | 17-62 | 17-63 | 17-70 | 17-71 | 17-72 | 17-73 | 17-74 | 17-75 | 17-76 | 17-77 | 17-78 | 17-79 | 17-80 | 17-82 |
| Q | Q- | Q- | Q- | Q- | Q- | Q- | Q- | Q- | Q- | Q- | Q- | Q- | Q- | Q- | Q- | Q- | Q- | Q- |
| | 24.5 | 24.6 | 1.220 | 1.231 | 1.238 | 1.200 | 21.18 | 21.2 | 23.5 | 1.100 | 1.113 | 1.27 | 23.2 | 1.39 | 1.120 | 1.106 | 1.45 | 1.116 |

| | No. | | | | | | | | | | | | | | |
|---|---|---|---|---|---|---|---|---|---|---|---|---|---|---|---|
| | I. | I. | I. | I. | I. | I. | I. | I. | I. | I. | I. | I. | I. | I. | I. |
| | 17-83 | 17-84 | 17-86 | 17-90 | 17-91 | 17-92 | 17-93 | 17-95 | 17-103 | 17-105 | 17-106 | 17-107 | 17-108 | 17-109 | 17-110 |
| Q | Q- | Q- | Q- | Q- | Q- | Q- | Q- | Q- | Q- | Q- | Q- | Q- | Q- | Q- | Q- |
| | 1.99 | 1.125 | 1.93 | 1.128 | 1.134 | 1.143 | 1.190 | 1.176 | 1.234 | 1.155 | 1.110 | 1.154 | 1.266 | 1.56 | 1.57 |

TABLE 18
with basic structure I.18 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 18-1 | 18-2 | 18-3 | 18-4 | 18-5 | 18-9 | 18-11 | 18-12 | 18-13 | 18-14 | 18-21 | 18-23 | 18-24 | 18-26 | 18-28 | 18-29 | 18-33 | 18-34 | 18-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 18-36 | 18-37 | 18-38 | 18-39 | 18-40 | 18-41 | 18-42 | 18-43 | 18-44 | 18-45 | 18-46 | 18-47 | 18-48 | 18-49 | 18-50 | 18-51 | 18-54 | 18-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 18-56 | 18-57 | 18-58 | 18-60 | 18-61 | 18-62 | 18-63 | 18-70 | 18-71 | 18-72 | 18-73 | 18-74 | 18-75 | 18-76 | 18-77 | 18-78 | 18-79 | 18-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 18-82 | 18-83 | 18-84 | 18-86 | 18-90 | 18-91 | 18-92 | 18-93 | 18-95 | 18-103 | 18-105 | 18-106 | 18-107 | 18-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 19
with basic structure I.19 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 19-1 | 19-2 | 19-3 | 19-4 | 19-5 | 19-9 | 19-11 | 19-12 | 19-13 | 19-14 | 19-21 | 19-23 | 19-24 | 19-26 | 19-28 | 19-29 | 19-33 | 19-34 | 19-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 19-36 | 19-37 | 19-38 | 19-39 | 19-40 | 19-41 | 19-42 | 19-43 | 19-44 | 19-45 | 19-46 | 19-47 | 19-48 | 19-49 | 19-50 | 19-51 | 19-54 | 19-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 19-56 | 19-57 | 19-58 | 19-60 | 19-61 | 19-62 | 19-63 | 19-70 | 19-71 | 19-72 | 19-73 | 19-74 | 19-75 | 19-76 | 19-77 | 19-78 | 19-79 | 19-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 19-82 | 19-83 | 19-84 | 19-86 | 19-90 | 19-91 | 19-92 | 19-93 | 19-95 | 19-103 | 19-105 | 19-106 | 19-107 | 19-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 20
with basic structure I.20 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 20-1 | 20-2 | 20-3 | 20-4 | 20-5 | 20-9 | 20-11 | 20-12 | 20-13 | 20-14 | 20-21 | 20-23 | 20-24 | 20-26 | 20-28 | 20-29 | 20-33 | 20-34 | 20-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 21.8 | 21.10 | 21.9 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 20-36 | 20-37 | 20-38 | 20-39 | 20-40 | 20-41 | 20-42 | 20-43 | 20-44 | 20-45 | 20-46 | 20-47 | 20-48 | 20-49 | 20-50 | 20-51 | 20-54 | 20-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 21.12 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 20-57 | 20-58 | 20-60 | 20-61 | 20-62 | 20-63 | 20-70 | 20-71 | 20-72 | 20-73 | 20-74 | 20-75 | 20-76 | 20-77 | 20-78 | 20-79 | 20-80 | 20-82 |
| Q | Q- | Q- | Q- | Q- | Q- | Q- | Q- | Q- | Q- | Q- | Q- | Q- | Q- | Q- | Q- | Q- | Q- | Q- |
| | 24.5 | 24.6 | 1.220 | 1.231 | 1.238 | 1.200 | 21.18 | 21.2 | 23.5 | 1.100 | 1.113 | 1.27 | 23.2 | 1.39 | 1.120 | 1.106 | 1.45 | 1.116 |

| | No. | | | | | | | | | | | | | | |
|---|---|---|---|---|---|---|---|---|---|---|---|---|---|---|---|
| | I. | I. | I. | I. | I. | I. | I. | I. | I. | I. | I. | I. | I. | I. | I. |
| | 20-83 | 20-84 | 20-86 | 20-90 | 20-91 | 20-92 | 20-93 | 20-95 | 20-103 | 20-105 | 20-106 | 20-107 | 20-108 | 20-109 | 20-110 |
| Q | Q- | Q- | Q- | Q- | Q- | Q- | Q- | Q- | Q- | Q- | Q- | Q- | Q- | Q- | Q- |
| | 1.99 | 1.125 | 1.93 | 1.128 | 1.134 | 1.143 | 1.190 | 1.176 | 1.234 | 1.155 | 1.110 | 1.154 | 1.266 | 1.56 | 1.57 |

TABLE 21
with basic structure I.21 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 21-1 | 21-2 | 21-3 | 21-4 | 21-5 | 21-9 | 21-11 | 21-12 | 21-13 | 21-14 | 21-21 | 21-23 | 21-24 | 21-26 | 21-28 | 21-29 | 21-33 | 21-34 | 21-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 21-36 | 21-37 | 21-38 | 21-39 | 21-40 | 21-41 | 21-42 | 21-43 | 21-44 | 21-45 | 21-46 | 21-47 | 21-48 | 21-49 | 21-50 | 21-51 | 21-54 | 21-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 21-56 | 21-57 | 21-58 | 21-60 | 21-61 | 21-62 | 21-63 | 21-70 | 21-71 | 21-72 | 21-73 | 21-74 | 21-75 | 21-76 | 21-77 | 21-78 | 21-79 | 21-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 21-82 | 21-83 | 21-84 | 21-86 | 21-90 | 21-91 | 21-92 | 21-93 | 21-95 | 21-103 | 21-105 | 21-106 | 21-107 | 21-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 22
with basic structure I.22 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 22-1 | 22-2 | 22-3 | 22-4 | 22-5 | 22-9 | 22-11 | 22-12 | 22-13 | 22-14 | 22-21 | 22-23 | 22-24 | 22-26 | 22-28 | 22-29 | 22-33 | 22-34 | 22-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 22-36 | 22-37 | 22-38 | 22-39 | 22-40 | 22-41 | 22-42 | 22-43 | 22-44 | 22-45 | 22-46 | 22-47 | 22-48 | 22-49 | 22-50 | 22-51 | 22-54 | 22-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 22-56 | 22-57 | 22-58 | 22-60 | 22-61 | 22-62 | 22-63 | 22-70 | 22-71 | 22-72 | 22-73 | 22-74 | 22-75 | 22-76 | 22-77 | 22-78 | 22-79 | 22-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 22-82 | 22-83 | 22-84 | 22-86 | 22-90 | 22-91 | 22-92 | 22-93 | 22-95 | 22-103 | 22-105 | 22-106 | 22-107 | 22-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 23
with basic structure I.23 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 23-1 | 23-2 | 23-3 | 23-4 | 23-5 | 23-9 | 23-11 | 23-12 | 23-13 | 23-14 | 23-21 | 23-23 | 23-24 | 23-26 | 23-28 | 23-29 | 23-33 | 23-34 | 23-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 23-36 | 23-37 | 23-38 | 23-39 | 23-40 | 23-41 | 23-42 | 23-43 | 23-44 | 23-45 | 23-46 | 23-47 | 23-48 | 23-49 | 23-50 | 23-51 | 23-54 | 23-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 23-56 | 23-57 | 23-58 | 23-60 | 23-61 | 23-62 | 23-63 | 23-70 | 23-71 | 23-72 | 23-73 | 23-74 | 23-75 | 23-76 | 23-77 | 23-78 | 23-79 | 23-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 23-82 | 23-83 | 23-84 | 23-86 | 23-90 | 23-91 | 23-92 | 23-93 | 23-95 | 23-103 | 23-105 | 23-106 | 23-107 | 23-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 24
with basic structure I.24 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 24-1 | 24-2 | 24-3 | 24-4 | 24-5 | 24-9 | 24-11 | 24-12 | 24-13 | 24-14 | 24-21 | 24-23 | 24-24 | 24-26 | 24-28 | 24-29 | 24-33 | 24-34 | 24-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 21.8 | 21.10 | 21.9 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 24-36 | 24-37 | 24-38 | 24-39 | 24-40 | 24-41 | 24-42 | 24-43 | 24-44 | 24-45 | 24-46 | 24-47 | 24-48 | 24-49 | 24-50 | 24-51 | 24-54 | 24-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 21.12 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 24-57 | 24-58 | 24-60 | 24-61 | 24-62 | 24-63 | 24-70 | 24-71 | 24-72 | 24-73 | 24-74 | 24-75 | 24-76 | 24-77 | 24-78 | 24-79 | 24-80 | 24-82 |
| Q | Q- | Q- | Q- | Q- | Q- | Q- | Q- | Q- | Q- | Q- | Q- | Q- | Q- | Q- | Q- | Q- | Q- | Q- |
| | 24.5 | 24.6 | 1.220 | 1.231 | 1.238 | 1.200 | 21.18 | 21.2 | 23.5 | 1.100 | 1.113 | 1.27 | 23.2 | 1.39 | 1.120 | 1.106 | 1.45 | 1.116 |

| | No. | | | | | | | | | | | | |
|---|---|---|---|---|---|---|---|---|---|---|---|---|---|
| | I. | I. | I. | I. | I. | I. | I. | I. | I. | I. | I. | I. | I. |
| | 24-83 | 24-84 | 24-86 | 24-90 | 24-91 | 24-92 | 24-93 | 24-95 | 24-103 | 24-105 | 24-106 | 24-107 | 24-108 |
| Q | Q- | Q- | Q- | Q- | Q- | Q- | Q- | Q- | Q- | Q- | Q- | Q- | Q- |
| | 1.99 | 1.125 | 1.93 | 1.128 | 1.134 | 1.143 | 1.190 | 1.176 | 1.234 | 1.155 | 1.110 | 1.154 | 1.266 |

TABLE 25
with basic structure I.25 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 25-1 | 25-2 | 25-3 | 25-4 | 25-5 | 25-9 | 25-11 | 25-12 | 25-13 | 25-14 | 25-21 | 25-23 | 25-24 | 25-26 | 25-28 | 25-29 | 25-33 | 25-34 | 25-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 25-36 | 25-37 | 25-38 | 25-39 | 25-40 | 25-41 | 25-42 | 25-43 | 25-44 | 25-45 | 25-46 | 25-47 | 25-48 | 25-49 | 25-50 | 25-51 | 25-54 | 25-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 25-56 | 25-57 | 25-58 | 25-60 | 25-61 | 25-62 | 25-63 | 25-70 | 25-71 | 25-72 | 25-73 | 25-74 | 25-75 | 25-76 | 25-77 | 25-78 | 25-79 | 25-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 25-82 | 25-83 | 25-84 | 25-86 | 25-90 | 25-91 | 25-92 | 25-93 | 25-95 | 25-103 | 25-105 | 25-106 | 25-107 | 25-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 26
with basic structure I.26 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 26-1 | 26-2 | 26-3 | 26-4 | 26-5 | 26-9 | 26-11 | 26-12 | 26-13 | 26-14 | 26-21 | 26-23 | 26-24 | 26-26 | 26-28 | 26-29 | 26-33 | 26-34 | 26-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 26-36 | 26-37 | 26-38 | 26-39 | 26-40 | 26-41 | 26-42 | 26-43 | 26-44 | 26-45 | 26-46 | 26-47 | 26-48 | 26-49 | 26-50 | 26-51 | 26-54 | 26-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 26-56 | 26-57 | 26-58 | 26-60 | 26-61 | 26-62 | 26-63 | 26-70 | 26-71 | 26-72 | 26-73 | 26-74 | 26-75 | 26-76 | 26-77 | 26-78 | 26-79 | 26-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 26-82 | 26-83 | 26-84 | 26-86 | 26-90 | 26-91 | 26-92 | 26-93 | 26-95 | 26-103 | 26-105 | 26-106 | 26-107 | 26-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 27
with basic structure I.27 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 27-1 | 27-2 | 27-3 | 27-4 | 27-5 | 27-9 | 27-11 | 27-12 | 27-13 | 27-14 | 27-21 | 27-23 | 27-24 | 27-26 | 27-28 | 27-29 | 27-33 | 27-34 | 27-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 27-36 | 27-37 | 27-38 | 27-39 | 27-40 | 27-41 | 27-42 | 27-43 | 27-44 | 27-45 | 27-46 | 27-47 | 27-48 | 27-49 | 27-50 | 27-51 | 27-54 | 27-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 27-56 | 27-57 | 27-58 | 27-60 | 27-61 | 27-62 | 27-63 | 27-70 | 27-71 | 27-72 | 27-73 | 27-74 | 27-75 | 27-76 | 27-77 | 27-78 | 27-79 | 27-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 27-82 | 27-83 | 27-84 | 27-86 | 27-90 | 27-91 | 27-92 | 27-93 | 27-95 | 27-103 | 27-105 | 27-106 | 27-107 | 27-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 28
with basic structure I.28 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 28-1 | 28-2 | 28-3 | 28-4 | 28-5 | 28-9 | 28-11 | 28-12 | 28-13 | 28-14 | 28-21 | 28-23 | 28-24 | 28-26 | 28-28 | 28-29 | 28-33 | 28-34 | 28-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 28-36 | 28-37 | 28-38 | 28-39 | 28-40 | 28-41 | 28-42 | 28-43 | 28-44 | 28-45 | 28-46 | 28-47 | 28-48 | 28-49 | 28-50 | 28-51 | 28-54 | 28-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 28-56 | 28-57 | 28-58 | 28-60 | 28-61 | 28-62 | 28-63 | 28-70 | 28-71 | 28-72 | 28-73 | 28-74 | 28-75 | 28-76 | 28-77 | 28-78 | 28-79 | 28-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 28-82 | 28-83 | 28-84 | 28-86 | 28-90 | 28-91 | 28-92 | 28-93 | 28-95 | 28-103 | 28-105 | 28-106 | 28-107 | 28-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 29
with basic structure I.29 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 29-1 | 29-2 | 29-3 | 29-4 | 29-5 | 29-9 | 29-11 | 29-12 | 29-13 | 29-14 | 29-21 | 29-23 | 29-24 | 29-26 | 29-28 | 29-29 | 29-33 | 29-34 | 29-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 29-36 | 29-37 | 29-38 | 29-39 | 29-40 | 29-41 | 29-42 | 29-43 | 29-44 | 29-45 | 29-46 | 29-47 | 29-48 | 29-49 | 29-50 | 29-51 | 29-54 | 29-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 29-56 | 29-57 | 29-58 | 29-60 | 29-61 | 29-62 | 29-63 | 29-70 | 29-71 | 29-72 | 29-73 | 29-74 | 29-75 | 29-76 | 29-77 | 29-78 | 29-79 | 29-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 29-82 | 29-83 | 29-84 | 29-86 | 29-90 | 29-91 | 29-92 | 29-93 | 29-95 | 29-103 | 29-105 | 29-106 | 29-107 | 29-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 30
with basic structure I.30 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 30-1 | 30-2 | 30-3 | 30-4 | 30-5 | 30-9 | 30-11 | 30-12 | 30-13 | 30-14 | 30-21 | 30-23 | 30-24 | 30-26 | 30-28 | 30-29 | 30-33 | 30-34 | 30-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 30-36 | 30-37 | 30-38 | 30-39 | 30-40 | 30-41 | 30-42 | 30-43 | 30-44 | 30-45 | 30-46 | 30-47 | 30-48 | 30-49 | 30-50 | 30-51 | 30-54 | 30-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 30-56 | 30-57 | 30-58 | 30-60 | 30-61 | 30-62 | 30-63 | 30-70 | 30-71 | 30-72 | 30-73 | 30-74 | 30-75 | 30-76 | 30-77 | 30-78 | 30-79 | 30-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 30-82 | 30-83 | 30-84 | 30-86 | 30-90 | 30-91 | 30-92 | 30-93 | 30-95 | 30-103 | 30-105 | 30-106 | 30-107 | 30-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 31
with basic structure I.31 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 27-1 | 31-2 | 31-3 | 31-4 | 31-5 | 31-9 | 31-11 | 31-12 | 31-13 | 31-14 | 31-21 | 31-23 | 31-24 | 31-26 | 31-28 | 31-29 | 31-33 | 31-34 | 31-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 31-36 | 31-37 | 31-38 | 31-39 | 31-40 | 31-41 | 31-42 | 31-43 | 31-44 | 31-45 | 31-46 | 31-47 | 31-48 | 31-49 | 31-50 | 31-51 | 31-54 | 31-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 31-56 | 31-57 | 31-58 | 31-60 | 31-61 | 31-62 | 31-63 | 31-70 | 31-71 | 31-72 | 31-73 | 31-74 | 31-75 | 31-76 | 31-77 | 31-78 | 31-79 | 31-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 31-82 | 31-83 | 31-84 | 31-86 | 31-90 | 31-91 | 31-92 | 31-93 | 31-95 | 31-103 | 31-105 | 31-106 | 31-107 | 31-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 32
with basic structure I.32 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 32-1 | 32-2 | 32-3 | 32-4 | 32-5 | 32-9 | 32-11 | 32-12 | 32-13 | 32-14 | 32-21 | 32-23 | 32-24 | 32-26 | 32-28 | 32-29 | 32-33 | 32-34 | 32-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 32-36 | 32-37 | 32-38 | 32-39 | 32-40 | 32-41 | 32-42 | 32-43 | 32-44 | 32-45 | 32-46 | 32-47 | 32-48 | 32-49 | 32-50 | 32-51 | 32-54 | 32-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 32-56 | 32-57 | 32-58 | 32-60 | 32-61 | 32-62 | 32-63 | 32-70 | 32-71 | 32-72 | 32-73 | 32-74 | 32-75 | 32-76 | 32-77 | 32-78 | 32-79 | 32-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 32-82 | 32-83 | 32-84 | 32-86 | 32-90 | 32-91 | 32-92 | 32-93 | 32-95 | 32-103 | 32-105 | 32-106 | 32-107 | 32-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 33
with basic structure I.33 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 33-1 | 33-2 | 33-3 | 33-4 | 33-5 | 33-9 | 33-11 | 33-12 | 33-13 | 33-14 | 33-21 | 33-23 | 33-24 | 33-26 | 33-28 | 33-29 | 33-33 | 33-34 | 33-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 33-36 | 33-37 | 33-38 | 33-39 | 33-40 | 33-41 | 33-42 | 33-43 | 33-44 | 33-45 | 33-46 | 33-47 | 33-48 | 33-49 | 33-50 | 33-51 | 33-54 | 33-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 33-56 | 33-57 | 33-58 | 33-60 | 33-61 | 33-62 | 33-63 | 33-70 | 33-71 | 33-72 | 33-73 | 33-74 | 33-75 | 33-76 | 33-77 | 33-78 | 33-79 | 33-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 33-82 | 33-83 | 33-84 | 33-86 | 33-90 | 33-91 | 33-92 | 33-93 | 33-95 | 33-103 | 33-105 | 33-106 | 33-107 | 33-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 34
with basic structure I.34 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 34-1 | 34-2 | 34-3 | 34-4 | 34-5 | 34-9 | 34-11 | 34-12 | 34-13 | 34-14 | 34-21 | 34-23 | 34-24 | 34-26 | 34-28 | 34-29 | 34-33 | 34-34 | 34-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 34-36 | 34-37 | 34-38 | 34-39 | 34-40 | 34-41 | 34-42 | 34-43 | 34-44 | 34-45 | 34-46 | 34-47 | 34-48 | 34-49 | 34-50 | 34-51 | 34-54 | 34-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 34-56 | 34-57 | 34-58 | 34-60 | 34-61 | 34-62 | 34-63 | 34-70 | 34-71 | 34-72 | 34-73 | 34-74 | 34-75 | 34-76 | 34-77 | 34-78 | 34-79 | 34-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 34-82 | 34-83 | 34-84 | 34-86 | 34-90 | 34-91 | 34-92 | 34-93 | 34-95 | 34-103 | 34-105 | 34-106 | 34-107 | 34-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 35
with basic structure I.35 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 35-1 | 35-2 | 35-3 | 35-4 | 35-5 | 35-9 | 35-11 | 35-12 | 35-13 | 35-14 | 35-21 | 35-23 | 35-24 | 35-26 | 35-28 | 35-29 | 35-33 | 35-34 | 35-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 35-36 | 35-37 | 35-38 | 35-39 | 35-40 | 35-41 | 35-42 | 35-43 | 35-44 | 35-45 | 35-46 | 35-47 | 35-48 | 35-49 | 35-50 | 35-51 | 35-54 | 35-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 35-56 | 35-57 | 35-58 | 35-60 | 35-61 | 35-62 | 35-63 | 35-70 | 35-71 | 35-72 | 35-73 | 35-74 | 35-75 | 35-76 | 35-77 | 35-78 | 35-79 | 35-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 35-82 | 35-83 | 35-84 | 35-86 | 35-90 | 35-91 | 35-92 | 35-93 | 35-95 | 35-103 | 35-105 | 35-106 | 35-107 | 35-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 36
with basic structure I.36 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 36-1 | 36-2 | 36-3 | 36-4 | 36-5 | 36-9 | 36-11 | 36-12 | 36-13 | 36-14 | 36-21 | 36-23 | 36-24 | 36-26 | 36-28 | 36-29 | 36-33 | 36-34 | 36-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 36-36 | 36-37 | 36-38 | 36-39 | 36-40 | 36-41 | 36-42 | 36-43 | 36-44 | 36-45 | 36-46 | 36-47 | 36-48 | 36-49 | 36-50 | 36-51 | 36-54 | 36-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 36-56 | 36-57 | 36-58 | 36-60 | 36-61 | 36-62 | 36-63 | 36-70 | 36-71 | 36-72 | 36-73 | 36-74 | 36-75 | 36-76 | 36-77 | 36-78 | 36-79 | 36-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 36-82 | 36-83 | 36-84 | 36-86 | 36-90 | 36-91 | 36-92 | 36-93 | 36-95 | 36-103 | 36-105 | 36-106 | 36-107 | 36-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 37
with basic structure I.37 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 37-1 | 37-2 | 37-3 | 37-4 | 37-5 | 37-9 | 37-11 | 37-12 | 37-13 | 37-14 | 37-21 | 37-23 | 37-24 | 37-26 | 37-28 | 37-29 | 37-33 | 37-34 | 37-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I |
| | 37-36 | 37-37 | 37-38 | 37-39 | 37-40 | 37-41 | 37-42 | 37-43 | 37-44 | 37-45 | 37-46 | 37-47 | 37-48 | 37-49 | 37-50 | 37-51 | 37-54 | 37-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I | I | I | I | I | I | I | I | I | I | I | I | I | I | I | I | I | I |
| | 37-56 | 37-57 | 37-58 | 37-60 | 37-61 | 37-62 | 37-63 | 37-70 | 37-71 | 37-72 | 37-73 | 37-74 | 37-75 | 37-76 | 37-77 | 37-78 | 37-79 | 37-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I | I. | I. | I. | I. | I. | I. | I. | I. | I. | I. | I. | I. | I. |
| | 37-82 | 37-83 | 37-84 | 37-86 | 37-90 | 37-91 | 37-92 | 37-93 | 37-95 | 37-103 | 37-105 | 37-106 | 37-107 | 37-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 38
with basic structure I.38 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 38-1 | 38-2 | 38-3 | 38-4 | 38-5 | 38-9 | 38-11 | 38-12 | 38-13 | 38-14 | 38-21 | 38-23 | 38-24 | 38-26 | 38-28 | 38-29 | 38-33 | 38-34 | 38-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 38-36 | 38-37 | 38-38 | 38-39 | 38-40 | 38-41 | 38-42 | 38-43 | 38-44 | 38-45 | 38-46 | 38-47 | 38-48 | 38-49 | 38-50 | 38-51 | 38-54 | 38-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 38-56 | 38-57 | 38-58 | 38-60 | 38-61 | 38-62 | 38-63 | 38-70 | 38-71 | 38-72 | 38-73 | 38-74 | 38-75 | 38-76 | 38-77 | 38-78 | 38-79 | 38-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 38-82 | 38-83 | 38-84 | 38-86 | 38-90 | 38-91 | 38-92 | 38-93 | 38-95 | 38-103 | 38-105 | 38-106 | 38-107 | 38-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 39
with basic structure I.39 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 39-1 | 39-2 | 39-3 | 39-4 | 39-5 | 39-9 | 39-11 | 39-12 | 39-13 | 39-14 | 39-21 | 39-23 | 39-24 | 39-26 | 39-28 | 39-29 | 39-33 | 39-34 | 39-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 39-36 | 39-37 | 39-38 | 39-39 | 39-40 | 39-41 | 39-42 | 39-43 | 39-44 | 39-45 | 39-46 | 39-47 | 39-48 | 39-49 | 39-50 | 39-51 | 39-54 | 39-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 39-56 | 39-57 | 39-58 | 39-60 | 39-61 | 39-62 | 39-63 | 39-70 | 39-71 | 39-72 | 39-73 | 39-74 | 39-75 | 39-76 | 39-77 | 39-78 | 39-79 | 39-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 39-82 | 39-83 | 39-84 | 39-86 | 39-90 | 39-91 | 39-92 | 39-93 | 39-95 | 39-103 | 39-105 | 39-106 | 39-107 | 39-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 40
with basic structure I.40 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 40-1 | 40-2 | 40-3 | 40-4 | 40-5 | 40-9 | 40-11 | 40-12 | 40-13 | 40-14 | 40-21 | 40-23 | 40-24 | 40-26 | 40-28 | 40-29 | 40-33 | 40-34 | 40-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 40-36 | 40-37 | 40-38 | 40-39 | 40-40 | 40-41 | 40-42 | 40-43 | 40-44 | 40-45 | 40-46 | 40-47 | 40-48 | 40-49 | 40-50 | 40-51 | 40-54 | 40-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 40-56 | 40-57 | 40-58 | 40-60 | 40-61 | 40-62 | 40-63 | 40-70 | 40-71 | 40-72 | 40-73 | 40-74 | 40-75 | 40-76 | 40-77 | 40-78 | 40-79 | 40-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 40-82 | 40-83 | 40-84 | 40-86 | 40-90 | 40-91 | 40-92 | 40-93 | 40-95 | 40-103 | 40-105 | 40-106 | 40-107 | 40-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 41
with basic structure I.41 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 41-1 | 41-2 | 41-3 | 41-4 | 41-5 | 41-9 | 41-11 | 41-12 | 41-13 | 41-14 | 41-21 | 41-23 | 41-24 | 41-26 | 41-28 | 41-29 | 41-33 | 41-34 | 41-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 41-36 | 41-37 | 41-38 | 41-39 | 41-40 | 41-41 | 41-42 | 41-43 | 41-44 | 41-45 | 41-46 | 41-47 | 41-48 | 41-49 | 41-50 | 41-51 | 41-54 | 41-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 41-56 | 41-57 | 41-58 | 41-60 | 41-61 | 41-62 | 41-63 | 41-70 | 41-71 | 41-72 | 41-73 | 41-74 | 41-75 | 41-76 | 41-77 | 41-78 | 41-79 | 41-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 41-82 | 41-83 | 41-84 | 41-86 | 41-90 | 41-91 | 41-92 | 41-93 | 41-95 | 41-103 | 41-105 | 41-106 | 41-107 | 41-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 42
with basic structure I.42 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 42-1 | 42-2 | 42-3 | 42-4 | 42-5 | 42-9 | 42-11 | 42-12 | 42-13 | 42-14 | 42-21 | 42-23 | 42-24 | 42-26 | 42-28 | 42-29 | 42-33 | 42-34 | 42-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 42-36 | 42-37 | 42-38 | 42-39 | 42-40 | 42-41 | 42-42 | 42-43 | 42-44 | 42-45 | 42-46 | 42-47 | 42-48 | 42-49 | 42-50 | 42-51 | 42-54 | 42-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 42-56 | 42-57 | 42-58 | 42-60 | 42-61 | 42-62 | 42-63 | 42-70 | 42-71 | 42-72 | 42-73 | 42-74 | 42-75 | 42-76 | 42-77 | 42-78 | 42-79 | 42-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 42-82 | 42-83 | 42-84 | 42-86 | 42-90 | 42-91 | 42-92 | 42-93 | 42-95 | 42-103 | 42-105 | 42-106 | 42-107 | 42-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 43
with basic structure I.43 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 43-1 | 43-2 | 43-3 | 43-4 | 43-5 | 43-9 | 43-11 | 43-12 | 43-13 | 43-14 | 43-21 | 43-23 | 43-24 | 43-26 | 43-28 | 43-29 | 43-33 | 43-34 | 43-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 43-36 | 43-37 | 43-38 | 43-39 | 43-40 | 43-41 | 43-42 | 43-43 | 43-44 | 43-45 | 43-46 | 43-47 | 43-48 | 43-49 | 43-50 | 43-51 | 43-54 | 43-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 43-56 | 43-57 | 43-58 | 43-60 | 43-61 | 43-62 | 43-63 | 43-70 | 43-71 | 43-72 | 43-73 | 43-74 | 43-75 | 43-76 | 43-77 | 43-78 | 43-79 | 43-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 43-82 | 43-83 | 43-84 | 43-86 | 43-90 | 43-91 | 43-92 | 43-93 | 43-95 | 43-103 | 43-105 | 43-106 | 43-107 | 43-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 44
with basic structure I.44 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 44-1 | 44-2 | 44-3 | 44-4 | 44-5 | 44-9 | 44-11 | 44-12 | 44-13 | 44-14 | 44-21 | 44-23 | 44-24 | 44-26 | 44-28 | 44-29 | 44-33 | 44-34 | 44-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 44-36 | 44-37 | 44-38 | 44-39 | 44-40 | 44-41 | 44-42 | 44-43 | 44-44 | 44-45 | 44-46 | 44-47 | 44-48 | 44-49 | 44-50 | 44-51 | 44-54 | 44-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 44-56 | 44-57 | 44-58 | 44-60 | 44-61 | 44-62 | 44-63 | 44-70 | 44-71 | 44-72 | 44-73 | 44-74 | 44-75 | 44-76 | 44-77 | 44-78 | 44-79 | 44-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 44-82 | 44-83 | 44-84 | 44-86 | 44-90 | 44-91 | 44-92 | 44-93 | 44-95 | 44-103 | 44-105 | 44-106 | 44-107 | 44-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 45
with basic structure I.45 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 45-1 | 45-2 | 45-3 | 45-4 | 45-5 | 45-9 | 45-11 | 45-12 | 45-13 | 45-14 | 45-21 | 45-23 | 45-24 | 45-26 | 45-28 | 45-29 | 45-33 | 45-34 | 45-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 45-36 | 45-37 | 45-38 | 45-39 | 45-40 | 45-41 | 45-42 | 45-43 | 45-44 | 45-45 | 45-46 | 45-47 | 45-48 | 45-49 | 45-50 | 45-51 | 45-54 | 45-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 45-56 | 45-57 | 45-58 | 45-60 | 45-61 | 45-62 | 45-63 | 45-70 | 45-71 | 45-72 | 45-73 | 45-74 | 45-75 | 45-76 | 45-77 | 45-78 | 45-79 | 45-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 45-82 | 45-83 | 45-84 | 45-86 | 45-90 | 45-91 | 45-92 | 45-93 | 45-95 | 45-103 | 45-105 | 45-106 | 45-107 | 45-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 46
with basic structure I.46 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 46-1 | 46-2 | 46-3 | 46-4 | 46-5 | 46-9 | 46-11 | 46-12 | 46-13 | 46-14 | 46-21 | 46-23 | 46-24 | 46-26 | 46-28 | 46-29 | 46-33 | 46-34 | 46-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 46-36 | 46-37 | 46-38 | 46-39 | 46-40 | 46-41 | 46-42 | 46-43 | 46-44 | 46-45 | 46-46 | 46-47 | 46-48 | 46-49 | 46-50 | 46-51 | 46-54 | 46-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 46-56 | 46-57 | 46-58 | 46-60 | 46-61 | 46-62 | 46-63 | 46-70 | 46-71 | 46-72 | 46-73 | 46-74 | 46-75 | 46-76 | 46-77 | 46-78 | 46-79 | 46-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 46-82 | 46-83 | 46-84 | 46-86 | 46-90 | 46-91 | 46-92 | 46-93 | 46-95 | 46-103 | 46-105 | 46-106 | 46-107 | 46-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 47
with basic structure I.47 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 47-1 | 47-2 | 47-3 | 47-4 | 47-5 | 47-9 | 47-11 | 47-12 | 47-13 | 47-14 | 47-21 | 47-23 | 47-24 | 47-26 | 47-28 | 47-29 | 47-33 | 47-34 | 47-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 47-36 | 47-37 | 47-38 | 47-39 | 47-40 | 47-41 | 47-42 | 47-43 | 47-44 | 47-45 | 47-46 | 47-47 | 47-48 | 47-49 | 47-50 | 47-51 | 47-54 | 47-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 47-56 | 47-57 | 47-58 | 47-60 | 47-61 | 47-62 | 47-63 | 47-70 | 47-71 | 47-72 | 47-73 | 47-74 | 47-75 | 47-76 | 47-77 | 47-78 | 47-79 | 47-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 47-82 | 47-83 | 47-84 | 47-86 | 47-90 | 47-91 | 47-92 | 47-93 | 47-95 | 47-103 | 47-105 | 47-106 | 47-107 | 47-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 48
with basic structure I.48 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 48-1 | 48-2 | 48-3 | 48-4 | 48-5 | 48-9 | 48-11 | 48-12 | 48-13 | 48-14 | 48-21 | 48-23 | 48-24 | 48-26 | 48-28 | 48-29 | 48-33 | 48-34 | 48-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 48-36 | 48-37 | 48-38 | 48-39 | 48-40 | 48-41 | 48-42 | 48-43 | 48-44 | 48-45 | 48-46 | 48-47 | 48-48 | 48-49 | 48-50 | 48-51 | 48-54 | 48-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 48-56 | 48-57 | 48-58 | 48-60 | 48-61 | 48-62 | 48-63 | 48-70 | 48-71 | 48-72 | 48-73 | 48-74 | 48-75 | 48-76 | 48-77 | 48-78 | 48-79 | 48-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 48-82 | 48-83 | 48-84 | 48-86 | 48-90 | 48-91 | 48-92 | 48-93 | 48-95 | 48-103 | 48-105 | 48-106 | 48-107 | 48-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 49
with basic structure I.49 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 49-1 | 49-2 | 49-3 | 49-4 | 49-5 | 49-9 | 49-11 | 49-12 | 49-13 | 49-14 | 49-21 | 49-23 | 49-24 | 49-26 | 49-28 | 49-29 | 49-33 | 49-34 | 49-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 49-36 | 49-37 | 49-38 | 49-39 | 49-40 | 49-41 | 49-42 | 49-43 | 49-44 | 49-45 | 49-46 | 49-47 | 49-48 | 49-49 | 49-50 | 49-51 | 49-54 | 49-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 49-56 | 49-57 | 49-58 | 49-60 | 49-61 | 49-62 | 49-63 | 49-70 | 49-71 | 49-72 | 49-73 | 49-74 | 49-75 | 49-76 | 49-77 | 49-78 | 49-79 | 49-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 49-82 | 49-83 | 49-84 | 49-86 | 49-90 | 49-91 | 49-92 | 49-93 | 49-95 | 49-103 | 49-105 | 49-106 | 49-107 | 49-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 50
with basic structure I.50 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 50-1 | 50-2 | 50-3 | 50-4 | 50-5 | 50-9 | 50-11 | 50-12 | 50-13 | 50-14 | 50-21 | 50-23 | 50-24 | 50-26 | 50-28 | 50-29 | 50-33 | 50-34 | 50-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 50-36 | 50-37 | 50-38 | 50-39 | 50-40 | 50-41 | 50-42 | 50-43 | 50-44 | 50-45 | 50-46 | 50-47 | 50-48 | 50-49 | 50-50 | 50-51 | 50-54 | 50-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 50-56 | 50-57 | 50-58 | 50-60 | 50-61 | 50-62 | 50-63 | 50-70 | 50-71 | 50-72 | 50-73 | 50-74 | 50-75 | 50-76 | 50-77 | 50-78 | 50-79 | 50-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 50-82 | 50-83 | 50-84 | 50-86 | 50-90 | 50-91 | 50-92 | 50-93 | 50-95 | 50-103 | 50-105 | 50-106 | 50-107 | 50-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 51
with basic structure I.51 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 51-1 | 51-2 | 51-3 | 51-4 | 51-5 | 51-9 | 51-11 | 51-12 | 51-13 | 51-14 | 51-21 | 51-23 | 51-24 | 51-26 | 51-28 | 51-29 | 51-33 | 51-34 | 51-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 51-36 | 51-37 | 51-38 | 51-39 | 51-40 | 51-41 | 51-42 | 51-43 | 51-44 | 51-45 | 51-46 | 51-47 | 51-48 | 51-49 | 51-50 | 51-51 | 51-54 | 51-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 51-56 | 51-57 | 51-58 | 51-60 | 51-61 | 51-62 | 51-63 | 51-70 | 51-71 | 51-72 | 51-73 | 51-74 | 51-75 | 51-76 | 51-77 | 51-78 | 51-79 | 51-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 51-82 | 51-83 | 51-84 | 51-86 | 51-90 | 51-91 | 51-92 | 51-93 | 51-95 | 51-103 | 51-105 | 51-106 | 51-107 | 51-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 52
with basic structure I.52 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 52-1 | 52-2 | 52-3 | 52-4 | 52-5 | 52-9 | 52-11 | 52-12 | 52-13 | 52-14 | 52-21 | 52-23 | 52-24 | 52-26 | 52-28 | 52-29 | 52-33 | 52-34 | 52-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 52-36 | 52-37 | 52-38 | 52-39 | 52-40 | 52-41 | 52-42 | 52-43 | 52-44 | 52-45 | 52-46 | 52-47 | 52-48 | 52-49 | 52-50 | 52-51 | 52-54 | 52-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 52-56 | 52-57 | 52-58 | 52-60 | 52-61 | 52-62 | 52-63 | 52-70 | 52-71 | 52-72 | 52-73 | 52-74 | 52-75 | 52-76 | 52-77 | 52-78 | 52-79 | 52-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 52-82 | 52-83 | 52-84 | 52-86 | 52-90 | 52-91 | 52-92 | 52-93 | 52-95 | 52-103 | 52-105 | 52-106 | 52-107 | 52-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 53
with basic structure I.53 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 53-1 | 53-2 | 53-3 | 53-4 | 53-5 | 53-9 | 53-11 | 53-12 | 53-13 | 53-14 | 53-21 | 53-23 | 53-24 | 53-26 | 53-28 | 53-29 | 53-33 | 53-34 | 53-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 53-36 | 53-37 | 53-38 | 53-39 | 53-40 | 53-41 | 53-42 | 53-43 | 53-44 | 53-45 | 53-46 | 53-47 | 53-48 | 53-49 | 53-50 | 53-51 | 53-54 | 53-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 53-56 | 53-57 | 53-58 | 53-60 | 53-61 | 53-62 | 53-63 | 53-70 | 53-71 | 53-72 | 53-73 | 53-74 | 53-75 | 53-76 | 53-77 | 53-78 | 53-79 | 53-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 53-82 | 53-83 | 53-84 | 53-86 | 53-90 | 53-91 | 53-92 | 53-93 | 53-95 | 53-103 | 53-105 | 53-106 | 53-107 | 53-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 54
with basic structure I.54 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 54-1 | 54-2 | 54-3 | 54-4 | 54-5 | 54-9 | 54-11 | 54-12 | 54-13 | 54-14 | 54-21 | 54-23 | 54-24 | 54-26 | 54-28 | 54-29 | 54-33 | 54-34 | 54-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 54-36 | 54-37 | 54-38 | 54-39 | 54-40 | 54-41 | 54-42 | 54-43 | 54-44 | 54-45 | 54-46 | 54-47 | 54-48 | 54-49 | 54-50 | 54-51 | 54-54 | 54-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 54-56 | 54-57 | 54-58 | 54-60 | 54-61 | 54-62 | 54-63 | 54-70 | 54-71 | 54-72 | 54-73 | 54-74 | 54-75 | 54-76 | 54-77 | 54-78 | 54-79 | 54-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 54-82 | 54-83 | 54-84 | 54-86 | 54-90 | 54-91 | 54-92 | 54-93 | 54-95 | 54-103 | 54-105 | 54-106 | 54-107 | 54-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 55
with basic structure I.55 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 55-1 | 55-2 | 55-3 | 55-4 | 55-5 | 55-9 | 55-11 | 55-12 | 55-13 | 55-14 | 55-21 | 55-23 | 55-24 | 55-26 | 55-28 | 55-29 | 55-33 | 55-34 | 55-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 55-36 | 55-37 | 55-38 | 55-39 | 55-40 | 55-41 | 55-42 | 55-43 | 55-44 | 55-45 | 55-46 | 55-47 | 55-48 | 55-49 | 55-50 | 55-51 | 55-54 | 55-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 55-56 | 55-57 | 55-58 | 55-60 | 55-61 | 55-62 | 55-63 | 55-70 | 55-71 | 55-72 | 55-73 | 55-74 | 55-75 | 55-76 | 55-77 | 55-78 | 55-79 | 55-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 55-82 | 55-83 | 55-84 | 55-86 | 55-90 | 55-91 | 55-92 | 55-93 | 55-95 | 55-103 | 55-105 | 55-106 | 55-107 | 55-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 56
with basic structure I.56 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 56-1 | 56-2 | 56-3 | 56-4 | 56-5 | 56-9 | 56-11 | 56-12 | 56-13 | 56-14 | 56-21 | 56-23 | 56-24 | 56-26 | 56-28 | 56-29 | 56-33 | 56-34 | 56-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 56-36 | 56-37 | 56-38 | 56-39 | 56-40 | 56-41 | 56-42 | 56-43 | 56-44 | 56-45 | 56-46 | 56-47 | 56-48 | 56-49 | 56-50 | 56-51 | 56-54 | 56-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 56-56 | 56-57 | 56-58 | 56-60 | 56-61 | 56-62 | 56-63 | 56-70 | 56-71 | 56-72 | 56-73 | 56-74 | 56-75 | 56-76 | 56-77 | 56-78 | 56-79 | 56-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 56-82 | 56-83 | 56-84 | 56-86 | 56-90 | 56-91 | 56-92 | 56-93 | 56-95 | 56-103 | 56-105 | 56-106 | 56-107 | 56-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 57
with basic structure I.57 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 57-1 | 57-2 | 57-3 | 57-4 | 57-5 | 57-9 | 57-11 | 57-12 | 57-13 | 57-14 | 57-21 | 57-23 | 57-24 | 57-26 | 57-28 | 57-29 | 57-33 | 57-34 | 57-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 57-36 | 57-37 | 57-38 | 57-39 | 57-40 | 57-41 | 57-42 | 57-43 | 57-44 | 57-45 | 57-46 | 57-47 | 57-48 | 57-49 | 57-50 | 57-51 | 57-54 | 57-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 57-56 | 57-57 | 57-58 | 57-60 | 57-61 | 57-62 | 57-63 | 57-70 | 57-71 | 57-72 | 57-73 | 57-74 | 57-75 | 57-76 | 57-77 | 57-78 | 57-79 | 57-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 57-82 | 57-83 | 57-84 | 57-86 | 57-90 | 57-91 | 57-92 | 57-93 | 57-95 | 57-103 | 57-105 | 57-106 | 57-107 | 57-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 58
with basic structure I.58 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 58-1 | 58-2 | 58-3 | 58-4 | 58-5 | 58-9 | 58-11 | 58-12 | 58-13 | 58-14 | 58-21 | 58-23 | 58-24 | 58-26 | 58-28 | 58-29 | 58-33 | 58-34 | 58-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 58-36 | 58-37 | 58-38 | 58-39 | 58-40 | 58-41 | 58-42 | 58-43 | 58-44 | 58-45 | 58-46 | 58-47 | 58-48 | 58-49 | 58-50 | 58-51 | 58-54 | 58-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 58-56 | 58-57 | 58-58 | 58-60 | 58-61 | 58-62 | 58-63 | 58-70 | 58-71 | 58-72 | 58-73 | 58-74 | 58-75 | 58-76 | 58-77 | 58-78 | 58-79 | 58-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 58-82 | 58-83 | 58-84 | 58-86 | 58-90 | 58-91 | 58-92 | 58-93 | 58-95 | 58-103 | 58-105 | 58-106 | 58-107 | 58-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 59
with basic structure I.59 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 59-1 | 59-2 | 59-3 | 59-4 | 59-5 | 59-9 | 59-11 | 59-12 | 59-13 | 59-14 | 59-21 | 59-23 | 59-24 | 59-26 | 59-28 | 59-29 | 59-33 | 59-34 | 59-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 59-36 | 59-37 | 59-38 | 59-39 | 59-40 | 59-41 | 59-42 | 59-43 | 59-44 | 59-45 | 59-46 | 59-47 | 59-48 | 59-49 | 59-50 | 59-51 | 59-54 | 59-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 59-56 | 59-57 | 59-58 | 59-60 | 59-61 | 59-62 | 59-63 | 59-70 | 59-71 | 59-72 | 59-73 | 59-74 | 59-75 | 59-76 | 59-77 | 59-78 | 59-79 | 59-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 59-82 | 59-83 | 59-84 | 59-86 | 59-90 | 59-91 | 59-92 | 59-93 | 59-95 | 59-103 | 59-105 | 59-106 | 59-107 | 59-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 60
with basic structure I.60 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 60-1 | 60-2 | 60-3 | 60-4 | 60-5 | 60-9 | 60-11 | 60-12 | 60-13 | 60-14 | 60-21 | 60-23 | 60-24 | 60-26 | 60-28 | 60-29 | 60-33 | 60-34 | 60-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 60-36 | 60-37 | 60-38 | 60-39 | 60-40 | 60-41 | 60-42 | 60-43 | 60-44 | 60-45 | 60-46 | 60-47 | 60-48 | 60-49 | 60-50 | 60-51 | 60-54 | 60-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 60-56 | 60-57 | 60-58 | 60-60 | 60-61 | 60-62 | 60-63 | 60-70 | 60-71 | 60-72 | 60-73 | 60-74 | 60-75 | 60-76 | 60-77 | 60-78 | 60-79 | 60-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 60-82 | 60-83 | 60-84 | 60-86 | 60-90 | 60-91 | 60-92 | 60-93 | 60-95 | 60-103 | 60-105 | 60-106 | 60-107 | 60-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 61
with basic structure I.61 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 61-1 | 61-2 | 61-3 | 61-4 | 61-5 | 61-9 | 61-11 | 61-12 | 61-13 | 61-14 | 61-21 | 61-23 | 61-24 | 61-26 | 61-28 | 61-29 | 61-33 | 61-34 | 61-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 61-36 | 61-37 | 61-38 | 61-39 | 61-40 | 61-41 | 61-42 | 61-43 | 61-44 | 61-45 | 61-46 | 61-47 | 61-48 | 61-49 | 61-50 | 61-51 | 61-54 | 61-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 61-56 | 61-57 | 61-58 | 61-60 | 61-61 | 61-62 | 61-63 | 61-70 | 61-71 | 61-72 | 61-73 | 61-74 | 61-75 | 61-76 | 61-77 | 61-78 | 61-79 | 61-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 61-82 | 61-83 | 61-84 | 61-86 | 61-90 | 61-91 | 61-92 | 61-93 | 61-95 | 61-103 | 61-105 | 61-106 | 61-107 | 61-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 62
with basic structure I.62 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 62-1 | 62-2 | 62-3 | 62-4 | 62-5 | 62-9 | 62-11 | 62-12 | 62-13 | 62-14 | 62-21 | 62-23 | 62-24 | 62-26 | 62-28 | 62-29 | 62-33 | 62-34 | 62-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 62-36 | 62-37 | 62-38 | 62-39 | 62-40 | 62-41 | 62-42 | 62-43 | 62-44 | 62-45 | 62-46 | 62-47 | 62-48 | 62-49 | 62-50 | 62-51 | 62-54 | 62-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 62-56 | 62-57 | 62-58 | 62-60 | 62-61 | 62-62 | 62-63 | 62-70 | 62-71 | 62-72 | 62-73 | 62-74 | 62-75 | 62-76 | 62-77 | 62-78 | 62-79 | 62-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 62-82 | 62-83 | 62-84 | 62-86 | 62-90 | 62-91 | 62-92 | 62-93 | 62-95 | 62-103 | 62-105 | 62-106 | 62-107 | 62-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 63
with basic structure I.63 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 63-1 | 63-2 | 63-3 | 63-4 | 63-5 | 63-9 | 63-11 | 63-12 | 63-13 | 63-14 | 63-21 | 63-23 | 63-24 | 63-26 | 63-28 | 63-29 | 63-33 | 63-34 | 63-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 63-36 | 63-37 | 63-38 | 63-39 | 63-40 | 63-41 | 63-42 | 63-43 | 63-44 | 63-45 | 63-46 | 63-47 | 63-48 | 63-49 | 63-50 | 63-51 | 63-54 | 63-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 63-56 | 63-57 | 63-58 | 63-60 | 63-61 | 63-62 | 63-63 | 63-70 | 63-71 | 63-72 | 63-73 | 63-74 | 63-75 | 63-76 | 63-77 | 63-78 | 63-79 | 63-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 63-82 | 63-83 | 63-84 | 63-86 | 63-90 | 63-91 | 63-92 | 63-93 | 63-95 | 63-103 | 63-105 | 63-106 | 63-107 | 63-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 64
with basic structure I.64 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 64-1 | 64-2 | 64-3 | 64-4 | 64-5 | 64-9 | 64-11 | 64-12 | 64-13 | 64-14 | 64-21 | 64-23 | 64-24 | 64-26 | 64-28 | 64-29 | 64-33 | 64-34 | 64-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 64-36 | 64-37 | 64-38 | 64-39 | 64-40 | 64-41 | 64-42 | 64-43 | 64-44 | 64-45 | 64-46 | 64-47 | 64-48 | 64-49 | 64-50 | 64-51 | 64-54 | 64-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 64-56 | 64-57 | 64-58 | 64-60 | 64-61 | 64-62 | 64-63 | 64-70 | 64-71 | 64-72 | 64-73 | 64-74 | 64-75 | 64-76 | 64-77 | 64-78 | 64-79 | 64-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 64-82 | 64-83 | 64-84 | 64-86 | 64-90 | 64-91 | 64-92 | 64-93 | 64-95 | 64-103 | 64-105 | 64-106 | 64-107 | 64-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 65
with basic structure I.65 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 65-1 | 65-2 | 65-3 | 65-4 | 65-5 | 65-9 | 65-11 | 65-12 | 65-13 | 65-14 | 65-21 | 65-23 | 65-24 | 65-26 | 65-28 | 65-29 | 65-33 | 65-34 | 65-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 65-36 | 65-37 | 65-38 | 65-39 | 65-40 | 65-41 | 65-42 | 65-43 | 65-44 | 65-45 | 65-46 | 65-47 | 65-48 | 65-49 | 65-50 | 65-51 | 65-54 | 65-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 65-56 | 65-57 | 65-58 | 65-60 | 65-61 | 65-62 | 65-63 | 65-70 | 65-71 | 65-72 | 65-73 | 65-74 | 65-75 | 65-76 | 65-77 | 65-78 | 65-79 | 65-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 65-82 | 65-83 | 65-84 | 65-86 | 65-90 | 65-91 | 65-92 | 65-93 | 65-95 | 65-103 | 65-105 | 65-106 | 65-107 | 65-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 66
with basic structure I.66 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 66-1 | 66-2 | 66-3 | 66-4 | 66-5 | 66-9 | 66-11 | 66-12 | 66-13 | 66-14 | 66-21 | 66-23 | 66-24 | 66-26 | 66-28 | 66-29 | 66-33 | 66-34 | 66-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 66-36 | 66-37 | 66-38 | 66-39 | 66-40 | 66-41 | 66-42 | 66-43 | 66-44 | 66-45 | 66-46 | 66-47 | 66-48 | 66-49 | 66-50 | 66-51 | 66-54 | 66-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 66-56 | 66-57 | 66-58 | 66-60 | 66-61 | 66-62 | 66-63 | 66-70 | 66-71 | 66-72 | 66-73 | 66-74 | 66-75 | 66-76 | 66-77 | 66-78 | 66-79 | 66-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 66-82 | 66-83 | 66-84 | 66-86 | 66-90 | 66-91 | 66-92 | 66-93 | 66-95 | 66-103 | 66-105 | 66-106 | 66-107 | 66-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 67
with basic structure I.67 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 67-1 | 67-2 | 67-3 | 67-4 | 67-5 | 67-9 | 67-11 | 67-12 | 67-13 | 67-14 | 67-21 | 67-23 | 67-24 | 67-26 | 67-28 | 67-29 | 67-33 | 67-34 | 67-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 67-36 | 67-37 | 67-38 | 67-39 | 67-40 | 67-41 | 67-42 | 67-43 | 67-44 | 67-45 | 67-46 | 67-47 | 67-48 | 67-49 | 67-50 | 67-51 | 67-54 | 67-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 67-56 | 67-57 | 67-58 | 67-60 | 67-61 | 67-62 | 67-63 | 67-70 | 67-71 | 67-72 | 67-73 | 67-74 | 67-75 | 67-76 | 67-77 | 67-78 | 67-79 | 67-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 67-82 | 67-83 | 67-84 | 67-86 | 67-90 | 67-91 | 67-92 | 67-93 | 67-95 | 67-103 | 67-105 | 67-106 | 67-107 | 67-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 68
with basic structure I.68 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 68-1 | 68-2 | 68-3 | 68-4 | 68-5 | 68-9 | 68-11 | 68-12 | 68-13 | 68-14 | 68-21 | 68-23 | 68-24 | 68-26 | 68-28 | 68-29 | 68-33 | 68-34 | 68-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 68-36 | 68-37 | 68-38 | 68-39 | 68-40 | 68-41 | 68-42 | 68-43 | 68-44 | 68-45 | 68-46 | 68-47 | 68-48 | 68-49 | 68-50 | 68-51 | 68-54 | 68-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 68-56 | 68-57 | 68-58 | 68-60 | 68-61 | 68-62 | 68-63 | 68-70 | 68-71 | 68-72 | 68-73 | 68-74 | 68-75 | 68-76 | 68-77 | 68-78 | 68-79 | 68-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 68-82 | 68-83 | 68-84 | 68-86 | 68-90 | 68-91 | 68-92 | 68-93 | 68-95 | 68-103 | 68-105 | 68-106 | 68-107 | 68-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 69
with basic structure I.69 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 69-1 | 69-2 | 69-3 | 69-4 | 69-5 | 69-9 | 69-11 | 69-12 | 69-13 | 69-14 | 69-21 | 69-23 | 69-24 | 69-26 | 69-28 | 69-29 | 69-33 | 69-34 | 69-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 69-36 | 69-37 | 69-38 | 69-39 | 69-40 | 69-41 | 69-42 | 69-43 | 69-44 | 69-45 | 69-46 | 69-47 | 69-48 | 69-49 | 69-50 | 69-51 | 69-54 | 69-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 69-56 | 69-57 | 69-58 | 69-60 | 69-61 | 69-62 | 69-63 | 69-70 | 69-71 | 69-72 | 69-73 | 69-74 | 69-75 | 69-76 | 69-77 | 69-78 | 69-79 | 69-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 69-82 | 69-83 | 69-84 | 69-86 | 69-90 | 69-91 | 69-92 | 69-93 | 69-95 | 69-103 | 69-105 | 69-106 | 69-107 | 69-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 70
with basic structure I.70 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 70-1 | 70-2 | 70-3 | 70-4 | 70-5 | 70-9 | 70-11 | 70-12 | 70-13 | 70-14 | 70-21 | 70-23 | 70-24 | 70-26 | 70-28 | 70-29 | 70-33 | 70-34 | 70-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 70-36 | 70-37 | 70-38 | 70-39 | 70-40 | 70-41 | 70-42 | 70-43 | 70-44 | 70-45 | 70-46 | 70-47 | 70-48 | 70-49 | 70-50 | 70-51 | 70-54 | 70-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 70-56 | 70-57 | 70-58 | 70-60 | 70-61 | 70-62 | 70-63 | 70-70 | 70-71 | 70-72 | 70-73 | 70-74 | 70-75 | 70-76 | 70-77 | 70-78 | 70-79 | 70-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 70-82 | 70-83 | 70-84 | 70-86 | 70-90 | 70-91 | 70-92 | 70-93 | 70-95 | 70-103 | 70-105 | 70-106 | 70-107 | 70-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 71
with basic structure I.71 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 71-1 | 71-2 | 71-3 | 71-4 | 71-5 | 71-9 | 71-11 | 71-12 | 71-13 | 71-14 | 71-21 | 71-23 | 71-24 | 71-26 | 71-28 | 71-29 | 71-33 | 71-34 | 71-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 71-36 | 71-37 | 71-38 | 71-39 | 71-40 | 71-41 | 71-42 | 71-43 | 71-44 | 71-45 | 71-46 | 71-47 | 71-48 | 71-49 | 71-50 | 71-51 | 71-54 | 71-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 71-56 | 71-57 | 71-58 | 71-60 | 71-61 | 71-62 | 71-63 | 71-70 | 71-71 | 71-72 | 71-73 | 71-74 | 71-75 | 71-76 | 71-77 | 71-78 | 71-79 | 71-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 71-82 | 71-83 | 71-84 | 71-86 | 71-90 | 71-91 | 71-92 | 71-93 | 71-95 | 71-103 | 71-105 | 71-106 | 71-107 | 71-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 72
with basic structure I.72 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 72-1 | 72-2 | 72-3 | 72-4 | 72-5 | 72-9 | 72-11 | 72-12 | 72-13 | 72-14 | 72-21 | 72-23 | 72-24 | 72-26 | 72-28 | 72-29 | 72-33 | 72-34 | 72-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 72-36 | 72-37 | 72-38 | 72-39 | 72-40 | 72-41 | 72-42 | 72-43 | 72-44 | 72-45 | 72-46 | 72-47 | 72-48 | 72-49 | 72-50 | 72-51 | 72-54 | 72-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 72-56 | 72-57 | 72-58 | 72-60 | 72-61 | 72-62 | 72-63 | 72-70 | 72-71 | 72-72 | 72-73 | 72-74 | 72-75 | 72-76 | 72-77 | 72-78 | 72-79 | 72-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 72-82 | 72-83 | 72-84 | 72-86 | 72-90 | 72-91 | 72-92 | 72-93 | 72-95 | 72-103 | 72-105 | 72-106 | 72-107 | 72-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 73
with basic structure I.73 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 73-1 | 73-2 | 73-3 | 73-4 | 73-5 | 73-9 | 73-11 | 73-12 | 73-13 | 73-14 | 73-21 | 73-23 | 73-24 | 73-26 | 73-28 | 73-29 | 73-33 | 73-34 | 73-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 73-36 | 73-37 | 73-38 | 73-39 | 73-40 | 73-41 | 73-42 | 73-43 | 73-44 | 73-45 | 73-46 | 73-47 | 73-48 | 73-49 | 73-50 | 73-51 | 73-54 | 73-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 73-56 | 73-57 | 73-58 | 73-60 | 73-61 | 73-62 | 73-63 | 73-70 | 73-71 | 73-72 | 73-73 | 73-74 | 73-75 | 73-76 | 73-77 | 73-78 | 73-79 | 73-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 73-82 | 73-83 | 73-84 | 73-86 | 73-90 | 73-91 | 73-92 | 73-93 | 73-95 | 73-103 | 73-105 | 73-106 | 73-107 | 73-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 74
with basic structure I.74 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 74-1 | 74-2 | 74-3 | 74-4 | 74-5 | 74-9 | 74-11 | 74-12 | 74-13 | 74-14 | 74-21 | 74-23 | 74-24 | 74-26 | 74-28 | 74-29 | 74-33 | 74-34 | 74-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 74-36 | 74-37 | 74-38 | 74-39 | 74-40 | 74-41 | 74-42 | 74-43 | 74-44 | 74-45 | 74-46 | 74-47 | 74-48 | 74-49 | 74-50 | 74-51 | 74-54 | 74-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 74-56 | 74-57 | 74-58 | 74-60 | 74-61 | 74-62 | 74-63 | 74-70 | 74-71 | 74-72 | 74-73 | 74-74 | 74-75 | 74-76 | 74-77 | 74-78 | 74-79 | 74-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 74-82 | 74-83 | 74-84 | 74-86 | 74-90 | 74-91 | 74-92 | 74-93 | 74-95 | 74-103 | 74-105 | 74-106 | 74-107 | 74-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 75
with basic structure I.75 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 75-1 | 75-2 | 75-3 | 75-4 | 75-5 | 75-9 | 75-11 | 75-12 | 75-13 | 75-14 | 75-21 | 75-23 | 75-24 | 75-26 | 75-28 | 75-29 | 75-33 | 75-34 | 75-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 75-36 | 75-37 | 75-38 | 75-39 | 75-40 | 75-41 | 75-42 | 75-43 | 75-44 | 75-45 | 75-46 | 75-47 | 75-48 | 75-49 | 75-50 | 75-51 | 75-54 | 75-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 75-56 | 75-57 | 75-58 | 75-60 | 75-61 | 75-62 | 75-63 | 75-70 | 75-71 | 75-72 | 75-73 | 75-74 | 75-75 | 75-76 | 75-77 | 75-78 | 75-79 | 75-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 75-82 | 75-83 | 75-84 | 75-86 | 75-90 | 75-91 | 75-92 | 75-93 | 75-95 | 75-103 | 75-105 | 75-106 | 75-107 | 75-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 76
with basic structure I.76 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 76-1 | 76-2 | 76-3 | 76-4 | 76-5 | 76-9 | 76-11 | 76-12 | 76-13 | 76-14 | 76-21 | 76-23 | 76-24 | 76-26 | 76-28 | 76-29 | 76-33 | 76-34 | 76-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 76-36 | 76-37 | 76-38 | 76-39 | 76-40 | 76-41 | 76-42 | 76-43 | 76-44 | 76-45 | 76-46 | 76-47 | 76-48 | 76-49 | 76-50 | 76-51 | 76-54 | 76-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 76-56 | 76-57 | 76-58 | 76-60 | 76-61 | 76-62 | 76-63 | 76-70 | 76-71 | 76-72 | 76-73 | 76-74 | 76-75 | 76-76 | 76-77 | 76-78 | 76-79 | 76-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 76-82 | 76-83 | 76-84 | 76-86 | 76-90 | 76-91 | 76-92 | 76-93 | 76-95 | 76-103 | 76-105 | 76-106 | 76-107 | 76-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 77
with basic structure I.77 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 77-1 | 77-2 | 77-3 | 77-4 | 77-5 | 77-9 | 77-11 | 77-12 | 77-13 | 77-14 | 77-21 | 77-23 | 77-24 | 77-26 | 77-28 | 77-29 | 77-33 | 77-34 | 77-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 77-36 | 77-37 | 77-38 | 77-39 | 77-40 | 77-41 | 77-42 | 77-43 | 77-44 | 77-45 | 77-46 | 77-47 | 77-48 | 77-49 | 77-50 | 77-51 | 77-54 | 77-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 77-56 | 77-57 | 77-58 | 77-60 | 77-61 | 77-62 | 77-63 | 77-70 | 77-71 | 77-72 | 77-73 | 77-74 | 77-75 | 77-76 | 77-77 | 77-78 | 77-79 | 77-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 77-82 | 77-83 | 77-84 | 77-86 | 77-90 | 77-91 | 77-92 | 77-93 | 77-95 | 77-103 | 77-105 | 77-106 | 77-107 | 77-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 78
with basic structure I.78 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 78-1 | 78-2 | 78-3 | 78-4 | 78-5 | 78-9 | 78-11 | 78-12 | 78-13 | 78-14 | 78-21 | 78-23 | 78-24 | 78-26 | 78-28 | 78-29 | 78-33 | 78-34 | 78-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 78-36 | 78-37 | 78-38 | 78-39 | 78-40 | 78-41 | 78-42 | 78-43 | 78-44 | 78-45 | 78-46 | 78-47 | 78-48 | 78-49 | 78-50 | 78-51 | 78-54 | 78-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 78-56 | 78-57 | 78-58 | 78-60 | 78-61 | 78-62 | 78-63 | 78-70 | 78-71 | 78-72 | 78-73 | 78-74 | 78-75 | 78-76 | 78-77 | 78-78 | 78-79 | 78-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 78-82 | 78-83 | 78-84 | 78-86 | 78-90 | 78-91 | 78-92 | 78-93 | 78-95 | 78-103 | 78-105 | 78-106 | 78-107 | 78-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 79
with basic structure I.79 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 79-1 | 79-2 | 79-3 | 79-4 | 79-5 | 79-9 | 79-11 | 79-12 | 79-13 | 79-14 | 79-21 | 79-23 | 79-24 | 79-26 | 79-28 | 79-29 | 79-33 | 79-34 | 79-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 79-36 | 79-37 | 79-38 | 79-39 | 79-40 | 79-41 | 79-42 | 79-43 | 79-44 | 79-45 | 79-46 | 79-47 | 79-48 | 79-49 | 79-50 | 79-51 | 79-54 | 79-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 79-56 | 79-57 | 79-58 | 79-60 | 79-61 | 79-62 | 79-63 | 79-70 | 79-71 | 79-72 | 79-73 | 79-74 | 79-75 | 79-76 | 79-77 | 79-78 | 79-79 | 79-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 79-82 | 79-83 | 79-84 | 79-86 | 79-90 | 79-91 | 79-92 | 79-93 | 79-95 | 79-103 | 79-105 | 79-106 | 79-107 | 79-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 80
with basic structure I.80 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 80-1 | 80-2 | 80-3 | 80-4 | 80-5 | 80-9 | 80-11 | 80-12 | 80-13 | 80-14 | 80-21 | 80-23 | 80-24 | 80-26 | 80-28 | 80-29 | 80-33 | 80-34 | 80-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 80-36 | 80-37 | 80-38 | 80-39 | 80-40 | 80-41 | 80-42 | 80-43 | 80-44 | 80-45 | 80-46 | 80-47 | 80-48 | 80-49 | 80-50 | 80-51 | 80-54 | 80-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 80-56 | 80-57 | 80-58 | 80-60 | 80-61 | 80-62 | 80-63 | 80-70 | 80-71 | 80-72 | 80-73 | 80-74 | 80-75 | 80-76 | 80-77 | 80-78 | 80-79 | 80-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 80-82 | 80-83 | 80-84 | 80-86 | 80-90 | 80-91 | 80-92 | 80-93 | 80-95 | 80-103 | 80-105 | 80-106 | 80-107 | 80-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 81
with basic structure I.81 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 81-1 | 81-2 | 81-3 | 81-4 | 81-5 | 81-9 | 81-11 | 81-12 | 81-13 | 81-14 | 81-21 | 81-23 | 81-24 | 81-26 | 81-28 | 81-29 | 81-33 | 81-34 | 81-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 81-36 | 81-37 | 81-38 | 81-39 | 81-40 | 81-41 | 81-42 | 81-43 | 81-44 | 81-45 | 81-46 | 81-47 | 81-48 | 81-49 | 81-50 | 81-51 | 81-54 | 81-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 81-56 | 81-57 | 81-58 | 81-60 | 81-61 | 81-62 | 81-63 | 81-70 | 81-71 | 81-72 | 81-73 | 81-74 | 81-75 | 81-76 | 81-77 | 81-78 | 81-79 | 81-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 81-82 | 81-83 | 81-84 | 81-86 | 81-90 | 81-91 | 81-92 | 81-93 | 81-95 | 81-103 | 81-105 | 81-106 | 81-107 | 81-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 82
with basic structure I.82 and the Q radicals listed:

| | No. | | | | | | | | | | | | | | | | | | |
|---|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. | I. |
| | 82-1 | 82-2 | 82-3 | 82-4 | 82-5 | 82-9 | 82-11 | 82-12 | 82-13 | 82-14 | 82-21 | 82-23 | 82-24 | 82-26 | 82-28 | 82-29 | 82-33 | 82-34 | 82-35 |
| Q | Q- | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 | 1.57 |

| | No. | | | | | | | | | | | | | | | | | |
|---|---|---|---|---|---|---|---|---|---|---|---|---|---|---|---|---|---|---|
| | I. | I. | I. | I. | I. | I. | I. | I. | I. | I. | I. | I. | I. | I. | I. | I. | I. | I. |
| | 82-36 | 82-37 | 82-38 | 82-39 | 82-40 | 82-41 | 82-42 | 82-43 | 82-44 | 82-45 | 82-46 | 82-47 | 82-48 | 82-49 | 82-50 | 82-51 | 82-54 | 82-55 |
| Q | Q- | Q- | Q- | Q- | Q- | Q- | Q- | Q- | Q- | Q- | Q- | Q- | Q- | Q- | Q- | Q- | Q- | Q- |
| | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 | 1.222 |
| | No. | | | | | | | | | | | | | | | | | |
| | I. | I. | I. | I. | I. | I. | I. | I. | I. | I. | I. | I. | I. | I. | I. | I. | I. | I. |
| | 82-56 | 82-57 | 82-58 | 82-60 | 82-61 | 82-62 | 82-63 | 82-70 | 82-71 | 82-72 | 82-73 | 82-74 | 82-75 | 82-76 | 82-77 | 82-78 | 82-79 | 82-80 |
| Q | Q- | Q- | Q- | Q- | Q- | Q- | Q- | Q- | Q- | Q- | Q- | Q- | Q- | Q- | Q- | Q- | Q- | Q- |
| | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 | 1.45 |

| | No. | | | | | | | | | | | | | |
|---|---|---|---|---|---|---|---|---|---|---|---|---|---|---|
| | I. | I. | I. | I. | I. | I. | I. | I. | I. | I. | I. | I. | I. | I. |
| | 82-82 | 82-83 | 82-84 | 82-86 | 82-90 | 82-91 | 82-92 | 82-93 | 82-95 | 82-103 | 82-105 | 82-106 | 82-107 | 82-108 |
| Q | Q- | Q- | Q- | Q- | Q- | Q- | Q- | Q- | Q- | Q- | Q- | Q- | Q- | Q- |
| | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 83
with basic structure I.83 and the Q radicals listed:

| | I. | I. | I. | I. | I. | I. | I. | I. | I. | I. | I. | I. | I. | I. | I. |
|---|---|---|---|---|---|---|---|---|---|---|---|---|---|---|---|
| No. | 83-1 | 83-2 | 83-3 | 83-4 | 83-5 | 83-9 | 83-11 | 83-12 | 83-13 | 83-14 | 83-21 | 83-23 | 83-24 | 83-26 | 83-28 |
| Q | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 |
| | I. | I. | I. | I. | I. | I. | I. | I. | I. | I. | I. | I. | I. | I. | I. |
| No. | 83-29 | 83-33 | 83-34 | 83-35 | 83-36 | 83-37 | 83-38 | 83-39 | 83-40 | 83-41 | 83-42 | 83-43 | 83-44 | 83-45 | 83-46 |
| Q | Q- | Q- | Q- | Q- | Q- | Q- | Q- | Q- | Q- | Q- | Q- | Q- | Q- | Q- | Q- |
| | 1.207 | 1.56 | 1.58 | 1.57 | 24.9 | 24.8 | 24.11 | 24.7 | 24.10 | 24.3 | 24.1 | 1.66 | 22.1 | 22.2 | 22.3 |
| | I. | I. | I. | I. | I. | I. | I. | I. | I. | I. | I. | I. | I. | I. | I. |
| No. | 83-47 | 83-48 | 83-49 | 83-50 | 83-51 | 83-54 | 83-55 | 83-56 | 83-57 | 83-58 | 83-60 | 83-61 | 83-62 | 83-63 | 83-70 |
| Q | Q- | Q- | Q- | Q- | Q- | Q- | Q- | Q- | Q- | Q- | Q- | Q- | Q- | Q- | Q- |
| | 22.4 | 22.7 | 22.8 | 22.9 | 22.10 | 22.11 | 1.222 | 1.221 | 24.5 | 24.6 | 1.220 | 1.231 | 1.238 | 1.200 | 1.245 |
| | I. | I. | I. | I. | I. | I. | I. | I. | I. | I. | I. | I. | I. | I. | I. |
| No. | 83-71 | 83-72 | 83-73 | 83-74 | 83-75 | 83-76 | 83-77 | 83-78 | 83-79 | 83-80 | 83-82 | 83-83 | 83-84 | 83-86 | 83-90 |
| Q | Q- | Q- | Q- | Q- | Q- | Q- | Q- | Q- | Q- | Q- | Q- | Q- | Q- | Q- | Q- |
| | 1.3 | 1.21 | 1.100 | 1.113 | 1.27 | 1.15 | 1.39 | 1.120 | 1.106 | 1.45 | 1.116 | 1.99 | 1.125 | 1.93 | 1.128 |
| | I. | I. | I. | I. | I. | I. | I. | I. | I. | | | | | | |
| No. | 83-91 | 83-92 | 83-93 | 83-95 | 83-103 | 83-105 | 83-106 | 83-107 | 83-108 | | | | | | |
| Q | Q- | Q- | Q- | Q- | Q- | Q- | Q- | Q- | Q- | | | | | | |
| | 1.134 | 1.143 | 1.190 | 1.176 | 1.234 | 1.155 | 1.110 | 1.154 | 1.266 | | | | | | |

TABLE 84
with basic structure I.84 and the Q radicals listed:

| | I. | I. | I. | I. | I. | I. | I. | I. | I. | I. | I. | I. | I. | I. | I. |
|---|---|---|---|---|---|---|---|---|---|---|---|---|---|---|---|
| No. | 84-1 | 84-2 | 84-3 | 84-4 | 84-5 | 84-9 | 84-11 | 84-12 | 84-13 | 84-14 | 84-21 | 84-23 | 84-24 | 84-26 | 84-28 |
| Q | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 |
| | I. | I. | I. | I. | I. | I. | I. | I. | I. | I. | I. | I. | I. | I. | I. |
| No. | 84-29 | 84-33 | 84-34 | 84-35 | 84-36 | 84-37 | 84-38 | 84-39 | 84-40 | 84-41 | 84-42 | 84-43 | 84-44 | 84-45 | 84-46 |
| Q | Q- | Q- | Q- | Q- | Q- | Q- | Q- | Q- | Q- | Q- | Q- | Q- | Q- | Q- | Q- |
| | 1.207 | 1.56 | 1.58 | 1.57 | 24.9 | 24.8 | 24.11 | 24.7 | 24.10 | 24.3 | 24.1 | 1.66 | 22.1 | 22.2 | 22.3 |
| | I. | I. | I. | I. | I. | I. | I. | I. | I. | I. | I. | I. | I. | I. | I. |
| No. | 84-47 | 84-48 | 84-49 | 84-50 | 84-51 | 84-54 | 84-55 | 84-56 | 84-57 | 84-58 | 84-60 | 84-61 | 84-62 | 84-63 | 84-70 |
| Q | Q- | Q- | Q- | Q- | Q- | Q- | Q- | Q- | Q- | Q- | Q- | Q- | Q- | Q- | Q- |
| | 22.4 | 22.7 | 22.8 | 22.9 | 22.10 | 22.11 | 1.222 | 1.221 | 24.5 | 24.6 | 1.220 | 1.231 | 1.238 | 1.200 | 1.245 |
| | I. | I. | I. | I. | I. | I. | I. | I. | I. | I. | I. | I. | I. | I. | I. |
| No. | 84-71 | 84-72 | 84-73 | 84-74 | 84-75 | 84-76 | 84-77 | 84-78 | 84-79 | 84-80 | 84-82 | 84-83 | 84-84 | 84-86 | 84-90 |
| Q | Q- | Q- | Q- | Q- | Q- | Q- | Q- | Q- | Q- | Q- | Q- | Q- | Q- | Q- | Q- |
| | 1.3 | 1.21 | 1.100 | 1.113 | 1.27 | 1.15 | 1.39 | 1.120 | 1.106 | 1.45 | 1.116 | 1.99 | 1.125 | 1.93 | 1.128 |
| | I. | I. | I. | I. | I. | I. | I. | I. | I. | | | | | | |
| No. | 84-91 | 84-92 | 84-93 | 84-95 | 84-103 | 84-105 | 84-106 | 84-107 | 84-108 | | | | | | |
| Q | Q- | Q- | Q- | Q- | Q- | Q- | Q- | Q- | Q- | | | | | | |
| | 1.134 | 1.143 | 1.190 | 1.176 | 1.234 | 1.155 | 1.110 | 1.154 | 1.266 | | | | | | |

TABLE 85
with basic structure I.85 and the Q radicals listed:

| | I. | I. | I. | I. | I. | I. | I. | I. | I. | I. | I. | I. | I. | I. | I. |
|---|---|---|---|---|---|---|---|---|---|---|---|---|---|---|---|
| No. | 85-1 | 85-2 | 85-3 | 85-4 | 85-5 | 85-9 | 85-11 | 85-12 | 85-13 | 85-14 | 85-21 | 85-23 | 85-24 | 85-26 | 85-28 |
| Q | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 |
| | I. | I. | I. | I. | I. | I. | I. | I. | I. | I. | I. | I. | I. | I. | I. |
| No. | 85-29 | 85-33 | 85-34 | 85-35 | 85-36 | 85-37 | 85-38 | 85-39 | 85-40 | 85-41 | 85-42 | 85-43 | 85-44 | 85-45 | 85-46 |
| Q | Q- | Q- | Q- | Q- | Q- | Q- | Q- | Q- | Q- | Q- | Q- | Q- | Q- | Q- | Q- |
| | 1.207 | 1.56 | 1.58 | 1.57 | 24.9 | 24.8 | 24.11 | 24.7 | 24.10 | 24.3 | 24.1 | 1.66 | 22.1 | 22.2 | 22.3 |
| | I. | I. | I. | I. | I. | I. | I. | I. | I. | I. | I. | I. | I. | I. | I. |
| No. | 85-47 | 85-48 | 85-49 | 85-50 | 85-51 | 85-54 | 85-55 | 85-56 | 85-57 | 85-58 | 85-60 | 85-61 | 85-62 | 85-63 | 85-70 |
| Q | Q- | Q- | Q- | Q- | Q- | Q- | Q- | Q- | Q- | Q- | Q- | Q- | Q- | Q- | Q- |
| | 22.4 | 22.7 | 22.8 | 22.9 | 22.10 | 22.11 | 1.222 | 1.221 | 24.5 | 24.6 | 1.220 | 1.231 | 1.238 | 1.200 | 1.245 |
| | I. | I. | I. | I. | I. | I. | I. | I. | I. | I. | I. | I. | I. | I. | I. |
| No. | 85-71 | 85-72 | 85-73 | 85-74 | 85-75 | 85-76 | 85-77 | 85-78 | 85-79 | 85-80 | 85-82 | 85-83 | 85-84 | 85-86 | 85-90 |
| Q | Q- | Q- | Q- | Q- | Q- | Q- | Q- | Q- | Q- | Q- | Q- | Q- | Q- | Q- | Q- |
| | 1.3 | 1.21 | 1.100 | 1.113 | 1.27 | 1.15 | 1.39 | 1.120 | 1.106 | 1.45 | 1.116 | 1.99 | 1.125 | 1.93 | 1.128 |
| | I. | I. | I. | I. | I. | I. | I. | I. | I. | | | | | | |
| No. | 85-91 | 85-92 | 85-93 | 85-95 | 85-103 | 85-105 | 85-106 | 85-107 | 85-108 | | | | | | |
| Q | Q- | Q- | Q- | Q- | Q- | Q- | Q- | Q- | Q- | | | | | | |
| | 1.134 | 1.143 | 1.190 | 1.176 | 1.234 | 1.155 | 1.110 | 1.154 | 1.266 | | | | | | |

TABLE 86
with basic structure I.86 and the Q radicals listed:

| | I. | I. | I. | I. | I. | I. | I. | I. | I. | I. | I. | I. | I. | I. | I. |
|---|---|---|---|---|---|---|---|---|---|---|---|---|---|---|---|
| No. | 86-1 | 86-2 | 86-3 | 86-4 | 86-5 | 86-9 | 86-11 | 86-12 | 86-13 | 86-14 | 86-21 | 86-23 | 86-24 | 86-26 | 86-28 |
| Q | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 |
| | I. | I. | I. | I. | I. | I. | I. | I. | I. | I. | I. | I. | I. | I. | I. |
| No. | 86-29 | 86-33 | 86-34 | 86-35 | 86-36 | 86-37 | 86-38 | 86-39 | 86-40 | 86-41 | 86-42 | 86-43 | 86-44 | 86-45 | 86-46 |
| Q | Q- | Q- | Q- | Q- | Q- | Q- | Q- | Q- | Q- | Q- | Q- | Q- | Q- | Q- | Q- |
| | 1.207 | 1.56 | 1.58 | 1.57 | 24.9 | 24.8 | 24.11 | 24.7 | 24.10 | 24.3 | 24.1 | 1.66 | 22.1 | 22.2 | 22.3 |
| | I. | I. | I. | I. | I. | I. | I. | I. | I. | I. | I. | I. | I. | I. | I. |
| No. | 86-47 | 86-48 | 86-49 | 86-50 | 86-51 | 86-54 | 86-55 | 86-56 | 86-57 | 86-58 | 86-60 | 86-61 | 86-62 | 86-63 | 86-70 |
| Q | Q- | Q- | Q- | Q- | Q- | Q- | Q- | Q- | Q- | Q- | Q- | Q- | Q- | Q- | Q- |
| | 22.4 | 22.7 | 22.8 | 22.9 | 22.10 | 22.11 | 1.222 | 1.221 | 24.5 | 24.6 | 1.220 | 1.231 | 1.238 | 1.200 | 1.245 |
| | I. | I. | I. | I. | I. | I. | I. | I. | I. | I. | I. | I. | I. | I. | I. |
| No. | 86-71 | 86-72 | 86-73 | 86-74 | 86-75 | 86-76 | 86-77 | 86-78 | 86-79 | 86-80 | 86-82 | 86-83 | 86-84 | 86-86 | 86-90 |
| Q | Q- | Q- | Q- | Q- | Q- | Q- | Q- | Q- | Q- | Q- | Q- | Q- | Q- | Q- | Q- |
| | 1.3 | 1.21 | 1.100 | 1.113 | 1.27 | 1.15 | 1.39 | 1.120 | 1.106 | 1.45 | 1.116 | 1.99 | 1.125 | 1.93 | 1.128 |
| | I. | I. | I. | I. | I. | I. | I. | I. | I. | | | | | | |
| No. | 86-91 | 86-92 | 86-93 | 86-95 | 86-103 | 86-105 | 86-106 | 86-107 | 86-108 | | | | | | |
| Q | Q- | Q- | Q- | Q- | Q- | Q- | Q- | Q- | Q- | | | | | | |
| | 1.134 | 1.143 | 1.190 | 1.176 | 1.234 | 1.155 | 1.110 | 1.154 | 1.266 | | | | | | |

TABLE 87
with basic structure I.87 and the Q radicals listed:

| | I. | I. | I. | I. | I. | I. | I. | I. | I. | I. | I. | I. | I. | I. | I. |
|---|---|---|---|---|---|---|---|---|---|---|---|---|---|---|---|
| No. | 87-1 | 87-2 | 87-3 | 87-4 | 87-5 | 87-9 | 87-11 | 87-12 | 87-13 | 87-14 | 87-21 | 87-23 | 87-24 | 87-26 | 87-28 |
| Q | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 |
| | I. | I. | I. | I. | I. | I. | I. | I. | I. | I. | I. | I. | I. | I. | I. |
| No. | 87-29 | 87-33 | 87-34 | 87-35 | 87-36 | 87-37 | 87-38 | 87-39 | 87-40 | 87-41 | 87-42 | 87-43 | 87-44 | 87-45 | 87-46 |
| Q | Q- | Q- | Q- | Q- | Q- | Q- | Q- | Q- | Q- | Q- | Q- | Q- | Q- | Q- | Q- |
| | 1.207 | 1.56 | 1.58 | 1.57 | 24.9 | 24.8 | 24.11 | 24.7 | 24.10 | 24.3 | 24.1 | 1.66 | 22.1 | 22.2 | 22.3 |
| | I. | I. | I. | I. | I. | I. | I. | I. | I. | I. | I. | I. | I. | I. | I. |
| No. | 87-47 | 87-48 | 87-49 | 87-50 | 87-51 | 87-54 | 87-55 | 87-56 | 87-57 | 87-58 | 87-60 | 87-61 | 87-62 | 87-63 | 87-70 |
| Q | Q- | Q- | Q- | Q- | Q- | Q- | Q- | Q- | Q- | Q- | Q- | Q- | Q- | Q- | Q- |
| | 22.4 | 22.7 | 22.8 | 22.9 | 22.10 | 22.11 | 1.222 | 1.221 | 24.5 | 24.6 | 1.220 | 1.231 | 1.238 | 1.200 | 1.245 |
| | I. | I. | I. | I. | I. | I. | I. | I. | I. | I. | I. | I. | I. | I. | I. |
| No. | 87-71 | 87-72 | 87-73 | 87-74 | 87-75 | 87-76 | 87-77 | 87-78 | 87-79 | 87-80 | 87-82 | 87-83 | 87-84 | 87-86 | 87-90 |
| Q | Q- | Q- | Q- | Q- | Q- | Q- | Q- | Q- | Q- | Q- | Q- | Q- | Q- | Q- | Q- |
| | 1.3 | 1.21 | 1.100 | 1.113 | 1.27 | 1.15 | 1.39 | 1.120 | 1.106 | 1.45 | 1.116 | 1.99 | 1.125 | 1.93 | 1.128 |
| | I. | I. | I. | I. | I. | I. | I. | I. | I. | | | | | | |
| No. | 87-91 | 87-92 | 87-93 | 87-95 | 87-103 | 87-105 | 87-106 | 87-107 | 87-108 | | | | | | |
| Q | Q- | Q- | Q- | Q- | Q- | Q- | Q- | Q- | Q- | | | | | | |
| | 1.134 | 1.143 | 1.190 | 1.176 | 1.234 | 1.155 | 1.110 | 1.154 | 1.266 | | | | | | |

TABLE 88
with basic structure I.88 and the Q radicals listed:

| | I. | I. | I. | I. | I. | I. | I. | I. | I. | I. | I. | I. | I. | I. | I. |
|---|---|---|---|---|---|---|---|---|---|---|---|---|---|---|---|
| No. | 88-1 | 88-2 | 88-3 | 88-4 | 88-5 | 88-9 | 88-11 | 88-12 | 88-13 | 88-14 | 88-21 | 88-23 | 88-24 | 88-26 | 88-28 |
| Q | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 |
| | I. | I. | I. | I. | I. | I. | I. | I. | I. | I. | I. | I. | I. | I. | I. |
| No. | 88-29 | 88-33 | 88-34 | 88-35 | 88-36 | 88-37 | 88-38 | 88-39 | 88-40 | 88-41 | 88-42 | 88-43 | 88-44 | 88-45 | 88-46 |
| Q | Q- | Q- | Q- | Q- | Q- | Q- | Q- | Q- | Q- | Q- | Q- | Q- | Q- | Q- | Q- |
| | 1.207 | 1.56 | 1.58 | 1.57 | 24.9 | 24.8 | 24.11 | 24.7 | 24.10 | 24.3 | 24.1 | 1.66 | 22.1 | 22.2 | 22.3 |
| | I. | I. | I. | I. | I. | I. | I. | I. | I. | I. | I. | I. | I. | I. | I. |
| No. | 88-47 | 88-48 | 88-49 | 88-50 | 88-51 | 88-54 | 88-55 | 88-56 | 88-57 | 88-58 | 88-60 | 88-61 | 88-62 | 88-63 | 88-70 |
| Q | Q- | Q- | Q- | Q- | Q- | Q- | Q- | Q- | Q- | Q- | Q- | Q- | Q- | Q- | Q- |
| | 22.4 | 22.7 | 22.8 | 22.9 | 22.10 | 22.11 | 1.222 | 1.221 | 24.5 | 24.6 | 1.220 | 1.231 | 1.238 | 1.200 | 1.245 |
| | I. | I. | I. | I. | I. | I. | I. | I. | I. | I. | I. | I. | I. | I. | I. |
| No. | 88-71 | 88-72 | 88-73 | 88-74 | 88-75 | 88-76 | 88-77 | 88-78 | 88-79 | 88-80 | 88-82 | 88-83 | 88-84 | 88-86 | 88-90 |
| Q | Q- | Q- | Q- | Q- | Q- | Q- | Q- | Q- | Q- | Q- | Q- | Q- | Q- | Q- | Q- |
| | 1.3 | 1.21 | 1.100 | 1.113 | 1.27 | 1.15 | 1.39 | 1.120 | 1.106 | 1.45 | 1.116 | 1.99 | 1.125 | 1.93 | 1.128 |
| | I. | I. | I. | I. | I. | I. | I. | I. | I. | | | | | | |
| No. | 88-91 | 88-92 | 88-93 | 88-95 | 88-103 | 88-105 | 88-106 | 88-107 | 88-108 | | | | | | |
| Q | Q- | Q- | Q- | Q- | Q- | Q- | Q- | Q- | Q- | | | | | | |
| | 1.134 | 1.143 | 1.190 | 1.176 | 1.234 | 1.155 | 1.110 | 1.154 | 1.266 | | | | | | |

TABLE 89
with basic structure I.89 and the Q radicals listed:

| | I. | I. | I. | I. | I. | I. | I. | I. | I. | I. | I. | I. | I. | I. | I. |
|---|---|---|---|---|---|---|---|---|---|---|---|---|---|---|---|
| No. | 89-1 | 89-2 | 89-3 | 89-4 | 89-5 | 89-9 | 89-11 | 89-12 | 89-13 | 89-14 | 89-21 | 89-23 | 89-24 | 89-26 | 89-28 |
| Q | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 |
| | I. | I. | I. | I. | I. | I. | I. | I. | I. | I. | I. | I. | I. | I. | I. |
| No. | 89-29 | 89-33 | 89-34 | 89-35 | 89-36 | 89-37 | 89-38 | 89-39 | 89-40 | 89-41 | 89-42 | 89-43 | 89-44 | 89-45 | 89-46 |
| Q | Q- | Q- | Q- | Q- | Q- | Q- | Q- | Q- | Q- | Q- | Q- | Q- | Q- | Q- | Q- |
| | 1.207 | 1.56 | 1.58 | 1.57 | 24.9 | 24.8 | 24.11 | 24.7 | 24.10 | 24.3 | 24.1 | 1.66 | 22.1 | 22.2 | 22.3 |
| | I. | I. | I. | I. | I. | I. | I. | I. | I. | I. | I. | I. | I. | I. | I. |
| No. | 89-47 | 89-48 | 89-49 | 89-50 | 89-51 | 89-54 | 89-55 | 89-56 | 89-57 | 89-58 | 89-60 | 89-61 | 89-62 | 89-63 | 89-70 |
| Q | Q- | Q- | Q- | Q- | Q- | Q- | Q- | Q- | Q- | Q- | Q- | Q- | Q- | Q- | Q- |
| | 22.4 | 22.7 | 22.8 | 22.9 | 22.10 | 22.11 | 1.222 | 1.221 | 24.5 | 24.6 | 1.220 | 1.231 | 1.238 | 1.200 | 1.245 |
| | I. | I. | I. | I. | I. | I. | I. | I. | I. | I. | I. | I. | I. | I. | I. |
| No. | 89-71 | 89-72 | 89-73 | 89-74 | 89-75 | 89-76 | 89-77 | 89-78 | 89-79 | 89-80 | 89-82 | 89-83 | 89-84 | 89-86 | 89-90 |
| Q | Q- | Q- | Q- | Q- | Q- | Q- | Q- | Q- | Q- | Q- | Q- | Q- | Q- | Q- | Q- |
| | 1.3 | 1.21 | 1.100 | 1.113 | 1.27 | 1.15 | 1.39 | 1.120 | 1.106 | 1.45 | 1.116 | 1.99 | 1.125 | 1.93 | 1.128 |
| | I. | I. | I. | I. | I. | I. | I. | I. | I. | | | | | | |
| No. | 89-91 | 89-92 | 89-93 | 89-95 | 89-103 | 89-105 | 89-106 | 89-107 | 89-108 | | | | | | |
| Q | Q- | Q- | Q- | Q- | Q- | Q- | Q- | Q- | Q- | | | | | | |
| | 1.134 | 1.143 | 1.190 | 1.176 | 1.234 | 1.155 | 1.110 | 1.154 | 1.266 | | | | | | |

TABLE 90
with basic structure I.90 and the Q radicals listed:

| | I. | I. | I. | I. | I. | I. | I. | I. | I. | I. | I. | I. | I. | I. | I. |
|---|---|---|---|---|---|---|---|---|---|---|---|---|---|---|---|
| No. | 90-1 | 90-2 | 90-3 | 90-4 | 90-5 | 90-9 | 90-11 | 90-12 | 90-13 | 90-14 | 90-21 | 90-23 | 90-24 | 90-26 | 90-28 |
| Q | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 |
| | I. | I. | I. | I. | I. | I. | I. | I. | I. | I. | I. | I. | I. | I. | I. |
| No. | 90-29 | 90-33 | 90-34 | 90-35 | 90-36 | 90-37 | 90-38 | 90-39 | 90-40 | 90-41 | 90-42 | 90-43 | 90-44 | 90-45 | 90-46 |
| Q | Q- | Q- | Q- | Q- | Q- | Q- | Q- | Q- | Q- | Q- | Q- | Q- | Q- | Q- | Q- |
| | 1.207 | 1.56 | 1.58 | 1.57 | 24.9 | 24.8 | 24.11 | 24.7 | 24.10 | 24.3 | 24.1 | 1.66 | 22.1 | 22.2 | 22.3 |
| | I. | I. | I. | I. | I. | I. | I. | I. | I. | I. | I. | I. | I. | I. | I. |
| No. | 90-47 | 90-48 | 90-49 | 90-50 | 90-51 | 90-54 | 90-55 | 90-56 | 90-57 | 90-58 | 90-60 | 90-61 | 90-62 | 90-63 | 90-70 |
| Q | Q- | Q- | Q- | Q- | Q- | Q- | Q- | Q- | Q- | Q- | Q- | Q- | Q- | Q- | Q- |
| | 22.4 | 22.7 | 22.8 | 22.9 | 22.10 | 22.11 | 1.222 | 1.221 | 24.5 | 24.6 | 1.220 | 1.231 | 1.238 | 1.200 | 1.245 |
| | I. | I. | I. | I. | I. | I. | I. | I. | I. | I. | I. | I. | I. | I. | I. |
| No. | 90-71 | 90-72 | 90-73 | 90-74 | 90-75 | 90-76 | 90-77 | 90-78 | 90-79 | 90-80 | 90-82 | 90-83 | 90-84 | 90-86 | 90-90 |
| Q | Q- | Q- | Q- | Q- | Q- | Q- | Q- | Q- | Q- | Q- | Q- | Q- | Q- | Q- | Q- |
| | 1.3 | 1.21 | 1.100 | 1.113 | 1.27 | 1.15 | 1.39 | 1.120 | 1.106 | 1.45 | 1.116 | 1.99 | 1.125 | 1.93 | 1.128 |
| | I. | I. | I. | I. | I. | I. | I. | I. | I. | | | | | | |
| No. | 90-91 | 90-92 | 90-93 | 90-95 | 90-103 | 90-105 | 90-106 | 90-107 | 90-108 | | | | | | |
| Q | Q- | Q- | Q- | Q- | Q- | Q- | Q- | Q- | Q- | | | | | | |
| | 1.134 | 1.143 | 1.190 | 1.176 | 1.234 | 1.155 | 1.110 | 1.154 | 1.266 | | | | | | |

TABLE 91
with basic structure I.91 and the Q radicals listed:

| | I. | I. | I. | I. | I. | I. | I. | I. | I. | I. | I. | I. | I. | I. | I. |
|---|---|---|---|---|---|---|---|---|---|---|---|---|---|---|---|
| No. | 91-1 | 91-2 | 91-3 | 91-4 | 91-5 | 91-9 | 91-11 | 91-12 | 91-13 | 91-14 | 91-21 | 91-23 | 91-24 | 91-26 | 91-28 |
| Q | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 |
| | I. | I. | I. | I. | I. | I. | I. | I. | I. | I. | I. | I. | I. | I. | I. |
| No. | 91-29 | 91-33 | 91-34 | 91-35 | 91-36 | 91-37 | 91-38 | 91-39 | 91-40 | 91-41 | 91-42 | 91-43 | 91-44 | 91-45 | 91-46 |
| Q | Q- | Q- | Q- | Q- | Q- | Q- | Q- | Q- | Q- | Q- | Q- | Q- | Q- | Q- | Q- |
| | 1.207 | 1.56 | 1.58 | 1.57 | 24.9 | 24.8 | 24.11 | 24.7 | 24.10 | 24.3 | 24.1 | 1.66 | 22.1 | 22.2 | 22.3 |
| | I. | I. | I. | I. | I. | I. | I. | I. | I. | I. | I. | I. | I. | I. | I. |
| No. | 91-47 | 91-48 | 91-49 | 91-50 | 91-51 | 91-54 | 91-55 | 91-56 | 91-57 | 91-58 | 91-60 | 91-61 | 91-62 | 91-63 | 91-70 |
| Q | Q- | Q- | Q- | Q- | Q- | Q- | Q- | Q- | Q- | Q- | Q- | Q- | Q- | Q- | Q- |
| | 22.4 | 22.7 | 22.8 | 22.9 | 22.10 | 22.11 | 1.222 | 1.221 | 24.5 | 24.6 | 1.220 | 1.231 | 1.238 | 1.200 | 1.245 |
| | I. | I. | I. | I. | I. | I. | I. | I. | I. | I. | I. | I. | I. | I. | I. |
| No. | 91-71 | 91-72 | 91-73 | 91-74 | 91-75 | 91-76 | 91-77 | 91-78 | 91-79 | 91-80 | 91-82 | 91-83 | 91-84 | 91-86 | 91-90 |
| Q | Q- | Q- | Q- | Q- | Q- | Q- | Q- | Q- | Q- | Q- | Q- | Q- | Q- | Q- | Q- |
| | 1.3 | 1.21 | 1.100 | 1.113 | 1.27 | 1.15 | 1.39 | 1.120 | 1.106 | 1.45 | 1.116 | 1.99 | 1.125 | 1.93 | 1.128 |
| | I. | I. | I. | I. | I. | I. | I. | I. | I. | | | | | | |
| No. | 91-91 | 91-92 | 91-93 | 91-95 | 91-103 | 91-105 | 91-106 | 91-107 | 91-108 | | | | | | |
| Q | Q- | Q- | Q- | Q- | Q- | Q- | Q- | Q- | Q- | | | | | | |
| | 1.134 | 1.143 | 1.190 | 1.176 | 1.234 | 1.155 | 1.110 | 1.154 | 1.266 | | | | | | |

TABLE 92
with basic structure I.92 and the Q radicals listed:

| | I. | I. | I. | I. | I. | I. | I. | I. | I. | I. | I. | I. | I. | I. | I. |
|---|---|---|---|---|---|---|---|---|---|---|---|---|---|---|---|
| No. | 92-1 | 92-2 | 92-3 | 92-4 | 92-5 | 92-9 | 92-11 | 92-12 | 92-13 | 92-14 | 92-21 | 92-23 | 92-24 | 92-26 | 92-28 |
| Q | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 |
| | I. | I. | I. | I. | I. | I. | I. | I. | I. | I. | I. | I. | I. | I. | I. |
| No. | 92-29 | 92-33 | 92-34 | 92-35 | 92-36 | 92-37 | 92-38 | 92-39 | 92-40 | 92-41 | 92-42 | 92-43 | 92-44 | 92-45 | 92-46 |
| Q | Q- | Q- | Q- | Q- | Q- | Q- | Q- | Q- | Q- | Q- | Q- | Q- | Q- | Q- | Q- |
| | 1.207 | 1.56 | 1.58 | 1.57 | 24.9 | 24.8 | 24.11 | 24.7 | 24.10 | 24.3 | 24.1 | 1.66 | 22.1 | 22.2 | 22.3 |
| | I. | I. | I. | I. | I. | I. | I. | I. | I. | I. | I. | I. | I. | I. | I. |
| No. | 92-47 | 92-48 | 92-49 | 92-50 | 92-51 | 92-54 | 92-55 | 92-56 | 92-57 | 92-58 | 92-60 | 92-61 | 92-62 | 92-63 | 92-70 |
| Q | Q- | Q- | Q- | Q- | Q- | Q- | Q- | Q- | Q- | Q- | Q- | Q- | Q- | Q- | Q- |
| | 22.4 | 22.7 | 22.8 | 22.9 | 22.10 | 22.11 | 1.222 | 1.221 | 24.5 | 24.6 | 1.220 | 1.231 | 1.238 | 1.200 | 1.245 |
| | I. | I. | I. | I. | I. | I. | I. | I. | I. | I. | I. | I. | I. | I. | I. |
| No. | 92-71 | 92-72 | 92-73 | 92-74 | 92-75 | 92-76 | 92-77 | 92-78 | 92-79 | 92-80 | 92-82 | 92-83 | 92-84 | 92-86 | 92-90 |
| Q | Q- | Q- | Q- | Q- | Q- | Q- | Q- | Q- | Q- | Q- | Q- | Q- | Q- | Q- | Q- |
| | 1.3 | 1.21 | 1.100 | 1.113 | 1.27 | 1.15 | 1.39 | 1.120 | 1.106 | 1.45 | 1.116 | 1.99 | 1.125 | 1.93 | 1.128 |
| | I. | I. | I. | I. | I. | I. | I. | I. | I. | | | | | | |
| No. | 92-91 | 92-92 | 92-93 | 92-95 | 92-103 | 92-105 | 92-106 | 92-107 | 92-108 | | | | | | |
| Q | Q- | Q- | Q- | Q- | Q- | Q- | Q- | Q- | Q- | | | | | | |
| | 1.134 | 1.143 | 1.190 | 1.176 | 1.234 | 1.155 | 1.110 | 1.154 | 1.266 | | | | | | |

TABLE 93
with basic structure I.93 and the Q radicals listed:

| | I. | I. | I. | I. | I. | I. | I. | I. | I. | I. | I. | I. | I. | I. | I. |
|---|---|---|---|---|---|---|---|---|---|---|---|---|---|---|---|
| No. | 93-1 | 93-2 | 93-3 | 93-4 | 93-5 | 93-9 | 93-11 | 93-12 | 93-13 | 93-14 | 93-21 | 93-23 | 93-24 | 93-26 | 93-28 |
| Q | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 |
| | I. | I. | I. | I. | I. | I. | I. | I. | I. | I. | I. | I. | I. | I. | I. |
| No. | 93-29 | 93-33 | 93-34 | 93-35 | 93-36 | 93-37 | 93-38 | 93-39 | 93-40 | 93-41 | 93-42 | 93-43 | 93-44 | 93-45 | 93-46 |
| Q | Q- | Q- | Q- | Q- | Q- | Q- | Q- | Q- | Q- | Q- | Q- | Q- | Q- | Q- | Q- |
| | 1.207 | 1.56 | 1.58 | 1.57 | 24.9 | 24.8 | 24.11 | 24.7 | 24.10 | 24.3 | 24.1 | 1.66 | 22.1 | 22.2 | 22.3 |
| | I. | I. | I. | I. | I. | I. | I. | I. | I. | I. | I. | I. | I. | I. | I. |
| No. | 93-47 | 93-48 | 93-49 | 93-50 | 93-51 | 93-54 | 93-55 | 93-56 | 93-57 | 93-58 | 93-60 | 93-61 | 93-62 | 93-63 | 93-70 |
| Q | Q- | Q- | Q- | Q- | Q- | Q- | Q- | Q- | Q- | Q- | Q- | Q- | Q- | Q- | Q- |
| | 22.4 | 22.7 | 22.8 | 22.9 | 22.10 | 22.11 | 1.222 | 1.221 | 24.5 | 24.6 | 1.220 | 1.231 | 1.238 | 1.200 | 1.245 |
| | I. | I. | I. | I. | I. | I. | I. | I. | I. | I. | I. | I. | I. | I. | I. |
| No. | 93-71 | 93-72 | 93-73 | 93-74 | 93-75 | 93-76 | 93-77 | 93-78 | 93-79 | 93-80 | 93-82 | 93-83 | 93-84 | 93-86 | 93-90 |
| Q | Q- | Q- | Q- | Q- | Q- | Q- | Q- | Q- | Q- | Q- | Q- | Q- | Q- | Q- | Q- |
| | 1.3 | 1.21 | 1.100 | 1.113 | 1.27 | 1.15 | 1.39 | 1.120 | 1.106 | 1.45 | 1.116 | 1.99 | 1.125 | 1.93 | 1.128 |
| | I. | I. | I. | I. | I. | I. | I. | I. | I. | | | | | | |
| No. | 93-91 | 93-92 | 93-93 | 93-95 | 93-103 | 93-105 | 93-106 | 93-107 | 93-108 | | | | | | |
| Q | Q- | Q- | Q- | Q- | Q- | Q- | Q- | Q- | Q- | | | | | | |
| | 1.134 | 1.143 | 1.190 | 1.176 | 1.234 | 1.155 | 1.110 | 1.154 | 1.266 | | | | | | |

TABLE 94
with basic structure I.94 and the Q radicals listed:

| | I. | I. | I. | I. | I. | I. | I. | I. | I. | I. | I. | I. | I. | I. | I. |
|---|---|---|---|---|---|---|---|---|---|---|---|---|---|---|---|
| No. | 94-1 | 94-2 | 94-3 | 94-4 | 94-5 | 94-9 | 94-11 | 94-12 | 94-13 | 94-14 | 94-21 | 94-23 | 94-24 | 94-26 | 94-28 |
| Q | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 |
| | I. | I. | I. | I. | I. | I. | I. | I. | I. | I. | I. | I. | I. | I. | I. |
| No. | 94-29 | 94-33 | 94-34 | 94-35 | 94-36 | 94-37 | 94-38 | 94-39 | 94-40 | 94-41 | 94-42 | 94-43 | 94-44 | 94-45 | 94-46 |
| Q | Q- | Q- | Q- | Q- | Q- | Q- | Q- | Q- | Q- | Q- | Q- | Q- | Q- | Q- | Q- |
| | 1.207 | 1.56 | 1.58 | 1.57 | 24.9 | 24.8 | 24.11 | 24.7 | 24.10 | 24.3 | 24.1 | 1.66 | 22.1 | 22.2 | 22.3 |
| | I. | I. | I. | I. | I. | I. | I. | I. | I. | I. | I. | I. | I. | I. | I. |
| No. | 94-47 | 94-48 | 94-49 | 94-50 | 94-51 | 94-54 | 94-55 | 94-56 | 94-57 | 94-58 | 94-60 | 94-61 | 94-62 | 94-63 | 94-70 |
| Q | Q- | Q- | Q- | Q- | Q- | Q- | Q- | Q- | Q- | Q- | Q- | Q- | Q- | Q- | Q- |
| | 22.4 | 22.7 | 22.8 | 22.9 | 22.10 | 22.11 | 1.222 | 1.221 | 24.5 | 24.6 | 1.220 | 1.231 | 1.238 | 1.200 | 1.245 |
| | I. | I. | I. | I. | I. | I. | I. | I. | I. | I. | I. | I. | I. | I. | I. |
| No. | 94-71 | 94-72 | 94-73 | 94-74 | 94-75 | 94-76 | 94-77 | 94-78 | 94-79 | 94-80 | 94-82 | 94-83 | 94-84 | 94-86 | 94-90 |
| Q | Q- | Q- | Q- | Q- | Q- | Q- | Q- | Q- | Q- | Q- | Q- | Q- | Q- | Q- | Q- |
| | 1.3 | 1.21 | 1.100 | 1.113 | 1.27 | 1.15 | 1.39 | 1.120 | 1.106 | 1.45 | 1.116 | 1.99 | 1.125 | 1.93 | 1.128 |
| | I. | I. | I. | I. | I. | I. | I. | I. | I. | | | | | | |
| No. | 94-91 | 94-92 | 94-93 | 94-95 | 94-103 | 94-105 | 94-106 | 94-107 | 94-108 | | | | | | |
| Q | Q- | Q- | Q- | Q- | Q- | Q- | Q- | Q- | Q- | | | | | | |
| | 1.134 | 1.143 | 1.190 | 1.176 | 1.234 | 1.155 | 1.110 | 1.154 | 1.266 | | | | | | |

TABLE 95
with basic structure I.95 and the Q radicals listed:

| | I. | I. | I. | I. | I. | I. | I. | I. | I. | I. | I. | I. | I. | I. | I. |
|---|---|---|---|---|---|---|---|---|---|---|---|---|---|---|---|
| No. | 95-1 | 95-2 | 95-3 | 95-4 | 95-5 | 95-9 | 95-11 | 95-12 | 95-13 | 95-14 | 95-21 | 95-23 | 95-24 | 95-26 | 95-28 |
| Q | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 |
| | I. | I. | I. | I. | I. | I. | I. | I. | I. | I. | I. | I. | I. | I. | I. |
| No. | 95-29 | 95-33 | 95-34 | 95-35 | 95-36 | 95-37 | 95-38 | 95-39 | 95-40 | 95-41 | 95-42 | 95-43 | 95-44 | 95-45 | 95-46 |
| Q | Q- | Q- | Q- | Q- | Q- | Q- | Q- | Q- | Q- | Q- | Q- | Q- | Q- | Q- | Q- |
| | 1.207 | 1.56 | 1.58 | 1.57 | 24.9 | 24.8 | 24.11 | 24.7 | 24.10 | 24.3 | 24.1 | 1.66 | 22.1 | 22.2 | 22.3 |
| | I. | I. | I. | I. | I. | I. | I. | I. | I. | I. | I. | I. | I. | I. | I. |
| No. | 95-47 | 95-48 | 95-49 | 95-50 | 95-51 | 95-54 | 95-55 | 95-56 | 95-57 | 95-58 | 95-60 | 95-61 | 95-62 | 95-63 | 95-70 |
| Q | Q- | Q- | Q- | Q- | Q- | Q- | Q- | Q- | Q- | Q- | Q- | Q- | Q- | Q- | Q- |
| | 22.4 | 22.7 | 22.8 | 22.9 | 22.10 | 22.11 | 1.222 | 1.221 | 24.5 | 24.6 | 1.220 | 1.231 | 1.238 | 1.200 | 1.245 |
| | I. | I. | I. | I. | I. | I. | I. | I. | I. | I. | I. | I. | I. | I. | I. |
| No. | 95-71 | 95-72 | 95-73 | 95-74 | 95-75 | 95-76 | 95-77 | 95-78 | 95-79 | 95-80 | 95-82 | 95-83 | 95-84 | 95-86 | 95-90 |
| Q | Q- | Q- | Q- | Q- | Q- | Q- | Q- | Q- | Q- | Q- | Q- | Q- | Q- | Q- | Q- |
| | 1.3 | 1.21 | 1.100 | 1.113 | 1.27 | 1.15 | 1.39 | 1.120 | 1.106 | 1.45 | 1.116 | 1.99 | 1.125 | 1.93 | 1.128 |
| | I. | I. | I. | I. | I. | I. | I. | I. | I. | | | | | | |
| No. | 95-91 | 95-92 | 95-93 | 95-95 | 95-103 | 95-105 | 95-106 | 95-107 | 95-108 | | | | | | |
| Q | Q- | Q- | Q- | Q- | Q- | Q- | Q- | Q- | Q- | | | | | | |
| | 1.134 | 1.143 | 1.190 | 1.176 | 1.234 | 1.155 | 1.110 | 1.154 | 1.266 | | | | | | |

TABLE 96
with basic structure I.96 and the Q radicals listed:

| | I. | I. | I. | I. | I. | I. | I. | I. | I. | I. | I. | I. | I. | I. | I. |
|---|---|---|---|---|---|---|---|---|---|---|---|---|---|---|---|
| No. | 96-1 | 96-2 | 96-3 | 96-4 | 96-5 | 96-9 | 96-11 | 96-12 | 96-13 | 96-14 | 96-21 | 96-23 | 96-24 | 96-26 | 96-28 |
| Q | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 |
| | I. | I. | I. | I. | I. | I. | I. | I. | I. | I. | I. | I. | I. | I. | I. |
| No. | 96-29 | 96-33 | 96-34 | 96-35 | 96-36 | 96-37 | 96-38 | 96-39 | 96-40 | 96-41 | 96-42 | 96-43 | 96-44 | 96-45 | 96-46 |
| Q | Q- | Q- | Q- | Q- | Q- | Q- | Q- | Q- | Q- | Q- | Q- | Q- | Q- | Q- | Q- |
| | 1.207 | 1.56 | 1.58 | 1.57 | 24.9 | 24.8 | 24.11 | 24.7 | 24.10 | 24.3 | 24.1 | 1.66 | 22.1 | 22.2 | 22.3 |
| | I. | I. | I. | I. | I. | I. | I. | I. | I. | I. | I. | I. | I. | I. | I. |
| No. | 96-47 | 96-48 | 96-49 | 96-50 | 96-51 | 96-54 | 96-55 | 96-56 | 96-57 | 96-58 | 96-60 | 96-61 | 96-62 | 96-63 | 96-70 |
| Q | Q- | Q- | Q- | Q- | Q- | Q- | Q- | Q- | Q- | Q- | Q- | Q- | Q- | Q- | Q- |
| | 22.4 | 22.7 | 22.8 | 22.9 | 22.10 | 22.11 | 1.222 | 1.221 | 24.5 | 24.6 | 1.220 | 1.231 | 1.238 | 1.200 | 1.245 |
| | I. | I. | I. | I. | I. | I. | I. | I. | I. | I. | I. | I. | I. | I. | I. |
| No. | 96-71 | 96-72 | 96-73 | 96-74 | 96-75 | 96-76 | 96-77 | 96-78 | 96-79 | 96-80 | 96-82 | 96-83 | 96-84 | 96-86 | 96-90 |
| Q | Q- | Q- | Q- | Q- | Q- | Q- | Q- | Q- | Q- | Q- | Q- | Q- | Q- | Q- | Q- |
| | 1.3 | 1.21 | 1.100 | 1.113 | 1.27 | 1.15 | 1.39 | 1.120 | 1.106 | 1.45 | 1.116 | 1.99 | 1.125 | 1.93 | 1.128 |
| | I. | I. | I. | I. | I. | I. | I. | I. | I. | | | | | | |
| No. | 96-91 | 96-92 | 96-93 | 96-95 | 96-103 | 96-105 | 96-106 | 96-107 | 96-108 | | | | | | |
| Q | Q- | Q- | Q- | Q- | Q- | Q- | Q- | Q- | Q- | | | | | | |
| | 1.134 | 1.143 | 1.190 | 1.176 | 1.234 | 1.155 | 1.110 | 1.154 | 1.266 | | | | | | |

TABLE 97
with basic structure I.97 and the Q radicals listed:

| | I. | I. | I. | I. | I. | I. | I. | I. | I. | I. | I. | I. | I. | I. | I. |
|---|---|---|---|---|---|---|---|---|---|---|---|---|---|---|---|
| No. | 97-1 | 97-2 | 97-3 | 97-4 | 97-5 | 97-9 | 97-11 | 97-12 | 97-13 | 97-14 | 97-21 | 97-23 | 97-24 | 97-26 | 97-28 |
| Q | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 |
| | I. | I. | I. | I. | I. | I. | I. | I. | I. | I. | I. | I. | I. | I. | I. |
| No. | 97-29 | 97-33 | 97-34 | 97-35 | 97-36 | 97-37 | 97-38 | 97-39 | 97-40 | 97-41 | 97-42 | 97-43 | 97-44 | 97-45 | 97-46 |
| Q | Q- | Q- | Q- | Q- | Q- | Q- | Q- | Q- | Q- | Q- | Q- | Q- | Q- | Q- | Q- |
| | 1.207 | 1.56 | 1.58 | 1.57 | 24.9 | 24.8 | 24.11 | 24.7 | 24.10 | 24.3 | 24.1 | 1.66 | 22.1 | 22.2 | 22.3 |
| | I. | I. | I. | I. | I. | I. | I. | I. | I. | I. | I. | I. | I. | I. | I. |
| No. | 97-47 | 97-48 | 97-49 | 97-50 | 97-51 | 97-54 | 97-55 | 97-56 | 97-57 | 97-58 | 97-60 | 97-61 | 97-62 | 97-63 | 97-70 |
| Q | Q- | Q- | Q- | Q- | Q- | Q- | Q- | Q- | Q- | Q- | Q- | Q- | Q- | Q- | Q- |
| | 22.4 | 22.7 | 22.8 | 22.9 | 22.10 | 22.11 | 1.222 | 1.221 | 24.5 | 24.6 | 1.220 | 1.231 | 1.238 | 1.200 | 1.245 |
| | I. | I. | I. | I. | I. | I. | I. | I. | I. | I. | I. | I. | I. | I. | I. |
| No. | 97-71 | 97-72 | 97-73 | 97-74 | 97-75 | 97-76 | 97-77 | 97-78 | 97-79 | 97-80 | 97-82 | 97-83 | 97-84 | 97-86 | 97-90 |
| Q | Q- | Q- | Q- | Q- | Q- | Q- | Q- | Q- | Q- | Q- | Q- | Q- | Q- | Q- | Q- |
| | 1.3 | 1.21 | 1.100 | 1.113 | 1.27 | 1.15 | 1.39 | 1.120 | 1.106 | 1.45 | 1.116 | 1.99 | 1.125 | 1.93 | 1.128 |
| | I. | I. | I. | I. | I. | I. | I. | I. | I. | | | | | | |
| No. | 97-91 | 97-92 | 97-93 | 97-95 | 97-103 | 97-105 | 97-106 | 97-107 | 97-108 | | | | | | |
| Q | Q- | Q- | Q- | Q- | Q- | Q- | Q- | Q- | Q- | | | | | | |
| | 1.134 | 1.143 | 1.190 | 1.176 | 1.234 | 1.155 | 1.110 | 1.154 | 1.266 | | | | | | |

TABLE 98
with basic structure I.98 and the Q radicals listed:

| | I. | I. | I. | I. | I. | I. | I. | I. | I. | I. | I. | I. | I. | I. | I. | I. | I. | I. |
|---|---|---|---|---|---|---|---|---|---|---|---|---|---|---|---|---|---|---|
| No. | 98-1 | 98-2 | 98-3 | 98-4 | 98-5 | 98-9 | 98-11 | 98-12 | 98-13 | 98-14 | 98-21 | 98-23 | 98-24 | 98-26 | 98-28 | 98-29 | 98-33 | 98-34 |
| Q | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 |
| | I. | I. | I. | I. | I. | I. | I. | I. | I. | I. | I. | I. | I. | I. | I. | I. | I. | I. |
| No. | 98-35 | 98-36 | 98-37 | 98-38 | 98-39 | 98-40 | 98-41 | 98-42 | 98-43 | 98-44 | 98-45 | 98-46 | 98-47 | 98-48 | 98-49 | 98-50 | 98-51 | 98-54 |
| Q | Q- | Q- | Q- | Q- | Q- | Q- | Q- | Q- | Q- | Q- | Q- | Q- | Q- | Q- | Q- | Q- | Q- | Q- |
| | 1.57 | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 |
| | I. | I. | I. | I. | I. | I. | I. | I. | I. | I. | I. | I. | I. | I. | I. | I. | I. | I. |
| No. | 98-55 | 98-56 | 98-57 | 98-58 | 98-60 | 98-61 | 98-62 | 98-63 | 98-70 | 98-71 | 98-72 | 98-73 | 98-74 | 98-75 | 98-76 | 98-77 | 98-78 | 98-79 |
| Q | Q- | Q- | Q- | Q- | Q- | Q- | Q- | Q- | Q- | Q- | Q- | Q- | Q- | Q- | Q- | Q- | Q- | Q- |
| | 1.222 | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 |
| | | | | I. | I. | I. | I. | I. | I. | I. | I. | I. | I. | I. | I. | I. | I. | I. |
| | | | No. | 98-80 | 98-82 | 98-83 | 98-84 | 98-86 | 98-90 | 98-91 | 98-92 | 98-93 | 98-95 | 98-103 | 98-105 | 98-106 | 98-107 | 98-108 |
| | | | Q | Q- | Q- | Q- | Q- | Q- | Q- | Q- | Q- | Q- | Q- | Q- | Q- | Q- | Q- | Q- |
| | | | | 1.45 | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 99
with basic structure I.99 and the Q radicals listed:

| | I. | I. | I. | I. | I. | I. | I. | I. | I. | I. | I. | I. | I. | I. | I. | I. | I. | I. |
|---|---|---|---|---|---|---|---|---|---|---|---|---|---|---|---|---|---|---|
| No. | 99-1 | 99-2 | 99-3 | 99-4 | 99-5 | 99-9 | 99-11 | 99-12 | 99-13 | 99-14 | 99-21 | 99-23 | 99-24 | 99-26 | 99-28 | 99-29 | 99-33 | 99-34 |
| Q | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 |
| | I. | I. | I. | I. | I. | I. | I. | I. | I. | I. | I. | I. | I. | I. | I. | I. | I. | I. |
| No. | 99-35 | 99-36 | 99-37 | 99-38 | 99-39 | 99-40 | 99-41 | 99-42 | 99-43 | 99-44 | 99-45 | 99-46 | 99-47 | 99-48 | 99-49 | 99-50 | 99-51 | 99-54 |
| Q | Q- | Q- | Q- | Q- | Q- | Q- | Q- | Q- | Q- | Q- | Q- | Q- | Q- | Q- | Q- | Q- | Q- | Q- |
| | 1.57 | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 |
| | I. | I. | I. | I. | I. | I. | I. | I. | I. | I. | I. | I. | I. | I. | I. | I. | I. | I. |
| No. | 99-55 | 99-56 | 99-57 | 99-58 | 99-60 | 99-61 | 99-62 | 99-63 | 99-70 | 99-71 | 99-72 | 99-73 | 99-74 | 99-75 | 99-76 | 99-77 | 99-78 | 99-79 |
| Q | Q- | Q- | Q- | Q- | Q- | Q- | Q- | Q- | Q- | Q- | Q- | Q- | Q- | Q- | Q- | Q- | Q- | Q- |
| | 1.222 | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 |
| | | | | I. | I. | I. | I. | I. | I. | I. | I. | I. | I. | I. | I. | I. | I. | I. |
| | | | No. | 99-80 | 99-82 | 99-83 | 99-84 | 99-86 | 99-90 | 99-91 | 99-92 | 99-93 | 99-95 | 99-103 | 99-105 | 99-106 | 99-107 | 99-108 |
| | | | Q | Q- | Q- | Q- | Q- | Q- | Q- | Q- | Q- | Q- | Q- | Q- | Q- | Q- | Q- | Q- |
| | | | | 1.45 | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 100
with basic structure I.100 and the Q radicals listed:

| | | | | | | | I. | I. | I. | I. | I. | I. | I. | I. | I. | I. | I. | I. |
|---|---|---|---|---|---|---|---|---|---|---|---|---|---|---|---|---|---|---|
| | I. | I. | I. | I. | I. | I. | 100- | 100- | 100- | 100- | 100- | 100- | 100- | 100- | 100- | 100- | 100- | 100- |
| No. | 100-1 | 100-2 | 100-3 | 100-4 | 100-5 | 100-9 | 11 | 12 | 13 | 14 | 21 | 23 | 24 | 26 | 28 | 29 | 33 | 34 |
| Q | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 |
| | I. | I. | I. | I. | I. | I. | I. | I. | I. | I. | I. | I. | I. | I. | I. | I. | I. | I. |
| | 100- | 100- | 100- | 100- | 100- | 100- | 100- | 100- | 100- | 100- | 100- | 100- | 100- | 100- | 100- | 100- | 100- | 100- |
| No. | 35 | 36 | 37 | 38 | 39 | 40 | 41 | 42 | 43 | 44 | 45 | 46 | 47 | 48 | 49 | 50 | 51 | 54 |
| Q | Q- | Q- | Q- | Q- | Q- | Q- | Q- | Q- | Q- | Q- | Q- | Q- | Q- | Q- | Q- | Q- | Q- | Q- |
| | 1.57 | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 |
| | I. | I. | I. | I. | I. | I. | I. | I. | I. | I. | I. | I. | I. | I. | I. | I. | I. | I. |
| | 100- | 100- | 100- | 100- | 100- | 100- | 100- | 100- | 100- | 100- | 100- | 100- | 100- | 100- | 100- | 100- | 100- | 100- |
| No. | 55 | 56 | 57 | 58 | 60 | 61 | 62 | 63 | 70 | 71 | 72 | 73 | 74 | 75 | 76 | 77 | 78 | 79 |
| Q | Q- | Q- | Q- | Q- | Q- | Q- | Q- | Q- | Q- | Q- | Q- | Q- | Q- | Q- | Q- | Q- | Q- | Q- |
| | 1.222 | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 |
| | | | | I. | I. | I. | I. | I. | I. | I. | I. | I. | I. | I. | I. | I. | I. | I. |
| | | | | 100- | 100- | 100- | 100- | 100- | 100- | 100- | 100- | 100- | 100- | 100- | 100- | 100- | 100- | 100- |
| | | | No. | 80 | 82 | 83 | 84 | 86 | 90 | 91 | 92 | 93 | 95 | 103 | 105 | 106 | 107 | 108 |
| | | | Q | Q- | Q- | Q- | Q- | Q- | Q- | Q- | Q- | Q- | Q- | Q- | Q- | Q- | Q- | Q- |
| | | | | 1.45 | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 101
with basic structure I.101 and the Q radicals listed:

| | | | | | | | I. | I. | I. | I. | I. | I. | I. | I. | I. | I. |
|---|---|---|---|---|---|---|---|---|---|---|---|---|---|---|---|---|
| | I. | I. | I. | I. | I. | I. | 101- | 101- | 101- | 101- | 101- | 101- | 101- | 101- | 101- | 101- |
| No. | 101-1 | 101-2 | 101-3 | 101-4 | 101-5 | 101-9 | 11 | 12 | 13 | 14 | 21 | 23 | 24 | 26 | 28 | 29 |
| Q | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 |
| | I. | I. | I. | I. | I. | I. | I. | I. | I. | I. | I. | I. | I. | I. | I. | I. |
| | 101- | 101- | 101- | 101- | 101- | 101- | 101- | 101- | 101- | 101- | 101- | 101- | 101- | 101- | 101- | 101- |
| No. | 33 | 34 | 35 | 36 | 37 | 38 | 39 | 40 | 41 | 42 | 43 | 44 | 45 | 46 | 47 | 48 |
| Q | Q- | Q- | Q- | Q- | Q- | Q- | Q- | Q- | Q- | Q- | Q- | Q- | Q- | Q- | Q- | Q- |
| | 1.56 | 1.58 | 1.57 | 24.9 | 24.8 | 24.11 | 24.7 | 24.10 | 24.3 | 24.1 | 1.66 | 22.1 | 22.2 | 22.3 | 22.4 | 22.7 |
| | | | | | I. | I. | I. | I. | I. | I. | I. | I. | I. | I. | I. | I. |
| | I. | I. | I. | I. | 101- | 101- | 101- | 101- | 101- | 101- | 101- | 101- | 101- | 101- | 101- | 101- |
| No. | 101-49 | 101-50 | 101-51 | 101-54 | 55 | 56 | 57 | 58 | 60 | 61 | 62 | 63 | 70 | 71 | 72 | 73 |
| Q | Q- | Q- | Q- | Q- | Q- | Q- | Q- | Q- | Q- | Q- | Q- | Q- | Q- | Q- | Q- | Q- |
| | 22.8 | 22.9 | 22.10 | 22.11 | 1.222 | 1.221 | 24.5 | 24.6 | 1.220 | 1.231 | 1.238 | 1.200 | 1.245 | 1.3 | 1.21 | 1.100 |
| | I. | I. | I. | I. | I. | I. | I. | I. | I. | I. | I. | I. | I. | I. | I. | I. |
| | 101- | 101- | 101- | 101- | 101- | 101- | 101- | 101- | 101- | 101- | 101- | 101- | 101- | 101- | 101- | 101- |
| No. | 74 | 75 | 76 | 77 | 78 | 79 | 80 | 82 | 83 | 84 | 86 | 90 | 91 | 92 | 93 | 95 |
| Q | Q- | Q- | Q- | Q- | Q- | Q- | Q- | Q- | Q- | Q- | Q- | Q- | Q- | Q- | Q- | Q- |
| | 1.113 | 1.27 | 1.15 | 1.39 | 1.120 | 1.106 | 1.45 | 1.116 | 1.99 | 1.125 | 1.93 | 1.128 | 1.134 | 1.143 | 1.190 | 1.176 |
| | | | | | | | | | | | | I. | I. | I. | I. | I. |
| | | | | | | | | | | | | 101- | 101- | 101- | 101- | 101- |
| | | | | | | | | | | | No. | 103 | 105 | 106 | 107 | 108 |
| | | | | | | | | | | | | Q- | Q- | Q- | Q- | Q- |
| | | | | | | | | | | | Q | 1.234 | 1.155 | 1.110 | 1.154 | 1.266 |

TABLE 102
with basic structure I.102 and the Q radicals listed:

| | | | | | | | I. | I. | I. | I. | I. | I. | I. | I. | I. | I. |
|---|---|---|---|---|---|---|---|---|---|---|---|---|---|---|---|---|
| | I. | I. | I. | I. | I. | I. | 102- | 102- | 102- | 102- | 102- | 102- | 102- | 102- | 102- | 102- |
| No. | 102-1 | 102-2 | 102-3 | 102-4 | 102-5 | 102-9 | 11 | 12 | 13 | 14 | 21 | 23 | 24 | 26 | 28 | 29 |
| Q | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 |
| | I. | I. | I. | I. | I. | I. | I. | I. | I. | I. | I. | I. | I. | I. | I. | I. |
| | 102- | 102- | 102- | 102- | 102- | 102- | 102- | 102- | 102- | 102- | 102- | 102- | 102- | 102- | 102- | 102- |
| No. | 33 | 34 | 36 | 35 | 37 | 38 | 39 | 40 | 41 | 42 | 43 | 44 | 45 | 46 | 47 | 48 |
| Q | Q- | Q- | Q- | Q- | Q- | Q- | Q- | Q- | Q- | Q- | Q- | Q- | Q- | Q- | Q- | Q- |
| | 1.56 | 1.58 | 1.57 | 24.9 | 24.8 | 24.11 | 24.7 | 24.10 | 24.3 | 24.1 | 1.66 | 22.1 | 22.2 | 22.3 | 22.4 | 22.7 |
| | | | | | I. | I. | I. | I. | I. | I. | I. | I. | I. | I. | I. | I. |
| | I. | I. | I. | I. | 102- | 102- | 102- | 102- | 102- | 102- | 102- | 102- | 102- | 102- | 102- | 102- |
| No. | 102-49 | 102-50 | 102-51 | 102-54 | 55 | 56 | 57 | 58 | 60 | 61 | 62 | 63 | 70 | 71 | 72 | 73 |
| Q | Q- | Q- | Q- | Q- | Q- | Q- | Q- | Q- | Q- | Q- | Q- | Q- | Q- | Q- | Q- | Q- |
| | 22.8 | 22.9 | 22.10 | 22.11 | 1.222 | 1.221 | 24.5 | 24.6 | 1.220 | 1.231 | 1.238 | 1.200 | 1.245 | 1.3 | 1.21 | 1.100 |
| | I. | I. | I. | I. | I. | I. | I. | I. | I. | I. | I. | I. | I. | I. | I. | I. |
| | 102- | 102- | 102- | 102- | 102- | 102- | 102- | 102- | 102- | 102- | 102- | 102- | 102- | 102- | 102- | 102- |
| No. | 74 | 75 | 76 | 77 | 78 | 79 | 80 | 82 | 83 | 84 | 86 | 90 | 91 | 92 | 93 | 95 |
| Q | Q- | Q- | Q- | Q- | Q- | Q- | Q- | Q- | Q- | Q- | Q- | Q- | Q- | Q- | Q- | Q- |
| | 1.113 | 1.27 | 1.15 | 1.39 | 1.120 | 1.106 | 1.45 | 1.116 | 1.99 | 1.125 | 1.93 | 1.128 | 1.134 | 1.143 | 1.190 | 1.176 |
| | | | | | | | | | | | | I. | I. | I. | I. | I. |
| | | | | | | | | | | | | 102- | 102- | 102- | 102- | 102- |
| | | | | | | | | | | | No. | 103 | 105 | 106 | 107 | 108 |
| | | | | | | | | | | | Q | Q- | Q- | Q- | Q- | Q- |
| | | | | | | | | | | | | 1.234 | 1.155 | 1.110 | 1.154 | 1.266 |

TABLE 103
with basic structure I.103 and the Q radicals listed:

| | | | | | | | I. | I. | I. | I. | I. | I. | I. | I. | I. | I. |
|---|---|---|---|---|---|---|---|---|---|---|---|---|---|---|---|---|
| | I. | I. | I. | I. | I. | I. | 103- | 103- | 103- | 103- | 103- | 103- | 103- | 103- | 103- | 103- |
| No. | 103-1 | 103-2 | 103-3 | 103-4 | 103-5 | 103-9 | 11 | 12 | 13 | 14 | 21 | 23 | 24 | 26 | 28 | 29 |
| Q | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 |
| | I. | I. | I. | I. | I. | I. | I. | I. | I. | I. | I. | I. | I. | I. | I. | I. |
| | 103- | 103- | 103- | 103- | 103- | 103- | 103- | 103- | 103- | 103- | 103- | 103- | 103- | 103- | 103- | 103- |
| No. | 33 | 34 | 35 | 36 | 37 | 38 | 39 | 40 | 41 | 42 | 43 | 44 | 45 | 46 | 47 | 48 |
| Q | Q- | Q- | Q- | Q- | Q- | Q- | Q- | Q- | Q- | Q- | Q- | Q- | Q- | Q- | Q- | Q- |
| | 1.56 | 1.58 | 1.57 | 24.9 | 24.8 | 24.11 | 24.7 | 24.10 | 24.3 | 24.1 | 1.66 | 22.1 | 22.2 | 22.3 | 22.4 | 22.7 |
| | | | | | I. | I. | I. | I. | I. | I. | I. | I. | I. | I. | I. | I. |
| | I. | I. | I. | I. | 103- | 103- | 103- | 103- | 103- | 103- | 103- | 103- | 103- | 103- | 103- | 103- |
| No. | 103-49 | 103-50 | 103-51 | 103-54 | 55 | 56 | 57 | 58 | 60 | 61 | 62 | 63 | 70 | 71 | 72 | 73 |
| Q | Q- | Q- | Q- | Q- | Q- | Q- | Q- | Q- | Q- | Q- | Q- | Q- | Q- | Q- | Q- | Q- |
| | 22.8 | 22.9 | 22.10 | 22.11 | 1.222 | 1.221 | 24.5 | 24.6 | 1.220 | 1.231 | 1.238 | 1.200 | 1.245 | 1.3 | 1.21 | 1.100 |
| | I. | I. | I. | I. | I. | I. | I. | I. | I. | I. | I. | I. | I. | I. | I. | I. |
| | 103- | 103- | 103- | 103- | 103- | 103- | 103- | 103- | 103- | 103- | 103- | 103- | 103- | 103- | 103- | 103- |
| No. | 74 | 75 | 76 | 77 | 78 | 79 | 80 | 82 | 83 | 84 | 86 | 90 | 91 | 92 | 93 | 95 |
| Q | Q- | Q- | Q- | Q- | Q- | Q- | Q- | Q- | Q- | Q- | Q- | Q- | Q- | Q- | Q- | Q- |
| | 1.113 | 1.27 | 1.15 | 1.39 | 1.120 | 1.106 | 1.45 | 1.116 | 1.99 | 1.125 | 1.93 | 1.128 | 1.134 | 1.143 | 1.190 | 1.176 |
| | | | | | | | | | | | | I. | I. | I. | I. | I. |
| | | | | | | | | | | | | 103- | 103- | 103- | 103- | 103- |
| | | | | | | | | | | | No. | 103 | 105 | 106 | 107 | 108 |
| | | | | | | | | | | | Q | Q- | Q- | Q- | Q- | Q- |
| | | | | | | | | | | | | 1.234 | 1.155 | 1.110 | 1.154 | 1.266 |

TABLE 104
with basic structure I.104 and the Q radicals listed:

| | | | | | | | I. | I. | I. | I. | I. | I. | I. | I. | I. | I. |
|---|---|---|---|---|---|---|---|---|---|---|---|---|---|---|---|---|
| | I. | I. | I. | I. | I. | I. | 104- | 104- | 104- | 104- | 104- | 104- | 104- | 104- | 104- | 104- |
| No. | 104-1 | 104-2 | 104-3 | 104-4 | 104-5 | 104-9 | 11 | 12 | 13 | 14 | 21 | 23 | 24 | 26 | 28 | 29 |
| Q | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 |
| | I. | I. | I. | I. | I. | I. | I. | I. | I. | I. | I. | I. | I. | I. | I. | I. |
| | 104- | 104- | 104- | 104- | 104- | 104- | 104- | 104- | 104- | 104- | 104- | 104- | 104- | 104- | 104- | 104- |
| No. | 33 | 34 | 35 | 36 | 37 | 38 | 39 | 40 | 41 | 42 | 43 | 44 | 45 | 46 | 47 | 48 |
| Q | Q- | Q- | Q- | Q- | Q- | Q- | Q- | Q- | Q- | Q- | Q- | Q- | Q- | Q- | Q- | Q- |
| | 1.56 | 1.58 | 1.57 | 24.9 | 24.8 | 24.11 | 24.7 | 24.10 | 24.3 | 24.1 | 1.66 | 22.1 | 22.2 | 22.3 | 22.4 | 22.7 |
| | | | | | I. | I. | I. | I. | I. | I. | I. | I. | I. | I. | I. | I. |
| | I. | I. | I. | I. | 104- | 104- | 104- | 104- | 104- | 104- | 104- | 104- | 104- | 104- | 104- | 104- |
| No. | 104-49 | 104-50 | 104-51 | 104-54 | 55 | 56 | 57 | 58 | 60 | 61 | 62 | 63 | 70 | 71 | 72 | 73 |
| Q | Q- | Q- | Q- | Q- | Q- | Q- | Q- | Q- | Q- | Q- | Q- | Q- | Q- | Q- | Q- | Q- |
| | 22.8 | 22.9 | 22.10 | 22.11 | 1.222 | 1.221 | 24.5 | 24.6 | 1.220 | 1.231 | 1.238 | 1.200 | 1.245 | 1.3 | 1.21 | 1.100 |
| | I. | I. | I. | I. | I. | I. | I. | I. | I. | I. | I. | I. | I. | I. | I. | I. |
| | 104- | 104- | 104- | 104- | 104- | 104- | 104- | 104- | 104- | 104- | 104- | 104- | 104- | 104- | 104- | 104- |
| No. | 74 | 75 | 76 | 77 | 78 | 79 | 80 | 82 | 83 | 84 | 86 | 90 | 91 | 92 | 93 | 95 |
| Q | Q- | Q- | Q- | Q- | Q- | Q- | Q- | Q- | Q- | Q- | Q- | Q- | Q- | Q- | Q- | Q- |
| | 1.113 | 1.27 | 1.15 | 1.39 | 1.120 | 1.106 | 1.45 | 1.116 | 1.99 | 1.125 | 1.93 | 1.128 | 1.134 | 1.143 | 1.190 | 1.176 |
| | | | | | | | | | | | | I. | I. | I. | I. | I. |
| | | | | | | | | | | | | 104- | 104- | 104- | 104- | 104- |
| | | | | | | | | | | | No. | 103 | 105 | 106 | 107 | 108 |
| | | | | | | | | | | | Q | Q- | Q- | Q- | Q- | Q- |
| | | | | | | | | | | | | 1.234 | 1.155 | 1.110 | 1.154 | 1.266 |

TABLE 105
with basic structure I.105 and the Q radicals listed:

| | | | | | | | I. | I. | I. | I. | I. | I. | I. | I. | I. | I. |
|---|---|---|---|---|---|---|---|---|---|---|---|---|---|---|---|---|
| | I. | I. | I. | I. | I. | I. | 105- | 105- | 105- | 105- | 105- | 105- | 105- | 105- | 105- | 105- |
| No. | 105-1 | 105-2 | 105-3 | 105-4 | 105-5 | 105-9 | 11 | 12 | 13 | 14 | 21 | 23 | 24 | 26 | 28 | 29 |
| Q | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 |
| | I. | I. | I. | I. | I. | I. | I. | I. | I. | I. | I. | I. | I. | I. | I. | I. |
| | 105- | 105- | 105- | 105- | 105- | 105- | 105- | 105- | 105- | 105- | 105- | 105- | 105- | 105- | 105- | 105- |
| No. | 33 | 34 | 35 | 36 | 37 | 38 | 39 | 40 | 41 | 42 | 43 | 44 | 45 | 46 | 47 | 48 |
| Q | Q- | Q- | Q- | Q- | Q- | Q- | Q- | Q- | Q- | Q- | Q- | Q- | Q- | Q- | Q- | Q- |
| | 1.56 | 1.58 | 1.57 | 24.9 | 24.8 | 24.11 | 24.7 | 24.10 | 24.3 | 24.1 | 1.66 | 22.1 | 22.2 | 22.3 | 22.4 | 22.7 |
| | | | | | I. | I. | I. | I. | I. | I. | I. | I. | I. | I. | I. | I. |
| | I. | I. | I. | I. | 105- | 105- | 105- | 105- | 105- | 105- | 105- | 105- | 105- | 105- | 105- | 105- |
| No. | 105-49 | 105-50 | 105-51 | 105-54 | 55 | 56 | 57 | 58 | 60 | 61 | 62 | 63 | 70 | 71 | 72 | 73 |
| Q | Q- | Q- | Q- | Q- | Q- | Q- | Q- | Q- | Q- | Q- | Q- | Q- | Q- | Q- | Q- | Q- |
| | 22.8 | 22.9 | 22.10 | 22.11 | 1.222 | 1.221 | 24.5 | 24.6 | 1.220 | 1.231 | 1.238 | 1.200 | 1.245 | 1.3 | 1.21 | 1.100 |
| | I. | I. | I. | I. | I. | I. | I. | I. | I. | I. | I. | I. | I. | I. | I. | I. |
| | 105- | 105- | 105- | 105- | 105- | 105- | 105- | 105- | 105- | 105- | 105- | 105- | 105- | 105- | 105- | 105- |
| No. | 74 | 75 | 76 | 77 | 78 | 79 | 80 | 82 | 83 | 84 | 86 | 90 | 91 | 92 | 93 | 95 |
| Q | Q- | Q- | Q- | Q- | Q- | Q- | Q- | Q- | Q- | Q- | Q- | Q- | Q- | Q- | Q- | Q- |
| | 1.113 | 1.27 | 1.15 | 1.39 | 1.120 | 1.106 | 1.45 | 1.116 | 1.99 | 1.125 | 1.93 | 1.128 | 1.134 | 1.143 | 1.190 | 1.176 |
| | | | | | | | | | | | | I. | I. | I. | I. | I. |
| | | | | | | | | | | | | 105- | 105- | 105- | 105- | 105- |
| | | | | | | | | | | | No. | 103 | 105 | 106 | 107 | 108 |
| | | | | | | | | | | | Q | Q- | Q- | Q- | Q- | Q- |
| | | | | | | | | | | | | 1.234 | 1.155 | 1.110 | 1.154 | 1.266 |

TABLE 106
with basic structure I.106 and the Q radicals listed:

| | | | | | | | I. | I. | I. | I. | I. | I. | I. | I. | I. | I. |
|---|---|---|---|---|---|---|---|---|---|---|---|---|---|---|---|---|
| | I. | I. | I. | I. | I. | I. | 106- | 106- | 106- | 106- | 106- | 106- | 106- | 106- | 106- | 106- |
| No. | 106-1 | 106-2 | 106-3 | 106-4 | 106-5 | 106-9 | 11 | 12 | 13 | 14 | 21 | 23 | 24 | 26 | 28 | 29 |
| Q | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 |
| | I. | I. | I. | I. | I. | I. | I. | I. | I. | I. | I. | I. | I. | I. | I. | I. |
| | 106- | 106- | 106- | 106- | 106- | 106- | 106- | 106- | 106- | 106- | 106- | 106- | 106- | 106- | 106- | 106- |
| No. | 33 | 34 | 35 | 36 | 37 | 38 | 39 | 40 | 41 | 42 | 43 | 44 | 45 | 46 | 47 | 48 |
| Q | Q- | Q- | Q- | Q- | Q- | Q- | Q- | Q- | Q- | Q- | Q- | Q- | Q- | Q- | Q- | Q- |
| | 1.56 | 1.58 | 1.57 | 24.9 | 24.8 | 24.11 | 24.7 | 24.10 | 24.3 | 24.1 | 1.66 | 22.1 | 22.2 | 22.3 | 22.4 | 22.7 |
| | | | | | I. | I. | I. | I. | I. | I. | I. | I. | I. | I. | I. | I. |
| | I. | I. | I. | I. | 106- | 106- | 106- | 106- | 106- | 106- | 106- | 106- | 106- | 106- | 106- | 106- |
| No. | 106-49 | 106-50 | 106-51 | 106-54 | 55 | 56 | 57 | 58 | 60 | 61 | 62 | 63 | 70 | 71 | 72 | 73 |
| Q | Q- | Q- | Q- | Q- | Q- | Q- | Q- | Q- | Q- | Q- | Q- | Q- | Q- | Q- | Q- | Q- |
| | 22.8 | 22.9 | 22.10 | 22.11 | 1.222 | 1.221 | 24.5 | 24.6 | 1.220 | 1.231 | 1.238 | 1.200 | 1.245 | 1.3 | 1.21 | 1.100 |
| | I. | I. | I. | I. | I. | I. | I. | I. | I. | I. | I. | I. | I. | I. | I. | I. |
| | 106- | 106- | 106- | 106- | 106- | 106- | 106- | 106- | 106- | 106- | 106- | 106- | 106- | 106- | 106- | 106- |
| No. | 74 | 75 | 76 | 77 | 78 | 79 | 80 | 82 | 83 | 84 | 86 | 90 | 91 | 92 | 93 | 95 |
| Q | Q- | Q- | Q- | Q- | Q- | Q- | Q- | Q- | Q- | Q- | Q- | Q- | Q- | Q- | Q- | Q- |
| | 1.113 | 1.27 | 1.15 | 1.39 | 1.120 | 1.106 | 1.45 | 1.116 | 1.99 | 1.125 | 1.93 | 1.128 | 1.134 | 1.143 | 1.190 | 1.176 |
| | | | | | | | | | | | | I. | I. | I. | I. | I. |
| | | | | | | | | | | | | 106- | 106- | 106- | 106- | 106- |
| | | | | | | | | | | | No. | 103 | 105 | 106 | 107 | 108 |
| | | | | | | | | | | | Q | Q- | Q- | Q- | Q- | Q- |
| | | | | | | | | | | | | 1.234 | 1.155 | 1.110 | 1.154 | 1.266 |

TABLE 107
with basic structure I.107 and the Q radicals listed:

| | | | | | | | I. | I. | I. | I. | I. | I. | I. | I. | I. | I. |
|---|---|---|---|---|---|---|---|---|---|---|---|---|---|---|---|---|
| | I. | I. | I. | I. | I. | I. | 107- | 107- | 107- | 107- | 107- | 107- | 107- | 107- | 107- | 107- |
| No. | 107-1 | 107-2 | 107-3 | 107-4 | 107-5 | 107-9 | 11 | 12 | 13 | 14 | 21 | 23 | 24 | 26 | 28 | 29 |
| Q | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 |
| | I. | I. | I. | I. | I. | I. | I. | I. | I. | I. | I. | I. | I. | I. | I. | I. |
| | 107- | 107- | 107- | 107- | 107- | 107- | 107- | 107- | 107- | 107- | 107- | 107- | 107- | 107- | 107- | 107- |
| No. | 33 | 34 | 35 | 36 | 37 | 38 | 39 | 40 | 41 | 42 | 43 | 44 | 45 | 46 | 47 | 48 |
| Q | Q- | Q- | Q- | Q- | Q- | Q- | Q- | Q- | Q- | Q- | Q- | Q- | Q- | Q- | Q- | Q- |
| | 1.56 | 1.58 | 1.57 | 24.9 | 24.8 | 24.11 | 24.7 | 24.10 | 24.3 | 24.1 | 1.66 | 22.1 | 22.2 | 22.3 | 22.4 | 22.7 |
| | | | | | I. | I. | I. | I. | I. | I. | I. | I. | I. | I. | I. | I. |
| | I. | I. | I. | I. | 107- | 107- | 107- | 107- | 107- | 107- | 107- | 107- | 107- | 107- | 107- | 107- |
| No. | 107-49 | 107-50 | 107-51 | 107-54 | 55 | 56 | 57 | 58 | 60 | 61 | 62 | 63 | 70 | 71 | 72 | 73 |
| Q | Q- | Q- | Q- | Q- | Q- | Q- | Q- | Q- | Q- | Q- | Q- | Q- | Q- | Q- | Q- | Q- |
| | 22.8 | 22.9 | 22.10 | 22.11 | 1.222 | 1.221 | 24.5 | 24.6 | 1.220 | 1.231 | 1.238 | 1.200 | 1.245 | 1.3 | 1.21 | 1.100 |
| | I. | I. | I. | I. | I. | I. | I. | I. | I. | I. | I. | I. | I. | I. | I. | I. |
| | 107- | 107- | 107- | 107- | 107- | 107- | 107- | 107- | 107- | 107- | 107- | 107- | 107- | 107- | 107- | 107- |
| No. | 74 | 75 | 76 | 77 | 78 | 79 | 80 | 82 | 83 | 84 | 86 | 90 | 91 | 92 | 93 | 95 |
| Q | Q- | Q- | Q- | Q- | Q- | Q- | Q- | Q- | Q- | Q- | Q- | Q- | Q- | Q- | Q- | Q- |
| | 1.113 | 1.27 | 1.15 | 1.39 | 1.120 | 1.106 | 1.45 | 1.116 | 1.99 | 1.125 | 1.93 | 1.128 | 1.134 | 1.143 | 1.190 | 1.176 |
| | | | | | | | | | | | | I. | I. | I. | I. | I. |
| | | | | | | | | | | | | 107- | 107- | 107- | 107- | 107- |
| | | | | | | | | | | | No. | 103 | 105 | 106 | 107 | 108 |
| | | | | | | | | | | | Q | Q- | Q- | Q- | Q- | Q- |
| | | | | | | | | | | | | 1.234 | 1.155 | 1.110 | 1.154 | 1.266 |

TABLE 108
with basic structure I.108 and the Q radicals listed:

| | | | | | | | I. | I. | I. | I. | I. | I. | I. | I. | I. | I. |
|---|---|---|---|---|---|---|---|---|---|---|---|---|---|---|---|---|
| | I. | I. | I. | I. | I. | I. | 108- | 108- | 108- | 108- | 108- | 108- | 108- | 108- | 108- | 108- |
| No. | 108-1 | 108-2 | 108-3 | 108-4 | 108-5 | 108-9 | 11 | 12 | 13 | 14 | 21 | 23 | 24 | 26 | 28 | 29 |
| Q | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 |
| | I. | I. | I. | I. | I. | I. | I. | I. | I. | I. | I. | I. | I. | I. | I. | I. |
| | 108- | 108- | 108- | 108- | 108- | 108- | 108- | 108- | 108- | 108- | 108- | 108- | 108- | 108- | 108- | 108- |
| No. | 33 | 34 | 35 | 36 | 37 | 38 | 39 | 40 | 41 | 42 | 43 | 44 | 45 | 46 | 47 | 48 |
| Q | Q- | Q- | Q- | Q- | Q- | Q- | Q- | Q- | Q- | Q- | Q- | Q- | Q- | Q- | Q- | Q- |
| | 1.56 | 1.58 | 1.57 | 24.9 | 24.8 | 24.11 | 24.7 | 24.10 | 24.3 | 24.1 | 1.66 | 22.1 | 22.2 | 22.3 | 22.4 | 22.7 |
| | | | | | I. | I. | I. | I. | I. | I. | I. | I. | I. | I. | I. | I. |
| | I. | I. | I. | I. | 108- | 108- | 108- | 108- | 108- | 108- | 108- | 108- | 108- | 108- | 108- | 108- |
| No. | 108-49 | 108-50 | 108-51 | 108-54 | 55 | 56 | 57 | 58 | 60 | 61 | 62 | 63 | 70 | 71 | 72 | 73 |
| Q | Q- | Q- | Q- | Q- | Q- | Q- | Q- | Q- | Q- | Q- | Q- | Q- | Q- | Q- | Q- | Q- |
| | 22.8 | 22.9 | 22.10 | 22.11 | 1.222 | 1.221 | 24.5 | 24.6 | 1.220 | 1.231 | 1.238 | 1.200 | 1.245 | 1.3 | 1.21 | 1.100 |
| | I. | I. | I. | I. | I. | I. | I. | I. | I. | I. | I. | I. | I. | I. | I. | I. |
| | 108- | 108- | 108- | 108- | 108- | 108- | 108- | 108- | 108- | 108- | 108- | 108- | 108- | 108- | 108- | 108- |
| No. | 74 | 75 | 76 | 77 | 78 | 79 | 80 | 82 | 83 | 84 | 86 | 90 | 91 | 92 | 93 | 95 |
| Q | Q- | Q- | Q- | Q- | Q- | Q- | Q- | Q- | Q- | Q- | Q- | Q- | Q- | Q- | Q- | Q- |
| | 1.113 | 1.27 | 1.15 | 1.39 | 1.120 | 1.106 | 1.45 | 1.116 | 1.99 | 1.125 | 1.93 | 1.128 | 1.134 | 1.143 | 1.190 | 1.176 |
| | | | | | | | | | | | | I. | I. | I. | I. | I. |
| | | | | | | | | | | | | 108- | 108- | 108- | 108- | 108- |
| | | | | | | | | | | | No. | 103 | 105 | 106 | 107 | 108 |
| | | | | | | | | | | | Q | Q- | Q- | Q- | Q- | Q- |
| | | | | | | | | | | | | 1.234 | 1.155 | 1.110 | 1.154 | 1.266 |

TABLE 109
with basic structure I.109 and the Q radicals listed:

| | | | | | | | I. | I. | I. | I. | I. | I. | I. | I. | I. | I. | I. | I. |
|---|---|---|---|---|---|---|---|---|---|---|---|---|---|---|---|---|---|---|
| | I. | I. | I. | I. | I. | I. | 109- | 109- | 109- | 109- | 109- | 109- | 109- | 109- | 109- | 109- | 109- | 109- |
| No. | 109-1 | 109-2 | 109-3 | 109-4 | 109-5 | 109-9 | 11 | 12 | 13 | 14 | 21 | 23 | 24 | 26 | 28 | 29 | 33 | 34 |
| Q | Q- | Q- | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 | 1.56 | 1.58 |
| | I. | I. | I. | I. | I. | I. | I. | I. | I. | I. | I. | I. | I. | I. | I. | I. | I. | I. |
| | 109- | 109- | 109- | 109- | 109- | 109- | 109- | 109- | 109- | 109- | 109- | 109- | 109- | 109- | 109- | 109- | 109- | 109- |
| No. | 35 | 36 | 37 | 38 | 39 | 40 | 41 | 42 | 43 | 44 | 45 | 46 | 47 | 48 | 49 | 50 | 51 | 54 |
| Q | Q- | Q- | Q- | Q- | Q- | Q- | Q- | Q- | Q- | Q- | Q- | Q- | Q- | Q- | Q- | Q- | Q- | Q- |
| | 1.57 | 24.9 | 24.8 | 24.11 | 24.7 | 24.10 | 24.3 | 24.1 | 1.66 | 22.1 | 22.2 | 22.3 | 22.4 | 22.7 | 22.8 | 22.9 | 22.10 | 22.11 |
| | I. | I. | I. | I. | I. | I. | I. | I. | I. | I. | I. | I. | I. | I. | I. | I. | I. | I. |
| | 109- | 109- | 109- | 109- | 109- | 109- | 109- | 109- | 109- | 109- | 109- | 109- | 109- | 109- | 109- | 109- | 109- | 109- |
| No. | 55 | 56 | 57 | 58 | 60 | 61 | 62 | 63 | 70 | 71 | 72 | 73 | 74 | 75 | 76 | 77 | 78 | 79 |
| Q | Q- | Q- | Q- | Q- | Q- | Q- | Q- | Q- | Q- | Q- | Q- | Q- | Q- | Q- | Q- | Q- | Q- | Q- |
| | 1.222 | 1.221 | 24.5 | 24.6 | 1.220 | 1.231 | 1.238 | 1.200 | 1.245 | 1.3 | 1.21 | 1.100 | 1.113 | 1.27 | 1.15 | 1.39 | 1.120 | 1.106 |
| | | | | I. | I. | I. | I. | I. | I. | I. | I. | I. | I. | I. | I. | I. | I. | I. |
| | | | | 109- | 109- | 109- | 109- | 109- | 109- | 109- | 109- | 109- | 109- | 109- | 109- | 109- | 109- | 109- |
| | | | No. | 80 | 82 | 83 | 84 | 86 | 90 | 91 | 92 | 93 | 95 | 103 | 105 | 106 | 107 | 108 |
| | | | Q | Q- | Q- | Q- | Q- | Q- | Q- | Q- | Q- | Q- | Q- | Q- | Q- | Q- | Q- | Q- |
| | | | | 1.45 | 1.116 | 1.99 | 1.125 | 1.93 | 1.128 | 1.134 | 1.143 | 1.190 | 1.176 | 1.234 | 1.155 | 1.110 | 1.154 | 1.266 |

TABLE 110
with basic structure I.110 and the Q radicals listed:

| | | | | | | | I. | I. | I. | I. | I. | I. | I. | I. | I. | I. |
|---|---|---|---|---|---|---|---|---|---|---|---|---|---|---|---|---|
| | I. | I. | I. | I. | I. | I. | 110- | 110- | 110- | 110- | 110- | 110- | 110- | 110- | 110- | 110- |
| No. | 110-1 | 110-2 | 110-3 | 110-4 | 110-5 | 110-9 | 11 | 12 | 13 | 14 | 21 | 23 | 24 | 26 | 28 | 29 |
| Q | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 |
| | I. | I. | I. | I. | I. | I. | I. | I. | I. | I. | I. | I. | I. | I. | I. | I. |
| | 110- | 110- | 110- | 110- | 110- | 110- | 110- | 110- | 110- | 110- | 110- | 110- | 110- | 110- | 110- | 110- |
| No. | 33 | 34 | 35 | 36 | 37 | 38 | 39 | 40 | 41 | 42 | 43 | 44 | 45 | 46 | 47 | 48 |
| Q | Q- | Q- | Q- | Q- | Q- | Q- | Q- | Q- | Q- | Q- | Q- | Q- | Q- | Q- | Q- | Q- |
| | 1.56 | 1.58 | 1.57 | 24.9 | 24.8 | 24.11 | 24.7 | 24.10 | 24.3 | 24.1 | 1.66 | 22.1 | 22.2 | 22.3 | 22.4 | 22.7 |
| | | | | | I. | I. | I. | I. | I. | I. | I. | I. | I. | I. | I. | I. |
| | I. | I. | I. | I. | 110- | 110- | 110- | 110- | 110- | 110- | 110- | 110- | 110- | 110- | 110- | 110- |
| No. | 110-49 | 110-50 | 110-51 | 110-54 | 55 | 56 | 57 | 58 | 60 | 61 | 62 | 63 | 70 | 71 | 72 | 73 |
| Q | Q- | Q- | Q- | Q- | Q- | Q- | Q- | Q- | Q- | Q- | Q- | Q- | Q- | Q- | Q- | Q- |
| | 22.8 | 22.9 | 22.10 | 22.11 | 1.222 | 1.221 | 24.5 | 24.6 | 1.220 | 1.231 | 1.238 | 1.200 | 1.245 | 1.3 | 1.21 | 1.100 |
| | I. | I. | I. | I. | I. | I. | I. | I. | I. | I. | I. | I. | I. | I. | I. | I. |
| | 110- | 110- | 110- | 110- | 110- | 110- | 110- | 110- | 110- | 110- | 110- | 110- | 110- | 110- | 110- | 110- |
| No. | 74 | 75 | 76 | 77 | 78 | 79 | 80 | 82 | 83 | 84 | 86 | 90 | 91 | 92 | 93 | 95 |
| Q | Q- | Q- | Q- | Q- | Q- | Q- | Q- | Q- | Q- | Q- | Q- | Q- | Q- | Q- | Q- | Q- |
| | 1.113 | 1.27 | 1.15 | 1.39 | 1.120 | 1.106 | 1.45 | 1.116 | 1.99 | 1.125 | 1.93 | 1.128 | 1.134 | 1.143 | 1.190 | 1.176 |
| | | | | | | | | | | | | I. | I. | I. | I. | I. |
| | | | | | | | | | | | | 110- | 110- | 110- | 110- | 110- |
| | | | | | | | | | | | No. | 103 | 105 | 106 | 107 | 108 |
| | | | | | | | | | | | Q | Q- | Q- | Q- | Q- | Q- |
| | | | | | | | | | | | | 1.234 | 1.155 | 1.110 | 1.154 | 1.266 |

TABLE 111
with basic structure I.111 and the Q radicals listed:

| | | | | | | | I. | I. | I. | I. | I. | I. | I. | I. | I. | I. |
|---|---|---|---|---|---|---|---|---|---|---|---|---|---|---|---|---|
| | I. | I. | I. | I. | I. | I. | 111- | 111- | 111- | 111- | 111- | 111- | 111- | 111- | 111- | 111- |
| No. | 111-1 | 111-2 | 111-3 | 111-4 | 111-5 | 111-9 | 11 | 12 | 13 | 14 | 21 | 23 | 24 | 26 | 28 | 29 |
| Q | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 |
| | I. | I. | I. | I. | I. | I. | I. | I. | I. | I. | I. | I. | I. | I. | I. | I. |
| | 111- | 111- | 111- | 111- | 111- | 111- | 111- | 111- | 111- | 111- | 111- | 111- | 111- | 111- | 111- | 111- |
| No. | 33 | 34 | 35 | 36 | 37 | 38 | 39 | 40 | 41 | 42 | 43 | 44 | 45 | 46 | 47 | 48 |
| Q | Q- | Q- | Q- | Q- | Q- | Q- | Q- | Q- | Q- | Q- | Q- | Q- | Q- | Q- | Q- | Q- |
| | 1.56 | 1.58 | 1.57 | 24.9 | 24.8 | 24.11 | 24.7 | 24.10 | 24.3 | 24.1 | 1.66 | 22.1 | 22.2 | 22.3 | 22.4 | 22.7 |
| | | | | | I. | I. | I. | I. | I. | I. | I. | I. | I. | I. | I. | I. |
| | I. | I. | I. | I. | 111- | 111- | 111- | 111- | 111- | 111- | 111- | 111- | 111- | 111- | 111- | 111- |
| No. | 111-49 | 111-50 | 111-51 | 111-54 | 55 | 56 | 57 | 58 | 60 | 61 | 62 | 63 | 70 | 71 | 72 | 73 |
| Q | Q- | Q- | Q- | Q- | Q- | Q- | Q- | Q- | Q- | Q- | Q- | Q- | Q- | Q- | Q- | Q- |
| | 22.8 | 22.9 | 22.10 | 22.11 | 1.222 | 1.221 | 24.5 | 24.6 | 1.220 | 1.231 | 1.238 | 1.200 | 1.245 | 1.3 | 1.21 | 1.100 |
| | I. | I. | I. | I. | I. | I. | I. | I. | I. | I. | I. | I. | I. | I. | I. | I. |
| | 111- | 111- | 111- | 111- | 111- | 111- | 111- | 111- | 111- | 111- | 111- | 111- | 111- | 111- | 111- | 111- |
| No. | 74 | 75 | 76 | 77 | 78 | 79 | 80 | 82 | 83 | 84 | 86 | 90 | 91 | 92 | 93 | 95 |
| Q | Q- | Q- | Q- | Q- | Q- | Q- | Q- | Q- | Q- | Q- | Q- | Q- | Q- | Q- | Q- | Q- |
| | 1.113 | 1.27 | 1.15 | 1.39 | 1.120 | 1.106 | 1.45 | 1.116 | 1.99 | 1.125 | 1.93 | 1.128 | 1.134 | 1.143 | 1.190 | 1.176 |
| | | | | | | | | | | | | I. | I. | I. | I. | I. |
| | | | | | | | | | | | | 111- | 111- | 111- | 111- | 111- |
| | | | | | | | | | | | No. | 103 | 105 | 106 | 107 | 108 |
| | | | | | | | | | | | Q | Q- | Q- | Q- | Q- | Q- |
| | | | | | | | | | | | | 1.234 | 1.155 | 1.110 | 1.154 | 1.266 |

TABLE 112
with basic structure I.112 and the Q radicals listed:

| | | | | | | | I. | I. | I. | I. | I. | I. | I. | I. | I. | I. |
|---|---|---|---|---|---|---|---|---|---|---|---|---|---|---|---|---|
| | I. | I. | I. | I. | I. | I. | 112- | 112- | 112- | 112- | 112- | 112- | 112- | 112- | 112- | 112- |
| No. | 112-1 | 112-2 | 112-3 | 112-4 | 112-5 | 112-9 | 11 | 12 | 13 | 14 | 21 | 23 | 24 | 26 | 28 | 29 |
| Q | Q- | Q- | Q- | Q- | Q- | Q- | Q- | Q- | Q- | Q- | Q- | Q- | Q- | Q- | Q- | Q- |
| | 20.1 | 20.2 | 20.5 | 1.25 | 1.67 | 1.68 | 1.69 | 1.70 | 1.71 | 1.72 | 1.73 | 1.75 | 20.6 | 1.247 | 1.208 | 1.207 |
| | I. | I. | I. | I. | I. | I. | I. | I. | I. | I. | I. | I. | I. | I. | I. | I. |
| | 112- | 112- | 112- | 112- | 112- | 112- | 112- | 112- | 112- | 112- | 112- | 112- | 112- | 112- | 112- | 112- |
| No. | 33 | 34 | 35 | 36 | 37 | 38 | 39 | 40 | 41 | 42 | 43 | 44 | 45 | 46 | 47 | 48 |
| Q | Q- | Q- | Q- | Q- | Q- | Q- | Q- | Q- | Q- | Q- | Q- | Q- | Q- | Q- | Q- | Q- |
| | 1.56 | 1.58 | 1.57 | 24.9 | 24.8 | 24.11 | 24.7 | 24.10 | 24.3 | 24.1 | 1.66 | 22.1 | 22.2 | 22.3 | 22.4 | 22.7 |
| | | | | | I. | I. | I. | I. | I. | I. | I. | I. | I. | I. | I. | I. |
| | I. | I. | I. | I. | 112- | 112- | 112- | 112- | 112- | 112- | 112- | 112- | 112- | 112- | 112- | 112- |
| No. | 112-49 | 112-50 | 112-51 | 112-54 | 55 | 56 | 57 | 58 | 60 | 61 | 62 | 63 | 70 | 71 | 72 | 73 |
| Q | Q- | Q- | Q- | Q- | Q- | Q- | Q- | Q- | Q- | Q- | Q- | Q- | Q- | Q- | Q- | Q- |
| | 22.8 | 22.9 | 22.10 | 22.11 | 1.222 | 1.221 | 24.5 | 24.6 | 1.220 | 1.231 | 1.238 | 1.200 | 1.245 | 1.3 | 1.21 | 1.100 |
| | I. | I. | I. | I. | I. | I. | I. | I. | I. | I. | I. | I. | I. | I. | I. | I. |
| | 112- | 112- | 112- | 112- | 112- | 112- | 112- | 112- | 112- | 112- | 112- | 112- | 112- | 112- | 112- | 112- |
| No. | 74 | 75 | 76 | 77 | 78 | 79 | 80 | 82 | 83 | 84 | 86 | 90 | 91 | 92 | 93 | 95 |
| Q | Q- | Q- | Q- | Q- | Q- | Q- | Q- | Q- | Q- | Q- | Q- | Q- | Q- | Q- | Q- | Q- |
| | 1.113 | 1.27 | 1.15 | 1.39 | 1.120 | 1.106 | 1.45 | 1.116 | 1.99 | 1.125 | 1.93 | 1.128 | 1.134 | 1.143 | 1.190 | 1.176 |
| | | | | | | | | | | | | I. | I. | I. | I. | I. |
| | | | | | | | | | | | | 112- | 112- | 112- | 112- | 112- |
| | | | | | | | | | | | No. | 103 | 105 | 106 | 107 | 108 |
| | | | | | | | | | | | Q | Q- | Q- | Q- | Q- | Q- |
| | | | | | | | | | | | | 1.234 | 1.155 | 1.110 | 1.154 | 1.266 |

Spectroscopic data of selected chemical examples:

### EXAMPLE NO. I.1-1

¹H NMR (400 MHz, CDCl₃ δ, ppm) 7.77 (d, 2H), 7.71 (d, 2H), 5.02 (br. t, 1H, NH), 4.06 (d, 2H).

### EXAMPLE NO. I.1-2

¹H NMR (400 MHz, CDCl₃ δ, ppm) 7.78 (d, 2H), 7.73 (d, 2H), 5.11 (br. d, 1H, NH), 4.36 (quint, 1H), 1.59 (d, 3H).

### EXAMPLE NO. I.1-3

¹H NMR (400 MHz, CDCl₃ δ, ppm) 7.81 (d, 2H), 7.69 (d, 2H), 5.17 (br. s, 1H, NH), 1.67 (s, 6H).

### EXAMPLE NO. I.1-4

¹H NMR (400 MHz, CDCl₃ δ, ppm) 7.78 (d, 2H), 7.72 (d, 2H), 5.27 (br. d, 1H, NH), 4.06 (dd, 1H), 2.07 (m, 1H), 1.08 (d, 6H).

### EXAMPLE NO. I.1-5

¹H NMR (400 MHz, CDCl₃ δ, ppm) 7.80 (d, 2H), 7.68 (d, 2H), 4.98 (br. s, 1H, NH), 1.82 (sext, 2H), 1.65 (s, 3H), 1.47 (sext, 2H), 0.96 (t, 3H).

### EXAMPLE NO. I.1-9

¹H NMR (400 MHz, CDCl₃ δ, ppm) 7.81 (d, 2H), 7.71 (d, 2H), 5.44 (br. s, 1H, NH), 3.56 (d, 1H), 3.47 (d, 1H), 3.44 (s, 3H), 1.65 (s, 3H).

### EXAMPLE NO. I.1-11

¹H NMR (400 MHz, CDCl₃ δ, ppm) 7.81 (d, 2H), 7.69 (d, 2H), 5.22 (br. s, 1H, NH), 1.72 (s, 3H), 1.18 (m, 1H), 0.62 (m, 4H).

### EXAMPLE NO. I.1-12

¹H NMR (400 MHz, CDCl₃ δ, ppm) 7.80 (d, 2H), 7.69 (d, 2H), 4.72 (br. s, 1H, NH), 1.92 (m, 4H), 1.00 (t, 6H).

### EXAMPLE NO. I.1-13

¹H NMR (400 MHz, CDCl₃ δ, ppm) 7.80 (d, 2H), 7.71 (d, 2H), 4.92 (br. s, 1H, NH), 1.90 (m, 2H), 1.64 (s, 3H), 1.06 (t, 3H).

### EXAMPLE NO. I.1-14

¹H NMR (400 MHz, CDCl₃ δ, ppm) 7.82 (d, 2H), 7.69 (d, 2H), 5.02 (br. s, 1H, NH), 1.82 (m, 1H), 1.78 (dd, 1H), 1.69 (dd, 1H), 1.68 (s, 3H), 0.99 (d, 6H).

### EXAMPLE NO. I.1-21

¹H NMR (400 MHz, CDCl₃ δ, ppm) 7.82 (d, 2H), 7.71 (d, 2H), 5.03 (br. s, 1H, NH), 1.75 (m, 2H), 1.62 (s, 3H), 1.08 (m, 1H), 1.02 (m, 3H), 0.92 (m, 3H).

### EXAMPLE NO. I.1-23

¹H NMR (400 MHz, CDCl₃ δ, ppm) 7.64 (d, 2H), 7.61 (d, 2H), 7.39 (m, 3H), 7.32 (m, 2H), 4.83 (br. s, 1H, NH), 3.21 (d, 1H), 3.06 (d, 1H), 1.68 (s, 3H).

### EXAMPLE NO. I.1-24

¹H NMR (400 MHz, CDCl₃ δ, ppm) 7.74 (d, 2H), 7.68 (d, 2H), 5.29 (br. t, 1H, NH), 3.25 (q, 2H), 2.62 (t, 2H).

### EXAMPLE NO. I.1-28

¹H NMR (400 MHz, CDCl₃ δ, ppm) 7.74 (d, 2H), 7.62 (d, 2H), 5.26 (br. d, 1H, NH), 4.03 (q, 2H), 3.33 (m, 1H), 2.42 (dd, 1H), 2.31 (dd, 1H), 1.80 (m, 1H), 1.22 (t, 3H), 0.85 (d, 3H), 0.82 (d, 3H).

### EXAMPLE NO. I.1-33

¹H NMR (400 MHz, d₆-DMSO δ, ppm) 8.71 (br. s, 1H, NH), 7.57 (d, 2H), 7.43 (d, 2H), 7.32 (d, 1H), 7.25 (d, 1H), 7.12 (m, 2H), 5.18 (t, 1H), 3.97 (q, 2H), 2.62 (m, 2H), 1.11 (t, 3H).

### EXAMPLE NO. I.1-35

¹H NMR (400 MHz, d₆-DMSO δ, ppm) 8.56 (br. s, 1H, NH), 7.58 (d, 2H), 7.42 (d, 2H), 7.31 (d, 2H), 7.07 (d, 2H), 4.61 (t, 1H), 3.48 (s, 3H), 2.70 (m, 2H).

### EXAMPLE NO. I.1-41

¹H NMR (400 MHz, CDCl₃ δ, ppm) 7.74 (d, 2H), 7.64 (d, 2H), 5.25-5.30 (br. d, 1H, NH), 4.05-4.15 (m, 2H), 3.68-3.75 (m, 1H), 2.42 (m, 2H), 1.22-1.25 (t, 3H), 1.17-1.19 (d, 3H).

### EXAMPLE NO. I.1-60

¹H NMR (400 MHz, d₆-DMSO δ, ppm) 8.54 (br. d, 1H, NH), 7.55 (d, 2H), 7.43 (d, 2H), 7.12 (m, 5H), 4.66 (m, 1H), 3.94 (q, 2H), 2.71 (dd, 1H), 2.67 (dd, 1H), 1.08 (t, 3H).

### EXAMPLE NO. I.1-61

¹H NMR (400 MHz, d₆-DMSO δ, ppm) 8.05 (br. d, 1H, NH), 7.64 (d, 2H), 7.50 (d, 2H), 7.17 (m, 3H), 7.04 (m, 2H), 3.68 (m, 1H), 3.46 (s, 3H), 2.63 (m, 2H), 2.39 (m, 2H).

### EXAMPLE NO. I.1-62

¹H NMR (400 MHz, d₆-DMSO δ, ppm) 7.89 (br. d, 1H, NH), 7.82 (d, 2H), 7.69 (d, 2H), 3.92 (q, 2H), 3.49 (m, 1H), 2.32 (dd, 1H), 2.28 (dd, 1H), 1.44 (m, 1H), 1.24 (m, 1H), 1.12 (t, 3H), 1.09 (m, 1H), 0.75 (d, 3H), 0.60 (d, 3H).

### EXAMPLE NO. I.1-63

¹H NMR (400 MHz, d₆-DMSO δ, ppm) 8.64 (br. d, 1H, NH), 7.82 (d, 2H), 7.68 (d, 2H), 4.22 (m, 1H), 3.52 (s, 3H), 3.42 (s, 3H), 2.74 (dd, 1H), 2.61 (dd, 1H).

### EXAMPLE NO. I.1-74

¹H NMR (400 MHz, d₆-DMSO δ, ppm) 8.82 (s, 1H), 8.66 (br. d, 1H, NH), 7.78 (d, 2H), 7.57 (d, 2H), 7.31 (s, 1H), 4.21 (m, 1H), 3.77 (s, 3H), 3.46 (s, 3H), 3.04 (dd, 1H), 2.88 (dd, 1H).

### EXAMPLE NO. I.1-75

¹H NMR (400 MHz, d₆-DMSO δ, ppm) 8.40 (br. d, 1H, NH), 7.79 (d, 2H), 7.66 (d, 2H), 3.57 (m, 1H), 3.38 (s, 3H), 1.90 (m, 1H), 0.80 (d, 3H), 0.78 (d, 3H).

### EXAMPLE NO. I.1-77

¹H NMR (400 MHz, d₆-DMSO δ, ppm) 8.44 (br. d, 1H, NH), 7.79 (d, 2H), 7.67 (d, 2H), 3.77 (m, 1H), 3.39 (s, 3H), 1.57 (m, 1H), 2.42 (m, 2H), 0.81 (d, 3H), 0.71 (d, 3H).

### EXAMPLE NO. I.1-79

¹H NMR (400 MHz, d₆-DMSO δ, ppm) 8.51 (br. m, 1H, NH), 7.82 (d, 2H), 7.68 (d, 2H), 3.98 (m, 1H), 3.44 (s, 3H), 2.41 (m, 1H), 2.32 (m, 1H), 1.94 (s, 3H), 1.82 (m, 1H), 1.77 (m, 1H).

### EXAMPLE NO. I.1-80

¹H NMR (400 MHz, d₆-DMSO δ, ppm) 8.62 (br. d, 1H, NH), 7.68 (d, 2H), 7.50 (d, 2H), 7.19 (m, 3H), 7.11 (m, 2H), 3.97 (m, 1H), 3.81 (q, 2H), 2.92 (dd, 1H), 2.78 (dd, 1H), 0.97 (t, 3H).

### EXAMPLE NO. I.1-82

¹H NMR (400 MHz, d₆-DMSO δ, ppm) 8.65 (br. d, 1H, NH), 8.42 (d, 1H), 8.40 (d, 1H), 7.68 (m, 3H), 7.47 (d, 2H), 7.30 (dd, 1H), 4.11 (m, 1H), 3.42 (s, 3H), 3.02 (dd, 1H), 2.80 (dd, 1H).

### EXAMPLE NO. I.1-83

¹H NMR (400 MHz, d₆-DMSO δ, ppm) 7.86 (br. d, 1H, NH), 7.80 (d, 2H), 7.68 (d, 2H), 3.41 (m, 1H), 3.37 (s, 3H), 2.45 (dd, 1H), 2.17 (dd, 1H), 1.62 (m, 2H), 1.55 (m, 2H), 1.49 (m, 1H), 1.28 (m, 1H), 1.05 (m, 3H), 0.88 (m, 1H), 0.82 (m, 1H).

### EXAMPLE NO. I.1-84

¹H NMR (400 MHz, d₆-DMSO δ, ppm) 8.43 (br. d, 1H, NH), 7.79 (d, 2H), 7.67 (d, 2H), 6.76 (br. t, 1H, NH), 3.78 (m, 1H), 3.39 (s, 3H), 2.82 (m, 2H), 1.59 (m, 1H), 1.50 (m, 1H), 1.36 (s, 9H), 1.20 (m, 2H).

### EXAMPLE NO. I.1-86

¹H NMR (400 MHz, d₆-DMSO δ, ppm) 8.68 (br. d, 1H, NH), 7.80 (d, 2H), 7.70 (d, 2H), 3.99 (m, 1H), 3.43 (s, 3H), 2.89 (s, 1H), 2.58 (m, 1H), 2.50 (m, 1H).

### EXAMPLE NO. I.1-90

¹H NMR (400 MHz, d₆-DMSO δ, ppm) 8.62 (br. d, 1H, NH), 7.66 (d, 2H), 7.47 (d, 2H), 7.14 (m, 2H), 6.98 (m, 2H), 3.97 (m, 1H), 3.44 (s, 3H), 2.96 (dd, 1H), 2.73 (dd, 1H).

### EXAMPLE NO. I.1-92

¹H NMR (400 MHz, d₆-DMSO δ, ppm) 8.50 (br. d, 1H, NH), 7.70 (d, 2H), 7.68 (d, 2H), 7.28 (m, 6H), 7.19 (m, 4H), 4.97 (d, 1H), 4.87 (d, 1H), 4.45 (d, 1H), 4.27 (d, 1H), 4.08 (m, 1H), 3.96 (m, 1H), 0.93 (d, 3H).

### EXAMPLE NO. I.1-103

¹H NMR (400 MHz, d₆-DMSO δ, ppm) 8.98 (br. d, 1H, NH), 7.80 (d, 2H), 7.68 (d, 2H), 4.32 (m, 1H), 3.87 (q, 2H), 2.78 (dd, 1H), 2.42 (dd, 1H), 1.11 (t, 3H).

### EXAMPLE NO. I.1-106

¹H NMR (400 MHz, d₆-DMSO δ, ppm) 13.74 (br. s, 1H, NH), 8.93 (br. d, 1H, NH), 8.90 (s, 1H), 7.60 (d, 2H), 7.43 (s, 1H), 7.38 (d, 2H), 4.36 (m, 1H), 3.74 (s, 3H), 3.22 (dd, 1H), 3.18 (dd, 1H).

### EXAMPLE NO. I.1-108

¹H NMR (400 MHz, d₆-DMSO δ, ppm) 8.75 (br. d, 1H, NH), 8.42 (m, 2H), 7.64 (d, 2H), 7.52 (d, 2H), 7.28 (m, 2H), 4.68 (q, 2H), 3.48 (s, 3H), 2.73 (m, 2H).

### EXAMPLE NO. I.2-1

¹H NMR (400 MHz, d₆-DMSO δ, ppm), 8.88 (br. t, 1H, NH), 8.59 (d, 1H), 8.27 (d, 1H), 8.18 (d, 1H), 8.11 (d, 1H), 7.72 (m, 1H), 7.68 (m, 2H), 4.09 (d, 2H).

### EXAMPLE NO. I.2-2

¹H NMR (400 MHz, d₆-DMSO δ, ppm), 8.99 (br. d, 1H, NH), 8.57 (d, 1H), 8.28 (d, 1H), 8.19 (d, 1H), 8.11 (d, 1H), 7.73 (m, 1H), 7.67 (m, 2H), 4.42 (m, 1H), 1.29 (d, 3H).

### EXAMPLE NO. I.2-3

¹H NMR (400 MHz, d₆-DMSO δ, ppm), 8.88 (br. s, 1H, NH), 8.61 (d, 1H), 8.26 (d, 1H), 8.23 (d, 1H), 8.10 (d, 1H), 7.72 (m, 1H), 7.68 (m, 2H), 1.49 (s, 6H).

### EXAMPLE NO. I.2-4

¹H NMR (400 MHz, d₆-DMSO δ, ppm), 8.98 (br. d, 1H, NH), 8.53 (d, 1H), 8.28 (d, 1H), 8.20 (d, 1H), 8.10 (d, 1H), 7.73 (m, 1H), 7.67 (m, 2H), 4.12 (dd, 1H), 1.82 (m, 1H), 0.84 (d, 3H), 0.78 (d, 3H).

### EXAMPLE NO. I.2-9

¹H NMR (400 MHz, d₆-DMSO δ, ppm), 8.91 (br. s, 1H, NH), 8.60 (d, 1H), 8.25 (d, 1H), 8.23 (d, 1H), 8.10 (d, 1H), 7.70 (m, 1H), 7.65 (m, 2H), 3.59 (d, 1H), 3.40 (d, 1H), 3.19 (s, 3H), 1.48 (s, 3H).

### EXAMPLE NO. I.2-13

¹H NMR (400 MHz, d₆-DMSO δ, ppm), 8.75 (br. s, 1H, NH), 8.61 (d, 1H), 8.23 (d, 1H), 8.21 (d, 1H), 8.09 (d, 1H), 7.71 (m, 1H), 7.66 (m, 2H), 1.84 (m, 1H), 1.75 (m, 1H), 1.44 (s, 3H), 0.74 (t, 3H).

### EXAMPLE NO. I.2-14

¹H NMR (400 MHz, d₆-DMSO δ, ppm), 8.70 (br. s, 1H, NH), 8.60 (d, 1H), 8.24 (d, 1H), 8.22 (d, 1H), 8.10 (d, 1H), 7.73 (m, 1H), 7.69 (m, 2H), 1.78 (m, 1H), 1.66 (m, 1H), 1.62 (m, 1H), 1.48 (s, 3H), 0.80 (d, 3H), 0.72 (d, 3H).

### EXAMPLE NO. I.2-23

¹H NMR (400 MHz, d₆-DMSO δ, ppm), 8.96 (br. s, 1H, NH), 8.62 (d, 1H), 8.22 (d, 1H), 8.13 (d, 1H), 8.08 (d, 1H), 7.72 (m, 1H), 7.68 (m, 1H), 7.59 (m, 1H), 7.24 (m, 2H), 7.21 (m, 3H), 3.20 (d, 1H), 3.06 (d, 1H), 1.39 (s, 3H).

### EXAMPLE NO. I.2-24

¹H NMR (400 MHz, d₆-DMSO δ, ppm), 8.62 (d, 1H), 8.39 (br. t, 1H, NH), 8.24 (d, 1H), 8.13 (d, 1H), 8.09 (d, 1H), 7.71 (m, 1H), 7.66 (m, 2H), 3.03 (m, 2H), 2.61 (m, 2H).

### EXAMPLE NO. I.2-28

¹H NMR (400 MHz, d₆-DMSO δ, ppm) 8.66 (br. d, 1H, NH), 8.21 (d, 1H), 8.13 (d, 1H), 8.06 (d, 1H), 8.04 (d, 1H), 7.69 (dd, 1H), 7.62 (m, 2H), 3.60 (q, 2H), 3.53 (m, 1H), 2.34 (dd, 1H), 2.12 (dd, 1H), 1.62 (m, 1H), 0.95 (t, 3H), 0.69 (d, 3H), 0.59 (d, 3H).

### EXAMPLE NO. I.2-34

¹H NMR (400 MHz, d₆-DMSO δ, ppm) 8.62 (br. d, 1H, NH), 8.24 (d, 1H), 8.12 (d, 1H), 8.10 (d, 1H), 8.08 (d, 1H), 7.69 (dd, 1H), 7.66 (m, 2H), 3.87 (q, 2H), 3.03 (m, 1H), 2.36 (m, 2H), 1.05 (t, 3H).

### EXAMPLE NO. I.2-60

¹H NMR (400 MHz, d₆-DMSO δ, ppm) 8.68 (br. d, 1H, NH), 8.56 (d, 1H), 8.07 (d, 1H), 7.96 (m, 2H), 7.62 (m, 2H), 7.47 (m, 1H), 7.00 (m, 2H), 6.93 (m, 3H), 4.62 (m, 1H), 3.68 (q, 2H), 2.67 (dd, 1H), 2.62 (dd, 1H), 0.97 (t, 3H).

### EXAMPLE NO. I.2-61

¹H NMR (400 MHz, d₆-DMSO δ, ppm) 8.52 (br. d, 1H, NH), 8.20 (d, 1H), 8.16 (d, 1H), 8.05 (d, 1H), 8.03 (m, 1H), 7.62 (m, 2H), 7.57 (m, 2H), 7.01 (m, 3H), 6.91 (m, 2H), 3.68 (m, 1H), 3.14 (s, 3H), 2.60 (m, 2H), 2.32 (m, 2H).

### EXAMPLE NO. I.2-62

¹H NMR (400 MHz, d₆-DMSO δ, ppm) 8.63 (br. d, 1H, NH), 8.22 (d, 1H), 8.17 (d, 1H), 8.08 (d, 1H), 8.00 (d, 1H), 7.66 (m, 3H), 3.76 (q, 2H), 3.43 (m, 1H), 2.25 (m, 2H), 1.22 (m, 2H), 1.02 (t, 3H), 1.00 (m, 1H), 0.59 (d, 3H), 0.32 (d, 3H).

### EXAMPLE NO. I.2-63

¹H NMR (400 MHz, d₆-DMSO δ, ppm) 8.66 (br. d, 1H, NH), 8.57 (d, 1H), 8.23 (d, 1H), 8.12 (d, 1H), 8.09 (d, 1H), 7.67 (m, 3H), 4.13 (m, 1H), 3.22 (s, 3H), 3.19 (s, 3H), 2.69 (dd, 1H), 2.53 (dd, 1H).

### EXAMPLE NO. I.2-70

¹H NMR (400 MHz, d₆-DMSO δ, ppm) 8.62 (d, 1H), 8.20 (d, 1H), 8.09 (m, 2H), 7.95 (br. t, 1H, NH), 7.69 (m, 1H), 7.64 (m, 2H), 2.78 (m, 2H), 2.08 (t, 2H), 1.50 (quint, 2H), 1.30 (s, 9H).

### EXAMPLE NO. I.2-71

¹H NMR (400 MHz, d₆-DMSO δ, ppm), 8.63 (d, 1H), 8.58 (br. t, 1H, NH), 8.21 (d, 1H), 8.10 (d, 1H), 8.08 (d, 1H), 7.72 (m, 1H), 7.66 (m, 1H), 7.61 (m, 1H), 3.78 (q, 2H), 3.72 (d, 2H), 0.91 (t, 3H).

### EXAMPLE NO. I.2-74

¹H NMR (400 MHz, d₆-DMSO δ, ppm) 8.87 (br. d, 1H, NH), 8.43 (d, 1H), 8.39 (s, 1H), 8.22 (d, 1H), 8.08 (m, 1H), 8.05 (d, 1H), 7.68 (m, 1H), 7.60 (m, 1H), 7.04 (s, 1H), 4.12 (m, 1H), 3.49 (s, 3H), 3.29 (s, 3H), 2.94 (dd, 1H), 2.81 (dd, 1H).

### EXAMPLE NO. I.2-75

¹H NMR (400 MHz, d₆-DMSO δ, ppm), 8.69 (br. d, 1H, NH), 8.59 (d, 1H), 8.22 (d, 1H), 8.11 (d, 1H), 8.07 (d, 1H), 7.71 (m, 1H), 7.64 (m, 1H), 7.60 (m, 1H), 3.42 (m, 1H), 3.10 (s, 3H), 1.84 (m, 1H), 0.72 (d, 3H), 0.63 (d, 3H).

### EXAMPLE NO. I.2-77

¹H NMR (400 MHz, d₆-DMSO δ, ppm), 8.57 (br. d, 1H, NH), 8.55 (d, 1H), 8.22 (d, 1H), 8.12 (d, 1H), 8.09 (d, 1H), 7.70 (m, 1H), 7.65 (m, 1H), 7.61 (m, 1H), 3.65 (m, 1H), 3.15 (s, 3H), 1.41 (m, 2H), 1.27 (m, 1H), 0.68 (d, 3H), 0.41 (d, 3H).

### EXAMPLE NO. I.2-80

¹H NMR (400 MHz, d₆-DMSO δ, ppm), 8.81 (br. d, 1H, NH), 8.58 (d, 1H), 8.16 (d, 1H), 8.04 (d, 1H), 7.92 (d, 1H), 7.64 (m, 2H), 7.51 (m, 1H), 7.04 (m, 5H), 3.92 (m, 1H), 3.59 (m, 1H), 3.52 (m, 1H), 2.89 (dd, 1H), 2.77 (dd, 1H), 0.75 (t, 3H).

### EXAMPLE NO. I.2-83

¹H NMR (400 MHz, d₆-DMSO δ, ppm) 8.64 (br. d, 1H, NH), 8.21 (d, 1H), 8.13 (d, 1H), 8.08 (d, 1H), 8.05 (d, 1H), 7.69 (dd, 1H), 7.64 (m, 2H), 3.37 (m, 1H), 3.12 (s, 3H), 2.36 (dd, 1H), 2.11 (dd, 1H), 1.54 (m, 1H), 1.44 (m, 3H), 1.38 (m, 1H), 1.16 (m, 1H), 0.89 (m, 2H), 0.78 (m, 2H), 0.68 (m, 1H).

### EXAMPLE NO. I.2-84

¹H NMR (400 MHz, d₆-DMSO δ, ppm), 8.64 (br. d, 1H, NH), 8.61 (d, 1H), 8.21 (d, 1H), 8.10 (d, 1H), 8.07 (d, 1H), 7.68 (m, 2H), 7.61 (m, 1H), 6.78 (br. t, 1H), 3.72 (m, 1H), 3.32 (s, 3H), 2.70 (m, 2H), 1.49 (m, 2H), 1.34 (s, 9H), 1.28 (m, 1H), 1.16 (m, 1H).

### EXAMPLE NO. I.2-86

¹H NMR (400 MHz, d₆-DMSO δ, ppm), 8.88 (br. d, 1H, NH), 8.62 (d, 1H), 8.22 (d, 1H), 8.14 (d, 1H), 8.08 (d, 1H), 7.68 (m, 2H), 7.63 (m, 1H), 3.91 (m, 1H), 3.11 (s, 3H), 2.74 (s, 1H), 2.49 (m, 1H), 2.43 (m, 1H).

### EXAMPLE NO. I.2-90

¹H NMR (400 MHz, d₆-DMSO δ, ppm), 8.80 (br. d, 1H, NH), 8.49 (d, 1H), 8.12 (d, 1H), 8.00 (d, 1H), 7.91 (d, 1H), 7.62 (m, 2H), 7.49 (m, 1H), 6.95 (m, 2H), 6.63 (m, 2H), 3.88 (m, 1H), 3.28 (s, 3H), 2.86 (m, 1H), 2.69 (m, 1H).

### EXAMPLE NO. I.2-92

¹H NMR (400 MHz, d₆-DMSO δ, ppm), 8.77 (br. d, 1H, NH), 8.74 (d, 1H), 8.19 (d, 1H), 8.15 (d, 1H), 8.07 (d, 1H), 7.66 (m, 2H), 7.56 (m, 1H), 7.23 (m, 6H), 7.12 (m, 4H), 4.83 (d, 1H), 4.66 (d, 1H), 4.36 (d, 1H), 4.21 (d, 1H), 4.01 (m, 1H), 3.82 (m, 1H), 0.93 (d, 3H).

### EXAMPLE NO. I.2-103

¹H NMR (400 MHz, d₆-DMSO δ, ppm) 9.15 (br. d, 1H, NH), 8.55 (d, 1H), 8.22 (d, 1H), 8.13 (d, 1H), 8.08 (d, 1H), 7.65 (m, 3H), 4.29 (m, 1H), 3.62 (m, 1H), 3.49 (m, 1H), 2.69 (dd, 1H), 2.40 (dd, 1H), 0.93 (t, 3H).

### EXAMPLE NO. I.2-106

¹H NMR (400 MHz, d₆-DMSO δ, ppm) 13.70 (br. s, 1H, NH), 8.91 (br. d, 1H, NH), 8.60 (s, 1H), 8.51 (d, 1H), 8.24 (d, 1H), 8.03 (d, 1H), 7.99 (d, 1H), 7.83 (m, 2H), 7.76 (m, 1H), 7.12 (s, 1H), 4.20 (m, 1H), 3.24 (s, 3H), 3.03 (dd, 1H), 2.92 (dd, 1H).

### EXAMPLE NO. I.2-108

¹H NMR (400 MHz, d₆-DMSO δ, ppm) 8.91 (br. d, 1H, NH), 8.55 (d, 1H), 8.15 (m, 2H), 8.08 (d, 1H), 8.02 (d, 1H), 7.97 (d, 1H), 7.66 (m, 1H), 7.62 (m, 1H), 7.49 (m, 1H), 7.07 (m, 2H), 4.62 (q, 2H), 3.64 (s, 3H), 2.65 (m, 2H).

### EXAMPLE NO. I.2-109

¹H NMR (400 MHz, d₆-DMSO δ, ppm) 8.86 (br. d, 1H, NH), 8.57 (d, 1H), 8.04 (m, 2H), 7.94 (d, 1H), 7.65 (m, 1H), 7.60 (m, 1H), 7.47 (m, 1H), 7.23 (d, 1H), 7.07 (d, 1H), 6.92 (dd, 1H), 6.74 (dd, 1H), 5.15 (m, 1H), 3.72 (q, 2H), 2.59 (dd, 1H), 2.55 (dd, 1H), 0.99 (t, 3H).

### EXAMPLE NO. I.2-110

¹H NMR (400 MHz, d₆-DMSO δ, ppm) 8.71 (br. d, 1H, NH), 8.49 (d, 1H), 8.09 (d, 1H), 7.97 (m, 2H), 7.64 (m, 2H), 7.48 (m, 1H), 7.04 (d, 2H), 6.90 (d, 2H), 4.58 (m, 1H), 3.28 (s, 3H), 2.70 (dd, 1H), 2.62 (dd, 1H).

### EXAMPLE NO. I.3-1

¹H NMR (400 MHz, CDCl₃ δ, ppm) 8.58 (m, 1H), 8.45 (m, 1H), 8.15 (d, 1H), 7.92 (d, 1H), 7.72-7.78 (m, 2H), 5.00-5.10 (br. t, 1H, NH), 3.96 (d, 2H).

### EXAMPLE NO. I.3-24

¹H NMR (400 MHz, CDCl₃ δ, ppm) 8.62 (d, 1H), 8.42 (d, 1H), 8.09 (d, 1H), 7.89 (d, 1H), 7.73-7.77 (m, 2H), 5.28-5.31 (br. t, 1H, NH), 3.21 (m, 2H), 2.55 (m, 2H).

### EXAMPLE NO. I.3-26

¹H NMR (400 MHz, CDCl₃ δ, ppm) 8.64 (d, 1H), 8.41 (d, 1H), 8.11 (d, 1H), 7.89 (d, 1H), 7.74-7.78 (m, 2H), 4.96 (br. d, 1H, NH), 3.31 (m, 1H), 2.58 (dd, 1H), 2.50 (dd, 1H), 1.51 (m, 1H), 1.47 (m, 1H), 0.58 (t, 3H).

### EXAMPLE NO. I.3-28

¹H NMR (400 MHz, CDCl₃ δ, ppm) 8.66 (d, 1H), 8.38 (d, 1H), 8.12 (d, 1H), 7.88 (d, 1H), 7.70 (m, 2H), 5.55 (br. d, 1H, NH), 3.87 (q, 2H), 3.24 (m, 1H), 2.33 (dd, 1H), 2.18 (dd, 1H), 1.78 (m, 1H), 1.12 (t, 3H), 0.73 (d, 3H), 0.70 (d, 3H).

### EXAMPLE NO. I.3-34

¹H NMR (400 MHz, d₆-DMSO δ, ppm) 8.67 (d, 1H), 8.32 (d, 1H), 8.27 (br. t, 1H, NH), 8.07 (d, 1H), 8.02 (d, 1H), 7.82 (m, 2H), 3.82 (q, 2H), 3.03 (m, 2H), 2.35 (t, 2H), 1.03 (t, 3H).

### EXAMPLE NO. I.3-41

¹H NMR (400 MHz, CDCl₃ δ, ppm) 8.62 (m, 1H), 8.38 (m, 1H), 8.14 (d, 1H), 7.87 (d, 1H), 7.68-7.74 (m, 2H), 5.50 (br. d, 1H, NH), 3.85-3.98 (m, 2H), 3.62-3.70 (m, 1H), 2.30 (d, 2H), 1.12-1.18 (t, 3H), 1.08-1.10 (d, 3H).

### EXAMPLE NO. I.3-42

¹H NMR (400 MHz, CDCl₃ δ, ppm) 8.60 (m, 1H), 8.36 (m, 1H), 8.14 (d, 1H), 7.86-7.90 (d, 1H), 7.70 (m, 2H), 5.40-5.45 (br. d, 1H, NH), 3.65-3.72 (m, 1H), 2.45 (d, 2H), 1.10 (d, 3H).

### EXAMPLE NO. I.3-60

¹H NMR (400 MHz, d₆-DMSO δ, ppm) 8.83 (br. d, 1H, NH), 8.57 (d, 1H), 8.14 (d, 1H), 7.83 (m, 2H), 7.74 (m, 2H), 6.91 (m, 3H), 6.84 (m, 2H), 4.58 (m, 1H), 3.69 (q, 2H), 2.67 (dd, 1H), 2.57 (dd, 1H), 0.96 (t, 3H).

### EXAMPLE NO. I.3-61

¹H NMR (400 MHz, d₆-DMSO δ, ppm) 8.54 (d, 1H), 8.35 (d, 1H), 8.23 (br. d, 1H, NH), 7.92 (m, 2H), 7.75 (m, 2H), 6.88 (m, 5H), 3.68 (m, 1H), 3.22 (s, 3H), 2.60 (m, 2H), 2.40 (m, 2H).

### EXAMPLE NO. I.3-62

¹H NMR (400 MHz, d₆-DMSO δ, ppm) 8.67 (d, 1H), 8.31 (d, 1H), 8.20 (br. d, 1H, NH), 8.06 (m, 2H), 7.82 (m, 2H), 3.68 (m, 2H), 3.40 (m, 1H), 2.23 (m, 2H), 1.22 (m, 2H), 1.01 (m, 1H), 0.97 (t, 3H), 0.60 (d, 3H), 0.36 (d, 3H).

### EXAMPLE NO. I.3-63

¹H NMR (400 MHz, d₆-DMSO δ, ppm) 9.01 (br. d, 1H, NH), 8.63 (d, 1H), 8.32 (d, 1H), 8.07 (d, 1H), 8.02 (d, 1H), 7.82 (m, 2H), 4.13 (m, 1H), 3.24 (s, 3H), 3.22 (s, 3H), 2.68 (dd, 1H), 2.55 (dd, 1H).

### EXAMPLE NO. I.3-70

¹H NMR (400 MHz, d₆-DMSO δ, ppm) 8.69 (d, 1H), 8.31 (m, 1H), 8.10 (br. t, 1H, NH), 8.06 (d, 1H), 7.99 (d, 1H), 7.82 (m, 2H), 2.79 (m, 2H), 2.04 (t, 2H), 1.49 (quint, 2H), 1.29 (s, 9H).

### EXAMPLE NO. I.3-71

¹H NMR (400 MHz, d₆-DMSO δ, ppm) 8.73 (d, 1H), 8.69 (br. t, 1H, NH), 8.32 (m, 1H), 8.03 (d, 1H), 8.00 (d, 1H), 7.82 (m, 2H), 3.78 (q, 2H), 3.75 (d, 2H), 0.91 (t, 3H).

### EXAMPLE NO. I.3-72

¹H NMR (400 MHz, d₆-DMSO δ, ppm) 8.72 (d, 1H), 8.63 (br. s, 1H, NH), 8.32 (m, 1H), 8.05 (d, 1H), 8.00 (d, 1H), 7.83 (m, 2H), 3.37 (s, 3H), 1.27 (s, 2H).

### EXAMPLE NO. I.3-73

¹H NMR (400 MHz, d₆-DMSO δ, ppm) 8.79 (br. d, 1H, NH), 8.73 (d, 1H), 8.31 (m, 1H), 8.06 (d, 1H), 8.00 (d, 1H), 7.84 (m, 2H), 3.70 (m, 1H), 3.18 (s, 3H), 1.48 (q, 2H), 1.13 (m, 1H), 1.06 (m, 1H), 0.60 (t, 3H).

### EXAMPLE NO. I.3-74

¹H NMR (400 MHz, d₆-DMSO δ, ppm) 9.01 (br. d, 1H, NH), 8.93 (d, 1H), 8.53 (s, 1H), 8.32 (d, 1H), 8.16 (d, 1H), 8.04 (d, 1H), 7.78 (m, 1H), 7.63 (m, 1H), 7.13 (s, 1H), 4.15 (m, 1H), 3.54 (s, 3H), 3.28 (s, 3H), 2.97 (dd, 1H), 2.83 (dd, 1H).

### EXAMPLE NO. I.3-75

¹H NMR (400 MHz, d₆-DMSO δ, ppm) 8.78 (d, 1H), 8.62 (br. d, 1H, NH), 8.31 (m, 1H), 8.04 (d, 1H), 7.99 (d, 1H), 7.82 (m, 2H), 3.44 (m, 1H), 3.12 (s, 3H), 1.85 (m, 1H), 0.72 (d, 3H), 0.64 (d, 3H).

### EXAMPLE NO. I.3-76

¹H NMR (400 MHz, d₆-DMSO δ, ppm) 8.80 (br. d, 1H, NH), 8.72 (d, 1H), 8.33 (m, 1H), 8.07 (d, 1H), 8.00 (d, 1H), 7.83 (m, 2H), 3.90 (m, 1H), 3.18 (s, 3H), 1.15 (d, 3H).

### EXAMPLE NO. I.3-77

¹H NMR (400 MHz, d₆-DMSO δ, ppm) 8.81 (br. d, 1H, NH), 8.71 (d, 1H), 8.32 (m, 1H), 8.06 (d, 1H), 8.00 (d, 1H), 7.84 (m, 2H), 3.69 (m, 1H), 3.15 (s, 3H), 1.42 (m, 2H), 1.29 (m, 1H), 0.70 (d, 3H), 0.46 (d, 3H).

### EXAMPLE NO. I.3-79

¹H NMR (400 MHz, d₆-DMSO δ, ppm) 8.85 (br. d, 1H, NH), 8.71 (d, 1H), 8.32 (m, 1H), 8.07 (d, 1H), 8.00 (d, 1H), 7.85 (m, 2H), 3.88 (m, 1H), 3.28 (s, 3H), 2.23 (m, 1H), 2.04 (m, 1H), 1.75 (s, 3H), 1.71 (m, 2H).

### EXAMPLE NO. I.3-80

¹H NMR (400 MHz, d₆-DMSO δ, ppm) 8.94 (br. d, 1H, NH), 8.61 (d, 1H), 8.24 (d, 1H), 7.91 (d, 1H), 7.79 (d, 1H), 7.75 (m, 2H), 6.95 (m, 5H), 3.94 (m, 1H), 3.68 (q, 2H), 2.91 (dd, 1H), 2.72 (dd, 1H), 0.82 (t, 3H).

### EXAMPLE NO. I.3-82

¹H NMR (400 MHz, d₆-DMSO δ, ppm) 8.98 (br. d, 1H, NH), 8.43 (d, 1H), 8.39 (s, 1H), 8.26 (m, 2H), 7.95 (d, 1H), 7.82 (d, 1H), 7.79 (m, 2H), 7.63 (m, 1H), 7.19 (m, 1H), 4.15 (m, 1H), 3.38 (s, 3H), 3.11 (dd, 1H), 2.73 (dd, 1H).

### EXAMPLE NO. I.3-83

¹H NMR (400 MHz, d₆-DMSO δ, ppm) 8.68 (d, 1H), 8.30 (d, 1H), 8.22 (br. d, 1H, NH), 8.05 (d, 1H), 8.01 (d, 1H), 7.81 (m, 2H), 3.34 (m, 1H), 3.05 (s, 3H), 2.36 (dd, 1H), 2.09 (dd, 1H), 1.53 (m, 1H), 1.48 (m, 2H), 1.41 (m, 1H), 1.19 (m, 1H), 0.91 (m, 2H), 0.76-0.89 (m, 3H), 0.69 (m, 1H).

### EXAMPLE NO. I.3-84

¹H NMR (400 MHz, d₆-DMSO δ, ppm) 8.76 (br. d, 1H, NH), 8.71 (m, 1H), 8.31 (m, 1H), 8.04 (d, 1H), 7.99 (d, 1H), 7.82 (m, 2H), 6.66 (br. t, 1H, NH), 4.07 (m, 1H), 3.74 (m, 1H), 3.10 (s, 3H), 2.72 (m, 2H), 1.52 (m, 2H), 1.34 (s, 9H), 1.19 (m, 1H).

### EXAMPLE NO. I.3-86

¹H NMR (400 MHz, d₆-DMSO δ, ppm) 8.99 (br. d, 1H, NH), 8.70 (m, 1H), 8.33 (m, 1H), 8.06 (d, 1H), 8.04 (d, 1H), 7.82 (m, 2H), 3.94 (m, 1H), 3.16 (s, 3H), 2.71 (s, 1H), 2.47 (m, 2H).

### EXAMPLE NO. I.3-90

¹H NMR (400 MHz, d₆-DMSO δ, ppm) 8.92 (br. d, 1H, NH), 8.49 (d, 1H), 8.24 (d, 1H), 7.89 (d, 1H), 7.79 (d, 1H), 7.77 (m, 1H), 7.70 (m, 1H), 6.88 (m, 2H), 6.51 (m, 2H), 3.92 (m, 1H), 3.39 (s, 3H), 2.86 (dd, 1H), 2.63 (dd, 1H).

### EXAMPLE NO. I.3-91

¹H NMR (400 MHz, d₆-DMSO δ, ppm) 8.80 (br. d, 1H, NH), 8.74 (d, 1H), 8.32 (d, 1H), 8.05 (d, 1H), 8.03 (d, 1H), 7.81 (m, 2H), 3.88 (m, 1H), 3.34 (m, 2H), 3.33 (s, 3H), 0.83 (s, 9H).

### EXAMPLE NO. I.3-92

¹H NMR (400 MHz, d₆-DMSO δ, ppm) 8.87 (br. d, 1H, NH), 8.84 (d, 1H), 8.29 (d, 1H), 8.03 (d, 1H), 7.94 (d, 1H), 7.78 (m, 2H), 7.27 (m, 3H), 7.10 (m, 2H), 4.84 (d, 1H), 4.69 (d, 1H), 4.39 (d, 1H), 4.21 (d, 1H), 4.05 (m, 1H), 3.87 (m, 1H), 0.93 (d, 3H).

### EXAMPLE NO. I.3-103

¹H NMR (400 MHz, d₆-DMSO δ, ppm) 9.32 (br. d, 1H, NH), 8.62 (d, 1H), 8.32 (m, 1H), 8.05 (d, 1H), 8.03 (d, 1H), 7.82 (m, 2H), 4.28 (m, 1H), 3.59 (m, 1H), 3.41 (m, 1H), 2.71 (dd, 1H), 2.39 (dd, 1H), 0.91 (t, 3H).

### EXAMPLE NO. I.3-106

¹H NMR (400 MHz, d₆-DMSO δ, ppm) 13.82 (br. s, 1H, NH), 8.98 (br. d, 1H, NH), 8.58 (s, 1H), 8.52 (d, 1H), 8.30 (d, 1H), 8.05 (d, 1H), 7.93 (d, 1H), 7.81 (m, 1H), 7.75 (m, 1H), 7.15 (s, 1H), 4.17 (m, 1H), 3.22 (s, 3H), 3.00 (dd, 1H), 2.89 (dd, 1H).

### EXAMPLE NO. I.3-108

¹H NMR (400 MHz, d₆-DMSO δ, ppm) 9.09 (br. d, 1H, NH), 8.59 (d, 1H), 8.23 (m, 3H), 7.92 (m, 2H), 7.79 (m, 2H), 7.21 (m, 2H), 4.67 (q, 2H), 3.79 (s, 3H), 2.68 (m, 2H).

### EXAMPLE NO. I.3-109

¹H NMR (400 MHz, d₆-DMSO δ, ppm) 9.01 (br. d, 1H, NH), 8.60 (m, 1H), 8.15 (m, 1H), 7.91 (d, 1H), 7.86 (d, 1H), 7.76 (m, 2H), 7.13 (d, 1H), 7.03 (d, 1H), 6.90 (dd, 1H), 6.65 (dd, 1H), 5.13 (m, 1H), 3.73 (q, 2H), 2.62 (dd, 1H), 2.55 (dd, 1H), 1.02 (t, 3H).

### EXAMPLE NO. I.3-110

¹H NMR (400 MHz, d₆-DMSO δ, ppm) 8.82 (br. d, 1H, NH), 8.53 (d, 1H), 8.19 (d, 1H), 7.87 (d, 1H), 7.85 (d, 1H), 7.77 (m, 1H), 7.75 (m, 1H), 6.93 (d, 2H), 6.80 (d, 2H), 4.52 (m, 1H), 3.32 (s, 3H), 2.73 (dd, 1H), 2.61 (dd, 1H).

### EXAMPLE NO. I.12-29

¹H NMR (400 MHz, CDCl₃ δ, ppm) 12.05 (br. s, 2H, NH), 8.28 (d, 1H), 8.09 (d, 1H), 8.04 (d, 1H), 7.48 (dd, 1H), 7.45 (dd, 1H), 6.87 (d, 1H), 5.39 (br. d, 1H, NH), 3.24 (m, 1H), 2.30 (dd, 1H), 2.14 (dd, 1H), 1.74 (m, 1H), 0.75 (d, 3H), 0.68 (d, 3H).

### EXAMPLE NO. I.12-35

¹H NMR (400 MHz, CDCl₃ δ, ppm) 12.11 (br. s, 2H, NH), 8.27 (d, 1H), 8.10 (d, 1H), 8.01 (d, 1H), 7.49 (m, 2H), 6.89 (d, 1H), 5.37 (br. t, 1H, NH), 3.55 (s, 3H), 3.12 (q, 2H), 2.40 (t, 2H).

### EXAMPLE NO. I.13-105

¹H NMR (400 MHz, d₆-DMSO δ, ppm) 8.44 (d, 1H, NH), 8.42 (d, 1H), 8.30 (d, 1H), 8.11 (d, 1H), 7.58 (m, 2H), 7.52 (br. m, 1H, NH), 7.23 (d, 1H), 6.88-7.30 (br. m, 3H, NH), 3.67 (m, 1H), 2.92 (m, 2H), 2.83 (s, 6H), 1.62 (m, 1H), 1.52 (m, 1H), 1.40 (m, 1H), 1.32 (m, 1H).

### EXAMPLE NO. I.14-1

¹H NMR (400 MHz, d₆-DMSO δ, ppm) 8.81 (br. t, 1H, NH), 8.17 (d, 1H), 8.13 (d, 1H), 8.01 (d, 1H), 7.87 (d, 1H), 7.49 (dd, 1H), 7.33 (dd, 1H), 4.23 (q, 2H), 4.06 (s, 2H), 1.41 (t, 3H).

### EXAMPLE NO. I.14-24

¹H NMR (400 MHz, d₆-DMSO δ, ppm) 8.38 (br. t, 1H, H), 8.16 (d, 1H), 8.11 (d, 1H), 8.00 (d, 1H), 7.92 (d, 1H), 7.48 (dd, 1H), 7.31 (dd, 1H), 4.23 (q, 2H), 2.98 (t, 2H), 2.49 (t, 2H), 1.43 (t, 3H).

### EXAMPLE NO. I.19-105

¹H NMR (400 MHz, d₆-DMSO δ, ppm) 7.82 (m, 1H, NH), 7.59 (br. m, 2H, NH), 7.19 (br. m, 1H, NH), 6.98 (m, 1H, NH), 6.68 (s, 1H), 3.79 (s, 3H), 3.15 (m, 1H), 3.03 (m, 2H), 2.61 (s, 3H), 2.51 (s, 3H), 2.05 (s, 3H), 1.69 (m, 1H), 1.54 (m, 1H), 1.48 (m, 1H), 1.39 (m, 1H).

### EXAMPLE NO. I.29-60

¹H NMR (400 MHz, d₆-DMSO δ, ppm) 8.47 (br. d, 1H, NH), 7.58 (m, 2H), 7.18 (d, 2H), 7.13 (m, 5H), 4.66 (m, 1H), 3.97 (q, 2H), 2.70 (dd, 1H), 2.64 (dd, 1H), 1.10 (t, 3H).

### EXAMPLE NO. I.30-60

¹H NMR (400 MHz, d₆-DMSO δ, ppm) 8.67 (br. d, 1H, NH), 7.60 (d, 1H), 7.50 (d, 1H), 7.44 (dd, 1H), 7.11 (m, 5H), 4.68 (m, 1H), 3.98 (q, 2H), 2.69 (dd, 1H), 2.67 (dd, 1H), 1.09 (t, 3H).

### EXAMPLE NO. I.32-24

¹H NMR (400 MHz, CDCl₃ δ, ppm) 7.81 (d, 2H), 7.52 (d, 2H), 5.24 (br. t, 1H, NH), 3.26 (q, 2H), 2.60 (t, 2H).

### EXAMPLE NO. I.32-26

¹H NMR (400 MHz, CDCl₃ δ, ppm) 7.82 (d, 2H), 7.50 (d, 2H), 4.94 (br. d, 1H, NH), 3.39 (m, 1H), 2.63 (dd, 1H), 2.58 (dd, 1H), 1.63 (m, 1H), 1.56 (m, 1H), 0.79 (t, 3H).

### EXAMPLE NO. I.32-60

¹H NMR (400 MHz, d₆-DMSO δ, ppm) 8.54 (br. d, 1H, NH), 7.51 (d, 2H), 7.39 (d, 2H), 7.12 (m, 5H), 4.66 (m, 1H), 3.95 (q, 2H), 2.71 (dd, 1H), 2.68 (dd, 1H), 1.08 (t, 3H).

### EXAMPLE NO. I.33-60

¹H NMR (400 MHz, d₆-DMSO δ, ppm) 8.50 (br. d, 1H, NH), 7.72 (d, 2H), 7.28 (d, 2H), 7.11 (m, 5H), 4.64 (m, 1H), 3.93 (q, 2H), 2.70 (dd, 1H), 2.66 (dd, 1H), 1.09 (t, 3H).

### EXAMPLE NO. I.34-60

¹H NMR (400 MHz, d₆-DMSO δ, ppm) 8.44 (br. d, 1H, NH), 7.57 (d, 1H), 7.33 (d, 1H), 7.28 (dd, 1H), 7.11 (m, 5H), 4.66 (m, 1H), 3.95 (q, 2H), 2.72 (dd, 1H), 2.68 (dd, 1H), 2.21 (s, 3H), 1.10 (t, 3H).

### EXAMPLE NO. I.36-60

¹H NMR (400 MHz, d₆-DMSO δ, ppm) 8.52 (br. d, 1H, NH), 7.64 (d, 2H), 7.31 (d, 2H), 7.11 (m, 5H), 4.64 (m, 1H), 3.97 (q, 2H), 2.70 (dd, 1H), 2.64 (dd, 1H), 1.05 (t, 3H).

### EXAMPLE NO. I.37-1

¹H NMR (400 MHz, CDCl₃ δ, ppm) 7.86 (d, 2H), 7.03 (d, 2H), 5.07 (br. t, 1H, NH), 4.01 (d, 2H), 3.89 (s, 3H).

### EXAMPLE NO. I.37-2

¹H NMR (400 MHz, CDCl₃ δ, ppm) 7.86 (d, 2H), 7.04 (d, 2H), 4.98 (br. d, 1H, NH), 4.32 (quint, 1H), 3.88 (s, 3H), 1.56 (d, 3H).

### EXAMPLE NO. I.37-3

¹H NMR (400 MHz, CDCl₃ δ, ppm) 7.89 (d, 2H), 6.99 (d, 2H), 5.16 (br. s, 1H, NH), 3.87 (s, 3H), 1.66 (s, 6H).

### EXAMPLE NO. I.37-4

¹H NMR (400 MHz, CDCl₃ δ, ppm) 7.84 (d, 2H), 7.03 (d, 2H), 5.14 (br. d, 1H, NH), 4.03 (dd, 1H), 3.88 (s, 3H), 2.05 (m, 1H), 1.06 (d, 6H).

### EXAMPLE NO. I.37-5

¹H NMR (400 MHz, CDCl₃ δ, ppm) 7.88 (d, 2H), 6.98 (d, 2H), 5.01 (br. s, 1H, NH), 3.88 (s, 3H), 1.79 (sext, 2H), 1.63 (s, 3H), 1.45 (sext, 2H), 0.93 (t, 3H).

### EXAMPLE NO. I.37-9

¹H NMR (400 MHz, CDCl₃ δ, ppm) 7.88 (d, 2H), 7.02 (d, 2H), 5.39 (br. s, 1H, NH), 3.88 (s, 3H), 3.51 (d, 1H), 3.45 (d, 1H), 3.44 (s, 3H), 1.64 (s, 3H).

### EXAMPLE NO. I.37-11

¹H NMR (400 MHz, CDCl₃ δ, ppm) 7.88 (d, 2H), 7.00 (d, 2H), 5.22 (br. s, 1H, NH), 3.88 (s, 3H), 1.72 (s, 3H), 1.16 (m, 1H), 0.59 (m, 4H).

### EXAMPLE NO. I.37-12

¹H NMR (400 MHz, CDCl₃ δ, ppm) 7.89 (d, 2H), 7.00 (d, 2H), 4.90 (br. s, 1H, NH), 3.88 (s, 3H), 1.93 (m, 4H), 0.97 (t, 6H).

### EXAMPLE NO. I.37-14

¹H NMR (400 MHz, CDCl₃ δ, ppm) 7.90 (d, 2H), 7.00 (d, 2H), 4.94 (br. s, 1H, NH), 3.87 (s, 3H), 1.84 (m, 1H), 1.76 (dd, 1H), 1.68 (dd, 1H), 1.67 (s, 3H), 1.01 (d, 6H).

### EXAMPLE NO. I.37-21

¹H NMR (400 MHz, CDCl₃ δ, ppm) 7.89 (d, 2H), 6.99 (d, 2H), 5.06 (br. s, 1H, NH), 3.88 (s, 3H), 1.74 (m, 2H), 1.57 (s, 3H), 1.09 (m, 1H), 1.01 (m, 3H), 0.94 (m, 3H).

### EXAMPLE NO. I.37-23

¹H NMR (400 MHz, CDCl₃ δ, ppm) 7.78 (d, 2H), 7.35 (m, 3H), 7.30 (m, 2H), 6.96 (d, 2H), 4.93 (br. s, 1H, NH), 3.86 (s, 3H), 3.12 (d, 1H), 3.09 (d, 1H), 1.65 (s, 3H).

### EXAMPLE NO. I.37-24

¹H NMR (400 MHz, CDCl₃ δ, ppm) 7.82 (d, 2H), 6.99 (d, 2H), 5.02 (br. t, 1H, NH), 3.89 (s, 3H), 3.23 (m, 2H), 2.58 (m, 2H).

### EXAMPLE NO. I.37-26

¹H NMR (400 MHz, CDCl₃ δ, ppm) 7.81 (d, 2H), 6.98 (d, 2H), 4.87 (br. d, 1H, NH), 3.88 (s, 3H), 3.34 (m, 1H), 2.61 (dd, 1H), 2.54 (dd, 1H), 1.62 (m, 1H), 1.54 (m, 1H), 0.78 (t, 3H).

### EXAMPLE NO. I.37-28

¹H NMR (400 MHz, CDCl₃ δ, ppm) 7.79 (d, 2H), 6.95 (d, 2H), 5.17 (br. d, 1H, NH), 4.06 (q, 2H), 3.78 (s, 3H), 3.32 (m, 1H), 2.41 (dd, 1H), 2.33 (dd, 1H), 1.82 (m, 1H), 1.23 (t, 3H), 0.83 (d, 3H), 0.81 (d, 3H).

### EXAMPLE NO. I.37-33

¹H NMR (400 MHz, d₆-DMSO δ, ppm) 8.38 (br. d, 1H, NH), 7.47 (d, 2H), 7.34 (d, 1H), 7.24 (d, 1H), 7.11 (m, 2H), 6.86 (d, 2H), 5.17 (t, 1H), 3.98 (q, 2H), 3.75 (s, 3H), 2.59 (m, 2H), 1.10 (t, 3H).

### EXAMPLE NO. I.37-35

¹H NMR (400 MHz, d₆-DMSO δ, ppm) 8.27 (br. d, 1H, NH), 7.46 (d, 2H), 7.31 (d, 2H), 7.07 (d, 2H), 6.88 (d, 2H), 4.59 (q, 1H), 3.79 (s, 3H), 3.48 (s, 3H), 2.68 (m, 2H).

### EXAMPLE NO. I.37-60

¹H NMR (400 MHz, d₆-DMSO δ, ppm) 8.23 (br. d, 1H, NH), 7.49 (d, 2H), 7.14 (m, 5H), 6.88 (d, 2H), 4.61 (m, 1H), 3.92 (q, 2H), 3.76 (s, 3H), 2.65 (dd, 1H), 2.63 (dd, 1H), 1.05 (t, 3H).

### EXAMPLE NO. I.37-62

¹H NMR (400 MHz, d₆-DMSO δ, ppm) 7.71 (d, 2H), 7.56 (br. d, 1H, NH), 7.11 (d, 2H), 3.95 (q, 2H), 3.84 (s, 3H), 3.43 (m, 1H), 2.28 (m, 2H), 1.48 (m, 1H), 1.22 (m, 1H), 1.12 (t, 3H), 1.06 (m, 1H), 0.74 (d, 3H), 0.58 (d, 3H).

### EXAMPLE NO. I.37-63

¹H NMR (400 MHz, d₆-DMSO δ, ppm) 8.32 (br. d, 1H, NH), 7.69 (d, 2H), 7.10 (d, 2H), 4.13 (m, 1H), 3.83 (s, 3H), 3.52 (s, 3H), 3.42 (s, 3H), 2.71 (dd, 1H), 2.55 (dd, 1H).

### EXAMPLE NO. I.37-73

¹H NMR (400 MHz, d₆-DMSO δ, ppm) 8.11 (br. d, 1H, NH), 7.68 (d, 2H), 7.08 (d, 2H), 3.83 (s, 3H), 3.69 (m, 1H), 3.41 (s, 3H), 1.50 (m, 2H), 1.19 (m, 2H), 0.75 (t, 3H).

### EXAMPLE NO. I.37-75

¹H NMR (400 MHz, d₆-DMSO δ, ppm) 8.05 (br. d, 1H, NH), 7.68 (d, 2H), 7.07 (d, 2H), 3.83 (s, 3H), 3.48 (m, 1H), 3.37 (s, 3H), 1.87 (m, 1H), 0.82 (d, 3H), 0.79 (d, 3H).

### EXAMPLE NO. I.37-77

¹H NMR (400 MHz, d₆-DMSO δ, ppm) 8.13 (br. d, 1H, NH), 7.67 (d, 2H), 7.09 (d, 2H), 3.83 (s, 3H), 3.70 (m, 1H), 3.39 (s, 3H), 1.54 (m, 1H), 1.38 (m, 2H), 0.80 (d, 3H), 0.71 (d, 3H).

### EXAMPLE NO. I.37-79

¹H NMR (400 MHz, d₆-DMSO δ, ppm) 8.17 (br. d, 1H, NH), 7.69 (d, 2H), 7.10 (d, 2H), 3.90 (m, 1H), 3.83 (s, 3H), 3.44 (s, 3H), 2.38 (m, 1H), 2.31 (m, 1H), 1.94 (s, 3H), 1.79 (m, 1H), 1.74 (m, 1H).

### EXAMPLE NO. I.37-80

¹H NMR (400 MHz, d₆-DMSO δ, ppm) 8.29 (br. d, 1H, NH), 7.55 (d, 2H), 7.20 (m, 3H), 7.09 (d, 2H), 6.98 (m, 2H), 3.89 (m, 1H), 3.81 (s, 3H), 3.76 (q, 2H), 2.88 (dd, 1H), 2.77 (dd, 1H), 0.95 (t, 3H).

### EXAMPLE NO. I.37-82

¹H NMR (400 MHz, d₆-DMSO δ, ppm) 8.57 (br. d, 1H, NH), 8.51 (s, 1H), 8.34 (d, 1H), 7.93 (d, 1H), 7.56 (m, 1H), 7.49 (d, 2H), 6.98 (d, 2H), 4.09 (m, 1H), 3.82 (s, 3H), 3.44 (s, 3H), 3.08 (dd, 1H), 2.86 (dd, 1H).

### EXAMPLE NO. I.37-83

¹H NMR (400 MHz, d₆-DMSO δ, ppm) 7.69 (d, 2H), 7.53 (br. d, 1H, NH), 7.09 (d, 2H), 3.82 (s, 3H), 3.43 (s, 3H), 3.36 (m, 1H), 2.42 (dd, 1H), 2.14 (dd, 1H), 1.63 (m, 2H), 1.54 (m, 2H), 1.47 (m, 1H), 1.25 (m, 1H), 1.03 (m, 3H), 0.91 (m, 1H), 0.83 (m, 1H).

### EXAMPLE NO. I.37-84

¹H NMR (400 MHz, d₆-DMSO δ, ppm) 8.13 (br. d, 1H, NH), 7.67 (d, 2H), 7.09 (d, 2H), 6.72 (br. t, 1H, NH), 3.83 (s, 3H), 3.71 (m, 1H), 3.39 (s, 3H), 2.82 (m, 2H), 1.56 (m, 1H), 1.48 (m, 1H), 1.36 (s, 9H), 1.29 (m, 2H).

### EXAMPLE NO. I.37-86

¹H NMR (400 MHz, d₆-DMSO δ, ppm) 8.32 (br. d, 1H, NH), 7.70 (d, 2H), 7.08 (d, 2H), 3.90 (m, 1H), 3.84 (s, 3H), 3.43 (s, 3H), 2.87 (s, 1H), 2.51 (m, 1H), 2.43 (m, 1H).

### EXAMPLE NO. I.37-90

¹H NMR (400 MHz, d₆-DMSO δ, ppm) 8.29 (br. d, 1H, NH), 7.49 (d, 2H), 7.12 (m, 2H), 7.02 (d, 2H), 6.95 (d, 2H), 3.90 (m, 1H), 3.82 (s, 3H), 3.40 (s, 3H), 2.92 (dd, 1H), 2.74 (dd, 2H).

### EXAMPLE NO. I.37-91

¹H NMR (400 MHz, d₆-DMSO δ, ppm) 8.10 (br. d, 1H, NH), 7.72 (d, 2H), 7.09 (m, 2H), 3.86 (m, 1H), 3.83 (s, 3H), 3.45 (s, 3H), 3.38 (m, 2H), 1.01 (s, 9H).

### EXAMPLE NO. I.37-92

¹H NMR (400 MHz, d₆-DMSO δ, ppm) 8.16 (br. d, 1H, NH), 7.72 (d, 2H), 7.27 (m, 6H), 7.20 (m, 4H), 6.99 (d, 2H), 4.98 (d, 1H), 4.90 (d, 1H), 4.46 (d, 1H), 4.31 (d, 1H), 4.02 (m, 1H), 3.90 (m, 1H), 3.80 (s, 3H), 1.09 (d, 3H).

### EXAMPLE NO. I.37-93

¹H NMR (400 MHz, d₆-DMSO δ, ppm) 8.10 (br. d, 1H, NH), 7.68 (d, 2H), 7.32 (m, 5H), 7.17 (br. t, 1H, NH), 7.07 (d, 2H), 5.00 (s, 2H), 3.82 (s, 3H), 3.69 (m, 1H), 3.40 (s, 3H), 2.89 (m, 2H), 1.51 (m, 2H), 1.29 (m, 2H), 1.20 (m, 1H), 1.15 (m, 1H).

### EXAMPLE NO. I.37-103

¹H NMR (400 MHz, d₆-DMSO δ, ppm) 8.68 (br. d, 1H, NH), 7.69 (d, 2H), 7.10 (d, 2H), 4.30 (m, 1H), 3.90 (q, 2H), 3.83 (s, 3H), 2.74 (dd, 1H), 2.39 (dd, 1H), 1.10 (t, 3H).

### EXAMPLE NO. I.37-105

¹H NMR (400 MHz, d₆-DMSO δ, ppm) 10.06 (br. s, 1H, NH), 7.82 (d, 2H), 6.96 (d, 2H), 4.17 (q, 2H), 3.87 (s, 3H), 2.71 (m, 2H), 2.44 (m, 2H), 1.78 (m, 2H), 1.27 (t, 3H).

### EXAMPLE NO. I.37-108

¹H NMR (400 MHz, d₆-DMSO δ, ppm) 8.53 (br. d, 1H, NH), 8.49 (d, 1H), 7.55 (d, 2H), 7.51 (m, 1H), 7.48 (m, 2H), 6.94 (d, 2H), 4.70 (q, 2H), 3.82 (s, 3H), 2.72 (m, 2H).

### EXAMPLE NO. I.38-1

¹H NMR (400 MHz, CDCl₃ δ, ppm) 7.81 (d, 2H), 7.38 (d, 2H), 4.96 (br. t, 1H, NH), 4.02 (d, 2H), 2.45 (s, 3H).

### EXAMPLE NO. I.38-2

¹H NMR (400 MHz, CDCl₃ δ, ppm) 7.79 (d, 2H), 7.35 (d, 2H), 4.80 (br. d, 1H, NH), 4.35 (quint, 1H), 2.45 (s, 3H), 1.57 (d, 3H).

### EXAMPLE NO. I.38-3

¹H NMR (400 MHz, CDCl₃ δ, ppm) 7.81 (d, 2H), 7.34 (d, 2H), 4.89 (br. s, 1H, NH), 2.44 (s, 3H), 1.66 (s, 6H).

### EXAMPLE NO. I.38-4

¹H NMR (400 MHz, CDCl₃ δ, ppm) 7.80 (d, 2H), 7.37 (d, 2H), 5.06 (br. d, 1H, NH), 4.05 (dd, 1H), 2.45 (s, 3H), 2.05 (m, 1H), 1.06 (d, 6H).

### EXAMPLE NO. I.38-5

¹H NMR (400 MHz, CDCl₃ δ, ppm) 7.83 (d, 2H), 7.33 (d, 2H), 4.99 (br. s, 1H, NH), 2.44 (s, 3H), 1.81 (m, 2H), 1.63 (s, 3H), 1.45 (sext, 2H), 0.92 (t, 3H).

### EXAMPLE NO. I.38-9

¹H NMR (400 MHz, CDCl₃ δ, ppm) 7.83 (d, 2H), 7.36 (d, 2H), 5.42 (br. s, 1H, NH), 3.54 (d, 1H), 3.46 (d, 1H), 3.44 (s, 3H), 2.44 (s, 3H), 1.63 (s, 3H).

### EXAMPLE NO. I.38-11

¹H NMR (400 MHz, CDCl₃ δ, ppm) 7.83 (d, 2H), 7.35 (d, 2H), 5.11 (br. s, 1H, NH), 2.44 (s, 3H), 1.73 (s, 3H), 1.19 (m, 1H), 0.60 (m, 4H).

### EXAMPLE NO. I.38-12

¹H NMR (400 MHz, CDCl₃ δ, ppm) 7.84 (d, 2H), 7.33 (d, 2H), 4.74 (br. s, 1H, NH), 2.44 (s, 3H), 1.91 (m, 4H), 0.99 (t, 6H).

### EXAMPLE NO. I.38-14

¹H NMR (400 MHz, CDCl₃ δ, ppm) 7.83 (d, 2H), 7.34 (d, 2H), 4.99 (br. s, 1H, NH), 2.44 (s, 3H), 1.85 (m, 1H), 1.78 (dd, 1H), 1.69 (dd, 1H), 1.66 (s, 3H), 0.98 (d, 6H).

### EXAMPLE NO. I.38-21

¹H NMR (400 MHz, CDCl₃ δ, ppm) 7.82 (d, 2H), 7.35 (d, 2H), 5.01 (br. s, 1H, NH), 2.44 (s, 3H), 1.75 (m, 2H), 1.61 (s, 3H), 1.09 (m, 1H), 1.00 (m, 3H), 0.91 (m, 3H).

### EXAMPLE NO. I.38-23

¹H NMR (400 MHz, CDCl₃ δ, ppm) 7.70 (d, 2H), 7.37 (m, 3H), 7.29 (m, 4H), 4.77 (br. s, 1H, NH), 3.15 (d, 1H), 3.09 (d, 1H), 2.42 (s, 3H), 1.67 (s, 3H).

### EXAMPLE NO. I.38-28

¹H NMR (400 MHz, d₆-DMSO δ, ppm) 7.66 (d, 2H), 7.62 (br. d, 1H, NH), 7.37 (d, 2H), 3.86 (q, 2H), 3.41 (m, 1H), 2.38 (s, 3H), 2.35 (dd, 1H), 2.11 (dd, 1H), 1.62 (m, 1H), 1.10 (t, 3H), 0.74 (d, 6H).

### EXAMPLE NO. I.38-33

¹H NMR (400 MHz, d₆-DMSO δ, ppm) 8.46 (br. d, 1H, NH), 7.43 (d, 2H), 7.34 (d, 1H), 7.24 (d, 1H), 7.13 (d, 2H), 7.09 (m, 2H), 5.16 (q, 1H), 3.95 (q, 2H), 2.60 (m, 2H), 2.27 (s, 3H), 1.09 (t, 3H).

### EXAMPLE NO. I.38-35

¹H NMR (400 MHz, d₆-DMSO δ, ppm) 8.32 (br. d, 1H, NH), 7.40 (d, 2H), 7.29 (d, 2H), 7.18 (d, 2H), 7.06 (d, 2H), 4.59 (q, 1H), 3.46 (s, 3H), 2.68 (m, 2H), 2.34 (s, 3H).

### EXAMPLE NO. I.38-60

¹H NMR (400 MHz, d₆-DMSO δ, ppm) 8.31 (br. d, 1H, NH), 7.44 (d, 2H), 7.16 (d, 2H), 7.13 (m, 5H), 4.63 (m, 1H), 3.91 (q, 2H), 2.66 (dd, 1H), 2.64 (dd, 1H), 1.04 (t, 3H).

### EXAMPLE NO. I.38-61

¹H NMR (400 MHz, d₆-DMSO δ, ppm) 7.79 (br. d, 1H, NH), 7.54 (d, 2H), 7.28 (d, 2H), 7.19 (m, 3H), 7.04 (m, 2H), 3.65 (q, 1H), 3.42 (s, 3H), 2.61 (m, 2H), 2.36 (s, 3H), 2.33 (m, 2H).

### EXAMPLE NO. I.38-62

¹H NMR (400 MHz, d₆-DMSO δ, ppm) 7.66 (d, 2H), 7.63 (br. d, 1H, NH), 7.39 (d, 2H), 3.94 (q, 2H), 3.47 (m, 1H), 2.38 (s, 3H), 2.26 (m, 2H), 1.47 (m, 1H), 1.22 (m, 1H), 1.12 (t, 3H), 1.06 (m, 1H), 0.74 (d, 3H), 0.57 (d, 3H).

### EXAMPLE NO. I.38-63

¹H NMR (400 MHz, d₆-DMSO δ, ppm) 8.40 (br. d, 1H, NH), 7.63 (d, 2H), 7.38 (d, 2H), 4.15 (m, 1H), 3.51 (s, 3H), 3.40 (s, 3H), 2.71 (dd, 1H), 2.57 (dd, 1H), 2.38 (s, 3H).

### EXAMPLE NO. I.38-83

¹H NMR (400 MHz, d₆-DMSO δ, ppm) 7.64 (d, 2H), 7.61 (br. d, 1H, NH), 7.37 (d, 2H), 3.38 (s, 3H), 3.35 (m, 1H), 2.41 (dd, 1H), 2.39 (s, 3H), 2.12 (dd, 1H), 1.61 (m, 2H), 1.53 (m, 2H), 1.48 (m, 1H), 1.24 (m, 1H), 1.01 (m, 3H), 0.90 (m, 1H), 0.82 (m, 1H).

### EXAMPLE NO. I.38-103

¹H NMR (400 MHz, d₆-DMSO δ, ppm) 8.74 (br. d, 1H, NH), 7.65 (d, 2H), 7.37 (d, 2H), 4.31 (m, 1H), 3.86 (q, 2H), 2.74 (dd, 1H), 2.40 (dd, 1H), 2.38 (s, 3H), 1.09 (t, 3H).

### EXAMPLE NO. I.38-105

¹H NMR (400 MHz, d₆-DMSO δ, ppm) 8.98 (br. d, 1H, NH), 7.65 (d, 2H), 7.49 (br. t, 1H, NH), 7.40 (m, 1H, NH), 7.33 (d, 2H), 7.29 (br. s, 2H, NH), 3.16 (m, 1H), 3.02 (m, 1H), 2.97 (m, 1H), 2.36 (s, 3H), 1.59 (m, 2H), 1.49 (m, 1H), 1.33 (m, 1H).

### EXAMPLE NO. I.38-107

¹H NMR (400 MHz, d₆-DMSO δ, ppm) 8.33 (br. d, 1H, NH), 7.70 (br. t, 1H, NH), 7.64 (d, 2H), 7.43 (m, 1H, NH), 7.38 (d, 2H), 6.92 (br. s, 2H, NH), 3.76 (m, 1H), 3.02 (m, 2H), 2.38 (s, 3H), 1.63 (m, 1H), 1.54 (m, 1H), 1.46 (m, 1H), 1.34 (m, 1H).

### EXAMPLE NO. I.44-36

¹H NMR (400 MHz, CDCl₃ δ, ppm) 8.06 (d, 1H), 7.20-7.50 (m, 8H), 4.72-4.78 (d, 1H), 4.48-4.54 (d, 1H), 4.25-4.35 (m, 1H), 3.98-4.04 (m, 2H), 2.52-2.60 (dd, 1H), 2.15-2.20 (q, 1H), 1.16-1.20 (t, 3H), 1.10-1.15 (d, 3H).

### EXAMPLE NO. I.44-37

¹H NMR (400 MHz, CDCl₃ δ, ppm) 8.10 (d, 1H), 7.45-7.55 (m, 2H), 7.40 (t, 1H), 6.10 (br. s, 1H, NH), 4.14-4.18 (q, 2H), 2.53 (s, 2H), 1.25 (m, 9H).

### EXAMPLE NO. I.44-38

¹H NMR (400 MHz, CDCl₃ δ, ppm) 8.15-8.20 (d, 1H), 7.50-7.56 (m, 2H), 7.40-7.46 (m, 1H), 5.75-5.80 (br. t, 1H, NH), 2.96 (d, 2H), 1.26 (s, 6H).

### EXAMPLE NO. I.44-39

¹H NMR (400 MHz, CDCl₃ δ, ppm) 8.10-8.14 (d, 1H), 7.48-7.54 (m, 2H), 7.38-7.44 (m, 1H), 5.95 (br. s, 1H, NH), 2.66 (s, 2H), 1.30 (s, 6H).

### EXAMPLE NO. I.44-40

¹H NMR (400 MHz, CDCl₃ δ, ppm) 8.06-8.10 (dd, 1H), 7.44-7.50 (m, 2H), 7.26-7.40 (m, 6H), 4.72-4.80 (d, 1H), 4.48-4.52 (d, 1H), 4.20-4.30 (m, 1H), 2.58-2.63 (dd, 1H), 2.14-2.20 (dd, 1H), 1.15 (d, 3H).

### EXAMPLE NO. I.44-41

¹H NMR (400 MHz, CDCl₃ δ, ppm) 8.10 (d, 1H), 7.48-7.54 (m, 2H), 7.38-7.42 (m, 1H), 5.65-5.72 (bd, 1H, NH), 4.10 (q, 2H), 3.70-3.80 (m, 1H), 2.45 (d, 2H), 1.20-1.26 (t, 3H), 1.10-1.15 (d, 3H).

### EXAMPLE NO. I.44-42

¹H NMR (400 MHz, CDCl₃ δ, ppm) 8.12 (d, 1H), 7.50-7.56 (m, 1H), 7.40-7.46 (m, 1H), 5.56-5.60 (d, 1H, NH), 3.72-3.80 (m, 1H), 2.56-2.60 (d, 2H), 1.18-1.20 (d, 3H).

### EXAMPLE NO. I.44-44

¹H NMR (400 MHz, CDCl₃ δ, ppm) 8.10 (d, 1H), 7.48-7.56 (m, 2H), 7.40 (m, 1H), 7.25-7.30 (m, 2H), 6.95-7.04 (m, 2H), 4.54 (s, 2H), 3.58 (s, 3H), 3.50-3.54 (t, 2H), 2.40-2.44 (t, 2H).

### EXAMPLE NO. I.44-45

¹H NMR (400 MHz, CDCl₃ δ, ppm) 8.10 (dd, 1H), 7.45-7.52 (m, 2H), 7.36-7.42 (m, 1H), 4.28 (s, 2H), 3.70 (s, 3H), 3.62-3.68 (m, 5H), 2.60-2.68 (t, 2H)

### EXAMPLE NO. I.44-46

¹H NMR (400 MHz, CDCl₃ δ, ppm) 8.10-8.16 (d, 1H), 7.24-7.56 (m, 8H), 4.56 (s, 2H), 3.50-3.58 (m, 5H), 2.40 (t, 2H).

### EXAMPLE NO. I.44-47

¹H NMR (400 MHz, CDCl₃ δ, ppm) 8.02-8.06 (d, 1H), 7.64-7.70 (m, 2H), 7.50-7.56 (m, 1H), 4.16 (s, 2H), 3.42-3.48 (t, 2H), 2.45-2.50 (m, 2H).

### EXAMPLE NO. I.44-48

¹H NMR (400 MHz, CDCl₃ δ, ppm) 8.10 (dd, 1H), 7.46-7.50 (m, 2H), 7.38-7.42 (m, 1H), 7.16-7.26 (m, 3H), 7.10-7.14 (d, 2H), 3.64-3.70 (m, 5H), 3.50-3.56 (t, 2H), 2.80-2.86 (t, 2H), 2.57-2.62 (t, 2H).

### EXAMPLE NO. I.44-49

¹H NMR (400 MHz, CDCl₃ δ, ppm) 7.76-7.80 (d, 1H), 7.48-7.52 (m, 2H), 7.18-7.32 (m, 3H), 6.86-6.92 (t, 1H), 6.62-6.65 (d, 1H), 4.22-4.30 (br. t, 2H), 3.68 (s, 3H), 3.62 (s, 3H), 2.84-2.90 (t, 2H).

### EXAMPLE NO. I.44-50

¹H NMR (400 MHz, CDCl₃ δ, ppm) 8.20-8.24 (dd, 1H), 7.42-7.56 (m, 3H), 4.24-4.28 (m, 2H), 3.72 (s, 3H), 3.64 (s, 3H), 2.84-2.87 (m, 2H).

### EXAMPLE NO. I.44-51

¹H NMR (400 MHz, CDCl₃ δ, ppm) 8.08-8.14 (d, 1H), 7.46-7.52 (m, 2H), 7.38-7.42 (m, 1H), 7.20-7.27 (m, 2H), 6.96-7.01 (t, 2H), 4.50 (s, 2H), 3.46-3.54 (t, 2H), 2.40-2.44 (t, 2H).

### EXAMPLE NO. I.44-55

¹H NMR (400 MHz, CDCl₃ δ, ppm) 8.70-8.90 (d, 2H), 7.46-7.52 (d, 2H), 7.34-7.38 (m, 4H), 5.82 (br. d, 1H, NH), 4.46-4.52 (t, 1H), 3.62 (s, 3H), 3.20-3.26 (dd, 1H), 2.92-3.00 (dd, 1H).

### EXAMPLE NO. I.52-28

¹H NMR (400 MHz, CDCl₃ δ, ppm) 7.24 (dd, 1H), 7.12 (d, 2H), 5.31 (br. d, 1H, NH), 3.99 (q, 2H), 3.31 (m, 1H), 2.43 (dd, 1H), 2.35 (dd, 1H), 1.80 (m, 1H), 1.21 (t, 3H), 0.82 (d, 3H), 0.79 (d, 3H).

### EXAMPLE NO. I.67-1

¹H NMR (400 MHz, CDCl₃ δ, ppm) 8.31 (d, 1H), 8.10 (d, 2H), 7.71 (dd, 1H), 6.86 (br. t, 1H, NH), 5.22 (br. t, 1H, NH), 4.38 (d, 2H), 4.14 (d, 2H).

### EXAMPLE NO. I.73-54

¹H NMR (400 MHz, CDCl₃ δ, ppm) 7.80-7.84 (d, 2H), 7.48-7.62 (m, 3H), 4.15 (s, 2H), 4.08-4.13 (q, 2H), 3.42-3.48 (t, 2H), 2.62-2.66 (t, 2H), 2.14 (s, 3H), 1.20-1.26 (t, 3H).

### EXAMPLE NO. I.84-41

¹H NMR (400 MHz, CDCl₃ δ, ppm) 7.74 (d, 2H), 7.53 (m, 1H), 5.40-5.45 (br. d, 1H, NH), 4.08-4.15 (m, 2H), 3.70-3.78 (m, 1H), 2.47 (t, 2H), 1.20-1.30 (m, 3H).

### EXAMPLE NO. I.84-42

¹H NMR (400 MHz, CDCl₃ δ, ppm) 7.75 (m, 2H), 7.54 (s, 1H), 5.30 (br. d, 1H, NH), 3.72-3.80 (m, 1H), 2.55-2.58 (m, 2H), 1.24 (d, 3H).

### EXAMPLE NO. I.84-57

¹H NMR (400 MHz, CDCl₃ δ, ppm) 7.78 (m, 2H), 7.52 (m, 1H), 6.35-6.40 (br. d, 1H, NH), 5.26-5.30 (br. d, 1H, NH), 4.00-4.08 (m, 1H), 3.62-3.70 (sept, 1H), 2.30 (dd, 1H), 2.15 (dd, 1H), 1.10-1.25 (m, 9H).

### EXAMPLE NO. I.84-58

¹H NMR (400 MHz, CDCl₃ δ, ppm) 7.76 (m, 2H), 7.52 (m, 1H), 7.28 (s, 1H), 6.20 (br. d, 1H, NH), 5.50-5.55 (br. t, 1H, NH), 4.20 (m, 2H), 4.04-4.10 (q, 2H), 3.65-3.75 (m, 1H), 2.35-2.40 (dd, 1H), 2.20 (s, 3H), 2.15-2.20 (dd, 1H), 1.42-1.48 (t, 3H), 1.20 (d, 3H).

### EXAMPLE NO. I.88-1

¹H NMR (400 MHz, CDCl₃ δ, ppm) 7.70 (d, 2H), 7.62 (d, 2H), 4.68 (br. t, 1H, NH), 4.45 (s, 2H), 4.03 (d, 2H).

### EXAMPLE NO. I.88-2

¹H NMR (400 MHz, CDCl₃ δ, ppm) 7.70 (d, 2H), 7.61 (d, 2H), 4.95 (br. d, 1H, NH), 4.55 (s, 2H), 4.28 (quint, 1H), 1.58 (d, 3H).

### EXAMPLE NO. I.88-3

¹H NMR (400 MHz, CDCl₃ δ, ppm) 7.69 (d, 2H), 7.59 (d, 2H), 4.63 (br. s, 1H, NH), 4.53 (s, 2H), 1.70 (s, 6H).

### EXAMPLE NO. I.88-4

¹H NMR (400 MHz, CDCl₃ δ, ppm) 7.71 (d, 2H), 7.63 (d, 2H), 4.67 (br. d, 1H, NH), 4.46 (d, 1H), 4.44 (d, 1H), 4.14 (dd, 1H), 2.04 (m, 1H), 1.09 (d, 6H).

### EXAMPLE NO. I.88-5

¹H NMR (400 MHz, CDCl₃ δ, ppm) 7.67 (d, 2H), 7.58 (d, 2H), 4.58 (d, 1H), 4.54 (d, 1H), 4.46 (br. s, 1H, NH), 1.83 (m, 2H), 1.70 (s, 3H), 1.48 (m, 2H), 0.99 (t, 3H).

### EXAMPLE NO. I.88-9

¹H NMR (400 MHz, CDCl₃ δ, ppm) 7.68 (d, 2H), 7.63 (d, 2H), 5.02 (br. s, 1H, NH), 4.63 (d, 1H), 4.48 (d, 1H), 3.62 (d, 1H), 3.45 (d, 1H), 3.43 (s, 3H), 1.70 (s, 3H).

### EXAMPLE NO. I.88-11

¹H NMR (400 MHz, CDCl₃ δ, ppm) 7.69 (d, 2H), 7.60 (d, 2H), 4.71 (br. s, 1H, NH), 4.55 (d, 1H), 4.47 (d, 1H), 1.80 (s, 3H), 1.22 (m, 1H), 0.73 (m, 4H).

### EXAMPLE NO. I.88-12

¹H NMR (400 MHz, CDCl₃ δ, ppm) 7.68 (d, 2H), 7.61 (d, 2H), 4.56 (s, 2H), 4.35 (br. s, 1H, NH), 2.02 (m, 2H), 1.91 (m, 2H), 1.04 (t, 6H).

### EXAMPLE NO. I.88-14

¹H NMR (400 MHz, CDCl₃ δ, ppm) 7.68 (d, 2H), 7.61 (d, 2H), 4.56 (s, 2H), 4.38 (br. s, 1H, NH), 1.85 (m, 1H), 1.80 (m, 1H), 1.74 (m, 1H), 1.73 (s, 3H), 1.03 (d, 3H), 1.00 (d, 3H).

### EXAMPLE NO. I.88-23

¹H NMR (400 MHz, CDCl₃ δ, ppm) 7.52 (d, 2H), 7.36 (m, 3H), 7.26 (m, 4H), 4.51 (d, 1H), 4.43 (d, 1H), 4.35 (br. s, 1H, NH), 3.24 (d, 1H), 3.06 (d, 1H), 1.77 (s, 3H).

### EXAMPLE NO. I.88-24

¹H NMR (400 MHz, CDCl₃ δ, ppm) 7.67 (d, 2H), 7.55 (d, 2H), 4.64 (br. t, 1H, NH), 4.36 (s, 2H), 3.26 (q, 2H), 2.50 (t, 2H).

### EXAMPLE NO. I.88-26

¹H NMR (400 MHz, CDCl₃ δ, ppm) 7.67 (d, 2H), 7.58 (d, 2H), 4.40 (br. d, 1H, NH), 4.38 (s, 2H), 3.47 (m, 1H), 2.55 (dd, 1H), 2.47 (dd, 1H), 1.60 (m, 2H), 0.94 (t, 3H).

### EXAMPLE NO. I.92-1

¹H NMR (400 MHz, d₆-DMSO δ, ppm) 8.38 (d, 1H), 8.14 (br. m, 1H, NH), 7.84 (dd, 1H), 7.57 (d, 1H), 4.56 (s, 2H), 4.20 (s, 2H).

### EXAMPLE NO. I.92-4

¹H NMR (400 MHz, d₆-DMSO δ, ppm) 8.41 (d, 1H), 8.38 (br. d, 1H, NH), 7.86 (dd, 1H), 7.58 (d, 1H), 4.59 (d, 1H), 4.55 (d, 1H), 4.35 (d, 1H), 1.94 (m, 1H), 0.99 (d, 3H), 0.95 (d, 3H).

### EXAMPLE NO. I.92-5

¹H NMR (400 MHz, d₆-DMSO δ, ppm) 8.38 (d, 1H), 8.02 (br. s, 1H, NH), 7.85 (dd, 1H), 7.57 (d, 1H), 4.51 (s, 2H), 1.82 (m, 1H), 1.73 (m, 1H), 1.59 (s, 3H), 1.40 (m, 2H), 0.91 (t, 3H).

### EXAMPLE NO. I.92-9

¹H NMR (400 MHz, d₆-DMSO δ, ppm) 8.40 (d, 1H), 8.16 (br. s, 1H, NH), 7.86 (dd, 1H), 7.57 (d, 1H), 4.52 (s, 2H), 3.62 (d, 1H), 3.51 (d, 1H), 3.38 (s, 3H), 1.57 (s, 3H).

### EXAMPLE NO. I.92-13

¹H NMR (400 MHz, d₆-DMSO δ, ppm) 8.39 (d, 1H), 7.99 (br. s, 1H, NH), 7.86 (dd, 1H), 7.57 (d, 1H), 4.52 (s, 2H), 1.91 (m, 1H), 1.80 (m, 1H), 1.58 (s, 3H), 0.95 (t, 3H).

### EXAMPLE NO. I.92-14

¹H NMR (400 MHz, d₆-DMSO δ, ppm) 8.37 (d, 1H), 7.98 (br. s, 1H, NH), 7.87 (dd, 1H), 7.59 (d, 1H), 4.51 (s, 2H), 2.32 (m, 2H), 1.79 (m, 1H), 1.62 (s, 3H), 0.96 (d, 6H).

### EXAMPLE NO. I.92-23

¹H NMR (400 MHz, d₆-DMSO δ, ppm) 8.32 (d, 1H), 8.21 (br. s, 1H, NH), 7.71 (dd, 1H), 7.50 (d, 1H), 7.33 (m, 5H), 4.50 (s, 2H), 3.22 (d, 1H), 3.09 (d, 1H), 1.51 (s, 3H).

### EXAMPLE NO. I.92-24

¹H NMR (400 MHz, d₆-DMSO δ, ppm) 8.39 (d, 1H), 7.85 (dd, 1H), 7.62 (br. s, 1H, NH), 7.55 (d, 1H), 4.50 (s, 2H), 3.20 (m, 2H), 2.68 (m, 2H).

The present invention accordingly provides for the use of at least one compound selected from the group consisting of open-chain aryl-, heteroaryl- and benzylsulfonamidocarboxylic acids, -carboxylic esters, -carboxamides and -carbonitriles of the formula (I), and of any desired mixtures of these open-chain aryl-, heteroaryl- and benzylsulfonamidocarboxylic acids, -carboxylic esters, -carboxamides and -carbonitriles of the formula (I) according to the invention, with active agrochemical ingredients in accordance with the definition below, for enhancement of the resistance of plants to abiotic stress factors, preferably stress due to drought, and for strengthening the plant growth and/or for increasing the plant yield.

The present invention further provides a spray solution for treatment of plants, comprising an amount, effective for enhancement of the resistance of plants to abiotic stress factors, of at least one compound selected from the group consisting of open-chain aryl-, heteroaryl- and benzylsulfonamidocarboxylic acids, -carboxylic esters, -carboxamides and -carbonitriles of the formula (I). Abiotic stress conditions which can be relativized include, for example, drought, heat, cold and drought stress (stress caused by drought and/or lack of water), osmotic stress, waterlogging, elevated soil salinity, elevated exposure to minerals, ozone conditions, strong light conditions, limited availability of nitrogen nutrients, limited availability of phosphorus nutrients.

In one embodiment, it is possible, for example, that the compounds envisaged in accordance with the invention, i.e. the appropriate open-chain aryl-, heteroaryl- and benzylsulfonamidocarboxylic acids, -carboxylic esters, -carboxamides and -carbonitriles of the formula (I), are applied by spray application to appropriate plants or plant parts to be treated. The use intended according to the invention of the compounds of the formula (I) or their salts is preferably carried out using a dosage from 0.00005 to 3 kg/ha, particularly preferably from 0.0001 to 2 kg/ha, especially preferably from 0.0005 to 1 kg/ha. If, in the context of the present invention, abscisic acid is used simultaneously with open-chain aryl-, heteroaryl- and benzylsulfonamidocarboxylic acids, -carboxylic esters, -carboxamides and -carbonitriles of the formula (I), for example in the context of a combined preparation or formulation, the addition of abscisic acid is preferably carried out in a dosage from 0.001 to 3 kg/ha, particularly preferably from 0.005 to 2 kg/ha, especially from 0.01 to 1 kg/ha.

The term “resistance to abiotic stress” is understood in the context of the present invention to mean various kinds of advantages for plants. Such advantageous properties are manifested, for example, in the following improved plant characteristics: improved root growth with regard to surface area and depth, increased stolon and tiller formation, stronger and more productive stolons and tillers, improvement in shoot growth, increased lodging resistance, increased shoot base diameter, increased leaf area, higher yields of nutrients and constituents, for example carbohydrates, fats, oils, proteins, vitamins, minerals, essential oils, dyes, fibers, better fiber quality, earlier flowering, increased number of flowers, reduced content of toxic products such as mycotoxins, reduced content of residues or disadvantageous constituents of any kind, or better digestibility, improved storage stability of the harvested material, improved tolerance to disadvantageous temperatures, improved tolerance to drought and aridity, and also oxygen deficiency as a result of waterlogging, improved tolerance to elevated salt contents in soil and water, enhanced tolerance to ozone stress, improved compatibility with respect to herbicides and other crop treatment compositions, improved water absorption and photosynthesis performance, advantageous plant properties, for example acceleration of ripening, more homogeneous ripening, greater attractiveness to beneficial animals, improved pollination, or other advantages well known to a person skilled in the art.

More particularly, the inventive use exhibits the advantages described in spray application to plants and plant parts. Combinations of the corresponding open-chain aryl-, heteroaryl- and benzylsulfonamidocarboxylic acids, -carboxylic esters, -carboxamides and -carbonitriles of the formula (I) with substances including insecticides, attractants, acaricides, fungicides, nematicides, herbicides, growth regulators, safeners, substances which influence plant maturity, and bactericides can likewise be employed in the control of plant disorders in the context of the present invention. In addition, the combined use of corresponding open-chain aryl-, heteroaryl- and benzylsulfonamidocarboxylic acids, -carboxylic esters, -carboxamides and -carbonitriles of the formula (I) with genetically modified cultivars with a view to increased tolerance to abiotic stress is likewise possible.

As is known, the various advantages for plants, which have been mentioned further above, can be combined in parts, and generally applicable terms can be used to describe them. Such terms are, for example, the following names: phytotonic effect, resistance to stress factors, less plant stress, plant health, healthy plants, plant fitness, plant wellness, plant concept, vigor effect, stress shield, protective shield, crop health, crop health properties, crop health products, crop health management, crop health therapy, plant health, plant health properties, plant health products, plant health management, plant health therapy, greening effect or regreening effect, freshness, or other terms with which a person skilled in the art is quite familiar.

In the context of the present invention, a good effect on the resistance to abiotic stress is understood as meaning, but not by limitation,
at least an emergence improved by generally 3%, especially more than 5%, more preferably more than 10%,
at least a yield enhanced by generally 3%, especially more than 5%, more preferably more than 10%,
at least a root development improved by generally 3%, especially more than 5%, more preferably more than 10%,
at least a shoot size rising by generally 3%, especially more than 5%, more preferably more than 10%,
at least a leaf area increased by generally 3%, especially more than 5%, more preferably more than 10%,
at least a photosynthesis performance improved by generally 3%, especially more than 5%, more preferably more than 10%, and/or
at least a flower development improved by generally 3%, especially more than 5%, more preferably more than 10%,
   it being possible for the effects to manifest themselves individually or else in any combination of two or more effects.

The present invention further provides a spray solution for treatment of plants, comprising an amount, effective for enhancement of the resistance of plants to abiotic stress factors, of at least one compound of the formula (I). The spray solution may comprise other customary constituents, such as solvents, formulation aids, especially water. Further constituents may include active agrochemical compounds which are described below.

The present invention further provides for the use of corresponding spray solutions for enhancing the resistance of plants to abiotic stress factors. The remarks which follow apply both to the inventive use of the compounds of the formula (I) per se and to the corresponding spray solutions.

In accordance with the invention, it has additionally been found that the application, to plants or in their environment, of the compounds of the formula (I) in combination with at least one fertilizer as defined below is possible.

Fertilizers which can be used in accordance with the invention together with the compounds of the formula (I) elucidated in detail above are generally organic and inorganic nitrogen-containing compounds, for example ureas, urea/formaldehyde condensation products, amino acids, ammonium salts and ammonium nitrates, potassium salts (preferably chlorides, sulfates, nitrates), salts of phosphoric acid and/or salts of phosphorous acid (preferably potassium salts and ammonium salts). In this context, particular mention may be made of the NPK fertilizers, i.e. fertilizers which contain nitrogen, phosphorus and potassium, calcium ammonium nitrate, i.e. fertilizers which additionally contain calcium, or ammonium sulfate nitrate (general formula (NH₄)₂SO₄NH₄NO₃), ammonium phosphate and ammonium sulfate. These fertilizers are common knowledge to those skilled in the art; see also, for example, Ullmann's Encyclopedia of Industrial Chemistry, 5th edition, Vol. A 10, pages 323 to 431, Verlagsgesellschaft, Weinheim, 1987.

The fertilizers may also contain salts of micronutrients (preferably calcium, sulfur, boron, manganese, magnesium, iron, boron, copper, zinc, molybdenum and cobalt) and phytohormones (for example vitamin B1 and indole-3-acetic acid) or mixtures of these. Fertilizers employed in accordance with the invention may also contain other salts such as monoammonium phosphate (MAP), diammonium phosphate (DAP), potassium sulfate, potassium chloride, magnesium sulfate. Suitable amounts of the secondary nutrients, or trace elements, are amounts of from 0.5 to 5% by weight, based on the totality of the fertilizer. Other possible ingredients are crop protection agents, insecticides or fungicides, growth regulators or mixtures of these. This will be explained in more detail further below.

The fertilizers can be employed for example in the form of powders, granules, prills or compactates. However, the fertilizers can also be employed in liquid form, dissolved in an aqueous medium. In this case, dilute aqueous ammonia may also be employed as nitrogen fertilizer. Further possible ingredients for fertilizers are described, for example, in Ullmann's Encyclopedia of Industrial Chemistry, 5th edition, 1987, volume A 10, pages 363 to 401, DE-A 41 28 828, DE-A 19 05 834 and DE-A 196 31 764. The general composition of the fertilizers which, within the context of the present invention, may take the form of straight and/or compound fertilizers, for example composed of nitrogen, potassium or phosphorus, may vary within a wide range. In general, a content of from 1 to 30% by weight of nitrogen (preferably 5 to 20% by weight), from 1 to 20% by weight of potassium (preferably from 3 to 15% by weight) and a content of from 1 to 20% by weight of phosphorus (preferably from 3 to 10% by weight) is advantageous. The microelement content is usually in the ppm order of magnitude, preferably in the order of magnitude of from 1 to 1000 ppm.

In the context of the present invention, the fertilizer and the compounds of the formula (I) may be administered simultaneously. However, it is also possible first to apply the fertilizer and then a compound of the formula (I), or first to apply a compound of the formula (I) and then the fertilizer. In the case of nonsynchronous application of a compound of the formula (I) and the fertilizer, the application in the context of the present invention is, however, effected in a functional relationship, especially within a period of generally 24 hours, preferably 18 hours, more preferably 12 hours, specifically 6 hours, more specifically 4 hours, even more specifically within 2 hours. In very particular embodiments of the present invention, the compound of the formula (I) according to the invention and the fertilizer are applied within a time frame of less than 1 hour, preferably less than 30 minutes, more preferably less than 15 minutes.

Preferred is the use of compounds of the formula (I) on plants from the group of the useful plants, ornamentals, turfs, generally used trees which are employed as ornamentals in the public and domestic sectors, and forestry trees. Forestry trees comprise trees for the production of timber, cellulose, paper and products produced from parts of the trees. The term “useful plants” as used in the present context refers to crop plants which are employed as plants for obtaining foodstuffs, feedstuffs, fuels or for industrial purposes.

The useful plants include, for example, the following types of plants: triticale, durum wheat, turf, vines, cereals, for example wheat, barley, rye, oats, rice, corn and millet/sorghum; beet, for example sugar beet and fodder beet; fruits, for example pome fruit, stone fruit and soft fruit, for example apples, pears, plums, peaches, almonds, cherries and berries, for example strawberries, raspberries, blackberries; legumes, for example beans, lentils, peas and soybeans; oil crops, for example oilseed rape, mustard, poppies, olives, sunflowers, coconuts, castor oil plants, cacao beans and peanuts; cucurbits, for example pumpkin/squash, cucumbers and melons; fiber plants, for example cotton, flax, hemp and jute; citrus fruits, for example oranges, lemons, grapefruit and tangerines; vegetables, for example spinach, lettuce, asparagus, cabbage species, carrots, onions, tomatoes, potatoes and bell peppers; Lauraceae, for example avocado, Cinnamomum, camphor, or also plants such as tobacco, nuts, coffee, aubergine, sugar cane, tea, pepper, grapevines, hops, bananas, latex plants and ornamentals, for example flowers, shrubs, deciduous trees and coniferous trees, such as conifers. This enumeration has no limitation.

The following plants are considered to be particularly suitable target crops for applying the method according to the invention: oats, rye, triticale, durum, cotton, aubergine, turf, pome fruit, stone fruit, soft fruit, corn, wheat, barley, cucumber, tobacco, vines, rice, cereals, pears, pepper, beans, soybeans, oilseed rape, tomato, bell pepper, melons, cabbage, potatoes and apples.

Examples of trees which can be improved in accordance with the method according to the invention are: Abies sp., Eucalyptus sp., Picea sp., Pinus sp., Aesculus sp., Platanus sp., Tilia sp., Acer sp., Tsuga sp., Fraxinus sp., Sorbus sp., Betula sp., Crataegus sp., Ulmus sp., Quercus sp., Fagus sp., Salix sp., Populus sp.

Preferred trees which can be improved in accordance with the method according to the invention are: from the tree species Aesculus: A. hippocastanum, A. pariflora, A. carnea; from the tree species Platanus: P. aceriflora, P. occidentalis, P. racemosa; from the tree species Picea: P. abies; from the tree species Pinus: P. radiate, P. ponderosa, P. contorta, P. sylvestre, P. elliottii, P. montecola, P. albicaulis, P. resinosa, P. palustris, P. taeda, P. flexilis, P. jeffregi, P. baksiana, P. strobes; from the tree species Eucalyptus: E. grandis, E. globulus, E. camadentis, E. nitens, E. obliqua, E. regnans, E. pilularus.

Very particularly preferred trees which can be improved in accordance with the method according to the invention are: from the tree species Pinus: P. radiate, P. ponderosa, P. contorta, P. sylvestre, P. strobes; from the tree species Eucalyptus: E. grandis, E. globulus and E. camadentis.

Very particularly preferred trees which can be improved in accordance with the method according to the invention are: horse chestnut, Platanaceae, linden tree and maple tree.

The present invention can also be applied to any turfgrasses, including cool-season turfgrasses and warm-season turfgrasses. Examples of cold-season turfgrasses are bluegrasses (Poa spp.), such as Kentucky bluegrass (Poa pratensis L.), rough bluegrass (Poa trivialis L.), Canada bluegrass (Poa compressa L.), annual bluegrass (Poa annua L.), upland bluegrass (Poa glaucantha Gaudin), wood bluegrass (Poa nemoralis L.) and bulbous bluegrass (Poa bulbosa L.); bentgrasses (Agrostis spp.) such as creeping bentgrass (Agrostis palustris Huds.), colonial bentgrass (Agrostis tenuis Sibth.), velvet bentgrass (Agrostis canina L.), South German Mixed Bentgrass (Agrostis spp. including Agrostis tenius Sibth., Agrostis canina L., and Agrostis palustris Huds.), and redtop (Agrostis alba L.); fescues (Festuca spp.), such as red fescue (Festuca rubra L. spp. rubra), creeping fescue (Festuca rubra L.), chewings fescue (Festuca rubra commutata Gaud.), sheep fescue (Festuca ovina L.), hard fescue (Festuca longifolia Thuill.), hair fescue (Festucu capillata Lam.), tall fescue (Festuca arundinacea Schreb.) and meadow fescue (Festuca elanor L.);

ryegrasses (Lolium spp.), such as annual ryegrass (Lolium multiflorum Lam.), perennial ryegrass (Lolium perenne L.) and italian ryegrass (Lolium multiflorum Lam.);

and wheatgrasses (Agropyron spp.), such as fairway wheatgrass (Agropyron cristatum (L.) Gaertn.), crested wheatgrass (Agropyron desertorum (Fisch.) Schult.) and western wheatgrass (Agropyron smithii Rydb.).

Examples of further cool-season turfgrasses are beachgrass (Ammophila breviligulata Fern.), smooth bromegrass (Bromus inermis Leyss.), cattails such as Timothy (Phleum pratense L.), sand cattail (Phleum subulatum L.), orchardgrass (Dactylis glomerata L.), weeping alkaligrass (Puccinellia distans (L.) Parl.) and crested dog's-tail (Cynosurus cristatus L.).

Examples of warm-season turfgrasses are Bermuda grass (Cynodon spp. L. C. Rich), zoysia grass (Zoysia spp. Willd.), St. Augustine grass (Stenotaphrum secundatum Walt Kuntze), centipede grass (Eremochloa ophiuroides Munro Hack.), carpet grass (Axonopus affinis Chase), Bahia grass (Paspalum notatum Flugge), Kikuyu grass (Pennisetum clandestinum Hochst. ex Chiov.), buffalo grass (Buchloe dactyloids (Nutt.) Engelm.), Blue gramma (Bouteloua gracilis (H.B.K.) Lag. ex Griffiths), seashore paspalum (Paspalum vaginatum Swartz) and sideoats grama (Bouteloua curtipendula (Michx. Torr.). Cool-season turfgrasses are generally preferred for the use according to the invention. Especially preferred are bluegrass, bentgrass and redtop, fescues and ryegrasses. Bentgrass is especially preferred.

More preferably, plants of the plant cultivars which are each commercially available or in use are treated in accordance with the invention. Plant cultivars are to be understood as meaning plants having new properties (“traits”) and which have been obtained by conventional breeding, by mutagenesis or with the aid of recombinant DNA techniques. Crop plants can thus be plants which can be obtained by conventional breeding and optimization methods or by biotechnological and genetic engineering methods or combinations of these methods, including the transgenic plants and including the plant varieties which can or cannot be protected by varietal property rights.

The method of treatment according to the invention can therefore also be used in the treatment of genetically modified organisms (GMOs), e.g. plants or seeds. Genetically modified plants (or transgenic plants) are plants in which a heterologous gene has been stably integrated into the genome. The expression “heterologous gene” essentially means a gene which is provided or assembled outside the plant and when introduced in the nuclear, chloroplastic or mitochondrial genome gives the transformed plant new or improved agronomic or other properties by expressing a protein or polypeptide of interest or by downregulating or silencing other gene(s) which are present in the plant (using for example antisense technology, cosuppression technology or RNAi technology [RNA interference]). A heterologous gene that is present in the genome is also called a transgene. A transgene that is defined by its particular location in the plant genome is called a transformation or transgenic event.

Plants and plant varieties which are preferably treated according to the invention include all plants which have genetic material which imparts particularly advantageous, useful traits to these plants (whether obtained by breeding and/or biotechnological means).

Plants and plant varieties which may also be treated according to the invention are those plants which are resistant to one or more abiotic stress factors. Abiotic stress conditions may include, for example, drought, cold temperature exposure, heat exposure, osmotic stress, waterlogging, increased soil salinity, increased exposure to minerals, exposure to ozone, exposure to strong light, limited availability of nitrogen nutrients, limited availability of phosphorus nutrients or shade avoidance.

Plants and plant varieties which may also be treated according to the invention are those plants characterized by enhanced yield characteristics. Enhanced yield in said plants can be the result of, for example, improved plant physiology, growth and development, such as water use efficiency, water retention efficiency, improved nitrogen use, enhanced carbon assimilation, improved photosynthesis, increased germination efficiency and accelerated maturation. Yield can furthermore be affected by improved plant architecture (under stress and non-stress conditions), including early flowering, flowering control for hybrid seed production, seedling vigor, plant size, internode number and distance, root growth, seed size, fruit size, pod size, pod or ear number, seed number per pod or ear, seed mass, enhanced seed filling, reduced seed dispersal, reduced pod dehiscence and lodging resistance. Further yield traits include seed composition, such as carbohydrate content, protein content, oil content and composition, nutritional value, reduction in anti-nutritional compounds, improved processability and better storage stability.

Plants that may also be treated according to the invention are hybrid plants that already express the characteristics of heterosis, or hybrid vigor, which results in generally higher yield, vigor, health and resistance towards biotic and abiotic stress factors. Such plants are typically made by crossing an inbred male-sterile parent line (the female crossbreeding parent) with another inbred male-fertile parent line (the male crossbreeding parent). The hybrid seed is typically harvested from the male-sterile plants and sold to growers. Male-sterile plants can sometimes (e.g. in corn) be produced by detasseling (i.e. mechanical removal of the male reproductive organs or male flowers) but, more typically, male sterility is the result of genetic determinants in the plant genome. In that case, and especially when seed is the desired product to be harvested from the hybrid plants, it is typically useful to ensure that male fertility in hybrid plants, which contain the genetic determinants responsible for male sterility, is fully restored. This can be accomplished by ensuring that the male crossbreeding parents have appropriate fertility restorer genes which are capable of restoring the male fertility in hybrid plants that contain the genetic determinants responsible for male sterility. Genetic determinants for male sterility may be located in the cytoplasm. Examples of cytoplasmic male sterility (CMS) were for instance described in Brassica species (WO 92/005251, WO 95/009910, WO 98/27806, WO 05/002324, WO 06/021972 and U.S. Pat. No. 6,229,072). However, genetic determinants for male sterility can also be located in the nuclear genome. Male-sterile plants can also be obtained by plant biotechnology methods such as genetic engineering. A particularly useful means for obtaining male-sterile plants is described in WO 89/10396 in which, for example, a ribonuclease such as a barnase is selectively expressed in the tapetum cells in the stamens. Fertility can then be restored by expression in the tapetum cells of a ribonuclease inhibitor such as barstar (e.g. WO 91/002069).

Plants or plant varieties (obtained by plant biotechnology methods such as genetic engineering) which may also be treated according to the invention are herbicide-tolerant plants, i.e. plants made tolerant to one or more given herbicides. Such plants can be obtained either by genetic transformation, or by selection of plants containing a mutation imparting such herbicide tolerance.

Herbicide-tolerant plants are for example glyphosate-tolerant plants, i.e. plants made tolerant to the herbicide glyphosate or salts thereof. For example, glyphosate-tolerant plants can be obtained by transforming the plant with a gene encoding the enzyme 5-enolpyruvylshikimate-3-phosphate synthase (EPSPS). Examples of such EPSPS genes are the AroA gene (mutant CT7) of the bacterium Salmonella typhimurium (Comai et al., Science (1983), 221, 370-371), the CP4 gene of the bacterium Agrobacterium sp. (Barry et al., Curr. Topics Plant Physiol. (1992), 7, 139-145), the genes encoding a petunia EPSPS (Shah et al., Science (1986), 233, 478-481), a tomato EPSPS (Gasser et al., J. Biol. Chem. (1988), 263, 4280-4289) or an Eleusine EPSPS (WO 01/66704). It can also be a mutated EPSPS, as described, for example, in EP-A 0837944, WO 00/066746, WO 00/066747 or WO 02/026995. Glyphosate-tolerant plants can also be obtained by expressing a gene that encodes a glyphosate oxidoreductase enzyme as described in U.S. Pat. No. 5,776,760 and U.S. Pat. No. 5,463,175. Glyphosate-tolerant plants can also be obtained by expressing a gene that encodes a glyphosate acetyl transferase enzyme as described, for example, in WO 02/036782, WO 03/092360, WO 05/012515 and WO 07/024,782. Glyphosate-tolerant plants can also be obtained by selecting plants containing naturally occurring mutations of the above-mentioned genes as described, for example, in WO 01/024615 or WO 03/013226.

Other herbicide-resistant plants are for example plants which have been made tolerant to herbicides inhibiting the enzyme glutamine synthase, such as bialaphos, phosphinothricin or glufosinate. Such plants can be obtained by expressing an enzyme detoxifying the herbicide or a mutant glutamine synthase enzyme that is resistant to inhibition. One such efficient detoxifying enzyme is, for example, an enzyme encoding a phosphinothricin acetyltransferase (such as the bar or pat protein from Streptomyces species for example). Plants expressing an exogenous phosphinothricin acetyltransferase have been described, for example, in U.S. Pat. No. 5,561,236; U.S. Pat. No. 5,648,477; U.S. Pat. No. 5,646,024; U.S. Pat. No. 5,273,894; U.S. Pat. No. 5,637,489; U.S. Pat. No. 5,276,268; U.S. Pat. No. 5,739,082; U.S. Pat. No. 5,908,810 and U.S. Pat. No. 7,112,665.

Further herbicide-tolerant plants are also plants that have been made tolerant to the herbicides inhibiting the enzyme hydroxyphenylpyruvate dioxygenase (HPPD). Hydroxyphenylpyruvate dioxygenases are enzymes that catalyze the reaction in which para-hydroxyphenylpyruvate (HPP) is transformed into homogentisate. Plants tolerant to HPPD-inhibitors can be transformed with a gene encoding a naturally-occurring resistant HPPD enzyme, or a gene encoding a mutated HPPD enzyme according to WO 96/038567, WO 99/024585 and WO 99/024586. Tolerance to HPPD inhibitors can also be obtained by transforming plants with genes encoding certain enzymes enabling the formation of homogentisate despite the inhibition of the native HPPD enzyme by the HPPD inhibitor. Such plants and genes are described in WO 99/034008 and WO 2002/36787. Tolerance of plants to HPPD inhibitors can also be improved by transforming plants with a gene encoding an enzyme prephenate dehydrogenase in addition to a gene encoding an HPPD-tolerant enzyme, as described in WO 2004/024928.

Further herbicide-resistant plants are plants that have been made tolerant to acetolactate synthase (ALS) inhibitors. Known ALS inhibitors include, for example, sulfonylurea, imidazolinone, triazolopyrimidines, pyrimidinyl oxy(thio)benzoates, and/or sulfonylaminocarbonyltriazolinone herbicides. Different mutations in the ALS enzyme (also known as acetohydroxy acid synthase, AHAS) are known to confer tolerance to different herbicides and groups of herbicides, as described, for example, in Tranel and Wright, Weed Science (2002), 50, 700-712, and also in U.S. Pat. No. 5,605,011, U.S. Pat. No. 5,378,824, U.S. Pat. No. 5,141,870 and U.S. Pat. No. 5,013,659. The production of sulfonylurea-tolerant plants and imidazolinone-tolerant plants has been described in U.S. Pat. No. 5,605,011; U.S. Pat. No. 5,013,659; U.S. Pat. No. 5,141,870; U.S. Pat. No. 5,767,361; U.S. Pat. No. 5,731,180; U.S. Pat. No. 5,304,732; U.S. Pat. No. 4,761,373; U.S. Pat. No. 5,331,107; U.S. Pat. No. 5,928,937; and U.S. Pat. No. 5,378,824; and also in the international publication WO 96/033270. Further imidazolinone-tolerant plants have also been described, for example in WO 2004/040012, WO 2004/106529, WO 2005/020673, WO 2005/093093, WO 2006/007373, WO 2006/015376, WO 2006/024351 and WO 2006/060634. Further sulfonylurea- and imidazolinone-tolerant plants have also been described, for example in WO 2007/024782.

Other plants tolerant to ALS inhibitors, in particular imidazolinones, sulfonylureas and/or sulfamoylcarbonyltriazolinones, can be obtained by induced mutagenesis, by selection in cell cultures in the presence of the herbicide or by mutation breeding, as described, for example, for soybeans in U.S. Pat. No. 5,084,082, for rice in WO 97/41218, for sugar beet in U.S. Pat. No. 5,773,702 and WO 99/057965, for lettuce in U.S. Pat. No. 5,198,599 or for sunflower in WO 2001/065922.

Plants or plant varieties (obtained by plant biotechnology methods such as genetic engineering) which may also be treated according to the invention are insect-resistant transgenic plants, i.e. plants made resistant to attack by certain target insects. Such plants can be obtained by genetic transformation, or by selection of plants containing a mutation imparting such insect resistance.

In the present context, the term “insect-resistant transgenic plant” includes any plant containing at least one transgene comprising a coding sequence encoding the following:

1) an insecticidal crystal protein from Bacillus thuringiensis or an insecticidal portion thereof, such as the insecticidal crystal proteins compiled by Crickmore et al., Microbiology and Molecular Biology Reviews (1998), 62, 807-813, updated by Crickmore et al. (2005) in the Bacillus thuringiensis toxin nomenclature, (online at: http://www.lifesci.sussex.ac.uk/Home/Neil_Crickmore/Bt/), or insecticidal portions thereof, for example proteins of the Cry protein classes Cry1Ab, Cry1Ac, Cry1F, Cry2Ab, Cry3Ae or Cry3Bb or insecticidal portions thereof; or

2) a crystal protein from Bacillus thuringiensis or a portion thereof which is insecticidal in the presence of a second other crystal protein from Bacillus thuringiensis or a portion thereof, such as the binary toxin made up of the Cy₃₄ and Cy35 crystal proteins (Moellenbeck et al., Nat. Biotechnol. (2001), 19, 668-72; Schnepf et al., Applied Environm. Microb. (2006), 71, 1765-1774); or

3) a hybrid insecticidal protein comprising portions of two different insecticidal crystal proteins from Bacillus thuringiensis, such as a hybrid of the proteins of 1) above or a hybrid of the proteins of 2) above, for example the Cry1A.105 protein produced by corn event MON98034 (WO 2007/027777); or

4) a protein of any one of points 1) to 3) above wherein some, particularly 1 to 10, amino acids have been replaced by another amino acid to obtain a higher insecticidal activity to a target insect species, and/or to expand the range of the target insect species affected, and/or because of changes induced in the encoding DNA during cloning or transformation, such as the Cry3Bb1 protein in corn events MON863 or MON88017, or the Cry3A protein in corn event MIR 604; or

5) an insecticidal secreted protein from Bacillus thuringiensis or Bacillus cereus, or an insecticidal portion thereof, such as the vegetative insecticidal proteins (VIPs) listed under the following link, for example proteins from the VIP3Aa protein class: http://www.lifesci.sussex.ac.uk/Home/Neil_Crickmore/Bt/vip.html; or

6) a secreted protein from Bacillus thuringiensis or Bacillus cereus which is insecticidal in the presence of a second secreted protein from Bacillus thuringiensis or B. cereus, such as the binary toxin made up of the VIP1A and VIP2A proteins (WO 94/21795); or

7) a hybrid insecticidal protein comprising portions from different secreted proteins from Bacillus thuringiensis or Bacillus cereus, such as a hybrid of the proteins in 1) above or a hybrid of the proteins in 2) above; or

8) a protein of any one of points 1) to 3) above wherein some, particularly 1 to 10, amino acids have been replaced by another amino acid to obtain a higher insecticidal activity to a target insect species, and/or to expand the range of the target insect species affected, and/or because of changes induced in the encoding DNA during cloning or transformation (while still encoding an insecticidal protein), such as the VIP3Aa protein in cotton event COT 102.

Of course, insect-resistant transgenic plants, as used herein, also include any plant comprising a combination of genes encoding the proteins of any one of the above classes 1 to 8. In one embodiment, an insect-resistant plant contains more than one transgene encoding a protein of any one of the above classes 1 to 8, to expand the range of the target insect species affected or to delay insect resistance development to the plants, by using different proteins insecticidal to the same target insect species but having a different mode of action, such as binding to different receptor binding sites in the insect.

Plants or plant varieties (obtained by plant biotechnology methods such as genetic engineering) which may also be treated according to the invention are tolerant to abiotic stress factors. Such plants can be obtained by genetic transformation, or by selection of plants containing a mutation imparting such stress resistance.

Particularly useful stress-tolerant plants include the following:

a. plants which contain a transgene capable of reducing the expression and/or the activity of the poly(ADP-ribose)polymerase (PARP) gene in the plant cells or plants, as described in WO 2000/004173 or EP 04077984.5 or EP 06009836.5.

b. plants which contain a stress tolerance-enhancing transgene capable of reducing the expression and/or the activity of the PARG encoding genes of the plants or plant cells, as described, for example, in WO 2004/090140;

c. plants which contain a stress tolerance-enhancing transgene coding for a plant-functional enzyme of the nicotinamide adenine dinucleotide salvage biosynthesis pathway, including nicotinamidase, nicotinate phosphoribosyltransferase, nicotinic acid mononucleotide adenyl transferase, nicotinamide adenine dinucleotide synthetase or nicotinamide phosphoribosyltransferase, as described, for example, in EP 04077624.7 or WO 2006/133827 or PCT/EP07/002,433.

Plants or plant varieties (obtained by plant biotechnology methods such as genetic engineering) which may also be treated according to the invention show altered quantity, quality and/or storage stability in the harvested product and/or altered properties of specific ingredients of the harvested product such as, for example:

1) Transgenic plants which synthesize a modified starch which is altered with respect to its chemophysical traits, in particular the amylose content or the amylose/amylopectin ratio, the degree of branching, the average chain length, the distribution of the side chains, the viscosity behavior, the gel resistance, the grain size and/or grain morphology of the starch in comparison to the synthesized starch in wild-type plant cells or plants, such that this modified starch is better suited for certain applications. These transgenic plants synthesizing a modified starch are described, for example, in EP 0571427, WO 95/004826, EP 0719338, WO 96/15248, WO 96/19581, WO 96/27674, WO 97/11188, WO 97/26362, WO 97/32985, WO 97/42328, WO 97/44472, WO 97/45545, WO 98/27212, WO 98/40503, WO 99/58688, WO 99/58690, WO 99/58654, WO 2000/008184, WO 2000/008185, WO 2000/28052, WO 2000/77229, WO 2001/12782, WO 2001/12826, WO 2002/101059, WO 2003/071860, WO 2004/056999, WO 2005/030942, WO 2005/030941, WO 2005/095632, WO 2005/095617, WO 2005/095619, WO 2005/095618, WO 2005/123927, WO 2006/018319, WO 2006/103107, WO 2006/108702, WO 2007/009823, WO 2000/22140, WO 2006/063862, WO 2006/072603, WO 2002/034923, EP 06090134.5, EP 06090228.5, EP 06090227.7, EP 07090007.1, EP 07090009.7, WO 2001/14569, WO 2002/79410, WO 2003/33540, WO 2004/078983, WO 2001/19975, WO 95/26407, WO 96/34968, WO 98/20145, WO 99/12950, WO 99/66050, WO 99/53072, U.S. Pat. No. 6,734,341, WO 2000/11192, WO 98/22604, WO 98/32326, WO 2001/98509, WO 2001/98509, WO 2005/002359, U.S. Pat. No. 5,824,790, U.S. Pat. No. 6,013,861, WO 94/004693, WO 94/009144, WO 94/11520, WO 95/35026 and WO 97/20936.

2) Transgenic plants which synthesize non-starch carbohydrate polymers or which synthesize non-starch carbohydrate polymers with altered properties in comparison to wild-type plants without genetic modification. Examples are plants which produce polyfructose, especially of the inulin and levan type, as described in EP 0663956, WO 96/001904, WO 96/021023, WO 98/039460 and WO 99/024593, plants which produce alpha-1,4-glucans, as described in WO 95/031553, US 2002/031826, U.S. Pat. No. 6,284,479, U.S. Pat. No. 5,712,107, WO 97/047806, WO 97/047807, WO 97/047808 and WO 2000/14249, plants which produce alpha-1,6-branched alpha-1,4-glucans, as described in WO 2000/73422, and plants which produce alternan, as described in WO 2000/047727, EP 06077301.7, U.S. Pat. No. 5,908,975 and EP 0728213.

3) Transgenic plants which produce hyaluronan, as described, for example, in WO 06/032538, WO 2007/039314, WO 2007/039315, WO 2007/039316, JP 2006/304779 and WO 2005/012529.

Plants or plant varieties (obtained by plant biotechnology methods such as genetic engineering) which may also be treated according to the invention are plants, such as cotton plants, with altered fiber characteristics. Such plants can be obtained by genetic transformation, or by selection of plants containing a mutation imparting such altered fiber characteristics and include:

a) plants, such as cotton plants, which contain an altered form of cellulose synthase genes, as described in WO 98/000549;

b) plants, such as cotton plants, which contain an altered form of rsw2 or rsw3 homologous nucleic acids, as described in WO 2004/053219;

c) plants, such as cotton plants, with an increased expression of sucrose phosphate synthase as described in WO 2001/017333;

d) plants, such as cotton plants, with an increased expression of sucrose synthase, as described in WO 02/45485;

e) plants, such as cotton plants, wherein the timing of the plasmodesmatal gating at the basis of the fiber cell is altered, for example through downregulation of fiber-selective β-1,3-glucanase as described in WO 2005/017157;

f) plants, such as cotton plants, which have fibers with altered reactivity, for example through the expression of the N-acetylglucosamine transferase gene including nodC and chitin synthase genes, as described in WO 2006/136351.

Plants or plant varieties (obtained by plant biotechnology methods such as genetic engineering) which may also be treated according to the invention are plants, such as oilseed rape or related Brassica plants, with altered oil profile characteristics. Such plants can be obtained by genetic transformation or by selection of plants containing a mutation imparting such altered oil characteristics and include:

a) plants, such as oilseed rape plants, which produce oil having a high oleic acid content, as described, for example, in U.S. Pat. No. 5,969,169, U.S. Pat. No. 5,840,946 or U.S. Pat. No. 6,323,392 or U.S. Pat. No. 6,063,947;

b) plants, such as oilseed rape plants, which produce oil having a low linolenic acid content, as described in U.S. Pat. No. 6,270,828, U.S. Pat. No. 6,169,190 or U.S. Pat. No. 5,965,755;

c) plants, such as oilseed rape plants, which produce oil having a low level of saturated fatty acids, as described, for example, in U.S. Pat. No. 5,434,283.

Particularly useful transgenic plants which may be treated according to the invention are plants containing transformation events, or a combination of transformation events, and that are listed for example in the databases of various national or regional regulatory agencies.

Particularly useful transgenic plants which may be treated according to the invention are plants, for example, which comprise one or more genes which encode one or more toxins and are the transgenic plants available under the following trade names: YIELD GARD® (for example corn, cotton, soybeans), KnockOut® (for example corn), BiteGard® (for example corn), BT-Xtra® (for example corn), StarLink® (for example corn), Bollgard® (cotton), Nucotn® (cotton), Nucotn 33B® (cotton), NatureGard® (for example corn), Protecta® and NewLeaf® (potato). Examples of herbicide-tolerant plants which may be mentioned are corn varieties, cotton varieties and soybean varieties which are available under the following trade names: Roundup Ready® (tolerance to glyphosates, for example corn, cotton, soybeans), Liberty Link® (tolerance to phosphinothricin, for example oilseed rape), IMI® (tolerance to imidazolinone) and SCS® (tolerance to sulfonylurea, for example corn). Herbicide-resistant plants (plants bred in a conventional manner for herbicide tolerance) which may be mentioned include the varieties sold under the name Clearfield® (for example corn).

The compounds of the formula (I) to be used in accordance with the invention can be converted to customary formulations, such as solutions, emulsions, wettable powders, water- and oil-based suspensions, powders, dusts, pastes, soluble powders, soluble granules, granules for broadcasting, suspoemulsion concentrates, natural compounds impregnated with active ingredient, synthetic substances impregnated with active ingredient, fertilizers, and also microencapsulations in polymeric substances. In the context of the present invention, it is especially preferred when the compounds of the formula (I) are used in the form of a spray formulation.

The present invention therefore additionally also relates to a spray formulation for enhancing the resistance of plants to abiotic stress. A spray formulation is described in detail hereinafter:

The formulations for spray application are produced in a known manner, for example by mixing the compounds of the formula (I) for use in accordance with the invention with extenders, i.e. liquid solvents and/or solid carriers, optionally with use of surfactants, i.e. emulsifiers and/or dispersants and/or foam formers. Further customary additives, for example customary extenders and solvents or diluents, dyes, wetting agents, dispersants, emulsifiers, antifoams, preservatives, secondary thickeners, stickers, gibberellins and also water, can optionally also be used. The formulations are produced either in suitable plants or else before or during application.

Suitable for use as auxiliaries are substances which impart to the composition itself and/or to preparations derived therefrom (for example spray liquors, seed dressings) particular properties such as certain technical properties and/or also particular biological properties. Typical auxiliaries include: extenders, solvents and carriers.

Suitable extenders are, for example, water, polar and nonpolar organic chemical liquids, for example from the classes of the aromatic and nonaromatic hydrocarbons (such as paraffins, alkylbenzenes, alkylnaphthalenes, chlorobenzenes), the alcohols and polyols (which, if appropriate, may also be substituted, etherified and/or esterified), the ketones (such as acetone, cyclohexanone), esters (including fats and oils) and (poly)ethers, the unsubstituted and substituted amines, amides, lactams (such as N-alkylpyrrolidones) and lactones, the sulfones and sulfoxides (such as dimethyl sulfoxide).

If the extender used is water, it is also possible to employ, for example, organic solvents as auxiliary solvents. Essentially, suitable liquid solvents are: aromatics such as xylene, toluene or alkylnaphthalenes, chlorinated aromatics and chlorinated aliphatic hydrocarbons such as chlorobenzenes, chloroethylenes or methylene chloride, aliphatic hydrocarbons such as cyclohexane or paraffins, for example petroleum fractions, mineral and vegetable oils, alcohols such as butanol or glycol and also their ethers and esters, ketones such as acetone, methyl ethyl ketone, methyl isobutyl ketone or cyclohexanone, strongly polar solvents such as dimethyl sulfoxide, and also water.

It is possible to use colorants such as inorganic pigments, for example iron oxide, titanium oxide and Prussian Blue, and organic colorants such as alizarin colorants, azo colorants and metal phthalocyanine colorants, and trace nutrients such as salts of iron, manganese, boron, copper, cobalt, molybdenum and zinc.

Suitable wetting agents which may be present in the formulations which can be used in accordance with the invention are all substances which promote wetting and which are conventionally used for the formulation of agrochemical active compounds. Preference is given to using alkylnaphthalenesulfonates, such as diisopropyl or diisobutylnaphthalenesulfonates.

Suitable dispersants and/or emulsifiers which may be present in the formulations which can be used in accordance with the invention are all nonionic, anionic and cationic dispersants conventionally used for the formulation of agrochemical active compounds. Preference is given to using nonionic or anionic dispersants or mixtures of nonionic or anionic dispersants. Suitable nonionic dispersants are especially ethylene oxide/propylene oxide block polymers, alkylphenol polyglycol ethers and tristryrylphenol polyglycol ethers, and the phosphated or sulfated derivatives thereof. Suitable anionic dispersants are, in particular, lignosulfonates, polyacrylic acid salts and arylsulfonate/formaldehyde condensates.

Suitable antifoams which may be present in the formulations which can be used in accordance with the invention are all foam-inhibiting substances conventionally used for the formulation of agrochemically active compounds. Silicone antifoams and magnesium stearate can preferably be used.

Suitable preservatives which may be present in the formulations which can be used in accordance with the invention are all substances usable for such purposes in agrochemical compositions. Dichlorophene and benzyl alcohol hemiformal may be mentioned by way of example.

Suitable secondary thickeners which may be present in the formulations which can be used in accordance with the invention are all substances usable for such purposes in agrochemical compositions. Cellulose derivatives, acrylic acid derivatives, xanthan, modified clays and finely divided silica are preferred.

Suitable stickers which may be present in the formulations which can be used in accordance with the invention include all customary binders usable in seed-dressing products. Polyvinylpyrrolidone, polyvinyl acetate, polyvinyl alcohol and tylose may be mentioned as being preferred. Suitable gibberellins which can be present in the formulations which can be used in accordance with the invention are preferably the gibberellins A1, A3 (=gibberellic acid), A4 and A7; gibberellic acid is especially preferably used. The gibberellins are known (cf. R. Wegler “Chemie der Pflanzenschutz- and Schadlingsbekampfungsmittel” [Chemistry of the Crop Protection Compositions and Pesticides], vol. 2, Springer Verlag, 1970, pp. 401-412).

Other possible additives are perfumes, mineral or vegetable oils which are optionally modified, waxes and nutrients (including trace nutrients), such as salts of iron, manganese, boron, copper, cobalt, molybdenum and zinc. Additionally present may be stabilizers, such as cold stabilizers, antioxidants, light stabilizers or other agents which improve chemical and/or physical stability.

The formulations contain generally between 0.01 and 98% by weight, preferably between 0.5 and 90%, of the compound of the formula (I).

The active compound according to the invention can be present in its commercially available formulations and in the use forms, prepared from these formulations, as a mixture with other active compounds, such as insecticides, attractants, sterilizing agents, bactericides, acaricides, nematicides, fungicides, growth-regulating substances, herbicides, safeners, fertilizers or semiochemicals.

In addition, the described positive effect of the compounds of the formula (I) on the plants’ own defenses can be supported by an additional treatment with insecticidally, fungicidally or bactericidally active compounds.

Preferred times for the application of compounds of the formula (I) for enhancing resistance to abiotic stress are treatments of the soil, stems and/or leaves with the approved application rates.

The active compounds of the formula (I) may generally additionally be present in their commercial formulations and in the use forms prepared from these formulations in mixtures with other active compounds, such as insecticides, attractants, sterilants, acaricides, nematicides, fungicides, bactericides, growth-regulating substances, substances which influence plant maturity, safeners or herbicides. Particularly favorable mixing partners are, for example, the active compounds of the different classes, specified below in groups, without any preference resulting from the sequence thereof:

Fungicides:

F1) nucleic acid synthesis inhibitors, for example benalaxyl, benalaxyl-M, bupirimate, chiralaxyl, clozylacon, dimethirimol, ethirimol, furalaxyl, hymexazole, metalaxyl, metalaxyl-M, ofurace, oxadixyl, oxolinic acid;

F2) mitosis and cell division inhibitors, for example benomyl, carbendazim, diethofencarb, fuberidazole, fluopicolide, pencycuron, thiabendazole, thiophanate-methyl, zoxamide and chloro-7-(4-methylpiperidin-1-yl)-6-(2,4,6-trifluorophenyl)[1,2,4]triazolo[1,5-a]pyrimidine;

F3) respiratory chain complex I/II inhibitors, for example diflumetorim, bixafen, boscalid, carboxin, diflumethorim, fenfuram, fluopyram, flutolanil, furametpyr, mepronil, oxycarboxin, penflufen, penthiopyrad, thifluzamide, N-[2-(1,3-dimethylbutyl)phenyl]-5-fluoro-1,3-dimethyl-1H-pyrazole-4-carboxamide, isopyrazam, sedaxan, 3-(difluoromethyl)-1-methyl-N-(3′,4′,5′-trifluorobiphenyl-2-yl)-1H-pyrazole-4-carboxamide, 3-(difluoromethyl)-1-methyl-N-[2-(1,1,2,2-tetrafluoroethoxy)phenyl]-1H-pyrazole-4-carboxamide, 3-(difluoromethyl)-N-[4-fluoro-2-(1,1,2,3,3,3-hexafluoropropoxy)phenyl]-1-methyl-1H-pyrazole-4-carboxamide, N-[1-(2,4-dichlorophenyl)-1-methoxypropan-2-yl]-3-(difluoromethyl)-1-methyl-1H-pyrazole-4-carboxamide and corresponding salts;

F4) respiratory chain complex Ill inhibitors, for example amisulbrom, azoxystrobin, cyazofamid, dimoxystrobin, enestrobin, famoxadon, fenamidon, fluoxastrobin, kresoxim-methyl, metominostrobin, orysastrobin, pyraclostrobin, pyribencarb, picoxystrobin, trifloxystrobin, (2E)-2-(2-{[6-(3-chloro-2-methylphenoxy)-5-fluoropyrimidin-4-yl]oxy}phenyl)-2-(methoxyimino)-N-methylethanamide, (2E)-2-(ethoxyimino)-N-methyl-2-(2-{[({(1E)-1-[3-(trifluoromethyl)phenyl]ethylidene}amino)oxy]methyl}phenyl)ethanamide and corresponding salts, (2E)-2-(methoxyimino)-N-methyl-2-{2-[(E)-({1-[3-(trifluoromethyl)phenyl]ethoxy}imino)methyl]phenyl}ethanamide, (2E)-2-{2-[({[(1E)-1-(3-{[(E)-1-fluoro-2-phenylethenyl]oxy}phenyl)ethylidene]amino}oxy)methyl]phenyl}-2-(methoxyimino)-N-methylethanamide, (2E)-2-{2-[({[(2E,3E)-4-(2,6-dichlorophenyl)but-3-en-2-ylidene]amino}oxy)methyl]phenyl}-2-(methoxyimino)-N-methylethanamide, 2-chloro-N-(1,1,3-trimethyl-2,3-dihydro-1H-inden-4-yl)pyridine-3-carboxamide, 5-methoxy-2-methyl-4-(2-{[({(1E)-1-[3-(trifluoromethyl)phenyl]ethylidene}amino)oxy]methyl}phenyl)-2,4-dihydro-3H-1,2,4-triazol-3-one, 2-methyl-{2-[({cyclopropyl[(4-methoxyphenyl)imino]methyl}sulfanyl)methyl]phenyl}-3-methoxyacrylate, N-(3-ethyl-3,5,5-trimethylcyclohexyl)-3-(formylamino)-2-hydroxybenzamide and corresponding salts;

F5) decouplers, for example dinocap, fluazinam;

F6) ATP production inhibitors, for example fentin acetate, fentin chloride, fentin hydroxide, silthiofam;

F7) amino acid and protein biosynthesis inhibitors, for example andoprim, blasticidin-S, cyprodinil, kasugamycin, kasugamycin hydrochloride hydrate, mepanipyrim, pyrimethanil;

F8) signal transduction inhibitors, for example fenpiclonil, fludioxonil, quinoxyfen;

F9) lipid and membrane synthesis inhibitors, for example chlozolinate, iprodione, procymidone, vinclozolin, ampropylfos, potassium-ampropylfos, edifenphos, iprobenfos (IBP), isoprothiolane, pyrazophos, tolclofos-methyl, biphenyl, iodocarb, propamocarb, propamocarb hydrochloride;

F10) ergosterol biosynthesis inhibitors, for example fenhexamid, azaconazole, bitertanol, bromuconazole, diclobutrazole, difenoconazole, diniconazole, diniconazole-M, etaconazole, fenbuconazole, fluquinconazole, flusilazole, flutriafol, furconazole, furconazole-cis, hexaconazole, imibenconazole, ipconazole, metconazole, myclobutanil, paclobutrazole, penconazole, propiconazole, prothioconazole, simeconazole, spiroxamine, tebuconazole, triadimefon, triadimenol, triticonazole, uniconazole, voriconazole, imazalil, imazalil sulfate, oxpoconazole, fenarimol, flurprimidol, nuarimol, pyrifenox, triforin, pefurazoate, prochloraz, triflumizole, viniconazole, aldimorph, dodemorph, dodemorph acetate, fenpropimorph, tridemorph, fenpropidin, naftifin, pyributicarb, terbinafin, 1-(4-chlorophenyl)-2-(1H-1,2,4-triazol-1-yl)cycloheptanol, methyl 1-(2,2-dimethyl-2,3-dihydro-1H-inden-1-yl)-1H-imidazole-5-carboxylate, N′-{5-(difluoromethyl)-2-methyl-4-[3-(trimethyl-silyl)propoxy]phenyl}-N-ethyl-N-methylimidoformamide, N-ethyl-N-methyl-N′-{2-methyl-5-(trifluoromethyl)-4-[3-(trimethylsilyl)propoxy]phenyl}imidoformamide and O-{1-[(4-methoxyphenoxy)methyl]-2,2-dimethylpropyl}-1H-imidazole-1-carbothioate;

F11) cell wall synthesis inhibitors, for example benthiavalicarb, bialaphos, dimethomorph, flumorph, iprovalicarb, polyoxins, polyoxorim, validamycin A;

F12) melanine biosynthesis inhibitors, for example capropamide, diclocymet, fenoxanil, phthalide, pyroquilon, tricyclazole;

F13) resistance induction, for example acibenzolar-5-methyl, probenazole, tiadinil;

F14) multisite, for example captafol, captan, chlorothalonil, copper salts such as: copper hydroxide, copper naphthenate, copper oxychloride, copper sulfate, copper oxide, oxine-copper and Bordeaux mixture, dichlofluanid, dithianon, dodine, dodine free base, ferbam, folpet, fluorofolpet, guazatine, guazatine acetate, iminoctadine, iminoctadine albesilate, iminoctadine triacetate, mancopper, mancozeb, maneb, metiram, metiram zinc, propineb, sulfur and sulfur preparations containing calcium polysulfide, thiram, tolylfluanid, zineb, ziram;

F15) unknown mechanism, for example amibromdol, benthiazole, bethoxazin, capsimycin, carvone, chinomethionat, chloropicrin, cufraneb, cyflufenamid, cymoxanil, dazomet, debacarb, diclomezine, dichlorophen, dicloran, difenzoquat, difenzoquat methyl sulfate, diphenylamine, ethaboxam, ferimzone, flumetover, flusulfamide, fluopicolid, fluoroimid, fosatyl-Al, hexachlorobenzene, 8-hydroxyquinoline sulfate, iprodione, irumamycin, isotianil, methasulfocarb, metrafenone, methyl isothiocyanate, mildiomycin, natamycin, nickel dimethyl dithiocarbamate, nitrothal-isopropyl, octhilinone, oxamocarb, oxyfenthiin, pentachlorophenol and salts, 2-phenylphenol and salts, piperalin, propanosine-sodium, proquinazid, pyrrolnitrin, quintozene, tecloftalam, tecnazene, triazoxide, trichlamide, zarilamid and 2,3,5,6-tetrachloro-4-(methylsulfonyl)pyridine, N-(4-chloro-2-nitrophenyl)-N-ethyl-4-methylbenzenesulfonamide, 2-amino-4-methyl-N-phenyl-5-thiazolecarboxamide, 2-chloro-N-(2,3-dihydro-1,1,3-trimethyl-1H-inden-4-yl)-3-pyridinecarboxamide, 3-[5-(4-chlorophenyl)-2,3-dimethylisoxazolidin-3-yl]pyridine, cis-1-(4-chlorophenyl)-2-(1H-1,2,4-triazol-1-yl)cycloheptanol, 2,4-dihydro-5-methoxy-2-methyl-4-[[[[1-[3(trifluoromethyl)phenyl]ethylidene]amino]oxy]methyl]phenyl]-3H-1,2,3-triazol-3-one (185336-79-2), methyl 1-(2,3-dihydro-2,2-dimethyl-1H-inden-1-yl)-1H-imidazole-5-carboxylate, 3,4,5-trichloro-2,6-pyridinedicarbonitrile, methyl 2-[[[cyclopropyl[(4-methoxyphenyl)imino]methyl]thio]methyl]-.alpha.-(methoxymethylene)benzacetate, 4-chloro-alpha-propynyloxy-N-[2-[3-methoxy-4-(2-propynyloxy)phenyl]ethyl]benzacetamide, (2S)—N-[2-[4-[[3-(4-chlorophenyl)-2-propynyl]oxy]-3-methoxyphenyl]ethyl]-3-methyl-2-[(methylsulfonyl)amino]butanamide, 5-chloro-7-(4-methylpiperidin-1-yl)-6-(2,4,6-trifluorophenyl)[1,2,4]triazolo[1,5-a]pyrimidine, 5-chloro-6-(2,4,6-trifluorophenyl)-N-[(1R)-1,2,2-trimethylpropyl][1,2,4]triazolo[1,5-a]pyrimidine-7-amine, 5-chloro-N-[(1R)-1,2-dimethylpropyl]-6-(2,4,6-trifluorophenyl)[1,2,4]triazolo[1,5-a]pyrimidine-7-amine, N-[1-(5-bromo-3-chloropyridin-2-yl)ethyl]-2,4-dichloronicotinamide, N-(5-bromo-3-chloropyridin-2-yl)methyl-2,4-dichloronicotinamide, 2-butoxy-6-iodo-3-propylbenzopyranon-4-one, N-{(Z)-[(cyclopropylmethoxy)imino][6-(difluoromethoxy)-2,3-difluorophenyl]methyl}-2-benzacetamide, N-(3-ethyl-3,5,5-trimethylcyclohexyl)-3-formylamino-2-hydroxybenzamide, 2-[[[[1-[3(1-fluoro-2-phenylethyl)oxy]phenyl]ethylidene]amino]oxy]methyl]-alpha-(methoxyimino)-N-methyl-alphaE-benzacetamide, N-{2-[3-chloro-5-(trifluoromethyl)pyridin-2-yl]ethyl}-2-(trifluoromethyl)benzamide, N-(3′,4′-dichloro-5-fluorobiphenyl-2-yl)-3-(difluoromethyl)-1-methyl-1H-pyrazole-4-carboxamide, N-(6-methoxy-3-pyridinyl)cyclopropanecarboxamide, 1-[(4-methoxyphenoxy)methyl]-2,2-dimethylpropyl-1H-imidazole-1-carboxylic acid, O-[1-[(4-methoxyphenoxy)methyl]2,2-dimethylpropyl]-1H-imidazole-1-carbothioic acid, 2-(2-{[6-(3-chloro-2-methylphenoxy)-5-fluoropyrimidin-4-yl]oxy}phenyl)-2-(methoxyimino)-N-methylacetamide.

Bactericides:

bronopol, dichlorophen, nitrapyrin, nickel dimethyldithiocarbamate, kasugamycin, octhilinone, furancarboxylic acid, oxytetracyclin, probenazole, streptomycin, tecloftalam, copper sulfate and other copper preparations.

Insecticides/acaricides/nematicides:

I1) acetylcholinesterase (AChE) inhibitors, such as, for example, carbamates, for example alanycarb, aldicarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, triazamate, trimethacarb, XMC and xylylcarb; or organophosphates, for example acephate, azamethiphos, azinphos (-methyl, -ethyl), cadusafos, chlorethoxyfos, chlorfenvinphos, chlormephos, chlorpyrifos (-methyl), coumaphos, cyanophos, demeton-5-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, isofenphos, isopropyl O-(methoxyaminothiophosphoryl) salicylate, isoxathion, malathion, mecarbam, methamidophos, methidathion, mevinphos, monocrotophos, naled, omethoate, oxydemeton-methyl, parathion (-methyl), phenthoate, phorate, phosalone, phosmet, phosphamidon, phoxim, pirimiphos (-methyl), profenofos, propetamphos, prothiofos, pyraclofos, pyridaphenthion, quinalphos, sulfotep, tebupirimfos, temephos, terbufos, tetrachlorvinphos, thiometon, triazophos, triclorfon and vamidothion;

I2) GABA-gated chloride channel antagonists, such as, for example, organochlorines, for example chlordane and endosulfan (alpha-); or fiproles (phenylpyrazoles), for example ethiprole, fipronil, pyrafluprole and pyriprole;

I3) sodium channel modulators/voltage-gated sodium channel blockers, such as, for example, pyrethroids, for example acrinathrin, allethrin (d-cis-trans, d-trans), bifenthrin, bioallethrin, bioallethrin-5-cyclopentenyl, bioresmethrin, cycloprothrin, cyfluthrin (beta-), cyhalothrin (gamma-, lambda-), cypermethrin (alpha-, beta-, theta-, zeta-), cyphenothrin [(1R)-trans-isomers], deltamethrin, dimefluthrin, empenthrin [(EZ)-(1R)-isomers], esfenvalerate, etofenprox, fenpropathrin, fenvalerate, flucythrinate, flumethrin, fluvalinate (tau-), halfenprox, imiprothrin, metofluthrin, permethrin, phenothrin [(1R)-trans-isomer], prallethrin, profluthrin, pyrethrins (pyrethrum), resmethrin, RU 15525, silafluofen, tefluthrin, tetramethrin [(1R)-isomers], tralomethrin, transfluthrin and ZXI 8901; or -DDT; or methoxychlor;

I4) nicotinergic acetylcholine receptor agonists, such as, for example, neonicotinoids, for example acetamiprid, clothianidin, dinotefuran, imidacloprid, nitenpyram, thiacloprid, thiamethoxam; or nicotine;

I5) allosteric acetylcholine receptor modulators (agonists) such as, for example, spinosyns, for example spinetoram and spinosad;

I6) chloride channel activators, such as, for example, avermectins/milbemycins, for example abamectin, emamectin, emamectin benzoate, lepimectin and milbemectin;

I7) juvenile hormone analogs, for example hydroprene, kinoprene, methoprene; or fenoxycarb; pyriproxyfen;

I8) active compounds with unknown or non-specific mechanisms of action, such as, for example, fumigants, for example methyl bromide and other alkyl halides; or chloropicrin; sulfuryl fluoride; borax; tartar emetic;

I9) selective antifeedants, for example pymetrozine; or flonicamid;

I10) mite growth inhibitors, for example clofentezine, diflovidazin, hexythiazox, etoxazole;

I11) microbial disruptors of the insect gut membrane, such as, for example Bacillus thuringiensis subspecies israelensis, Bacillus sphaericus, Bacillus thuringiensis subspecies aizawai, Bacillus thuringiensis subspecies kurstaki, Bacillus thuringiensis subspecies tenebrionis, and BT plant proteins, for example Cry1Ab, Cry1Ac, Cry1Fa, Cry2Ab, mCry3A, Cry3Ab, Cry3Bb, Cry34/35Ab1;

I12) oxidative phosphorylation inhibitors, ATP disruptors, such as, for example, diafenthiuron; or organotin compounds, for example azocyclotin, cyhexatin, fenbutatin oxide; or propargite; tetradifon;

I13) oxidative phosphorylation decouplers acting by interrupting the H proton gradients, such as, for example, chlorfenapyr and DNOC;

I14) nicotinergic acetylcholine receptor antagonists, such as, for example, bensultap, cartap (-hydrochloride), thiocyclam, and thiosultap (-sodium);

I15) chitin biosynthesis inhibitors, type 0, such as, for example, benzoylureas, for example bistrifluoron, chlorfluazuron, diflubenzuron, flucycloxuron, flufenoxuron, hexaflumuron, lufenuron, novaluron, noviflumuron, teflubenzuron and triflumuron;

I16) chitin biosynthesis inhibitors, type 1, such as, for example, buprofezin;

I17) moulting disruptors such as, for example, cyromazine;

I18) ecdysone agonists/disruptors, such as, for example, diacylhydrazines, for example chromafenozide, halofenozide, methoxyfenozide and tebufenozide;

I19) octopaminergic agonists, such as, for example, amitraz;

I20) complex-III electron transport inhibitors, such as, for example, hydramethylnone; acequinocyl; fluacrypyrim;

I21) complex-1 electron transport inhibitors, for example from the group of the METI acaricides, for example fenazaquin, fenpyroximate, pyrimidifen, pyridaben, tebufenpyrad, tolfenpyrad; or rotenone (Derris);

I22) voltage-gated sodium channel blockers, for example indoxacarb; metaflumizone;

I23) inhibitors of acetyl-CoA carboxylase, such as, for example, tetronic acid derivatives, for example spirodiclofen and spiromesifen; or tetramic acid derivatives, for example spirotetramat;

I24) complex-IV electron transport inhibitors, such as, for example, phosphines, for example aluminum phosphide, calcium phosphide, phosphine, zinc phosphide; or cyanide;

I25) complex-II electron transport inhibitors, such as, for example, cyenopyrafen;

I26) ryanodine receptor effectors, such as, for example, diamides, for example flubendiamide, chlorantraniliprole (Rynaxypyr), cyantraniliprole (Cyazypyr) and also 3-bromo-N-{2-bromo-4-chloro-6-[(1-cyclopropylethyl)carbamoyl]phenyl}-1-(3-chloropyridin-2-yl)-1H-pyrazole-5-carboxamide (known from WO2005/077934) or methyl 2-[3,5-dibromo-2-({[3-bromo-1-(3-chloropyridin-2-yl)-1H-pyrazol-5-yl]carbonyl}amino)benzoyl]-1,2-dimethylhydrazinecarboxylate (known from WO2007/043677).

Further active compounds having an unknown mechanism of action, such as, for example, azadirachtin, amidoflumet, benzoximate, bifenazate, chinomethionat, cryolite, cyflumetofen, dicofol, 5-chloro-2-[(3,4,4-trifluorobut-3-en-1-yl)sulfonyl]-1,3-thiazole, flufenerim, pyridalyl and pyrifluquinazon; furthermore preparations based on Bacillus firmus (1-1582, BioNeem, Votivo) and the following known active compounds 4-{[(6-bromopyrid-3-yl)methyl](2-fluoroethyl)amino}furan-2(5H)-one (known from WO 2007/115644), 4-{[(6-fluoropyrid-3-yl)methyl](2,2-difluoroethyl)amino}furan-2(5H)-one (known from WO 2007/115644), 4-{[(2-chloro-1,3-thiazol-5-yl)methyl](2-fluoroethyl)amino}furan-2(5H)-one (known from WO 2007/115644), 4-{[(6-chloropyrid-3-yl)methyl](2-fluoroethyl)amino}furan-2(5H)-one (known from WO 2007/115644), 4-{[(6-chloropyrid-3-yl)methyl](2,2-difluoroethyl)amino}furan-2(5H)-one (known from WO 2007/115644), 4-{[(6-chloro-5-fluoropyrid-3-yl)methyl](methyl)amino}furan-2(5H)-one (known from WO 2007/115643), 4-{[(5,6-dichloropyrid-3-yl)methyl](2-fluoroethyl)amino}furan-2(5H)-one (known from WO 2007/115646), 4-{[(6-chloro-5-fluoropyrid-3-yl)methyl](cyclopropyl)amino}furan-2(5H)-one (known from WO 2007/115643), 4-{[(6-chloropyrid-3-yl)methyl](cyclopropyl)amino}furan-2(5H)-one (known from EP0539588), 4-{[(6-chloropyrid-3-yl)methyl](methyl)amino}furan-2(5H)-one (known from EP0539588), [1-(6-chloropyridin-3-yl)ethyl](methyl)oxido-λ⁴-sulfanylidenecyanamide (known from WO 2007/149134) and its diastereomers {[(1R)-1-(6-chloropyridin-3-yl)ethyl](methyl)oxido-lambda⁶-sulfanylidene}cyanamide and {[(1S)-1-(6-chloropyridin-3-yl)ethyl](methyl)oxido-lambda⁶-sulfanylidene}cyanamide (likewise known from WO 2007/149134) and sulfoxaflor (likewise known from WO 2007/149134), 1-[2-fluoro-4-methyl-5-[(2,2,2-trifluoroethyl)sulfinyl]phenyl]-3-(trifluoromethyl)-1H-1,2,4-triazole-5-amine (known from WO 2006/043635), [(3S,4aR,12R,12aS,12bS)-3-[(cyclopropylcarbonyl)oxy]-6,12-dihydroxy-4,12b-dimethyl-11-oxo-9-(pyridin-3-yl)-1,3,4,4a,5,6,6a,12,12a,12b-decahydro-2H,11H-benzo[f]pyrano[4,3-b]chromen-4-yl]methylcyclopropanecarboxylate (known from WO 2006/129714), 2-cyano-3-(difluoromethoxy)-N,N-dimethylbenzenesulfonamide (known from WO2006/056433), 2-cyano-3-(difluoromethoxy)-N-methylbenzenesulfonamide (known from WO2006/100288), 2-cyano-3-(difluoromethoxy)-N-ethylbenzenesulfonamide (known from WO2005/035486), 4-(difluoromethoxy)-N-ethyl-N-methyl-1,2-benzothiazole-3-amine 1,1-dioxide (known from WO2007/057407), N-[1-(2,3-dimethylphenyl)-2-(3,5-dimethylphenyl)ethyl]-4,5-dihydro-1,3-thiazole-2-amine (known from WO2008/104503), {1′-[(2E)-3-(4-chlorophenyl)prop-2-en-1-yl]-5-fluorospiro[indol-3,4′-piperidin]-[(2H)-yl}(2-chloropyridin-4-yl)methanone (known from WO2003/106457), 3-(2,5-dimethylphenyl)-4-hydroxy-8-methoxy-1,8-diazaspiro[4.5]dec-3-en-2-one (known from WO2009/049851), 3-(2,5-dimethylphenyl)-8-methoxy-2-oxo-1,8-diazaspiro[4.5]dec-3-en-4-yl ethyl carbonate (known from WO2009/049851), 4-(but-2-yn-1-yloxy)-6-(3,5-dimethylpiperidin-1-yl)-5-fluoropyrimidine (known from WO2004/099160), (2,2,3,3,4,4,5,5-octafluoropentyl)(3,3,3-trifluoropropyl)malononitrile (known from WO2005/063094), (2,2,3,3,4,4,5,5-octafluoropentyl)(3,3,4,4,4-pentafluorobutyl)malononitrile (known from WO2005/063094), 8-[2-(cyclopropylmethoxy)-4-(trifluoromethyl)phenoxy]-3-[6-(trifluoromethyl)pyridazin-3-yl]-3-azabicyclo[3.2.1]octane (known from WO2007/040280282), 2-ethyl-7-methoxy-3-methyl-6-[(2,2,3,3-tetrafluoro-2,3-dihydro-1,4-benzodioxin-6-yl)oxy]quinolin-4-yl methyl carbonate (known from JP2008110953), 2-ethyl-7-methoxy-3-methyl-6-[(2,2,3,3-tetrafluoro-2,3-dihydro-1,4-benzodioxin-6-yl)oxy]quinolin-4-yl acetate (known from JP2008110953), PF1364 (Chemical Abstracts No 1204776-60-2, known from JP2010018586), 5-[5-(3,5-dichlorophenyl)-5-(trifluoromethyl)-4,5-dihydro-1,2-oxazol-3-yl]-2-(1H-1,2,4-triazol-1-yl)benzonitrile (known from WO2007/075459), 5-[5-(2-chloropyridin-4-yl)-5-(trifluoromethyl)-4,5-dihydro-1,2-oxazol-3-yl]-2-(1H-1,2,4-triazol-1-yl)benzonitrile (known from WO2007/075459), 4-[5-(3,5-dichlorophenyl)-5-(trifluoromethyl)-4,5-dihydro-1,2-oxazol-3-yl]-2-methyl-N-{2-oxo-2-[(2,2,2-trifluoroethyl)amino]ethyl}benzamide (known from WO2005/085216).

Safeners are preferably selected from the group consisting of:

S1) compounds of the formula (S1),

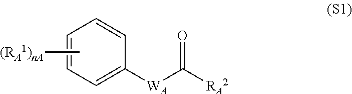

where the symbols and indices have the following meanings:

n_{A} is a natural number from 0 to 5, preferably 0 to 3;

R_{A}¹ is halogen, (C₁-C₄)alkyl, (C₁-C₄)alkoxy, nitro or (C₁-C₄)haloalkyl;

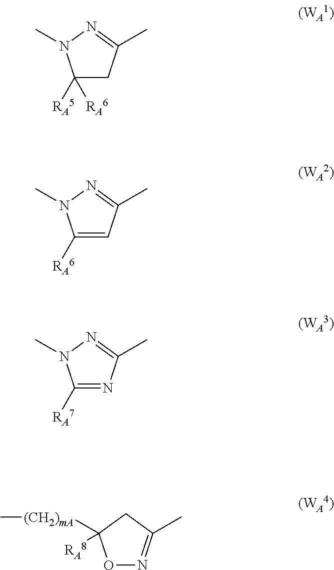

W_{A} is an unsubstituted or substituted divalent heterocyclic radical from the group of the partially unsaturated or aromatic five-membered heterocycles having 1 to 3 ring heteroatoms from the group consisting of N and O, where at least one nitrogen atom and at most one oxygen atom is present in the ring, preferably a radical from the group consisting of (W_{A}¹) to (W_{A}⁴),

m_{A} is 0 or 1;

R_{A}² is OR_{A}³, SR_{A}³ or NR_{A}³R_{A}⁴ or a saturated or unsaturated 3- to 7-membered heterocycle having at least one nitrogen atom and up to 3 heteroatoms, preferably from the group consisting of O and S, which is joined to the carbonyl group in (S1) via the nitrogen atom and is unsubstituted or substituted by radicals from the group consisting of (C₁-C₄)alkyl, (C₁-C₄)alkoxy or optionally substituted phenyl, preferably a radical of the formula OR_{A}³, NHR_{A}⁴ or N(CH₃)₂, especially of the formula OR_{A}³;

R_{A}³ is hydrogen or an unsubstituted or substituted aliphatic hydrocarbon radical, preferably having a total of 1 to 18 carbon atoms;

R_{A}⁴ is hydrogen, (C₁-C₆)alkyl, (C₁-C₆)alkoxy or substituted or unsubstituted phenyl;

R_{A}⁵ is H, (C₁-C₈)alkyl, (C₁-C₈)haloalkyl, (C₁-C₄)alkoxy(C₁-C₈)alkyl, cyano or COOR_{A}⁹ in which R_{A}⁹ is hydrogen, (C₁-C₈)alkyl, (C₁-C₈)haloalkyl, (C₁-C₄)alkoxy(C₁-C₄)alkyl, (C₁-C₆)hydroxyalkyl, (C₃-C₁₂)cycloalkyl or tri(C₁-C₄)alkylsilyl;

R_{A}⁶, R_{A}⁷, R_{A}⁸ are the same or different and are each hydrogen, (C₁-C₈)alkyl, (C₁-C₈)haloalkyl, (C₃-C₁₂)cycloalkyl or substituted or unsubstituted phenyl;

preferably:

a) compounds of the dichlorophenylpyrazoline-3-carboxylic acid (S1^{a}) type, preferably compounds such as 1-(2,4-dichlorophenyl)-5-(ethoxycarbonyl)-5-methyl-2-pyrazoline-3-carboxylic acid, ethyl 1-(2,4-dichlorophenyl)-5-(ethoxycarbonyl)-5-methyl-2-pyrazoline-3-carboxylate (S1-1) (“mefenpyr-diethyl”), and related compounds as described in WO-A-91/07874;

b) derivatives of dichlorophenylpyrazolecarboxylic acid (S1^{b}), preferably compounds such as ethyl 1-(2,4-dichlorophenyl)-5-methylpyrazole-3-carboxylate (S1-2), ethyl 1-(2,4-dichlorophenyl)-5-isopropylpyrazole-3-carboxylate (S1-3), ethyl 1-(2,4-dichlorophenyl)-5-(1,1-dimethylethyl)pyrazole-3-carboxylate (S1-4) and related compounds as described in EP-A-333 131 and EP-A-269 806;

c) derivatives of dichlorophenylpyrazolecarboxylic acid (S1^{c}), preferably compounds such as ethyl 1-(2,4-dichlorophenyl)-5-phenylpyrazole-3-carboxylate (S1-5), ethyl 1-(2-chlorophenyl)-5-phenylpyrazole-3-carboxylate (S1-6) and related compounds as described in EP-A-268 554, for example;

d) compounds of the triazolecarboxylic acid type (S1^{d}), preferably compounds such as fenchlorazole(-ethyl ester), i.e. ethyl 1-(2,4-dichlorophenyl)-5-trichloromethyl-(1H)-1,2,4-triazole-3-carboxylate (S1-7), and related compounds as described in EP-A-174 562 and EP-A-346 620;

e) compounds of the 5-benzyl- or 5-phenyl-2-isoxazoline-3-carboxylic acid or of the 5,5-diphenyl-2-isoxazoline-3-carboxylic acid type (S1^{e}), preferably compounds such as ethyl 5-(2,4-dichlorobenzyl)-2-isoxazoline-3-carboxylate (S1-8) or ethyl 5-phenyl-2-isoxazoline-3-carboxylate (S1-9) and related compounds as described in WO-A-91/08202, or 5,5-diphenyl-2-isoxazoline-3-carboxylic acid (S1-10) or ethyl 5,5-diphenyl-2-isoxazoline-3-carboxylate (S1-11) (“isoxadifen-ethyl”) or n-propyl 5,5-diphenyl-2-isoxazoline-3-carboxylate (S1-12) or ethyl 5-(4-fluorophenyl)-5-phenyl-2-isoxazoline-3-carboxylate (S1-13), as described in patent application WO-A-95/07897.

S2) Quinoline derivatives of the formula (S2)

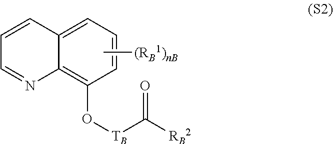

where the symbols and indices have the following meanings:

R_{B}¹ is halogen, (C₁-C₄)alkyl, (C₁-C₄)alkoxy, nitro or (C₁-C₄)haloalkyl;

n_{B} is a natural number from 0 to 5, preferably 0 to 3;

R_{B}² is OR_{B}³, SR_{B}³ or NR_{B}³R_{B}⁴ or a saturated or unsaturated 3- to 7-membered heterocycle having at least one nitrogen atom and up to 3 heteroatoms, preferably from the group consisting of O and S, which is joined to the carbonyl group in (S2) via the nitrogen atom and is unsubstituted or substituted by radicals from the group consisting of (C₁-C₄)alkyl, (C₁-C₄)alkoxy or optionally substituted phenyl, preferably a radical of the formula OR_{B}³, NHR_{B}⁴ or N(CH₃)₂, especially of the formula OR_{B}³;

R_{A}³ is hydrogen or an unsubstituted or substituted aliphatic hydrocarbon radical, preferably having a total of 1 to 18 carbon atoms;

R_{B}⁴ is hydrogen, (C₁-C₆)alkyl, (C₁-C₆)alkoxy or substituted or unsubstituted phenyl;

T_{B} is a (C₁ or C₂)alkanediyl chain which is unsubstituted or substituted by one or two (C₁-C₄)alkyl radicals or by [(C₁-C₃)alkoxy]carbonyl;

preferably:

a) compounds of the 8-quinolinoxyacetic acid type (S2^{a}), preferably 1-methylhexyl (5-chloro-8-quinolinoxy)acetate (“cloquintocet-mexyl”) (S2-1), 1,3-dimethylbut-1-yl (5-chloro-8-quinolinoxy)acetate (S2-2), 4-allyloxybutyl (5-chloro-8-quinolinoxy)acetate (S2-3), 1-allyloxyprop-2-yl (5-chloro-8-quinolinoxy)acetate (S2-4), ethyl (5-chloro-8-quinolinoxy)acetate (S2-5), methyl (5-chloro-8-quinolinoxy)acetate (S2-6), allyl (5-chloro-8-quinolinoxy)acetate (S2-7), 2-(2-propylideneiminoxy)-1-ethyl (5-chloro-8-quinolinoxy)acetate (S2-8), 2-oxoprop-1-yl (5-chloro-8-quinolinoxy)acetate (S2-9) and related compounds, as described in EP-A-86 750, EP-A-94 349 and EP-A-191 736 or EP-A-0 492 366, and also (5-chloro-8-quinolinoxy)acetic acid (S2-10), hydrates and salts thereof, for example the lithium, sodium, potassium, calcium, magnesium, aluminum, iron, ammonium, quaternary ammonium, sulfonium or phosphonium salts thereof, as described in WO-A-2002/34048;

b) compounds of the (5-chloro-8-quinolinoxy)malonic acid type (S2^{b}), preferably compounds such as diethyl (5-chloro-8-quinolinoxy)malonate, diallyl (5-chloro-8-quinolinoxy)malonate, methyl ethyl (5-chloro-8-quinolinoxy)malonate and related compounds, as described in EP-A-0 582 198.

S3) Compounds of the formula (S3)

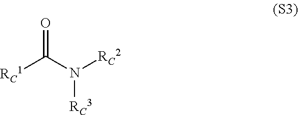

where the symbols and indices have the following meanings:

R_{C}¹ is (C₁-C₄)alkyl, (C₁-C₄)haloalkyl, (C₂-C₄)alkenyl, (C₂-C₄)haloalkenyl, (C₃-C₇)cycloalkyl, preferably dichloromethyl;

R_{C}², R_{C}³ are the same or different and are each hydrogen, (C₁-C₄)alkyl, (C₂-C₄)alkenyl, (C₂-C₄)alkynyl, (C₁-C₄)haloalkyl, (C₂-C₄)haloalkenyl, (C₁-C₄)alkylcarbamoyl(C₁-C₄)alkyl, (C₂-C₄)alkenylcarbamoyl(C₁-C₄)alkyl, (C₁-C₄)alkoxy(C₁-C₄)alkyl, dioxolanyl(C₁-C₄)alkyl, thiazolyl, furyl, furylalkyl, thienyl, piperidyl, substituted or unsubstituted phenyl, or R_{C}² and R_{C}³ together form a substituted or unsubstituted heterocyclic ring, preferably an oxazolidine, thiazolidine, piperidine, morpholine, hexahydropyrimidine or benzoxazine ring; preferably: active compounds of the dichloroacetamide type, which are frequently used as pre-emergence safeners (soil-acting safeners), for example “dichlormid” (N,N-diallyl-2,2-dichloroacetamide) (S3-1), “R-29148” (3-dichloroacetyl-2,2,5-trimethyl-1,3-oxazolidine) from Stauffer (S3-2), “R-28725” (3-dichloroacetyl-2,2-dimethyl-1,3-oxazolidine) from Stauffer (S3-3), “benoxacor” (4-dichloroacetyl-3,4-dihydro-3-methyl-2H-1,4-benzoxazine) (S3-4), “PPG-1292” (N-allyl-N-[(1,3-dioxolan-2-yl)methyl]dichloroacetamide) from PPG Industries (S3-5), “DKA-24” (N-allyl-N-[(allylaminocarbonyl)methyl]dichloroacetamide) from Sagro-Chem (S3-6), “AD-67” or “MON 4660” (3-dichloroacetyl-1-oxa-3-azaspiro[4,5]decane) from Nitrokemia or Monsanto (S3-7), “TI-35” (1-dichloroacetylazepane) from TRI-Chemical RT (S3-8), “diclonon” (dicyclonone) or “BAS145138” or “LAB145138” (S3-9) ((RS)-1-dichloroacetyl-3,3,8a-trimethylperhydropyrrolo[1,2-a]pyrimidin-6-one) from BASF, “furilazole” or “MON 13900” ((RS)-3-dichloroacetyl-5-(2-furyl)-2,2-dimethyloxazolidine) (S3-10); and the (R) isomer thereof (S3-11).

S4) N-Acylsulfonamides of the formula (S4) and salts thereof,

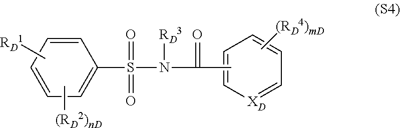

where the symbols and indices have the following meanings:

X_{D} is CH or N;

R_{D}¹ is CO—NR_{D}⁵R_{D}⁶ or NHCO—R_{D}⁷;

R_{D}² is halogen, (C₁-C₄)haloalkyl, (C₁-C₄)haloalkoxy, nitro, (C₁-C₄)alkyl, (C₁-C₄)alkoxy, (C₁-C₄)alkylsulfonyl, (C₁-C₄)alkoxycarbonyl or (C₁-C₄)alkylcarbonyl;

R_{D}³ is hydrogen, (C₁-C₄)alkyl, (C₂-C₄)alkenyl or (C₂-C₄)alkynyl;

R_{D}⁴ is halogen, nitro, (C₁-C₄)alkyl, (C₁-C₄)haloalkyl, (C₁-C₄)haloalkoxy, (C₃-C₆)cycloalkyl, phenyl, (C₁-C₄)alkoxy, cyano, (C₁-C₄)alkylthio, (C₁-C₄)alkylsulfinyl, (C₁-C₄)alkylsulfonyl, (C₁-C₄)alkoxycarbonyl or (C₁-C₄)alkylcarbonyl;

R_{D}⁵ is hydrogen, (C₁-C₆)alkyl, (C₃-C₆)cycloalkyl, (C₂-C₆)alkenyl, (C₂-C₆)alkynyl, (C₅-C₆)cycloalkenyl, phenyl or 3- to 6-membered heterocyclyl containing v_{D} heteroatoms from the group consisting of nitrogen, oxygen and sulfur, where the seven latter radicals are substituted by v_{D} substituents from the group consisting of halogen, (C₁-C₆)alkoxy, (C₁-C₆)haloalkoxy, (C₁-C₂)alkylsulfinyl, (C₁-C₂)alkylsulfonyl, (C₃-C₆)cycloalkyl, (C₁-C₄)alkoxycarbonyl, (C₁-C₄)alkylcarbonyl and phenyl and, in the case of cyclic radicals, also (C₁-C₄)alkyl and (C₁-C₄)haloalkyl;

R_{D}⁶ is hydrogen, (C₁-C₆)alkyl, (C₂-C₆)alkenyl or (C₂-C₆)alkynyl, where the three latter radicals are substituted by v_{D} radicals from the group consisting of halogen, hydroxy, (C₁-C₄)alkyl, (C₁-C₄)alkoxy and (C₁-C₄)alkylthio, or

R_{D}⁵ and R_{D}⁶, together with the nitrogen atom bearing them, form a pyrrolidinyl or piperidinyl radical;

R_{D}⁷ is hydrogen, (C₁-C₄)alkylamino, di-(C₁-C₄)alkylamino, (C₁-C₆)alkyl, (C₃-C₆)cycloalkyl, where the 2 latter radicals are substituted by v_{D} substituents from the group consisting of halogen, (C₁-C₄)alkoxy, (C₁-C₆)haloalkoxy and (C₁-C₄)alkylthio and, in the case of cyclic radicals, also (C₁-C₄)alkyl and (C₁-C₄)haloalkyl;

n_{D} is 0, 1 or 2;

m_{D} is 1 or 2;

v_{D} is 0, 1, 2 or 3;

among these, preference is given to compounds of the N-acylsulfonamide type, for example of the formula (S4^{a}) below, which are known, for example, from WO-A-97/45016

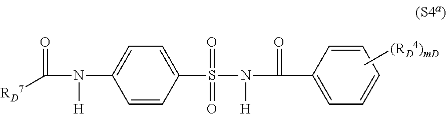

in which

R_{D}⁷ is (C₁-C₆)alkyl, (C₃-C₆)cycloalkyl, where the 2 latter radicals are substituted by v_{D} substituents from the group consisting of halogen, (C₁-C₄)alkoxy, (C₁-C₆)haloalkoxy and (C₁-C₄)alkylthio and, in the case of cyclic radicals, also (C₁-C₄)alkyl and (C₁-C₄)haloalkyl;

R_{D}⁴ is halogen, (C₁-C₄)alkyl, (C₁-C₄)alkoxy, CF₃;

m_{D} is 1 or 2;

v_{D} is 0, 1, 2 or 3;

and also to acylsulfamoylbenzamides, for example of the formula (S4^{b}) below, which are known, for example, from WO-A-99/16744,

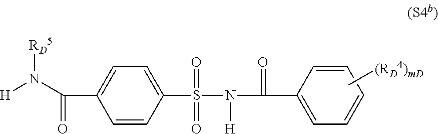

for example those in which

R_{D}⁵=cyclopropyl and (R_{D}⁴)=2-OMe (“cyprosulfamide”, S4-1),

R_{D}⁵=cyclopropyl and (R_{D}⁴)=5-Cl-2-OMe (S4-2),

R_{D}⁵=ethyl and (R_{D}⁴)=2-OMe (S4-3),

R_{D}⁵=isopropyl and (R_{D}⁴)=5-Cl-2-OMe (S4-4) and

R_{D}⁵=isopropyl and (R_{D}⁴)=2-OMe (S4-5)

and to compounds of the N-acylsulfamoylphenylurea type, of the formula (S4^{c}), which are known, for example, from EP-A-365484,

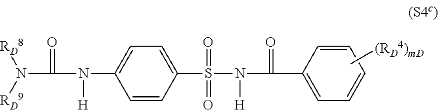

in which

R_{D}⁸ and R_{D}⁹ are each independently of one another hydrogen, (C₁-C₈)alkyl, (C₃-C₈)cycloalkyl, (C₃-C₆)alkenyl, (C₃-C₆)alkynyl,

R_{D}⁴ is halogen, (C₁-C₄)alkyl, (C₁-C₄)alkoxy, CF₃;

m_{D} is 1 or 2;

for example

1-[4-(N-2-methoxybenzoylsulfamoyl)phenyl]-3-methylurea, 1-[4-(N-2-methoxybenzoylsulfamoyl)phenyl]-3,3-dimethylurea, 1-[4-(N-4,5-dimethylbenzoylsulfamoyl)phenyl]-3-methylurea.

S5) Active compounds from the class of the hydroxyaromatics and aromatic-aliphatic carboxylic acid derivatives (S5), for example ethyl 3,4,5-triacetoxybenzoate, 3,5-dimethoxy-4-hydroxybenzoic acid, 3,5-dihydroxybenzoic acid, 4-hydroxysalicylic acid, 4-fluorosalicyclic acid, 2-hydroxycinnamic acid, 2,4-dichlorocinnamic acid, as described in WO-A-2004/084631, WO-A-2005/015994, WO-A-2005/016001.

S6) Active compounds from the class of the 1,2-dihydroquinoxalin-2-ones (S6), for example 1-methyl-3-(2-thienyl)-1,2-dihydroquinoxalin-2-one, 1-methyl-3-(2-thienyl)-1,2-dihydroquinoxaline-2-thione, 1-(2-aminoethyl)-3-(2-thienyl)-1,2-dihydroquinoxalin-2-one hydrochloride, 1-(2-methylsulfonylaminoethyl)-3-(2-thienyl)-1,2-dihydroquinoxalin-2-one, as described in WO-A-2005/112630.

S7) Compounds of the formula (S7), as described in WO-A-1998/38856,

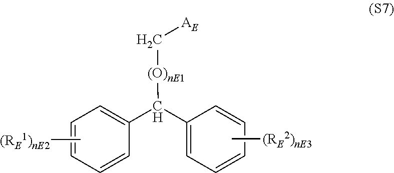

where the symbols and indices have the following meanings:

R_{E}¹, R_{E}² are each independently of one another halogen, (C₁-C₄)alkyl, (C₁-C₄)alkoxy, (C₁-C₄)haloalkyl, (C₁-C₄)alkylamino, di(C₁-C₄)alkylamino, nitro;

A_{E} is COOR_{E}³ or COSR_{E}⁴

R_{E}³, R_{E}⁴ are each independently of one another hydrogen, (C₁-C₄)alkyl, (C₂-C₆)alkenyl, (C₂-C₄)alkynyl, cyanoalkyl, (C₁-C₄)haloalkyl, phenyl, nitrophenyl, benzyl, halobenzyl, pyridinylalkyl and alkylammonium,

n_{E}¹ is 0 or 1

n_{E}², n_{E}³ are each independently of one another 0, 1 or 2,

preferably diphenylmethoxyacetic acid, ethyl diphenylmethoxyacetate, methyl diphenylmethoxyacetate (CAS reg. no. 41858-19-9) (S7-1).

S8) Compounds of the formula (S8), as described in WO-A-98/27049,

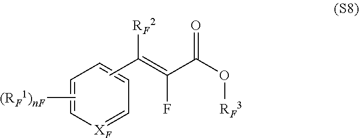

in which

X_{F} is CH or N,

n_{F} in the case that X_{F}=N is an integer from 0 to 4 and
in the case that X_{F}=CH is an integer from 0 to 5,

R_{F}¹ is halogen, (C₁-C₄)alkyl, (C₁-C₄)haloalkyl, (C₁-C₄)alkoxy, (C₁-C₄)haloalkoxy, nitro, (C₁-C₄)alkylthio, (C₁-C₄)alkylsulfonyl, (C₁-C₄)alkoxycarbonyl, optionally substituted phenyl, optionally substituted phenoxy,

R_{F}² is hydrogen or (C₁-C₄)alkyl

R_{F}³ is hydrogen, (C₁-C₈)alkyl, (C₂-C₄)alkenyl, (C₂-C₄)alkynyl, or aryl, where each of the aforementioned carbon-containing radicals is unsubstituted or substituted by one or more, preferably up to three identical or different radicals from the group consisting of halogen and alkoxy; or salts thereof,

preferably compounds in which

X_{F} is CH,

n_{F} is an integer from 0 to 2,

R_{F}¹ is halogen, (C₁-C₄)alkyl, (C₁-C₄)haloalkyl, (C₁-C₄)alkoxy, (C₁-C₄)haloalkoxy,

R_{F}² is hydrogen or (C₁-C₄)alkyl

R_{F}³ is hydrogen, (C₁-C₈)alkyl, (C₂-C₄)alkenyl, (C₂-C₄)alkynyl, or aryl, where each of the aforementioned carbon-containing radicals is unsubstituted or substituted by one or more, preferably up to three identical or different radicals from the group consisting of halogen and alkoxy; or salts thereof,

S9) Active compounds from the class of the 3-(5-tetrazolylcarbonyl)-2-quinolones (S9), e.g. 1,2-dihydro-4-hydroxy-1-ethyl-3-(5-tetrazolylcarbonyl)-2-quinolone (CAS reg. no. 219479-18-2), 1,2-dihydro-4-hydroxy-1-methyl-3-(5-tetrazolylcarbonyl)-2-quinolone (CAS reg. no. 95855-00-8), as described in WO-A-1999/000020.

S10) Compounds of the formulae (S10^{a}) or (S10^{b}),

as described in WO-A-2007/023719 and WO-A-2007/023764

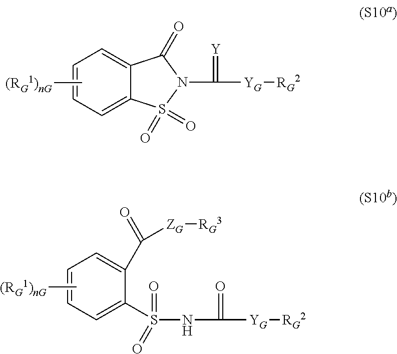

in which

R_{G}¹ is halogen, (C₁-C₄)alkyl, methoxy, nitro, cyano, CF₃, OCF₃

Y_{G}, Z_{G} are each independently of one another O or S,

n_{G} is an integer from 0 to 4,

R_{G}² is (C₁-C₁₆)alkyl, (C₂-C₆)alkenyl, (C₃-C₆)cycloalkyl, aryl; benzyl, halobenzyl,

R_{G}³ is hydrogen or (C₁-C₆)alkyl.

S11) Active compounds of the oxyimino compounds type (S11), which are known as seed-dressing compositions, for example “oxabetrinil” ((Z)-1,3-dioxolan-2-yl-methoxyimino(phenyl)acetonitrile) (S11-1), which is known as a seed-dressing safener for millet/sorghum, against damage by metolachlor, “fluxofenim” (1(4-chlorophenyl)-2,2,2-trifluoro-1-ethanone O-(1,3-dioxolan-2-ylmethyl)oxime) (S11-2), which is known as a seed-dressing safener for millet/sorghum against damage by metolachlor, and “cyometrinil” or “CGA-43089” ((Z)-cyanomethoxyimino(phenyl)acetonitrile) (S11-3), which is known as a seed-dressing safener for millet/sorghum against damage by metolachlor.

S12) Active compounds from the class of the isothiochromanones (S12), for example methyl [(3-oxo-1H-2-benzothiopyran-4(3H)-ylidene)methoxy]acetate (CAS reg. no. 205121-04-6) (S12-1) and related compounds from WO-A-1998/13361.

S13) One or more compounds from group (S13): “naphthalic anhydride” (1,8-naphthalenedicarboxylic anhydride) (S13-1), which is known as a seed-dressing safener for corn against damage by thiocarbamate herbicides, “fenclorim” (4,6-dichloro-2-phenylpyrimidine) (S13-2), which is known as a safener for pretilachlor in sown rice, “flurazole” (benzyl 2-chloro-4-trifluoromethyl-1,3-thiazole-5-carboxylate) (S13-3), which is known as a seed-dressing safener for millet/sorghum against damage by alachlor and metolachlor, “CL 304415” (CAS reg. no. 31541-57-8) (4-carboxy-3,4-dihydro-2H-1-benzopyran-4-acetic acid) (S13-4) from American Cyanamid, which is known as a safener for corn against damage by imidazolinones, “MG 191” (CAS reg. no. 96420-72-3) (2-dichloromethyl-2-methyl-1,3-dioxolane) (S13-5) from Nitrokemia, which is known as a safener for corn, “MG-838” (CAS reg. no. 133993-74-5) (2-propenyl 1-oxa-4-azaspiro[4.5]decane-4-carbodithioate) (S13-6) from Nitrokemia, “disulfoton” (O,O-diethyl S-2-ethylthioethyl phosphorodithioate) (S13-7), “dietholate” (O,O-diethyl O-phenylphosphorothioate) (S13-8), “mephenate” (4-chlorophenyl methylcarbamate) (S13-9).

S14) Active compounds which, in addition to herbicidal action against harmful plants, also have safener action on crop plants such as rice, for example “dimepiperate” or “MY-93” (S-1-methyl-1-phenylethylpiperidine-1-carbothioate), which is known as a safener for rice against damage by the herbicide molinate, “daimuron” or “SK 23” (1-(1-methyl-1-phenylethyl)-3-p-tolylurea), which is known as a safener for rice against damage by the herbicide imazosulfuron, “cumyluron”=“JC-940” (3-(2-chlorophenylmethyl)-1-(1-methyl-1-phenylethypurea, see JP-A-60087254), which is known as a safener for rice against damage by some herbicides, “methoxyphenone” or “NK 049” (3,3′-dimethyl-4-methoxybenzophenone), which is known as a safener for rice against damage by some herbicides, “CSB” (1-bromo-4-(chloromethylsulfonyl)benzene) from Kumiai, (CAS reg. no. 54091-06-4), which is known as a safener against damage by some herbicides in rice.

S15) Compounds of the formula (S15) or tautomers thereof,
as described in WO-A-2008/131861 and WO-A-2008/131860,

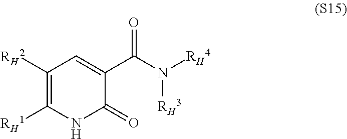

in which

R_{H}¹ is a (C₁-C₆)haloalkyl radical and

R_{H}² is hydrogen or halogen and

R_{H}³, R_{H}⁴ are each independently of one another hydrogen, (C₁-C₁₆)alkyl, (C₂-C₁₆)alkenyl or (C₂-C₁₆)alkynyl, where each of the latter 3 radicals is unsubstituted or substituted by one or more radicals from the group consisting of halogen, hydroxy, cyano, (C₁-C₄)alkoxy, (C₁-C₄)haloalkoxy, (C₁-C₄)alkylthio, (C₁-C₄)alkylamino, di[(C₁-C₄)alkyl]amino, [(C₁-C₄)alkoxy]carbonyl, [(C₁-C₄)haloalkoxy]carbonyl, (C₃-C₆)cycloalkyl which is unsubstituted or substituted, phenyl which is unsubstituted or substituted, and heterocyclyl which is unsubstituted or substituted, or (C₃-C₆)cycloalkyl, (C₄-C₆)cycloalkenyl, (C₃-C₆)cycloalkyl which is fused on one side of the ring to a 4- to 6-membered saturated or unsaturated carbocyclic ring, or (C₄-C₆)cycloalkenyl which is fused on one side of the ring to a 4- to 6-membered saturated or unsaturated carbocyclic ring, where each of the latter 4 radicals is unsubstituted or substituted by one or more radicals from the group consisting of halogen, hydroxy, cyano, (C₁-C₄)alkyl, (C₁-C₄)haloalkyl, (C₁-C₄)alkoxy, (C₁-C₄)haloalkoxy, (C₁-C₄)alkylthio, (C₁-C₄)alkylamino, di[(C₁-C₄)alkyl]amino, [(C₁-C₄)alkoxy]carbonyl, [(C₁-C₄)haloalkoxy]carbonyl, (C₃-C₆)cycloalkyl which is unsubstituted or substituted, phenyl which is unsubstituted or substituted, and heterocyclyl which is unsubstituted or substituted, or

R_{H}³ is (C₁-C₄)alkoxy, (C₂-C₄)alkenyloxy, (C₂-C₆)alkynyloxy or (C₂-C₄)haloalkoxy and

R_{H}⁴ is hydrogen or (C₁-C₄)alkyl or

R_{H}³ and R_{H}⁴ together with the directly bonded nitrogen atom form a four- to eight-membered heterocyclic ring which, in addition to the nitrogen atom, may also contain further ring heteroatoms, preferably up to two further ring heteroatoms from the group consisting of N, O and S, and which is unsubstituted or substituted by one or more radicals from the group consisting of halogen, cyano, nitro, (C₁-C₄)alkyl, (C₁-C₄)haloalkyl, (C₁-C₄)alkoxy, (C₁-C₄)haloalkoxy and (C₁-C₄)alkylthio.

S16) Active compounds which are used primarily as herbicides but also have safener action on crop plants, for example (2,4-dichlorophenoxy)acetic acid (2,4-D), (4-chlorophenoxy)acetic acid, (R,S)-2-(4-chloro-o-tolyloxy)propionic acid (mecoprop), 4-(2,4-dichlorophenoxy)butyric acid (2,4-DB), (4-chloro-o-tolyloxy)acetic acid (MCPA), 4-(4-chloro-o-tolyloxy)butyric acid, 4-(4-chlorophenoxy)butyric acid, 3,6-dichloro-2-methoxybenzoic acid (dicamba), 1-(ethoxycarbonyl)ethyl 3,6-dichloro-2-methoxybenzoate (lactidichlor-ethyl).

Substances which influence plant maturity:

Combination partners usable for the compounds of the formula (I) in mixture formulations or in tank mixes are, for example, known active compounds based on inhibition of, for example, 1-aminocyclopropane-1-carboxylate synthase, 1-aminocyclopropane-1-carboxylate oxidase and the ethylene receptors, for example ETR1, ETR2, ERS1, ERS2 or EIN4, as described, for example, in Biotechn. Adv. 2006, 24, 357-367; Bot. Bull. Acad. Sin. 199, 40, 1-7 or Plant Growth Reg. 1993, 13, 41-46 and literature cited therein.

Examples of known substances which influence plant maturity and can be combined with the compounds of the formula (I) include the active compounds which follow (the compounds are designated either by the “common name” according to the International Organization for Standardization (ISO) or by the chemical name or by the code number) and always encompass all use forms, such as acids, salts, esters and isomers, such as stereoisomers and optical isomers. Here, by way of example, one and in some cases a plurality of use forms are mentioned:

rhizobitoxine, 2-aminoethoxyvinylglycine (AVG), methoxyvinylglycine (MVG), vinylglycine, aminooxyacetic acid, sinefungin, S-adenosylhomocysteine, 2-keto-4-methyl thiobutyrate, 2-(methoxy)-2-oxoethyl (isopropylidene)aminooxyacetate, 2-(hexyloxy)-2-oxoethyl (isopropylidene)aminooxyacetate, 2-(isopropyloxy)-2-oxoethyl (cyclohexylidene)aminooxyacetate, putrescine, spermidine, spermine, 1,8-diamino-4-aminoethyloctane, L-canaline, daminozide, methyl 1-aminocyclopropyl-1-carboxylate, N-methyl-1-aminocyclopropyl-1-carboxylic acid, 1-aminocyclopropyl-1-carboxamide, substituted 1-aminocyclopropyl-1-carboxylic acid derivatives as described in DE3335514, EP30287, DE2906507 or U.S. Pat. No. 5,123,951, 1-aminocyclopropyl-1-hydroxamic acid, 1-methylcyclopropene, 3-methylcyclopropene, 1-ethylcyclopropene, 1-n-propylcyclopropene, 1-cyclopropenylmethanol, carvone, eugenol, sodium cycloprop-1-en-1-ylacetate, sodium cycloprop-2-en-1-ylacetate, sodium 3-(cycloprop-2-en-1-yl)propanoate, sodium 3-(cycloprop-1-en-1-yl)propanoate, jasmonic acid, methyl jasmonate, ethyl jasmonate.

Substances which moderate plant health and germination:

Known compounds moderating plant health (the compounds are designated either by the “common name” according to the International Organization for Standardization (ISO) or by the chemical name or by the code number and always encompass all use forms, such as acids, salts, esters and isomers, such as stereoisomers and optical isomers), for example, can be used as combination partners for the compounds of the formula (I) in mixture formulations or in tank mixes: sarcosine, phenylalanine, tryptophan, N′-methyl-1-phenyl-1-N,N-diethylaminomethanesulfonamide, apio-galacturonanes, as described in WO2010017956, 4-oxo-4-[(2-phenylethyl)amino]butanoic acid, 4-{[2-(1H-indol-3-yl)ethyl]amino}-4-oxobutanoic acid, 4-[(3-methylpyridin-2-yl)amino]-4-oxobutanoic acid, allantoin, 5-aminolevulinic acid, (2S,3R)-2-(3,4-dihydroxyphenyl)-3,4-dihydro-2H-chromene-3,5,7-triol and structurally related catechins as described in WO2010122956, 2-hydroxy-4-(methylsulfanyl)butanoic acid, (3E,3aR,8(3S)-3-({[(2R)-4-methyl-5-oxo-2,5-dihydrofuran-2-yl]oxy}methylene)-3,3α,4,8β-tetrahydro-2H-indeno[1,2-b]furan-2-one and analogous lactones as described in EP2248421, abscissic acid, (2Z,4E)-5-[(1R,6R)-6-ethynyl-1-hydroxy-2,6-dimethyl-4-oxocyclohex-2-en-1-yl]-3-methylpenta-2,4-dienoic acid, methyl (2Z,4E)-5-[(1R,6R)-6-ethynyl-1-hydroxy-2,6-dimethyl-4-oxocyclohex-2-en-1-yl]-3-methylpenta-2,4-dienoate, 4-phenylbutyric acid, sodium 4-phenylbutanoate, potassium 4-phenylbutanoate.

Herbicides or plant growth regulators:

Combination partners usable for the compounds of the formula (I) in mixture formulations or in tank mixes are, for example, known active compounds based on inhibition of, for example, acetolactate synthase, acetyl-CoA carboxylase, cellulose synthase, enolpyruvylshikimate-3-phosphate synthase, glutamine synthetase, p-hydroxyphenylpyruvate dioxygenase, phytoendesaturase, photosystem I, photosystem II, protoporphyrinogen oxidase, as described, for example, in Weed Research 26 (1986) 441-445 or “The Pesticide Manual”, 14th edition, The British Crop Protection Council and the Royal Soc. of Chemistry, 2006 and literature cited therein.

Examples of known herbicides or plant growth regulators which can be combined with compounds of the formula (I) include the active compounds which follow (the compounds are designated either by the “common name” according to the International Organization for Standardization (ISO) or by the chemical name or by the code number) and always encompass all use forms, such as acids, salts, esters and isomers, such as stereoisomers and optical isomers. Here, by way of example, one and in some cases a plurality of use forms are mentioned:

acetochlor, acibenzolar, acibenzolar-5-methyl, acifluorfen, acifluorfen-sodium, aclonifen, alachlor, allidochlor, alloxydim, alloxydim-sodium, ametryne, amicarbazone, amidochlor, amidosulfuron, aminocyclopyrachlor, aminopyralid, amitrole, ammonium sulfamate, ancymidol, anilofos, asulam, atrazine, azafenidin, azimsulfuron, aziprotryne, beflubutamid, benazolin, benazolin-ethyl, bencarbazone, benfluralin, benfuresate, bensulide, bensulfuron, bensulfuron-methyl, bentazone, benzfendizone, benzobicyclon, benzofenap, benzofluor, benzoylprop, bicyclopyrone, bifenox, bilanafos, bilanafos-sodium, bispyribac, bispyribac-sodium, bromacil, bromobutide, bromofenoxim, bromoxynil, bromuron, buminafos, busoxinone, butachlor, butafenacil, butamifos, butenachlor, butralin, butroxydim, butylate, cafenstrole, carbetamide, carfentrazone, carfentrazone-ethyl, chlomethoxyfen, chloramben, chlorazifop, chlorazifop-butyl, chlorbromuron, chlorbufam, chlorfenac, chlorfenac-sodium, chlorfenprop, chlorflurenol, chlorflurenol-methyl, chloridazon, chlorimuron, chlorimuron-ethyl, chlormequat-chloride, chlornitrofen, chlorophthalim, chlorthal-dimethyl, chlortoluron, chlorsulfuron, cinidon, cinidon-ethyl, cinmethylin, cinosulfuron, clethodim, clodinafop, clodinafop-propargyl, clofencet, clomazone, clomeprop, cloprop, clopyralid, cloransulam, cloransulam-methyl, cumyluron, cyanamide, cyanazine, cyclanilide, cycloate, cyclosulfamuron, cycloxydim, cycluron, cyhalofop, cyhalofop-butyl, cyperquat, cyprazine, cyprazole, 2,4-D, 2,4-DB, daimuron/dymron, dalapon, daminozide, dazomet, n-decanol, desmedipham, desmetryn, detosyl-pyrazolate (DTP), diallate, dicamba, dichlobenil, dichlorprop, dichlorprop-P, diclofop, diclofop-methyl, diclofop-P-methyl, diclosulam, diethatyl, diethatyl-ethyl, difenoxuron, difenzoquat, diflufenican, diflufenzopyr, diflufenzopyr-sodium, dimefuron, dikegulac-sodium, dimefuron, dimepiperate, dimethachlor, dimethametryn, dimethenamid, dimethenamid-P, dimethipin, dimetrasulfuron, dinitramine, dinoseb, dinoterb, diphenamid, dipropetryn, diquat, diquat-dibromide, dithiopyr, diuron, DNOC, eglinazine-ethyl, endothal, EPTC, esprocarb, ethalfluralin, ethametsulfuron, ethametsulfuron-methyl, ethephon, ethidimuron, ethiozin, ethofumesate, ethoxyfen, ethoxyfen-ethyl, ethoxysulfuron, etobenzanid, F-5331, i.e. N-[2-chloro-4-fluoro-5-[4-(3-fluoropropyl)-4,5-dihydro-5-oxo-1H-tetrazol-1-yl]phenyl]ethanesulfonamide, F-7967, i.e. 3-[7-chloro-5-fluoro-2-(trifluoromethyl)-1H-benzimidazol-4-yl]-1-methyl-6-(trifluoromethyl)pyrimidine-2,4(1H,3H)-dione, fenoprop, fenoxaprop, fenoxaprop-P, fenoxaprop-ethyl, fenoxaprop-P-ethyl, fenoxasulfone, fentrazamide, fenuron, flamprop, flamprop-M-isopropyl, flamprop-M-methyl, flazasulfuron, florasulam, fluazifop, fluazifop-P, fluazifop-butyl, fluazifop-P-butyl, fluazolate, flucarbazone, flucarbazone-sodium, flucetosulfuron, fluchloralin, flufenacet (thiafluamide), flufenpyr, flufenpyr-ethyl, flumetralin, flumetsulam,

flumiclorac, flumiclorac-pentyl, flumioxazin, flumipropyn, fluometuron, fluorodifen, fluoroglycofen, fluoroglycofen-ethyl, flupoxam, flupropacil, flupropanate, flupyrsulfuron, flupyrsulfuron-methyl-sodium, flurenol, flurenol-butyl, fluridone, fluorochloridone, fluoroxypyr, fluoroxypyr-meptyl, flurprimidol, flurtamone, fluthiacet, fluthiacet-methyl, fluthiamide, fomesafen, foramsulfuron, forchlorfenuron, fosamine, furyloxyfen, gibberellic acid, glufosinate, glufosinate-ammonium, glufosinate-P, glufosinate-P-ammonium, glufosinate-P-sodium, glyphosate, glyphosate-isopropylammonium, H-9201, i.e. 0-(2,4-dimethyl-6-nitrophenyl) O-ethyl isopropylphosphoramidothioate, halosafen, halosulfuron,

halosulfuron-methyl, haloxyfop, haloxyfop-P, haloxyfop-ethoxyethyl, haloxyfop-P-ethoxyethyl, haloxyfop-methyl, haloxyfop-P-methyl, hexazinone, HW-02, i.e. 1-(dimethoxyphosphoryl)ethyl (2,4-dichlorophenoxy)acetate, imazamethabenz, imazamethabenz-methyl, imazamox, imazamox-ammonium, imazapic, imazapyr, imazapyr-isopropylammonium, imazaquin, imazaquin-ammonium, imazethapyr, imazethapyr-ammonium, imazosulfuron, inabenfide, indanofan, indaziflam, indoleacetic acid (IAA), 4-indol-3-ylbutyric acid (IBA), iodosulfuron, iodosulfuron-methyl-sodium, ioxynil, ipfencarbazone, isocarbamid, isopropalin, isoproturon, isouron, isoxaben, isoxachlortole, isoxaflutole, isoxapyrifop, KUH-043, i.e. 3-({[5-(difluoromethyl)-1-methyl-3-(trifluoromethyl)-1H-pyrazol-4-yl]methyl}sulfonyl)-5,5-dimethyl-4,5-dihydro-1,2-oxazole, karbutilate, ketospiradox, lactofen, lenacil, linuron, maleic hydrazide, MCPA, MCPB, MCPB-methyl, -ethyl and -sodium, mecoprop, mecoprop-sodium, mecoprop-butotyl, mecoprop-P-butotyl, mecoprop-P-dimethylammonium, mecoprop-P-2-ethylhexyl, mecoprop-P-potassium, mefenacet, mefluidide, mepiquat-chloride, mesosulfuron, mesosulfuron-methyl, mesotrione, methabenzthiazuron, metam, metamifop, metamitron, metazachlor, metazasulfuron, methazole, methiopyrsulfuron, methiozolin, methoxyphenone, methyldymron, 1-methylcyclopropene, methyl isothiocyanate, metobenzuron, metobromuron, metolachlor, S-metolachlor, metosulam, metoxuron, metribuzin, metsulfuron, metsulfuron-methyl, molinate, monalide, monocarbamide, monocarbamide dihydrogensulfate, monolinuron, monosulfuron, monosulfuron ester, monuron, MT-128, i.e. 6-chloro-N-[(2E)-3-chloroprop-2-en-1-yl]-5-methyl-N-phenylpyridazine-3-amine, MT-5950, i.e. N-[3-chloro-4-(1-methylethyl)phenyl]-2-methylpentanamide, NGGC-011, naproanilide, napropamide, naptalam, NC-310, i.e. 4-(2,4-dichlorobenzoyl)-1-methyl-5-benzyloxypyrazole, neburon, nicosulfuron, nipyraclofen, nitralin, nitrofen, nitrophenolate-sodium (isomer mixture), nitrofluorfen, nonanoic acid, norflurazon, orbencarb, orthosulfamuron, oryzalin, oxadiargyl, oxadiazon, oxasulfuron, oxaziclomefone, oxyfluorfen, paclobutrazole, paraquat, paraquat dichloride, pelargonic acid (nonanoic acid), pendimethalin, pendralin, penoxsulam, pentanochlor, pentoxazone, perfluidone, pethoxamid, phenisopham, phenmedipham, phenmedipham-ethyl, picloram, picolinafen, pinoxaden, piperophos, pirifenop, pirifenop-butyl, pretilachlor, primisulfuron, primisulfuron-methyl, probenazole, profluazole, procyazine, prodiamine, prifluraline, profoxydim, prohexadione, prohexadione-calcium, prohydrojasmone, prometon, prometryn, propachlor, propanil, propaquizafop, propazine, propham, propisochlor, propoxycarbazone, propoxycarbazone-sodium, propyrisulfuron, propyzamide, prosulfalin, prosulfocarb, prosulfuron, prynachlor, pyraclonil, pyraflufen, pyraflufen-ethyl, pyrasulfotole, pyrazolynate (pyrazolate), pyrazosulfuron, pyrazosulfuron-ethyl, pyrazoxyfen, pyribambenz, pyribambenz-isopropyl, pyribambenz-propyl, pyribenzoxim, pyributicarb, pyridafol, pyridate, pyriftalid, pyriminobac, pyriminobac-methyl, pyrimisulfan, pyrithiobac, pyrithiobac-sodium, pyroxasulfone, pyroxsulam, quinclorac, quinmerac, quinoclamine, quizalofop, quizalofop-ethyl, quizalofop-P, quizalofop-P-ethyl, quizalofop-P-tefuryl, rimsulfuron, saflufenacil, secbumeton, sethoxydim, siduron, simazine, simetryn, SN-106279, i.e. methyl (2R)-2-({7-[2-chloro-4-(trifluoromethyl)phenoxy]-2-naphthyl}oxy)propanoate, sulcotrione, sulfallate (CDEC), sulfentrazone, sulfometuron, sulfometuron-methyl, sulfosate (glyphosate-trimesium), sulfosulfuron, SYN-523, SYP-249, i.e. 1-ethoxy-3-methyl-1-oxobut-3-en-2-yl 5-[2-chloro-4-(trifluoromethyl)phenoxy]-2-nitrobenzoate, SYP-300, i.e. 1-[7-fluoro-3-oxo-4-(prop-2-yn-1-yl)-3,4-dihydro-2H-1,4-benzoxazin-6-yl]-3-propyl-2-thioxoimidazolidine-4,5-dione, tebutam, tebuthiuron, tecnazene, tefuryltrione, tembotrione, tepraloxydim, terbacil, terbucarb, terbuchlor, terbumeton, terbuthylazine, terbutryne, thenylchlor, thiafluamide, thiazafluoron, thiazopyr, thidiazimin, thidiazuron, thiencarbazone, thiencarbazone-methyl, thifensulfuron, thifensulfuron-methyl, thiobencarb, tiocarbazil, topramezone, tralkoxydim, triallate, triasulfuron, triaziflam, triazofenamide, tribenuron, tribenuron-methyl, trichloroacetic acid (TCA), triclopyr, tridiphane, trietazine, trifloxysulfuron, trifloxysulfuron-sodium, trifluralin, triflusulfuron, triflusulfuron-methyl, trimeturon, trinexapac, trinexapac-ethyl, tritosulfuron, tsitodef, uniconazole, uniconazole-P, vernolate, ZJ-0862, i.e. 3,4-dichloro-N-{2-[(4,6-dimethoxypyrimidin-2-yl)oxy]benzyl}aniline, and the following compounds:

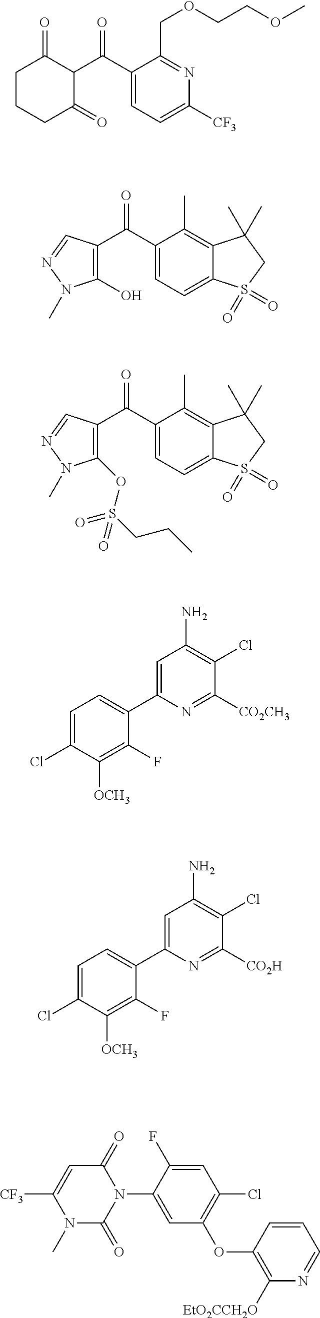

The invention is to be illustrated by the biological examples which follow, but without restricting it thereto.

### BIOLOGICAL EXAMPLES

Seeds of monocotyledonous and dicotyledonous crop plants were placed in sandy loam in wood-fiber pots, covered with soil and cultivated in a greenhouse under good growth conditions. The test plants were treated at the early leaf stage (BBCH10 BBCH13). To ensure uniform water supply before commencement of stress, the potted plants were supplied with the maximum amount of water immediately beforehand by dam irrigation and, after application, transferred in plastic inserts in order to prevent subsequent, excessively rapid drying. The inventive compounds, formulated in the form of wettable powders (WP), wettable granules (WG), suspension concentrates (SC) or emulsion concentrates (EC), were sprayed onto the green parts of the plants as an aqueous suspension at an equivalent water application rate of 600 l/ha with addition of 0.2% wetting agent (agrotin). Substance application is followed immediately by stress treatment of the plants (cold or drought stress). For cold stress treatment, the plants were kept under the following controlled conditions:

“day”: 12 hours with illumination at 8° C.

“night”: 12 hours without illumination at 1° C.

Drought stress was induced by gradual drying out under the following conditions:

“day”: 14 hours with illumination at 26° C.

“night”: 10 hours without illumination at 18° C.

The duration of the respective stress phases was guided mainly by the state of the untreated, stressed control plants and thus varied from crop to crop. It was ended (by re-irrigating or transferring it to a greenhouse with good growth conditions) as soon as irreversible damage was observed on the untreated, stressed control plants. In the case of dicotyledonous crops, for example oilseed rape and soybeans, the duration of the drought stress phase varied between 3 and 5 days, in the case of monocotyledonous crops, for example wheat, barley or corn, between 6 and 10 days. The duration of the cold stress phase varied between 12 and 14 days. The end of the stress phase was followed by an approx. 5-7-day recovery phase, during which the plants were once again kept under good growth conditions in a greenhouse. In order to rule out any influence of the effects observed by any fungicidal action of the test compounds, it is additionally ensured that the tests proceed without fungal infection and without infection pressure.

After the recovery phase had ended, the intensities of damage were rated in visual comparison to untreated, unstressed controls of the same age (in the case of drought stress) or the same growth stage (in the case of cold stress). The intensity of damage was first assessed as a percentage (100%=plants have died, 0%=like control plants). These values were then used to calculate the efficacy of the test compounds (=percentage reduction in the intensity of damage as a result of substance application) by the following formula:

$$EF = \frac{( {DV}_{us} - {DV}_{ts} ) \times 100}{{DV}_{us}}$$

EF: Efficacy (%)

DVᵤₛ: damage value of the untreated, stressed control

DVₜₛ: damage value of the plants treated with test compound

The tables below list mean values in each case from three results of the same test.

Effects of selected compounds of the formula (I):

under drought stress:

TABLE A-1

| | | | | EF |
|---|---|---|---|---|
| No. | Substance | Dosage | Unit | (BRSNS) |
| 1 | I.1-14 | 25 | g/ha | >5 |
| 2 | I.1-28 | 2.5 | g/ha | >5 |
| 3 | I.1-29 | 250 | g/ha | >5 |
| 4 | I.1-33 | 25 | g/ha | >5 |
| 5 | I.1-35 | 2.5 | g/ha | >5 |
| 6 | I.1-63 | 250 | g/ha | >5 |
| 7 | I.1-77 | 250 | g/ha | >5 |
| 8 | I.1-84 | 2.5 | g/ha | >5 |
| 9 | I.1-103 | 250 | g/ha | >5 |
| 10 | I.2-71 | 250 | g/ha | >5 |
| 11 | I.2-74 | 250 | g/ha | >5 |
| 12 | I.2-75 | 25 | g/ha | >5 |
| 13 | I.2-77 | 2.5 | g/ha | >5 |
| 14 | I.2-86 | 250 | g/ha | >5 |
| 15 | I.3-24 | 250 | g/ha | >5 |
| 16 | I.3-28 | 250 | g/ha | >5 |
| 17 | I.3-70 | 2.5 | g/ha | >5 |
| 18 | I.3-75 | 250 | g/ha | >5 |
| 19 | I.3-90 | 25 | g/ha | >5 |
| 20 | I.3-103 | 25 | g/ha | >5 |
| 21 | I.3-106 | 25 | g/ha | >5 |
| 22 | I.37-28 | 250 | g/ha | >5 |
| 23 | I.37-73 | 25 | g/ha | >5 |
| 24 | I.37-75 | 250 | g/ha | >5 |
| 25 | I.37-82 | 250 | g/ha | >5 |
| 26 | I.37-84 | 25 | g/ha | >5 |
| 27 | I.37-90 | 250 | g/ha | >5 |
| 28 | I.37-91 | 250 | g/ha | >5 |
| 29 | I.52-28 | 25 | g/ha | >5 |
| 30 | I.92-24 | 250 | g/ha | >5 |

TABLE A-2

| | | | | EF |
|---|---|---|---|---|
| No. | Substance | Dosage | Unit | (ZEAMX) |
| 1 | I.1-14 | 250 | g/ha | >5 |
| 2 | I.1-29 | 250 | g/ha | >5 |
| 3 | I.2-62 | 25 | g/ha | >5 |
| 4 | I.2-75 | 250 | g/ha | >5 |
| 5 | I.37-79 | 250 | g/ha | >5 |
| 6 | I.37-84 | 250 | g/ha | >5 |
| 7 | I.37-86 | 250 | g/ha | >5 |
| 8 | I.37-90 | 25 | g/ha | >5 |
| 9 | I.37-91 | 25 | g/ha | >5 |
| 10 | I.88-24 | 250 | g/ha | >5 |

TABLE A-3

| | | | | EF |
|---|---|---|---|---|
| No. | Substance | Dosage | Unit | (TRZAS) |
| 1 | I.1-33 | 250 | g/ha | >5 |
| 2 | I.1-35 | 25 | g/ha | >5 |
| 3 | I.1-63 | 25 | g/ha | >5 |
| 4 | I.1-84 | 25 | g/ha | >5 |
| 5 | I.1-103 | 25 | g/ha | >5 |
| 6 | I.2-62 | 250 | g/ha | >5 |
| 7 | I.2-71 | 250 | g/ha | >5 |
| 8 | I.2-74 | 25 | g/ha | >5 |
| 9 | I.2-75 | 25 | g/ha | >5 |
| 10 | I.2-77 | 250 | g/ha | >5 |
| 11 | I.2-86 | 250 | g/ha | >5 |
| 12 | I.3-28 | 250 | g/ha | >5 |
| 13 | I.3-75 | 25 | g/ha | >5 |
| 14 | I.3-90 | 25 | g/ha | >5 |
| 15 | I.3-103 | 25 | g/ha | >5 |
| 16 | I.3-106 | 250 | g/ha | >5 |
| 17 | I.37-28 | 250 | g/ha | >5 |
| 18 | I.37-73 | 250 | g/ha | >5 |
| 19 | I.37-79 | 250 | g/ha | >5 |
| 20 | I.37-82 | 25 | g/ha | >5 |
| 21 | I.37-86 | 250 | g/ha | >5 |

In the above tables:

BRSNS=Brassica napus

TRZAS=Triticum aestivum

ZEAMX=Zea mays

Similar results were also achieved with further compounds of the formula (I), also in the case of application to different plant species.

1. An open-chain aryl-, heteroaryl- and/or benzylsulfonamido carboxylic acid, -carboxylic ester, -carboxamide and/or -carbonitrile of formula (I) and/or salt thereof 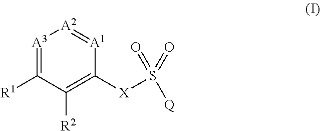
capable of being used for increasing tolerance to abiotic stress in a plant, where
Q is at least one of moieties 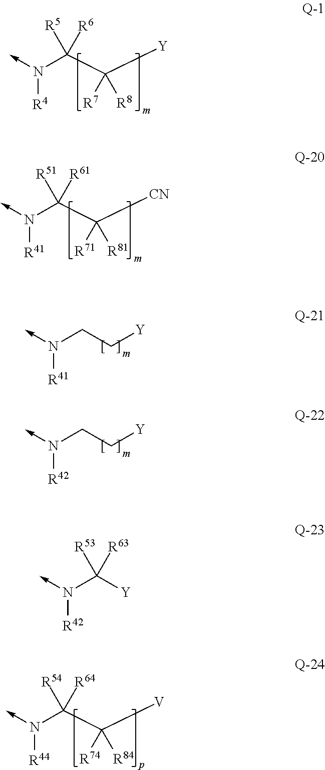
and where the radicals R⁴ to R⁸, and R⁴¹ to R⁸⁴ and also Y and m and p in each case have the meaning according to the definitions below and where the arrow is a bond to the sulfur atom of the SO₂ group;
A¹, A², A³ are the same or different and independently of one another are N nitrogen or a C—W moiety, but there are never more than two adjacent nitrogen atoms, and where W in the C—W moiety in each case has the same or different meanings according to the definition below,
W is in each case hydrogen, nitro, amino, cyano, thiocyanato, isothiocyanato, halogen, (C₁-C₈)-alkyl, (C₃-C₈)-cycloalkyl, (C₂-C₈)-alkenyl, (C₂-C₈)-alkynyl, aryl, aryl-(C₁-C₈)-alkyl, aryl-(C₁-C₆)-alkoxy, hetero aryl, (C₁-C₆)-alkoxy-(C₁-C₈)-alkyl, (C₁-C₈)-haloalkyl, (C₃-C₈)-halocycloalkyl, (C₁-C₈)-alkoxy, (C₁-C₈)-haloalkoxy, aryloxy, heteroaryloxy, (C₃-C₈)-cycloalkyloxy, (C₃-C₈)-cycloalkyl-(C₁-C₈)-alkoxy, (C₁-C₈)-alkoxycarbonyl, (C₁-C₆)-alkoxycarbonyl-(C₁-C₆)-alkyl, hydroxycarbonyl, aminocarbonyl, (C₁-C₈)-alkylaminocarbonyl, (C₃-C₈)-cycloalkylaminocarbonyl, cyano-(C₁-C₈)-alkylaminocarbonyl, (C₂-C₈)-alkenylaminocarbonyl, (C₂-C₈)-alkynylaminocarbonyl, (C₁-C₈)-alkylamino, (C₁-C₈)-alkylthio, (C₁-C₈)-halo alkylthio , bis-(C₁-C₈)-alkylamino , (C₃-C₈)-cycloalkylamino, (C₁-C₈)-alkylcarbonylamino, (C₃-C₈)-cycloalkylcarbonylamino, formylamino, (C₁-C₈)-haloalkylcarbonylamino, (C₁-C₈)-alkoxycarbonylamino, (C₁-C₈)-alkylaminocarbonylamino , bis-[(C₁-C₈)-alkyl]-aminocarbonyl-amino, (C₁-C₈)-alkylsulfonylamino , (C₃-C₈)-cycloalkylsulfonylamino, arylsulfonylamino, hetarylsulfonylamino, sulfonyl-(C₁-C₈)-haloalkylamino, amino-(C₁-C₈)-alkylsulfonyl, amino-(C₁-C₈)-haloalkylsulfonyl, (C₁-C₈)-alkylsulfonyl, (C₃-C₈)-cycloalkylsulfonyl, arylsulfonyl, (C₁-C₈)-alkylsulfinyl, (C₃-C₈)-cycloalkylsulfinyl, arylsulfinyl, N,S-di-(C₁-C₈)-alkylsulfonimidoyl, S—(C₁-C₈)-alkylsulfonimidoyl, (C₁-C₈)-alkylsulfonylaminocarbonyl, (C₃-C₈)-cycloalkylsulfonylaminocarbonyl, (C₃-C₈)-cycloalkylaminosulfonyl, aryl-(C₁-C₈)-alkylcarbonylamino, (C₃-C₈)-cycloalkyl-(C₁-C₈)-alkylcarbonylamino, heteroarylcarbonylamino, (C₁-C₈)-alkoxy-(C₁-C₈)-alkylcarbonylamino, hydroxy-(C₁-C₈)-alkylcarbonylamino,
R¹ is H, nitro, amino, cyano, halogen, (C₁-C₈)-alkyl, (C₃-C₈)-cycloalkyl, (C₂-C₈)-alkenyl, (C₂-C₈)-alkynyl, aryl, aryl-(C₁-C₈)-alkyl, heteroaryl, (C₁-C₈)-alkoxy-(C₁-C₈)-alkyl, (C₁-C₈)-halo alkyl, (C₃-C₈)-halocycloalkyl, (C₁-C₈)-alkoxy, (C₁-C₈)-haloalkoxy, (C₁-C₈)-alkylthio , (C₁-C₈)-halo alkylthio , (C₁-C₈)-alkoxycarbonyl, hydroxycarbonyl, aminocarbonyl, (C₁-C₈)-alkylaminocarbonyl, (C₁-C₈)-alkylamino, bis-(C₁-C₈)-alkylamino, (C₃-C₈)-cycloalkylamino, (C₁-C₈)-alkylcarbonylamino, (C₃-C₈)-cycloalkylcarbonylamino, formylamino, (C₁-C₈)-haloalkylcarbonylamino, (C₁-C₈)-alkoxycarbonylamino , [(C₁-C₈)-alkyl-]aminocarbonyl-amino, sulfonylamino, (C₁-C₈)-alkylsulfonylamino , (C₁-C₈)-haloalkylsulfonylamino, (C₃-C₈)-cycloalkylsulfonylamino, amino-(C₁-C₈)-alkylsulfonyl, amino-(C₁-C₈)-haloalkylsulfonyl, (C₁-C₈)-alkylsulfonyl, (C₃-C₈)-cycloalkylsulfonyl, arylsulfonyl, (C₁-C₈)-alkylsulfinyl, (C₃-C₈)-cycloalkylsulfinyl, arylsulfinyl, N,S-di-(C₁-C₈)-alkylsulfonimidoyl, S—(C₁-C₈)-alkylsulfonimidoyl, (C₁-C₈)-alkylsulfonylamino carbonyl, (C₃-C₈)-cycloalkylsulfonylaminocarbonyl, (C₃-C₈)-cycloalkylaminosulfonyl, amino-(C₁-C₈)-alkyl, amino-(C₂-C₈)-alkenyl, (C₂-C₈)-alkenylamino, (C₂-C₈)-alkenylimino,
R² is H, nitro, amino, cyano, halogen, (C₁-C₈)-alkyl, (C₃-C₈)-cycloalkyl, (C₂-C₈)-alkenyl, (C₂-C₈)-alkynyl, aryl, aryl-(C₁-C₈)-alkyl, heteroaryl, (C₁-C₈)-alkoxy-(C₁-C₈)-alkyl, (C₁-C₈)-halo alkyl, (C₃-C₈)-halocycloalkyl, (C₁-C₈)-alkoxy, (C₁-C₈)-haloalkoxy, (C₁-C₈)-alkylthio , (C₁-C₈)-halo alkylthio , (C₁-C₈)-alkoxycarbonyl, hydroxycarbonyl, aminocarbonyl, (C₁-C₈)-alkylaminocarbonyl, (C₁-C₈)-alkylamino, bis-(C₁-C₈)-alkylamino, (C₃-C₈)-cycloalkylamino, (C₁-C₈)-alkylcarbonylamino, (C₃-C₈)-cycloalkylcarbonylamino, formylamino, (C₁-C₈)-haloalkylcarbonylamino, (C₁-C₈)-alkoxycarbonylamino, [(C₁-C₈)-alkyl-]-aminocarbonyl-amino, sulfonylamino, (C₁-C₈)-alkylsulfonylamino, (C₁-C₈)-haloalkylsulfonylamino, (C₃-C₈)-cycloalkylsulfonylamino, amino-(C₁-C₈)-alkylsulfonyl, amino-(C₁-C₈)-haloalkylsulfonyl, (C₁-C₈)-alkylsulfonyl, (C₃-C₈)-cycloalkylsulfonyl, arylsulfonyl, (C₁-C₈)-alkylsulfinyl, (C₃-C₈)-cycloalkylsulfinyl, arylsulfinyl, N,S-di-(C₁-C₈)-alkylsulfonimidoyl, S—(C₁-C₈)-alkylsulfonimidoyl, (C₁-C₈)-alkylsulfonylamino carbonyl, (C₃-C₈)-cycloalkylsulfonylaminocarbonyl, (C₃-C₈)-cycloalkylaminosulfonyl, amino-(C₁-C₈)-alkyl, amino-(C₂-C₈)-alkenyl, (C₂-C₈)-alkenylamino, (C₂-C₈)-alkenylimino,
R¹ and R² with the atoms to which they are attached form a fully saturated, partially saturated or fully unsaturated, 5- to 7-membered ring optionally interrupted by heteroatoms and optionally with further substitution by W, and where, in the case of compounds of the general formula (I), they must form a corresponding ring with the moieties Q-21 and Q-23.
R¹ and A³, if A³ is a C—W group, with the atoms to which they are attached form a fully saturated, partially saturated or fully unsaturated, 5- to 7-membered ring optionally interrupted by heteroatoms and optionally with further substitution,
X is a direct bond or is a (CHR³) moiety, and where R³ in the (CHR³) moiety in each case has the same or different meanings according to the definition below,
n is 0, 1,
R³ is H, (C₁-C₈)-alkyl, (C₂-C₈)-alkenyl-(C₁-C₈)-alkyl, (C₁-C₈)-haloalkyl, (C₃-C₈)-cycloalkyl, (C₃-C₈)-cycloalkyl-(C₁-C₈)-alkyl, aryl-(C₁-C₈)-alkyl, heteroaryl-(C₁-C₈)-alkyl, (C₁-C₈)-alkoxy-(C₁-C₈)-alkyl, (C₁-C₈)-haloalkoxy-(C₁-C₈)-alkyl, (C₁-C₈)-alkylthio-(C₁-C₈)-alkyl, (C₁-C₈)-haloalkylthio-(C₁-C₈)-alkyl,
R⁴ is H, (C₁-C₈)-alkyl, (C₂-C₈)-alkenyl-(C₁-C₈)-alkyl, (C₂-C₈)-alkynyl, (C₁-C₈)-alkylcarbonyl, (C₃-C₈)-cycloalkylcarbonyl, arylcarbonyl, heteroarylcarbonyl, (C₁-C₈)-alkoxycarbonyl, aryl-(C₁-C₈)-alkoxycarbonyl, (C₃-C₈)-cycloalkoxycarbonyl, (C₃-C₈)-cyclo alkyl-(C₁-C₈)-alkoxycarbonyl, (C₁-C₈)-alkylsulfonyl, (C₃-C₈)-cycloalkylsulfonyl, arylsulfonyl, (C₁-C₈)-alkoxycarbonylcarbonyl, aryl-(C₁-C₈)-alkoxycarbonylcarbonyl, (C₁-C₈)-alkylaminothiocarbonyl, (C₁-C₈)-alkylamino carbonyl, aryl-(C₁-C₈)-alkyl, heteroaryl-(C₁-C₈)-alkyl, cyano-(C₁-C₈)-alkyl, (C₁-C₈)-haloalkyl, (C₃-C₈)-cycloalkyl, (C₃-C₈)-cyclo alkyl-(C₁-C₈)-alkyl, (C₁-C₈)-alkoxy-(C₁-C₈)-alkyl, (C₁-C₈)-haloalkoxy-(C₁-C₈)-alkyl, (C₂-C₈)-alkynyl-(C₁-C₈)-alkyl, (C₁-C₈)-alkoxycarbonyl-(C₁-C₈)-alkyl, aminocarbonyl-(C₁-C₈)-alkyl, (C₁-C₈)-alkylaminocarbonyl-(C₁-C₈)-alkyl, bis-(C₁-C₈)-alkylamino carbonyl-(C₁-C₈)-alkyl,
R⁵ is halogen, (C₂-C₈)-alkyl, (C₁-C₈)-alkoxy, (C₁-C₈)-alkoxycarbonyloxy, (C₂-C₈)-alkenyl, (C₂-C₈)-haloalkenyl, (C₂-C₈)-alkenyl-(C₁-C₈)-alkyl, (C₂-C₈)-alkynyl, (C₂-C₈)-alkynyl-(C₁-C₈)-alkyl, aryl-(C₁-C₈)-alkyl, bisaryl-(C₁-C₈)-alkyl, aryl-(C₁-C₈)-alkoxyaryl-(C₁-C₈)-alkyl, aryloxyaryl-(C₁-C₈)-alkyl, (C₁-C₈)-alkoxyaryl-(C₁-C₈)-alkyl, heteroaryl-(C₁-C₈)-alkyl, heterocyclyl-(C₁-C₈)-alkyl, N—(C₁-C₈)-alkylheterocyclyl-(C₁-C₈)-alkyl, N—[(C₁-C₈)-alkoxycarbonyl]heterocyclyl-(C₁-C₈)-alkyl, N-(aryl-(C₁-C₈)-alkoxycarbonyl)heterocyclyl-(C₁-C₈)-alkyl, N-(arylcarbonyl)heterocyclyl-(C₁-C₈)-alkyl, N—[(C₁-C₈)-alkylcarbonyl]heterocyclyl-(C₁-C₈)-alkyl, N—[(C₃-C₈)-cycloalkylcarbonyl]heterocyclyl-(C₁-C₈)-alkyl, cyano-(C₁-C₈)-alkyl, (C₁-C₈)-haloalkyl, (C₃-C₈)-cyclo alkyl, (C₃-C₈)-halo cyclo alkyl, (C₄-C₈)-cyclo alkenyl, (C₃-C₈)-cyclo alkyl-(C₁-C₈)-alkyl, (C₃-C₈)-cycloalkenyl-(C₁-C₈)-alkyl, hydroxy-(C₁-C₈)-alkyl, (C₁-C₈)-alkoxy-(C₁-C₈)-alkyl, (C₁-C₈)-haloalkoxy-(C₁-C₈)-alkyl, aryloxy-(C₁-C₈)-alkyl, aryl-(C₁-C₈)-alkoxy-(C₁-C₈)-alkyl, heteroaryl-(C₁-C₈)-alkoxy-(C₁-C₈)-alkyl, (C₃-C₈)-cyclo alkoxy-(C₁-C₈)-alkyl, (C₃-C₈)-cycloalkyl-(C₁-C₈)-alkoxy-(C₁-C₈)-alkyl, (C₁-C₈)-alkylcarbonyloxy-(C₁-C₈)-alkyl, arylcarbonyloxy-(C₁-C₈)-alkyl, heteroarylcarbonyloxy-(C₁-C₈)-alkyl, (C₃-C₈)-cycloalkylcarbonyloxy-(C₁-C₈)-alkyl, arylsulfonyloxy-(C₁-C₈)-alkyl, (C₁-C₈)-alkylsulfonyloxy-(C₁-C₈)-alkyl, hydrothio-(C₁-C₈)-alkyl, (C₁-C₈)-alkylthio-(C₁-C₈)-alkyl, (C₁-C₈)-haloalkylthio-(C₁-C₈)-alkyl, aryl-(C₁-C₈)-alkylthiol-(C₁-C₈)-alkyl, (C₃-C₈)-cycloalkylthiol-(C₁-C₈)-alkyl, arylthio-(C₁-C₈)-alkyl, (C₁-C₈)-alkylsulfinyl-(C₁-C₈)-alkyl, (C₁-C₈)-alkylsulfonyl-(C₁-C₈)-alkyl, (C₁-C₈)-haloalkylsulfinyl-(C₁-C₈)-alkyl, (C₁-C₈)-haloalkylsulfonyl-(C₁-C₈)-alkyl, aryl-(C₁-C₈)-alkylsulfinyl-(C₁-C₈)-alkyl, aryl-(C₁-C₈)-alkylsulfonyl-(C₁-C₈)-alkyl, (C₃-C₈)-cycloalkylsulfinyl-(C₁-C₈)-alkyl, (C₃-C₈)-cycloalkylsulfonyl-(C₁-C₈)-alkyl, aryl, heteroaryl, heterocyclyl, N—[(C₁-C₈)-alkyl]heterocyclyl, N—[(C₁-C₈)-alkoxycarbonyl]heterocyclyl, N—[aryl-(C₁-C₈)-alkoxycarbonyl]heterocyclyl, N-(arylcarbonyl)heterocyclyl, N—[(C₁-C₈)-alkylcarbonyl]heterocyclyl, N—[(C₁-C₈)-cycloalkylcarbonyl]heterocyclyl, hydroxycarbonyl, (C₁-C₈)-alkoxycarbonyl, (C₃-C₈)-cycloalkoxycarbonyl, (C₃-C₈)-cyclo alkyl-(C₁-C₈)-alkoxycarbonyl, aryl-(C₁-C₈)-alkoxycarbonyl, hetero aryl-(C₁-C₈)-alkoxycarbonyl, (C₁-C₈)-alkylaminocarbonyl, aminocarbonyl, bis-(C₁-C₈)-alkylaminocarbonyl, (C₃-C₈)-cycloalkylaminocarbonyl, aryl-(C₁-C₈)-alkylaminocarbonyl, heteroarylaminocarbonyl, cyano-(C₁-C₈)-alkylamino carbonyl, (C₁-C₈)-halo alkylamino carbonyl, (C₂-C₈)-alkynyl-(C₁-C₈)-alkylamino carbonyl, hydroxycarbonyl-(C₁-C₈)-alkyl, (C₁-C₈)-alkoxycarbonyl-(C₁-C₈)-alkyl, (C₃-C₈)-cycloalkoxycarbonyl-(C₁-C₈)-alkyl, (C₃-C₈)-cyclo alkyl-(C₁-C₈)-alkoxycarbonyl-(C₁-C₈)-alkyl, aryl-(C₁-C₈)-alkoxycarbonyl-(C₁-C₈)-alkyl, heteroaryl-(C₁-C₈)-alkoxycarbonyl-(C₁-C₈)-alkyl, (C₁-C₈)-alkylaminocarbonyl-(C₁-C₈)-alkyl, aminocarbonyl-(C₁-C₈)-alkyl, bis-(C₁-C₈)-alkylaminocarbonyl-(C₁-C₈)-alkyl, (C₃-C₈)-cycloalkylaminocarbonyl-(C₁-C₈)-alkyl, aryl-(C₁-C₈)-alkylaminocarbonyl-(C₁-C₈)-alkyl, heteroarylaminocarbonyl-(C₁-C₈)-alkyl, cyano-(C₁-C₈)-alkylaminocarbonyl-(C₁-C₈)-alkyl, (C₁-C₈)-haloalkylaminocarbonyl-(C₁-C₈)-alkyl, (C₂-C₈)-alkynyl-(C₁-C₈)-alkylaminocarbonyl-(C₁-C₈)-alkyl, amino-(C₁-C₈)-alkyl, (C₁-C₈)-alkylamino-(C₁-C₈)-alkyl, (C₂-C₈)-alkenylamino-(C₁-C₈)-alkyl, arylamino-(C₁-C₈)-alkyl, bis-(C₁-C₈)-alkylamino-(C₁-C₈)-alkyl, bis-(C₃-C₈)-cycloalkylamino-(C₁-C₈)-alkyl, aryl-(C₁-C₈)-alkylamino-(C₁-C₈)-alkyl, tris-aryl-(C₁-C₈)-alkylamino-(C₁-C₈)-alkyl, (C₃-C₈)-cyclo alkylamino-(C₁-C₈)-alkyl, (C₃-C₈)-cycloalkyl-(C₁-C₈)-alkylamino-(C₁-C₈)-alkyl, (C₁-C₈)-haloalkylamino-(C₁-C₈)-alkyl, (C₁-C₈)-alkylcarbonylamino-(C₁-C₈)-alkyl, (C₁-C₈)-cyclo alkylcarbonylamino-(C₁-C₈)-alkyl, arylcarbonylamino-(C₁-C₈)-alkyl, heteroarylcarbonylamino-(C₁-C₈)-alkyl, (C₁-C₈)-alkoxycarbonylamino-(C₁-C₈)-alkyl, (C₂-C₈)-alkenyloxycarbonylamino-(C₁-C₈)-alkyl, aryl-(C₁-C₈)-alkoxycarbonylamino-(C₁-C₈)-alkyl, aryl-(C₁-C₈)-alkoxycarbonyl [N—(C₁-C₈)-alkyl]amino-(C₁-C₈)-alkyl, heteroaryl-(C₁-C₈)-alkoxycarbonylamino-(C₁-C₈)-alkyl, (C₃-C₈)-cyclo alkyl-(C₁-C₈)-alkoxycarbonylamino-(C₁-C₈)-alkyl, (C₃-C₈)-cycloalkoxycarbonylamino-(C₁-C₈)-alkyl, aminocarbonylamino-(C₁-C₈)-alkyl, arylsulfonylamino-(C₁-C₈)-alkyl, heteroarylsulfonylamino-(C₁-C₈)-alkyl, (C₁-C₈)-alkylsulfonylamino-(C₁-C₈)-alkyl, (C₃-C₈)-cycloalkylsulfonylamino-(C₁-C₈)-alkyl, aminoiminoamino-(C₁-C₈)-alkyl, arylsulfonylaminoiminoamino-(C₁-C₈)-alkyl, (C₁-C₈)-alkylaminoiminoamino-(C₁-C₈)-alkyl,
R⁷ is hydrogen, halogen, (C₁-C₈)-alkyl, (C₁-C₈)-alkoxy, (C₁-C₈)-alkoxycarbonyloxy, (C₂-C₈)-alkenyl, (C₂-C₈)-haloalkenyl, (C₂-C₈)-alkenyl-(C₁-C₈)-alkyl, (C₂-C₈)-alkynyl, (C₂-C₈)-alkynyl-(C₁-C₈)-alkyl, aryl-(C₁-C₈)-alkyl, bisaryl-(C₁-C₈)-alkyl, aryl-(C₁-C₈)-alkoxyaryl-(C₁-C₈)-alkyl, aryloxyaryl-(C₁-C₈)-alkyl, (C₁-C₈)-alkoxyaryl-(C₁-C₈)-alkyl, heteroaryl-(C₁-C₈)-alkyl, heterocyclyl-(C₁-C₈)-alkyl, N—(C₁-C₈)-alkylheterocyclyl-(C₁-C₈)-alkyl, N—[(C₁-C₈)-alkoxycarbonyl]heterocyclyl-(C₁-C₈)-alkyl, N-(aryl-(C₁-C₈)-alkoxycarbonyl)heterocyclyl-(C₁-C₈)-alkyl, N-(arylcarbonyl)heterocyclyl-(C₁-C₈)-alkyl, N—[(C₁-C₈)-alkylcarbonyl]heterocyclyl-(C₁-C₈)-alkyl, N—[(C₃-C₈)-cycloalkylcarbonyl]heterocyclyl-(C₁-C₈)-alkyl, cyano-(C₁-C₈)-alkyl, (C₁-C₈)-haloalkyl, (C₃-C₈)-cycloalkyl, (C₃-C₈)-halocycloalkyl, (C₄-C₈)-cycloalkenyl, (C₃-C₈)-cyclo alkyl-(C₁-C₈)-alkyl, (C₃-C₈)-cycloalkenyl-(C₁-C₈)-alkyl, hydroxy-(C₁-C₈)-alkyl, (C₁-C₈)-alkoxy-(C₁-C₈)-alkyl, (C₁-C₈)-haloalkoxy-(C₁-C₈)-alkyl, aryloxy-(C₁-C₈)-alkyl , aryl-(C₁-C₈)-alkoxy-(C₁-C₈)-alkyl, heteroaryl-(C₁-C₈)-alkoxy-(C₁-C₈)-alkyl, (C₃-C₈)-cycloalkoxy-(C₁-C₈)-alkyl, (C₃-C₈)-cyclo alkyl-(C₁-C₈)-alkoxy-(C₁-C₈)-alkyl, (C₁-C₈)-alkylcarbonyloxy-(C₁-C₈)-alkyl, arylcarbonyloxy-(C₁-C₈)-alkyl, hetero arylcarbonyloxy-(C₁-C₈)-alkyl, —(C₃-C₈)-cycloalkylcarbonyloxy-(C₁-C₈)-alkyl, arylsulfonyloxy-(C₁-C₈)-alkyl, (C₁-C₈)-alkylsulfonyloxy-(C₁-C₈)-alkyl, hydrothio-(C₁-C₈)-alkyl, (C₁-C₈)-alkylthio-(C₁-C₈)-alkyl, (C₁-C₈)-haloalkylthio-(C₁-C₈)-alkyl, aryl-(C₁-C₈)-alkylthio-(C₁-C₈)-alkyl, —(C₃-C₈)-cycloalkylthio-(C₁-C₈)-alkyl , arylthio-(C₁-C₈)-alkyl, (C₁-C₈)-alkylsulfinyl-(C₁-C₈)-alkyl, (C₁-C₈)-alkylsulfonyl-(C₁-C₈)-alkyl, (C₁-C₈)-haloalkylsulfinyl-(C₁-C₈)-alkyl, (C₁-C₈)-haloalkylsulfonyl-(C₁-C₈)-alkyl, aryl-(C₁-C₈)-alkylsulfinyl-(C₁-C₈)-alkyl, aryl-(C₁-C₈)-alkylsulfonyl-(C₁-C₈)-alkyl, (C₃-C₈)-cycloalkylsulfinyl-(C₁-C₈)-alkyl, (C₃-C₈)-cycloalkylsulfonyl-(C₁-C₈)-alkyl, aryl, heteroaryl, heterocyclyl, N—[(C₁-C₈)-alkyl]heterocyclyl, N—[(C₁-C₈)-alkoxycarbonyl]heterocyclyl, N—[aryl-(C₁-C₈)-alkoxycarbonyl]heterocyclyl, N-(arylcarbonyl)heterocyclyl, N—[(C₁-C₈)-alkylcarbonyl]heterocyclyl, N—[(C₁-C₈)-cycloalkylcarbonyl]heterocyclyl, hydroxycarbonyl, (C₁-C₈)-alkoxycarbonyl, (C₃-C₈)-cycloalkoxycarbonyl, (C₃-C₈)-cycloalkyl-(C₁-C₈)-alkoxycarbonyl, aryl-(C₁-C₈)-alkoxycarbonyl, heteroaryl-(C₁-C₈)-alkoxycarbonyl, (C₁-C₈)-alkylaminocarbonyl, aminocarbonyl, bis-(C₁-C₈)-alkylaminocarbonyl, (C₃-C₈)-cycloalkylaminocarbonyl, aryl-(C₁-C₈)-alkylaminocarbonyl, heteroarylaminocarbonyl, cyano-(C₁-C₈)-alkylaminocarbonyl, (C₁-C₈)-haloalkylaminocarbonyl, (C₂-C₈)-alkynyl-(C₁-C₈)-alkylaminocarbonyl, hydroxycarbonyl-(C₁-C₈)-alkyl, (C₁-C₈)-alkoxycarbonyl-(C₁-C₈)-alkyl, (C₃-C₈)-cyclo alkoxycarbonyl-(C₁-C₈)-alkyl, (C₃-C₈)-cycloalkyl-(C₁-C₈)-alkoxycarbonyl-(C₁-C₈)-alkyl, aryl-(C₁-C₈)-alkoxycarbonyl-(C₁-C₈)-alkyl, hetero aryl-(C₁-C₈)-alkoxycarbonyl-(C₁-C₈)-alkyl, (C₁-C₈)-alkylaminocarbonyl-(C₁-C₈)-alkyl, aminocarbonyl-(C₁-C₈)-alkyl, bis-(C₁-C₈)-alkylaminocarbonyl-(C₁-C₈)-alkyl, (C₃-C₈)-cycloalkylaminocarbonyl-(C₁-C₈)-alkyl, aryl-(C₁-C₈)-alkylaminocarbonyl-(C₁-C₈)-alkyl, hetero arylamino carbonyl-(C₁-C₈)-alkyl, cyano-(C₁-C₈)-alkylaminocarbonyl-(C₁-C₈)-alkyl, (C₁-C₈)-haloalkylaminocarbonyl-(C₁-C₈)-alkyl, (C₂-C₈)-alkynyl-(C₁-C₈)-alkylaminocarbonyl-(C₁-C₈)-alkyl, amino-(C₁-C₈)-alkyl, (C₁-C₈)-alkylamino-(C₁-C₈)-alkyl, (C₂-C₈)-alkenylamino-(C₁-C₈)-alkyl, arylamino-(C₁-C₈)-alkyl, bis-(C₁-C₈)-alkylamino-(C₁-C₈)-alkyl, bis-(C₃-C₈)-cycloalkylamino-(C₁-C₈)-alkyl, aryl-(C₁-C₈)-alkylamino-(C₁-C₈)-alkyl, tris-aryl-(C₁-C₈)-alkylamino-(C₁-C₈)-alkyl, (C₃-C₈)-cycloalkylamino-(C₁-C₈)-alkyl, (C₃-C₈)-cycloalkyl-(C₁-C₈)-alkylamino-(C₁-C₈)-alkyl, (C₁-C₈)-halo alkylamino-(C₁-C₈)-alkyl, (C₁-C₈)-alkylcarbonylamino-(C₁-C₈)-alkyl, (C₁-C₈)-cyclo alkylcarbonylamino-(C₁-C₈)-alkyl, arylcarbonylamino-(C₁-C₈)-alkyl, heteroarylcarbonylamino-(C₁-C₈)-alkyl, (C₁-C₈)-alkoxycarbonylamino-(C₁-C₈)-alkyl, (C₂-C₈)-alkenyloxycarbonylamino-(C₁-C₈)-alkyl, aryl-(C₁-C₈)-alkoxycarbonylamino-(C₁-C₈)-alkyl, aryl-(C₁-C₈)-alkoxycarbonyl[N—(C₁-C₈)-alkyl]amino-(C₁-C₈)-alkyl, heteroaryl-(C₁-C₈)-alkoxycarbonylamino-(C₁-C₈)-alkyl, (C₃-C₈)-cycloalkyl-(C₁-C₈)-alkoxycarbonylamino-(C₁-C₈)-alkyl, (C₃-C₈)-cycloalkoxycarbonylamino-(C₁-C₈)-alkyl, amino carbonylamino-(C₁-C₈)-alkyl, arylsulfonylamino-(C₁-C₈)-alkyl, heteroarylsulfonylamino-(C₁-C₈)-alkyl, (C₁-C₈)-alkylsulfonylamino-(C₁-C₈)-alkyl, (C₃-C₈)-cycloalkylsulfonylamino-(C₁-C₈)-alkyl, aminoiminoamino-(C₁-C₈)-alkyl, arylsulfonylaminoiminoamino-(C₁-C₈)-alkyl, (C₁-C₈)-alkylaminoiminoamino-(C₁-C₈)-alkyl,
R⁶ and R⁸ independently of one another are H, (C₁-C₈)-alkyl, (C₂-C₈)-alkenyl-(C₁-C₈)-alkyl, (C₂-C₈)-alkynyl-(C₁-C₈)-alkyl, aryl-(C₁-C₈)-alkyl, (C₃-C₈)-cycloalkyl, (C₃-C₈)-cycloalkyl-(C₁-C₈)-alkyl, heterocyclyl, heterocyclyl-(C₁-C₈)-alkyl, amino-(C₁-C₈)-alkyl, (C₁-C₈)-alkoxy-(C₁-C₈)-alkyl, (C₁-C₈)-alkylthio-(C₁-C₈)-alkyl, (C₁-C₈)-haloalkyl, (C₁-C₈)-alkylamino-(C₁-C₈)-alkyl, bis-(C₁-C₈)-alkylamino-(C₁-C₈)-alkyl, (C₁-C₈)-alkylcarbonylamino-(C₁-C₈)-alkyl, (C₃-C₈)-cycloalkylcarbonylamino-(C₁-C₈)-alkyl, arylcarbonylamino-(C₁-C₈)-alkyl, (C₁-C₈)-alkoxycarbonylamino-(C₁-C₈)-alkyl, aryl-(C₁-C₈)-alkoxycarbonylamino-(C₁-C₈)-alkyl, (C₃-C₈)-cycloalkyl-(C₁-C₈)-alkoxycarbonylamino-(C₁-C₈)-alkyl, aminocarbonylamino-(C₁-C₈)-alkyl, aminoiminoamino-(C₁-C₈)-alkyl, arylsulfonylaminoiminoamino-(C₁-C₈)-alkyl, (C₁-C₈)-alkylaminoiminoamino-(C₁-C₈)-alkyl,
R⁴¹ is H, (C₁-C₈)-alkyl, (C₂-C₈)-alkenyl-(C₁-C₈)-alkyl, (C₂-C₈)-alkynyl, (C₁-C₈)-alkylcarbonyl, (C₃-C₈)-cycloalkylcarbonyl, arylcarbonyl, heteroarylcarbonyl, (C₁-C₈)-alkoxycarbonyl, aryl-(C₁-C₈)-alkoxycarbonyl, (C₃-C₈)-cyclo alkoxycarbonyl, (C₃-C₈)-cycloalkyl-(C₁-C₈)-alkoxycarbonyl, (C₁-C₈)-alkylsulfonyl, (C₃-C₈)-cycloalkylsulfonyl, arylsulfonyl, (C₁-C₈)-alkoxycarbonylcarbonyl, aryl-(C₁-C₈)-alkoxycarbonylcarbonyl, (C₁-C₈)-alkylaminothiocarbonyl, (C₁-C₈)-alkylamino carbonyl, aryl-(C₁-C₈)-alkyl, heteroaryl-(C₁-C₈)-alkyl, cyano-(C₁-C₈)-alkyl, (C₁-C₈)-haloalkyl, (C₃-C₈)-cycloalkyl, (C₃-C₈)-cycloalkyl-(C₁-C₈)-alkyl, (C₁-C₈)-alkoxy-(C₁-C₈)-alkyl, (C₁-C₈)-haloalkoxy-(C₁-C₈)-alkyl, (C₂-C₈)-alkynyl-(C₁-C₈)-alkyl, (C₁-C₈)-alkoxycarbonyl-(C₁-C₈)-alkyl, aminocarbonyl-(C₁-C₈)-alkyl, (C₁-C₈)-alkylaminocarbonyl-(C₁-C₈)-alkyl, bis-(C₁-C₈)-alkylamino carbonyl-(C₁-C₈)-alkyl,
in the case of the grouping Q-21 is exclusively H or methyl,
R⁴² is (C₂-C₈)-alkyl, (C₂-C₈)-alkenyl-(C₁-C₈)-alkyl, (C₂-C₈)-alkynyl, (C₁-C₈)-alkylcarbonyl, (C₃-C₈)-cycloalkylcarbonyl, arylcarbonyl, heteroarylcarbonyl, (C₁-C₈)-alkoxycarbonyl, aryl-(C₁-C₈)-alkoxycarbonyl, (C₃-C₈)-cyclo alkoxycarbonyl, (C₃-C₈)-cycloalkyl-(C₁-C₈)-alkoxycarbonyl, (C₁-C₈)-alkylsulfonyl, (C₃-C₈)-cycloalkylsulfonyl, arylsulfonyl, (C₁-C₈)-alkoxycarbonylcarbonyl, aryl-(C₁-C₈)-alkoxycarbonylcarbonyl, (C₁-C₈)-alkylaminothiocarbonyl, (C₁-C₈)-alkylamino carbonyl, aryl-(C₁-C₈)-alkyl, heteroaryl-(C₁-C₈)-alkyl, cyano-(C₁-C₈)-alkyl, (C₁-C₈)-haloalkyl, (C₃-C₈)-cycloalkyl, (C₃-C₈)-cycloalkyl-(C₁-C₈)-alkyl, (C₁-C₈)-alkoxy-(C₁-C₈)-alkyl, (C₁-C₈)-haloalkoxy-(C₁-C₈)-alkyl, (C₂-C₈)-alkynyl-(C₁-C₈)-alkyl, (C₁-C₈)-alkoxycarbonyl-(C₁-C₈)-alkyl, amino carbonyl-(C₁-C₈)-alkyl, (C₁-C₈)-alkylaminocarbonyl-(C₁-C₈)-alkyl, bis-(C₁-C₈)-alkylamino carbonyl-(C₁-C₈)-alkyl,
R⁴³ is H or methyl,
R⁴⁴ is hydrogen, (C₁-C₈)-alkyl, (C₂-C₈)-alkenyl-(C₁-C₈)-alkyl, (C₂-C₈)-alkynyl, (C₁-C₈)-alkylcarbonyl, (C₃-C₈)-cycloalkylcarbonyl, arylcarbonyl, heteroarylcarbonyl, (C₁-C₈)-alkoxycarbonyl, aryl-(C₁-C₈)-alkoxycarbonyl, (C₃-C₈)-cycloalkoxycarbonyl, (C₃-C₈)-cyclo alkyl-(C₁-C₈)-alkoxycarbonyl, (C₁-C₈)-alkylsulfonyl, (C₃-C₈)-cycloalkylsulfonyl, arylsulfonyl, (C₁-C₈)-alkoxycarbonylcarbonyl, aryl-(C₁-C₈)-alkoxycarbonylcarbonyl, (C₁-C₈)-alkylaminothiocarbonyl, (C₁-C₈)-alkylamino carbonyl, aryl-(C₁-C₈)-alkyl, heteroaryl-(C₁-C₈)-alkyl, cyano-(C₁-C₈)-alkyl, (C₁-C₈)-haloalkyl, (C₃-C₈)-cycloalkyl, (C₃-C₈)-cycloalkyl-(C₁-C₈)-alkyl, (C₁-C₈)-alkoxy-(C₁-C₈)-alkyl, (C₁-C₈)-haloalkoxy-(C₁-C₈)-alkyl, (C₂-C₈)-alkynyl-(C₁-C₈)-alkyl, (C₁-C₈)-alkoxycarbonyl-(C₁-C₈)-alkyl, amino carbonyl-(C₁-C₈)-alkyl, (C₁-C₈)-alkylaminocarbonyl-(C₁-C₈)-alkyl, bis-(C₁-C₈)-alkylamino carbonyl-(C₁-C₈)-alkyl,
R⁵¹ and R⁷¹ independently of one another are hydrogen and methyl,
R⁵³ is methyl,
R⁶¹ and R⁸¹ independently of one another are hydrogen and methyl,
R⁶³ is H, methyl,
R⁵⁴, R⁶⁴, R⁷⁴, R⁸⁴ independently of one another are hydrogen, methyl, where at least one of the groups R⁵⁴, R⁶⁴, R⁷⁴, R⁸⁴ must be methyl,
V is hydroxycarbonyl, (C₁-C₈)-alkoxycarbonyl, (C₃-C₈)-cycloalkoxycarbonyl, (C₃-C₈)-cycloalkyl-(C₁-C₈)-alkoxycarbonyl, aryloxycarbonyl, aryl-(C₁-C₈)-alkoxycarbonyl, aminocarbonyl, (C₁-C₈)-alkylamino carbonyl, bis-(C₁-C₈)-alkylamino carbonyl, (C₁-C₈)-alkyl-[(C₁-C₈)-alkoxy]amino carbonyl, (C₃-C₈)-cycloalkylaminocarbonyl, aryl-(C₁-C₈)-alkylaminocarbonyl, heteroaryl-(C₁-C₈)-alkylamino carbonyl, cyano-(C₁-C₈)-alkylaminocarbonyl, (C₁-C₈)-haloalkylaminocarbonyl, (C₂-C₈)-alkynyl-(C₁-C₈)-alkylamino carbonyl, (C₁-C₈)-alkoxycarbonyl-(C₁-C₈)-alkylamino carbonyl, hydroxycarbonyl-(C₁-C₈)-alkylamino carbonyl, aminocarbonyl-(C₁-C₈)-alkylaminocarbonyl, (C₁-C₈)-alkylaminocarbonyl-(C₁-C₈)-alkylaminocarbonyl, (C₃-C₈)-cycloalkylaminocarbonyl-(C₁-C₈)-alkylaminocarbonyl, (C₃-C₈)-cycloalkyl-(C₁-C₈)-alkylamino carbonyl,
m is 0, 1, 2, 3, 4, 5,
p is 1, 2, 3, 4,
Y is cyano, cyano-(C₁-C₈)-alkyl, hydroxy-(C₁-C₈)-alkyl, (C₁-C₈)-alkoxy-(C₁-C₈)-alkyl, hydroxycarbonyl, (C₁-C₈)-alkoxycarbonyl, (C₃-C₈)-cycloalkoxycarbonyl, (C₃-C₈)-cycloalkyl-(C₁-C₈)-alkoxycarbonyl, aryloxycarbonyl, aryl-(C₁-C₈)-alkoxycarbonyl, aminocarbonyl, (C₁-C₈)-alkylaminocarbonyl, bis-(C₁-C₈)-alkylamino carbonyl, (C₁-C₈)-alkyl [(C₁-C₈)-alkoxy]amino carbonyl, (C₃-C₈)-cycloalkylaminocarbonyl, aryl-(C₁-C₈)-alkylaminocarbonyl, heteroaryl-(C₁-C₈)-alkylamino carbonyl, cyano-(C₁-C₈)-alkylaminocarbonyl, (C₁-C₈)-haloalkylaminocarbonyl, (C₂-C₈)-alkynyl-(C₁-C₈)-alkylaminocarbonyl, (C₁-C₈)-alkoxycarbonylamino carbonyl, aryl-(C₁-C₈)-alkoxycarbonylamino carbonyl, hydroxycarbonyl-(C₁-C₈)-alkyl, (C₁-C₈)-alkoxycarbonyl-(C₁-C₈)-alkyl, (C₃-C₈)-cycloalkoxycarbonyl-(C₁-C₈)-alkyl, (C₃-C₈)-cycloalkyl-(C₁-C₈)-alkoxycarbonyl-(C₁-C₈)-alkyl, (C₁-C₈)-alkylamino carbonyl-(C₁-C₈)-alkyl, aminocarbonyl-(C₁-C₈)-alkyl, bis-(C₁-C₈)-alkylamino carbonyl-(C₁-C₈)-alkyl, (C₃-C₈)-cycloalkylaminocarbonyl-(C₁-C₈)-alkyl, aryl-(C₁-C₈)-alkylaminocarbonyl-(C₁-C₈)-alkyl, heteroaryl-(C₁-C₈)-alkylamino carbonyl-(C₁-C₈)-alkyl, cyano-(C₁-C₈)-alkylaminocarbonyl-(C₁-C₈)-alkyl, (C₁-C₈)-haloalkylamino carbonyl-(C₁-C₈)-alkyl, (C₂-C₈)-alkynyl-(C₁-C₈)-alkylaminocarbonyl-(C₁-C₈)-alkyl, (C₃-C₈)-cycloalkyl-(C₁-C₈)-alkylaminocarbonyl-(C₁-C₈)-alkyl, (C₁-C₈)-alkoxycarbonylaminocarbonyl-(C₁-C₈)-alkyl, aryl-(C₁-C₈)-alkoxycarbonylamino carbonyl-(C₁-C₈)-alkyl, (C₁-C₈)-alkoxycarbonyl-(C₁-C₈)-alkylamino carbonyl, hydroxycarbonyl-(C₁-C₈)-alkylamino carbonyl, aminocarbonyl-(C₁-C₈)-alkylamino carbonyl, (C₁-C₈)-alkylaminocarbonyl-(C₁-C₈)-alkylaminocarbonyl, (C₃-C₈)-cyclo alkylamino carbonyl-(C₁-C₈)-alkylamino carbonyl, (C₃-C₈)-cycloalkyl-(C₁-C₈)-alkylamino carbonyl, (C₃-C₈)-cycloalkyl-(C₁-C₈)-alkylaminocarbonyl-(C₁-C₈)-alkyl, (C₂-C₈)-alkenyloxycarbonyl, (C₂-C₈)-alkenyloxycarbonyl-(C₁-C₈)-alkyl, (C₂-C₈)-alkenylaminocarbonyl, (C₂-C₈)-alkenyl-(C₁-C₈)-alkylaminocarbonyl, (C₂-C₈)-alkenylaminocarbonyl-(C₁-C₈)-alkyl, (C₂-C₈)-alkenyl-(C₁-C₈)-alkylaminocarbonyl-(C₁-C₈)-alkyl.

2. The compound of formula (I) and/or salt thereof capable of being used as claimed in claim 1, where
Q is at least one of 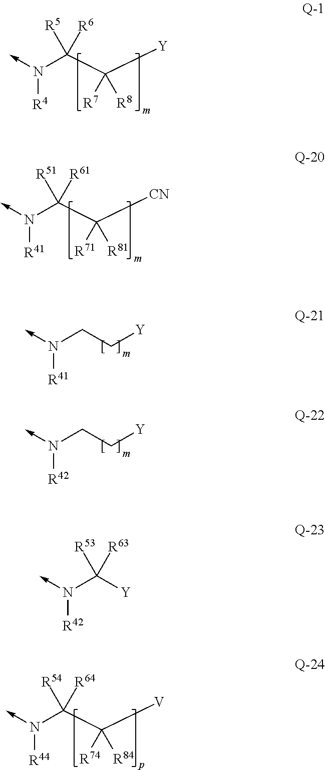
and where the radicals R⁴ to R⁸, and R⁴¹ to R⁸⁴ and also Y and m and p in each case have the meaning according to the definitions below and where the arrow is a bond to the sulfur atom of the SO₂ group;
A¹, A², A³ are the same or different and independently of one another are N (nitrogen) or the C—W moiety, but there are never more than two adjacent nitrogen atoms, and where W in the C—W moiety in each case has the same or different meanings according to the definition below,
W is in each case hydrogen, nitro, amino, cyano, thiocyanato, isothiocyanato, halogen, (C₁-C₆)-alkyl, (C₃-C₆)-cycloalkyl, (C₂-C₆)-alkenyl, (C₂-C₆)-alkynyl, aryl, aryl-(C₁-C₆)-alkyl, aryl-(C₁-C₆)-alkoxy, hetero aryl, (C₁-C₆)-alkoxy-(C₁-C₆)-alkyl, (C₁-C₆)-haloalkyl, (C₃-C₆)-halocycloalkyl, (C₁-C₆)-alkoxy, (C₁-C₆)-haloalkoxy, aryloxy, heteroaryloxy, (C₃-C₆)-cycloalkyloxy, (C₃-C₆)-cycloalkyl-(C₁-C₆)-alkoxy, (C₁-C₆)-alkoxycarbonyl, (C₁-C₆)-alkoxycarbonyl-(C₁-C₆)-alkyl, hydroxycarbonyl, aminocarbonyl, (C₁-C₆)-alkylaminocarbonyl, (C₃-C₆)-cycloalkylaminocarbonyl, cyano-(C₁-C₆)-alkylaminocarbonyl, (C₂-C₆)-alkenylaminocarbonyl, (C₂-C₆)-alkynylaminocarbonyl, (C₁-C₆)-alkylamino, (C₁-C₆)-alkylthio, (C₁-C₆)-halo alkylthio , bis-(C₁-C₆)-alkylamino , (C₃-C₆)-cycloalkylamino, (C₁-C₆)-alkylcarbonylamino, (C₃-C₆)-cycloalkylcarbonylamino, formylamino, (C₁-C₆)-halo alkylcarbonylamino, (C₁-C₆)-alkoxycarbonylamino, (C₁-C₆)-alkylaminocarbonylamino, bis-[(C₁-C₆)-alkyl]-aminocarbonyl-amino, (C₁-C₆)-alkylsulfonylamino , (C₃-C₆)-cycloalkylsulfonylamino, arylsulfonylamino, hetarylsulfonylamino, sulfonyl-(C₁-C₆)-haloalkylamino, amino-(C₁-C₆)-alkylsulfonyl, amino-(C₁-C₆)-haloalkylsulfonyl, (C₁-C₆)-alkylsulfonyl, (C₃-C₆)-cycloalkylsulfonyl, arylsulfonyl, (C₁-C₆)-alkylsulfinyl, (C₃-C₆)-cycloalkylsulfinyl, arylsulfinyl, N,S-di-(C₁-C₆)-alkylsulfonimidoyl, S—(C₁-C₆)-alkylsulfonimidoyl, (C₁-C₆)-alkylsulfonylaminocarbonyl, (C₃-C₆)-cycloalkylsulfonylaminocarbonyl, (C₃-C₆)-cycloalkylaminosulfonyl, aryl-(C₁-C₆)-alkylcarbonylamino, (C₃-C₆)-cycloalkyl-(C₁-C₆)-alkylcarbonylamino, heteroarylcarbonylamino, (C₁-C₆)-alkoxy-(C₁-C₆)-alkylcarbonylamino, hydroxy-(C₁-C₆)-alkylcarbonylamino,
R¹ is H, nitro, amino, cyano, halogen, (C₁-C₆)-alkyl, (C₃-C₆)-cycloalkyl, (C₂-C₆)-alkenyl, (C₂-C₆)-alkynyl, aryl, aryl-(C₁-C₆)-alkyl, heteroaryl, (C₁-C₆)-alkoxy-(C₁-C₆)-alkyl, (C₁-C₆)-halo alkyl, (C₃-C₆)-halocycloalkyl, (C₁-C₆)-alkoxy, (C₁-C₆)-haloalkoxy, (C₁-C₆)-alkylthio , (C₁-C₆)-halo alkylthio , (C₁-C₆)-alkoxycarbonyl, hydroxycarbonyl, aminocarbonyl, (C₁-C₆)-alkylaminocarbonyl, (C₁-C₆)-alkylamino, bis-(C₁-C₆)-alkylamino, (C₃-C₆)-cycloalkylamino, (C₁-C₆)-alkylcarbonylamino, (C₃-C₆)-cycloalkylcarbonylamino, formylamino, (C₁-C₆)-haloalkylcarbonylamino, (C₁-C₆)-alkoxycarbonylamino , [(C₁-C₆)-alkyl-]aminocarbonyl-amino, sulfonylamino, (C₁-C₆)-alkylsulfonylamino, (C₁-C₆)-haloalkylsulfonylamino, (C₃-C₆)-cycloalkylsulfonylamino, amino-(C₁-C₆)-alkylsulfonyl, amino-(C₁-C₆)-haloalkylsulfonyl, (C₁-C₆)-alkylsulfonyl, (C₃-C₆)-cycloalkylsulfonyl, arylsulfonyl, (C₁-C₆)-alkylsulfinyl, (C₃-C₆)-cycloalkylsulfinyl, arylsulfinyl, N,S-di-(C₁-C₆)-alkylsulfonimidoyl, S—(C₁-C₆)-alkylsulfonimidoyl, (C₁-C₆)-alkylsulfonylamino carbonyl, (C₃-C₆)-cycloalkylsulfonylaminocarbonyl, (C₃-C₆)-cycloalkylaminosulfonyl, amino-(C₁-C₆)-alkyl, amino-(C₂-C₆)-alkenyl, (C₂-C₆)-alkenylamino, (C₂-C₆)-alkenylimino,
R² is H, nitro, amino, cyano, halogen, (C₁-C₆)-alkyl, (C₃-C₆)-cycloalkyl, (C₂-C₆)-alkenyl, (C₂-C₆)-alkynyl, aryl, aryl-(C₁-C₆)-alkyl, heteroaryl, (C₁-C₆)-alkoxy-(C₁-C₆)-alkyl, (C₁-C₆)-halo alkyl, (C₃-C₆)-halocycloalkyl, (C₁-C₆)-alkoxy, (C₁-C₆)-haloalkoxy, (C₁-C₆)-alkylthio , (C₁-C₆)-halo alkylthio , (C₁-C₆)-alkoxycarbonyl, hydroxycarbonyl, aminocarbonyl, (C₁-C₆)-alkylaminocarbonyl, (C₁-C₆)-alkylamino, bis-(C₁-C₆)-alkylamino, (C₃-C₆)-cycloalkylamino, (C₁-C₆)-alkylcarbonylamino, (C₃-C₆)-cycloalkylcarbonylamino, formylamino, (C₁-C₆)-haloalkylcarbonylamino, (C₁-C₆)-alkoxycarbonylamino, [(C₁-C₆)-alkyl-]-aminocarbonyl-amino , sulfonylamino, (C₁-C₆)-alkylsulfonylamino, (C₁-C₆)-haloalkylsulfonylamino, (C₃-C₆)-cycloalkylsulfonylamino, amino-(C₁-C₆)-alkylsulfonyl, amino-(C₁-C₆)-haloalkylsulfonyl, (C₁-C₆)-alkylsulfonyl, (C₃-C₆)-cycloalkylsulfonyl, arylsulfonyl, (C₁-C₆)-alkylsulfinyl, (C₃-C₆)-cycloalkylsulfinyl, arylsulfinyl, N,S-di-(C₁-C₆)-alkylsulfonimidoyl, S—(C₁-C₆)-alkylsulfonimidoyl, (C₁-C₆)-alkylsulfonylamino carbonyl, (C₃-C₆)-cycloalkylsulfonylaminocarbonyl, (C₃-C₆)-cycloalkylaminosulfonyl, amino-(C₁-C₆)-alkyl, amino-(C₂-C₆)-alkenyl, (C₂-C₆)-alkenylamino, (C₂-C₆)-alkenylimino,
R¹ and R² with the atoms to which they are attached form a fully saturated, partially saturated or fully unsaturated, 5- to 7-membered ring optionally interrupted by heteroatoms and optionally with further substitution by W, and where, in the case of compounds of the general formula (I), they must form a corresponding ring with the moieties Q-21 and Q-23.
R¹ and A³, if A³ is a C—W group, with the atoms to which they are attached form a fully saturated, partially saturated or fully unsaturated, 5- to 7-membered ring optionally interrupted by heteroatoms and optionally with further substitution,
X is a direct bond or is a (CHR³)ₙ moiety, and where R³ in the (CHR³)ₙ moiety in each case has the same or different meanings according to the definition below,
n is 0, 1,
R³ is H, (C₁-C₆)-alkyl, (C₂-C₆)-alkenyl-(C₁-C₆)-alkyl, (C₁-C₆)-haloalkyl, (C₃-C₆)-cycloalkyl, (C₃-C₆)-cycloalkyl-(C₁-C₆)-alkyl, aryl-(C₁-C₆)-alkyl, heteroaryl-(C₁-C₆)-alkyl, (C₁-C₆)-alkoxy-(C₁-C₆)-alkyl, (C₁-C₆)-haloalkoxy-(C₁-C₆)-alkyl, (C₁-C₆)-alkylthio-(C₁-C₆)-alkyl, (C₁-C₆)-haloalkylthio-(C₁-C₆)-alkyl,
R⁴ is H, (C₁-C₆)-alkyl, (C₂-C₆)-alkenyl-(C₁-C₆)-alkyl, (C₂-C₆)-alkynyl, (C₁-C₆)-alkylcarbonyl, (C₃-C₆)-cycloalkylcarbonyl, arylcarbonyl, heteroarylcarbonyl, (C₁-C₆)-alkoxycarbonyl, aryl-(C₁-C₆)-alkoxycarbonyl, (C₃-C₆)-cycloalkoxycarbonyl, (C₃-C₆)-cycloalkyl-(C₁-C₆)-alkoxycarbonyl, (C₁-C₆)-alkylsulfonyl, (C₃-C₆)-cycloalkylsulfonyl, arylsulfonyl, (C₁-C₆)-alkoxycarbonylcarbonyl, aryl-(C₁-C₆)-alkoxycarbonylcarbonyl, (C₁-C₆)-alkylaminothiocarbonyl, (C₁-C₆)-alkylamino carbonyl, aryl-(C₁-C₆)-alkyl, heteroaryl-(C₁-C₆)-alkyl, cyano-(C₁-C₆)-alkyl, (C₁-C₆)-haloalkyl, (C₃-C₆)-cycloalkyl, (C₃-C₆)-cycloalkyl-(C₁-C₆)-alkyl, (C₁-C₆)-alkoxy-(C₁-C₆)-alkyl, (C₁-C₆)-haloalkoxy-(C₁-C₆)-alkyl, (C₂-C₆)-alkynyl-(C₁-C₆)-alkyl, (C₁-C₆)-alkoxycarbonyl-(C₁-C₆)-alkyl, aminocarbonyl-(C₁-C₆)-alkyl, (C₁-C₆)-alkylaminocarbonyl-(C₁-C₆)-alkyl, bis-(C₁-C₆)-alkylamino carbonyl-(C₁-C₆)-alkyl,
R⁵ is halogen, (C₂-C₆)-alkyl, (C₁-C₆)-alkoxy, (C₁-C₆)-alkoxycarbonyloxy, (C₂-C₆)-alkenyl, (C₂-C₆)-haloalkenyl, (C₂-C₆)-alkenyl-(C₁-C₆)-alkyl, (C₂-C₆)-alkynyl, (C₂-C₆)-alkynyl-(C₁-C₆)-alkyl, aryl-(C₁-C₆)-alkyl, bisaryl-(C₁-C₆)-alkyl, aryl-(C₁-C₆)-alkoxyaryl-(C₁-C₆)-alkyl, aryloxyaryl-(C₁-C₆)-alkyl, (C₁-C₆)-alkoxyaryl-(C₁-C₆)-alkyl, heteroaryl-(C₁-C₆)-alkyl, heterocyclyl-(C₁-C₆)-alkyl, N—(C₁-C₆)-alkylheterocyclyl-(C₁-C₆)-alkyl, N—[(C₁-C₆)-alkoxycarbonyl]heterocyclyl-(C₁-C₆)-alkyl, N-(aryl-(C₁-C₆)-alkoxycarbonyl)heterocyclyl-(C₁-C₆)-alkyl, N-(arylcarbonyl)heterocyclyl-(C₁-C₆)-alkyl, N—[(C₁-C₆)-alkylcarbonyl]heterocyclyl-(C₁-C₆)-alkyl, N—[(C₃-C₆)-cycloalkylcarbonyl]heterocyclyl-(C₁-C₆)-alkyl, cyano-(C₁-C₆)-alkyl, (C₁-C₆)-haloalkyl, (C₃-C₆)-cycloalkyl, (C₃-C₆)-halocycloalkyl, (C₄-C₆)-cycloalkenyl, (C₃-C₆)-cycloalkyl-(C₁-C₆)-alkyl, (C₃-C₆)-cycloalkenyl-(C₁-C₆)-alkyl, hydroxy-(C₁-C₆)-alkyl, (C₁-C₆)-alkoxy-(C₁-C₆)-alkyl, (C₁-C₆)-haloalkoxy-(C₁-C₆)-alkyl, aryloxy-(C₁-C₆)-alkyl, aryl-(C₁-C₆)-alkoxy-(C₁-C₆)-alkyl, heteroaryl-(C₁-C₆)-alkoxy-(C₁-C₆)-alkyl, (C₃-C₆)-cycloalkoxy-(C₁-C₆)-alkyl, (C₃-C₆)-cycloalkyl-(C₁-C₆)-alkoxy-(C₁-C₆)-alkyl, (C₁-C₆)-alkylcarbonyloxy-(C₁-C₆)-alkyl, arylcarbonyloxy-(C₁-C₆)-alkyl, heteroarylcarbonyloxy-(C₁-C₆)-alkyl, —(C₃-C₆)-cycloalkylcarbonyloxy-(C₁-C₆)-alkyl, arylsulfonyloxy-(C₁-C₆)-alkyl, (C₁-C₆)-alkylsulfonyloxy-(C₁-C₆)-alkyl, hydrothio-(C₁-C₆)-alkyl, (C₁-C₆)-alkylthio-(C₁-C₆)-alkyl, (C₁-C₆)-haloalkylthio-(C₁-C₆)-alkyl, aryl-(C₁-C₆)-alkylthio-(C₁-C₆)-alkyl, (C₃-C₆)-cycloalkylthio-(C₁-C₆)-alkyl, arylthio-(C₁-C₆)-alkyl, (C₁-C₆)-alkylsulfinyl-(C₁-C₆)-alkyl, (C₁-C₆)-alkylsulfonyl-(C₁-C₈)-alkyl, (C₁-C₆)-haloalkylsulfinyl-(C₁-C₆)-alkyl, (C₁-C₆)-haloalkylsulfonyl-(C₁-C₆)-alkyl, aryl-(C₁-C₆)-alkylsulfinyl-(C₁-C₆)-alkyl, aryl-(C₁-C₆)-alkylsulfonyl-(C₁-C₆)-alkyl, (C₃-C₆)-cycloalkylsulfinyl-(C₁-C₆)-alkyl, (C₃-C₆)-cycloalkylsulfonyl-(C₁-C₆)-alkyl, aryl, heteroaryl, heterocyclyl, N—[(C₁-C₆)-alkyl]heterocyclyl, N—[(C₁-C₆)-alkoxycarbonyl]heterocyclyl, N—[aryl-(C₁-C₆)-alkoxycarbonyl]heterocyclyl, N-(arylcarbonyl)heterocyclyl, N—[(C₁-C₆)-alkylcarbonyl]heterocyclyl, N—[(C₁-C₆)-cycloalkylcarbonyl]heterocyclyl, hydroxycarbonyl, (C₁-C₆)-alkoxycarbonyl, (C₃-C₆)-cycloalkoxycarbonyl, (C₃-C₆)-cycloalkyl-(C₁-C₆)-alkoxycarbonyl, aryl-(C₁-C₆)-alkoxycarbonyl, heteroaryl-(C₁-C₆)-alkoxycarbonyl, (C₁-C₆)-alkylaminocarbonyl, aminocarbonyl, bis-(C₁-C₆)-alkylaminocarbonyl, (C₃-C₆)-cycloalkylaminocarbonyl, aryl-(C₁-C₆)-alkylaminocarbonyl, heteroarylaminocarbonyl, cyano-(C₁-C₆)-alkylaminocarbonyl, (C₁-C₆)-haloalkylaminocarbonyl, (C₂-C₆)-alkynyl-(C₁-C₆)-alkylamino carbonyl, hydroxycarbonyl-(C₁-C₆)-alkyl, (C₁-C₆)-alkoxycarbonyl-(C₁-C₆)-alkyl, (C₃-C₆)-cycloalkoxycarbonyl-(C₁-C₆)-alkyl, (C₃-C₆)-cyclo alkyl-(C₁-C₆)-alkoxycarbonyl-(C₁-C₆)-alkyl , aryl-(C₁-C₆)-alkoxycarbonyl-(C₁-C₆)-alkyl, heteroaryl-(C₁-C₆)-alkoxycarbonyl-(C₁-C₆)-alkyl, (C₁-C₆)-alkylaminocarbonyl-(C₁-C₆)-alkyl, amino carbonyl-(C₁-C₆)-alkyl, bis-(C₁-C₆)-alkylaminocarbonyl-(C₁-C₆)-alkyl, (C₃-C₆)-cycloalkylaminocarbonyl-(C₁-C₆)-alkyl, aryl-(C₁-C₆)-alkylaminocarbonyl-(C₁-C₆)-alkyl, heteroarylaminocarbonyl-(C₁-C₆)-alkyl, cyano-(C₁-C₆)-alkylaminocarbonyl-(C₁-C₆)-alkyl, (C₁-C₆)-haloalkylaminocarbonyl-(C₁-C₆)-alkyl, (C₂-C₈)-alkynyl-(C₁-C₈)-alkylaminocarbonyl-(C₁-C₈)-alkyl, amino-(C₁-C₆)-alkyl, (C₁-C₆)-alkylamino-(C₁-C₆)-alkyl, (C₂-C₆)-alkenylamino-(C₁-C₆)-alkyl, arylamino-(C₁-C₆)-alkyl, bis-(C₁-C₆)-alkylamino-(C₁-C₆)-alkyl, bis-(C₃-C₆)-cycloalkylamino-(C₁-C₆)-alkyl, aryl-(C₁-C₆)-alkylamino-(C₁-C₆)-alkyl, tris-aryl-(C₁-C₆)-alkylamino-(C₁-C₆)-alkyl, (C₃-C₆)-cyclo alkylamino-(C₁-C₆)-alkyl, (C₃-C₆)-cycloalkyl-(C₁-C₆)-alkylamino-(C₁-C₆)-alkyl, (C₁-C₆)-haloalkylamino-(C₁-C₆)-alkyl, (C₁-C₆)-alkylcarbonylamino-(C₁-C₆)-alkyl, (C₁-C₆)-cyclo alkylcarbonylamino-(C₁-C₆)-alkyl, arylcarbonylamino-(C₁-C₆)-alkyl, heteroarylcarbonylamino-(C₁-C₆)-alkyl, (C₁-C₆)-alkoxycarbonylamino-(C₁-C₆)-alkyl, (C₂-C₆)-alkenyloxycarbonylamino-(C₁-C₆)-alkyl, aryl-(C₁-C₆)-alkoxycarbonylamino-(C₁-C₆)-alkyl, aryl-(C₁-C₆)-alkoxycarbonyl [N—(C₁-C₆)-alkyl]amino-(C₁-C₆)-alkyl, heteroaryl-(C₁-C₆)-alkoxycarbonylamino-(C₁-C₆)-alkyl, (C₃-C₆)-cycloalkyl-(C₁-C₆)-alkoxycarbonylamino-(C₁-C₆)-alkyl, (C₃-C₆)-cycloalkoxycarbonylamino-(C₁-C₆)-alkyl, amino carbonylamino-(C₁-C₆)-alkyl , arylsulfonylamino-(C₁-C₆)-alkyl, heteroarylsulfonylamino-(C₁-C₆)-alkyl, (C₁-C₆)-alkylsulfonylamino-(C₁-C₆)-alkyl, (C₃-C₆)-cycloalkylsulfonylamino-(C₁-C₆)-alkyl, aminoiminoamino-(C₁-C₆)-alkyl, arylsulfonylaminoiminoamino-(C₁-C₆)-alkyl, (C₁-C₆)-alkylaminoiminoamino-(C₁-C₆)-alkyl,
R⁷ is hydrogen, halogen, (C₁-C₆)-alkyl, (C₁-C₆)-alkoxy, (C₁-C₆)-alkoxycarbonyloxy, (C₂-C₆)-alkenyl, (C₂-C₆)-haloalkenyl, (C₂-C₆)-alkenyl-(C₁-C₆)-alkyl, (C₂-C₆)-alkynyl, (C₂-C₆)-alkynyl-(C₁-C₆)-alkyl, aryl-(C₁-C₆)-alkyl, bisaryl-(C₁-C₆)-alkyl, aryl-(C₁-C₆)-alkoxyaryl-(C₁-C₆)-alkyl, aryloxyaryl-(C₁-C₆)-alkyl, (C₁-C₆)-alkoxyaryl-(C₁-C₆)-alkyl, heteroaryl-(C₁-C₆)-alkyl, heterocyclyl-(C₁-C₆)-alkyl, N—(C₁-C₆)-alkylheterocyclyl-(C₁-C₆)-alkyl, N—[(C₁-C₆)-alkoxycarbonyl]heterocyclyl-(C₁-C₆)-alkyl, N-(aryl-(C₁-C₆)-alkoxycarbonyl)heterocyclyl-(C₁-C₆)-alkyl, N-(arylcarbonyl)heterocyclyl-(C₁-C₆)-alkyl, N—[(C₁-C₆)-alkylcarbonyl]heterocyclyl-(C₁-C₆)-alkyl, N—[(C₃-C₆)-cycloalkylcarbonyl]heterocyclyl-(C₁-C₆)-alkyl, cyano-(C₁-C₆)-alkyl, (C₁-C₆)-haloalkyl, (C₃-C₆)-cycloalkyl, (C₃-C₆)-halocycloalkyl, (C₄-C₆)-cycloalkenyl, (C₃-C₆)-cyclo alkyl-(C₁-C₆)-alkyl, (C₃-C₆)-cycloalkenyl-(C₁-C₆)-alkyl, hydroxy-(C₁-C₆)-alkyl, (C₁-C₆)-alkoxy-(C₁-C₆)-alkyl, (C₁-C₆)-haloalkoxy-(C₁-C₆)-alkyl, aryloxy-(C₁-C₆)-alkyl, aryl-(C₁-C₆)-alkoxy-(C₁-C₆)-alkyl, hetero aryl-(C₁-C₆)-alkoxy-(C₁-C₆)-alkyl, (C₃-C₆)-cycloalkoxy-(C₁-C₆)-alkyl, (C₃-C₆)-cyclo alkyl-(C₁-C₆)-alkoxy-(C₁-C₆)-alkyl, (C₁-C₆)-alkylcarbonyloxy-(C₁-C₆)-alkyl, arylcarbonyloxy-(C₁-C₆)-alkyl, heteroarylcarbonyloxy-(C₁-C₆)-alkyl, (C₃-C₆)-cyclo alkylcarbonyloxy-(C₁-C₈)-alkyl, arylsulfonyloxy-(C₁-C₆)-alkyl, (C₁-C₆)-alkylsulfonyloxy-(C₁-C₆)-alkyl, hydrothio-(C₁-C₆)-alkyl, (C₁-C₆)-alkylthio-(C₁-C₆)-alkyl, (C₁-C₆)-haloalkylthio-(C₁-C₆)-alkyl, aryl-(C₁-C₆)-alkylthio-(C₁-C₆)-alkyl, (C₃-C₆)-cyclo alkylthio-(C₁-C₆)-alkyl, arylthio-(C₁-C₆)-alkyl, (C₁-C₆)-alkylsulfinyl-(C₁-C₆)-alkyl, (C₁-C₆)-alkylsulfonyl-(C₁-C₆)-alkyl, (C₁-C₆)-haloalkylsulfinyl-(C₁-C₆)-alkyl, (C₁-C₆)-haloalkylsulfonyl-(C₁-C₆)-alkyl, aryl-(C₁-C₆)-alkylsulfinyl-(C₁-C₆)-alkyl, aryl-(C₁-C₆)-alkylsulfonyl-(C₁-C₆)-alkyl, (C₃-C₆)-cyclo alkylsulfinyl-(C₁-C₆)-alkyl, (C₃-C₆)-cyclo alkylsulfonyl-(C₁-C₆)-alkyl, aryl, heteroaryl, heterocyclyl, N—[(C₁-C₆)-alkyl]heterocyclyl, N—[(C₁-C₆)-alkoxycarbonyl]heterocyclyl, N-[aryl-(C₁-C₆)-alkoxycarbonyl]heterocyclyl, N-(arylcarbonyl)heterocyclyl, N—[(C₁-C₆)-alkylcarbonyl]heterocyclyl, N—[(C₁-C₆)-cycloalkylcarbonyl]heterocyclyl, hydroxycarbonyl, (C₁-C₆)-alkoxycarbonyl, (C₃-C₆)-cycloalkoxycarbonyl, (C₃-C₆)-cyclo alkyl-(C₁-C₆)-alkoxycarbonyl, aryl-(C₁-C₆)-alkoxycarbonyl, heteroaryl-(C₁-C₆)-alkoxycarbonyl, (C₁-C₆)-alkylaminocarbonyl, aminocarbonyl, bis-(C₁-C₆)-alkylaminocarbonyl, (C₃-C₆)-cycloalkylaminocarbonyl, aryl-(C₁-C₆)-alkylaminocarbonyl, heteroarylaminocarbonyl, cyano-(C₁-C₆)-alkylaminocarbonyl, (C₁-C₆)-haloalkylaminocarbonyl, (C₂-C₆)-alkynyl-(C₁-C₆)-alkylaminocarbonyl, hydroxycarbonyl-(C₁-C₆)-alkyl, (C₁-C₆)-alkoxycarbonyl-(C₁-C₆)-alkyl, (C₃-C₆)-cyclo alkoxycarbonyl-(C₁-C₆)-alkyl, (C₃-C₆)-cycloalkyl-(C₁-C₆)-alkoxycarbonyl-(C₁-C₆)-alkyl, aryl-(C₁-C₆)-alkoxycarbonyl-(C₁-C₆)-alkyl, hetero aryl-(C₁-C₆)-alkoxycarbonyl-(C₁-C₆)-alkyl, (C₁-C₆)-alkylamino carbonyl-(C₁-C₆)-alkyl , aminocarbonyl-(C₁-C₆)-alkyl, bis-(C₁-C₆)-alkylamino carbonyl-(C₁-C₆)-alkyl , (C₃-C₆)-cycloalkylaminocarbonyl-(C₁-C₆)-alkyl, aryl-(C₁-C₆)-alkylaminocarbonyl-(C₁-C₆)-alkyl, hetero arylamino carbonyl-(C₁-C₆)-alkyl , cyano-(C₁-C₆)-alkylaminocarbonyl-(C₁-C₆)-alkyl, (C₁-C₆)-haloalkylaminocarbonyl-(C₁-C₆)-alkyl, (C₂-C₆)-alkynyl-(C₁-C₆)-alkylaminocarbonyl-(C₁-C₆)-alkyl, amino-(C₁-C₆)-alkyl, (C₁-C₆)-alkylamino-(C₁-C₆)-alkyl, (C₂-C₆)-alkenylamino-(C₁-C₆)-alkyl, arylamino-(C₁-C₆)-alkyl, bis-(C₁-C₆)-alkylamino-(C₁-C₆)-alkyl, bis-(C₃-C₆)-cycloalkylamino-(C₁-C₆)-alkyl, aryl-(C₁-C₆)-alkylamino-(C₁-C₆)-alkyl, tris-aryl-(C₁-C₆)-alkylamino-(C₁-C₆)-alkyl, (C₃-C₆)-cyclo alkylamino-(C₁-C₆)-alkyl, (C₃-C₆)-cycloalkyl-(C₁-C₆)-alkylamino-(C₁-C₆)-alkyl, (C₁-C₆)-haloalkylamino-(C₁-C₆)-alkyl, (C₁-C₆)-alkylcarbonylamino-(C₁-C₆)-alkyl, (C₁-C₆)-cyclo alkylcarbonylamino-(C₁-C₆)-alkyl, arylcarbonylamino-(C₁-C₆)-alkyl, heteroarylcarbonylamino-(C₁-C₆)-alkyl, (C₁-C₆)-alkoxycarbonylamino-(C₁-C₆)-alkyl, (C₂-C₆)-alkenyloxycarbonylamino-(C₁-C₆)-alkyl, aryl-(C₁-C₆)-alkoxycarbonylamino-(C₁-C₆)-alkyl, aryl-(C₁-C₆)-alkoxycarbonyl [N—(C₁-C₆)-alkyl]amino-(C₁-C₆)-alkyl, heteroaryl-(C₁-C₆)-alkoxycarbonylamino-(C₁-C₆)-alkyl, (C₃-C₆)-cycloalkyl-(C₁-C₆)-alkoxycarbonylamino-(C₁-C₆)-alkyl, (C₃-C₆)-cycloalkoxycarbonylamino-(C₁-C₆)-alkyl, amino carbonylamino-(C₁-C₆)-alkyl , arylsulfonylamino-(C₁-C₆)-alkyl, heteroarylsulfonylamino-(C₁-C₆)-alkyl, (C₁-C₆)-alkylsulfonylamino-(C₁-C₆)-alkyl, (C₃-C₆)-cycloalkylsulfonylamino-(C₁-C₆)-alkyl, aminoiminoamino-(C₁-C₆)-alkyl, arylsulfonylaminoiminoamino-(C₁-C₆)-alkyl, (C₁-C₆)-alkylaminoiminoamino-(C₁-C₆)-alkyl,
R⁶ and R⁸ independently of one another are H, (C₁-C₆)-alkyl, (C₂-C₆)-alkenyl-(C₁-C₆)-alkyl, (C₂-C₆)-alkynyl-(C₁-C₆)-alkyl, aryl-(C₁-C₆)-alkyl, (C₃-C₆)-cycloalkyl, (C₃-C₆)-cycloalkyl-(C₁-C₆)-alkyl, heterocyclyl, heterocyclyl-(C₁-C₆)-alkyl, amino-(C₁-C₆)-alkyl, (C₁-C₆)-alkoxy-(C₁-C₆)-alkyl, (C₁-C₆)-alkylthio-(C₁-C₆)-alkyl, (C₁-C₆)-haloalkyl, (C₁-C₆)-alkylamino-(C₁-C₆)-alkyl, bis-(C₁-C₆)-alkylamino-(C₁-C₆)-alkyl, (C₁-C₆)-alkylcarbonylamino-(C₁-C₆)-alkyl, (C₃-C₆)-cycloalkylcarbonylamino-(C₁-C₆)-alkyl, arylcarbonylamino-(C₁-C₆)-alkyl, (C₁-C₆)-alkoxycarbonylamino-(C₁-C₆)-alkyl, aryl-(C₁-C₆)-alkoxycarbonylamino-(C₁-C₆)-alkyl, (C₃-C₆)-cycloalkyl-(C₁-C₆)-alkoxycarbonylamino-(C₁-C₆)-alkyl, aminocarbonylamino-(C₁-C₆)-alkyl, aminoiminoamino-(C₁-C₆)-alkyl, arylsulfonylaminoiminoamino-(C₁-C₆)-alkyl, (C₁-C₆)-alkylaminoiminoamino-(C₁-C₆)-alkyl,
R⁴¹ is H, (C₁-C₆)-alkyl, (C₂-C₆)-alkenyl-(C₁-C₆)-alkyl, (C₂-C₆)-alkynyl, (C₁-C₆)-alkylcarbonyl, (C₃-C₆)-cycloalkylcarbonyl, arylcarbonyl, heteroarylcarbonyl, (C₁-C₆)-alkoxycarbonyl, aryl-(C₁-C₆)-alkoxycarbonyl, (C₃-C₆)-cycloalkoxycarbonyl, (C₃-C₆)-cycloalkyl-(C₁-C₆)-alkoxycarbonyl, (C₁-C₆)-alkylsulfonyl, (C₃-C₆)-cycloalkylsulfonyl, arylsulfonyl, (C₁-C₆)-alkoxycarbonylcarbonyl, aryl-(C₁-C₆)-alkoxycarbonylcarbonyl, (C₁-C₆)-alkylaminothiocarbonyl, (C₁-C₆)-alkylamino carbonyl, aryl-(C₁-C₆)-alkyl, heteroaryl-(C₁-C₆)-alkyl, cyano-(C₁-C₆)-alkyl, (C₁-C₆)-haloalkyl, (C₃-C₆)-cycloalkyl, (C₃-C₆)-cycloalkyl-(C₁-C₆)-alkyl, (C₁-C₆)-alkoxy-(C₁-C₆)-alkyl, (C₁-C₆)-haloalkoxy-(C₁-C₆)-alkyl, (C₂-C₆)-alkynyl-(C₁-C₆)-alkyl, (C₁-C₆)-alkoxycarbonyl-(C₁-C₆)-alkyl, aminocarbonyl-(C₁-C₆)-alkyl, (C₁-C₆)-alkylaminocarbonyl-(C₁-C₆)-alkyl, bis-(C₁-C₆)-alkylaminocarbonyl-(C₁-C₆)-alkyl,
in the case of the grouping Q-21 is exclusively H or methyl,
R⁴² is (C₂-C₆)-alkyl, (C₂-C₆)-alkenyl-(C₁-C₆)-alkyl, (C₂-C₆)-alkynyl, (C₁-C₆)-alkylcarbonyl, (C₃-C₆)-cycloalkylcarbonyl, arylcarbonyl, heteroarylcarbonyl, (C₁-C₆)-alkoxycarbonyl, aryl-(C₁-C₆)-alkoxycarbonyl, (C₃-C₆)-cycloalkoxycarbonyl, (C₃-C₆)-cycloalkyl-(C₁-C₆)-alkoxycarbonyl, (C₁-C₆)-alkylsulfonyl, (C₃-C₆)-cycloalkylsulfonyl, arylsulfonyl, (C₁-C₆)-alkoxycarbonylcarbonyl, aryl-(C₁-C₆)-alkoxycarbonylcarbonyl, (C₁-C₆)-alkylaminothiocarbonyl, (C₁-C₆)-alkylamino carbonyl, aryl-(C₁-C₆)-alkyl, heteroaryl-(C₁-C₆)-alkyl, cyano-(C₁-C₆)-alkyl, (C₁-C₆)-haloalkyl, (C₃-C₆)-cycloalkyl, (C₃-C₆)-cycloalkyl-(C₁-C₆)-alkyl, (C₁-C₆)-alkoxy-(C₁-C₆)-alkyl, (C₁-C₆)-haloalkoxy-(C₁-C₆)-alkyl, (C₂-C₆)-alkynyl-(C₁-C₆)-alkyl, (C₁-C₆)-alkoxycarbonyl-(C₁-C₆)-alkyl, amino carbonyl-(C₁-C₆)-alkyl, (C₁-C₆)-alkylaminocarbonyl-(C₁-C₆)-alkyl, bis-(C₁-C₆)-alkylamino carbonyl-(C₁-C₆)-alkyl,
R⁴³ is H or methyl,
R⁴⁴ is hydrogen, (C₁-C₆)-alkyl, (C₂-C₆)-alkenyl-(C₁-C₆)-alkyl, (C₂-C₆)-alkynyl, (C₁-C₆)-alkylcarbonyl, (C₃-C₆)-cycloalkylcarbonyl, arylcarbonyl, heteroarylcarbonyl, (C₁-C₆)-alkoxycarbonyl, aryl-(C₁-C₆)-alkoxycarbonyl, (C₃-C₆)-cycloalkoxycarbonyl, (C₃-C₆)-cycloalkyl-(C₁-C₆)-alkoxycarbonyl, (C₁-C₆)-alkylsulfonyl, (C₃-C₆)-cycloalkylsulfonyl, arylsulfonyl, (C₁-C₆)-alkoxycarbonylcarbonyl, aryl-(C₁-C₆)-alkoxycarbonylcarbonyl, (C₁-C₆)-alkylaminothiocarbonyl, (C₁-C₆)-alkylamino carbonyl, aryl-(C₁-C₆)-alkyl, heteroaryl-(C₁-C₆)-alkyl, cyano-(C₁-C₆)-alkyl, (C₁-C₆)-haloalkyl, (C₃-C₆)-cycloalkyl, (C₃-C₆)-cycloalkyl-(C₁-C₆)-alkyl, (C₁-C₆)-alkoxy-(C₁-C₆)-alkyl, (C₁-C₆)-haloalkoxy-(C₁-C₆)-alkyl, (C₂-C₆)-alkynyl-(C₁-C₆)-alkyl, (C₁-C₆)-alkoxycarbonyl-(C₁-C₆)-alkyl, aminocarbonyl-(C₁-C₆)-alkyl, (C₁-C₆)-alkylaminocarbonyl-(C₁-C₆)-alkyl, bis-(C₁-C₆)-alkylaminocarbonyl-(C₁-C₆)-alkyl,
R⁵¹ and R⁷¹ independently of one another are hydrogen and methyl,
R⁵³ is methyl,
R⁶¹ and R⁸¹ independently of one another are hydrogen and methyl,
R⁶³ is H, methyl,
R⁵⁴, R⁶⁴, R⁷⁴, R⁸⁴ independently of one another are hydrogen, methyl, where at least one of the groups R⁵⁴, R⁶⁴, R⁷⁴, R⁸⁴ must be methyl,
V is hydroxycarbonyl, (C₁-C₆)-alkoxycarbonyl, (C₃-C₆)-cycloalkoxycarbonyl, (C₃-C₆)-cycloalkyl-(C₁-C₆)-alkoxycarbonyl, aryloxycarbonyl, Aryl-(C₁-C₆)-alkoxycarbonyl, aminocarbonyl, (C₁-C₆)-alkylamino carbonyl, bis-(C₁-C₆)-alkylamino carbonyl, (C₁-C₆)-alkyl-[(C₁-C₆)-alkoxy]amino carbonyl, (C₃-C₆)-cycloalkylaminocarbonyl, aryl-(C₁-C₆)-alkylaminocarbonyl, heteroaryl-(C₁-C₆)-alkylamino carbonyl, cyano-(C₁-C₆)-alkylaminocarbonyl, (C₁-C₆)-haloalkylaminocarbonyl, (C₂-C₆)-alkynyl-(C₁-C₆)-alkylaminocarbonyl, (C₁-C₆)-alkoxycarbonyl-(C₁-C₆)-alkylamino carbonyl, hydroxycarbonyl-(C₁-C₆)-alkylamino carbonyl, aminocarbonyl-(C₁-C₆)-alkylaminocarbonyl, (C₁-C₆)-alkylaminocarbonyl-(C₁-C₆)-alkylaminocarbonyl, (C₃-C₆)-cycloalkylaminocarbonyl-(C₁-C₆)-alkylaminocarbonyl, (C₃-C₆)-cycloalkyl-(C₁-C₆)-alkylamino carbonyl,
m is 0, 1, 2, 3, 4, 5,
p is 1, 2, 3, 4,
Y is cyano, cyano-(C₁-C₆)-alkyl, hydroxy-(C₁-C₆)-alkyl, (C₁-C₆)-alkoxy-(C₁-C₆)-alkyl, hydroxycarbonyl, (C₁-C₆)-alkoxycarbonyl, (C₃-C₆)-cycloalkoxycarbonyl, (C₃-C₆)-cycloalkyl-(C₁-C₆)-alkoxycarbonyl, aryloxycarbonyl, aryl-(C₁-C₆)-alkoxycarbonyl, aminocarbonyl, (C₁-C₆)-alkylaminocarbonyl, bis-(C₁-C₆)-alkylamino carbonyl, (C₁-C₆)-alkyl [(C₁-C₆)-alkoxy]amino carbonyl, (C₃-C₆)-cycloalkylaminocarbonyl, aryl-(C₁-C₆)-alkylaminocarbonyl, heteroaryl-(C₁-C₆)-alkylaminocarbonyl, cyano-(C₁-C₆)-alkylaminocarbonyl, (C₁-C₆)-haloalkylaminocarbonyl, (C₂-C₆)-alkynyl-(C₁-C₆)-alkylamino carbonyl, (C₁-C₆)-alkoxycarbonylaminocarbonyl, aryl-(C₁-C₆)-alkoxycarbonylamino carbonyl, hydroxycarbonyl-(C₁-C₆)-alkyl, (C₁-C₆)-alkoxycarbonyl-(C₁-C₆)-alkyl, (C₃-C₆)-cycloalkoxycarbonyl-(C₁-C₆)-alkyl, (C₃-C₆)-cycloalkyl-(C₁-C₆)-alkoxycarbonyl-(C₁-C₆)-alkyl, (C₁-C₆)-alkylamino carbonyl-(C₁-C₆)-alkyl, aminocarbonyl-(C₁-C₆)-alkyl, bis-(C₁-C₆)-alkylamino carbonyl-(C₁-C₆)-alkyl, (C₃-C₆)-cycloalkylaminocarbonyl-(C₁-C₆)-alkyl, aryl-(C₁-C₆)-alkylaminocarbonyl-(C₁-C₆)-alkyl, heteroaryl-(C₁-C₆)-alkylamino carbonyl-(C₁-C₆)-alkyl, cyano-(C₁-C₆)-alkylaminocarbonyl-(C₁-C₆)-alkyl, (C₁-C₆)-haloalkylaminocarbonyl-(C₁-C₆)-alkyl, (C₂-C₆)-alkynyl-(C₁-C₆)-alkylaminocarbonyl-(C₁-C₆)-alkyl, (C₃-C₆)-cycloalkyl-(C₁-C₆)-alkylaminocarbonyl-(C₁-C₆)-alkyl, (C₁-C₆)-alkoxycarbonylamino carbonyl-(C₁-C₆)-alkyl, aryl-(C₁-C₆)-alkoxycarbonylamino carbonyl-(C₁-C₆)-alkyl, (C₁-C₆)-alkoxycarbonyl-(C₁-C₆)-alkylaminocarbonyl, hydroxycarbonyl-(C₁-C₆)-alkylamino carbonyl, aminocarbonyl-(C₁-C₆)-alkylamino carbonyl, (C₁-C₆)-alkylaminocarbonyl-(C₁-C₆)-alkylaminocarbonyl, (C₃-C₆)-cycloalkylaminocarbonyl-(C₁-C₆)-alkylamino carbonyl, (C₃-C₆)-cycloalkyl-(C₁-C₆)-alkylamino carbonyl, (C₃-C₆)-cycloalkyl-(C₁-C₆)-alkylaminocarbonyl-(C₁-C₆)-alkyl, (C₂-C₆)-alkenyloxycarbonyl, (C₂-C₆)-alkenyloxycarbonyl-(C₁-C₆)-alkyl, (C₂-C₆)-alkenylaminocarbonyl, (C₂-C₆)-alkenyl-(C₁-C₆)-alkylaminocarbonyl, (C₂-C₆)-alkenylaminocarbonyl-(C₁-C₆)-alkyl, (C₂-C₆)-alkenyl-(C₁-C₆)-alkylaminocarbonyl-(C₁-C₆)-alkyl.

3. The compound of the formula (I) or salt thereof capable of being used as claimed in claim 1, where
Q is at least one of 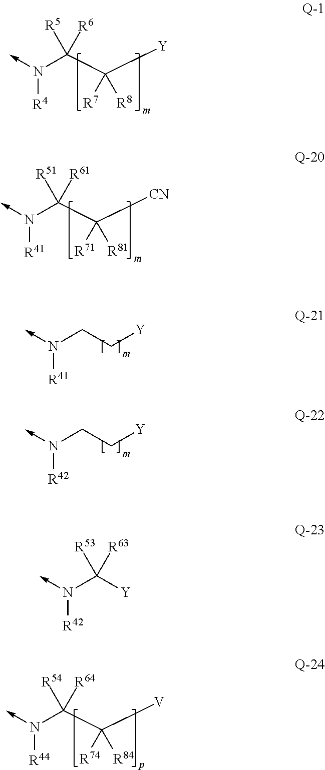
and where the radicals R⁴ to R⁸, and R⁴¹ to R⁸⁴ and also Y and m and p in each case have the meaning according to the definitions below and where the arrow is a bond to the sulfur atom of the SO₂ group,
A¹, A², A³ are the same or different and independently of one another are N nitrogen and/or a C—W moiety, but there are never more than two adjacent nitrogen atoms, and where W in the C—W moiety in each case has the same or different meanings according to the definition below,
W is in each case hydrogen, nitro, amino, cyano, thiocyanato, isothiocyanato, halogen, (C₁-C₄)-alkyl, (C₃-C₆)-cycloalkyl, (C₂-C₄)-alkenyl, (C₂-C₄)-alkynyl, aryl, aryl-(C₁-C₄)-alkyl, aryl-(C₁-C₄)-alkoxy, heteroaryl, (C₁-C₄)-alkoxy-(C₁-C₄)-alkyl, (C₁-C₄)-haloalkyl, (C₃-C₅)-halocycloalkyl, (C₁-C₄)-alkoxy, (C₁-C₄)-haloalkoxy, aryloxy, heteroaryloxy, (C₃-C₆)-cycloalkyloxy, (C₃-C₆)-cycloalkyl-(C₁-C₄)-alkoxy, (C₁-C₄)-alkoxycarbonyl, (C₁-C₄)-alkoxycarbonyl-(C₁-C₄)-alkyl, hydroxycarbonyl, aminocarbonyl, (C₁-C₄)-alkylaminocarbonyl, (C₃-C₆)-cycloalkylaminocarbonyl, cyano-(C₁-C₄)-alkylaminocarbonyl, (C₂-C₄)-alkenylaminocarbonyl, (C₂-C₄)-alkynylamino carbonyl, (C₁-C₄)-alkylamino, (C₁-C₄)-alkylthio, (C₁-C₄)-halo alkylthio , bis-(C₁-C₄)-alkylamino , (C₃-C₆)-cycloalkylamino, (C₁-C₄)-alkylcarbonylamino, (C₃-C₆)-cycloalkylcarbonylamino, formylamino, (C₁-C₄)-haloalkylcarbonylamino, (C₁-C₄)-alkoxycarbonylamino, (C₁-C₄)-alkylaminocarbonylamino, bis-[(C₁-C₄)-alkyl]-aminocarbonyl-amino, (C₁-C₄)-alkylsulfonylamino , (C₃-C₆)-cycloalkylsulfonylamino, arylsulfonylamino, Hetarylsulfonylamino, sulfonyl-(C₁-C₄)-haloalkylamino, amino-(C₁-C₄)-alkylsulfonyl, amino-(C₁-C₄)-haloalkylsulfonyl, (C₁-C₄)-alkylsulfonyl, (C₃-C₆)-cycloalkylsulfonyl, arylsulfonyl, (C₁-C₄)-alkylsulfinyl, (C₃-C₆)-cycloalkylsulfinyl, arylsulfinyl, N,S-di-(C₁-C₄)-alkylsulfonimidoyl, S—(C₁-C₄)-alkylsulfonimidoyl, (C₁-C₄)-alkylsulfonylaminocarbonyl, (C₃-C₆)-cycloalkylsulfonylaminocarbonyl, (C₃-C₆)-cycloalkylaminosulfonyl, aryl-(C₁-C₄)-alkylcarbonylamino, (C₃-C₆)-cycloalkyl-(C₁-C₄)-alkylcarbonylamino, heteroarylcarbonylamino, (C₁-C₄)-alkoxy-(C₁-C₄)-alkylcarbonylamino, hydroxy-(C₁-C₄)-alkylcarbonylamino,
R¹ is H, nitro, amino, cyano, halogen, (C₁-C₄)-alkyl, (C₃-C₆)-cycloalkyl, (C₂-C₄)-alkenyl, (C₂-C₄)-alkynyl, aryl, aryl-(C₁-C₄)-alkyl, heteroaryl, (C₁-C₄)-alkoxy-(C₁-C₄)-alkyl, (C₁-C₄)-halo alkyl, (C₃-C₆)-halocycloalkyl, (C₁-C₄)-alkoxy, (C₁-C₄)-haloalkoxy, (C₁-C₄)-alkylthio , (C₁-C₄)-halo alkylthio , (C₁-C₄)-alkoxycarbonyl, hydroxycarbonyl, aminocarbonyl, (C₁-C₄)-alkylaminocarbonyl, (C₁-C₄)-alkylamino, bis-(C₁-C₄)-alkylamino, (C₃-C₆)-cycloalkylamino, (C₁-C₄)-alkylcarbonylamino, (C₃-C₆)-cycloalkylcarbonylamino, formylamino, (C₁-C₄)-haloalkylcarbonylamino, (C₁-C₄)-alkoxycarbonylamino , [(C₁-C₄)-alkyl-]aminocarbonyl-amino, sulfonylamino, (C₁-C₄)-alkylsulfonylamino, (C₁-C₄)-haloalkylsulfonylamino, (C₃-C₆)-cycloalkylsulfonylamino, amino-(C₁-C₄)-alkylsulfonyl, amino-(C₁-C₄)-haloalkylsulfonyl, (C₁-C₄)-alkylsulfonyl, (C₃-C₆)-cycloalkylsulfonyl, arylsulfonyl, (C₁-C₄)-alkylsulfinyl, (C₃-C₆)-cycloalkylsulfinyl, arylsulfinyl, N,S-di-(C₁-C₄)-alkylsulfonimidoyl, S—(C₁-C₄)-alkylsulfonimidoyl, (C₁-C₄)-alkylsulfonylamino carbonyl, (C₃-C₆)-cycloalkylsulfonylaminocarbonyl, (C₃-C₆)-cycloalkylaminosulfonyl, amino-(C₁-C₄)-alkyl, amino-(C₂-C₄)-alkenyl, (C₂-C₄)-alkenylamino, (C₂-C₄)-alkenylimino,
R² is H, nitro, amino, cyano, halogen, (C₁-C₄)-alkyl, (C₃-C₆)-cycloalkyl, (C₂-C₄)-alkenyl, (C₂-C₄)-alkynyl, aryl, aryl-(C₁-C₄)-alkyl, heteroaryl, (C₁-C₄)-alkoxy-(C₁-C₄)-alkyl, (C₁-C₄)-halo alkyl, (C₃-C₆)-halocycloalkyl, (C₁-C₄)-alkoxy, (C₁-C₄)-haloalkoxy, (C₁-C₄)-alkylthio , (C₁-C₄)-halo alkylthio , (C₁-C₄)-alkoxycarbonyl, hydroxycarbonyl, aminocarbonyl, (C₁-C₄)-alkylaminocarbonyl, (C₁-C₄)-alkylamino, bis-(C₁-C₄)-alkylamino, (C₃-C₆)-cycloalkylamino, (C₁-C₄)-alkylcarbonylamino, (C₃-C₆)-cycloalkylcarbonylamino, formylamino, (C₁-C₄)-haloalkylcarbonylamino, (C₁-C₄)-alkoxycarbonylamino, [(C₁-C₄)-alkyl-]-aminocarbonyl-amino , sulfonylamino, (C₁-C₄)-alkylsulfonylamino , (C₁-C₄)-haloalkylsulfonylamino, (C₃-C₆)-cycloalkylsulfonylamino, amino-(C₁-C₄)-alkylsulfonyl, amino-(C₁-C₄)-haloalkylsulfonyl, (C₁-C₄)-alkylsulfonyl, (C₃-C₆)-cycloalkylsulfonyl, arylsulfonyl, (C₁-C₄)-alkylsulfinyl, (C₃-C₆)-cycloalkylsulfinyl, arylsulfinyl, N,S-di-(C₁-C₄)-alkylsulfonimidoyl, S—(C₁-C₄)-alkylsulfonimidoyl, (C₁-C₄)-alkylsulfonylamino carbonyl, (C₃-C₆)-cycloalkylsulfonylaminocarbonyl, (C₃-C₆)-cycloalkylaminosulfonyl, amino-(C₁-C₄)-alkyl, amino-(C₂-C₄)-alkenyl, (C₂-C₄)-alkenylamino, (C₂-C₄)-alkenylimino,
R¹ and R² with the atoms to which they are attached form a fully saturated, partially saturated or fully unsaturated, 5- to 7-membered ring optionally interrupted by heteroatoms and optionally with further substitution by W, and where, in the case of compounds of the general formula (I), they must form a corresponding ring with the moieties Q-21 and Q-23.
R¹ and A³, if A³ is a C—W group, with the atoms to which they are attached form a fully saturated, partially saturated or fully unsaturated, 5- to 7-membered ring optionally interrupted by heteroatoms and optionally with further substitution,
X is a direct bond or is a (CHR³)ₙ moiety, and where R³ in the (CHR³)ₙ moiety in each case has the same or different meanings according to the definition below,
n is 0, 1,
R³ is H, (C₁-C₄)-alkyl, (C₂-C₄)-alkenyl-(C₁-C₄)-alkyl, (C₁-C₄)-haloalkyl, (C₃-C₆)-cycloalkyl, (C₃-C₆)-cycloalkyl-(C₁-C₄)-alkyl, aryl-(C₁-C₄)-alkyl, heteroaryl-(C₁-C₄)-alkyl, (C₁-C₄)-alkoxy-(C₁-C₄)-alkyl, (C₁-C₄)-haloalkoxy-(C₁-C₄)-alkyl, (C₁-C₄)-alkylthio-(C₁-C₄)-alkyl, (C₁-C₄)-haloalkylthio-(C₁-C₄)-alkyl,
R⁴ is H, (C₁-C₄)-alkyl, (C₂-C₄)-alkenyl-(C₁-C₄)-alkyl, (C₂-C₄)-alkynyl, (C₁-C₄)-alkylcarbonyl, (C₃-C₆)-cycloalkylcarbonyl, arylcarbonyl, heteroarylcarbonyl, (C₁-C₄)-alkoxycarbonyl, aryl-(C₁-C₄)-alkoxycarbonyl, (C₃-C₆)-cycloalkoxycarbonyl, (C₃-C₆)-cycloalkyl-(C₁-C₄)-alkoxycarbonyl, (C₁-C₄)-alkylsulfonyl, (C₃-C₆)-cycloalkylsulfonyl, arylsulfonyl, (C₁-C₄)-alkoxycarbonylcarbonyl, aryl-(C₁-C₄)-alkoxycarbonylcarbonyl, (C₁-C₄)-alkylaminothiocarbonyl, (C₁-C₄)-alkylamino carbonyl, aryl-(C₁-C₄)-alkyl, heteroaryl-(C₁-C₄)-alkyl, cyano-(C₁-C₄)-alkyl, (C₁-C₄)-haloalkyl, (C₃-C₆)-cycloalkyl, (C₃-C₆)-cycloalkyl-(C₁-C₄)-alkyl, (C₁-C₄)-alkoxy-(C₁-C₄)-alkyl, (C₁-C₄)-haloalkoxy-(C₁-C₄)-alkyl, (C₂-C₄)-alkynyl-(C₁-C₄)-alkyl, (C₁-C₄)-alkoxycarbonyl-(C₁-C₄)-alkyl, aminocarbonyl-(C₁-C₄)-alkyl, (C₁-C₄)-alkylaminocarbonyl-(C₁-C₄)-alkyl, bis-(C₁-C₄)-alkylaminocarbonyl-(C₁-C₄)-alkyl,
R⁵ is halogen, (C₂-C₄)-alkyl, (C₁-C₄)-alkoxy, (C₁-C₄)-alkoxycarbonyloxy, (C₂-C₄)-alkenyl, (C₂-C₄)-haloalkenyl, (C₂-C₄)-alkenyl-(C₁-C₄)-alkyl, (C₂-C₄)-alkynyl, (C₂-C₄)-alkynyl-(C₁-C₄)-alkyl, aryl-(C₁-C₄)-alkyl, bisaryl-(C₁-C₄)-alkyl, aryl-(C₁-C₄)-alkoxyaryl-(C₁-C₄)-alkyl, aryloxyaryl-(C₁-C₄)-alkyl, (C₁-C₄)-alkoxyaryl-(C₁-C₄)-alkyl, heteroaryl-(C₁-C₄)-alkyl, heterocyclyl-(C₁-C₄)-alkyl, N—(C₁-C₄)-alkylheterocyclyl-(C₁-C₄)-alkyl, N—[(C₁-C₄)-alkoxycarbonyl]heterocyclyl-(C₁-C₄)-alkyl, N-(aryl-(C₁-C₄)-alkoxycarbonyl)heterocyclyl-(C₁-C₄)-alkyl, N-(arylcarbonyl)heterocyclyl-(C₁-C₄)-alkyl, N—[(C₁-C₄)-alkylcarbonyl]heterocyclyl-(C₁-C₄)-alkyl, N—[(C₃-C₆)-cycloalkylcarbonyl]heterocyclyl-(C₁-C₄)-alkyl, cyano-(C₁-C₄)-alkyl, (C₁-C₄)-haloalkyl, (C₃-C₆)-cyclo alkyl, (C₃-C₆)-halocycloalkyl, (C₄-C₆)-cyclo alkenyl, (C₃-C₆)-cyclo alkyl-(C₁-C₄)-alkyl, (C₃-C₆)-cycloalkenyl-(C₁-C₄)-alkyl, hydroxy-(C₁-C₄)-alkyl, (C₁-C₄)-alkoxy-(C₁-C₄)-alkyl, (C₁-C₄)-haloalkoxy-(C₁-C₄)-alkyl, aryloxy-(C₁-C₄)-alkyl, aryl-(C₁-C₄)-alkoxy-(C₁-C₄)-alkyl, heteroaryl-(C₁-C₄)-alkoxy-(C₁-C₄)-alkyl, (C₃-C₆)-cyclo alkoxy-(C₁-C₄)-alkyl, (C₃-C₆)-cycloalkyl-(C₁-C₄)-alkoxy-(C₁-C₄)-alkyl, (C₁-C₄)-alkylcarbonyloxy-(C₁-C₄)-alkyl, arylcarbonyloxy-(C₁-C₄)-alkyl, heteroarylcarbonyloxy-(C₁-C₄)-alkyl, (C₃-C₆)-cycloalkylcarbonyloxy-(C₁-C₄)-alkyl, arylsulfonyloxy-(C₁-C₄)-alkyl, (C₁-C₄)-alkylsulfonyloxy-(C₁-C₄)-alkyl, hydrothio-(C₁-C₄)-alkyl, (C₁-C₄)-alkylthio-(C₁-C₄)-alkyl, (C₁-C₄)-haloalkylthio-(C₁-C₄)-alkyl, aryl-(C₁-C₄)-alkylthio-(C₁-C₄)-alkyl, (C₃-C₆)-cyclo alkylthio-(C₁-C₄)-alkyl, arylthio-(C₁-C₄)-alkyl, (C₁-C₄)-alkylsulfinyl-(C₁-C₄)-alkyl, (C₁-C₄)-alkylsulfonyl-(C₁-C₄)-alkyl, (C₁-C₄)-haloalkylsulfinyl-(C₁-C₄)-alkyl, (C₁-C₄)-haloalkylsulfonyl-(C₁-C₄)-alkyl, aryl-(C₁-C₄)-alkylsulfinyl-(C₁-C₄)-alkyl, aryl-(C₁-C₄)-alkylsulfonyl-(C₁-C₄)-alkyl, (C₃-C₆)-cyclo alkylsulfinyl-(C₁-C₄)-alkyl, (C₃-C₆)-cycloalkylsulfonyl-(C₁-C₄)-alkyl, aryl, heteroaryl, heterocyclyl, N—[(C₁-C₄)-alkyl]heterocyclyl, N—[(C₁-C₄)-alkoxycarbonyl]heterocyclyl, N—[aryl-(C₁-C₄)-alkoxycarbonyl]heterocyclyl, N-(arylcarbonyl)heterocyclyl, N—[(C₁-C₄)-alkylcarbonyl]heterocyclyl, N—[(C₁-C₄)-cycloalkylcarbonyl]heterocyclyl, hydroxycarbonyl, (C₁-C₄)-alkoxycarbonyl, (C₃-C₆)-cycloalkoxycarbonyl, (C₃-C₆)-cycloalkyl-(C₁-C₄)-alkoxycarbonyl, aryl-(C₁-C₄)-alkoxycarbonyl, heteroaryl-(C₁-C₄)-alkoxycarbonyl, (C₁-C₄)-alkylamino carbonyl, aminocarbonyl, bis-(C₁-C₄)-alkylaminocarbonyl, (C₃-C₆)-cycloalkylamino carbonyl, aryl-(C₁-C₄)-alkylaminocarbonyl, heteroarylaminocarbonyl, cyano-(C₁-C₄)-alkylamino carbonyl, (C₁-C₄)-halo alkylamino carbonyl, (C₂-C₄)-alkynyl-(C₁-C₄)-alkylamino carbonyl, hydroxycarbonyl-(C₁-C₄)-alkyl, (C₁-C₄)-alkoxycarbonyl-(C₁-C₄)-alkyl, (C₃-C₆)-cycloalkoxycarbonyl-(C₁-C₄)-alkyl, (C₃-C₆)-cycloalkyl-(C₁-C₄)-alkoxycarbonyl-(C₁-C₄)-alkyl, aryl-(C₁-C₄)-alkoxycarbonyl-(C₁-C₄)-alkyl, heteroaryl-(C₁-C₄)-alkoxycarbonyl-(C₁-C₄)-alkyl, (C₁-C₄)-alkylaminocarbonyl-(C₁-C₄)-alkyl, amino carbonyl-(C₁-C₄)-alkyl, bis-(C₁-C₄)-alkylaminocarbonyl-(C₁-C₄)-alkyl, (C₃-C₆)-cyclo alkylamino carbonyl-(C₁-C₄)-alkyl, aryl-(C₁-C₄)-alkylaminocarbonyl-(C₁-C₄)-alkyl, heteroarylaminocarbonyl-(C₁-C₄)-alkyl, cyano-(C₁-C₄)-alkylamino carbonyl-(C₁-C₄)-alkyl, (C₁-C₄)-haloalkylaminocarbonyl-(C₁-C₄)-alkyl, (C₂-C₄)-alyinyl-(C₁-C₄)-alkylaminocarbonyl-(C₁-C₄)-alkyl, amino-(C₁-C₄)-alkyl, (C₁-C₄)-alkylamino-(C₁-C₄)-alkyl, (C₂-C₄)-alkenylamino-(C₁-C₄)-alkyl, arylamino-(C₁-C₄)-alkyl, bis-(C₁-C₄)-alkylamino-(C₁-C₄)-alkyl, bis-(C₃-C₆)-cycloalkylamino-(C₁-C₄)-alkyl, aryl-(C₁-C₄)-alkylamino-(C₁-C₄)-alkyl, tris-aryl-(C₁-C₄)-alkylamino-(C₁-C₄)-alkyl, (C₃-C₆)-cycloalkylamino-(C₁-C₄)-alkyl, (C₃-C₆)-cycloalkyl-(C₁-C₄)-alkylamino-(C₁-C₄)-alkyl, (C₁-C₄)-halo alkylamino-(C₁-C₄)-alkyl, (C₁-C₄)-alkylcarbonylamino-(C₁-C₄)-alkyl, (C₁-C₄)-cyclo alkylcarbonylamino-(C₁-C₄)-alkyl, arylcarbonylamino-(C₁-C₄)-alkyl, heteroarylcarbonylamino-(C₁-C₄)-alkyl, (C₁-C₄)-alkoxycarbonylamino-(C₁-C₄)-alkyl, (C₂-C₄)-alkenyloxycarbonylamino-(C₁-C₄)-alkyl, aryl-(C₁-C₄)-alkoxycarbonylamino-(C₁-C₄)-alkyl, aryl-(C₁-C₄)-alkoxycarbonyl[N—(C₁-C₄)-alkyl]amino-(C₁-C₄)-alkyl, heteroaryl-(C₁-C₄)-alkoxycarbonylamino-(C₁-C₄)-alkyl, (C₃-C₆)-cycloalkyl-(C₁-C₄)-alkoxycarbonylamino-(C₁-C₄)-alkyl, (C₃-C₆)-cycloalkoxycarbonylamino-(C₁-C₄)-alkyl, aminocarbonylamino-(C₁-C₄)-alkyl, arylsulfonylamino-(C₁-C₄)-alkyl, heteroarylsulfonylamino-(C₁-C₄)-alkyl, (C₁-C₄)-alkylsulfonylamino-(C₁-C₄)-alkyl, (C₃-C₆)-cycloalkylsulfonylamino-(C₁-C₄)-alkyl, aminoiminoamino-(C₁-C₄)-alkyl, arylsulfonylaminoiminoamino-(C₁-C₄)-alkyl, (C₁-C₄)-alkylaminoiminoamino-(C₁-C₄)-alkyl,
R⁷ is hydrogen, halogen, (C₁-C₄)-alkyl, (C₁-C₄)-alkoxy, (C₁-C₄)-alkoxycarbonyloxy, (C₂-C₄)-alkenyl, (C₂-C₄)-haloalkenyl, (C₂-C₄)-alkenyl-(C₁-C₄)-alkyl, (C₂-C₄)-alkynyl, (C₂-C₄)-alkynyl-(C₁-C₄)-alkyl, aryl-(C₁-C₄)-alkyl, bisaryl-(C₁-C₄)-alkyl, aryl-(C₁-C₄)-alkoxyaryl-(C₁-C₄)-alkyl, aryloxyaryl-(C₁-C₄)-alkyl, (C₁-C₄)-alkoxyaryl-(C₁-C₄)-alkyl, heteroaryl-(C₁-C₄)-alkyl, heterocyclyl-(C₁-C₄)-alkyl, N—(C₁-C₄)-alkylheterocyclyl-(C₁-C₄)-alkyl, N—[(C₁-C₄)-alkoxycarbonyl]heterocyclyl-(C₁-C₄)-alkyl, N-(aryl-(C₁-C₄)-alkoxycarbonyl)heterocyclyl-(C₁-C₄)-alkyl, N-(arylcarbonyl)heterocyclyl-(C₁-C₄)-alkyl, N—[(C₁-C₄)-alkylcarbonyl]heterocyclyl-(C₁-C₄)-alkyl, N—[(C₃-C₆)-cycloalkylcarbonyl]heterocyclyl-(C₁-C₄)-alkyl, cyano-(C₁-C₄)-alkyl, (C₁-C₄)-haloalkyl, (C₃-C₆)-cycloalkyl, (C₃-C₆)-halocycloalkyl, (C₄-C₆)-cycloalkenyl, (C₃-C₆)-cycloalkyl-(C₁-C₄)-alkyl, (C₃-C₆)-cycloalkenyl-(C₁-C₄)-alkyl, hydroxy-(C₁-C₄)-alkyl, (C₁-C₄)-alkoxy-(C₁-C₄)-alkyl, (C₁-C₄)-halo alkoxy-(C₁-C₄)-alkyl, aryloxy-(C₁-C₄)-alkyl, aryl-(C₁-C₄)-alkoxy-(C₁-C₄)-alkyl, heteroaryl-(C₁-C₄)-alkoxy-(C₁-C₄)-alkyl, (C₃-C₆)-cycloalkoxy-(C₁-C₄)-alkyl, (C₃-C₆)-cyclo alkyl-(C₁-C₄)-alkoxy-(C₁-C₄)-alkyl, (C₁-C₄)-alkylcarbonyloxy-(C₁-C₄)-alkyl, arylcarbonyloxy-(C₁-C₄)-alkyl, heteroarylcarbonyloxy-(C₁-C₄)-alkyl, (C₃-C₆)-cycloalkylcarbonyloxy-(C₁-C₄)-alkyl, arylsulfonyloxy-(C₁-C₄)-alkyl, (C₁-C₄)-alkylsulfonyloxy-(C₁-C₄)-alkyl, hydrothio-(C₁-C₄)-alkyl, (C₁-C₄)-alkylthio-(C₁-C₄)-alkyl, (C₁-C₄)-haloalkylthio-(C₁-C₄)-alkyl, aryl-(C₁-C₄)-alkylthio-(C₁-C₄)-alkyl, (C₃-C₆)-cycloalkylthio-(C₁-C₄)-alkyl, arylthio-(C₁-C₄)-alkyl, (C₁-C₄)-alkylsulfinyl-(C₁-C₄)-alkyl, (C₁-C₄)-alkylsulfonyl-(C₁-C₄)-alkyl, (C₁-C₄)-haloalkylsulfinyl-(C₁-C₄)-alkyl, (C₁-C₄)-haloalkylsulfonyl-(C₁-C₄)-alkyl, aryl-(C₁-C₄)-alkylsulfinyl-(C₁-C₄)-alkyl, aryl-(C₁-C₄)-alkylsulfonyl-(C₁-C₄)-alkyl, (C₃-C₆)-cycloalkylsulfinyl-(C₁-C₄)-alkyl, (C₃-C₆)-cycloalkylsulfonyl-(C₁-C₄)-alkyl, aryl, heteroaryl, heterocyclyl, N—[(C₁-C₄)-alkyl]heterocyclyl, N—[(C₁-C₄)-alkoxycarbonyl]heterocyclyl, N-[aryl-(C₁-C₄)-alkoxycarbonyl]heterocyclyl, N-(arylcarbonyl)heterocyclyl, N—[(C₁-C₄)-alkylcarbonyl]heterocyclyl, N—[(C₁-C₄)-cycloalkylcarbonyl]heterocyclyl, hydroxycarbonyl, (C₁-C₄)-alkoxycarbonyl, (C₃-C₆)-cycloalkoxycarbonyl, (C₃-C₆)-cycloalkyl-(C₁-C₄)-alkoxycarbonyl, aryl-(C₁-C₄)-alkoxycarbonyl, heteroaryl-(C₁-C₄)-alkoxycarbonyl, (C₁-C₄)-alkylaminocarbonyl, aminocarbonyl, bis-(C₁-C₄)-alkylaminocarbonyl, (C₃-C₆)-cycloalkylaminocarbonyl, aryl-(C₁-C₄)-alkylaminocarbonyl, heteroarylaminocarbonyl, cyano-(C₁-C₄)-alkylaminocarbonyl, (C₁-C₄)-haloalkylaminocarbonyl, (C₂-C₄)-alkynyl-(C₁-C₄)-alkylaminocarbonyl, hydroxycarbonyl-(C₁-C₄)-alkyl, (C₁-C₄)-alkoxycarbonyl-(C₁-C₄)-alkyl, (C₃-C₆)-cyclo alkoxycarbonyl-(C₁-C₄)-alkyl, (C₃-C₆)-cycloalkyl-(C₁-C₄)-alkoxycarbonyl-(C₁-C₄)-alkyl, aryl-(C₁-C₄)-alkoxycarbonyl-(C₁-C₄)-alkyl, heteroaryl-(C₁-C₄)-alkoxycarbonyl-(C₁-C₄)-alkyl, (C₁-C₄)-alkylamino carbonyl-(C₁-C₄)-alkyl , aminocarbonyl-(C₁-C₄)-alkyl, bis-(C₁-C₄)-alkylamino carbonyl-(C₁-C₄)-alkyl , (C₃-C₆)-cycloalkylaminocarbonyl-(C₁-C₄)-alkyl, aryl-(C₁-C₄)-alkylaminocarbonyl-(C₁-C₄)-alkyl, hetero arylamino carbonyl-(C₁-C₄)-alkyl , cyano-(C₁-C₄)-alkylaminocarbonyl-(C₁-C₄)-alkyl, (C₁-C₄)-haloalkylaminocarbonyl-(C₁-C₄)-alkyl, (C₂-C₄)-alkynyl-(C₁-C₄)-alkylaminocarbonyl-(C₁-C₄)-alkyl, amino-(C₁-C₄)-alkyl, (C₁-C₄)-alkylamino-(C₁-C₄)-alkyl, (C₂-C₄)-alkenylamino-(C₁-C₄)-alkyl, arylamino-(C₁-C₄)-alkyl, bis-(C₁-C₄)-alkylamino-(C₁-C₄)-alkyl, bis-(C₃-C₆)-cycloalkylamino-(C₁-C₄)-alkyl, aryl-(C₁-C₄)-alkylamino-(C₁-C₄)-alkyl, tris-aryl-(C₁-C₄)-alkylamino-(C₁-C₄)-alkyl, (C₃-C₆)-cycloalkylamino-(C₁-C₄)-alkyl, (C₃-C₆)-cycloalkyl-(C₁-C₄)-alkylamino-(C₁-C₄)-alkyl, (C₁-C₄)-halo alkylamino-(C₁-C₄)-alkyl, (C₁-C₄)-alkylcarbonylamino-(C₁-C₄)-alkyl, (C₁-C₄)-cyclo alkylcarbonylamino-(C₁-C₄)-alkyl, arylcarbonylamino-(C₁-C₄)-alkyl, heteroarylcarbonylamino-(C₁-C₄)-alkyl, (C₁-C₄)-alkoxycarbonylamino-(C₁-C₄)-alkyl, (C₂-C₄)-alkenyloxycarbonylamino-(C₁-C₄)-alkyl, aryl-(C₁-C₄)-alkoxycarbonylamino-(C₁-C₄)-alkyl, aryl-(C₁-C₄)-alkoxycarbonyl[N—(C₁-C₄)-alkyl]amino-(C₁-C₄)-alkyl, heteroaryl-(C₁-C₄)-alkoxycarbonylamino-(C₁-C₄)-alkyl, (C₃-C₆)-cycloalkyl-(C₁-C₄)-alkoxycarbonylamino-(C₁-C₄)-alkyl, (C₃-C₆)-cycloalkoxycarbonylamino-(C₁-C₄)-alkyl, aminocarbonylamino-(C₁-C₄)-alkyl, arylsulfonylamino-(C₁-C₄)-alkyl, heteroarylsulfonylamino-(C₁-C₄)-alkyl, (C₁-C₄)-alkylsulfonylamino-(C₁-C₄)-alkyl, (C₃-C₆)-cycloalkylsulfonylamino-(C₁-C₄)-alkyl, aminoiminoamino-(C₁-C₄)-alkyl, arylsulfonylaminoiminoamino-(C₁-C₄)-alkyl, (C₁-C₄)-alkylaminoiminoamino-(C₁-C₄)-alkyl,
R⁶ and R⁸ independently of one another are H, (C₁-C₄)-alkyl, (C₂-C₄)-alkenyl-(C₁-C₄)-alkyl, (C₂-C₄)-alkynyl-(C₁-C₄)-alkyl, aryl-(C₁-C₄)-alkyl, (C₃-C₆)-cycloalkyl, (C₃-C₆)-cycloalkyl-(C₁-C₄)-alkyl, heterocyclyl, heterocyclyl-(C₁-C₄)-alkyl, amino-(C₁-C₄)-alkyl, (C₁-C₄)-alkoxy-(C₁-C₄)-alkyl, (C₁-C₄)-alkylthio-(C₁-C₄)-alkyl, (C₁-C₄)-halo alkyl, (C₁-C₄)-alkylamino-(C₁-C₄)-alkyl, bis-(C₁-C₄)-alkylamino-(C₁-C₄)-alkyl, (C₁-C₄)-alkylcarbonylamino-(C₁-C₄)-alkyl, (C₃-C₆)-cycloalkylcarbonylamino-(C₁-C₄)-alkyl, arylcarbonylamino-(C₁-C₄)-alkyl, (C₁-C₄)-alkoxycarbonylamino-(C₁-C₆)-alkyl, aryl-(C₁-C₄)-alkoxycarbonylamino-(C₁-C₄)-alkyl, (C₃-C₆)-cycloalkyl-(C₁-C₄)-alkoxycarbonylamino-(C₁-C₄)-alkyl, aminocarbonylamino-(C₁-C₄)-alkyl, aminoiminoamino-(C₁-C₄)-alkyl, arylsulfonylaminoiminoamino-(C₁-C₄)-alkyl, (C₁-C₄)-alkylaminoiminoamino-(C₁-C₄)-alkyl,
R⁴¹ is H, (C₁-C₄)-alkyl, (C₂-C₄)-alkenyl-(C₁-C₄)-alkyl, (C₂-C₄)-alkynyl, (C₁-C₄)-alkylcarbonyl, (C₃-C₆)-cycloalkylcarbonyl, arylcarbonyl, heteroarylcarbonyl, (C₁-C₄)-alkoxycarbonyl, aryl-(C₁-C₄)-alkoxycarbonyl, (C₃-C₆)-cycloalkoxycarbonyl, (C₃-C₆)-cycloalkyl-(C₁-C₄)-alkoxycarbonyl, (C₁-C₄)-alkylsulfonyl, (C₃-C₆)-cycloalkylsulfonyl, arylsulfonyl, (C₁-C₄)-alkoxycarbonylcarbonyl, aryl-(C₁-C₄)-alkoxycarbonylcarbonyl, (C₁-C₄)-alkylaminothiocarbonyl, (C₁-C₄)-alkylamino carbonyl, aryl-(C₁-C₄)-alkyl, heteroaryl-(C₁-C₄)-alkyl, cyano-(C₁-C₄)-alkyl, (C₁-C₄)-haloalkyl, (C₃-C₆)-cycloalkyl, (C₃-C₆)-cycloalkyl-(C₁-C₄)-alkyl, (C₁-C₄)-alkoxy-(C₁-C₄)-alkyl, (C₁-C₄)-haloalkoxy-(C₁-C₄)-alkyl, (C₂-C₄)-alkynyl-(C₁-C₄)-alkyl, (C₁-C₄)-alkoxycarbonyl-(C₁-C₄)-alkyl, amino carbonyl-(C₁-C₄)-alkyl, (C₁-C₄)-alkylaminocarbonyl-(C₁-C₄)-alkyl, bis-(C₁-C₄)-alkylamino carbonyl-(C₁-C₄)-alkyl,
in the case of the grouping Q-21 is exclusively H or methyl,
R⁴² is (C₂-C₄)-alkyl, (C₂-C₄)-alkenyl-(C₁-C₄)-alkyl, (C₂-C₄)-alkynyl, (C₁-C₄)-alkylcarbonyl, (C₃-C₆)-cycloalkylcarbonyl, arylcarbonyl, heteroarylcarbonyl, (C₁-C₄)-alkoxycarbonyl, aryl-(C₁-C₄)-alkoxycarbonyl, (C₃-C₆)-cycloalkoxycarbonyl, (C₃-C₆)-cycloalkyl-(C₁-C₄)-alkoxycarbonyl, (C₁-C₄)-alkylsulfonyl, (C₃-C₆)-cycloalkylsulfonyl, arylsulfonyl, (C₁-C₄)-alkoxycarbonylcarbonyl, aryl-(C₁-C₄)-alkoxycarbonylcarbonyl, (C₁-C₄)-alkylaminothiocarbonyl, (C₁-C₄)-alkylamino carbonyl, aryl-(C₁-C₄)-alkyl, heteroaryl-(C₁-C₄)-alkyl, cyano-(C₁-C₄)-alkyl, (C₁-C₄)-haloalkyl, (C₃-C₆)-cycloalkyl, (C₃-C₆)-cycloalkyl-(C₁-C₄)-alkyl, (C₁-C₄)-alkoxy-(C₁-C₄)-alkyl, (C₁-C₄)-haloalkoxy-(C₁-C₄)-alkyl, (C₂-C₄)-alkynyl-(C₁-C₄)-alkyl, (C₁-C₄)-alkoxycarbonyl-(C₁-C₄)-alkyl, amino carbonyl-(C₁-C₄)-alkyl, (C₁-C₄)-alkylaminocarbonyl-(C₁-C₄)-alkyl, bis-(C₁-C₄)-alkylamino carbonyl-(C₁-C₄)-alkyl,
R⁴³ is H or methyl,
R⁴⁴ is hydrogen, (C₁-C₄)-alkyl, (C₂-C₄)-alkenyl-(C₁-C₄)-alkyl, (C₂-C₄)-alkynyl, (C₁-C₄)-alkylcarbonyl, (C₃-C₆)-cycloalkylcarbonyl, arylcarbonyl, heteroarylcarbonyl, (C₁-C₄)-alkoxycarbonyl, aryl-(C₁-C₄)-alkoxycarbonyl, (C₃-C₆)-cycloalkoxycarbonyl, (C₃-C₆)-cyclo alkyl-(C₁-C₄)-alkoxycarbonyl, (C₁-C₄)-alkylsulfonyl, (C₃-C₆)-cycloalkylsulfonyl, arylsulfonyl, (C₁-C₄)-alkoxycarbonylcarbonyl, aryl-(C₁-C₄)-alkoxycarbonylcarbonyl, (C₁-C₄)-alkylaminothiocarbonyl, (C₁-C₄)-alkylamino carbonyl, aryl-(C₁-C₄)-alkyl, heteroaryl-(C₁-C₄)-alkyl, cyano-(C₁-C₄)-alkyl, (C₁-C₄)-haloalkyl, (C₃-C₆)-cycloalkyl, (C₃-C₆)-cycloalkyl-(C₁-C₄)-alkyl, (C₁-C₄)-alkoxy-(C₁-C₄)-alkyl, (C₁-C₄)-haloalkoxy-(C₁-C₄)-alkyl, (C₂-C₄)-alkynyl-(C₁-C₄)-alkyl, (C₁-C₄)-alkoxycarbonyl-(C₁-C₄)-alkyl, amino carbonyl-(C₁-C₄)-alkyl, (C₁-C₄)-alkylaminocarbonyl-(C₁-C₄)-alkyl, bis-(C₁-C₄)-alkylamino carbonyl-(C₁-C₄)-alkyl,
R⁵¹ and R⁷¹ independently of one another are hydrogen and methyl,
R⁵³ is methyl,
R⁶¹ and R⁸¹ independently of one another are hydrogen,
R⁶³ is H, methyl,
R⁵⁴, R⁶⁴, R⁷⁴, R⁸⁴ independently of one another are hydrogen, methyl, where at least one of the groups R⁵⁴, R⁶⁴, R⁷⁴, R⁸⁴ must be methyl,
V is hydroxycarbonyl, (C₁-C₄)-alkoxycarbonyl, (C₃-C₆)-cycloalkoxycarbonyl, (C₃-C₆)-cycloalkyl-(C₁-C₄)-alkoxycarbonyl, aryloxycarbonyl, aryl-(C₁-C₄)-alkoxycarbonyl, aminocarbonyl, (C₁-C₄)-alkylaminocarbonyl, bis-(C₁-C₄)-alkylamino carbonyl, (C₁-C₄)-alkyl-[(C₁-C₄)-alkoxy]amino carbonyl, (C₃-C₆)-cycloalkylaminocarbonyl, aryl-(C₁-C₄)-alkylaminocarbonyl, heteroaryl-(C₁-C₄)-alkylaminocarbonyl, cyano-(C₁-C₄)-alkylaminocarbonyl, (C₁-C₄)-haloalkylaminocarbonyl, (C₂-C₄)-alkynyl-(C₁-C₄)-alkylamino carbonyl, (C₁-C₄)-alkoxycarbonyl-(C₁-C₄)-alkylamino carbonyl, hydroxycarbonyl-(C₁-C₄)-alkylamino carbonyl, aminocarbonyl-(C₁-C₄)-alkylaminocarbonyl, (C₁-C₄)-alkylaminocarbonyl-(C₁-C₄)-alkylaminocarbonyl, (C₃-C₆)-cycloalkylaminocarbonyl-(C₁-C₄)-alkylaminocarbonyl, (C₃-C₆)-cycloalkyl-(C₁-C₄)-alkylamino carbonyl,
m is 0, 1, 2, 3, 4, 5,
p is 1, 2, 3, 4,
Y is cyano, cyano-(C₁-C₄)-alkyl, hydroxy-(C₁-C₄)-alkyl, (C₁-C₄)-alkoxy-(C₁-C₄)-alkyl, hydroxycarbonyl, (C₁-C₄)-alkoxycarbonyl, (C₃-C₆)-cycloalkoxycarbonyl, (C₃-C₆)-cycloalkyl-(C₁-C₄)-alkoxycarbonyl, aryloxycarbonyl, aryl-(C₁-C₄)-alkoxycarbonyl, aminocarbonyl, (C₁-C₄)-alkylamino carbonyl, bis-(C₁-C₄)-alkylamino carbonyl, (C₁-C₄)-alkyl[(C₁-C₄)-alkoxy]amino carbonyl, (C₃-C₆)-cycloalkylaminocarbonyl, aryl-(C₁-C₄)-alkylaminocarbonyl, heteroaryl-(C₁-C₄)-alkylaminocarbonyl, cyano-(C₁-C₄)-alkylaminocarbonyl, (C₁-C₄)-haloalkylaminocarbonyl, (C₂-C₄)-alkynyl-(C₁-C₄)-alkylamino carbonyl, (C₁-C₄)-alkoxycarbonylaminocarbonyl, aryl-(C₁-C₄)-alkoxycarbonylamino carbonyl, hydroxycarbonyl-(C₁-C₄)-alkyl, (C₁-C₄)-alkoxycarbonyl-(C₁-C₄)-alkyl, (C₃-C₆)-cyclo alkoxycarbonyl-(C₁-C₄)-alkyl, (C₃-C₆)-cycloalkyl-(C₁-C₄)-alkoxycarbonyl-(C₁-C₄)-alkyl, (C₁-C₄)-alkylaminocarbonyl-(C₁-C₄)-alkyl, aminocarbonyl-(C₁-C₄)-alkyl, bis-(C₁-C₄)-alkylaminocarbonyl-(C₁-C₄)-alkyl, (C₃-C₆)-cycloalkylaminocarbonyl-(C₁-C₄)-alkyl, aryl-(C₁-C₄)-alkylaminocarbonyl-(C₁-C₄)-alkyl, heteroaryl-(C₁-C₄)-alkylaminocarbonyl-(C₁-C₄)-alkyl, cyano-(C₁-C₄)-alkylaminocarbonyl-(C₁-C₄)-alkyl, (C₁-C₄)-haloalkylaminocarbonyl-(C₁-C₄)-alkyl, (C₂-C₄)-alkynyl-(C₁-C₄)-alkylamino carbonyl-(C₁-C₄)-alkyl, (C₃-C₆)-cycloalkyl-(C₁-C₄)-alkylaminocarbonyl-(C₁-C₄)-alkyl, (C₁-C₄)-alkoxycarbonylaminocarbonyl-(C₁-C₄)-alkyl, aryl-(C₁-C₄)-alkoxycarbonylamino carbonyl-(C₁-C₄)-alkyl, (C₁-C₄)-alkoxycarbonyl-(C₁-C₄)-alkylamino carbonyl, hydroxycarbonyl-(C₁-C₄)-alkylaminocarbonyl, aminocarbonyl-(C₁-C₄)-alkylaminocarbonyl, (C₁-C₄)-alkylaminocarbonyl-(C₁-C₄)-alkylaminocarbonyl, (C₃-C₆)-cycloalkylaminocarbonyl-(C₁-C₄)-alkylaminocarbonyl, (C₃-C₆)-cycloalkyl-(C₁-C₄)-alkylamino carbonyl, (C₃-C₆)-cycloalkyl-(C₁-C₄)-alkylaminocarbonyl-(C₁-C₄)-alkyl, (C₂-C₄)-alkenyloxycarbonyl, (C₂-C₄)-alkenyloxycarbonyl-(C₁-C₄)-alkyl, (C₂-C₄)-alkenylaminocarbonyl, (C₂-C₄)-alkenyl-(C₁-C₄)-alkylamino carbonyl, (C₂-C₄)-alkenylaminocarbonyl-(C₁-C₄)-alkyl, (C₂-C₄)-alkenyl-(C₁-C₄)-alkylaminocarbonyl-(C₁-C₄)-alkyl.
and Q is furthermore one of the Q-1.1 to Q-24.15 moieties specifically listed in the table below

| | |
|---|---|
| 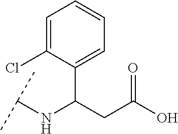 | Q-1.1 |
| 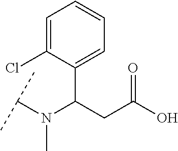 | Q-1.2 |
| 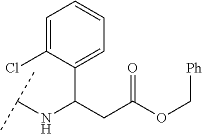 | Q-1.3 |
| 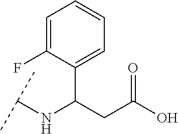 | Q-1.4 |
| 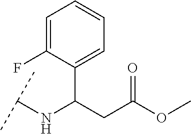 | Q-1.5 |
| 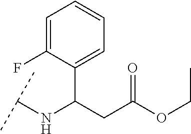 | Q-1.6 |
| 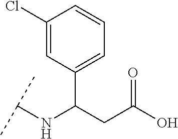 | Q-1.7 |
| 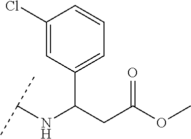 | Q-1.8 |
| 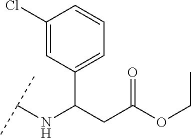 | Q-1.9 |
| 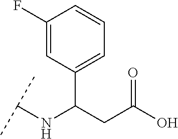 | Q-1.10 |
| 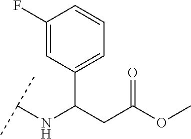 | Q-1.11 |
| 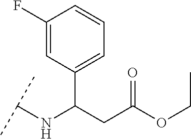 | Q-1.12 |
| 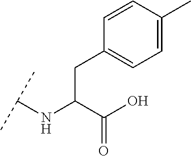 | Q-1.13 |
| 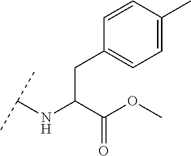 | Q-1.14 |
| 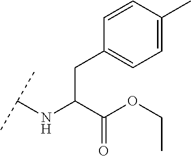 | Q-1.15 |
| 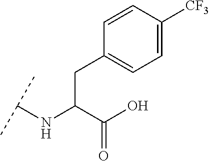 | Q-1.16 |
| 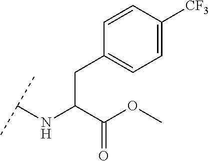 | Q-1.17 |
| 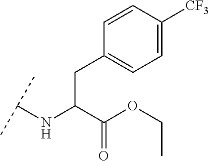 | Q-1.18 |
| 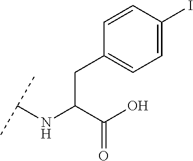 | Q-1.19 |
| 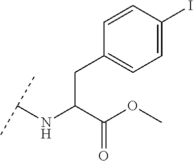 | Q-1.20 |
| 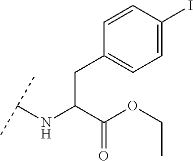 | Q-1.21 |
| 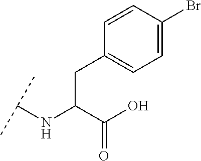 | Q-1.22 |
| 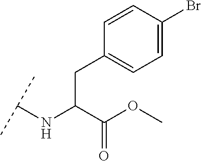 | Q-1.23 |
| 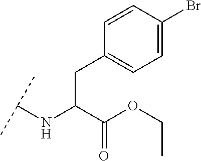 | Q-1.24 |
| 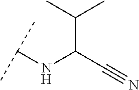 | Q-1.25 |
| 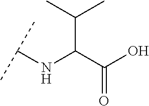 | Q-1.26 |
| 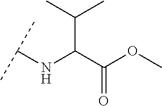 | Q-1.27 |
| 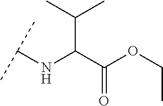 | Q-1.28 |
| 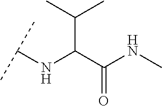 | Q-1.29 |
| 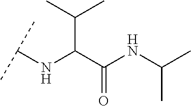 | Q-1.30 |
| 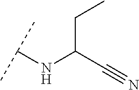 | Q-1.31 |
| 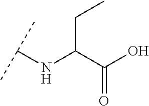 | Q-1.32 |
| 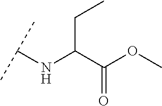 | Q-1.33 |
| 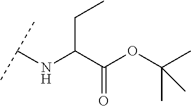 | Q-1.34 |
| 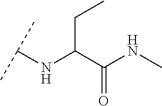 | Q-1.35 |
| 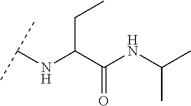 | Q-1.36 |
| 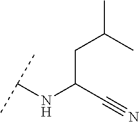 | Q-1.37 |
| 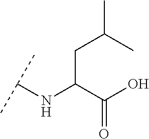 | Q-1.38 |
| 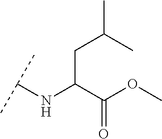 | Q-1.39 |
| 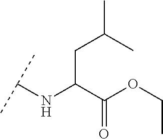 | Q-1.40 |
| 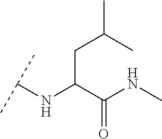 | Q-1.41 |
| 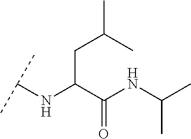 | Q-1.42 |
| 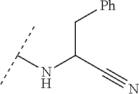 | Q-1.43 |
| 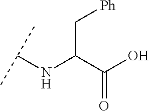 | Q-1.44 |
| 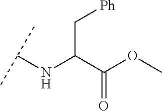 | Q-1.45 |
| 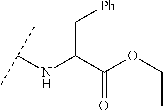 | Q-1.46 |
| 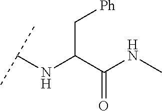 | Q-1.47 |
| 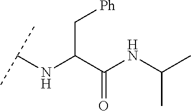 | Q-1.48 |
| 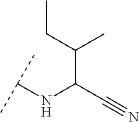 | Q-1.49 |
| 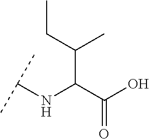 | Q-1.50 |
| 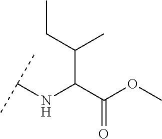 | Q-1.51 |
| 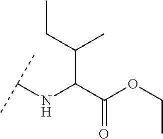 | Q-1.52 |
| 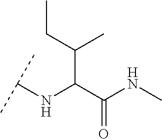 | Q-1.53 |
| 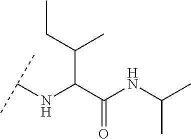 | Q-1.54 |
| 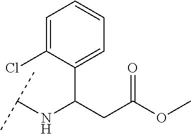 | Q-1.55 |
| 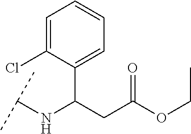 | Q-1.56 |
| 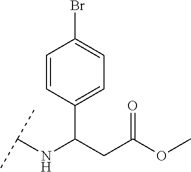 | Q-1.57 |
| 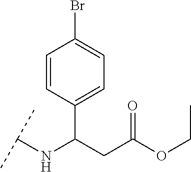 | Q-1.58 |
| 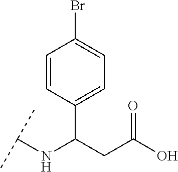 | Q-1.59 |
| 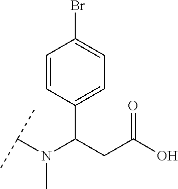 | Q-1.60 |
| 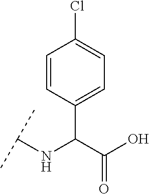 | Q-1.61 |
| 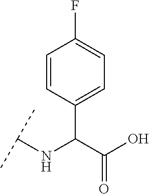 | Q-1.62 |
| 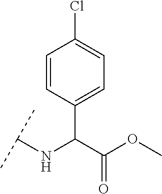 | Q-1.63 |
| 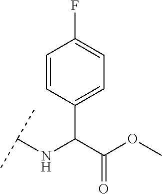 | Q-1.64 |
| 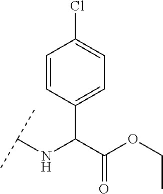 | Q-1.65 |
| 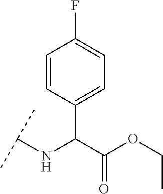 | Q-1.66 |
| 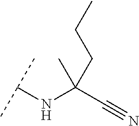 | Q-1.67 |
| 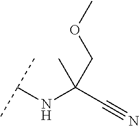 | Q-1.68 |
| 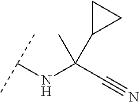 | Q-1.69 |
| 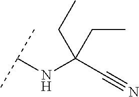 | Q-1.70 |
| 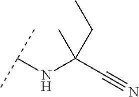 | Q-1.71 |
| 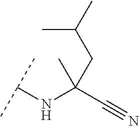 | Q-1.72 |
| 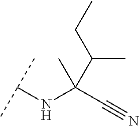 | Q-1.73 |
| 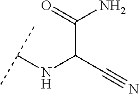 | Q-1.74 |
| 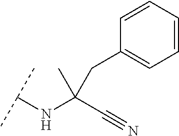 | Q-1.75 |
| 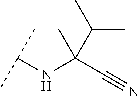 | Q-1.76 |
| 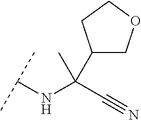 | Q-1.77 |
| 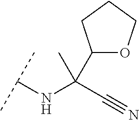 | Q-1.78 |
| 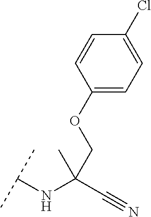 | Q-1.79 |
| 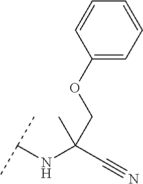 | Q-1.80 |
| 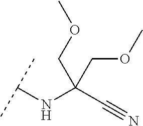 | Q-1.81 |
| 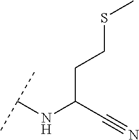 | Q-1.82 |
| 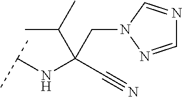 | Q-1.83 |
| 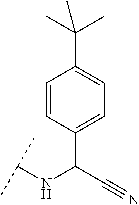 | Q-1.84 |
| 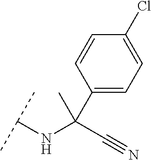 | Q-1.85 |
| 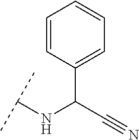 | Q-1.86 |
| 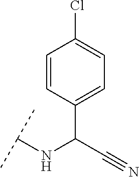 | Q-1.87 |
| 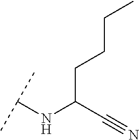 | Q-1.88 |
| 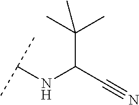 | Q-1.89 |
| 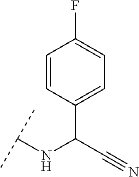 | Q-1.90 |
| 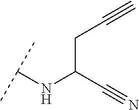 | Q-1.91 |
| 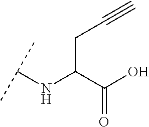 | Q-1.92 |
| 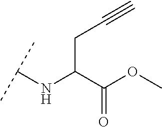 | Q-1.93 |
| 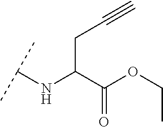 | Q-1.94 |
| 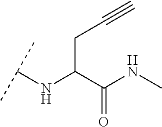 | Q-1.95 |
| 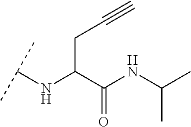 | Q-1.96 |
| 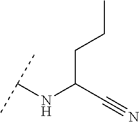 | Q-1.97 |
| 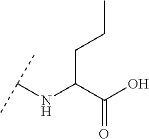 | Q-1.98 |
| 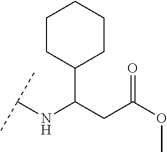 | Q-1.99 |
| 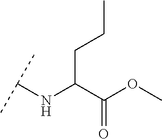 | Q-1.100 |
| 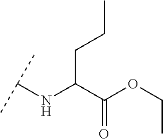 | Q-1.101 |
| 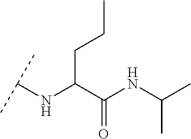 | Q-1.102 |
| 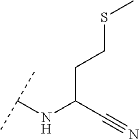 | Q-1.103 |
| 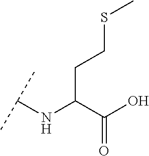 | Q-1.104 |
| 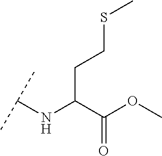 | Q-1.105 |
| 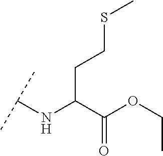 | Q-1.106 |
| 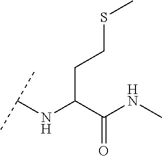 | Q-1.107 |
| 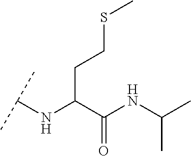 | Q-1.108 |
| 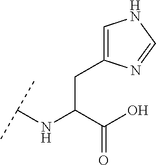 | Q-1.109 |
| 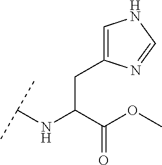 | Q-1.110 |
| 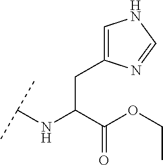 | Q-1.111 |
| 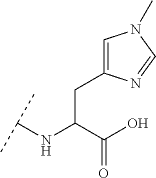 | Q-1.112 |
| 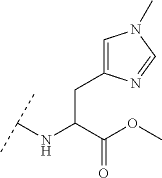 | Q-1.113 |
| 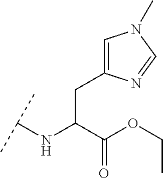 | Q-1.114 |
| 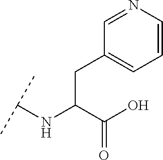 | Q-1.115 |
| 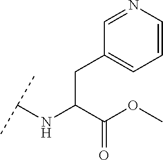 | Q-1.116 |
| 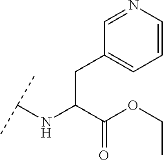 | Q-1.117 |
| 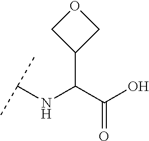 | Q-1.118 |
| 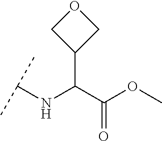 | Q-1.119 |
| 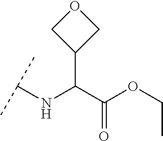 | Q-1.120 |
| 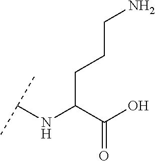 | Q-1.121 |
| 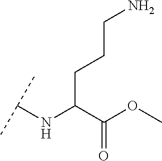 | Q-1.122 |
| 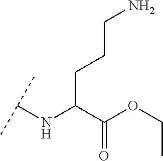 | Q-1.123 |
| 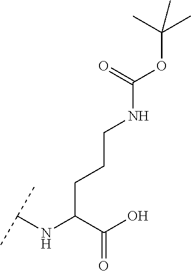 | Q-1.124 |
| 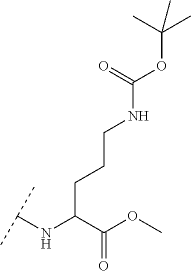 | Q-1.125 |
| 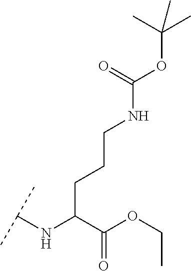 | Q-1.126 |
| 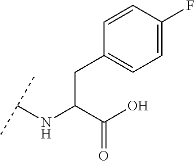 | Q-1.127 |
| 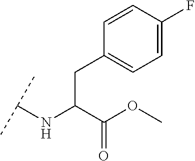 | Q-1.128 |
| 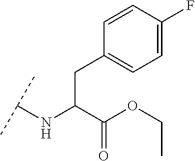 | Q-1.129 |
| 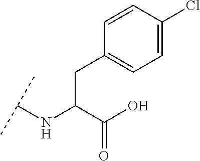 | Q-1.130 |
| 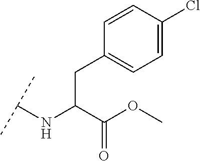 | Q-1.131 |
| 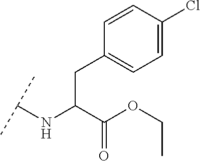 | Q-1.132 |
| 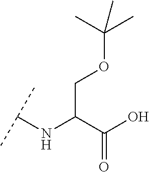 | Q-1.133 |
| 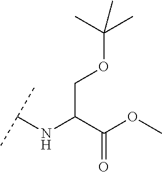 | Q-1.134 |
| 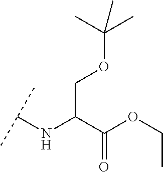 | Q-1.135 |
| 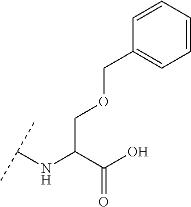 | Q-1.136 |
| 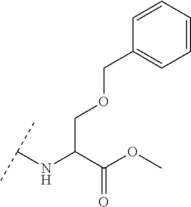 | Q-1.137 |
| 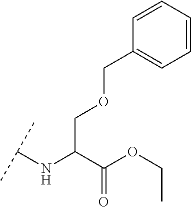 | Q-1.138 |
| 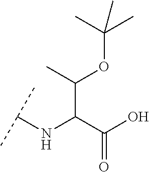 | Q-1.139 |
| 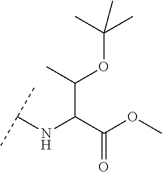 | Q-1.140 |
| 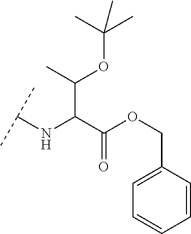 | Q-1.141 |
| 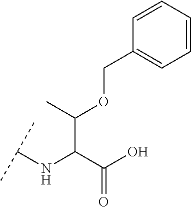 | Q-1.142 |
| 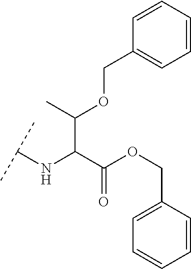 | Q-1.143 |
| 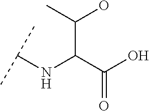 | Q-1.144 |
| 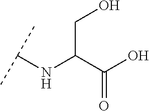 | Q-1.145 |
| 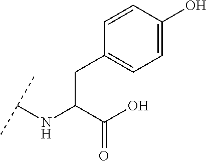 | Q-1.146 |
| 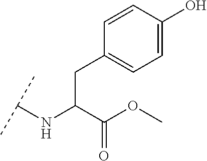 | Q-1.147 |
| 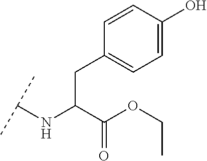 | Q-1.148 |
| 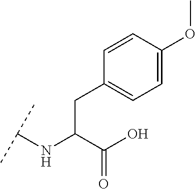 | Q-1.149 |
| 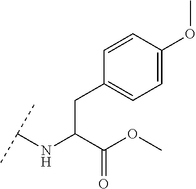 | Q-1.150 |
| 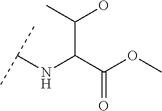 | Q-1.151 |
| 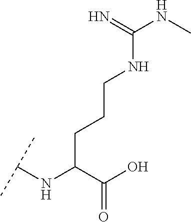 | Q-1.152 |
| 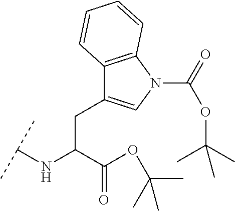 | Q-1.153 |
| 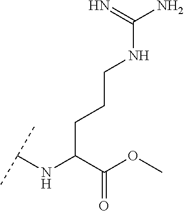 | Q-1.154 |
| 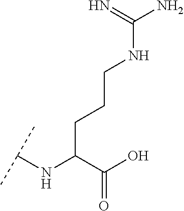 | Q-1.155 |
| 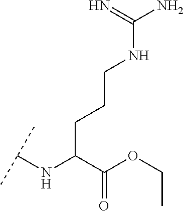 | Q-1.156 |
| 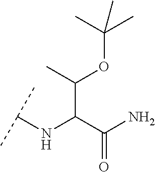 | Q-1.157 |
| 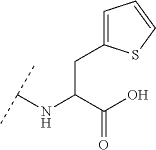 | Q-1.158 |
| 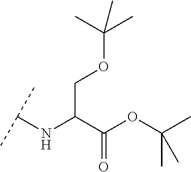 | Q-1.159 |
| 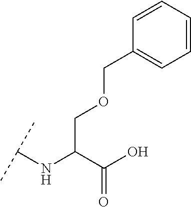 | Q-1.160 |
| 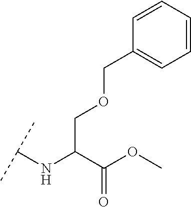 | Q-1.161 |
| 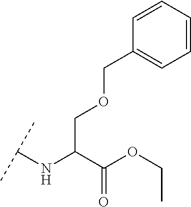 | Q-1.162 |
| 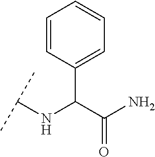 | Q-1.163 |
| 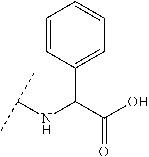 | Q-1.164 |
| 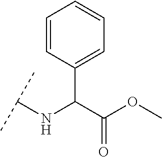 | Q-1.165 |
| 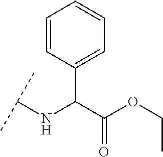 | Q-1.166 |
| 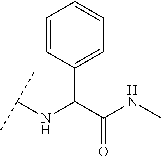 | Q-1.167 |
| 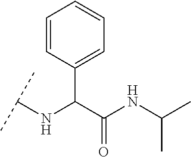 | Q-1.168 |
| 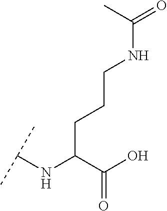 | Q-1.169 |
| 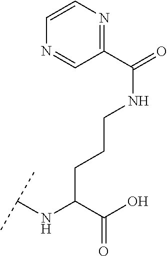 | Q-1.170 |
| 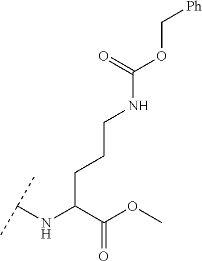 | Q-1.171 |
| 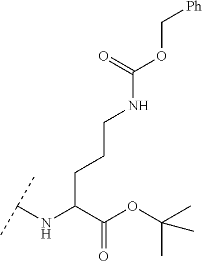 | Q-1.172 |
| 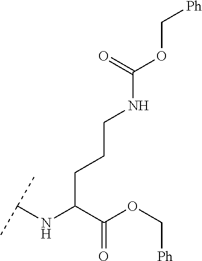 | Q-1.173 |
| 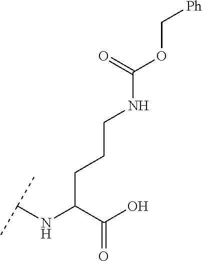 | Q-1.174 |
| 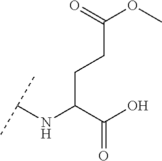 | Q-1.175 |
| 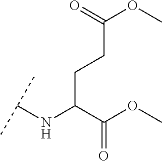 | Q-1.176 |
| 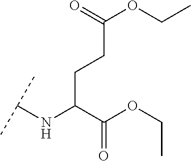 | Q-1.177 |
| 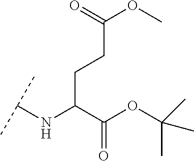 | Q-1.178 |
| 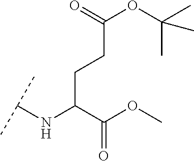 | Q-1.179 |
| 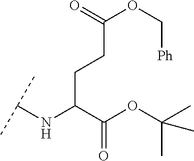 | Q-1.180 |
| 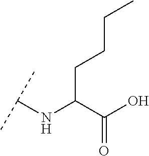 | Q-1.181 |
| 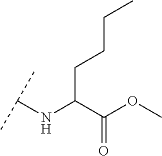 | Q-1.182 |
| 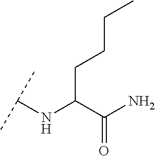 | Q-1.183 |
| 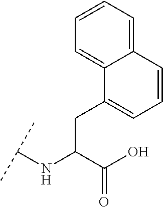 | Q-1.184 |
| 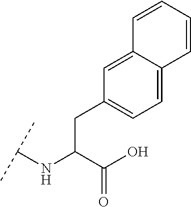 | Q-1.185 |
| 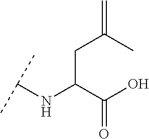 | Q-1.186 |
| 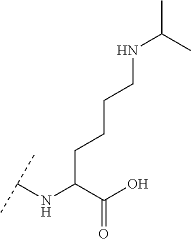 | Q-1.187 |
| 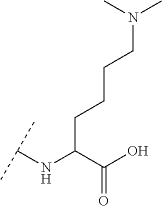 | Q-1.188 |
| 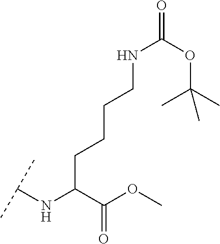 | Q-1.189 |
| 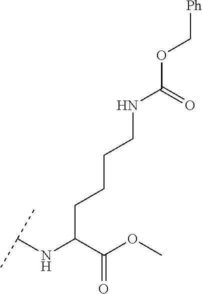 | Q-1.190 |
| 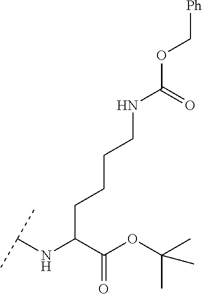 | Q-1.191 |
| 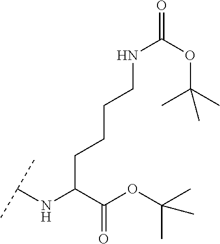 | Q-1.192 |
| 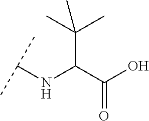 | Q-1.193 |
| 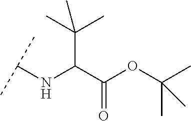 | Q-1.194 |
| 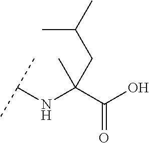 | Q-1.195 |
| 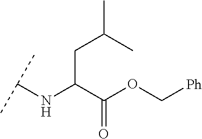 | Q-1.196 |
| 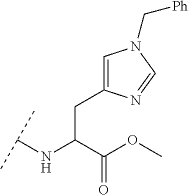 | Q-1.197 |
| 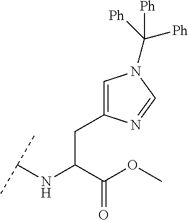 | Q-1.198 |
| 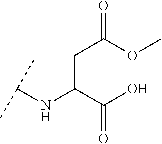 | Q-1.199 |
| 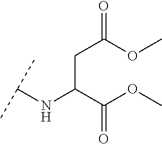 | Q-1.200 |
| 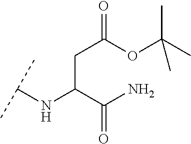 | Q-1.201 |
| 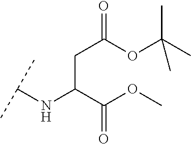 | Q-1.202 |
| 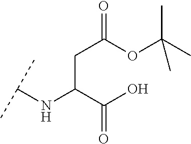 | Q-1.203 |
| 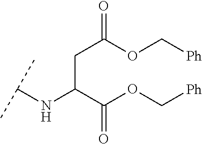 | Q-1.204 |
| 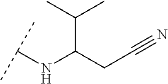 | Q-1.205 |
| 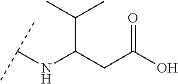 | Q-1.206 |
| 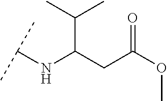 | Q-1.207 |
| 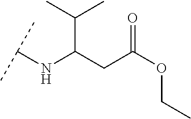 | Q-1.208 |
| 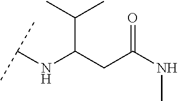 | Q-1.209 |
| 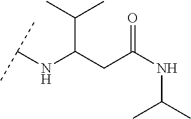 | Q-1.210 |
| 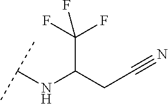 | Q-1.211 |
| 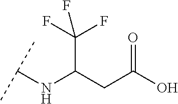 | Q-1.212 |
| 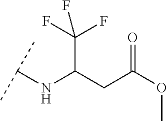 | Q-1.213 |
| 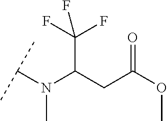 | Q-1.214 |
| 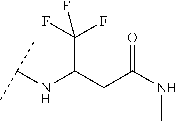 | Q-1.215 |
| 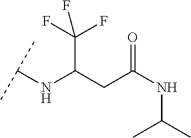 | Q-1.216 |
| 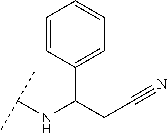 | Q-1.217 |
| 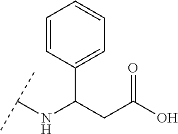 | Q-1.218 |
| 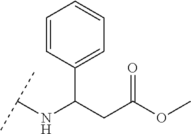 | Q-1.219 |
| 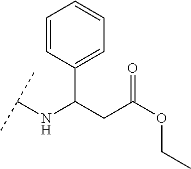 | Q-1.220 |
| 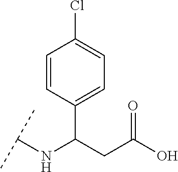 | Q-1.221 |
| 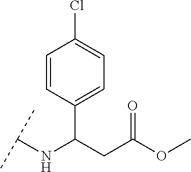 | Q-1.222 |
| 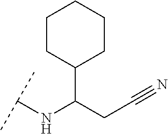 | Q-1.223 |
| 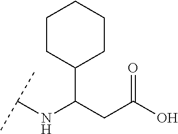 | Q-1.224 |
| 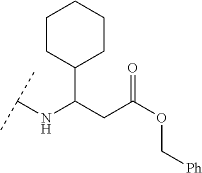 | Q-1.225 |
| 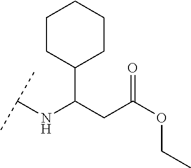 | Q-1.226 |
| 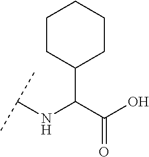 | Q-1.227 |
| 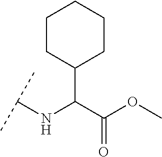 | Q-1.228 |
| 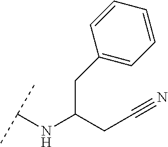 | Q-1.229 |
| 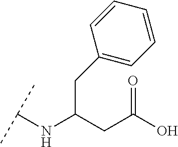 | Q-1.230 |
| 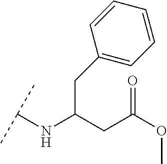 | Q-1.231 |
| 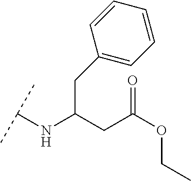 | Q-1.232 |
| 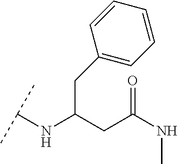 | Q-1.233 |
| 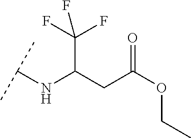 | Q-1.234 |
| 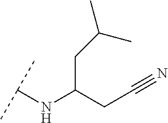 | Q-1.235 |
| 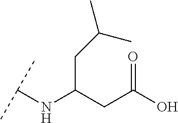 | Q-1.236 |
| 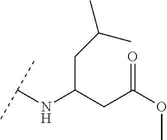 | Q-1.237 |
| 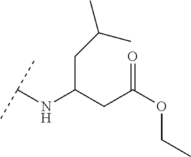 | Q-1.238 |
| 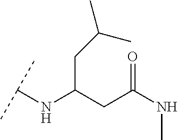 | Q-1.239 |
| 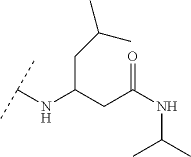 | Q-1.240 |
| 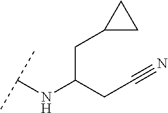 | Q-1.241 |
| 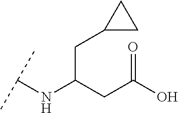 | Q-1.242 |
| 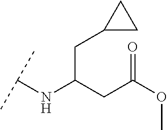 | Q-1.243 |
| 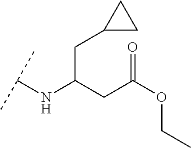 | Q-1.244 |
| 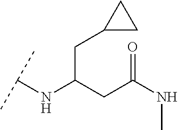 | Q-1.245 |
| 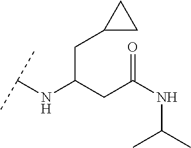 | Q-1.246 |
| 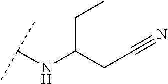 | Q-1.247 |
| 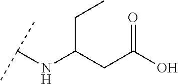 | Q-1.248 |
| 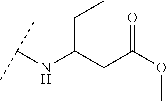 | Q-1.249 |
| 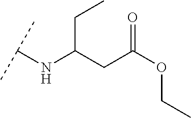 | Q-1.250 |
| 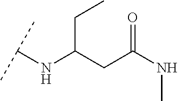 | Q-1.251 |
| 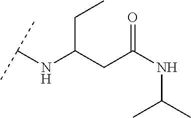 | Q-1.252 |
| 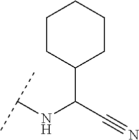 | Q-1.253 |
| 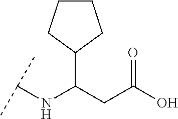 | Q-1.254 |
| 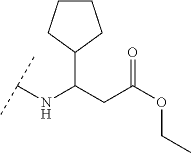 | Q-1.255 |
| 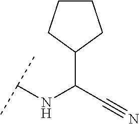 | Q-1.256 |
| 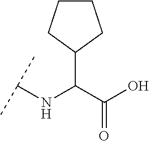 | Q-1.257 |
| 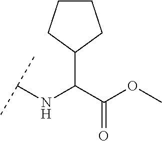 | Q-1.258 |
| 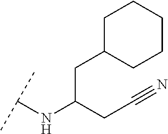 | Q-1.259 |
| 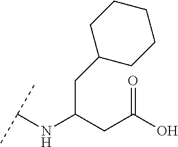 | Q-1.260 |
| 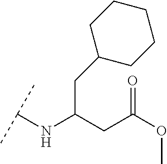 | Q-1.261 |
| 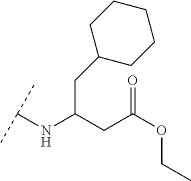 | Q-1.262 |
| 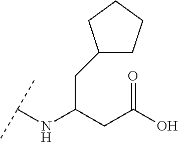 | Q-1.263 |
| 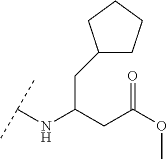 | Q-1.264 |
| 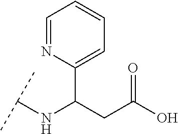 | Q-1.265 |
| 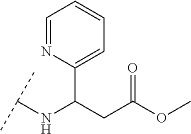 | Q-1.266 |
| 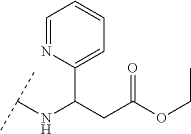 | Q-1.267 |
| 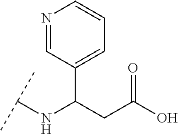 | Q-1.268 |
| 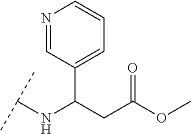 | Q-1.269 |
| 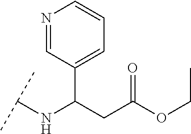 | Q-1.270 |
| 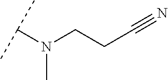 | Q-20.7 |
| 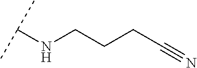 | Q-20.8 |
| 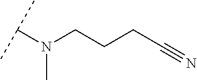 | Q-20.9 |
| 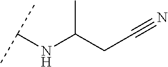 | Q-20.10 |
| 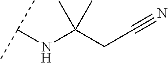 | Q-20.11 |
| 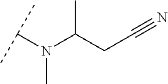 | Q-20.12 |
| 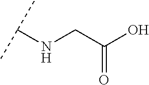 | Q-21.1 |
| 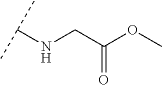 | Q-21.2 |
| 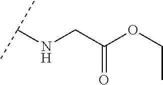 | Q-21.3 |
| 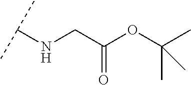 | Q-21.4 |
| 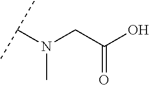 | Q-21.5 |
| 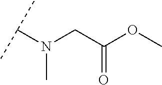 | Q-21.6 |
| 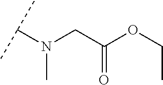 | Q-21.7 |
| 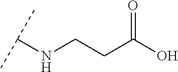 | Q-21.8 |
| 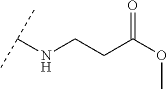 | Q-21.9 |
| 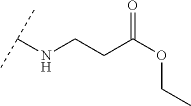 | Q-21.10 |
| 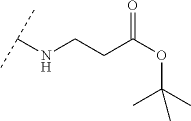 | Q-21.11 |
| 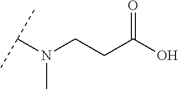 | Q-21.12 |
| 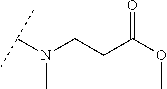 | Q-21.13 |
| 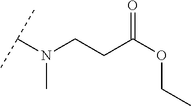 | Q-21.14 |
| 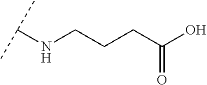 | Q-21.15 |
| 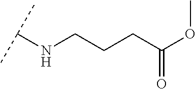 | Q-21.16 |
| 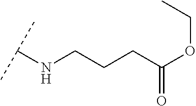 | Q-21.17 |
| 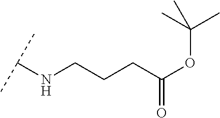 | Q-21.18 |
| 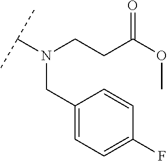 | Q-22.1 |
| 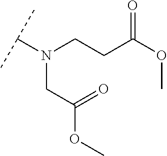 | Q-22.2 |
| 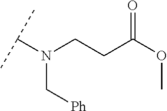 | Q-22.3 |
| 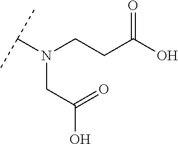 | Q-22.4 |
| 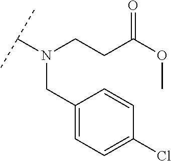 | Q-22.5 |
| 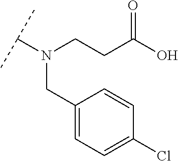 | Q-22.6 |
| 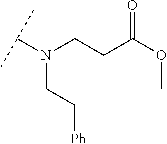 | Q-22.7 |
| 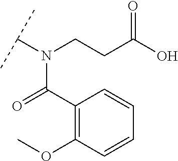 | Q-22.8 |
| 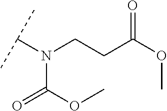 | Q-22.9 |
| 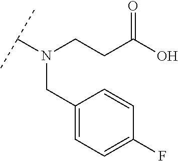 | Q-22.10 |
| 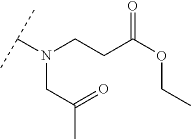 | Q-22.11 |
| 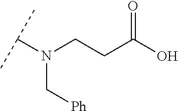 | Q-22.12 |
| 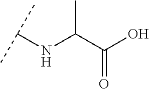 | Q-23.1 |
| 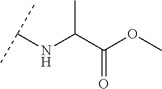 | Q-23.2 |
| 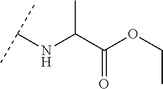 | Q-23.3 |
| 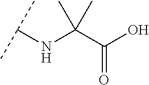 | Q-23.4 |
| 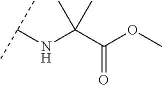 | Q-23.5 |
| 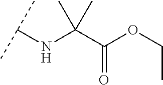 | Q-23.6 |
| 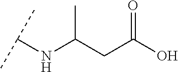 | Q-24.1 |
| 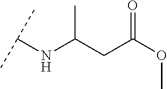 | Q-24.2 |
| 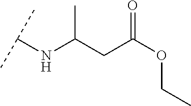 | Q-24.3 |
| 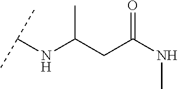 | Q-24.4 |
| 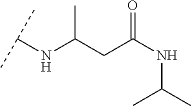 | Q-24.5 |
| 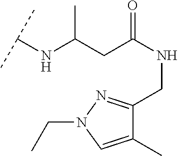 | Q-24.6 |
| 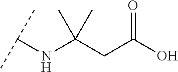 | Q-24.7 |
| 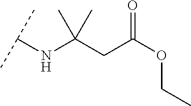 | Q-24.8 |
| 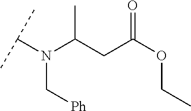 | Q-24.9 |
| 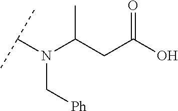 | Q-24.10 |
| 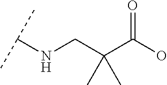 | Q-24.11 |
| 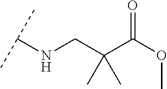 | Q-24.12 |
| 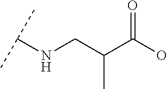 | Q-24.13 |
| 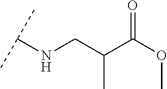 | Q-24.14 |
| 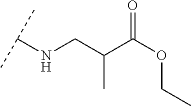 | Q-24.15 |

4. A method for treating plants, comprising applying a nontoxic amount, effective for enhancing resistance of a plant to at least one abiotic stress factor, at least one compound of formula (I) and/or a salt thereof as claimed in claim 1.

5. The method as claimed in claim 4, wherein the at least one abiotic stress condition corresponds to at least one condition selected from the group consisting of drought, cold and drought stress, osmotic stress, waterlogging, elevated soil salinity, elevated exposure to minerals, ozone conditions, strong light conditions, limited availability of nitrogen nutrients, and limited availability of phosphorus nutrients.

6. The open-chain aryl-, heteroaryl- and/or benzylsulfonamidocarboxylic acid, -carboxylic ester, -carboxamide and/or -carbonitrile and/or salt thereof as claimed in claim 1 capable of being used in a spray application to a plant and/or a plant part in combinations with at least one active ingredient selected from the group consisting of insecticides, attractants, acaricides, fungicides, nematicides, herbicides, growth regulators, safeners, substances which influence plant maturity and bactericides.

7. The open-chain aryl-, heteroaryl- and/or benzylsulfonamidocarboxylic acid, -carboxylic ester, -carboxamide and/or -carbonitrile and/or salt thereof as claimed in claim 1 capable of being used in a spray application to a plant and/or a plant part in combination with at least one fertilizer.

8. The open-chain aryl-, heteroaryl- and/or benzylsulfonamidocarboxylic acid, -carboxylic ester, -carboxamide and/or -carbonitrile and/or salt thereof as claimed in claim 1 capable of being used for application to a genetically modified variety, seed thereof, and/or to a cultivated area on which said genetically modified variety grows.

9. A spray solution comprising at least one open-chain aryl-, heteroaryl- and/or benzylsulfonamidocarboxylic acid, -carboxylic ester, -carboxamide and/or -carbonitrile and/or salt thereof as claimed in claim 1 capable of being used for enhancing resistance of a plant to an abiotic stress factor.

10. A method for increasing stress tolerance in a plant selected from the group consisting of useful plants, ornamental plants, lawn types and trees, which comprises applying a sufficient, nontoxic amount of at least one one compound of the open-chain aryl-, heteroaryl- and/or benzylsulfonamidocarboxylic acid, -carboxylic ester, -carboxamide and/or -carbonitrile and/or salt thereof as claimed in claim 1 to an area where a corresponding effect is desired, comprising applying to a plant, seed thereof and/or to an area on which a plant grows.

11. The method as claimed in claim 10, wherein resistance of a treated plant to abiotic stress is increased by at least 3% compared to an untreated plant under otherwise identical physiological conditions.
